(19) United States
(12) Patent Application Publication
(10) Pub. No.: US 2024/0046318 A1
(43) Pub. Date: Feb. 8, 2024

(54) SOCIAL NETWORK WITH NETWORK-BASED REWARDS

(71) Applicant: Arbnor Muriqi, Yonkers, NY (US)

(72) Inventor: Arbnor Muriqi, Yonkers, NY (US)

(21) Appl. No.: 18/230,612

(22) Filed: Aug. 4, 2023

Related U.S. Application Data
(60) Provisional application No. 63/395,322, filed on Aug. 4, 2022.

(51) Int. Cl. G06Q 30/0241; G06Q 50/00; G06Q 20/38; G06Q 30/0273

(52) U.S. Cl. CPC G06Q 30/0277; G06Q 50/01; G06Q 20/389; G06Q 30/0273; G06Q 20/10

(57) ABSTRACT

A user interface system is provided, comprising a content display output for presentation of content to a user; a communication network interface port; and at least one automated processor configured to: receive at least one hyperlink in a social network record of a social network; request content associated with the hyperlink; receive an advertisement associated with at least one of the user, the social network record, the hyperlink, and the content; verify presentation of the advertisement to the user; present the content to the user; and account for presentation of the advertisement to the user, by crediting at least one account distinct from an account associated with the user, an account associated with a content owner, and an account associated with a social network.

### CROSS REFERENCE TO RELATED APPLICATIONS

The present application claims benefit of priority under 35 U.S.C. § 119(e) from U.S. Provisional Patent Application No. 63/395,322, filed Aug. 4, 2022, the entirety of which is expressly incorporated herein by reference.

### FIELD OF THE INVENTION

The present invention relates to a social or user network that provides network-activity based rewards or incentives (or disincentives) to participants to encourage or discourage activities.

### BACKGROUND OF THE INVENTION

Each patent and non-patent literature reference cited herein is expressly incorporated herein by reference in its entirety as if expressly recited explicitly herein, for all purposes. Numbers refer to US Patent or Published Patent Application Nos., unless otherwise indicated.

The various disclosures of known concepts discussed herein are intended to be combined and permuted in accordance with the disclosure, to achieve the configurations and functions described.

A social network is a social structure made up of a set of social actors (such as individuals or organizations), sets of dyadic ties, and other social interactions between actors. The social network perspective provides a set of methods for analyzing the structure of whole social entities as well as a variety of theories explaining the patterns observed in these structures. The study of these structures uses social network analysis to identify local and global patterns, locate influential entities, and examine network dynamics.

Social network analysis represents an approach to understanding peer influence in larger social contexts. Social network analysis relies on the mapping of relationships or ties between different individuals. Individuals may be linked to one another through any number of relationship types or associations, from friends, associates, or individuals with whom they spend time. Social networks are typically identified through asking individuals to nominate all of their relationship ties within a certain context.

In typical social networks, the user receives benefits from using the network for free, but is subject to advertising or various other forms of monetization of the user or the user's information. An advertiser or subsidy provider pays, and the platform proprietor receives the payment. In content distribution networks and systems, users pay a subscription or content viewing fee and/or an advertiser pays for ads or product placements. In each case, the economic transfers fail to accurately address all economic and social costs, and therefore the result is suboptimum. According to one aspect, a distribution algorithm is provided that addresses a plurality of, and preferably all, relevant factors. For example, in a social network, a referrer of content has a cost, e.g., opportunity cost, which is compensated by a valuation function.

In complex economic transactions amongst multiple parties in an electronic network, in which trust may be required, it is advantageous to employ cryptocurrencies authenticated on a distributed ledger. Likewise, the economic transactions may be defined and controlled by a smartcontract. When the economic transactions impact the real economy, government regulations may require tax and transaction reporting, know-your-customer compliance, etc. The use of distributed ledger/blockchain transactions, and smartcontracts can assist in compliance with government regulations. The tokens may represent arbitrary units of wealth, a fiat currency, or other unit such as a commercial points program (e.g., airline miles, credit card points, S&H stamps [en.wikipedia.org/wiki/S %26H_Green_Stamps], etc.).

### SUMMARY OF THE INVENTION

The present invention involves use of incentives or disincentives to facilitate overall value and benefit of a user network, such as a social network. The incentives may be in the form of cryptocurrency or cryptographic tokens, and may be distributed to various participants (or abstaining non-participants) according to a comprehensive value function, such as content providers, resource providers, content recipients, investors, etc. The tokens are supplied by beneficiaries, who may be, for example, advertisers, media consumers, investors, or other sponsors, for example. The network may be partially or fully decentralized, or operate on a hybrid model, in which a privileged centralized infrastructure exists and is available to perform or facilitate system operations, but is not required for operation of the network. Indeed, the decentralized option constrains the privileged centralized infrastructure to abide by its rules or constraints, at risk of being demoted. The network has different functions, which may be consolidated or segregated, in which various functions are independently implemented, using various options.

The system has a centralized, decentralized, hybrid, or other control mechanism to apply the costs and benefits to the various participants or affected parties. In the simplest case, the costs and incentives/disincentives have predetermined and published values, so that each party may have advance notice of the value of participation. In more complex implementation, the control provides a dynamic economic optimization, or a dynamic decentralized economic optimization, which may take the form of an auction or multipart auction.

A particular use case of the system is a social content recommendation and distribution system. In this network, the major participants are content creators, content consumers, advertisers, network operators, and recommenders/influencers. Of course, other participants may be included as well. In this case, a content creator is typically compensated for making the content available, though in the case of promotional content (which may be advertising), the content provider pays for consumption of its content. Advertisers pay for placement of their messaging (though particularly popular ads may achieve meme status, and obtain positive utility and payment to the advertisement proprietor). The content consumer in this case has at least two economic functions, payment for content consumption, and subsidy payment for accepting and reviewing advertisements. The amount and value of the content and advertisements will determine the net user accounting. The network operator receives a payment or commission from some or all of the transactions on the network. Finally, recommenders and influencers, which serve to bias the network and give it character, receive payments for the value of their contributions. The network may also include investors, who provide payments to facilitate system operation, and receive return on investment from revenue streams. The investor function may be integrated with the network operator, or distinct from it.

The recommenders/influencers serve as peer leaders and visionaries, to define social norms, trends and political correctness. They pass value judgements, and cancel members. The network operator may exert control over the use and weighting of recommender/influencer effects, though in a fully decentralized system, the network operator may have little or no influence.

In various embodiments, the network operator, or other privileged member of the network may influence its control over the network through privileged tokens that differ from the normal participant tokens, that are used to control or bias/weight functions. The privileged tokens have different characteristics from “consumer” tokens, but operate within the optimization and targeting algorithms cooperative and competitive with the consumer tokens. There may be a plurality of different privileged tokens. These privileged tokens may be burnt (deactivated) during their use, transformed into another token type, distributed to other participants, or other disposition. In general, the common token has an economic value, and has a limited supply and positive demand. One type of privileged token has an unlimited supply to the network operator, and insignificant demand, such as due to restrictions on use. As a result, the value is zero or near zero, except to the network operator. The privileged tokens therefore perturb the targeting and compensation algorithms, and excess use will destabilize the network. As a result, the network operator is constrained by its own pecuniary interest to limit its privileged control over the network. The network operator may also use common tokens, though the costs may be prohibitive.

The media distribution social network is built around client software, which provides a media player with digital rights management support, cryptocurrency wallet and transactional support, and other social network functions such as referral/recommendation and messaging. In order to preserve privacy, communications may be encrypted end-to-end, which may be performed using transcryption (untrusted intermediary) and/or homomorphic cryptography (operations on encrypted messages).

The client software may operate as part of a decentralized ad hoc communication network, obviating the need for a massive scale centralized infrastructure. The client software uses and manages local storage, and broadband network access to communicate with other client software. Messages within the network may be routed using local routing tables, metadata, distributed ledgers, central database lookups, etc. Direct communications with a central server are also supported, thereby maintaining a conduit for the social network proprietor to exercise some control and ensure network stability.

In a prototypical embodiment, a social network is provided with a centralized or decentralized social network database, storing relationships between people and other objects, associated characteristics and information, and links to content and subsidized content (advertisements). In a decentralized database, the records may be stored in a decentralized ledger, with cryptographic protection of the content except with respect to authorized recipients. Typically, the distributed database would be replicated or near-replicated in a centralized location. In contrast to a cryptocurrency blockchain, immutability and perpetuality of data records are not necessarily critical characteristics of this aspect of the system. The token system, in contrast, preferably has characteristics of a more typical cryptocurrency blockchain. The various distributed ledgers may be consolidated or separate. The social network database is updatable, and according to social network rules, records may be purged and/or modified. Thus, the social network distributed ledger need not be immutable or non-repudiable, and therefore may be simplified with respect to a Bitcoin style blockchain.

In the social network, one typical aspect is that users consume content. The content is sponsored by advertising. Content is recommended or suggested to users according to the social network by referrers or influencers, in addition to automated recommenders. The responsible referrer(s) or influencer(s) receive a portion of the subsidy for the content as compensation, and thus become incentivized for their activities within the social network. Users may also receive a portion of the subsidy as incentive for participation.

Each participant in the system registers with a registrar, which may be a part of the system or external. The registrar performs user verification and authentication, and assures proper reporting to regulatory authorities. The registrar issues a credential, which may thereafter be used anonymously (pseudonomously) in the network. The registrar may be, for example, a bank, professional employer organization (PEO), credit card issuer, or other financial institution.

The social network may include various features of existing social networks and other related systems, and the features discussed above are not mandatory.

The elements of the system may be provided with an application programming interface, which segregates the underlying resources and functionality, from the operational paradigm and implementation as a skin. The network may support multiple skins concurrently, or the network may be segregated between system that have different skins. In the former case, filters may be used to isolate or restrict content sharing across different skinned applications, while sharing the same infrastructure.

The system interacts with a user through client software, which interacts with both a peer-to-peer network and a central server (where available and supported). A distributed ledger transactional database performs fine-scale accounting for information flows and monetary or token transactions. Therefore, the system is less subject to censorship and government regulation than fully centralized systems. However, the client may provide for central control or third party control, as a moderating influence, to ensure system stability, or to provide a value-added service. The availability of an application programming interface (API) and reduced reliance on a single central service provider makes possible competition for required or optional services, with associated token transactions, further extending the range of interactions supported through the platform.

For example, while freedom from censorship and anonymizing virtual private network communications are features desired by some users, others prefer or require a “walled garden” with curated content and centrally controlled or managed interactions. For example, where the system and method is deployed in a business environment, and especially a regulated business, all communications may be authenticated and logged, content filtered for malicious content, secret exfiltration attempts, user time-wasting, phishing attempts, etc. The business may prefer to avoid all third party advertising, and simply pay (self-subsidize) network usage. Other examples are religious or social groups that wish to implement a biased system toward their own beliefs or norms, and to exclude, tag, or diminish opposing or antithetical beliefs. While as a general feature for all users, such control is undesired, a user or group of users may voluntarily accept external limitations. A still further example are persons or groups for which the embedded payment scheme is unacceptable. For example, business employees should normally not be paid by third parties for work supposedly on behalf of the employer. Likewise, some persons may wish to remain anonymous on the network, and regulations in the US for users which accept payment transactions require compliance with know-your-customer regulations. Therefore, a user may simply wish to opt-out of accepting payments, and therefore heightened authentication requirements.

Therefore, the user interface is preferably modular, with a rich API, that allows extensions of the functionality and customization of both functionality and aesthetics. The modules are preferably cryptographically signed and authenticated with a supervisor, which acts as a hypervisor that executes a virtual machine and associated operating system isolated from other processes executing on the same platform. This helps avoid malicious additions and helps protect the system from other malicious processes, especially those modules that directly or indirectly influence the distributed ledger transactions. Likewise, such functions as biometric authentication and cryptocurrency wallet may be held to a higher standard than other modules or extensions.

The system architecture may provide a hypervisor executing on a host platform, which in turn executes an operating system such as Linux, Android, iOS, or Windows, which in turn provide security features and execute modules or apps. The memory access, interrupts, and I/O requests all pass through the hypervisor, which itself may make use of a trusted platform module for root authentication. A fully anonymous and privacy preserving version, on the other hand, avoids use of any persistent identifiers, and does not maintain a unique wallet or accept identified token transactions.

The social network according to the present technology may include a number of component interests, including a proprietor, content providers, advertisers, and users. Architecturally, it is preferably a decentralized network with privileged routes of communication to the network operator/proprietor. Operation of the system is preferably stabilized using a blockchain type decentralized ledger, which may be permissioned, public, or a hybrid. Operation of the system is influenced by an economic optimization, which seeks to include accounting for the interests of each participant in the system in a consolidated function.

A blockchain is a system that creates authenticated blocks which are predicated on prior blocks, and which are therefore a small subset of the entire network record. This block architecture therefore allows some nodes to maintain an incomplete record of the entire database, while ensuring that new transactions may be authenticated, and as appropriate, non-repudiable, at all relevant nodes regardless of their historical databases. Blocks referenced in new transactions and not immediately available may be requested and communicated as needed. Because prior blocks are static and “frozen”, the information contained in them is considered immutable, unless the entire network agrees to replace an old block with a replacement, which then requires all subsequent blocks to be replaced, since they are dependent on a hash of the prior block(s). This is called a “fork”, which is typically a rare event. However, in a small cooperative community, the replacement of a block is possible. An alternate is to return to the block in contest, alter the transaction data, and reprocess all subsequent transactions into new blocks in a batch process, which may be more efficient than processing in a real-time competitive process. For example, because the subsequent blocks are already processed, the cryptographic strength of the batch process (which may be centralized) may be lower, and the competitive process for allocating work minimized or dispensed with, to create the new blocks. In an at-scale social network, replacing old blocks with updated data is likely infeasible and untenable, because the community is large, the cooperation is uncertain, and the risks of desynchronized distributed ledgers is high.

The client software may permit interfacing with traditional type advertising syndication platforms, such as Google, Yahoo, and Facebook, and/or a special platform dedicated advertising platform for the social network. In some cases, a user may be a content creator, and/or may sponsor content instead of advertisements (“sponsored content”). The consolidated function typically provides that the advertiser (and perhaps sponsor and/or investor) funds the system according to an advertisement/sponsorship/investment program, in which viewing (or listening) of sponsored content/advertisements by users in a context that promotes the interests of the advertiser leads to a subsidy. That subsidy is then distributed amongst the other participants. In modified systems, other sources of subsidy are obtained and employed. The interests of the advertiser typically include the sale of products or services, though public interest and awareness campaigns are also possible. The advertising campaign may pay per view, click (interaction), sale, commission on sale, subscription, etc. A sponsor may have more diverse interests. An investor is typically more interested in the health of the network and therefore its aggregate value, than in the gain on an individual transaction, but may nevertheless arbitrage differences in economics across the network (and even beyond the network) in order to make a profit. The investor therefore may provide required liquidity and absorb excess liquidity to ensure an efficient market for the other participants.

The user has an economic interest in the opportunity cost of its time, and enjoyment of the interaction.

The content provider may provide content without expected return (e.g., blog posts), or with expectation of a fixed or variable fee for the content per consumption (e.g., studios), or a blanket license fee, etc.

The proprietor/network operator seeks compensation for establishing the opportunity for the other participants, and its own opportunity costs, and generally has the power to set terms on the entire system. In an optimized system, the proprietor in a steady state scenario may seek to maximize its own current revenues or profits, though during transition may define different strategies that do not achieve maximization of current revenues or profits. As the system becomes less centralized and more open to competing interests, the market power of the proprietor is diminished, and the profit seeking behavior becomes competitive, with competitors either internal or external to the social network. The proprietor may also assume other roles, e.g., investor, sponsor, content provider, etc., in the system.

In some cases, the advertising may be embedded in content, and therefore the economic analysis of sponsorship, content purveyance, content advocacy, and consumption becomes different. However, in many cases, these perturbations are self-correcting, since the system typically operates as a competitive process between interested parties or their automated agents.

In addition to human influencers and recommenders, the system supports automated agents that serve these roles. According to one embodiment, an open API is available for third parties to provide recommender and influencer services, which may be human, artificial intelligence, machine learning algorithms, or other algorithms. While the presence of “bots” on other social networks is considered a nuisance or worse, according to one aspect of the present technology, the application of recommenders and influencers is based on economics and/or success, in a generally competitive process. If a deranged recommender is nevertheless successful in engaging content consuming users and fulfilling their demand, that deranged recommender will be compensated in the same way that any ethical recommender is compensated. Of course, when and if a recommender (human or otherwise) is considered undesirable, it may be banned from the network, or filtered from user streams, or otherwise controlled or constrained. The limits may be imposed by any member based on economic flows, i.e., a content consuming user may restrict particular recommenders from providing a feed to it. The network operator may limit or restrict a recommender across all or a portion of the entire network. An advertiser, sponsor or investor may choose to disassociate from a recommender and not be involved in transactions including it. Recommenders may also interact with each other, and impose rules or controls on that interaction.

The present invention relates to a system and method for implementing a social network, which includes explicit referral fee compensation. The compensation is derived from a subsidy flow. Typically, the subsidy is provided by an advertiser, but any subsidy source or revenue stream may be employed. In addition to compensating the platform proprietor (as in e.g., Google, Facebook), other payments may be made, e.g., to the referrer of the content to a user, the user him or herself, upstream influencers, and others whose cooperation with the system is to be incentivized. In some cases, syndicated ads from outside the network may be shown, especially where internal advertising supply is insufficient, e.g., to properly fund system operations.

Each participant in the system has a profile, against which rules and algorithms may be applied. The profile may be public, private (locally applied filtering at the user node only), or semi-private, such as usage applied at a central location with privacy applied based on trust, use of homomorphic encryption to employ a profile in encrypted form without decryption, etc. Messages and content may include targeting data or metadata which interact with content and/or user profiles to achieve targeting. For example, a value function may be included in media content that specifies parameters of a valuation function for the content owner. An advertiser may release an advertisement according to an advertisement placement program, targeting user characteristics (e.g., demographics, preferences, etc.), and having a valuation (fixed or algorithmic). The ad then competes with other ads (or blank space) for placement in ad slots, with the ad sponsor paying for ad placement, and the funds distributed according to the system rules. The ad may be worth more when displayed to some users than others. Different ads are generally played to different users, and repetition of ads may be defined by advertiser preferences and ad rules, as well as targeted user rules and preferences.

Some incentive payments may be defined by the platform proprietor, and others may be defined by the advertiser or subsidy provider.

For example, the user may be compensated for watching the advertisement, the system operator may be compensated for the underlying platform, a provider may be compensated for content, upstream referrers may be compensated for establishing the social network (referral network), commenters may be compensated, etc.

The general architecture includes a custom content player, though a browser may be employed as well. The player integrates the display of content and advertisements, digital rights management for content protection, viewer/user verification/authentication, and the economic accounting for the content and advertisements. The player may also implement a digital wallet, e-commerce portal, a distributed ad hoc network for content distribution and redistribution, and social network functions.

The network is tied to an economic platform, that may have its own incentives. The economic platform links tokens employed within the social network (electronic payments cannot be a typical fiat currency). The preferred tokens are a blockchain-based cryptocurrency. The blockchain may be a decentralized public ledger, which allows low centralized infrastructure transactions without a single point of failure, or as a permissioned blockchain. The typical token is like a micropayment, for example with a value of less than $1.00, and perhaps less than 1 cent, implying that the level of security required to ensure authenticity is not high, and that the transactional costs need to be maintained as a fraction of the transactional value. The economic platform may process individual transactions or aggregated token transactions. Therefore, especially for referrers, publishers and advertisers, an aggregated transaction may be, for example, thousands of dollars. Therefore, the security of the system should be sufficient for the largest transactions supported, or scalable with different levels for different valued transactions. The payments may be made in arbitrary units, and may represent fiat currency valuation, cryptocurrency valuation or tokens, or other value infrastructures, such as credit card and airlines points valuations. The token platform may be linked to a “rewards program”, to permit barter transactions instead of cash transactions. The rewards program may advantageously be linked to the advertising platform, with vendors both advertising and selling goods on the platform.

Under U.S. law, transactions require identification of counterparties, and reporting of payments above a threshold. This function may be within the economic platform itself, or provided as a distinct function and platform. For example, participant identification may be tokenized, with chained cryptographic authentication used to tie the user authentication platform to the economic platform, while preserving privacy. By segregating these functions, and indeed every function, each aspect of the platform may become competitive, with a unitary token exchange provided to connect the disparate parts.

While the system need not have all features or any particular feature, the social network implementation typically requires an end user interface with consistent functions and themes, i.e., client software. The client software (optionally in conjunction with a central server) provides user authentication, user profile maintenance, cryptocurrency wallet, content consumption, advertising viewing, content and advertising viewing auditing/verification, referral and commenting, etc.

Because of the referral compensation scheme, a part of the social network may include speculation by users of what is likely to become viral, and allowing promoters of the potentially viral content to “bet” on their selections, and receive rewards for correct determination of future viral capability of content. This function may be distinct from an investor function, in that the speculator does not necessarily value the platform, only the return on transactional risk, while the investor seeks a return on investment derived from the success of the platform over time. This internal competition may increase competition for advertising, and thus reduce low cost and presumably low quality (poorly targeted) advertising. The speculation may permit financial investment in the content, wagering (side bets), equity infusion into platform participants, arbitrage transactions, and the like. In some cases, the opportunity for speculation can lead to higher efficiency for underlying transactions, and therefore may present an investment opportunity. However, speculation on underlying risks, without equity in those risks, may have a destabilizing effect and lead to bubbles and crashes. This destabilization may be limited by regulation of the types of speculation and the value, taxing risk-taking or gains from speculation, or other controls.

The platform may be integrated with an online gaming platform, with enforcement of legal and regulatory restrictions within the client and other aspects of the system. For example, financial institution “know your customer” regulations, or other financial industry support firms may provide regulatory compliance functions. Of course, these functions may be internal to another participant in the system. Because there are token exchanges, the gaming may include embedded advertising, or the advertising itself may be gamified. Tax regulation compliance may be provided intrinsically for all transactions having a monetary impact.

In some cases, a participant may wish to avoid government tax regulations, in which case, for that user, no external transfers of wealth are permitted; therefore, according to mainstream interpretation, no income or gains are possible. While in some cases, this may block the user from functions otherwise supported by the platform, in other cases, an internal account may be used for content consumption subsidy, or other purely internal functions.

Preferably, one or more application programming interfaces (APIs) are provided for third parties to enhance and extend the system. Each API may be linked to a central or distributed command and control infrastructure, the client software, and/or a blockchain virtual machine.

The system may include payment processing. That is, because of the financial system integration and regulatory compliance aspects, as well as the wallet infrastructure, payments may be made and received through the system, for both consumer and commercial accounts. Internal payments may be made with low transaction fees, and have the advantage of adding liquidity to the platform. External transfers may employ traditional technologies at competitive rates. The internal token preferably has the characteristics of a stablecoin, i.e., tending to maintain a constant valuation with respect to fiat currency, especially over short periods. However, this is not a limitation on the system as a whole. However, participants may act quite differently when payments are made in stablecoins as opposed to market-valued tokens. For example, a stablecoin would incentivize a participant to maintain tokens in an account, while a market valued token would incentivize a risk averse participant to liquidate tokens at earliest opportunity. The ability to monetize transactions is important, as the various businesses operate in the macroeconomy and therefore a stable and scalable exchange is important (though not critical for all implementations). Note that the business interests would generally not use the system for long-term savings, and therefore exchange rate stability over long terms is less critical than short term liquidity.

Consumers and speculators, on the other hand, may be interested in investing in the platform, and may therefore store wealth in the platform on expectation of return on investment. In order to avoid risk of coordinated speculator action (i.e., mass selloff or buying), limits on sales may be implemented. This would generally limit external exchange, but not activities within the platform.

The platform may also implement an auction-style selling site, to permit consumer sale and purchase transactions.

In a preferred implementation, a cost function is applied for various aspects of system operation, including predicates, and an advertiser or subsidy fee may be split between the platform, the user (i.e., viewer of an ad), content provider (to the extent required or appropriate), referrer (and perhaps upstream referrers), and any relevant others. The cost function sets a minimum cost for a transaction (or in some cases, a maximum or permissible range) and an allocation of proceeds among the participants.

In a typical implementation, a group of advertisers establish competing campaigns to deliver ads to users based on content consumed, demographics, user profile, user history, etc. The advertisers compete to establish pricing, which may be individualized, clustered, or fixed price for example. The advertiser provides the main financial input, and escrows tokens to fulfill the campaign with a smart contract on the blockchain. As an advertisement is delivered, and optionally viewing of the advertisement verified, and optionally authentication of the view performed, the appropriate token(s) are released from the escrow. In general, these are fungible tokens, though in some cases non-fungible tokens or classes of tokens may be employed. The release of the token(s) from escrow by the smart contract also leads to their disposition, according to the smart contract terms. The smart contract is “funded” by the sponsor (or other funding source), and may be a generic template or a specific smart contract generated by the sponsor. A portion of the sponsorship is allocated to the platform, which may be a fixed fee, a commission, or some other basis.

Preferably, a portion of the token(s) are allocated by the smart contract to the referrer. The referrer is typically the referrer of the content associated with the sponsorship, but is not so limited. In another case, it is the advertisement that is referred to the end user. In other cases, the referrer has a tie to the referee, and is compensated on that basis, in the manner of a multi-level marketing network. Similarly, various relations of the referrer or referee may be compensated, such as further upstream referrers, other social ties to the referrer or referee, charitable causes of the referrer or referee, creditors of the referrer or referee, tax authorities (e.g., tax withholding), and the like.

Optionally, the referee may be compensated for viewing of the advertisement. For example, if the content has a predetermined price below the portion of the advertisement subsidy allocated to the viewer, the excess may accrue to the account of the viewer. This account may then me used to consume commercial-free content, make up for content that is more expensive than the ads provided to subsidize it, or any other purpose. The referee may further refer the content, advertising, etc. to a contact, and become the referrer in that case.

In some cases, communications and token transfers between various participants may be performed in an ad hoc manner, without central control. For example, without central control, unilateral censorship is avoided. However, users may opt-in to restrict, limit or filter communications, undesirable advertising, content, etc. Indeed, the system is not limited to a unitary type of token (though in competitive environments, there should be an exchange to perform economic valuation of disparate opportunities). Therefore, multiple blockchains, smart contract term types, smart contract platforms, etc., may all be employed using a user or machine single interface.

Extending this paradigm further, there may be multiple independent network operators, each with their own native token for operating their controlled resources. Other independent portions and agents on the internetwork may then process different tokens, or exchange then with other tokens for processing.

For example, a user (or a control entity over the user) may wish to self-censor objectionable content, advertising, and communications. Therefore, a filter may be provided which limits access to that information. The content permission rules may be applied in a central authority, in the client application, in a blockchain virtual machine, etc. Advantageously, content permission rules are distributed on a blockchain, and are updated by a superuser or other privileged participant. An inverse way of addressing content permission is to consider subscription based content, where content is only available to a viewer who meets certain criteria, such as payment of a subscription fee, or personal authentication.

The inclusion of referrers within the compensated group allows use of an attention token as part of a social network.

While referral networks may be based on pre-existing relationships between social network participants, the system may also permit new relationships to evolve, either by manual selection or automatically.

In the case of automatically proposed relationships, the individuals referring the content to the user may be selected based on unique attributes that those individuals have that allow them to have better insight than other persons. These individuals can influence the user's decisions' because of high correctness, reputability or other factors determined to be relevant. The “influencers” (peer leaders within the group) may be algorithmically determined dependent on a large data set that uses user profiles, outcomes, feedback, and tendencies. Applying known habits and behaviors to tagged data, clusters of advertising types may be developed and refined for accurate and precise marketing to target audiences from specific peer leaders. See, U.S. Pat. Nos. 11,216,428; 10,282,762; 9,607,023; US 2013/0317908; US 2018/0204111; Doshi, Ronak, Ajay Ramesh, and Shrisha Rao. “Modeling Influencer Marketing Campaigns in Social Networks.” IEEE Transactions on Computational Social Systems (2022).

The advertisements may be provided in a traditional manner, through an advertisement server and according to campaign parameters. The campaign may target specific users or user profiles, and charge different fees for different users, for repeat presentation, etc. The ad server may seek to maximize platform profit, though different measures of profit or benefit may be employed. The targeted user may receive a portion of the payment, and the user may itself establish a campaign profile to price or limit ads presented, and other parameters. See, www.investopedia.com/terms/b/basic-attention-token.asp

A particular aspect of an embodiment of the technology is that the platform is a social network, in which, for example, content is referred from one user to another, or relationships between users or content is exploited in operation of the system. If a user refers content to another user, the referrer may be compensated. Depending on the scheme, upstream referrers may also receive compensation in the style of a multi-level marketing system. The advertiser or sponsor may seek to generate a transaction with the targeted user, and therefore the referral fee may be dependent on the transaction itself. In an outcome-priced sponsorship scenario, all or a portion of the compensation is deferred unless and until a transaction is consummated, and often the rescission period expires. Because this is less preferred by at least the social network platform and content provider elements of the network, a hybrid compensation scheme is preferred.

In a higher stakes risk and reward scenario, the referrer accepts a reward at least partially dependent on a rating of the referred content, product or service by the recipient. In some cases, a negative reward, i.e., penalty, is applied to a referrer whose reference is undesirable or “bad”. In some cases, the referee may have an option to reduce the reward to the referrer to at least zero, and with limits and constraints, to impose a cost upon the referrer for an improper or undesired reference, or for a referral to a product or service that fails to fulfill expectations. This kind of risk will tend to improve quality of referrals, since the referrer has a cost of reference.

Another option is to provide functionality within the system to select (or automatically select) the best (most optimal) referrers for any target. In other words, not everyone seeks to “keep□ up with the Kardashians”. Not everyone prefers five-star restaurants or hotels, even for the same price. On the other hand, some people prefer exclusivity, can afford “the best”, and seek assistance in identifying opportunities to experience it, even if higher costs for essentially the same product or service are incurred. By determining consumer profiles and preferences, and aligning referrer style with the referee utility function, referrals may be made that achieve highest social gains.

Because a vendor transaction is often outside of the social network, unless the payments pass through a payment system provided by the social network, the transaction and compensation for the transaction may be off-chain or off-network, and not enforceable by an applicable smart contract. The risks inherent in hybrid on-chain and off-chain transactions may be mitigated by providing incentives for reporting of transactions. For example, a user that issues a transaction may receive token(s) for reporting the transaction and/or reviewing the vendor or the product or service. A discount may be provided for orders placed through the social network platform. Likewise, the transactions may be tied to a network-affiliated logistics supplier, which can assist in tracking orders and deliveries. Audits may also be used to ensure compliance. See, US 2022/0092624, and U.S. Ser. No. 11/282,336.

According to the social network paradigm, the referred content should be preferred by the targeted user, e.g., have a higher ranking in terms of user preferences than foregone content. Given the limited attention capacity of the targeted user, preferred referrals are rewarded, and non-preferred referrals not rewarded or even penalized. For example, a social media influencer may himself or herself stake the referral, either to individual targeted users, or to a community. If the targeted users “like” the referral, then the system rewards the referrer. On the other hand, if the referral is undesirable, then the referrer may be denied compensation or affirmatively penalized.

In similar fashion, if a referral is automatically generated, the process provider that offered the referral may be penalized for poor performance. Thus, as an additional element of compensation, a broker or middleman may be provided that matches referrers (or itself acts as a referrer) with a consumer. The broker or middleman receives compensation for the presentation dependent on feedback from the user. In extreme cases, the broker or middleman receives no compensation or is affirmatively penalized. Normally, however, the broker or middleman receives a competitive payment for its service.

The penalty may be monetary, or social. Thus, according to one aspect, an “influencer” may be downgraded by poor evaluations of referral quality.

According to the economic scheme, content based likes and dislikes may be distinct criteria from the compensation relating to the advertising. Because the advertising is distinct from the referred content, and the advertisers ends may be met even if the associated targeted content is disliked, the advertising exchange may reward advertisement views regardless of referred content. That is, the status as an influencer relates to their capacity to recommend, while the economics follow from number of referrals, click-throughs, transactions, etc.

In general, the behavior of each participant is incentivized by a reward (and/or penalty) structure. Therefore, behavior of the user/consumer should also be incentivized (and/or disincentivized) to conform with the desired behaviors or avoid undesired behaviors. For example, consumer reviews may be corrupted for various reasons independent of the quality of the product or service. Further, various reviews are applied to the wrong products or services, or vendors, and may apply to factors other that the subject of the review. Finally, reviews (which are a kind of recommendation or referral) may be falsified.

By linking the economic interests of the individual to the social data in the database, incentives for optimality may be provided. Thus, a user who is subject to the review or recommendation can rate the reviewer, which can have a direct economic impact by way of reward or punishment, or a less direct impact be promoting or demoting the reviewer in a ranking or evaluation, which may then be used to determine which referrers obtain opportunity. In some cases, economic optimality may be perturbed by a non-economic or bias factor. For example, the network operator may have a woke bias, MAGA bias, liberal bias, Christian bias, etc., and impose this boas on the network as a perturbation of the economic optimization that targets media to consumers. Therefore, this does not directly act as a filter or restriction, and rather a weighting that is permissive of opposing viewpoints while emphasizing conforming viewpoints.

Determination of media content may be performed using a large language model (LLM), such as a generative pre-trained transformer system, e.g., ChatGPT, to understand the content of a work, its tone, bias, viewpoint, and other factors. The artificial intelligence (AI) system can operate on semantic components of media, or in a multimodal fashion. The AI system can perform specific functions within the network, or operate as a core function handling a variety of integrated tasks. For example, the AI may select and rank the content to be presented to a user, adaptively match ads to the selected content, and determine compensation for the participants in the network. The LLM typically requires substantial resources, more that can be realistically provided at each node. Therefore, the AI and/or LLM resources are typically centralized or cloud resources. On the other hand, the AI/LLM resources may analyze the media in a batch process, and append metadata to each record, that is available for processing by distributed nodes. A hybrid approach is also possible, where a centralized system selects a group of available media (subset) from a much larger universe (set), and the distributed system ranks that list for presentation to the user. The subset may be periodically adaptively updated. The subset may be derived from public selection criteria only, while the ranking may include private criteria as well. In a similar way, the economic analysis may also be performed centrally, with each record of the set tagged with the economic allocation parameters, so that the economics may be applied to the ranked subset.

According to one aspect of the invention, a collaborative filter is implemented which clusters people with similar tastes, so to optimize the predictive nature of a rating for members of the cluster. Alternately, collaborative filter is asymmetric, with user who have predictive capacity for acceptability of recommendations identified to lead a cluster.

Preferably, the data flows within the social network are monitored for aberrations. Given the decentralized nature of the platform, it is important to provide continuous monitoring and reporting, and a circumvention system which permits a graceful shut down of the system in case of hacking or unexpected operation. Most importantly, the state of the block chain is preserved, and further transfers are escrowed or blocked. Further, because an early indication may be incorrect, the early warning system preferably is sensitive, a complete system shutdown is preferably avoided initially. The operative system preferably provides a privileged API, which provides an ability to download state and log information, and alter system operation, i.e., update the software, while executing in a limited mode.

Exercise of the API is preferably authenticated through a blockchain, which may be the same or distinct from the economic platform blockchain. For example, the command and control interface may employ a distinct non-public (privileged) blockchain, which reduces the attack surface of the system, and allows the primary blockchain to be inactivated as necessary without preventing all access.

Compensation of participants may be performed using tokens, i.e., cryptocurrency tokens. For example, an advertiser may define a campaign based on a budget represented as tokens which are paid with advertising placement. The player used by the targeted user triggers a transaction upon playing the advertisement to the user. Evidence of viewing of the advertisement may be obtained by biometric confirmation, e.g., facial recognition of the user at the time of playing the ad, or other confirmation.

In some cases, the content itself is subject to a digital rights management (DRM) protection scheme, and the owner of the content also receives compensation, which can be paid through the same player as the advertisement. While the compensation trigger for the content may be independent from the compensation trigger for the advertisement, if the advertisement precedes the content play, then the accounting may be consolidated. On the other hand, if the DRM payment is triggered before the advertising payment, then if the advertising payment fails, the user is liable for the DRM payment. This, in fact, may be a feature of the system, since the risk of user liability for non-compliance with system may help prevent various types of fraud. On the other hand, it allows the user to avoid advertising by simply paying for use of the system. The compensation for media content may be hybrid between different paradigms, such as a minimum set fee per use, plus and allocated portion of the variable compensation available through the system. The distribution of the compensation may be made to various rightsholders for the media, e.g., through a smartcontract or other set of rules.

By using a cryptocurrency token system, the payment architecture is decentralized, and the need for a high reliability centralized infrastructure minimized or eliminated. Therefore, system infrastructure cost may be reduced, and various aspects of the system may become competitive, such as advertising syndication, content syndication, player design, affinity groups, etc.

The payment to the referrer, targeted user, content owner, may exceed U.S. Internal Revenue Service reporting thresholds. Therefore, the user account may be fully authenticated and verified, and supply a W-9 form. The player/social networking application may act as a cryptocurrency wallet for other purposes, and the currency may have value outside the network. Further, the value outside the network may be, for example, a “points” program, such as airline miles, credit card points, etc.

The technology may employ aspects of traditional mechanisms for targeting advertisements, modified as discussed herein.

A computer implemented method for recommending products and services can be provided. The method can enable a user to use the user interface to tune search results from a recommendation system. Interest input from the user can be received by the recommendation system. Interest-related categories of products or services to recommend to the user are determined based on the user interest input. The search results of the interest-related category recommendations are displayed. Each interest-related category recommendation is displayed with an associated slider bar. The user can use the slider bar to adjust the relevancy score of a respective interest-related category recommendation. The system can respond to the slider bar adjustment by recalculating the relevancy score of that respective interest-related category recommendation. The interest-related category recommendations can then be updated and redisplayed. The initial position of the slider bar represents the degree of the relevancy score. The relevancy score represents a normalized relevancy weight.

The slider bar is used by the user to refine the recommendations made, where the recommendations are made based at least in part on data models, which are generated from coincident keywords that frequently appear in a corpus of user profiles. The user profiles can be from, for example, a social networking or online dating user site. The recommendation system, e.g., recommender (human or machine) are compensated by a formula that allocates a portion of a sale price to the recommenders. In this case, the recommender share is predetermined and held in an escrow, pending determination of an actual outcome of the recommendation for the particular user. If the user fully endorses the original positive recommendation, then the payment is made to the affirmative recommenders under an allocation program. If the user ultimately disagrees with the positive recommenders, then the payment is denied to the positive recommenders, and may be allocated to negative reviewers or reviewers who provided qualified reviews. That is, a collaborative-type filter is used to reward those recommenders who, in advance, agreed with the user after the fact. Using the collaborative filter prospectively, the user may be matched with highly correlated recommenders, who then can help define a ranked list of media, ads, messages, or the like, to be presented. In this case, the recommender may be prospectively compensated, without awaiting user confirmation, subject to demotion or reclassification of recommenders with a low accuracy and/or reliability in recommendation in general or for the particular user.

A computer implemented method of providing targeted profile matching in an online dating network can be provided. User profiles of matched (or complementary) couples or groups from an online dating network to extract keywords are processed and used to create data models. The matched couples or groups can be couples that are already dating. Keywords that commonly occur in the user online dating profiles of the matched couples are identified. The identified co-occurring keywords from the user profiles of the matched couples are ranked. The ranked identified co-occurring keywords of the matched couples are used to make mate recommendations for users seeking a romantic match by comparing the identified co-occurring keywords of the matched couples with co-identified keywords from profiles of the users seeking a romantic match.

Objects of the Invention

It is therefore an object to provide a user interface system, comprising: a content display output for presentation of content to a user; a communication network interface port; and at least one automated processor configured to: receive at least one hyperlink in a social network record of a social network; request content associated with the hyperlink; receive an advertisement associated with at least one of the user, the social network record, the hyperlink, and the content; verify presentation of the advertisement to the user; present the content to the user; and account for presentation of the advertisement to the user, by crediting at least one account distinct from an account associated with the user, an account associated with a content owner, and an account associated with a social network.

It is also an object to provide a user interface method, comprising: presenting content to a user through a content display output; communicating through a communication network interface port; receiving at least one hyperlink in a social network record of a social network; requesting content associated with the hyperlink; receiving an advertisement associated with at least one of the user, the social network record, the hyperlink, and the content; verifying presentation of the advertisement to the user; presenting the content to the user; and accounting for presentation of the advertisement to the user, by crediting at least one account distinct from an account associated with the user, an account associated with a content owner, and an account associated with a social network. The account may be credited contingent on display of the advertisement, or consummation of a transaction after display of the advertisement. The communication network interface port may be configured to communicate with an ad hoc communications network, and the at least one automated processor configured to is configured to control communication network interface port to receive content from a decentralized ad hoc communication network. The social network record may comprise a referrer of the content to the user, and an account of the referrer is credited. The referrer may provide a rating for the content. The referrer may identify the user. The account may be maintained on a distributed ledger or a blockchain. The content may have an associated cost, and the advertisement may provide a subsidy to compensate for the associated cost of the content. The content may have an associated variable cost, and the advertisement may provide a subsidy to compensate for the associated variable cost of the content. The advertisement may be targeted to a user dependent on a user profile. The advertisement may be recommended to a user dependent on a user profile. The content may be recommended to a user dependent on a user profile. The content may be recommended to a user dependent on a collaborative filter. A cryptocurrency token wallet may be provided. The token wallet may be configured to hold representations of non-fungible tokens. The at least one automated processor may be configured to process a distributed ledger transaction, a blockchain transaction, a smart contract transaction, a transaction in consideration of a fungible token, a transaction in consideration of a non-fungible token. The at least one automated processor may be configured to process a smart contract transaction which: verifies presentation of the advertisement to a user; and compensates a referrer to the user. The at least one automated processor may be configured to implement a distributed virtual machine. The at least one automated processor may be configured to transfer a basic attention token in consideration of viewing an advertisement. The at least one automated processor may be configured to limit presentation of the content to the user contingent on satisfaction of a digital rights management rule. The at least one automated processor may be configured to engage in transcrypted communications through an untrusted intermediary. The at least one automated processor may be configured to perform a fully or partially homomorphic cryptographic operation on a message. en.wikipedia.org/wiki/Homomorphic_encryption. The at least one automated processor may be configured to cluster data. The at least one automated processor may be configured to engage in a distributed clustering of data with other nodes in a distributed network. The at least one automated processor may be configured to verify presentation of the advertisement to the user using a biometric sensor, video camera, eye tracking sensor, photoplethysmography, and/or user activity patterns. The at least one automated processor may be configured to perform sentiment analysis on the content. The at least one automated processor may be configured to calculate a distance function. The at least one automated processor may be configured to credit accounts of a content owner, a social network platform, a referrer, and optionally a user to account for presentation of the advertisement to the user. The at least one automated processor may be configured to adaptively credit a plurality of accounts to account for presentation of the advertisement to the user. The at least one automated processor may be configured to perform tax accounting for the crediting.

It is also an object to provide a media player, comprising: a cryptocurrency wallet; a communication network interface; a media user interface; a user interface configured to receive a user rating or endorsement of media; and at least one processor configured to present selected media to a user, communicate the user rating through the communication network interface, and process distributed ledger transactions relating to the cryptocurrency wallet, wherein at least one transaction relates to a media cost and at least one transaction relates to a media subsidy. The at least one processor may be further configured to interact with a social network database, wherein the user rating or endorsement of media is communicated to the social network database through the communication network interface. The at least one processor may be further configured to communicate through the communication network interface using a virtual private network. The at least one processor may be further configured to perform a homomorphic cryptographic operation or a fully homomorphic cryptographic operation. The at least one processor may be further configured to implement a media content or advertisement content recommender. The communication network interface may comprise a peer-to-peer ad hoc communication network, and the social network database may comprise a distributed database. At least one transaction may result in processing cryptocurrency transactions in at least three different cryptocurrency wallets. The at least one transaction may have a cryptocurrency valuation dependent on the user rating or endorsement of the media. The at least one processor is further configured to: receive at least one hyperlink in a social network record of a social network; request media content associated with the hyperlink; receive advertisement content dependent on at least one of a user, the social network record, the hyperlink, and the media content; verify presentation of the advertisement content through the media user interface to the user; present the media content to the user; and account for presentation of the advertisement content to the user, by crediting the cryptocurrency wallet. The hyperlink may reference a media object stored in a peer-to-peer file storage system. The media content and the advertisement content may be stored in a distributed database. The cryptocurrency wallet may be cryptographically accessible by the user through a wallet user interface and is may also be cryptographically accessible by an administrator through an administrator user interface. The communication network interface may comprise a cellular network communication transceiver. The cryptocurrency wallet may be owned by a user and may be configured to support credit transactions and debit transactions without advance user authorization.

It is also an object to provide a social network method, comprising: receiving at least one social network record of a social network, comprising a proposal, referral, or recommendation of content, through a network communication interface; requesting and receiving the content through the network communication interface; receiving a communication through the network communication interface; presenting the content and the communication to the user through a content presentation interface; and accounting for at least one of a presentation of the communication and an action predicated on the communication, to the user, by crediting at least one account associated with the proposal, referral, or recommendation, distinct from an account associated with the user, an account associated a proprietor of the content, and an account of a proprietor of the social network.

It is a still further object to provide a social network system, comprising a content presentation interface; a network communication interface; and at least one automated processor, the at least one automated processor being configured to: receive through the network communication interface at least one social network record of a social network, comprising a proposal, referral, or recommendation of content; receive the content through the network communication interface; receive a communication through the network communication interface; present the content and the communication to the user through the content presentation interface; and account for at least one of a presentation of the communication and an action predicated on the communication, to the user, by crediting at least one account associated with the proposal, referral, or recommendation, distinct from an account associated with the user, an account associated a proprietor of the content, and an account of a proprietor of the social network.

The social network record may comprise a history of user interaction with the content, further comprising debiting the account associated with the user for user interaction with the content. The method may further comprise receiving a subjective assessment or comment, wherein the subjective assessment or comment is linked to the social network record, and crediting or debiting the account associated with the user for the receipt of the subjective assessment or comment. The method may further comprise crediting or debiting the account associated with the user for the subjective assessment or comment, based on interaction of other users with the subjective assessment or comment. The method may further comprise crediting the account associated with the proprietor of the social network for the for at least one of the presentation of the communication and the action predicated on the communication. The method may further comprise crediting at least one of the account associated with the user, the account associated a proprietor of the content, and the account of a proprietor of the social network user for a presentation of the communication to the user. The method may further comprise verifying a presentation of the communication to the user. The method may further comprise capturing images of the user with a camera during the presentation of the communication; and verifying presentation of the communication to the user based on the captured images. The method may further comprise accounting for a transaction in a distributed ledger system. The method may further comprise receiving content through the network communication interface from a peer-to-peer distributed database. The method may further comprise receiving the at least one social network record from a decentralized social network database. The communication may comprise a commercial advertisement video, and the at least one social network record of the social network, comprising the proposal, referral, or recommendation of content may comprise a reference to a social media influencer who references the content, the method further comprising: receiving a payment from an account associated with a commercial sponsor of the commercial advertisement video; distributing proceeds of the payment to an account of social media influencer being the at least one account associated with the proposal, referral, or recommendation; and further distributing proceeds of the payment to an account associated with the user, an account associated a proprietor of the content, and an account of a proprietor of the social network. The method may further comprise initiating a transaction to authorize presentation of the content to the user through the content presentation interface, wherein the transaction comprises execution of a smart contract on a distributed virtual machine. The method may further comprise providing an automated recommender; generating the proposal, referral, or recommendation of content with the automated recommender; and selecting or ranking the content for presentation to the user. The method may further comprise storing a user profile; and targeting the communication to the user based on the user profile, wherein the user profile is unavailable to the social network. The method may further comprise communicating with a generative pre-trained transformer comprising a large language model, which processes social network records and generates the proposal, referral, or recommendation of the content. The social network record may comprise at least one hyperlink to the content; and the communication may comprise an advertisement selected based on at least the user, the social network record, and the content. The account may be credited contingent on at least one of a presentation to the user of the advertisement, and consummation of a commercial transaction after display of the advertisement. The method may further comprise communicating with a distributed ledger comprising a blockchain through the network communication interface; and the crediting the at least one account comprises performing a transaction to credit a cryptocurrency token to a cryptocurrency wallet.

A further object provides a decentralized social network method, for operating a device comprising a content presentation interface; a network communication interface; and at least one automated processor, the method comprising: receiving at least one social network record of a social network, comprising a proposal, referral, or recommendation of content, and a resource locator for the content, through the network communication interface; issuing a request for the content by communicating the resource locator through the network communication interface; receiving a sponsor message through the network communication interface associated with a smart contract, the smart contract defining a transaction comprising a cryptocurrency payment for at least one of a presentation to a user of the sponsor message and an action by the user predicated on the sponsor message; and accounting for the at least one of a presentation to the user of the sponsor message and the action predicated on the sponsor message, by executing the smart contract to conduct the transaction on a distributed ledger, crediting at least one cryptocurrency account associated with the proposal, referral, or recommendation, distinct from an account associated with the user, an account associated a proprietor of the content, and an account of a proprietor of the social network.

It is a further object to provide a decentralized social network system, comprising a content presentation interface; a network communication interface; and at least one automated processor, the at least one automated processor being configured to: receive at least one social network record of a social network, comprising a proposal, referral, or recommendation of content, and a resource locator for the content, through the network communication interface; issuing a request for the content by communicating the resource locator through the network communication interface; receive a sponsor message through the network communication interface associated with a smart contract, the smart contract defining a transaction comprising a cryptocurrency payment for at least one of a presentation to a user of the sponsor message and an action by the user predicated on the sponsor message; and account for the at least one of a presentation to the user of the sponsor message and the action predicated on the sponsor message, by executing the smart contract to conduct the transaction on a distributed ledger, crediting at least one cryptocurrency account associated with the proposal, referral, or recommendation, distinct from an account associated with the user, an account associated a proprietor of the content, and an account of a proprietor of the social network.

The social network record may comprise a history of user interaction with the content, and the at least one automated processor is further configured to debit the account associated with the user for user interaction with the content. A user input device may be provided, configured to receive a subjective assessment or comment, wherein the subjective assessment or comment is linked to the social network record, and the at least one automated processor is further configured to credit or debit the account associated with the user for the receipt of the subjective assessment or comment. The at least one automated processor may be further configured to credit or debit the account associated with the user for the subjective assessment or comment, based on interaction of other users with the subjective assessment or comment. The at least one automated processor may be further configured to credit the account associated with the proprietor of the social network for the for at least one of the presentation of the communication and the action predicated on the communication. The at least one automated processor may be further configured to credit at least one of the account associated with the user, the account associated a proprietor of the content, and the account of a proprietor of the social network user for a presentation of the communication to the user. The at least one automated processor may be further configured to verify presentation of the communication to the user. The system may further comprise a camera configured to capture images of the user during the presentation of the communication, wherein the at least one automated processor may be further configured to verify presentation of the communication to the user based on the captured images. The at least one automated processor may be configured to account for a transaction in a distributed ledger system. The content may be received through the network communication interface from a peer-to-peer distributed database. The at least one social network record may be is received from a decentralized social network database. The communication may comprise a commercial advertisement video, the proposal, referral, or recommendation of content may comprise a reference to a social media influencer who references the content, and the at least one automated processor may be further configured to receive a payment from an account associated with a commercial sponsor of the commercial advertisement video, distribute proceeds of the payment to an account of social media influencer being the at least one account associated with the proposal, referral, or recommendation, and further distribute proceeds of the payment to an account associated with the user, an account associated a proprietor of the content, and an account of a proprietor of the social network. The at least one automated processor may be further configured to initiate a transaction to authorize presentation of the content to the user through the content presentation interface, wherein the transaction may comprise execution of a smart contract on a distributed virtual machine. An automated recommender configured to generate the proposal, referral, or recommendation of content, and to select or rank content for presentation to the user may be provided. A memory may be provided, configured to store a user profile, wherein the at least one automated processor is further configured to target the communication to the user based on the user profile, wherein the user profile is unavailable to the social network. The at least one automated processor may be further configured to communicate with a generative pre-trained transformer comprising a large language model, configured to process social network records and generate the proposal, referral, or recommendation of the content. The social network record may comprise at least one hyperlink to the content, and the communication may comprise an advertisement selected based on at least the user, the social network record, and the content. The account may be credited contingent on at least one of a presentation to the user of the advertisement, and consummation of a commercial transaction after display of the advertisement. The network communication interface may be configured to communicate with a distributed ledger comprising a blockchain, and the at least one account may comprise a transaction to credit a cryptocurrency token to a cryptocurrency wallet.

A further object provides a social network, comprising: a distributed database comprising user records and content records; a distributed ledger, configured to authenticate ownership and authority to transfer a cryptotoken with respect to at least lack of prior encumbrance, and maintain an immutable record of a cryptotoken transaction; and a user interface device, configured to receive content records from the distributed database, dependent on user records from the distributed database, and update a respective user record. The social network may further comprise a distributed virtual machine configured to process a smart contract which controls the cryptotoken transaction to allocate the cryptotoken between at least two cryptotoken wallets, in dependence on parameters of the smart contract, wherein the user interface supplies at least parameter of the smart contract.

A still further object provides a social network, comprising: a social network database comprising user records, content records, and advertising records; a user interface configured to present content records and advertising records to a user; and a payment system configured to receive a payment from an advertiser and distribute a first portion to a content provider and a second portion to a recommender of the content.

Another object provides a social network system, comprising: a distributed database of social media records, the social media records comprising content references, relationships between people, relationships between persons and content, and at least one of subjective assessments and comments; a distributed virtual machine configured to execute smart contracts in conjunction with a blockchain; and a distributed ledger associated with the blockchain, storing smart contracts, wherein at least one smart contract is configured to execute on the distributed virtual machine to distribute a portion of a sponsor payment of a cryptocurrency token to a cryptocurrency wallet defined by the social media record.

1. Social Networks

Social networks are well-known. A social network is a social structure made up of a set of social actors (such as individuals or organizations), sets of dyadic ties, and other social interactions between actors. The social network perspective provides a set of methods for analyzing the structure of whole social entities as well as a variety of theories explaining the patterns observed in these structures. The study of these structures uses social network analysis to identify local and global patterns, locate influential entities, and examine network dynamics.

The social network is a theoretical construct useful in the social sciences to study relationships between individuals, groups, organizations, or even entire societies (social units, see differentiation). The term is used to describe a social structure determined by such interactions. The ties through which any given social unit connects represent the convergence of the various social contacts of that unit. This theoretical approach is, necessarily, relational. An axiom of the social network approach to understanding social interaction is that social phenomena should be primarily conceived and investigated through the properties of relations between and within units, instead of the properties of these units themselves. Thus, one common criticism of social network theory is that individual agency is often ignored, although this may not be the case in practice (see agent-based modeling). Precisely because many different types of relations, singular or in combination, form these network configurations, network analytics are useful to a broad range of research enterprises. In social science, these fields of study include, but are not limited to anthropology, biology, communication studies, economics, geography, information science, organizational studies, social psychology, sociology, and sociolinguistics.

Social network activities may be analyzed economically, to determine their utility, and incentives to increase utility. Note that each participant in the network has a distinct utility function, and for example an advertiser has a distinct interest from an advertising target.

In general, social networks are self-organizing, emergent, and complex, such that a globally coherent pattern appears from the local interaction of the elements that make up the system. These patterns become more apparent as network size increases. While an algorithm may bias the links within a network, ultimately the network is dependent on human selection or appreciation of links, people, content, products, services, etc., and extraction and exploitation of the information derived from the human inputs.

The present technology encompasses a social network, in which media and/or multimedia are distributed to users according to a social network paradigm. A consuming user receive a feed, which is a series of media or media links that are a subset of a vast repository. The media are recommended for a user according to an algorithm, which has as a significant factor the satisfaction of a desire or need of the consuming user. The media may be accompanied by sponsored content, including advertisements. The media may be automatically recommended, or provided by an influencer or other user. An influencer is one who leads others in style, fashion, philosophy, prowess, or the like. The influencer participates in the social network for compensation, though the basis for compensation is not uniform across platforms. Media may be user-generated, or from professional sources. The social network database provides information on user characteristics, influencer characteristics, media characteristics, ad characteristics, accounting, etc.

Complex networks require methods specific to modelling and interpreting social complexity and complex adaptive systems, including techniques of dynamic network analysis. Mechanisms such as Dual-phase evolution explain how temporal changes in connectivity contribute to the formation of structure in social networks.

Computer networks combined with social networking software produce a new medium for social interaction. A relationship over a computerized social networking service can be characterized by context, direction, and strength. The content of a relation refers to the resource that is exchanged. In a computer mediated communication context, social pairs exchange different kinds of information, including sending a data file or a computer program as well as providing emotional support or arranging a meeting. With the rise of electronic commerce, information exchanged may also correspond to exchanges of money, goods or services in the “real” world. Social network analysis methods have become essential to examining these types of computer mediated communication.

Individuals influence each other through social interactions and marketers aim to leverage this interpersonal influence to attract new customers. It still remains a challenge to identify those customers in a social network that have the most influence on their social connections. A common approach to the influence maximization problem is to simulate influence cascades through the network based on the existence of links in the network using diffusion models. Referral Rank builds on the game theoretic concept of the Shapley value for assigning each individual in the network a value that reflects the likelihood of referring new customers. Looking at the influence of the two-hop neighbors of the customers improves the influence spread and product adoption.

People are highly influenced by information received from others and word-of-mouth (WOM) is the most influential source of information to a customer. Empirical research shows that consumers rely heavily on the advice of others in their personal network when making purchase decisions and that positive WOM has a positive effect on business outcomes, i.e., sales. Referral marketing has become an important marketing technique to stimulate WOM in a controlled way for acquiring new customers.

Suppose we have data on the social network of customers, in which the interactions give an indication of how influence flows between the individuals. If we want to attract as many new customers as possible by relying on the power of social influence, we want to initially target only a few individuals whom we expect to trigger a cascade of influence in which friends recommend the product to other friends. The key question is how to select those initial influencers who will seed this process. In order to do that, managers need to have an intelligent system that supports them in finding the optimal group of influential customers. Selecting a group of individuals who are most likely to generate the largest cascade of influence through WOM is also known as the influence maximization problem. Multiple approaches to solve the influence maximization problem have been developed.

Customer referral programs encourage existing customers to recommend a firm's services or products to their social network. They aim to provoke marketer-directed cascades of word-of-mouth (WOM). In that way, referral programs leverage on the powerful impact of WOM and the influence of social connections.

Because online circumstances allows communication remotely and out of synchronization, along with a better communication capacity, online referral reward programs in social networks may have different characteristics compared with traditional referral reward programs.

For decades, the advertising industry was based on an asymmetrical communication model, where marketers would engage audiences via paid media channels. The advent of social media platforms completely transformed the general media landscape, along with the advertising model, as audiences shifted from the role of content receivers to content creators, distributors, and commentators (Keller, 2009; Scott, 2015). Simply put, the empowerment of audiences from mere viewers to active content distributors effectively flipped the advertising model on its head. Where paid media (in this case, advertising) was once supported by earned and owned media, the modern advertising model uses owned, shared, and earned media as the key media planning strategy, supported by paid media (Pearson, 2016). Recognizing the increased potential for free content distribution, marketers realized that creating highly engaging advertising content could expand potential reach, a cheaper and more credible tactic than traditional paid advertising (Cho, Huh, & Faber, 2014; Golan & Zaidner, 2008). This fundamental disruption of the advertising and marketing world led to growing interest in content creation, co-creation, and distribution.

Advertising may be referred to as the “paid nonpersonal communication from an identified sponsor using mass media to persuade or influence an audience” (Wells, Moriarty, & Burnett, 2000, p. 6). Consistent with most, but not all, of these requirements, Porter and Golan (2006) defined viral advertising as “unpaid peer-to-peer communication of provocative content originating from an identified sponsor using the Internet to persuade or influence an audience to pass along the content to others” (p. 33). These definitions are useful, but not limiting on the disclosure as a whole.

The expanding literature on viral advertising recognizes the ways in which peer-to-peer distribution of advertising content are redefining the industry. When examined holistically, the literature has several limitations. First, existing viral advertising research is limited primarily to advertising spread within one step of the original source (e.g., predicting the number of message shares), while information on social media often spreads beyond a single step from the original source. Second, in focusing on the characteristics of shared content or sharing users, researchers make the assumption that all shares are equal in terms of their impact. However, sharing-impact varies among users, based on their connectivity. Third, the metaphor of virality, the idea that content is spread gradually among individuals and their immediate contacts, may not fully capture what is often a complex multi-actor process of content distribution. Cascades of content distribution were found to be centered on a small number of distributors, creating a hierarchical, rather than egalitarian, pattern of content distribution (Baños, BorgeHolthoefer, & Moreno, 2013).

An emergent body of scholarship in the field of marketing, advertising, and public relations examines the intermediary function of influencers between brands and consumers, organizations, and stakeholders in social media engagement (De Veirman, Cauberghe, & Hudders, 2017; Freberg, Graham, McGaughey, & Freberg, 2011; Fhua, Jin, & Kim, 2016). At the most basic level, influencer is identified by their number of followers and their ability to impact social media conversation regarding brands or topics (Watts & Dodds, 2007). While the term social media influencer is ubiquitously applied, there are few formal definitions of what an influencer actually is. Brown and Hayes (2008) defined influencers broadly as individuals who hold influence over potential buyers of a brand or product to aid in the marketing activities of the brand. Others narrow the definition of an influencer to reflect on the latest marketing trend in which social media celebrities are paid by advertisers to promote products (Abidin, 2016; Evans et al., 2017; Senft, 2008).

To explain the influence of influencers, media scholars often depend on the parasocial relationship explanation (Daniel, Crawford, & Westerman, 2018; Lou & Yuan, 2018; Rasmussen, 2018). Moving beyond a temporary parasocial interaction (as originally conceptualized by Horton & Wohl, 1956), parasocial relationships between audience members and mediated characters are formed over a period of time and provide audience members with a sense of engagement with onscreen characters (Klimmt, Hartmann, & Schramm, 2006; Tukachinsky, 2010). In the context of social media, such parasocial relationships provide influencers with unique social capital that leads to audience trust (Tsai & Men, 2017; Tsiotsou, 2015).

The central role of trust in parasocial relationships may provide a plausible explanation for the influencer phenomenon and the rise of influencer marketing (Audrezet, De Kerviler, & Moulard, 2018). Trust has been identified as a key predictor of several advertising consequences including recall, attitude, and likelihood to share (Cho et al., 2014; Lou & Yuan, 2018; Okazaki, Katsukura, & Nishiyama, 2007). Abidin (2016), building on the concept of parasocial relations, identified four ways that influencers appropriated and mobilized intimacies: commercial, interactive, reciprocal, and disclosive. Influencers are identified not only based on their sheer number of such parasocial relationships, such as subscribers or followers on social media, but primarily based on their ability to impact social media conversation and subsequent behavior regarding brands or topics (Watts & Dodds, 2007).

In some cases, influencers are valued because of the objective correctness of their communications and the objective value of their recommendations. In other cases, followers seek to emulate an influencer, regardless of the merit of the communication or recommendation. The later is not “wrong” and rather reflects the malleability of perceptions and value judgements, and a human need to belong to a community that is reflected by arbitrary customs.

As explained by Golan and Zaidner (2008), there are several key differences between viral and traditional advertising. First, viral advertising earns audience eyeballs, as opposed to paying for them. This is a major departure from the traditional advertising exchange, where brands purchase media space and interrupt an audience's media consumption with advertisements. Second, viral advertisements provide such increased value to audiences that they transform audiences from passive content receivers to active social distributors who play a key role in advertisement distribution. Third, although there are limited studies speaking to this point, it is worth noting that information sharing has been shown to increase a user's followers on Twitter, which is a long-term benefit for marketers (Hemsley, 2016).

Hayes, King, and Ramirez (2016) advanced research on viral advertising by illustrating the importance of interpersonal relationship strength in referral acceptance. Their study suggested that individuals are motivated to share advertising content based on reputational enhancement and reciprocal altruism. Alhabash and McAlister (2015) conceptualized virality based on three key components: viral reach, affective evaluation, and message deliberation. The authors linked virality and online audience behaviors in what they refer to as viral behavioral intentions (VBI). This linkage is supported by later research indicating that the virality of digital advertising is often related to several VBIs motivated by a variety of audience-based characteristics (Alhabash, Baek, Cunningham, & Hagerstrom, 2015; Alhabash et al., 2013).

In essence, viral advertising represents a “peer-to-peer communication” strategy that depends on distribution of content (Petrescu & Korgaonkar, 2011; Porter & Golan, 2006). Despite the fact that most peer-to-peer social media shares include multiple distribution phases (e.g., from user A to user B to user C), existing viral advertising research is mostly limited to one-step advertisement spread (e.g., predicting number of message shares). Studies suggest that while content may be shared by many users, most viral content is spread beyond this single step (Bakshy, Hofman, Mason, & Watts, 2011). The body of literature concerning viral advertising does not examine advertising spread beyond a user's immediate set of connections.

The literature conceptualizes virality based on such sharing metrics as shares or retweets. In doing so, scholars fail to account for the possibility that the overall impact of such user actions may not result in equal content distribution outcomes. In fact, studies on virality of content and cascades of information flow highlight that “popularity is largely driven by the size of the largest broadcast” (Goel, Anderson, Hofman, & Watts, 2015, p. 180). In other words, it is not only the number of consumer-to-consumer interactions but the connectivity of these consumers with others that determines the impact of viral advertising. One user's retweet may count more than another user.

The idea that content is spread gradually from one source to that source's immediate small group of connections, to their neighbors, and so on is a powerful metaphor that resonates well with many scholars (Miles, 2014; Porter & Golan, 2006). However, research shows no foundation for such an egalitarian assumption. Connections are distributed in a skewed manner across individuals, a phenomenon referred to in ways that vary by discipline. Scholars offer different approaches to determine why do some advertisements receive wide-scale viewership via audience distribution, while others do not, one focusing on content characteristics (Brown, Bhadury, & Pope, 2010; Golan & Zaidner, 2008; Petrescu, 2014) and another examining virality attribute factors such as brand relationships (Hayes & King, 2014; Ketelaar et al., 2016; Shan & King, 2015).

Porter and Golan (2006) specifically identify provocative content as contributing to advertising virality. Other studies identify appeals to sexuality, as well as shock, violence, and other inflammatory content as key elements of message virality (Brown et al., 2010; Golan & Zaidner, 2008; Petrescu, 2014). Eckler and Bolls (2011) argue that the emotional tone of advertisement is directly related to audience intention to forward ads to others. Yet advertising content, tone, and emotion cannot fully account for ad virality. Scholars point to a variety of other variables significantly related to advertising virality including brand relationship (Hayes & King, 2014; Ketelaar et al., 2016; Shan & King, 2015), attitude toward the ad (Hsieh, Hsieh, & Tang, 2012; Huang, Su, Zhou, & Liu, 2013), and credibility of the sender/referrer (Cho et al., 2014; Phelps, Lewis, Mobilio, Perry, & Raman, 2004).

Hayes, King, and Ramirez (2016) advanced research on viral advertising by illustrating the importance of interpersonal relationship strength in referral acceptance. Their study suggested that individuals are motivated to share advertising content based on reputational enhancement and reciprocal altruism. Alhabash and McAlister (2015) conceptualized virality based on three key components: viral reach, affective evaluation, and message deliberation. The authors linked virality and online audience behaviors in what they refer to as viral behavioral intentions (VBI). This linkage is supported by later research indicating that the virality of digital advertising is often related to several VBIs motivated by a variety of audience-based characteristics (Alhabash, Baek, Cunningham, & Hagerstrom, 2015; Alhabash et al., 2013).

Viral advertising represents a “peer-to-peer communication” strategy that depends on distribution of content (Petrescu & Korgaonkar, 2011; Porter & Golan, 2006). Despite the fact that most peer-to-peer social media shares ultimately determined by their position in an issue or brand-specific conversation network, allowing their posted content to be distributed in a strategic manner. As such, these influencers play key roles in the virality of any advertising campaign on social media. A social networks approach, as illustrated by Himelboim, Golan, Moon, and Suto (2014) provides for a macro-understanding of social media relationships, content flow, and the role of social media influencers within the network.

The present technology is compatible with various types of advertising, and especially viral advertising, which can be readily exploited in a social network.

A single network can have different types of links, or ties, that connect its users. On Twitter, users can be connected, among others, by relationships of retweets and mentions. A network of advertising virality captures users who posted content with a hyperlink to a given ad. Such Twitter users share a link to a given advertisement via a tweet, expanding its reach one step away from the source (YouTube). Some studies have examined the overall network structure to explain virality. Pei et al. (2014) used social network analysis on LiveJournal, Twitter, Facebook, and APS journals and found that users who spread the most content were located in the K-Core (a metrics of subgroup cohesiveness in the network). At the node-level, a few users are expected to contribute further to the virality by having their tweets shared, or retweeted, by many additional users. Such users capture virality beyond a single step away from the source. Users with many connections in the network are known as social hubs (Goldenberg, Libai, & Muller, 2001) or simply Hubs. Using computer simulations, Hinz, Skiera, Barrot, and Becker (2011) found that seeding messages to hubs outperformed a random seeding strategy and seeding to low-degree users, in terms of number of referrals. Kaplan and Haenlein (2011) also illustrated the role that hubs play in integrative social media and viral marketing campaigns.

Influencers may be categorized into three different types, based on the type of relationships, links in the network, that makes them central in a network.

Given the opportunity to interact freely, connections among users will be distributed unequally, as a few will enjoy large and disproportionate number of relationships initiated with them, while most will have very few ties. On Twitter, content posted by a few users will enjoy major distribution via retweeting, while the rest will gain little shares, if any. Indeed, A^{r}aujo, Neijens, and Vliegenthart (2017), define influentials as “users with above average ability to stimulate retweets to their own messages” (p. 503), consistent with conceptualization of influencers based on impact on content distribution (Cha, Haddadi, Benevenuto, & Gummadi, 2010; Kwak, Lee, Park, & Moon, 2010). Hubs as conceptualized in social networks literature, therefore, are one type of social media influencers as conceptualized in social media scholarship, as each one makes a major contribution to content distribution. One type of influencer, from a social networks conceptualization, is therefore the Primary Influencer.

The social networks conceptual framework shifts the focus from individual traits to patterns of social relationships (Wasserman & Faust, 1994). Applying a social networks approach to social media activity allows researchers to capture content virality and identify key social media influencers that affect the conversation about a brand and reach key groups of consumers. A social network is formed when connections (“links”) are created among social actors (“nodes”), such as individuals and organizations. The collections of these connections aggregate into emergent patterns or network structures. On Twitter, social networks are composed of users and the connections they form with other users when they retweet, mention, and reply to (Hansen, Shneiderman, & Smith, 2011).

The network approach can bridge the viral advertising and social media influencer's bodies of literature. As discussed earlier, social media platforms allow individuals to maintain parasocial relationships with influencers (Abidin, 2016). In the case of Twitter, such engagement is manifested in the form of mentions, likes, and retweets. In social networks research, these relationships are conceptualized as links in a network.

The social networks approach allows us to capture the distribution of a specific piece of content (i.e., an advertisement) and identify users in key positions in the network that are responsible for the distribution of ads, as social media influencers. It should be noted that even in studies on information diffusion in related disciplines, it is quite rare to track the virality of a single piece of content, rather than the overall diffusion of messages in a broader conversation.

Viral advertising research often focuses on the most visible type of content that is spread, shared, or retweeted on Twitter. Social media influencers are often examined by their number of connections in a social media platform (De Veirman et al., 2017). However, a link to a video advertisement, or any other source of paid advertising content, may be posted by more than a single user who contributes to its diffusion. In other words, while the advertisement itself may have a single point of origin (e.g., a YouTube video page), this advertisement may have multiple users who may account for multiple points of origin for distribution on Twitter.

Burt's (1992, 2001) theory of structural holes examines social actors (e.g., individuals and organizations) in unique positions in a social network, where they connect other actors that otherwise would be less connected, if connected at all. In Burt's (2005) words, “A bridge is a (strong or weak) relationship for which there is no effective indirect connection through third parties. In other words, a bridge is a relationship that spans a structural hole” (p. 24). A lack of relationships among social actors, or groups of actors, in a network gives those positioned in structural holes strategic benefits, such as control, access to novel information, and resource brokerage (Burt, 1992, 2001). Actors that fill structural holes are viewed as attractive relationship partners precisely because of their structural position and related advantages (Burt, 1992, 2001).

US20130317908A1 relates to a search technology which generates recommendations with minimal user data and participation, and provides interpretation of user data, such as popularity, thus obtaining breadth and quality in recommendations. It is sensitive to the semantic content of natural language terms taken from user profiles at social networking and online dating applications and blogs. The profiles and blogs can include interests, eccentricities, age, gender, and location information associated with the user. The interest information can include music, movies, sports and personality traits. Based on the user's profile information, the system determines which ad from a stock of ads is best suited to a given profile and delivers that ad. The system can enable advertisers to create and manage online advertising campaigns using a campaign manager in which they attach descriptions to ads in their inventory, thereby generating a profile for each ad which is then compared to the profiles in the target online environment. A user interface can be provided to enable the user to fine-tune product and service recommendation results. The system can be used to match user profiles to provide mate-matching in an online dating environment.

The ability to consistently match a product or service to a consumer's request for a recommendation is a very valuable tool, as it can result in a high volume of sales for a particular product or company. Unfortunately, effectively accommodating these demands using existing search and recommendation technologies requires substantial time and resources, which are not easily captured into a search engine or recommendation system. The difficulties of this process are compounded by the unique challenges that online stores and advertisers face to make products and services known to consumers in this dynamic online environment.

An aspect of the technology seeks to enhance social networks by application of various economic principles and application of existing and novel technology to improve the functioning and economic outcomes of operating social networks and other types of systems using the technologies encompassed herein.

See Social Networks references.

2. Targeted Advertising

On aspect of fulfilling both the advertisers' interest and the user's interest is intelligent or optimal targeting of advertisements. This may be synopsized as getting the right advertisement, to the right user, for the right price.

Recommendation technology exists that attempts to predict items, such as movies, music and books that a user may be interested in, usually based on some information about the user's profile. Often, this is implemented as a collaborative filtering algorithm. Collaborative filtering algorithms typically analyze the user's past behavior in conjunction with the other users of the system. Ratings for products are collected from all users forming a collaborative set of related “interests” (e.g., “users that liked this item, have also like this other one”). In addition, a user's personal set of ratings allows for statistical comparison to a collaborative set and the formation of suggestions. Collaborative filtering is the recommendation system technology that is most common in current e-commerce systems. It is used in several vendor applications and online stores, such as Amazon.com.

Unfortunately, recommendation systems that use collaborative filtering are dependent on quality ratings, which are difficult to obtain because only a small set of users of the e-commerce system take the time to accurately rate products. Further, click-stream and buying behavior as ratings are often not connected to interests because the user navigation pattern through the e-commerce portal will not always be a precise indication of the user buying preferences. Additionally, a critical mass is difficult to achieve because collaborative rating relies on a large number of users for meaningful results, and achieving a critical mass limits the usefulness and applicability of these systems to a few vendors. Moreover, new users and new items require time to build history, and the statistical comparison of items relies on user ratings of previous selections. Furthermore, there is limited exposure of the “long tail,” such that the limitation on the growth of human-generated ratings limits the number of products that can be offered and have their popularity measured.

The long tail is a common representation of measurements of past consumer behavior. The theory of the long tail is that economy is increasingly shifting away from a focus on a relatively small number of “hits” (e.g., mainstream products and markets) at the head of the demand curve and toward a huge number of niches in the tail.

To compound problems, most traditional e-commerce systems make overspecialized recommendations. For instance, if the system has determined the user's preference for books, the system will not be capable of determining the user's preference for songs without obtaining additional data and having a profile extended, thereby constraining the recommendation capability of the system to just a few types of products and services.

There are rule-based recommendation systems that rely on user input and a set of pre-determined rules which are processed to generate output recommendations to users. A web portal, for example, gathers input to the recommendation system that focuses on user profile information (e.g., basic demographics and expressed category interests). The user input feeds into an inference engine that will use the pre-determined rules to generate recommendations that are output to the user. This is one simple form of recommendation systems, and it is typically found in direct marketing practices and vendor applications.

However, it is limited in that it requires a significant amount of work to manage rules and offers (e.g., the administrative overhead to maintain and expand the set of rules can be considerably large for e-commerce systems). Further, there is a limited number of pre-determined rules (e.g., the system is only as effective as its set of rules). Moreover, it is not scalable to large and dynamic e-commerce systems. Finally, there is limited exposure of the long tail (e.g., the limitation on the growth of a human-generated set of inference rules limits the number of products that can be offered and have their popularity measured).

Content-based recommendation systems exist that analyze content of past user selections to make new suggestions that are similar to the ones previously selected (e.g., “if you liked that article, you will also like this one”). This technology is based on the analysis of keywords present in the text to create a profile for each of the documents. Once the user rates one particular document, the system will understand that the user is interested in articles that have a similar profile. The recommendation is created by statistically relating the user interests to the other articles present in a set. Content-based systems have limited applicability, as they rely on a history being built from the user's previous accesses and interests. They are typically used in enterprise discovery systems and in news article suggestions.

In general, content-based recommendation systems are limited because they suffer from low degrees of effectiveness when applied beyond text documents because the analysis performed relies on a set of keywords extracted from textual content. Further, the system yields overspecialized recommendations as it builds an overspecialized profile based on history. If, for example, a user has a user profile for technology articles, the system will be unable to make recommendations that are disconnected from this area (e.g., poetry). Further, new users require time to build history because the statistical comparison of documents relies on user ratings of previous selections.

A complicated aspect of developing an information gathering and retrieval model is finding a scheme in which the cost-benefit analysis accommodates all participants, i.e., the users, the online stores, and the developers (e.g., search engine providers).

The present technology seeks to “optimize” utility of the experience of use of the network, and part of that optimization is selection of ads and other sponsored content for users based on both the objective value of the ad placement, e.g., in terms of driving sales, transactions, or sentiment according to the sponsor's goals, and subjective value to the recipient according to that recipients need or desire for information or content. Thus, in contrast to many targeted ad systems, the present technology may be quite sensitive to the offense taken by the targeted recipient to inappropriate, repetitive, useless, or offensive advertising. In some cases, the ad placement is in dependent of associated content presented by the network, while in others the ads are selected to be appropriate or integral with a common experience. In the later case, a single algorithm selects content, ads, and other user interface elements, and may perform an economic optimization on the whole, often using the ads to compensate content providers for the associated content in the transaction. On the other hand, since each participant in the network has an account that may be credited or debited over time, there is not a strict need for direct sponsorship of particular content, and rather these may be decoupled, even if part of a common experience. The algorithm may, however, seek to ensure that the available sponsorship covers all costs for a user over a period of time, and provides benefits according to the social network paradigm. A low valued user, i.e., one who is anticipated to produce low returns for advertisers may therefore see a greater number of ads, or be provided with lesser valued content. On the other hand, a higher valued user, may see a fewer number of highly targeted, high value ads, and have access to premium content. For example, a user who is anticipated to purchase a car or jewelry may receive significant subsidies from competing providers of those products, to the exclusion of other advertising of lesser anticipated value. Similarly, after a transaction, the seller may continue to subsidize use of the network by a valued user, with only after-the-transaction appropriate communications. In the market for attention, one ad sponsor may even bid to displace the competitor's ad, even if the sponsor's ad is not itself displayed

Ad profiles can be created to facilitate the ad selection process. One or more keywords from a candidate ad can be extracted. The frequency with which the one or more extracted keywords from the ad appear in conjunction with a coincident keyword from a plurality of user profiles can be computed. The extracted ad keywords from the ad can be expanded with additional interest related terms using one or more of the coincident keywords identified from the plurality of user profiles. The expanded ad related interest terms can be used to build an ad profile (data model). The expanded ad related interest terms in the ad profile can be compared with the expanded interest terms of the subject user profile to determine which ad to select from the ad inventory. When comparing the expanded ad related interest terms in the ad profile with the expanded interest terms of the subject user profile, no exact match of respective interest related terms is required.

When identifying the co-occurring keywords from the user profiles, the frequency with which a keyword appears in conjunction with another keyword is computed in the overall defined population. The degree to which the two keywords tend to occur together can be computed. A ratio indicating the frequency with which the two keywords occur together is determined. A correlation index indicating the likelihood that users interested in one of the keywords will also be interested in the other keyword, is determined. The computed degree, the determined ratio and the correlation index can be processed to determine a percentage of co-occurrence for each keyword. The percentage of co-occurrence for each keyword is used to determine a correlation ratio, which indicates how often a co-occurring keyword is present when another co-occurring keyword is present, as compared to how often it occurs on its own. This information is used in processing keywords in queries to identify matching keywords. The matching keywords can be used to search products, services or Internet sites to generate recommendations.

Term frequency-inverse-document frequency (tf-idf) weighing measures can be used to determine how important an identified keyword is to a subject user profile in a collection or corpus of profiles. The importance of the identified keyword can increase proportionally to the number of times it appears in the document, offset by the frequency the identified keyword occurs in the corpus. The tf-idf calculation can be used to determine the weight of the identified keyword (or node) based on its frequency, and it can be used for filtering in/out other identified keywords based on their overall frequency. The tf-idf scoring can be used to determine the value of the identified keyword as an indication of user interest. The tf-idf scoring can employ the topic vector space model (TVSM) to produce relevancy vector space of related keywords/interests.

Each identified keyword can be used to generate output nodes and super nodes. The output nodes are normally distributed close nodes around each token of the original query. The super nodes act as classifiers identified by deduction of their overall frequency in the corpus. A super node, for example, would be “rock music” or “hair bands.” However, if the idf value of an identified keyword is below zero, then it is determined not to be a super node. A keyword like “music,” for example is not considered a super node (classifier) because its idf value is below zero, in that it is too popular or broad to yield any indication of user interest. Basic probability, tf-idf, nodes, and concept specific ontology approaches can be used to determine coincident (co-occurring) keywords and terms. It should be noted, however, that any combination of the these methods can be used to determine coincident (co-occurring) keywords and terms.

A computer program product can be provided for managing online ad campaigns. Executable software code on a computer useable medium is used to create and manage the online advertising campaigns. Profiles can be associated with ads in an ad inventory. A social networking profile of a user who uses a social networking application can be accessed and processed. The social networking profile can be compared with one or more of the ad profiles. An ad from the ad inventory can be selected for use in connection with the user's use of the social networking application. The ad inventory includes ads that are stored on an ad server. Ads in the ad inventory are queued as candidates to be targeted to the user.

Currently, some applications and websites always publish pop-up ads, spam e-mails, and low-quality ads, etc. The proliferation of these ads has brought poor and even unbearable experience to the Internet users. Some ads may contain viruses, which induce users to click on and implant them into user's devices to steal the user's private data. These problems reflect that there lacks an effective supervision mechanism for the IDA, and the existing operation mechanism is outdated. Most websites rely on click-through rates to earn ad revenue. Some publishers may try to use fraudulent means to improve click-through rate, which is called “IDA fraud”.

Kim, Kyungwon, Eun Kwon, and Jaram Park. “Deep user segment interest network modeling for click-through rate prediction of online advertising.” IEEE Access 9 (2021): 9812-9821, discloses modelling of user interest applied in the realm of advertising.

Internet (online) advertising is becoming an important direction in the advertising industry with its strengths in diverse users, strong interactions, real-time feedback, and expandability. Internet advertising is mainly divided into search and exhibition ads. Exhibition ads mainly appear in the form of text or images that target web pages, applications, and videos. Search engine ads present advertisement inventory. After the advertiser participates in an auction, it takes up several inventories and exposes advertisements. Comparing with existing advertisements, the two kinds of Internet advertisements rely on the behavior history of users, such as consumers' or netizens' clicks and purchases, and valuable information can be obtained from several promotions. In other words, Internet advertisements can show great marketing ability by processing data from multiple channels to convey information, understanding what users want, and approaching them easily.

AI, and in particular, large language model based neural network systems, hold promise for application to targeting advertising. The purpose of the targeted advertising is to increase the efficiency of advertising, ultimately reflected in increased profits of the seller for a typical commercial advertiser. This may be achieved through reduced ad costs per sale, increased conversion of advertising impressions to sales, higher profits sales, and reduced competition. The LLM, or multimodal-enhanced LLM, in a larger system that implements the function, can model the nature of the product or service being conveyed, the characteristics of various users (targets), and the advertising market, to optimize the particular ads delivered to a target, and the valuation of the ad placement. The optimization is an economic optimization employing a value function, based on the desires, needs and value function of the user. In general, the neural networks are pretrained, and the economic optimization algorithm predetermined. The user profile and characteristics are adaptive, and are generic for all advertising and possibly the content targeting as well. Ads fed to the system are processed to extract their salient characteristics, and a metadata file with the characteristics is associated with the ad.

In a typical transaction, a user interface has an ad slot available. The nature of the slot and the user characteristics are then processed along with the metadata for the inventory of ads to determine ads that meet logistical and qualitative requirements of the ad slot, and then the algorithm executed to select the most optimal match, or rank the ads according to an optimality metric. The ads may be competitive, i.e., ad sponsors conduct an auction for control over an ad opportunity. However, the system preferably optimizes placement of the ad dependent on the ad characteristics, and not solely based on the economic value to the ad sponsor of the ad placement. This serves to limit display of inappropriate, subjectively offensive, repetitive, irrelevant, fraudulent, or otherwise subjectively undesirable ads to a user, thus increasing user satisfaction with the system, and hence, higher acceptability of appropriate ads.

The selected ad then funds the associated transaction. In general, the optimal ad will present a surplus over the minimum required compensation for the content associated with the transaction, but in some cases, there may be a deficiency, to be made up from other sources, such as another ad, the user's account, etc. Any surplus over the minimum(s) is allocated according to an allocation algorithm, e.g., to the content creator, consuming user, etc.

The four metric categories confirming the effectiveness of Internet advertising are cost per mile (CPM), cost per action (CPA), cost per click (CPC), and return on investment (ROI). Currently, most of the ad markets use CPC a lot, and ad revenue is expressed as the product of the probability of a user clicking the ad (click-through rate [CTR]), CPC, and the total number of clicks (N) (N×CTR×CPC). In the end, it directly depends on the number of clicks of users in the structure of the CPC billing of the demand-side platform (DSP). Therefore, predicting CTR is important in DSP [5], and predicting the CTR of an advertisement can increase advertisement revenue and user satisfaction.

The model traditionally used to predict CTR is logistic regression (LR). It can be explained and estimated quickly but cannot learn various patterns. In particular, it does not reflect the nonlinear relationship of data for CTR prediction, but the sparser the data and the more high-dimensional features are included, the more performance tends to decrease. Therefore, various algorithms have been developed to use computational complexity and reflect nonlinear characteristics. Factorization machine (FM), field-aware FM (FFM), and gradient boosting decision tree were proposed, but a rather simple algorithm for machine learning was used to reflect the nonlinear classification pattern of advertisement data. In recent years, neural network algorithms have been applied to improve these limitations. Thus, high-dimensional feature interactions can be reflected. To learn nonlinearity, a specific historical feature is converted into a vector of a specific length and combined with other features to form fully connected layers.

Researchers have recently proposed interest-based deep networks that can learn static interests from users' historical behaviors. For example, a deep interest network (DIN) improved the diversity of interest representation vectors by using an attention mechanism derived from machine translation. In general, users' interests change over time and are divided into positive ones with interest and negative ones with no interest. Therefore, the accuracy of CTR prediction may be lower because the real-time interest of the user cannot be reflected. To compensate for these shortcomings, a CTR prediction model that can reflect users' dynamic interests in past behavior was proposed.

Interests are not static but change dynamically according to changes in personal lifestyle or the socioeconomic environment. In this regard, we assume that users' changes in interests could be predicted by their changes in interests for other elements, specifically, similar users will experience changes in interests in a similar direction. Therefore, tracking how group-level interests evolve as well as individual-level interests is crucial. In this study, we propose a novel model, namely, the deep user segment interest network (DUSIN), to improve CTR prediction by using the recent latent interests of other users (i.e., segment interests) as well as users' individual interests. The model extracts latent interests at the individual and segment levels and activates the interest information to predict CTR for target advertisements. This study confirms the importance of segment interests to CTR prediction performance as well as the useful design of the segment interest activating layer.

Currently, CTR prediction models pay attention to individuals' “interests” and their evolution. Generally, a sum/average pooling layer is used to learn interests from past click sequences. Users' interests or feature patterns change constantly, and the fixed-length representation vectors of the pooling layer may have limitations in expressing such information. To solve this problem, efforts were exerted to extract user interests directly based on time-sequence data rather than pooling interest vectors. One such technique is the RNN model, which is employed in GRU4Rec to determine future preferences by using the past click behaviors of users. To extract sequential information effectively, an attention mechanism is used in DIN, which can extract relative and adaptive interests. The DIEN algorithm uses a two-layer RNN structure reflecting the attention framework to estimate the most relative interests of a candidate item. In addition, ATRANK utilizes a transformer, which is an attention-based framework that can improve machine translation performance. A transformer can be a feasible alternative to the RNN for estimating item dependencies and algorithm efficiency. Li et al. developed the attentive capsule network (ACN) algorithm to reflect users' multiple interests and used a transformer to extract feature interactions and multiple interests. Moreover, the authors proposed a modified dynamic routing algorithm to estimate the sequence representation.

Existing studies track changes in interests at the individual level. However, setting the target and segment groups for an advertisement and providing personalized advertisements to the target segments to improve performance are important. Therefore, in traditional marketing methods, audiences are divided into specific user groups through segmentation, and advertisements are presented to potential client groups as the “target,” who are relevant to and interested in the advertisement. One of the most used segmentation methods is interest-based segmentation, which groups users with similar interests. For example, if a user is interested in ingredient analysis for cosmetics or fair-trade products, then we can predict that he/she and other users in a similar group (i.e., segment) may also be interested in organic products. As computational advertising develops, a marketing approach that can comprehensively maximize ROI using information such as user interests, demographics, and geographic locations collected from the Data Management Platform (DMP) may be feasible.

Individual users have multiple and diverse interests, and Xiao et al. tried to estimate latent dominant interests by introducing a multi-interest extractor layer. The study estimates the representative evolution of individual users' dominant interests, whereas the model is focused on representative evolution at the segment and individual levels. Similarly, in a study on user segment extraction, Li et al. reflected the concept of time-aware item behaviors and estimated a user segment interested in a specific item over time. Subsequently, the authors improved recommendation performance by reflecting emerging preferences in a recent period. Therefore, to solve the time evolution problem, the authors developed a deep time-aware item evolution network (TIEN) algorithm using a time-interval attention layer. Moreover, Feng et al. applied the concept of multiplex relation to the algorithm to estimate user segment items. Users exhibit individual interests or item behaviors and are simply “fans of,” “members of,” or “themes of” something other than their interests. In addition, CTR prediction probability is affected by specific segments' interests or item behaviors. This concept is defined as multiplex relation, and the multiplex target-behavior relation network (MTBRN), which is an algorithm reflecting the “MTBR,” was developed to improve prediction performance. To estimate segment evolution, a knowledge graph (KG) was included in the existing recommender system.

Previous works focused on segment interests and their evolution to determine users' interests and grouped users into segments. However, a main reason for using segment information in the present research is not to segment users but to employ segment interests and evolving information based on predefined segment groups to predict CTR. Finding influencing factors in data analysis is a significant factor in improving analysis performance. An important factor to consider when making recommendations based on interests is that people's interests evolve over time, and cycles emerge during specific time periods. As information can spread rapidly in social networks through news or events, and users can quickly adapt to such information or recent trends, we assume that the interests of users in the same segments evolve similarly. Therefore, tracking users' changes in interests at the individual and segment levels is important for accurate target marketing. Inspired by the importance of the segment level and evolution of interests, we propose a model that can predict the click-through rate based on the interest evolution process at the segment and individual levels.

According to Kim et al., an algorithm is provided to optimize advertising. Given that the data in advertisement CTR prediction tasks are mostly categorical, the inputs are high-dimensional vectors and are sparse. Therefore, transforming them into low-dimensional dense representations is crucial to reduce dimensional complexity. The embedding layer reduces dimensional complexity and contextualizes the vectors. The categorical feature values are mapped to the integer index values and used as input for the embedding layer. The embedding layer looks up the embedding dictionary (i.e., lookup table), which is updated by a backpropagation algorithm during training. All outputs of embedding vectors are concatenated and fed into the following fully connected layers, except for users' behavior sequences. Users' behavior sequence features are fed into the individual user interest extractor layer, which will be presented later in this study. Segment interests are used to improve model performance for predicting advertisement click-through rates as well as individual user interests. Individual user interests are defined as latent user interest vectors extracted from individuals' sequential user behaviors, such as viewing the web page of a specific brand or product. The types of information that users focus were determined on based on their sequential behavior history. Segment interests are latent interest vectors that are extracted and aggregated from the sequential behavior history of users in a specific group. How individual and segment interests are generated and activated are described in the following sections. The DUSIN model is composed of three main parts, that is, an individual user interest extractor layer, a segment interest extractor layer, and a segment interest activating layer.

The model used embedding vectors of historical display sequences, which contain information about advertisements, such as the category and brand of the product. The users' complete history of advertisement display viewing behavior were focused on, rather than active behavior, such as buying or putting an item into a cart. Thus, the sequence history could be noisy. Therefore, given the enormous information of the users' history sequence, identifying the essential information for predicting CTR for the users would be better for the model.

To save more essential information in historical sequences, gated recurrent unit (GRU) cells are utilized, which have an update and reset gate to efficiently determine the quantity of past information to retain or forget. GRU has four components, namely, zₜ, the update gate at timestep t, rₜ, the reset gate at timestep t, hₜ, and the hidden layer at timestep t. By relying on the GRU, two kinds of individual user interest are present in output. First, the last hidden vector of the GRU is expected to have the accumulated information from the beginning of the user behavior sequence. Therefore, we define the last hidden vector as an individual user's latent interest. Second, the output sequences of GRU is used for activating segment interest. Through the individual user interest extractor layer, each user obtained their latent interest states at every advertising request for a user. Using this latent interest, segment interest is newly obtained and updated. Based on the segment IDs of users, the segment finder selects the segment to be updated and vertically concatenates the users' latent interest on the existing segment interest.

The embedding vectors of the historical viewing behavior of advertisements are first fed into the GRU layer. The output vectors of the GRU layer are then treated as an individual user's interest and fed into the segment interest activating layer. The key idea of this layer is based on the DIN local activation unit, which is similar to ideas incorporating attentional methods. The DIN activation unit calculated the activation weight by using the relationship of users' historical sequence (advertisement information) and target ad information. However, different from the DIN local activation unit, DUSIN calculated activation weight by considering the relationship of users' historical sequence and the recent latent interest of other users who are assumed to be similar with the user (i.e., segment interest). The obtained segment interest S₁ is activated in two ways in the segment interest activating module. First, the segment interest is element-wise multiplied by the target ad to represent the relationship between the current segment users' interests and the target advertisement. Second, the model obtains the weighted sum pooling using the activation weight and historical sequence.

Advertisements are exposed to customers through a transaction between the supply side platform, which supplies inventory for posting advertisements to users, and the DSP, which wants to purchase inventory to expose advertisements from the advertiser's point of view.

See Targeted Advertising references.

3. Distributed Ledger and Blockchain

A distributed ledger is a database that is consensually shared and synchronized across multiple sites, institutions, or geographies, accessible by multiple entities. It allows transactions to have public “witnesses.” The participant at each node of the network can access the recordings shared across that network and can own an identical copy of it. Any changes or additions made to the ledger are reflected and copied to all participants in a matter of seconds or minutes. A distributed ledger stands in contrast to a centralized ledger, which is the type of ledger that most companies use. A centralized ledger is more prone to cyber attacks and fraud, as it has a single point of failure.

The present technology may be centralized, and employ a traditional structured query language (SQL) or so-called NoSQL technology, implemented in centralized databases, datacenters, and cloud architectures. However, an interesting option arises to permit the system to operate without centralized infrastructure in a decentralized manner. In this case, the content is distributed among node of the database, and is available for communication to a requesting node, in a manner similar to the Torrent network, eDonkey network, or other peer-to-peer file sharing technology (P2P). Similarly, the ads may also be distributed through such a P2P. Further, metadata files for content and ads may also be distributed through P2P, ensuring that nodes have a sufficiently synchronized local database upon which to perform a targeting and optimization. Because influencers are not universal, respective users may receive metadata files associated with preferred influencers through the P2P. Therefore, a respective node of the system may have all of the data available, either stored locally, or accessible within a reasonable period of time, to filter, rank, and present media to a user, along with optimal ads, without involvement of central infrastructure.

The availability of data is not the entire issue. In order for the network to be sustainable, e.g., software development, resource availability, media availability, there needs to be a thriving economy. Thus, payments need to be made by or to network participants. The payments are preferably cryptocurrencies transacted through a decentralized ledger that would often be distinct from the distributed databases that include the social media content and metadata, though in some cases it may be within a common system. The transaction of providing content and ads to a user for consumption may be implemented as a smart contract, using cryptocurrency as the “fuel” or gas and the medium of compensation.

An advertiser provider advertising collateral, along with targeting data and rules, and cryptocurrency payment to the system, in a smart contract that permits the payment to be drawn upon compliance with the rules and according to the data. The user typically has a live, real-time feed which is updated, as the user interacts with the user interface and consumes the media. In advance of the consumption, the media may be associated with a payment from a media sponsor for favorable placement in a user's queue, or naturally placed according to the user's characteristics and profile. When the user seeks to consume the media, a transaction is triggered to compensate the content owner, recommender and/or influencer, network operator, etc., for the use of the network and content. Assuming that the transaction is within the transaction parameters for the ad, then the smart contract executes, drawing the compensation from the advertiser, and crediting the accounts of the network operator, recommender and/or influencer, media owner, and optionally also the users themselves. In some cases, P2P participants, or other infrastructure or service providers may also be compensated for maintaining the information in the distributed database and for communicating that information. A transaction may also be a hybrid transaction, such that some aspects are centralized, while others are distributed. For example, an adserver may provide the ads and ad metadata, or even process the user targeting aspects of the system. In that case, the adserver may also generate payments to the various participants. However, if the system is operated in a decentralized mode, it is preferred that it is fault tolerant, and privacy preserving, so that the adserver is preferably not a critical service of the network such that a failure of the adserver interrupts the network as a whole. In the decentralized paradigm, an unsubsidized transaction may still be processed, though funded by another account, such as the consuming user.

Another aspect of this system is that the idea of a sponsor or advertiser may be open to any interest that seeks to pay for a right or privilege on the system. For example, an influencer or would-be influencer may be willing to stake the system and pay for access to users, which can then accept the influencer or reject it. If accepted, the influencer may then recoup the investment based on referral fees. Similarly, a recommender may supply tokens or resources to control aspects of the network, and therefore may be a net source of subsidy, at least at some times.

The network operator may control a main automated recommender, and thus receive a share of transactions for this service, but the main automated recommender may be in competition with third party recommenders, which would also be compensated. Thus, a private label social network may be implemented by providing client software that selects a proprietary recommender that filters or ranks content for the users, generally limits access to other recommenders, and optionally controls ad flow.

A distributed ledger is a database that is synchronized and accessible across different sites and geographies by multiple participants. The need for a central authority to keep a check against manipulation is eliminated by the use of a distributed ledger. Distributed ledgers may be permissioned or permissionless. This determines if anyone or only approved people can run a node to validate transactions. They also vary between the consensus algorithm—proof of work, proof of stake, voting systems and hashgraph. They may be mineable (one can claim ownership of new coins contributing with a node) or not (the creator of the cryptocurrency owns all at the beginning). All blockchain is considered to be a form of DLT. There are also non-blockchain distributed ledger tables.

A blockchain is defined as a chronological arrangement of data blocks in a form similar to a linked list structure. The cryptography technology and consensus mechanisms are employed to ensure that block data cannot be tampered with and forged, and to achieve decentralized ledger. Blockchain is highly related to some traditional technologies such as peer-to-peer network technology, asymmetric cryptography, consensus mechanism, and smart contracts. Blockchain has the characteristics of decentralization, high reliability, anonymity, traceability, and high security. Many blockchain-based application systems with autonomous property have been designed.

Blockchain technology uses a number of recent advances of cryptography and security technologies, especially for identity authentication and privacy protection technologies. Some specific techniques include encryption algorithms, hash algorithms, digital signatures, digital certificates, PKI systems, Merkle trees, etc. Hash algorithm and digital signature scheme can ensure the integrity of blockchain structure. Digital signature and digital certificate guarantee non-repudiation of transactions. Merkle tree can organize transaction data in the block structure according to their hash values, which ensures that the transaction data cannot be maliciously falsified. Blockchain can be regarded as a distributed ledger based on trust mechanism.

Different nodes can be added to the blockchain network to implement synchronization and decentralization. Compared with traditional distributed storage technology, the blockchain system provides certain fault tolerance performance under the untrusted networks. With Byzantine fault tolerance, each node in an untrusted environment can only know that the majority of nodes in the entire network are honest, and all honest nodes can achieve consistence in the system.

The consensus mechanism in the blockchain system allows decentralized nodes to jointly maintain the consistency of the blockchain ledger. Many consensus mechanisms have been proposed, for example, Proof of Work (POW), Proof of Stake (POS), Delegated Proof of Stake (DPOS), Byzantine fault tolerance (BFT). Among them, POW is a mechanism to obtain block construction permissions using computer computing power. POS allocates the accounting right according to the amount of assets held by nodes and the time of holding money. DPOS improves POS greatly in achieving a consensus mechanism of selects the block person through the voting mechanism to complete the trust operation.

A Blockchain system can use a smart contract to disseminate, verify, and enforce contracts in an informational manner, so as to achieve trusted transactions without third parties. Blockchain technology provides a trusted execution environment for smart contracts. A blockchain-based smart contract is essentially a piece of unchangeable computer code. Smart contacts ensure the security and efficiency of the system and greatly reduces the transaction cost.

A blockchain is a growing list of records, called blocks, that are linked together using cryptography. Each block contains a cryptographic hash of the previous block, a timestamp, and transaction data (generally represented as a Merkle tree). The timestamp proves that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks. en.wikipedia.org/wiki/Blockchain

Blockchains are typically managed by a peer-to-peer network for use as a publicly distributed ledger, where nodes collectively adhere to a protocol to communicate and validate new blocks. Although blockchain records are not unalterable as forks are possible, blockchains may be considered secure by design and exemplify a distributed computing system with high Byzantine fault tolerance.

A blockchain is a decentralized, distributed, and oftentimes public, digital ledger consisting of records called blocks that is used to record transactions across many computers so that any involved block cannot be altered retroactively, without the alteration of all subsequent blocks. This allows the participants to verify and audit transactions independently and relatively inexpensively. A blockchain database is managed autonomously using a peer-to-peer network and a distributed timestamping server. In the case of Blockchain and other game theoretic reliance systems, they are authenticated by mass collaboration powered by collective self-interests. Such a design facilitates robust workflow where participants' uncertainty regarding data security is marginal. The use of a blockchain removes the characteristic of infinite reproducibility from a digital asset. It confirms that each unit of value was transferred only once, solving the long-standing problem of double spending. A blockchain has been described as a value-exchange protocol. A blockchain can maintain title rights because, when properly set up to detail the exchange agreement, it provides a record that compels offer and acceptance. Logically, a blockchain can be seen as consisting of several layers: infrastructure (hardware); networking (node discovery, information propagation and verification); consensus (proof of work, proof of stake); data (blocks, transactions); and application (smart contracts/decentralized applications, if applicable).

Blocks hold batches of valid transactions that are hashed and encoded into a Merkle tree. Each block includes the cryptographic hash of the prior block in the blockchain, linking the two. The linked blocks form a chain. This iterative process confirms the integrity of the previous block, all the way back to the initial block, which is known as the genesis block. To assure the integrity of a block and the data contained in it, the block is usually digitally signed.

Sometimes separate blocks can be produced concurrently, creating a temporary fork. In addition to a secure hash-based history, any blockchain has a specified algorithm for scoring different versions of the history so that one with a higher score can be selected over others. Blocks not selected for inclusion in the chain are called orphan blocks. Peers supporting the database have different versions of the history from time to time. They keep only the highest-scoring version of the database known to them. Whenever a peer receives a higher-scoring version (usually the old version with a single new block added) they extend or overwrite their own database and retransmit the improvement to their peers. There is never an absolute guarantee that any particular entry will remain in the best version of the history forever. Blockchains are typically built to add the score of new blocks onto old blocks and are given incentives to extend with new blocks rather than overwrite old blocks. Therefore, the probability of an entry becoming superseded decreases exponentially as more blocks are built on top of it, eventually becoming very low. For example, bitcoin uses a proof-of-work system, where the chain with the most cumulative proof-of-work is considered the valid one by the network. There are a number of methods that can be used to demonstrate a sufficient level of computation. Within a blockchain the computation is carried out redundantly rather than in the traditional segregated and parallel manner.

The block time is the average time it takes for the network to generate one extra block in the blockchain. Some blockchains create a new block as frequently as less than every five seconds. By the time of block completion, the included data becomes verifiable. In cryptocurrency, this is practically when the transaction takes place, so a shorter block time means faster transactions. The block time for Ethereum is set to between 14 and 15 seconds, while for Bitcoin it is on average 10 minutes.

A hard fork is a rule change such that the software validating according to the old rules will see the blocks produced according to the new rules as invalid. In case of a hard fork, all nodes meant to work in accordance with the new rules need to upgrade their software. If one group of nodes continues to use the old software while the other nodes use the new software, a permanent split can occur. For example, Ethereum has hard-forked to “make whole” the investors in The DAO, which had been hacked by exploiting a vulnerability in its code. In this case, the fork resulted in a split creating Ethereum and Ethereum Classic chains. Alternatively, to prevent a permanent split, a majority of nodes using the new software may return to the old rules. In the case of smart contracts, and especially those that automatically control transfer of rights or assets, a split is infeasible, unless the rights themselves are present on the old and new blockchains. Since the smart contract was written under the original rules, these should apply to the result, unless all parties to the transaction agree to updating the software/rule set.

A sidechain is a designation for a blockchain ledger that runs in parallel to a primary blockchain. Entries from the primary blockchain (where said entries typically represent digital assets) can be linked to and from the sidechain; this allows the sidechain to otherwise operate independently of the primary blockchain (e.g., by using an alternate means of record keeping, alternate consensus algorithm, etc.).

By storing data across its peer-to-peer network, the blockchain eliminates a number of risks that come with data being held centrally. The decentralized blockchain may use ad hoc message passing and distributed networking. One risk of a lack of a decentralization is a so-called “51% attack” where a central entity can gain control of more than half of a network and can manipulate that specific blockchain record at will, allowing double-spending. A key advantage to a decentralized blockchain implementation is that the business risk of a central clearing agent is abated, and should the originator no longer be available, smart contracts on the blockchain technically survive. It remains underdetermined what happens if the community supporting the blockchain ceases to operate, though an interested party could maintain a node and process its own transaction, though with greatly diminished distributed consensus protections.

Peer-to-peer blockchain networks lack centralized points of vulnerability that computer crackers can exploit; likewise, it has no central point of failure. Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or the means to otherwise interact with the various capabilities that blockchains now support. Data stored on the blockchain is generally considered incorruptible.

Every active mining node in a decentralized system has a copy of at least the last block of the blockchain. Data quality is maintained by massive database replication and computational trust. No centralized “official” copy exists and (in a pure proof of work consensus system) no user is “trusted” more than any other. Transactions are broadcast to the network using software. Messages are delivered on a best-effort basis. Mining nodes validate transactions, add them to the block they are building, and then broadcast the completed block to other nodes. Blockchains use various time-stamping schemes, such as proof-of-work, to serialize changes. Alternative consensus methods include proof-of-stake. Growth of a decentralized blockchain is accompanied by the risk of centralization because the computer resources required to process larger amounts of data become more expensive.

An advantage to an open, permissionless, or public, blockchain network is that guarding against bad actors is not required and no access control is needed. This means that applications can be added to the network without the approval or trust of others, using the blockchain as a transport layer.

Bitcoin and other cryptocurrencies currently secure their blockchain by requiring new entries to include a proof of work. To prolong the blockchain, bitcoin uses Hashcash puzzles. While Hashcash was designed in 1997 by Adam Back, the original idea was first proposed by Cynthia Dwork and Moni Naor and Eli Ponyatovski in their 1992 paper “Pricing via Processing or Combatting Junk Mail”.

Permissioned blockchains use an access control layer to govern who has access to the network. In contrast to public blockchain networks, validators on private blockchain networks are vetted by the network owner. They do not rely on anonymous nodes to validate transactions nor do they benefit from the network effect. It has been argued that permissioned blockchains can guarantee a certain level of decentralization, if carefully designed, as opposed to permissionless blockchains, which are often centralized in practice. A blockchain, if it is public, provides anyone who wants access to observe and analyze the chain data, given one has the know-how.

Blockchain-based smart contracts are contracts that can be partially or fully executed or enforced without human interaction. One of the main objectives of a smart contract is automated escrow. A key feature of smart contracts is that they do not need a trusted third party (such as a trustee) to act as an intermediary between contracting entities; the blockchain network executes the contract on its own. This may reduce friction between entities when transferring value and could subsequently open the door to a higher level of transaction automation.

Chakravorty, Antorweep, and Chunming Rong. “Ushare: user controlled social media based on blockchain.” In Proceedings of the 11th international conference on ubiquitous information management and communication, pp. 1-6.2017 relates to Ushare, which allows users to have control over their social interactions. It employs a blockchain that describes assets as data shared or broadcasted to the network. Unlike regular state transition systems that describe ownership status of assets, it describes a state as a depletion of a token value that determines the number of transactions or shares that can be performed with that asset. A Turing complete Relationship System (e.g., an Ethereum-style virtual machine) handles the transition of the states through validation of the tokens until they get completely depleted. Finally, a client based Personal Certificate Authority (PCA) maintains a user's relationships and ensure that the encrypted assets that have been shared are viewable by only the intended circle of members. Further, the Ushare is anonymous and secure as all stored data would be encrypted off-sight before storing it in the blockchain or any accompanying system.

A blockchain-based digital advertising media system (B2DAM) was proposed that uses the Hyperledger Fabric, which is named ad-chains. It applies the blockchain technology to address the issues in the IDA ecosystem. Advertising coins (ad-coins) are employed to realize a reward mechanism, and the interests of roles are clarified in the decentralized system. The ad-coin system provides interests as well as restrictive effects on the roles of the ad market. With the revenue mechanism, users could be motivated to watch ads more actively compared to that in existing IDA systems. The B2DAM system relies on numerous nodes to ensure system stability and security. Therefore, it is necessary to design an effective incentive mechanism to encourage users to build more nodes. During the system initialization phase, new nodes and users can get additional ad-coins as rewards when publishing, pushing, and watching ads. The number of rewards decreases as the number of nodes increases. The users' privacy exposure is a prominent problem in the IDA market. Budak et al. found that the widespread use of ad-blocking software and third-party platform tracking are the main causes of threats. Users must be rewarded for watching ads. Once a user finished watching an ad, both users and ad publishers are rewarded with ad-coins. ad-coins are issued by the ad-chains, and it can also be obtained through transactions, which can be used in the B2DAM system only. Watching ads can benefit both users and ad publishers. If a low-quality ad is found, the user can close, skip, or score after watching. The transactions of ad-coins must be verified. Both parties of a transaction must have their wallet address with enough ad-coins. The transaction records the transfer of ad-coins from one wallet address to another. Every transaction needs to be verified by the blockchain consensus mechanism. A secure consensus mechanism guarantees the security of currency transactions. The stability of B2DAM system relies on the adchains. The more nodes, the more stable the system is. User's privacy should be protected. Each user in the B2DAM system has a public wallet address and a private key. A wallet address is distributed by the ad-chains, which can be changed at any time when its holder needs. Users can anonymously conduct transactions of ad-coins and evaluation of ad-related information, while keeping it safe in their wallets. In an early stage, B2DAM system uses the smart contract to set an incentive mechanism, in order to stimulate users to watch ads. A reward mechanism is also implemented to reward each user watching the ads with some ad-coins. Users who join the system in advance can receive additional rewards until the system matures. New users can earn additional adcoins by watching ads on the ad publisher platform constantly, while the ad publisher can also get rewards from advertisers. Advertisers must have enough ad-coins before providing ad-related information in order to ensure that users can get rewards after they watched ad. The ad-chains provide a mechanism which is used to determine whether an advertiser has sufficient funds to cover the costs of ad that they delivered, to ensure that the system works properly. When advertisers' ad-coins are not enough to pay for the ads publish fees, the system will stop recommending ads and feedback to them. Once an ad is watched, the system will pay the advertiser's pre-stored ad-coins to the ad publisher and user. Users are able to obtain some ad-coins from the advertiser after they watched ad, and the rest is paid to the ad publisher.

Raft is a consensus algorithm with better performance in the consortium blockchain. The raft algorithm consists of three roles: follower, candidate, and leader. A node in a cluster can only be one of these three roles at a time. These three roles are mutually transformed as time and conditions change. There are two main processes in the algorithm: one is the leader election, and the other is log replication, where the log replication process is divided into two stages: logging and submitting data. The fault-tolerant node of the raft algorithm is (N−1)/2, where N is the total number of nodes in the cluster.

The Livepeer project provides a live video streaming network protocol that is fully decentralized, highly scalable, crypto token incentivized, and results in a solution which can serve as the live media layer in the decentralized development (web3) stack. In addition, Livepeer is meant to provide an economically efficient alternative to centralized broadcasting solutions for broadcasters. The Livepeer Protocol is a delegated stake based protocol for incentivizing participants in a live video broadcast network in a game-theoretically secure way.

Gu et al. provides an autonomous resource request transaction framework based on blockchain in a social network, in which all kinds of resources in the social community can be traded through blockchain technology. When a user needs to acquire some resources from a community, the user may make a transaction with the members from the community through blockchain technology while the members autonomously negotiate each other to reach an agreement. The proposed framework provides an incentive mechanism to encourage community members to disseminate the resources through a smart contract. An incentive mechanism is provided to encourage the community members to disseminate the digital resources through smart contracts, where the community members can both obtain some of payment from resource requesters. Smart contracts are provided for resource uploading and resource request respectively.

See Distributed Ledger And Blockchain references.

4. Smart Contracts

So-called “Smart Contracts” are legal obligations tied to a computer protocol intended to digitally facilitate, verify, or enforce the negotiation or performance of the contracts. Smart contracts allow the performance of credible transactions without third parties. These transactions are trackable and may be irreversible. See, en.wikipedia.org/wiki/Smart_contract. The phrase “smart contracts” was coined by computer scientist Nick Szabo in 1996.

A smart contract is a set of promises, specified in digital form, including protocols within which the parties perform on these promises. Recent implementations of smart contracts are based on blockchains, though this is not an intrinsic requirement. Building on this base, some recent interpretations of “smart contract” are mostly used more specifically in the sense of general purpose computation that takes place on a blockchain or distributed ledger. In this interpretation, used for example by the Ethereum Foundation or IBM, a smart contract is not necessarily related to the classical concept of a contract, but can be any kind of computer program.

As noted above, the operation of the social network may be through a series of transactions in a distributed ledger, in which tokens are disbursed according to a smart contract based on media access and consumption. In the most generic case, any network participant may fund a transaction, though typically the network has sponsors, who fund network operation, and functionaries and users, who are compensated from proceeds of network operations. The smart contracts in some cases need not follow strict requirements of immutability, and in fact, there may be condition subsequent rules that can alter the token distribution after the transaction. For example, when a user seeks content, and received advertising, the advertising subsidy may be dependent on the user actually viewing the ad. If a user monitoring process reveals that the ad was not actually viewed, the subsidy may be withdrawn. Similarly, if a content owner is compensated for use of content, but the content is not actually used, then the payment to the content owner may be reversed or partially reversed.

Byzantine fault tolerant algorithms allowed digital security through decentralization to form smart contracts. Additionally, the programming languages with various degrees of Turing-completeness as a built-in feature of some blockchains make the creation of custom sophisticated logic possible.

Notable examples of implementation of smart contracts are Decentralized cryptocurrency protocols are smart contracts with decentralized security, encryption, and limited trusted parties that fit Szabo's definition of a digital agreement with observability, verifiability, privity, and enforceability.

Bitcoin provides a Turing-incomplete Script language that allows the creation of custom smart contracts on top of Bitcoin like multisignature accounts, payment channels, escrows, time locks, atomic cross-chain trading, oracles, or multi-party lottery with no operator. Ethereum implements a nearly Turing-complete language on its blockchain, a prominent smart contract framework.

Smart contracts have advantages over equivalent conventional financial instruments, including minimizing counterparty risk, reducing settlement times, and increased transparency. Smart contracts deployed on blockchains enable the creation of new types of digital assets, called tokens, that can interact with each other. In general, all kinds of digital information or assets can be customized in the form of tokens, whose process refers to tokenization. After digital assets are tokenized, they can be recorded on the blockchain. Different blockchains may have different tokenization processes. Currently, the most well-known guideline to create a token is a series of Ethereum Request for Comments (ERCs), which describe the fundamental functionalities and provide guidelines that a token should comply with working correctly on the Ethereum network. Within ERCs, various types of tokens are defined regarding the features of assets, e.g., ERC-20 for divisible assets and ERC-721 for indivisible assets. Once a token representation of a digital asset is created on a blockchain, it can be traded via a process known as an Initial Coin Offering (ICO), the online sale of created tokens.

See Smart Contracts references.

5. Fungible Tokens (Ft) and Non-Fungible Tokens (Nft)

In the present technology, tokens are employed to facilitate decentralized transactions. In some cases, the token is used in an economic transaction, and a fungible token may be employed which can be used across all types of transactions within the system. On the other hand, specialized tokens may be used that have limiting or defining characteristics that are unique or semi-unique, and have a plurality of different classes. These unique or semi-unique tokens are considered non-fungible because they are not equivalent across classes and are not directly interchangeable. Nonfungible tokens can be associated with individual media files, ads, users, sponsors, investors, affinity groups, etc. NFT have be used in conjunction with smart contracts, such that a particular NFT is linked to a particular contract.

A non-fungible token (NFT) is a unique and non-interchangeable unit of data stored on a digital ledger (blockchain). NFTs can be associated with published digital works, and used to distinguish between possession of a copy of the work and rights with respect to the work. The NFT may be used analogously to a certificate of authenticity, and use blockchain technology to give the NFT a public proof of ownership. The lack of interchangeability (fungibility) distinguishes NFTs from blockchain cryptocurrencies, such as Bitcoin.

An NFT is a unit of data stored on a digital ledger, transfers of which can be transferred on the digital ledger. The ledger may be distributed, and be implemented as a blockchain. The NFT can be associated with a particular digital or physical asset (such as a file or a physical object). NFTs function like cryptographic tokens, but, unlike cryptocurrencies like Bitcoin, NFTs are not mutually interchangeable, hence not fungible. As a result, tokens have a value associated with the rights linked to the token, and not represented by the token itself. NFTs may be created by recording a record on a blockchain, which is then verifiable dependent on the blockchain. Changes of ownership may be recorded on the blockchain. Ownership of an NFT does not inherently grant copyright or intellectual property rights to whatever digital asset the token represents. While someone may sell an NFT representing their work, the buyer will not necessarily receive any exclusive rights to the underlying work, and so the original owner may be allowed to create more NFTs of the same work. On the other hand, if the original work is itself a creature of the blockchain, then a “rule” may be imposed limiting the number of NFTs that may be issued, or other exclusive rights of the recipient. In that sense, an NFT is merely a proof of ownership that is separate from a copyright. The unique identity and ownership of an NFT is verifiable via the blockchain ledger. Ownership of the NFT is often associated with a license to use the underlying digital asset, but generally does not confer copyright to the buyer, some agreements only grant a license for personal, non-commercial use, while other licenses also allow commercial use of the underlying digital asset.

In general, access to particular content may be limited based on availability of a corresponding token, which would then be considered a NFT, since the same token cannot be used for different content. The NFT may be integral to a digital rights management (DRM) system, to unlock the content and compensate the content owner. Thus, a smartcontract transaction results in an NFT being conveyed to the user's media player, which then consumes the NFT and presents the NFT to the user. The NFT may be generated during the transaction based on an advance authority, or obtained from the content owner through or as a result of the transaction. The NFT does not need to be consumed immediately, and of the NFT is not consumed, it may be returned, exchanged, or sold. This allows market participants to arbitrage inefficiencies within the social network, and as a result, provide incentives for increased efficiency. While there is a social cost in arbitrage, the cost of inefficiency may be much higher. Similarly, each participant may use FTs or NFT for their respective roles. FTs provide liquid present value and a future value based on the health of the social network itself (assuming a utility token is used for generic transactions within the network), while NFTs have a present value based on an immediate transaction, and a future value dependent on a market for a particular feature. NFTs may therefore be used to isolate speculation and arbitrage, and allocate specific rights in the future, whereas FTs follow the economy as a whole.

ERC-721 is an inheritable Solidity smart contract standard, meaning that developers can create new ERC-721-compliant contracts by importing them from the OpenZeppelin library. ERC-721 provides core methods that allow tracking the owner of a unique identifier, as well as a permissioned way for the owner to transfer the asset to others. The ERC-1155 standard offers “semi-fungibility”, as well as providing a superset of ERC-721 functionality (meaning that an ERC-721 asset could be built using ERC-1155). Unlike ERC-721 where a unique ID represents a single asset, the unique ID of an ERC-1155 token represent a class of assets, and there is an additional quantity field to represent the amount of the class that a particular wallet has. The assets under the same class are interchangeable, and the user can transfer any amount of assets to others. Some more recent NFT technologies use validation protocols distinct from proof of work, such as proof of stake, that have much less energy usage for a given validation cycle. Other approaches to reducing electricity include the use of off-chain transactions as part of minting an NFT. The distinctive feature of ERC1155 is that it uses a single smart contract to represent multiple tokens at once. This is why its balanceOf function differs from ERC20's and ERC777's: it has an additional id argument for the identifier of the token that you want to query the balance of. This is similar to how ERC721 does things, but in that standard a token id has no concept of balance: each token is non-fungible and exists or doesn't. The ERC721 balanceOf function refers to how many different tokens an account has, not how many of each. On the other hand, in ERC1155 accounts have a distinct balance for each token id, and non-fungible tokens are implemented by simply minting a single one of them. This approach leads to massive gas savings for projects that require multiple tokens. Instead of deploying a new contract for each token type, a single ERC1155 token contract can hold the entire system state, reducing deployment costs and complexity. Because all state is held in a single contract, it is possible to operate over multiple tokens in a single transaction very efficiently. The standard provides two functions, balanceOfBatch and safeBatchTransferFrom, that make querying multiple balances and transferring multiple tokens simpler and less gas-intensive.

Tokens can represent assets on the blockchain to facilitate transactions, whose representations, tokens, are roughly categorized into fungible tokens (FT) and non-fungible tokens (NFT), based on the fungibility of assets. Fungible tokens are exchangeable and identical in all aspects and generally divisible, while non-fungible tokens cannot be substituted for other tokens even with the same type and (at least to the extent compliant with prior standards) are indivisible. One classic example of fungible tokens is crypto-currencies, in which all the coins generated for crypto-currencies are equivalent and indistinguishable. On the other hand, non-fungible tokens are typically unique and specially identified, which cannot be exchanged in a fungible way, making them suitable for identifying unique assets. Furthermore, with the help of smart contracts on the blockchain, one can easily prove the existence and ownership of digital assets, and the full-history tradability and interoperability of blockchain assets make NFTs become a promising intellectual property protection solution.

Digital assets vary in terms of fungibility, which is a characteristic of a token that indicates whether assets can be entirely interchangeable during an exchange process. Fungible tokens of the same type are identical (like coins are identical), being divisible into smaller units (like coins of different values). Non-fungible tokens have been employed to represent unique assets (e.g., collectables, certificates of any kind, any type of access rights, objects, etc.). Thus, an NFT is unique, indivisible, and different from other tokens even with the same type. There exist several well-known crypto-tokens: crypto-coins, asset-tokens, and utility-tokens. From the perspective of fungibility, crypto coins typically belong to fungible tokens, and both asset-tokens and utility-tokens are non-fungible tokens. Crypto coins are commonly referred to as crypto-currencies, with the help of blockchain, which can be used as a medium of exchange of currencies without resorting to any centralized banks. Asset-tokens typically can be used to represent a wide range of assets beyond crypto-currencies, e.g., assets with physical existence (i.e., real properties) or without physical existence (i.e., stock shares). Utility-tokens are typically used to represent a unit of product or service, or tokens that enable future access to a product of service.

In general, a token is affected by four operations in its lifecycle. The issuer (often as a seller) first creates the token (e.g., via smart contracts). If traded on a trading market, the buyer then bids upon the token, at which point agreement, the seller transfers the token's value to the buyer. Finally, the new owner (e.g., the buyer) of a token can redeem the value of the token. This description describes a general model of a token life-cycle. When a token is created on a blockchain, e.g., public blockchain, everyone can see how it was developed and linked to the underlying right or asset. Due to the anonymity or pseudonymity of blockchain, when legal disputes arise from the creation and use of digital assets, it is often not enough to match these assets with the real-life owner or creator of the token, which makes the verification process of assets difficult. (anonymity or pseudonymity are optional, and therefore this may not be a significant problem). Most existing tokens are required to operate with smart contracts to verify their ownership and manage their transferability.

Blockchain is a publicly known distributed ledger technology underlying many digital crypto-currencies, such as Bitcoin. In a broad sense, blockchain can be roughly explained as an immutable, decentralized, trusted, and distributed ledger based on decentralized (e.g., peer-to-peer (P2P)) networks. Essentially, blockchain is a distributed data structure and is labelled as a “distributed ledger” in its applications, functioning to record transactions generated within a network. As a distributed and decentralized ledger, the essential component of blockchain is data, alternatively called transaction. The transaction information can be considered a token transferring process occurring in a network or any data exchange. Atomicity Consistency Isolation Durability (ACID) provides general principles for transaction processing systems, e.g., blockchain. A transaction in an ACID system should have the following features for a blockchain system: (a) a transaction (or a transaction block consisting of multiple transactions) is executed as a whole or not at all (e.g., enabling the feature of “all or nothing”); (b) each transaction transforms the system from one consistent and valid state to another, without compromising any validation rules and data integrity constraints; (c) concurrent transactions are executed securely and independently, preventing them from being affected by other transactions; and (d) once a transaction has been successfully executed, all changes generated by it become permanent even in the case of subsequent failures. Some indivisible assets require strong atomicity on the contained information, e.g., as one piece, while others (e.g., most crypto-currencies) can be dividable.

The Ethereum platform can be used to create arbitrary smart contracts, whose tokens can be used to represent various digital assets. These tokens can represent anything from both physical objects and virtual objects. They can use them for a variety of purposes, e.g., recording transactional data information or paying to access a network. The mapping process between a token and its representative asset is initially purely fictitious. The token contains the asset model that is certified by a smart contract to guarantee the uniqueness of data. In general, tokens will not depend on operating systems and do not include physical content within, and via the smart contract, it is easy to verify the validity of a token.

Tokenization is the transformation process of data/assets into a representation by a random digitized sequence of characters. It simplifies the process of representing physical/virtual assets and provides some protection on sensitive data, e.g., by substituting non-sensitive data into a token. The token serves merely as a reference to the original data or assets for blockchain applications but cannot be utilized to determine those values. A token itself does not include economic value information in it, and the “monetary” value of a token typically is assigned by the market. Thus, we can consider a token as a symbol that is validated by smart contracts of the target blockchain system. As long as validated by the smart contract, the token can be used in numerous applications or be traded in the market. Tokenization of real-world assets is a trend that generates much interest in blockchain research. Tokenization on the blockchain provides many advantages. For instance, tokenization eliminates most financial, legal, and regulatory intermediaries, resulting in significantly lower transaction costs.

A fungible asset can be interchangeable with other assets of the same category or type. Fungibility refers to an asset's capacity to be interchanged with other assets of the same or similar types. In other words, fungibility is one kind of property of a token that specifies whether objects or quantities of a similar type can be freely interchangeable during a trade or utilization. In general, in the finance domain, fungible assets simplify the exchange and trade processes, as fungibility implies equal value among the involved assets. In the token domain, some of them are purely equal (aka. perfectly fungible tokens), while others possess distinct characteristics which ensure their uniqueness (aka. non-fungible tokens).

The fungibility of a token refers to the fact that the token has the same or similar content compared to other fungible tokens. Thus, fungible tokens are interchangeable/replaceable with, or equal to, another asset of the same category. For example, A fungible token can be readily substituted by other assets of the same or equivalent value that may be divided or exchanged. They are identical to one another and can be divided into smaller units, which does not affect their values. Furthermore, fungible tokens typically are not unique. For example, a payment token is always fungible, which is exchangeable, divisible, and not unique in nature. From a technical perspective, a fungible token is implemented as a list of blockchain addresses (user accounts) that have a number (quantity) associated with them, together with (1) a set of methods used to manipulate that list, such as ‘transfer n tokens from address a to address b’, and (2) rules to determine who can manipulate that list in which way. Under applications of the Ethereum blockchain, ERC-20 (or Ethereum Request for Comments #20) is an example of fungible tokens. It is a specification established upon by the Ethereum community (a community that endorses ERCs) that specifies certain fundamental functionalities and provides criteria for a token to comply with performing correctly on Ethereum blockchains. An ERC-20 token is a token that follows ERC-20 guidelines. They have some inherent feature that makes one token identical to another token in terms of type and value. For example, an ERC-20 token functions similarly to ETH on the Ethereum blockchain, in that one token always have an equal value to all other tokens. Besides, the ERC-20 standard specifies a common interface for fungible tokens that are divisible and not distinguishable, which further ensures interoperability among the Ethereum blockchain community.

A non-fungible token (NFT) is a cryptographically unique token, which can be used to keep track of the ownership of individual assets. Non-fungible tokens differ from fungible tokens in terms of interchangeability, uniformity, and divisibility. A non-fungible token cannot be divided in nature, in which each one contains some distinctive information and attributes to identify itself from others uniquely. This feature makes NFTs impossible to interchange with each other. In general, each non-fungible token is unique and differs from others. The ERC-20 standard provides the technological framework and best practices for fungible token creation under Ethereum blockchains. Similarly, the ERC-721 standard did the same for non-fungible tokens, which allows the developers to create a digital asset representation that can be exchanged and tracked on the blockchain. The establishment of this new standard was prompted by the fact that there exists a significant difference between fungible and non-fungible tokens in nature. For example, the notion of fungible commonly describes the capacity of each piece of a commodity to be interchanged with other pieces of the same or similar commodity. ERC-721 defines that each NFT token must have a universally unique identifier, whose ownership can be identified and transferred with the help of metadata. In general, the ERC-721 standard specifies an interface that each smart contract on Ethereum that wants to create ERC-721 tokens has to implement.

The key characteristic of NFTs is that they symbolize ownership of digital or physical assets, which can encompass a wide range of assets. This distinguishes NFTs and allows for individual tracking of their ownership. Furthermore, with the help of blockchain, the NFT, as a token, provides the essential verifiable immutability and authenticity, as well as other characteristics like delegation, transfer of ownership, and revocation.

Tokens standards on fungible and non-fungible assets typically facilitate distinct contracts for each token type, which may place some redundant bytecodes on blockchain and limit certain functionality by the nature of separating each token contract. Semi-fungible tokens have the features of both fungible tokens and non-fungible tokens. SFTs provide more flexible interfaces to represent some complex assets or processes. ERC-721 is not the only token standard that exists for NFTs. The Ethereum ERC-1155 standard (Multi Token Standard) is another notable Ethereum variant that offers “semi-fungible” options and the potential to represent both fungible and non-fungible assets. This offers an interface to denote an NFT in a fungible way. For instance, an ERC-1155 token extends the functionality of token identification (“tokenId”), which can offer configurable token types. This type of token may contain customized information, e.g., metadata, timestamp information, supply, and other attributes In general, the ERC-1155 token is a new token proposal standard to create fungible and non-fungible tokens in the same contract.

In general, semi-fungible tokens can hold and represent the features of both fungible and non-fungible assets. Thus, semi-fungible tokens may be more efficient to create and bundle token transactions (without requiring a mandate unique token contract for each token created). For example, the ERC-1155 token offers some level of flexibility over the ERC-721 token, e.g., creating flexible, re-configurable, or exchangeable tokens with non-fungible features. Accordingly, the token structures and interfaces of SFTs will also be more complex.

Utility-tokens are typically used to represent a unit of product or service or tokens that enable future access to a product of service. Utility-tokens are not like crypto-currencies that are designed for investment or made for exchange purposes, and they are designed as a service that can be purchased. However, in practice, some situations may exist in which the same product or service can be distributed to multiple users and allow them to exchange utility information with each other. Typically, utility tokens belong to fungible tokens. For example, ERC-20 compatible tokens on the Ethereum platform are considered utility tokens. The utility tokens are generally valid between users within a network or community.

See FT and NFT references.

6. The Ethereum Virtual Machine (Evm)

The Ethereum White Paper, Vitalik Buterin, “Ethereum White Paper A Next Generation Smart Contract & Decentralized Application Platform” describes the Ethereum platform.

As discussed above, the social network operates as a series of transactions which convey media or rights relating to media, and various compensation. These transactions occur within a decentralized system as smart contracts. Smart contract, in turn, execute in a distributed virtual machine, such as the EVM. The EVM supports smart contracts and transactions of arbitrary complexity, and therefore may support a full range of transaction types. Of course, other virtual machine architectures may be employed.

Even without any extensions, the Bitcoin protocol actually does facilitate a weak version of a concept of “smart contracts”. UTXO in Bitcoin can be owned not just by a public key, but also by a more complicated script expressed in a simple stack-based programming language. In this paradigm, a transaction spending that UTXO must provide data that satisfies the script. Indeed, even the basic public key ownership mechanism is implemented via a script: the script takes an elliptic curve signature as input, verifies it against the transaction and the address that owns the UTXO, and returns 1 if the verification is successful and 0 otherwise. Other, more complicated, scripts exist for various additional use cases. For example, one can construct a script that requires signatures from two out of a given three private keys to validate (“multisig”), a setup useful for corporate accounts, secure savings accounts and some merchant escrow situations. Scripts can also be used to pay bounties for solutions to computational problems, and one can even construct a script that says something like “this Bitcoin UTXO is yours if you can provide an SPV proof that you sent a Dogecoin transaction of this denomination to me”, essentially allowing decentralized cross-cryptocurrency exchange. However, the scripting language as implemented in Bitcoin has several important limitations:

Lack of Turing-completeness—that is to say, while there is a large subset of computation that the Bitcoin scripting language supports, it does not nearly support everything. The main category that is missing is loops. This is done to avoid infinite loops during transaction verification; theoretically it is a surmountable obstacle for script programmers, since any loop can be simulated by simply repeating the underlying code many times with an if statement, but it does lead to scripts that are very space-inefficient. For example, implementing an alternative elliptic curve signature algorithm would likely require 256 repeated multiplication rounds all individually included in the code.

Value-blindness—there is no way for a UTXO script to provide fine-grained control over the amount that can be withdrawn. For example, one powerful use case of an oracle contract would be a hedging contract, where A and B put in $1000 worth of BTC and after 30 days the script sends $1000 worth of BTC to A and the rest to B. This would require an oracle to determine the value of 1 BTC in USD, but even then it is a massive improvement in terms of trust and infrastructure requirement over the fully centralized solutions that are available now. However, because UTXO are all-or-nothing, the only way to achieve this is through the very inefficient hack of having many UTXO of varying denominations (e.g., one UTXO of 2k for every k up to 30) and having the oracle pick which UTXO to send to A and which to B.

Lack of state—UTXO can either be spent or unspent; there is no opportunity for multi-stage contracts or scripts which keep any other internal state beyond that. This makes it hard to make multi-stage options contracts, decentralized exchange offers or two-stage cryptographic commitment protocols (necessary for secure computational bounties). It also means that UTXO can only be used to build simple, one-off contracts and not more complex “stateful” contracts such as decentralized organizations, and makes meta-protocols difficult to implement. Binary state combined with value-blindness also mean that another important application, withdrawal limits, is impossible.

Blockchain-blindness—UTXO are blind to blockchain data such as the nonce and previous hash. This severely limits applications in gambling, and several other categories, by depriving the scripting language of a potentially valuable source of randomness.

The intent of Ethereum is to merge together and improve upon the concepts of scripting, altcoins and on-chain meta-protocols, and allow developers to create arbitrary consensus-based applications that have the scalability, standardization, feature-completeness, ease of development and interoperability offered by these different paradigms all at the same time. Ethereum does this by building what is essentially the ultimate abstract foundational layer: a blockchain with a built-in Turing-complete programming language, allowing anyone to write smart contracts and decentralized applications where they can create their own arbitrary rules for ownership, transaction formats and state transition functions. A bare-bones version of Namecoin can be written in two lines of code, and other protocols like currencies and reputation systems can be built in under twenty. Smart contracts, cryptographic “boxes” that contain value and only unlock it if certain conditions are met, can also be built on top of the platform, with vastly more power than that offered by Bitcoin scripting because of the added powers of Turing-completeness, value-awareness, blockchain-awareness and state.

In Ethereum, the state is made up of objects called “accounts”, with each account having a 20-byte address and state transitions being direct transfers of value and information between accounts. An Ethereum account contains four fields: The nonce, a counter used to make sure each transaction can only be processed once; The account's current ether balance; The account's contract code, if present; and the account's storage (empty by default).

“Ether” is the main internal crypto-fuel of Ethereum, and is used to pay transaction fees. In general, there are two types of accounts: externally owned accounts, controlled by private keys, and contract accounts, controlled by their contract code. An externally owned account has no code, and one can send messages from an externally owned account by creating and signing a transaction; in a contract account, every time the contract account receives a message its code activates, allowing it to read and write to internal storage and send other messages or create contracts in turn.

An Ethereum message can be created either by an external entity or a contract, whereas a Bitcoin transaction can only be created externally. There is an explicit option for Ethereum messages to contain data. The recipient of an Ethereum message, if it is a contract account, has the option to return a response; this means that Ethereum messages also encompass the concept of functions.

The term “transaction” is used in Ethereum to refer to the signed data package that stores a message to be sent from an externally owned account. Transactions contain the recipient of the message, a signature identifying the sender, the amount of ether and the data to send, as well as two values called STARTGAS and GASPRICE. In order to prevent exponential blowup and infinite loops in code, each transaction is required to set a limit to how many computational steps of code execution it can spawn, including both the initial message and any additional messages that get spawned during execution. STARTGAS is this limit, and GASPRICE is the fee to pay to the miner per computational step. If transaction execution “runs out of gas”, all state changes revert—except for the payment of the fees, and if transaction execution halts with some gas remaining then the remaining portion of the fees is refunded to the sender. There is also a separate transaction type, and corresponding message type, for creating a contract; the address of a contract is calculated based on the hash of the account nonce and transaction data.

An important consequence of the message mechanism is the “first class citizen” property of Ethereum—the idea that contracts have equivalent powers to external accounts, including the ability to send message and create other contracts. This allows contracts to simultaneously serve many different roles: for example, one might have a member of a decentralized organization (a contract) be an escrow account (another contract) between an paranoid individual employing custom quantum-proof Lamport signatures (a third contract) and a co-signing entity which itself uses an account with five keys for security (a fourth contract). The strength of the Ethereum platform is that the decentralized organization and the escrow contract do not need to care about what kind of account each party to the contract is.

If there was no contract at the receiving end of the transaction, then the total transaction fee would simply be equal to the provided GASPRICE multiplied by the length of the transaction in bytes, and the data sent alongside the transaction would be irrelevant. Additionally, note that contract-initiated messages can assign a gas limit to the computation that they spawn, and if the sub-computation runs out of gas it gets reverted only to the point of the message call. Hence, just like transactions, contracts can secure their limited computational resources by setting strict limits on the sub-computations that they spawn.

The code in Ethereum contracts is written in a low-level, stack-based bytecode language, referred to as “Ethereum virtual machine code” or “EVM code”. The code consists of a series of bytes, where each byte represents an operation. In general, code execution is an infinite loop that consists of repeatedly carrying out the operation at the current program counter (which begins at zero) and then incrementing the program counter by one, until the end of the code is reached or an error or STOP or RETURN instruction is detected. The operations have access to three types of space in which to store data: The stack, a last-in-first-out container to which 32-byte values can be pushed and popped; Memory, an infinitely expandable byte array; AND The contract's long-term storage, a key/value store where keys and values are both 32 bytes. Unlike stack and memory, which reset after computation ends, storage persists for the long term. The code can also access the value, sender and data of the incoming message, as well as block header data, and the code can also return a byte array of data as an output.

The formal execution model of EVM code is surprisingly simple. While the Ethereum virtual machine is running, its full computational state can be defined by the tuple (block_state, transaction, message, code, memory, stack, pc, gas), where block_state is the global state containing all accounts and includes balances and storage. Every round of execution, the current instruction is found by taking the pc-th byte of code, and each instruction has its own definition in terms of how it affects the tuple. For example, ADD pops two items off the stack and pushes their sum, reduces gas by 1 and increments pc by 1, and SSTO RE pushes the top two items off the stack and inserts the second item into the contract's storage at the index specified by the first item, as well as reducing gas by up to 200 and incrementing pc by 1. Although there are many ways to optimize Ethereum via just-in-time compilation, a basic implementation of Ethereum can be done in a few hundred lines of code.

The Ethereum blockchain is in many ways similar to the Bitcoin blockchain, although it does have some differences. The main difference between Ethereum and Bitcoin with regard to the blockchain architecture is that, unlike Bitcoin, Ethereum blocks contain a copy of both the transaction list and the most recent state. Aside from that, two other values, the block number and the difficulty, are also stored in the block.

In general, there are three types of applications on top of Ethereum. The first category is financial applications, providing users with more powerful ways of managing and entering into contracts using their money. This includes sub-currencies, financial derivatives, hedging contracts, savings wallets, wills, and ultimately even some classes of full-scale employment contracts. The second category is semi-financial applications, where money is involved but there is also a heavy non-monetary side to what is being done; a perfect example is self-enforcing bounties for solutions to computational problems. Finally, there are applications such as online voting and decentralized governance that are not financial at all.

On-blockchain token systems have many applications ranging from sub-currencies representing assets such as USD or gold to company stocks, individual tokens representing smart property, secure unforgeable coupons, and even token systems with no ties to conventional value at all, used as point systems for incentivization. Token systems are surprisingly easy to implement in Ethereum. The key point to understand is that all a currency, or token system, fundamentally is a database with one operation: subtract X units from A and give X units to B, with the proviso that (i) X had at least X units before the transaction and (2) the transaction is approved by A. All that it takes to implement a token system is to implement this logic into a contract.

An important feature of the protocol is that, although it may seem like one is trusting many random nodes not to decide to forget the file, one can reduce that risk down to near-zero by splitting the file into many pieces via secret sharing, and watching the contracts to see each piece is still in some node's possession. If a contract is still paying out money, that provides a cryptographic proof that someone out there is still storing the file.

The general concept of a “decentralized organization” is that of a virtual entity that has a certain set of members or shareholders which, perhaps with a 67% majority, have the right to spend the entity's funds and modify its code. The members would collectively decide on how the organization should allocate its funds. Methods for allocating a DAO's funds could range from bounties, salaries to even more exotic mechanisms such as an internal currency to reward work. This essentially replicates the legal trappings of a traditional company or nonprofit but using only cryptographic blockchain technology for enforcement. So far much of the talk around DAOs has been around the “capitalist” model of a “decentralized autonomous corporation” (DAC) with dividend-receiving shareholders and tradable shares; an alternative, perhaps described as a “decentralized autonomous community”, would have all members have an equal share in the decision making and require 67% of existing members to agree to add or remove a member. The requirement that one person can only have one membership would then need to be enforced collectively by the group.

A general outline for how to code a DO is as follows. The simplest design is simply a piece of self-modifying code that changes if two thirds of members agree on a change. Although code is theoretically immutable, one can easily get around this and have de-facto mutability by having chunks of the code in separate contracts, and having the address of which contracts to call stored in the modifiable storage. An alternative model is for a decentralized corporation, where any account can have zero or more shares, and two thirds of the shares are required to make a decision. A complete skeleton would involve asset management functionality, the ability to make an offer to buy or sell shares, and the ability to accept offers (preferably with an order-matching mechanism inside the contract). Delegation would also exist Liquid Democracy-style, generalizing the concept of a “board of directors”.

Because every transaction published into the blockchain imposes on the network the cost of needing to download and verify it, there is a need for some regulatory mechanism, typically involving transaction fees, to prevent abuse. The default approach, used in Bitcoin, is to have purely voluntary fees, relying on miners to act as the gatekeepers and set dynamic minimums. This approach has been received very favorably in the Bitcoin community particularly because it is “market-based”, allowing supply and demand between miners and transaction senders determine the price. The problem with this line of reasoning is, however, that transaction processing is not a market; although it is intuitively attractive to construe transaction processing as a service that the miner is offering to the sender, in reality every transaction that a miner includes will need to be processed by every node in the network, so the vast majority of the cost of transaction processing is borne by third parties and not the miner that is making the decision of whether or not to include it. Hence, tragedy-of-the-commons problems are very likely to occur. However, as it turns out this flaw in the market-based mechanism, when given a particular inaccurate simplifying assumption, magically cancels itself out.

The Ethereum virtual machine is Turing-complete; this means that EVM code can encode any computation that can be conceivably carried out, including infinite loops. EVM code allows looping in two ways. First, there is a JUMP instruction that allows the program to jump back to a previous spot in the code, and a JUMPI instruction to do conditional jumping, allowing for statements like while x<27: x=x*2. Second, contracts can call other contracts, potentially allowing for looping through recursion. This naturally leads to a problem: can malicious users essentially shut miners and full nodes down by forcing them to enter into an infinite loop? The issue arises because of a problem in computer science known as the halting problem: there is no way to tell, in the general case, whether or not a given program will ever halt.

As described relating to state transition section, the system works by requiring a transaction to set a maximum number of computational steps that it is allowed to take, and if execution takes longer computation is reverted but fees are still paid. Messages work in the same way.

A review of Ethereum and its vulnerabilities are discussed in Atzei, Nicola, Massimo Bartoletti, and Tiziana Cimoli. “A survey of attacks on ethereum smart contracts (sok).” In International conference on principles of security and trust, pp. 164-186. Springer, Berlin, Heidelberg, 2017.

See EVM references.

7. Compensation of Users

The Basic Attention Token (BAT) provides an advertisement substitution platform based on incentive tokens for viewing of advertisements. The marketplace for online advertising, once dominated by advertisers, publishers and users, has seen a rise in prominence of “middleman” ad exchanges, audience segmentation, complicated behavioral and cross-device user tracking, and cross-party sharing through data management platforms. BAT proposes a decentralized, transparent digital ad exchange based on Blockchain. The first component is Brave, an open source, privacy-focused browser that blocks third party ads and trackers, and builds in a ledger system that measures user attention to reward publishers accordingly. BAT is a token for a decentralized ad exchange. It compensates the browser user for attention while protecting privacy. BAT connects advertisers, publishers, and users and is denominated by relevant user attention, while removing some social and economic costs associated with existing ad networks, e.g., fraud, privacy violations, and malvertising. BAT is a payment system that rewards and protects the user while giving better conversion to advertisers and higher yield to publishers.

The BAT system provides users with strong privacy and security when viewing advertisements, improved relevance and performance, and a share of tokens. Publishers see improved revenue, better reporting, and less fraud. Advertisers have less expensive customer attention, less fraud, and better attribution.

The present technology permits payments to the media consuming user, based on a subsidy from an advertiser. The BAT system, however, only compensates the user for viewing ads, and does not provide distribution to other members of the network. Further, the BAT system lacks a social network infrastructure.

Sales planners currently budgeting for brand advertising are required to account for an excessive number of intermediaries that stand between the ad and the end user. Agencies, trading desks, demand side platforms, desktop and mobile network exchanges, yield optimization, rich media vendors and partnered services often consume significant portions of creative and delivery ad budget. It is also common for agencies in charge of packaging brand campaigns to use data aggregators, data management platforms, data suppliers, analytics, measurement and verification services to fight fraud, enhance targeting, and confirm attribution. These factors add up to a high transaction cost on the efficient provision of attention to brand ad campaigns.

Publishers also face a number of costs and intermediaries on the receiving side of the ads served. Publishers pay ad serving fees, operational fees for campaign setup, deployment and monitoring, publisher analytics tools; also they give up substantial revenue to some of the same intermediaries that the brand advertisers use via programmatic ads. Publishers face direct costs of user complaints when malvertising spreads from exchanges to loyal readers, often with little or no idea of origin and with no help from the ad exchanges responsible for allowing such ads to serve from their systems. These diminish net revenue as the overall complexity of the advertising ecosystem raises headcount and expense.

There is a cost to this complexity. A single ad unit may bounce across many networks, buy and sell-side ad servers, verification partners and data management platforms. Publishers lose revenue from each middleman transaction. Each one of these transactions also detracts from the user experience. Many of the middle players involve data transfers, which add latency. Any transfers done via script on page eat into the user's data plan and battery life on mobile. Users often find their experience further diminished when the results finally arrive, confounded by distracting ads the publisher allowed to be placed in hope of greater revenue. The sum total of malvertisements, load times, data costs, battery life, and privacy loss has driven users to adopt ad-blocking software. This further reduces publisher revenues and leaves the remaining ad-viewing audience even harder to target.

User attention is valuable, but it hasn't been properly priced with an efficient and transparent market system. Further, the economic cost and impact of participants other than publisher, advertiser, user and middlemen has not been fully resolved and included in proposed solutions. Ultimately, a publisher provides information which may be of value to the user. Users give attention to the publisher in return for information that they value with their attention. At present, the publisher is paid by monetizing attention via a complex network of intermediary players through ad networks and other such tools. The publisher isn't paid directly for the attention given by the user. The publisher is actually paid for the indirectly measured attention given by users to ads. Publishers are used to working with this model for print ads, but web ads remain problematic for many of the reasons stated above. Users are subjected to the negative externalities that come with the present advertising ecosystem.

Users suffer a form of “electronic pollution” consisting of threats to security, threats to privacy, costs in inefficient download times, financial costs in extra mobile data fees, and in the case of the many ads, excessive costs to their attention. Human attention can be exhausted, until dopamine levels recover. Neurons can and do learn to ignore ad slots (so-called “banner blindness”). Abuse of user attention and permanent loss of users, via ad-slot blindness and ad-blocker adoption, make attention different from substitutable commodities such as pork bellies or crude oil, in the final analysis. While most users may be willing to pay some price for access to the publisher's information, user attention is mispriced when we sum up the growing negative externalities imposed by the present advertising ecosystem.

The BAT is supported by Brave, an open source, privacy-focused browser that blocks invasive ads and trackers, and contains a ledger system that anonymously measures user attention to accurately reward publishers. BAT is a token for the decentralized ad exchange that connects advertisers, publishers, and users, creating a new, efficient marketplace. The token is based on Ethereum technology, an open source, blockchain-based distributed computing platform with smart contracts. These cryptographically secure smart contracts are stateful applications stored in the Ethereum blockchain, fully capable of enforcing performance. The token is derived from—or denominated by—user attention. Attention is really just focused mental engagement—on an advertisement, in this case. The ability to privately monitor user intent at the browser level allows for the development of rich metrics for user attention. For example, it is known whether an impression has been served to an active tab, and measure the seconds of active user engagement. Attention is measured as viewed for content and ads only in the browser's active tab in real time. The Attention Value for the ad is calculated based on incremental duration and pixels in view in proportion to relevant content, prior to any direct engagement with the ad. In-device machine learning will match truly relevant ads to content from a level that middlemen with cookies and third party tracking are unable to achieve, regardless of how much of the user data is extracted and monitored from external models. These external models are unable to track transactions well enough not to serve ads for products users have often already purchased. User engagement through genuine feedback mechanisms ensures that users that have opted in for BAT are getting the best possible product match that they're most likely to convert into a transaction. Brave keeps the data on the device only, encrypting the data and shielding the identities of users as a core principle.

The high-level concept in payment flow is that the advertiser sends a payment in token along with ads to users in a locked state Xa. As the users view the ads, the flow of payments unlocks, keeping part of the payment for their own wallet (Xu), and passing on shares of the payment to Brave (Xb) and passing the remainder on to the Publisher (Xa-Xu-Xb). Ad fraud is prevented or reduced by cryptographically secure transactions. Ads served to individual browser/users are rate-limited and tied to active windows and tabs. Payments in BAT are sent only to publishers, though a payment for viewing an ad on one publisher may be used at another publisher or kept for some other premium services supplied through the BAT system.

Publisher payment is received through the BAT system. As initially conceived, the transactions in BAT take place through the Brave Ledger system, which is an open source Zero Knowledge Proof scheme which allows Brave users to make anonymous donations to publishers using bitcoin as the medium of exchange. The Brave Ledger system uses the ANONIZE algorithm to protect user privacy. All payments in BAT have a publisher endpoint. The “concave” awarding mechanism calculates an attention score based on a fixed threshold value for opening and viewing the page for a minimum of 25 seconds, and a bounded score for the amount of time spent on the page. A synopsis of user behavior is then sent back to the Brave Ledger System for recording and payments made on the basis of the scores.

A lottery system may be used, where small payments are made probabilistically, with payments happening essentially in the same way that coin mining works with proof of attention instead of proof of work, BOLT, Zero Knowledge SNARK or STARK algorithms may become part of this stack for guarding privacy of participants. The BAT situation is mitigated by the fact that the privacy of the browser customer is of primary importance; publishers and advertisers have fewer privacy concerns. The transactions in a fully distributed BAT system will almost always be one to many and many to one, therefore novel zero-knowledge transactions may be suggested by this arrangement. Brave is intended to move to a fully distributed micropayment system, allowing other developers to use the free and open source infrastructure to develop their own use cases for BAT.

As users are given access to some of the advertising spend in BAT, they become an important and active part of the advertising and publishing economy, rather than the passive participants as initially conceived. An obvious use case is for very specific targeted advertising. Some publishers may have premium content they would ordinarily only offer to subscribers. Since subscription models are not typically favored by users on the internet, this could unlock new revenue for premium content providers. Content may also be bought for friends using the token; if someone likes a premium article, they can make a micropayment to send it to three of their friends. Higher quality content may also be offered to users for a BAT transaction. For example, higher quality video or audio on an entertainment channel, or some kind of summary of headlines in a news source. Video or audio content in a news or other information source may be restricted to people who pay a small micropayment. Comments may be ranked or voted on using BAT tokens. Comment votes backed by BAT may be given more credibility due to the fact that someone cared enough to back the comment with what would be a limited supply of token, as well as the fact that a token transfer can be verified as coming from real people rather than robots. The right to post comments may also be purchased for some minimal payment, to cut down on abusive commenters. BAT might be used to purchase digital goods such as high resolution photos, data services, or publisher applications which are only needed on a one-time basis. Many publishers have access to interesting data sets and tools which they are not able to monetize on a subscription basis, but which individuals may wish to occasionally use. BAT may also be used in games provided by publishers. Custom news alerts may be offered as a service by news providers for a small payment of BAT within the ecosystem. Such news alerts may be very valuable to individuals who are concerned with current events, financial news or some anticipated event.

Various proxies have been developed by advertisers and publishers to attempt to measure user attention using indirect techniques of “viewability,” but the advent of adblocking technologies and the increasing problem of fraud from non-human entities have cast doubt on such methods. A more direct technique would be to pay publishers via cryptographically secure methods, and serve the ad directly in the browser. Since the browser ultimately measures how the user interacts with the website better than any indirect meddling by intermediaries, involving the browser software itself in the process provides accurate measures of user attention bestowed on the publisher and advertiser. The browser also provides a much richer data set for understanding what the individual user is interested in. The Brave browser will contain opt-in and transparent machine learning algorithms for assessing user interests. While an ad campaign targeted to a financial publisher may have value to the broad interests of the overall readership of the publisher, individual readers can be given ads tailored to their individual and even private preferences.

The idea that user attention should have monetary value is familiar to both publishers and advertisers. The idea of publishers and particularly users being paid directly for attention bestowed on the publisher is more recent. Since the valuable commodity is user attention, it makes economic sense that the user be compensated for their attention. One could justify this as a compensation for the externalities imposed on users by the advertising ecosystem. One could also justify this by the fact that one is more likely to perform an action if one is compensated for it. There is also confirmation that the actual user attention is bestowed on the publisher via the addition of cryptographic contracts built on blockchain to this advertising stack. The code is open source and can be reviewed by researchers and interested parties on the advertiser and publisher sides. Since the transactions for the first deployment of BAT will happen through the Brave Ledger, which has privacy and deterministic user anonymity by design, full transparency can be achieved while user privacy is maintained. While this centralized solution should fulfill economic and technical goals, for further iterations, a decentralized solution could be developed to allow for trustless auditable transactions.

While paying a user to look at a publisher content may seem heretical to advertisers, the reality is the advertiser is paying someone. Removing the vast field of middlemen allows for a situation where the user may be compensated for valuable attention (made more valuable and relevant by measures of user interest at the browser) with no impact to advertiser costs and positive impact to publisher revenues. From a financial point of view, this could be seen as a variation on some other kind of short term promotion: advertisers regularly provide coupons and rebates on products. Promotions do not solve the problem of informing the user of the advertiser's product in the first place. Promotions also don't induce user loyalty or engagement. Most CMOs agree that short term sales can be improved with promotions, but sustainable competitive advantage can't be achieved using promotions, hence the use of advertisements.

The three-way Coase theorem is a source of much research interest among economists. The existence of “empty cores” in some situations have called into question the applicability of the Coase theorem to real world examples involving multiple distinct players. While there are many more than three participants in the online ad market, we can idealize them as consisting of three participants: the advertiser, the publisher and the user. This analysis is useful for understanding the game theoretic considerations, for addressing any “empty core” arguments against the proposed Coasean bargain, as well as for illustrating the dire state of the publishing industry.

The Basic Attention Token (BAT), a cryptographically-secure token, is provided as the medium of exchange for facilitating this Coasean bargain while protecting the privacy of the user. The advertiser wants to purchase user attention. This is broadly analogous to the “cost of production” in the exposition of the Coase theorem, whose notation we follow. The advertiser values the user attention. The publisher wishes to monetize the attention paid to the website. The user who views the website values the content of the website with attention. Advertisers and publishers in the present ecosystem have transaction costs associated with monetization of attention. Publishers are paid by advertisers to provide user attention. The intermediaries of the present system create costs. “Transaction costs” per the Coase theorem refer to the transaction costs for negotiating a deal between the players of the Coasean game, therefore the monetary costs of getting the ad to the publisher is not considered a “transaction cost” per se. The existing present advertising ecosystem produces “social costs” or attention pollution. These social costs are known to be large. For some large fraction of users, the social costs are larger than the attention cost. Every user is different, and of course, the publishers and advertisers vary as well, but the existence and growth of a large population of users for whom the utility is negative indicates that we are approaching the time where this inequality is always violated.

The social cost should be decomposed into its constituent parts. The primary components of the social cost are discussed above. Security risk is one component. Hacker networks can place ads in irresponsible ad exchanges, which could have very large costs for individual users as well as the publisher who displays those ads. Privacy loss is a very important social cost associated with the advertising landscape as it presently exists. Privacy invasions are presently required by advertisers to make sure the advertisement is actually viewed by a relevant user. In effect, the advertisers are paying for something which adds value to the attention. Data costs are also a significant part of the social cost of the present day advertising ecosystem. These costs are often borne by the user as a result of the activities of the middlemen who serve the advertiser and publisher. These costs seem most trivial, but for many users, they are among the top causes driving ad blocker adoption. For all viewers of online ad funded content, considerable time is taken in dealing with the cost of downloading and executing all the privacy-violating code. In addition to this cost, for those users who are using mobile devices, the monetary charges can be significant. Finally, there is the cost to attention produced by the ad itself. In most cases, this is not a large cost, but as it is the thing actually valued most by advertisers, it should be accounted for separately. If ads can be made relevant, may even be negative. Some users like looking at certain ads. So, the total social cost as understood by BAT/Brave for the existing online ad ecosystem is the sum of these factors.

The societal gain may be improved by better modelling of the social costs (to avoid arbitrage and misallocation), and reducing the transactional costs that do not add intrinsic value to the core transaction. Note that in many cases, middlemen add value by reducing overall transactional costs, and thus the goal is not to reduce transactional intermediaries, but rather to competitively determine their value and function.

The exchange rate for BAT tokens is proportional to the volume of services purchased and inversely proportional to the currency not used in transactions during a respective time period. This equation encapsulates the insight that a lack of tokens in circulation will raise the exchange rate. Thus, a restriction in supply in conjunction with a positive demand utility will generally result in a positive (non-zero) token valuation. Tokens may be inactive because of intended withholding and involuntary restriction. The holders of inactive tokens have standard ways of evaluating future utility of the tokens in terms of modern risk management theory. Rational token holders expect future returns from a position in BAT to be proportional to the volatility of the position over the time period in question, scaled by a risk aversion term. The Black Scholes model provides at least an initial basis to consider the future value of tokens. See, en.wikipedia.org/wiki/Black-Scholes_model.

See Compensation of Users references.

8. Digital Rights Management (Drm) and Compensation of Content Providers

Digital rights management (DRM) is the management of legal access to digital content. Various tools or technological protection measures (TPM) such as access control technologies can restrict the use of proprietary hardware and copyrighted works. DRM technologies govern the use, modification, and distribution of copyrighted works (such as software and multimedia content), as well as systems that enforce these policies within devices. en.wikipedia.org/wiki/Digital_rights_management

The term “Digital Rights Management” (DRM) encompasses the management of legal rights, rightsholders, licenses, sales, agents, royalties and their associated terms and conditions. Copyright law gives the owner of copyright the exclusive right to do and to authorize (1) the reproduction of the copyrighted work; (2) the preparation of derivative works based upon the copyrighted work; (3) the distribution of copies of the copyrighted work to the public by sale or other transfer of ownership or by rental, lease, or lending; (4) the public performance of the copyrighted work; and (5) the public display of the copyrighted work. DRM is all about controlling those rights in consideration for the owner of those rights. See US 2005004416.

The rights encompass the privilege, to which one is justly entitled, to perform some action involving the intellectual property of some entity. The owner is the legal entity that owns the rights in some intellectual property by virtue of a copyright, trademark, patent and so on. These rightsholders may enter into legal arrangements whereby they either sell or license those rights or subset of rights to another party. When the rightsholder sells the rights they act as a seller or grantor of rights. When the rightsholder licenses those rights they act as a licensor. The Licensee is the legal entity that has either licensed or purchased rights for some type of content. If the user is licensing the rights, they act as a licensee. A rights transaction is the act of legally transferring rights from one entity to another. These rights transactions can be as simple as purchasing a DVD movie (right to view unlimited times), or complex business-to-business (B2B) transactions where many types of rights with complex provision are exchanged.

The media content of the social network may be protected by DRM. As noted above, the DRM may interaction directly with Fungible Tokens or Non-Fungible Tokens, or the GRM may employ separate cryptographic credentials.

A product key, typically an alphanumerical string, can represent a license to a particular copy of software. During the installation process or software launch, the user is asked to enter the key; if the key is valid (typically via internal algorithms), the key is accepted, and the user can continue. Product keys can be combined with other DRM practices (such as online “activation”), to prevent cracking the software to run without a product key, or using a keygen to generate acceptable keys. DRM can limit the number of devices on which a legal user can install content. This restriction typically support 3-5 devices. This affects users who have more devices than the limit. Some allow one device to be replaced with another. Without this software and hardware upgrades may require an additional purchase. Always-on DRM checks and rechecks authorization while the content is in use by interacting with a server operated by the copyright holder. In some cases, only part of the content is actually installed, while the rest is downloaded dynamically during use.

Encryption alters content in a way that means that it can be used without first decrypting it. Encryption can ensure that other restriction measures cannot be bypassed by modifying software, so DRM systems typically rely on encryption in addition to other techniques.

Restrictions can be applied to electronic books and documents, in order to prevent copying, printing, forwarding, and creating backup copies. This is common for both e-publishers and enterprise Information Rights Management. It typically integrates with content management system software.

Digital watermarks can be steganographically embedded within audio or video data. They can be used for recording the copyright owner, the distribution chain or identifying the purchaser. They are not complete DRM mechanisms in their own right, but are used as part of a system for copyright enforcement, such as helping provide evidence for legal purposes, rather than enforcing restrictions.

When the key value used to encrypt and decrypt the data is the same value, a symmetric key algorithm is being used. The key in this case is termed the ‘shared secret’. Any person or system having access to the shared secret can decrypt and re-encrypt the data.

In the asymmetric encryption model, two different keys are used to perform the encryption process. One key, termed the ‘public key’ is provided to the recipient for use in decrypting messages sent from the source system as well as encrypting messages that can only be decrypted by the source system. The second key, termed the ‘private key’ is securely retained by the source system and is never revealed. The private key is used to encrypt the messages for systems possessing the public key and for decrypting messages sent from targets using the public key. These keys are also referred to as a key pair and are generated at the same time by the source system.

Another aspect to digital security is the aspect of tampering with data. An algorithm that uses a secret key can be used to create a one-way hash value that represents the exact value of the data. In order to recreate the same one-way hash value, the same data value must be provided again. Message digests don't prevent data from being tampered with, they only alert systems that the data has been altered in some way.

A digital signature combines the functionality of the asymmetric cryptography and message digests to mimic the real world handwritten signing of a document. The legal entity performing the signing function must have generated an asymmetric key pair and an associated certificate. The certificate containing the signer's public key is distributed to other entities that will need to verify the digital signature of the signer.

The DRM may be tied to a trusted platform module (TPM), to provide high levels of security.

Lee, US20210334770 provides a method and system for protecting intellectual property rights on digital content using smart propertization.

The above technology may be enhanced using transcription, proxy key cryptography, atomic key cryptography, etc., and especially extensions that include multi-party cryptography. See, U.S. Pat. No. 8,566,247, A number of communications systems and methods are known for dealing with three-party communications, for example, where a third party provides ancillary services to support the communications, such as authentication, accounting, and key recovery. Often, the nature of these communications protocols places the third party (or group of third parties) in a position of trust, meaning that the third party or parties, without access to additional information, can gain access to private communications or otherwise undermine transactional security or privacy.

Transactions for which third party support may be appropriate include distribution of private medical records, communication of digital content, and anonymous proxy services.

Another aspect of three party communications is that it becomes possible for two (or more) parties to hold portions of a secret or a key to obtain the secret, without any one party alone being able to access the secret. For example, Silvio Micali has developed a mature Fair Encryption scheme in which a number of trustees collaborate to hold portions of a key used to secure privacy of a communication between two principals, but who must act together to gain access to the secret. In Micali's Fair Encryption scheme, however, cooperation of neither of the principal parties to a communication is required in order to access the secret. The third party trustees, as a group, are trusted with a secret. The basis for this trust is an issue of factual investigation. The Micali Fair Encryption scheme does, however, provide a basis for the generation and use of composite asymmetric encryption keys. See, Eyal Kushilevitz, Silvio Micali & Rafael Ostrovsky, “Reducibility and Completeness in Multi-Party Private Computations”, Proc. of 35th FOCS, pp. 478-489, 1994.

The Micali Fair Encryption scheme does not, however, allow communication of a secret in which only one party gains access to the content, and in which the third party or parties and one principal operate only on encrypted or secret information. This system is discussed in further detail below. See:

Gilboa, N., “Two Party RSA Key Generation”, Proc of Crypto '99, Lecture Notes in Computer Science, Vol. 1666, Springer-Verlag, pp. 116-129, 1999; D. Boneh, J. Horwitz, “Generating a product of three primes with an unknown factorization”, Proc. of the third Algorithmic Number Theory Symposium (ANTS), 1998, pp. 237-251; Lin, Cun-Li, Sun, Hung-Min, and Hwang, Tzonelih, “Three Party Key Exchange: Attacks and a Solution”.

Micali, S., Fair Public-Key Cryptosystems. Advances in Cryptology—Proceedings of CRYPTO'92 (E. F. Brickell, ed.) Lecture Notes in Computer Science 740, SpringerVerlag (1993) pages 113-138; S Micali, Fair cryptosystems, MIT Technical Report, MIT/LCS/TR-579, November 1993, MIT Laboratory for Computer Science, November 1993.

Encryption technologies, particularly public key encryption systems, seek to minimize some of these weaknesses by reducing the need to share secrets amongst participants to a secure or private communication. Typical public key encryption technologies, however, presume that a pair of communications partners seek to communicate directly between each other, without the optional or mandatory participation of a third party, and, in fact, are designed specifically to exclude third party monitoring. Third parties, however, may offer valuable services to the participants in a communication, but existing protocols for involvement of more than two parties are either inefficient or insecure.

Traditional encryption algorithm schemes rely on use of one or more finite keys which are provided to an algorithm which generates a data string which is apparently random, called pseudorandom, but which can be predicted based on a knowledge of both the algorithm and the key(s), allowing extraction of a superimposed data message. Optimality of an algorithm for a given set of circumstances is based on a number of factors, and therefore many different cryptographic schemes coexist. Essentially, the key should be sufficiently long and stochastic that an extraordinarily long period of time would be necessary to attempt a brute force attack on the algorithm, while only a reasonable amount of time is required to generate keys, encrypt and decrypt messages. In addition, the key should be sufficiently long that observation of pseudorandom (encrypted) datastreams does not permit one to determine the key to the algorithm.

Public Key Encryption is a concept wherein two keys are provided. The keys form a pair, such that a message encrypted with one key of the pair may be decrypted only by the corresponding key, but knowledge of the public key does not impart effective knowledge of the private key. Typically, one of the keys is made public, while the other remains secret, allowing use for both secure communications and authentication. Communications may include use of multiple key pairs, to provide bilateral security. The public key pair may be self-generated, and therefore a user need not transmit the private key. It must, however, be stored.

The basis for Diffie Hellman and RSA-type public key encryption methods is the large disparity in computational complexity between decrypting the public key created cipher text with the public key encryption private key, which is very rapid and simple to do, and working through the possibilities without the key, which takes a very long time through all known means.

Modern public-key data encryption was originally suggested by Diffie and Hellman, “New Directions In Cryptography,” I.E.E.E. Transactions on Information Theory (November 1976), and was further developed by Ronald L. Rivest, Adi Shamir, and Leonard M. Adleman: “A Method for Obtaining Digital Signatures and Public-Key Cryptosystems,” Communications of the ACM 21(2):120-126 (Feb. 1978). See also, U.S. Pat. No. 4,351,982.

The basic reason for public-key encryption system is to ensure both the security of the information transferred along a data line, and to guarantee the identity of the transmitter and to ensure the inability of a receiver to “forge” a transmission as being one from a subscriber on the data line. Both of these desired results can be accomplished with public-key data encryption without the need to maintain a list of secret keys specific to each subscriber on the data line, and without requiring the periodic physical delivery or the secure electronic transmission of secret keys to the various subscribers on the data line.

According to the Diffie Hellman scheme, two hosts can create and share a secret key without ever communicating the key. Each host receives the “Diffie-Hellman parameters”. A prime number, ‘p’ (larger than 2) and “base”, ‘g’, an integer that is smaller than ‘p’. The hosts each secretly generate their own private number, called ‘x’, which is less than “p-1”. The hosts next generate a respective public key, ‘y’. They are created with the function: y=g^{x} Mod p. The two hosts now exchange their respective public keys (‘y’) and the exchanged numbers are converted into a secret key, ‘z’ by the following function: z=y^{x} Mod p. ‘z’ can now be used as an encryption key in a symmetric encryption scheme. Mathematically, the two hosts should have generated the same value for‘z’, since according to mathematical identity theory,

z=(g^{x} Mod p)^{x′}Mod p=(g^{x′}Mod p)^{x} Mod p.

A method of public-key encryption developed by Rivest, Shamir & Adelman, and now generally referred to as RSA, is based upon the use of two extremely large prime numbers which fulfill the criteria for the “trap-door, one-way permutation.” Such a permutation function enables the sender to encrypt the message using a non-secret encryption key, but does not permit an eavesdropper to decrypt the message by crypto-analytic techniques within an acceptably long period of time. This is due to the fact that for a composite number composed of the product of two very large prime numbers, the computational time necessary to factor this composite number is unacceptably long. A brute force attack requires a sequence of putative keys to be tested to determine which, if any, is appropriate. Therefore a brute force attack requires a very large number of iterations. The number of iterations increases geometrically with the key bit size, while the normal decryption generally suffers only an arithmetic-type increase in computational complexity.

In the RSA encryption algorithm, the message (represented by a number M) is multiplied by itself (e) times (called “raising (M) to the power (e)”), and the product is then divided by a modulus (n), leaving the remainder as a ciphertext (C): C=M^{e} mod n. In the decryption operation, a different exponent, (d) is used to convert the ciphertext back into the plain text: M=C^{d} mod n. The modulus (n) is a composite number, constructed by multiplying two prime numbers, (p) and (q), together: n=p* q. The encryption and decryption exponents, (d) and (e), are related to each other and the modulus (n) in the following way: d=e⁻¹ mod ((p−1) (q−1)), or equivalently, d*e=1 mod ((p−1) (q−1)). The RSA ciphertext is thus represented by the expression C=M^{e} mod n. The associated decryption function is M=C^{d} mod n. Therefore, M=C^{d} mod n=(M^{e} mod n)^{d} mod n, indicating that the original message, encrypted with one key, is retrieved as plain text using the other key. To calculate the decryption key, one must know the numbers (p) and (q) (called the factors) used to calculate the modulus (n).

The RSA Algorithm may be divided, then, into three steps:
(1) key generation: in which the factors of the modulus (n) (the prime numbers (p) and (q)) are chosen and multiplied together to form (n), an encryption exponent (e) is chosen, and the decryption exponent (d) is calculated using (e), (p), and (q).
(2) encryption: in which the message (M) is raised to the power (e), and then reduced modulo (n).
(3) decryption: in which the ciphertext (C) is raised to the power (d), and then reduced modulo (n).

Micali, U.S. Pat. Nos. 6,026,163 and 5,315,658, teach a number of split key or so-called fair cryptosystems designed to allow a secret key to be distributed to a plurality of trusted entities, such that the encrypted message is protected unless the key portions are divulged by all of the trusted entities. Thus, a secret key may be recovered, through cooperation of a plurality of parties. These methods were applied in three particular fields; law enforcement, business auctions, and financial transactions.

Essentially, the Micali systems provide that the decryption key is split between a number (n) of trusted entities, meeting the following functional criteria: (1) The private key can be reconstructed given knowledge of all n of the pieces held by the plurality of trusted entities; (2) The private key cannot be guessed at all if one only knows less than all (<n−1) of the special pieces; and (3) For i−1, . . . n, the i^{th} special piece can be individually verified to be correct. The special pieces are defined by a simple public algorithm which itself exploits the difficulty in factoring large numbers as a basis for asymmetric security.

Micropayments are often preferred where the amount of the transaction does not justify the costs of complete financial security. In the micropayment scheme, typically a direct communication between creditor and debtor is not required; rather, the transaction produces a result which eventually results in an economic transfer, but which may remain outstanding subsequent to transfer of the underlying goods or services. The theory underlying this micropayment scheme is that the monetary units are small enough such that risks of failure in transaction closure is relatively insignificant for both parties, but that a user gets few chances to default before credit is withdrawn. On the other hand, the transaction costs of non-real time transactions of small monetary units are substantially less than those of secure, unlimited or potentially high value, real time verified transactions, allowing and facilitating such types of commerce. Thus, the rights management system may employ applets local to the client system, which communicate with other applets and/or the server and/or a vendor/rights-holder to validate a transaction, at low transactional costs. Often, a micropayment involves a cryptographic function which provides a portable, self-authenticating cryptographic data structure, and may involve asymmetric cryptography. As will be clear from the discussion below, such characteristics may permit micropayments to be integrated as a component of the embodiments, or permit aspects of the embodiments to operate as micropayments.

See Digital Rights Management (Drm) And Compensation Of Content Providers references

9. Transcryption and Intermediated Transactions

An intermediary may perform a requisite function with respect to the transaction without requiring the intermediary to be trusted with respect to the private information or cryptographic keys for communicated information. This system and method employ secure cryptographic schemes, which reduce the risks and liability for unauthorized disclosure of private information, while maintaining efficient and robust transactions. The third party may account for secure data transactions, by maintaining a critical logical function in data communication. Thus, during each such transaction, the intermediary may force or require a financial accounting for the transaction. Further, by exerting this control over the critical function outside the direct communication channel, the intermediary maintains a low communication bandwidth requirement and poses little risk of intrusion on the privacy of the secure communication. Further, the intermediary never possesses sufficient information to unilaterally intercept and decrypt the communication.

Ancillary services may be provided with respect to communicating information. These ancillary services encompass, for example, applying a set of rules governing an information communication transaction. For example, the rules limit access based on recipient authentication, define a financial accounting, role or class of an intended recipient, or establish other limits. These services may also include logging communications or assisting in defining communications counter-parties. The access control is implemented by an intermediary to the underlying transaction, which facilitates the transaction by removing the necessity for a direct and contemporaneous communication with the equitable holder of a pertinent right for each transaction. The intermediary maintains a set of rights-associated rules. In order to enforce rights-based restrictions, the trustee may hold, associated with the rights information, a key, for example an encryption key, necessary for access or use of the information.

The intermediary may be trusted to implement the rules, but not necessarily trusted with access to, or direct and sole access control over the information. According to a preferred embodiment, the intermediary, acting alone, cannot access or eavesdrop on the private information or a communication stream including the information. Further, in accordance with the Micali split key escrow scheme, the intermediary may be implemented as a set of entities, each holding a portion of a required key.

A conduit may be provided for authorized transmission of records, while maintaining the security of the records against unauthorized access. A preferred communications network is the Internet, a global interconnected set of public access networks, employing standardized protocols. Thus, the records may be transmitted virtually anywhere on earth using a single infrastructure. Alternately, private networks or virtual private networks may be employed.

Often, when seeking to move secret information through an infrastructure, it is necessary to alter the cryptographic transform between a form accessible for general purpose usage, and a form suitable for specific usage by an intended recipient. For example, a database may be encrypted, but the database system must possess sufficient access privileges to search that database and retrieve results. Further, these privileges typically encompass the entire database, which may include records that have varying security attributes and release criteria. The release of the cryptographic keys employed by the database system would, at least in theory, compromise the security of the database as a whole, and therefore as the data is returned from the database server, the cryptographic transform must be changed, so that the keys representing root level access are protected. In some cases, it is desired to search and retrieve data based on metadata, which may differ from an index of the data. That is, the search and retrieval may have limited release of the data being searched. For example, a record may be retrieved by user identifier, without revealing the content of the record. In conveying that record, it may be desired to encode the record with a cryptographic transform specific to the intended user, while avoiding release of the basic cryptographic transform keys representing the original storage format.

The present technology has, according to an embodiment, a P2P data distribution system. In many cases, the data being distributed is public, and there is no particular need to protect it. On the other hand, some data is private, for example, proprietary content and messages, and must be protected. Further, while symmetric or asymmetric key cryptography is usable if the source and destination can negotiate in advance the cryptographic credentials, in some cases, the source and destination do not have direct communications. This can be addressed through transcryption, also known as proxy key cryptography or atomic key cryptography, in which encrypted keys in transit are re-keyed to a different cryptographic decryption key. Therefore, according to the present technology, a message or other data is communicated in an encrypted form, to a peer, non-destination node. The peer node then negotiates a relay of the information to the destination (or other intermediary node), and “transcrypts” or rekeys the information, in a process that does not involve decryption or risk of release of the information. At the destination, the recipient has a key that reveals the contents of the message. In a decentralized architecture, this alleviates the need for a central management authority or trusted intermediaries.

A type of cryptographic algorithm is known, called “proxy key cryptography”, which provides means for converting a cryptographic transform between a first transform associated with a first set of keys, and a second cryptographic transform associated with a second set of keys, without requiring an intermediate decryption of the information. Therefore, for example, such an algorithm could be used to convert the decryption key of a secret record from an original format to a distribution format.

In typical proxy key systems, a proxy receives a private key from a sender of an asymmetrically encrypted message, and a public key from a recipient of the transformed encrypted message, and computes a transform key (e.g., a product of p and q in an RSA type PKI algorithm) which is applied to the asymmetrically encrypted message. The application of the transform key allows the recipient to use its private key to decrypt the message. As discussed in U.S. Pat. No. 6,937,726, other types of algorithms and cryptographic schemes may also be applied with similar function. In these architectures, the proxy is provided with the decryption key for the original message, and thus is in a position to delegate its right and authority to decrypt the message to the recipient. On the other hand, an intermediary may also be deprived of sufficient information to decrypt the message, and therefore be unprivileged. This, in turn, opens potentially different roles for the intermediary than the proxy according to U.S. Pat. No. 6,937,726.

Another class of problem involves distribution of content separate from a control over access to content. It is well known to distribute content protected by a digital rights management (DRM) system through peer to peer networks or publicly available forums, and then separately control and administer usage through a player or renderer. For example, Microsoft Windows Media Player supports such an architecture. However, this scheme requires that the content be distributed with a single decryption key, which is protected by a “branded” player. The branded player then retrieves a key for the content after authenticating itself to a server, which is stored in a protected key cache. If the security of the player itself becomes compromised, all of the keys in the cache are potentially compromised. Likewise, this scheme limits portability of media between players, which have to separately negotiate licenses, and requires a centralized architecture or direct communications between source and destination. In some cases, each use is monitored, or the duration of usage limited. Since the server provides the keys to the content, it must be privileged to decrypt that content.

According to one embodiment, a user provides the intermediary with necessary transactional information relating to private information, in a manner that discloses little or no private information to the intermediary. In like manner, private information may be supplied to a user after the user has supplied necessary transactional information to the intermediary, without in the process disclosing the private information to the intermediary.

These techniques may be extended to allow personally identifying information to be removed from a communication by substitution with a non-personally identifying code, supplied by the intermediary. Again, this anonymous process may take place without providing the intermediary with the private information.

In some embodiments, the two principals to the communication remain anonymous with respect to each other, while in other instances, they are known to each other. In the former case, a proxy is provided to avoid divulging the address (e.g., logical or physical address) of the recipient, and, depending on communication protocol, the identity of the sender. The communication channel may remain secure between the two principals, although the proxy becomes trusted with respect to identities of the principals.

The proxy cryptography or transcryption techniques provide enhanced opportunities for control and accounting for content or information usage. Content can be readily distributed or transformed into a format specific for an intended recipient. Using a combination of system architecture and controls, as well as adjunct techniques, such as key exchange, complex, multiple level or composite transcryption keys, and Kerberos type techniques, for example, attributes of the transcryption technique may be added to attributes of other techniques, and deficiencies of the various techniques may be remedied.

The technology encompasses monetary transactions involving the information usage and/or communication. According to one embodiment, digital signatures may be employed in monetary transactions that, after authentication, become anonymous. A personally identifying digital signature may be substituted by the intermediary with an anonymous transaction or session identifier. In this case, while the transaction becomes anonymous, it is not necessary for the intermediary to be a direct party to the exchange of value between the principals involved in the communication, and thus the intermediary does not necessarily become privy to the exchange details.

The security and privacy scheme may be employed to convey content to users while ensuring compensation for rights-holders in the content. An architecture is provided which allows accounting and implementation of various rules and limits on communications between two parties. Further, an intermediary becomes a necessary part of the negotiation for communication, and thus has opportunity to apply the rules and limits. Each use of a record may trigger an accounting/audit event, thus allowing finely granular transactional records, which may reduce the risks of security and privacy breach in connection with record transmission. Usage-based financial accounting may be used for the information, imposing a financial burden according to a value and/or consumption of system resources. For example, the cost to a user could be a flat fee, depend on a number of factors, be automatically calculated, or relate to volume of usage.

The accounting may also compensate a target of an electronic message for receipt thereof. Thus, a marketer may seek to send an advertisement to a user. The user may then compel the marketer to send the electronic message through an intermediary, providing compensation to the user. It is noted that the system may permit multiple concurrent types of advertisements, such as sequential video ads, banner ads, overlaid ads, sponsored product placement, etc.

In establishing a secure communications session between the user and the intermediary, it may be useful in some circumstances to employ a challenge-response authentication scheme, for example by passing messages back and forth between the user and the intermediary, the user and the data repository, or the data repository and the intermediary.

The user's “role” may be checked for consistency with a set of role-based usage rules. The reported role may be accepted, or verified with resort to an authentication database. Based on the role of the user and the identification of the content, the authority of the user to receive records may be determined.

In one embodiment, a user is required to identify the specific records sought, and therefore the authorization matrix representing correspondence of record content and user role may be associated with each record, and may be verified by the data repository as a part of a local authentication process prior to transmitting any portion of a record. Thus, the matrix may represent a metadata format describing the content of the record and the level or type of authority of the user to access that record. This metadata may, of course, itself be privileged information.

In the event that the distribution of metadata or its application at a site is impermissible, a separate metadata processing facility may be provided. This facility may process the metadata in an anonymous index format, thus reducing or eliminating the risks of a privacy or security breach. The user authority matrix may be protected using the composite session key format, and therefore made secure even from the intermediary, which, in this case, may communicate the authority matrix and transactional request details to the metadata processing facility using a composite of a user session key and a metadata session key. The results of the authorization may be transmitted directly from the metadata processing facility directly to the data repository, in the form of a prefiltered specific record request. The intermediary may account for the transaction either on a request-made basis or subscription basis, or communicate accounting information with the data repository, for example to properly exchange required keys and complete the transaction.

In order to provide further security for the records and the use of the system, various techniques are available. For example, dummy content records may be added to the database and index therefore. Any access of these records is presumably based on an attempt for unauthorized access. Thus, the existence of these records, with access tracking, allows detection of some unauthorized uses of the system. Another method of securing the system is the use of steganographic techniques, for example embedding watermarks in audio and images, pseudorandom dot patterns in scanned page images, random insertion of spaces between words, formatting information, or the like, in text records. Therefore, records obtained through the system may be identified by their characteristic markings. In fact, every authorized record may be subjected to a different set of markings, allowing a record to be tracked from original authorized access to ultimate disposition. An explicit bar code, watermark or other type of code may also be provided on the document for this purpose. It is noted that such markings cannot be implemented on encrypted data at the point of transmission, and thus this type of security requires access to the raw content. However, this may be implemented at the point of decryption, which may be in a sufficiently secure environment. For example, a secure applet may be provided, employing a securely delivered session key, which processes records to test for existing watermarks and to add or substitute a new watermark. A system for the decryption and watermarking of data is provided in one embodiment, in a content (or content type)—specific manner. An online handshaking event may occur on decryption, to provide confirmation of the process, and indeed may also authenticate the user of the system during decryption. Asymmetric key encryption may be employed to provide the establishment of secure communications channels involving an intermediary, without making the intermediary privy to the decryption key or the message. Thus, by transmitting only relatively unprivileged information, such as respective public keys, the information and integrity of the system remains fairly secure.

In order to provide a three party transaction in which the intermediary is a necessary party, the information sought to be transmitted is subjected to a secret comprehension function (e.g., a cryptographic or steganographic function) with the key known only to the intermediary. In establishing the communication channel, the information is transcoded between a first comprehension function and a second comprehension function without ever being publicly available.

Modulo arithmetic is both additive and multiplicative, thus, using the same modulo n:

(A^{x} mod n•A^{y} mod n)mod n=A^{x+y}mod n

((A)mod n+(B)mod n)mod n=(A+B)mod n

((A)mod n•(B)mod n)mod n=(A•B)mod n

(A^{x} mod n)^{y} mod n=(A^{y} mod n)^{x} mod n=A^{xy} mod n

A preferred algorithm relies on the multiplicative property of modulo arithmetic; in other words, A mod B*C mod B (A C)mod B. However, this property is not “reversible”, in that knowledge of (A*C) mod B and either A or C does not yield the other, unless the product A*C is less than B, since the modulo function always limits the operand to be less than the modulus value.

Thus, it is seen that in an RSA scheme, M=C^{d} mod n=(M^{e} mod n)^{d} mod n. Therefore, in order to communicate the intermediary private information to the intended recipient, the recipient public key ‘e1’ and intermediary private key ‘d2’ are defined using the same modulus n, multiplied, and provided to the sender. At the sender, the ciphertext C2=M^{e2} modn, previously encrypted with the intermediary's public key e2, is subjected to the function: C1=C2^{d2e1} mod n=M^{e1} mod n. The recipient may then apply its private key d1 to decrypt the message: M=C¹ mod n.

It should be understood that the algorithm described herein represents merely a portion of an RSA-type public key infrastructure, and that generally all known techniques for preparing the message, maintaining a public key directory, and the like, may be employed in conjunction therewith, to the extent not inconsistent. Thus, the transcoding algorithm should be considered as a generally interchangeable part of the entire cryptographic system, which may be substituted in various known techniques, to achieve the advantages recited herein. In general, only small changes will be necessary to the systems, for example, accommodating the larger composite key length. It is also particularly noted that there are a number of known barriers to exploits that are advantageously employed to improve and maintain the security of the present system and method.

See, David Chaum, “Blind Signatures for Untraceable Payments”, Proceedings of Crypto 82, August 1982, p. 199-203. According to the Chaum scheme, a server assists a user in decrypting a message without releasing its secret key or gaining access to the encrypted message. The user communicates a symmetric function of the ciphertext to the server, which is then processed with the secret key, and the resulting modified ciphertext returned to the user for application of an inverse to the symmetric function. See, U.S. Pat. No. 6,192,472. This technique, however, requires a communication of the complete message in various encrypted forms to and from the server, a potentially burdensome and inefficient task, and is not adapted to communicate a secret file from a first party to a second party.

The transcryption scheme may be employed to securely communicate cryptographic codes between parties to a communication, for example a symmetric encryption key. For example, the Advanced Encryption Standard (AES) employs the Rijndael algorithm, which may provide highly efficient encryption and decryption. Thus, the asymmetric key encryption may be directed principally toward key exchange. According to another embodiment, an encrypted message (ciphertext) is “transcoded” from a first encryption type to a second encryption type, without ever passing through a state where it exists as a plaintext message. Thus, for example, an intermediary to the transaction who negotiates the transaction, need not be privileged to the information transferred during the transaction. In the case of medical records, therefore, this means that the intermediary need not be “trusted” with respect to this information.

A system embodiment using the algorithm has three properties of particular relevance: (a) while an intermediary may be a necessary party to the transaction, the protocol does not provide the intermediary with sufficient information to eavesdrop, thus, the intermediary is not trusted with the secret communication; (b) due to the transcryption, the sender of the message may maintain an encrypted repository, and also need not be trusted with the secret communication; and (c) that neither the decryption key for the message, nor the message, is transmitted at any stage in the process in an analytic form. Therefore, the message is provided only to an authorized and actively authenticated recipient.

One basic mechanism for implementing this scheme is transcryption, in some cases using technology known as proxy key encryption, which permits encrypted information to be transformed from a state corresponding to one set of cryptographic keys to a state corresponding to another set of cryptographic keys. The information provided to perform the transcryption need not inherently leak any decryption key, and the transcryption process itself may be integral such that it may be performed under insecure conditions. In its most basic form, an RSA-styled transcryption employs a composite key, such that if one of the composite elements is known, the other can be derived. This leads to a possible collusion of two parties to reveal the data. Of course, in a three-party model, the source of the information typically possesses the information, and the recipient of the transcrypted information is typically granted a right to decrypt, so that the collusion itself represents one party passing a right it possesses to another party. On the other hand, if a party seeks to reuse its private key in multiple transactions, or the source and/or destination are not themselves authorized, then this collusion becomes at least theoretically problematic. The present technology therefore provides another layer, wherein a composite key is a function of multiple elements, at least one of which is dynamically generated and intended for single use, such that potential for leakage of persistent secrets is reduced. For example, a second party acting in an intermediary capacity may be provided within the infrastructure. Similarly, there are other techniques to remedy this and other shortcomings of the simplest transcryption implementations, to achieve the desired properties for the system with high efficiency. See, U.S. Pat. No. 7,181,017.

In operation, the user generates, on a session basis, a key pair, and provides one portion to the intermediary, the other is maintained in secrecy for the duration of the transaction. The intermediary receives the session key and multiplies it with the secret decryption key for the message held by the data repository. Both the session key and the decryption key individually are held in secrecy by the intermediary. The data repository further receives from the intermediary an identification of the user, which is used to query a certification authority for an appropriate public key. The data repository “transcrypts” the encrypted message with a composite key (resulting from the multiplicative combination of the Record Private Key, the User Public Session Key and the Intermediary Private Session Key) as well as the User (persistent) Public Key to yield a new encrypted message, which is transmitted to the user. The user then applies the retained portion of the session key, as well as its persistent private key, resulting in the original plaintext message. Likewise, the composite encryption key used by the data repository results from the combination of the Record Public Key, Intermediary Private Session Key, and User Public Session Key.

When data is added to the Encrypted Record Database, it may be advantageous to provide the user with a confirmation comprising a hash function performed on the received data, either in its Composite Session Key format (allowing immediate verification by the user) or in its Record Key format (allowing persistent verification of the transaction), or both. Further, it may also be advantageous for the intermediary to receive or act as conduit for these verification communications, allowing an accounting to take place on such confirmation.

When data is communicated from the Encrypted Record Database to a user, it may likewise be advantageous to provide the data repository with a confirmation comprising a hash function performed on data received by the user. This confirmation may advantageously be communicated through the intermediary, allowing an accounting to take place on such confirmation.

In one scenario, the Data Repository receives the information from the Intermediary, and recalls the identified record from an Encrypted Database. The database record remains encrypted with a Record Public Key, originally generated by the Key Pair Generator. The Record Public and Private Keys, in this case, is stored in the Secure Record Key Database. An Encryption Processor may be provided to carry the cryptographic processing burden of the Intermediary, for example implementing a secure socket layer (SSL) and/or TLS protocol. The encrypted database record from the Encrypted Record Database, is presented to the Remote Key Handler, a privileged processing environment having both high security and substantial cryptographic processing capacity. The Remote Key Handler implements the algorithm: C*=C^{drecord•dintermediary•euser} mod n wherein: d_{record} is the Record Private Key, d_{intermediary} is the Intermediary Private Session Key, euser is the User Public Session Key, C is the ciphertext message stored in the Encrypted Record Database, encrypted with the e_{record}, the Record Public Key, and C*is the ciphertext message in a composite-key transcrypted format for transmission to the User. Likewise, for record accession into the Encrypted Record Database from the User, the Remote Key Handler implements the algorithm: C=C*^{erecord•dintermediary•euser} mod n, wherein: e_{record} is the Record Public Key, d_{intermediary} is the Intermediary Private Session Key, euser is the User Public Session Key, C is the ciphertext message to be stored in the Encrypted Record Database, encrypted with the e_{record}, the Record Public Key, and C* is the ciphertext message in a composite-key transcrypted format, received from the User. It is noted that, while the public key generally corresponds to the encryption key (e), and the private key generally corresponds to the decryption key (d), in the present example, the Remote Key Handler 33 is considered privileged, and therefore receives a key containing the key component designated private. Since the encryption and decryption functions are complementary, the results are the same. The user therefore always applies its own private session key and the intermediary's public session key, regardless of the transaction type.

In another scenario, the User transmits a Data Record to the Data Repository. In this case, the Data Record is encrypted with the User Private Session Key, the Intermediary Public Session Key (received from the Intermediary during a handshaking communications), as well as the User Persistent Private Key corresponding to the certificate stored by the Certification Authority in the public key database. The Data Repository then receives the communication, first decrypts it with the User Persistent Public Key received from the Certification Authority from the Public Key Database in the Encryption Processor, and then passes it to the Remote Key Handler, which securely receives a composite User Public Session Key—Intermediary Private Session Key Record Public Key product from the Intermediary. This is employed by the Remote Key Handler to produce a transcrypted Data Record, encrypted with the Record Public Key (generated by the Intermediary in the Key Pair Generator). This Record (encrypted with the Record Public Key) is then passed to the Data Repository and stored in the Encrypted Database. It is noted that in anonymous communications, a proxy may be employed to blind the address of the User from the Data Repository. In this case, a modified scheme is employed which may not use a Certification Authority, although the Intermediary may provide anonymous certificate services. It is also noted that each communication channel may itself be secure, for example using 128 bit secure socket layer (SSL) communications or other secure communications technologies. In particular, it is important that only the Intermediary be in possession of the transcryption key (e.g., composite key) and the session key (e.g., Intermediary Private Session Key), since this will allow recovery of the private encryption key. As noted above, the release of private keys may be limited by having both the Intermediary and User each generate a respective session key pair. In this case, the Intermediary transmits the public portion of its session key pair to the User, which is then employed to decrypt the message from the Data Repository. The key provided by the Intermediary to the Remote Key Handler, in this case, is the product: Record Private Key·User Public Session Key·Intermediary Private Session Key.

The resulting transcrypted record from the Data Repository is encrypted with the product of the two session keys. Because the transmitted key is a triple composite, the Record Private Key is protected against factorization. The User then uses the User Private Session Key and Intermediary Public Session Key in order to decrypt the Data Record. In the case of a Data Record transmission from the User to Data Repository, the User transmits a record encrypted with the product: User Private Session Key—Intermediary Public Session Key. Intermediary transmits to the Remote Key Handler, the product: Public Record Key·User Public Session Key Intermediary Private Session Key, which is used to transcrypt the encrypted Data Record with the Public Record Key. In like manner, the Data Repository may also generate a session key pair, used to sign and authenticate transmissions.

In order to decrypt the message, the Data Repository communicates with the Intermediary, provides the unique identifier of the message, and receives the Intermediary Private Session Key. The Data Repository then computes the composite decryption key from Data Repository Private Key*Intermediary Private Session Key, and decrypts the message using this composite key.

The session key pair generated by the Intermediary is used once, and may be expired or controlled based on a set of rules. Thus, the Intermediary may have a policy of destroying keys after a set time period or upon existence of a condition. Since the security of the encryption is analogous to RSA-type encryption, it can be made relatively secure. Since the Intermediary has no access to the Data Repository Private Key, the message cannot be decrypted based on information available to it. In addition, higher order composite keys may be implemented, for example composites formed of three or more RSA-type keys, some of which may be enduring keys (for example to provide digital signature capability) and other session keys. A further limit may be placed on decryption by imposing a key escrow with a time limit or other contingent release of a key.

In order for the recipient to obtain the necessary decryption information, accounting, authentication, and logging are implemented. According to a preferred embodiment, the decryption is preferably implemented by controlled application software, which prevents export of the message, such as by printing, disk storage, or the like. Therefore, within a reasonable extent, the message is isolated within the controlled application. The right of the user to access a comprehensible version of the message may be temporally limited, for example with an expiration date. These rights may also be limited based on a specified condition. Further use would require either a new transmission of the message, or a further accounting and logging of activity. Further, this allows control over the message on a per use basis, potentially requiring each user of the controlled application to authenticate himself or herself, and provide accounting information. Each use and/or user may then be logged.

It is also possible to permit anonymity of one party, for example a sender of a message, by employing anonymous cryptographic protocols, such as a employed in micropayment technology. Thus, a sender of a message may provide an anonymous accounting by employing an anonymous micropayment to account for the message transmission.

This technique therefore provides client-side security for messages, including medical records. By employing a third party for key management, burden on the sender is reduced.

Various known proxy cryptographic schemes derived from Wang, U.S. Pat. No. 6,937,726, may be used in conjunction with the present schemes, in place of, or in conjunction with, the algorithms and techniques described herein.

Indeed, the above document distribution approach has the proxy encryption flavor; the owner encrypts the document first using a private-key scheme and then grants the decryption right, upon request, to its recipients via a public-key scheme. It turns out that, either one of the two new proxy encryption schemes can be used to combine the best features of the approach into a single, normal encryption scheme.

As described above, an adaptation of the present technology is also applicable to a file protection application. Usually, file protection in insecure systems such as laptops and networked hardware involves long-term encryption of files. Thus, encryption keys used for file encryption have much longer lifetimes than their communication counterparts. While a user's primary, long-term, secret key may be the fundamental representation of a network identity of the user, there is a danger that it might get compromised if it is used for many files over a long period of time. If the primary key is lost or stolen, not only are contents of the files encrypted with it disclosed, but also the user loses personal information based on the key such as credit card account, social security number, and so on. Therefore, it is often preferable to use an on-line method in which a new decryption key is derived from the primary key every time a file needs to be encrypted and gets updated on a regular basis.

With the proxy encryption schemes set forth herein, new decryption keys can be generated and constantly updated through self-delegation to keep them fresh. Once a new key is created and a corresponding proxy key generated, the old secret key can be destroyed, with the new key and proxy key maintaining the ability to decrypt the file.

Although the foregoing examples and algorithms all employ various adaptations of the ElGamal cryptosystem, it should be noted that other cryptosystems can also be adapted. For example, the Cramer-Shoup public-key cryptosystem is a recently proposed cryptosystem that is the first practical public-key system to be provably immune to the adaptive chosen ciphertext attack. See R. Cramer and V. Shoup, “A Practical Public Key Cryptosystem Provably Secure against Adaptive Chosen Ciphertext Attack,” Proceedings of CRYPTO '98, Springer Verlag LNCS, vol. 1462, pp. 13-25 (1998).

The transcription technologies, in their various forms, permit end-to-end encrypted communications, without risk of intermediary access to the communicated information, thus preserving privacy. The technology nevertheless involves an intermediary, who can be instrumental in completing the communication, with necessary knowledge of the communication participants, unless cloaking technology is employed, or a pair of intermediaries, each with knowledge of one participant only.

As part of a social network, these technologies permit some degree of moderation of social network communications, without content-based censorship. For example, personal messages may be protected from intrusion by others within the system or government agents.

See Transcryption And Intermediated Transactions references.

10. Homomorphic Encryption

Homomorphic encryption is a form of encryption that permits users to perform computations on its encrypted data without first decrypting it. These resulting computations are left in an encrypted form which, when decrypted, result in an identical output to that produced had the operations been performed on the unencrypted data. Homomorphic encryption can be used for privacy-preserving outsourced storage and computation. This allows data to be encrypted and out-sourced to commercial cloud environments for processing, all while encrypted.

For sensitive data, homomorphic encryption can be used to enable new services by removing privacy barriers inhibiting data sharing or increase security to existing services. For example, predictive analytics in health care can be hard to apply via a third party service provider due to medical data privacy concerns, but if the predictive analytics service provider can operate on encrypted data instead, these privacy concerns are diminished. Moreover, even if the service provider's system is compromised, the data would remain secure.

Homomorphic encryption may be used to preserve privacy while permitting some degree of external monitoring and control. For example, various mathematical and Boolean functions may be effected on encrypted files without decryption.

One common way to perform operations on encrypted data (such as, for example, performing machine learning operations) is to decrypt the encrypted data, perform the desired operations, and then re-encrypt the data, so that the data is decrypted during use, but encrypted as stored. While this may preserve the privacy of data in some cases, it leaves the data vulnerable to possible attack or disclosure while it is in use, and an entity attempting to breach the data would need only to change its target from the data in storage to the machine learning applications using the data. Further, the device performing the desired operations on the unencrypted data may be running additional applications accessed by multiple individuals or other entities, which increases the exposure of the unencrypted data. U.S. Pat. No. 11,374,736 discusses a system and method for fully homomorphic encryption in the context of blockchain transactions. Homomorphic computation software may contain if-statements, for-loops and while-loops, with the limitation that the number of times that the for-loops and while-loops are executed can be upper bounded by numbers that do not depend on encrypted data.

In order to ensure privacy of records in the distributed social network, fully homomorphic encryption (FHE) may be employed to interrogate and apply characteristics of record without revealing the content of the records.

See Homomorphic Encryption references.

11. Data Clustering

Data clustering is a process of grouping together data points having common characteristics. In automated processes, a cost function or distance function is defined, and data is classified is belonging to various clusters by making decisions about its relationship to the various defined clusters (or automatically defined clusters) in accordance with the cost function or distance function. Therefore, the clustering problem is an automated decision-making problem. The science of clustering is well established, and various different paradigms are available. After the cost or distance function is defined and formulated as clustering criteria, the clustering process becomes one of optimization according to an optimization process, which itself may be imperfect or provide different optimized results in dependence on the particular optimization employed. For large data sets, a complete evaluation of a single optimum state may be infeasible, and therefore the optimization process subject to error, bias, ambiguity, or other known artifacts.

In some cases, the distribution of data is continuous, and the cluster boundaries sensitive to subjective considerations or have particular sensitivity to the aspects and characteristics of the clustering technology employed. In contrast, in other cases, the inclusion of data within a particular cluster is relatively insensitive to the clustering methodology. Likewise, in some cases, the use of the clustering results focuses on the marginal data, that is, the quality of the clustering is a critical factor in the use of the system.

The ultimate goal of clustering is to provide users with meaningful insights from the original data, so that they can effectively solve the problems encountered. Clustering acts to effectively reduce the dimensionality of a data set by treating each cluster as a degree of freedom, with a distance from a centroid or other characteristic exemplar of the set. In a non-hybrid system, the distance is a scalar, while in systems that retain some flexibility at the cost of complexity, the distance itself may be a vector. Thus, a data set with 10,000 data points, potentially has 10,000 degrees of freedom, that is, each data point represents the centroid of its own cluster. However, if it is clustered into 100 groups of 100 data points, the degrees of freedom is reduced to 100, with the remaining differences expressed as a distance from the cluster definition. Cluster analysis groups data objects based on information in or about the data that describes the objects and their relationships. The goal is that the objects within a group be similar (or related) to one another and different from (or unrelated to) the objects in other groups. The greater the similarity (or homogeneity) within a group and the greater the difference between groups, the “better” or more distinct is the clustering.

In some cases, the dimensionality may be reduced to one, in which case all of the dimensional variety of the data set is reduced to a distance according to a distance function. This distance function may be useful, since it permits dimensionless comparison of the entire data set, and allows a user to modify the distance function to meet various constraints. Likewise, in certain types of clustering, the distance functions for each cluster may be defined independently, and then applied to the entire data set. In other types of clustering, the distance function is defined for the entire data set, and is not (or cannot readily be) tweaked for each cluster. Similarly, feasible clustering algorithms for large data sets preferably do not have interactive distance functions in which the distance function itself changes depending on the data. Many clustering processes are iterative, and as such produce a putative clustering of the data, and then seek to produce a better clustering, and when a better clustering is found, making that the putative clustering. However, in complex data sets, there are relationships between data points such that a cost or penalty (or reward) is incurred if data points are clustered in a certain way. Thus, while the clustering algorithm may split data points which have an affinity (or group together data points, which have a negative affinity, the optimization becomes more difficult.

Thus, for example, a semantic database may be represented as a set of documents with words or phrases. Words may be ambiguous, such as “apple”, representing a fruit, a computer company, a record company, and a musical artist. In order to effectively use the database, the multiple meanings or contexts need to be resolved. In order to resolve the context, an automated process might be used to exploit available information for separating the meanings, i.e., clustering documents according to their context. This automated process can be difficult as the data set grows, and in some cases the available information is insufficient for accurate automated clustering. On the other hand, a human can often determine a context by making an inference, which, though subject to error or bias, may represent a most useful result regardless.

In supervised classification, the mapping from a set of input data vectors to a finite set of discrete class labels is modeled in terms of some mathematical function including a vector of adjustable parameters. The values of these adjustable parameters are determined (optimized) by an inductive learning algorithm (also termed inducer), whose aim is to minimize an empirical risk function on a finite data set of input. When the inducer reaches convergence or terminates, an induced classifier is generated. In unsupervised classification, called clustering or exploratory data analysis, no labeled data are available. The goal of clustering is to separate a finite unlabeled data set into a finite and discrete set of “natural,” hidden data structures, rather than provide an accurate characterization of unobserved samples generated from the same probability distribution. In semi-supervised classification, a portion of the data are labeled, or sparse label feedback is used during the process.

Non-predictive clustering is a subjective process in nature, seeking to ensure that the similarity between objects within a cluster is larger than the similarity between objects belonging to different clusters. Cluster analysis divides data into groups (clusters) that are meaningful, useful, or both. If meaningful groups are the goal, then the clusters should capture the “natural” structure of the data. In some cases, however, cluster analysis is only a useful starting point for other purposes, such as data summarization. However, this often begs the question, especially in marginal cases; what is the natural structure of the data, and how do we know when the clustering deviates from “truth” ?

Many data analysis techniques, such as regression or principal component analysis (PCA) are not generally considered practical for large data sets. However, instead of applying the algorithm to the entire data set, it can be applied to a reduced data set consisting only of cluster prototypes. Depending on the type of analysis, the number of prototypes, and the accuracy with which the prototypes represent the data, the results can be comparable to those that would have been obtained if all the data could have been used. The entire data set may then be assigned to the clusters based on a distance function.

Clustering algorithms partition data into a certain number of clusters (groups, subsets, or categories). Important considerations include feature selection or extraction (choosing distinguishing or important features, and only such features); Clustering algorithm design or selection (accuracy and precision with respect to the intended use of the classification result; feasibility and computational cost; etc.); and to the extent different from the clustering criterion, optimization algorithm design or selection.

Finding nearest neighbors can require computing the pairwise distance between all points. However, clusters and their cluster prototypes might be found more efficiently. Assuming that the clustering distance metric reasonably includes close points, and excludes far points, then the neighbor analysis may be limited to members of nearby clusters, thus reducing the complexity of the computation.

There are generally three types of clustering structures, known as partitional clustering, hierarchical clustering, and individual clusters. The most commonly discussed distinction among different types of clusterings is whether the set of clusters is nested or unnested, or in more traditional terminology, hierarchical or partitional. A partitional clustering is simply a division of the set of data objects into non-overlapping subsets (clusters) such that each data object is in exactly one subset. If the clusters have sub-clusters, then we obtain a hierarchical clustering, which is a set of nested clusters that are organized as a tree. Each node (cluster) in the tree (except for the leaf nodes) is the union of its children (sub-clusters), and the root of the tree is the cluster containing all the objects. Often, but not always, the leaves of the tree are singleton clusters of individual data objects. A hierarchical clustering can be viewed as a sequence of partitional clusterings and a partitional clustering can be obtained by taking any member of that sequence; i.e., by cutting the hierarchical tree at a particular level.

A density-based cluster is a dense region of objects that is surrounded by a region of low density. A density-based definition of a cluster is often employed when the clusters are irregular or intertwined, and when noise and outliers are present. DBSCAN is a density-based clustering algorithm that produces a partitional clustering, in which the number of clusters is automatically determined by the algorithm. Points in low-density regions are classified as noise and omitted; thus, DBSCAN does not produce a complete clustering.

A prototype-based cluster is a set of objects in which each object is closer (more similar) to the prototype that defines the cluster than to the prototype of any other cluster. For data with continuous attributes, the prototype of a cluster is often a centroid, i.e., the average (mean) of all the points in the cluster. When a centroid is not meaningful, such as when the data has categorical attributes, the prototype is often a medoid, i.e., the most representative point of a cluster. For many types of data, the prototype can be regarded as the most central point. These clusters tend to be globular. K-means is a prototype-based, partitional clustering technique that attempts to find a user-specified number of clusters (K), which are represented by their centroids. Prototype-based clustering techniques create a one-level partitioning of the data objects. There are a number of such techniques, but two of the most prominent are K-means and K-medoid. K-means defines a prototype in terms of a centroid, which is usually the mean of a group of points, and is typically applied to objects in a continuous n-dimensional space. K-medoid defines a prototype in terms of a medoid, which is the most representative point for a group of points, and can be applied to a wide range of data since it requires only a proximity measure for a pair of objects. While a centroid almost never corresponds to an actual data point, a medoid, by its definition, must be an actual data point.

In the K-means clustering technique, we first choose K initial centroids, the number of clusters desired. Each point in the data set is then assigned to the closest centroid, and each collection of points assigned to a centroid is a cluster. The centroid of each cluster is then updated based on the points assigned to the cluster. We iteratively assign points and update until convergence (no point changes clusters), or equivalently, until the centroids remain the same. For some combinations of proximity functions and types of centroids, K-means always converges to a solution; i.e., K-means reaches a state in which no points are shifting from one cluster to another, and hence, the centroids don't change. Because convergence tends to b asymptotic, the end condition may be set as a maximum change between iterations. Because of the possibility that the optimization results in a local minimum instead of a global minimum, errors may be maintained unless and until corrected. Therefore, a human assignment or reassignment of data points into classes, either as a constraint on the optimization, or as an initial condition, is possible.

Hierarchical clustering techniques are a second important category of clustering methods. There are two basic approaches for generating a hierarchical clustering: Agglomerative and divisive. Agglomerative clustering merges close clusters in an initially high dimensionality space, while divisive splits large clusters. Agglomerative clustering relies upon a cluster distance, as opposed to an object distance. For example, the distance between centroids or medioids of the clusters, the closest points in two clusters, the further points in two clusters, or some average distance metric. Ward's method measures the proximity between two clusters in terms of the increase in the sum of the squares of the errors that results from merging the two clusters.

Agglomerative Hierarchical Clustering refers to clustering techniques that produce a hierarchical clustering by starting with each point as a singleton cluster and then repeatedly merging the two closest clusters until a single, all-encompassing cluster remains. Agglomerative hierarchical clustering cannot be viewed as globally optimizing an objective function. Instead, agglomerative hierarchical clustering techniques use various criteria to decide locally, at each step, which clusters should be merged (or split for divisive approaches). This approach yields clustering algorithms that avoid the difficulty of attempting to solve a hard combinatorial optimization problem. Furthermore, such approaches do not have problems with local minima or difficulties in choosing initial points. Agglomerative hierarchical clustering algorithms tend to make good local decisions about combining two clusters since they can use information about the pair-wise similarity of all points. However, once a decision is made to merge two clusters, it cannot be undone at a later time. This approach prevents a local optimization criterion from becoming a global optimization criterion.

In supervised classification, the evaluation of the resulting classification model is an integral part of the process of developing a classification model. Being able to distinguish whether there is non-random structure in the data is an important aspect of cluster validation.

U.S. Pat. No. 11,216,428 discusses a technology for identifying a reference-user, which exploits human interactions with an automated database system to derive insights about the data structures that are difficult, infeasible, or impossible to extract in a fully automated fashion, and to use these insights to accurately assess a risk adjusted value or cluster boundaries. The system monitors or polls a set of users, actively using the system or interacting with the outputs and providing inputs. The inputs may be normal usage, i.e., the user is acting in a goal directed manner, and providing inputs expressly related to the important issues, or explicit feedback, in which the user acts to correct or punish mistakes made by the automated system, and/or reward or reinforce appropriate actions. Through automated historical and action-outcome analysis, a subset of users, called “reference-users” are identified who demonstrate superior insight into the issue or sub-issue important to the system or its users. After the reference-users are identified, their actions or inputs are then used to modify or influence the data processing, such as to provide values or cluster the data. The adaptive algorithm is also able to demote reference-users to regular users. Additionally, because reference-user status may give rise to an ability to influence markets, some degree of random promotion and demotion is employed, to lessen the incentive to exploit an actual or presumed reference-user status. Indeed, the system may employ a genetic algorithm to continuously select appropriate reference-users, possibly through injection of “spikes” or spurious information, seeking to identify users that are able to identify the spurious data, as an indication of users who intuitively understand the data model and its normal and expected range. Thus, the system is continuously or sporadically doing three things—learning from reference-users and learning who is a reference-user, requesting more granulation/tagging and using that learning to cluster/partition the dataset for the ordinary users for the most contextually relevant insight.

Often, the reference-user's insights will be used to prospectively update the analytics, such as the distance function, clustering initial conditions or constraints, or optimization. However, in some cases, the adaptivity to the reference-user will only occur after verification. That is, a reference-user will provide an input which cannot contemporaneously be verified by the automated system. That input is stored, and the correspondence of the reference-user's insight to later reality then permits a model to be derived from that reference-user which is then used prospectively. This imposes a delay in the updating of the system, but also does not reveal the reference-user's decisions immediately for use by others. Thus, in a financial system, a reference-user might wish to withhold his insights from competitors while they are competitively valuable. However, after the immediate value has passed, the algorithm can be updated to benefit all. In an investment system, often a reference-user with superior insight would prefer that others follow, since this increases liquidity in the market, giving greater freedom to the reference-user.

A key issue is that a fully automated database analysis may be defined as an NP problem and in a massive database, the problem becomes essentially infeasible. However, humans tend to be effective pattern recognition engines, and reference-users may be selected that are better than average, and capable of estimating an optimal solution to a complex problem “intuitively”, that is, without a formal and exact computation, even if computationally infeasible. As stated above, some humans are better than others at certain problems, and once these better ones are identified, their insights may be exploited to advantage.

In clustering the database, a number of options are available to define the different groups of data. One option is to define persons who have a relationship to the data. That is, instead of seeking to define the context as an objective difference between data, the subjective relationships of users to data may define the clusters. This scenario redefines the problem from determining a cluster definition as a “topic” to determining a cluster definition as an affinity to a person. Note that these clusters will be quite different in their content and relationships, and thus have different application.

According to the present technology, the reference user may be considered an influencer, that is, one who provides recommendations or guidance to others. The clustering technology allows automated determination of optimal influencers for a respective user.

Optimal clustering is only one aspect of the use of a reference-user. More generally, the reference-user is a user that demonstrates uncommon insight with respect to an issue. For example, insight may help find clusters of data that tend to gravitate toward or away from each other and form clusters of similarity or boundaries. Clustering is at the heart of human pattern recognition, and involves information abstraction, classification and discrimination.

In some cases, a user wishes only results with high relevance, while in other cases, a user may wish to see a ranked list which extends to low relevance/low yield results. A list, however, is not the only way to organize results, and, in terms of visual outputs, these may be provided as maps (see 7,113,958 (Three-dimensional display of document set); 6,584,220 (Three-dimensional display of document set); 6,484,168 (System for information discovery); 6,772,170 (System and method for interpreting document contents), three or higher dimensional representations, or other organizations and presentations of the data. Thus, the distinction between the query or input processing, to access selected information from a database, and the presentation or output processing, to present the data to a user, is important. In some cases, these two functions are interactive, and for example, a context may be used preferentially during presentation rather than selection.

The user context may be determined in various ways, but in the case of persistent contexts, a user profile may be developed, and a reference-user selected with whom the user has some affinity, i.e., overlapping or correlated characteristics. There are multiple ways to designate the reference-user—the system designates the reference-user based on filtering a set of users to which reference-user best represents the responses and preferences of the set. This designation of reference-user comes from affinity, which could be network-affinity (users that are closely connected in the network in that context), knowledge-affinity (users that have superior expertise in that context), or skill-affinity (users possessing specialized skills in that context). It is noted that the reference-user is discussed as an actual single human user, but may be a hybrid of multiple users, machine assisted humans, or even paired guides.

The problem of defining the context of a user is then translated to the problem of finding a suitable reference-user or set of reference-users. In fact, the set of reference-users for a given user may have a high consistency, and as known in the field of social networking. That is, assuming that the word “friend” is properly defined, the universe of contexts for a user may be initially estimated by the contexts of interest to his or her identified friends. Such an estimation technology is best exploited in situations where error is tolerable, and where leakage of user-specific contexts is acceptable.

The value of an asset (poorly valued because of an inefficient market) is the actually realized value at duration of the final exit for a party, as opposed to price, which is the transaction value attributed at the trade or transaction today. When we use this in the context of digital assets such as domain names, Google rankings, ad placement etc. all of which classify as alternatives because they are traded in an inefficient market, then the price is the price paid by the advertiser. If the search engine makes its advertising placement decision based on the highest advertising price only, over the long term this results in poorer placement of items and attrition of eyeballs, in effect reduceng the value of the asset. Thus, understanding the difference between price and value, even directionally is critical. Accordingly, another aspect of the technology is to optimize advertisement placement into a natural result (that is, not influenced by the advertising) by referring to the clustering of the data as well as the context, such that the advertising is appropriate, inoffensive, and likely to increase the overall value of the enterprise, based on both the short term revenues from advertising, and the long term reputation and future cash flows that may be influenced. For example, an inappropriately placed ad will generate advertising revenue, but may disincentivize the advertiser to place ads in the future. An appropriately placed ad, which is contextually appropriate and topically appropriate, is more likely to result in a consumer-advertiser transaction, and thus lead to higher future advertising revenues, even if the present value of the ad is not the highest possible option.

A reference-user in this context may be a user who transacts with an advertiser. By matching users with a reference-user, within the appropriate context, it is more likely that the users will also transact with that advertiser, as compared to users in a different context. The ads may therefore be clustered as artificial insertions into the data universe, and clustered accordingly. When a user's corresponding reference-user(s) and cluster(s) of interest are identified, the advertisements within those clusters may then be considered for delivery to the user.

A user may seek a recommendation from a recommendation engine. The recommendation engine contains identifications and profiles of users who have posted recommendations/ratings, as well as profiles for users and usage feedback for the system. A user seeking to use the engine is presented (at some time) with a set of questions or the system otherwise obtains data inputs defining the characteristics of the user. In this case, the user characteristics generally define the context which is used to interpret or modify the basic goal of the user, and therefore the reference-user(s) for the user, though the user may also define or modify the context at the time of use. Thus, for example, a user seeks to buy a point-and-shoot camera as a gift for a friend. In this case, there are at least four different contexts to be considered: the gift, the gift giver, the gift receiver, and the gifting occasion. The likelihood of finding a single reference-user appropriate for each of these contexts is low, so a synthetic reference-user may be created, i.e., information from multiple users and gifts processed and exploited. The issues for consideration are: what kinds of cameras have people similarly situated to the gift giver (the user, in this case) had good experiences giving? For the recipient, what kinds of cameras do similar recipients like to receive? Based on the occasion, some givers and recipients may be filtered. Price may or may not be considered an independent context, or a modifier to the other contexts. The various considerations are used in a cluster analysis, in which recommendations relevant to the contexts may be presented, with a ranking according to the distance function from the “cluster definition”. As discussed above, once the clustering is determined, advertisements may be selected as appropriate for the cluster, to provide a subsidy for operation of the system, and also to provide relevant information for the user about available products.

Once again, the context is specific to the particular user and thus the right kind of camera for a first user to give a friend is not the same as the right kind of camera for a second user to give to a different friend; indeed, even if the friend is the same, the “right” kind of camera may differ between the two users. For example, if the first user is wealthier or other context differences.

See Data Clustering references.

12. Eye Tracking

U.S. Pat. No. 8,885,882 discloses a system for determining gaze direction using a 3D eyeball model, and in conjunction with a computer screen, determining what a subject is looking at. The overwhelming majority of gaze estimation approaches rely on glints (the reflection of light off the cornea) to construct 2D or 3D gaze models. Alternatively, eye gaze may be determined from the pupil or iris contours using ellipse fitting approaches. One can also leverage the estimated iris center directly and use its distance from some reference point (e.g., the eye corners) for gaze estimation. Indeed, the entire eye region may be segmented into the iris, sclera (white of the eye), and the surrounding skin; the resulting regions can then be matched pixel-wise with 3D rendered eyeball models (with different parameters). However, different subjects, head pose changes, and lighting conditions could significantly diminish the quality of the segmentation.

U.S. Pat. No. 8,077,217 provides an eyeball parameter estimating device and method, for estimating, from a camera image, as eyeball parameters, an eyeball central position and an eyeball radius which are required to estimate a line of sight of a person in the camera image. An eyeball parameter estimating device includes: a head posture estimating unit for estimating, from a face image of a person photographed by a camera, position data corresponding to three degrees of freedom (x-, y-, z-axes) in a camera coordinate system, of an origin in a head coordinate system and rotation angle data corresponding to three degrees of freedom (x-, y-, z-axes) of a coordinate axis of the head coordinate system relative to a coordinate axis of the camera coordinate system, as head posture data in the camera coordinate system; a head coordinate system eyeball central position candidate setting unit for setting candidates of eyeball central position data in the head coordinate system based on coordinates of two feature points on an eyeball, which are preliminarily set in the head coordinate system; a camera coordinate system eyeball central position calculating unit for calculating an eyeball central position in the camera coordinate system based on the head posture data, the eyeball central position candidate data, and pupil central position data detected from the face image; and an eyeball parameter estimating unit for estimating an eyeball central position and an eyeball radius based on the eyeball central position in the camera coordinate system so as to minimize deviations of position data of a point of gaze, a pupil center, and an eyeball center from a straight line joining original positions of the three pieces of position data.

U.S. Pat. No. 7,306,337, determines eye gaze parameters from eye gaze data, including analysis of a pupil-glint displacement vector from the center of the pupil image to the center of the glint in the image plane. The glint is a small bright spot near the pupil image resulting from a reflection of infrared light from a an infrared illuminator off the surface of the cornea.

U.S. Pat. Pub. 2011/0228975 determines a point-of-gaze of a user in three dimensions, by presenting a three-dimensional scene to both eyes of the user; capturing image data including both eyes of the user; estimating line-of-sight vectors in a three-dimensional coordinate system for the user's eyes based on the image data; and determining the point-of-gaze in the three-dimensional coordinate system using the line-of-sight vectors. It is assumed that the line-of-sight vector originates from the center of the cornea estimated in space from image data. The image data may be processed to analyze multiple glints (Purkinje reflections) of each eye.

U.S. Pat. No. 6,659,611 provides eye gaze tracking without calibrated cameras, direct measurements of specific users' eye geometries, or requiring the user to visually track a cursor traversing a known trajectory. One or more uncalibrated cameras imaging the user's eye and having on-axis lighting, capture images of a test pattern in real space as reflected from the user's cornea, which acts as a convex spherical mirror. Parameters required to define a mathematical mapping between real space and image space, including spherical and perspective transformations, are extracted, and subsequent images of objects reflected from the user's eye through the inverse of the mathematical mapping are used to determine a gaze vector and a point of regard.

U.S. Pat. No. 5,818,954 provides a method that calculates a position of the center of the eyeball as a fixed displacement from an origin of a facial coordinate system established by detection of three points on the face, and computes a vector therefrom to the center of the pupil. The vector and the detected position of the pupil are used to determine the visual axis.

U.S. Pat. No. 7,963,652 provides eye gaze tracking without camera calibration, eye geometry measurement, or tracking of a cursor image on a screen by the subject through a known trajectory. See also U.S. Pat. No. 7,809,160. One embodiment provides a method for tracking a user's eye gaze at a surface, object, or visual scene, comprising: providing an imaging device for acquiring images of at least one of the user's eves: modeling, measuring, estimating, and/or calibrating for the user's head position: providing one or more markers associated with the surface, object, or visual scene for producing corresponding glints or reflections in the user's eyes; analyzing the images to find said glints or reflections and/or the pupil: and determining eye gaze of the user upon a said one or more marker as indicative of the user's eye gaze at the surface, object, or visual scene.

By incorporating eye tracking into a display, broadcasters and/or advertisers can determine what (aspects of) advertisements are viewed by, and hence of interest to, a subject. Advertisers may verify attention to the advertisement, and/or use this information to focus their message on a particular subject or perceived interest of that subject, or to determine the cost per view of the advertisement, for example, but not limited to, cost per minute of product placements in television shows. For example, this method may be used to determine the amount of visual interest in an object or an advertisement, and that amount of interest used to determine a fee for display of the object or advertisement. The visual interest of a subject looking at the object or advertisement may be determined according to the correlation of the subject's optical axis with the object over a percentage of time that the object is on display. In addition, the method may be used to change the discourse with the television, or any appliance, by channeling user commands to the device or part of the display currently observed. In particular, keyboard or remote control commands can be routed to the appropriate application, window or device by looking at that device or window, or by looking at a screen or object that represents that device or window. In addition, TV content may be altered according to viewing patterns of the user, most notably by incorporating multiple scenarios that are played out according to the viewing behavior and visual interest of the user, for example, by telling a story from the point of view of the most popular character. Alternatively, characters in paintings or other forms of visual display may begin movement or engage in dialogue when receiving fixations from a subject user. Alternatively, viewing behavior may be used to determine what aspects of programs should be recorded, or to stop, mute or pause playback of a content source such as DVD and the like.

Eye contact sensing objects provide context for action, and therefore a programmable system may employ eye tracking or gaze estimation to determine context. A display may be presented, optimized to present different available contexts, from which the user may select by simply looking. When there are multiple contexts, or hybrid contexts, the user may have a complex eye motion pattern which can be used to determine complex contexts.

Eye tracking may also be used to control a user interface, and automatically acquire user interest, attention, and serve as inputs to the social network and/or adapt the user interface to the users visual interaction with the presentation.

See Eye Tracking references.

13. Biometric Auditing

US 20200257877 provides a method and apparatus for recognizing different users in a household without having the users to register or enroll their biometric features are provided. The apparatus may leverage sensors integrated with a remote-control device or connected to a media device and create pseudo-identity of a user when the user is consuming the content services from media device. When pseudo-identity is created, user's content preference, user's viewing habit, and user's viewing behavior with respect to the content, may be associated with more than one pseudo-identity to better identify the same user. In subsequent usage, personalized services, such as personalized guide & programs, user-selected preferences, targeted advertisement, or content recommendation, may be provided by service provider to user in a subtle and natural manner.

Oracle provides Moat analytics to provide analytics to publishers and advertisers. See, docs.oracle.com/en/cloudisaas/data-cloud/moat.html and linked pages.

A smartphone, Chromebook, laptop, desktop computer, etc., can also employ a biometric sensor, such as a video camera, fingerprint sensor, touchscreen, etc., to verify that a human viewer is available to receive the advertisement. In the case of a video camera, facial recognition software can identify the viewer, and or human recognition software can verify a moving human face. A higher level analysis may look for pulsatile variations from heartbeat, and gaze direction adjustment based on displaced objects.

See Biometric Auditing references.

14. Sentiment Analysis

Sentiment analysis (also known as opinion mining or emotion AI) is the use of natural language processing, text analysis, computational linguistics, and biometrics to systematically identify, extract, quantify, and study affective states and subjective information. Sentiment analysis is widely applied to voice of the customer materials such as reviews and survey responses, online and social media, and healthcare materials for applications that range from marketing to customer service to clinical medicine. With the rise of deep language models, such as RoBERTa, also more difficult data domains can be analyzed, e.g., news texts where authors typically express their opinion/sentiment less explicitly.

A basic task in sentiment analysis is classifying the polarity of a given text at the document, sentence, or feature/aspect level-whether the expressed opinion in a document, a sentence or an entity feature/aspect is positive, negative, or neutral. Advanced, “beyond polarity” sentiment classification looks, for instance, at emotional states such as enjoyment, anger, disgust, sadness, fear, and surprise. Precursors to sentimental analysis include the General Inquirer, which provided hints toward quantifying patterns in text and, separately, psychological research that examined a person's psychological state based on analysis of their verbal behavior. Subsequently, the method described in a patent by Volcani and Fogel, looked specifically at sentiment and identified individual words and phrases in text with respect to different emotional scales. A current system based on their work, called EffectCheck, presents synonyms that can be used to increase or decrease the level of evoked emotion in each scale.

Even though in most statistical classification methods, the neutral class is ignored under the assumption that neutral texts lie near the boundary of the binary classifier, several researchers suggest that, as in every polarity problem, three categories must be identified. Moreover, it can be proven that specific classifiers such as the Max Entropy and SVMs can benefit from the introduction of a neutral class and improve the overall accuracy of the classification. There are in principle two ways for operating with a neutral class. Either, the algorithm proceeds by first identifying the neutral language, filtering it out and then assessing the rest in terms of positive and negative sentiments, or it builds a three-way classification in one step. This second approach often involves estimating a probability distribution over all categories (e.g., naive Bayes classifiers as implemented by the NLTK). Whether and how to use a neutral class depends on the nature of the data: if the data is clearly clustered into neutral, negative and positive language, it makes sense to filter the neutral language out and focus on the polarity between positive and negative sentiments. If, in contrast, the data are mostly neutral with small deviations towards positive and negative affect, this strategy would make it harder to clearly distinguish between the two poles.

It is noted that in many cases, a sentiment is subjective, and without knowing the subjective context or bias, the sentiment analysis (SA) is potentially ambiguous or wrong. SA for social media data targeting therefore may include an analysis of the media to determine a vector of sentiment-sensitive classes, which can then be processed with a user sentiment profile, to determine affinity or aversion. For example, mention of political figures is polarizing, and evokes positive or negative sentiments from different people.

A different method for determining sentiment is the use of a scaling system whereby words commonly associated with having a negative, neutral, or positive sentiment with them are given an associated number on a −10 to +10 scale (most negative up to most positive) or simply from 0 to a positive upper limit such as +4. This makes it possible to adjust the sentiment of a given term relative to its environment (usually on the level of the sentence). When a piece of unstructured text is analyzed using natural language processing, each concept in the specified environment is given a score based on the way sentiment words relate to the concept and its associated score. This allows movement to a more sophisticated understanding of sentiment, because it is now possible to adjust the sentiment value of a concept relative to modifications that may surround it. Words, for example, that intensify, relax or negate the sentiment expressed by the concept can affect its score. Alternatively, texts can be given a positive and negative sentiment strength score if the goal is to determine the sentiment in a text rather than the overall polarity and strength of the text.

Subjectivity/objectivity identification is commonly defined as classifying a given text (usually a sentence) into one of two classes: objective or subjective. This problem can sometimes be more difficult than polarity classification. The subjectivity of words and phrases may depend on their context and an objective document may contain subjective sentences (e.g., a news article quoting people's opinions). Moreover, as mentioned by Su, results are largely dependent on the definition of subjectivity used when annotating texts. However, Pang showed that removing objective sentences from a document before classifying its polarity helped improve performance.

Emotions and sentiments are subjective in nature. The degree of emotions/sentiments expressed in a given text at the document, sentence, or feature/aspect level-to what degree of intensity is expressed in the opinion of a document, a sentence or an entity differs on a case-to-case basis. However, predicting only the emotion and sentiment does not always convey complete information. The degree or level of emotions and sentiments often plays a crucial role in understanding the exact feeling within a single class (e.g., ‘good’ versus ‘awesome’). Some methods leverage a stacked ensemble method for predicting intensity for emotion and sentiment by combining the outputs obtained and using deep learning models based on convolutional neural networks, long short-term memory networks and gated recurrent units.

Existing approaches to sentiment analysis can be grouped into three main categories: knowledge-based techniques, statistical methods, and hybrid approaches. Knowledge-based techniques classify text by affect categories based on the presence of unambiguous affect words such as happy, sad, afraid, and bored. Some knowledge bases not only list obvious affect words, but also assign arbitrary words a probable “affinity” to particular emotions. Statistical methods leverage elements from machine learning such as latent semantic analysis, support vector machines, “bag of words”, “Pointwise Mutual Information” for Semantic Orientation, semantic space models or word embedding models, and deep learning. More sophisticated methods try to detect the holder of a sentiment (i.e., the person who maintains that affective state) and the target (i.e., the entity about which the affect is felt). To mine the opinion in context and get the feature about which the speaker has opined, the grammatical relationships of words are used. Grammatical dependency relations are obtained by deep parsing of the text. Hybrid approaches leverage both machine learning and elements from knowledge representation such as ontologies and semantic networks in order to detect semantics that are expressed in a subtle manner, e.g., through the analysis of concepts that do not explicitly convey relevant information, but which are implicitly linked to other concepts that do so.

For a recommender system, sentiment analysis has been proven to be a valuable technique. A recommender system aims to predict the preference for an item of a target user. Mainstream recommender systems work on explicit data set. For example, collaborative filtering works on the rating matrix, and content-based filtering works on the meta-data of the items. In many social networking services or e-commerce websites, users can provide text review, comment or feedback to the items. These user-generated text provide a rich source of user's sentiment opinions about numerous products and items. Potentially, for an item, such text can reveal both the related feature/aspects of the item and the users' sentiments on each feature. The item's feature/aspects described in the text play the same role with the meta-data in content-based filtering, but the former are more valuable for the recommender system. Since these features are broadly mentioned by users in their reviews, they can be seen as the most crucial features that can significantly influence the user's experience on the item, while the meta-data of the item (usually provided by the producers instead of consumers) may ignore features that are concerned by the users. For different items with common features, a user may give different sentiments. Also, a feature of the same item may receive different sentiments from different users. Users' sentiments on the features can be regarded as a multi-dimensional rating score, reflecting their preference on the items.

Based on the feature/aspects and the sentiments extracted from the user-generated text, a hybrid recommender system can be constructed. There are two types of motivation to recommend a candidate item to a user. The first motivation is the candidate item have numerous common features with the users preferred items, while the second motivation is that the candidate item receives a high sentiment on its features. For a preferred item, it is reasonable to believe that items with the same features will have a similar function or utility. So, these items will also likely to be preferred by the user. On the other hand, for a shared feature of two candidate items, other users may give positive sentiment to one of them while giving negative sentiment to another. Clearly, the high evaluated item should be recommended to the user. Based on these two motivations, a combination ranking score of similarity and sentiment rating can be constructed for each candidate item.

See Sentiment Analysis references.

15. Virtual Private Network

A virtual private network (VPN) extends a private network across a public network and enables users to send and receive data across shared or public networks as if their computing devices were directly connected to the private network. The benefits of a VPN include increases in functionality, security, and management of the private network. It provides access to resources that are inaccessible on the public network and is typically used for remote workers. Encryption is common, although not an inherent part of a VPN connection. en.wikipedia.org/wiki/Virtual_private_network

A VPN is created by establishing a virtual point-to-point connection through the use of dedicated circuits or with tunneling protocols over existing networks. A VPN available from the public Internet can provide some of the benefits of a wide area network (WAN). From a user perspective, the resources available within the private network can be accessed remotely.

The present social network may employ VPN technology to secure communications between user, and also in communications involving central servers and infrastructure components.

Tunnel endpoints must be authenticated before secure VPN tunnels can be established. User-created remote-access VPNs may use passwords, biometrics, two-factor authentication or other cryptographic methods. Network-to-network tunnels often use passwords or digital certificates. Depending on the VPN protocol, they may store the key to allow the VPN tunnel to establish automatically, without intervention from the administrator. Data packets are secured by tamper proofing via a message authentication code (MAC), which prevents the message from being altered or tampered without being rejected due to the MAC not matching with the altered data packet. Tunneling protocols can operate in a point-to-point network topology that would theoretically not be considered a VPN because a VPN by definition is expected to support arbitrary and changing sets of network nodes. But since most router implementations support a software-defined tunnel interface, customer-provisioned VPNs often are simply defined tunnels running conventional routing protocols. Mobile virtual private networks are used in settings where an endpoint of the VPN is not fixed to a single IP address, but instead roams across various networks such as data networks from cellular carriers or between multiple Wi-Fi access points without dropping the secure VPN session or losing application sessions.

See Virtual Private Network references.

16. Artificial Intelligence

The various elements of the system may be analyzed and processed using artificial intelligence (AI). The AI may be used to determine media content, characteristics, biases, and parameters that may have no corresponding linguistic label, that are nevertheless relevant for use in the network. Likewise, users may be profiled, and their preference and non-preference characteristics, and value functions determined. AI (alone, or in conjunction with a coprocessor) may perform optimizations, including economic optimizations of various types. In general, a significant task of the social network is to form relationships between people, and exploit those relationships to present content and ads to users.

The AI may be used to create content, characterize content, characterize ads, characterize users, characterize influencers, recommend ads, content, and linkages, optimize pricing, and the like. Interesting options arise when the AI assumes multiple roles, such as generation of content, recommending content, and pricing of content. If one seeks objective results, this overlap may be a significant conflict of interest and problematic. In an entertainment context, however, a paramount issue is user satisfaction, not objective truth.

A large language model (LLM) is a computerized language model, embodied by an artificial neural network using an enormous amount of “parameters” (“neurons” in its layers with up to tens of millions to billions “weights” between them), that are (pre-)trained on many GPUs in relatively short time due to massive parallel processing of vast amounts of unlabeled texts containing up to trillions of tokens (parts of words) provided by corpora such as Wikipedia Corpus and Common Crawl, using self-supervised learning or semi-supervised learning, resulting in a tokenized vocabulary with a probability distribution. LLMs can be upgraded by using additional GPUs to (pre-)train the model with even more parameters on even vaster amounts of unlabeled texts.

The transformer algorithm, either unidirectional (such as used by GPT models) or bidirectional (such as used by BERT model), allows for such massively parallel processing.

In an implicit way, LLMs have acquired an embodied knowledge about syntax, semantics and “ontology” inherent in human language corpora, but also inaccuracies and biases present in the corpora. en.wikipedia.org/wiki/Large_language_model. The basic idea of LLMs, which is to start with a neural network as black box with randomized weights, using a simple repetitive architecture and (pre-)training it on a large language corpus, was not feasible until the 2010s when use of GPUs had enabled massively parallelized processing, which has gradually replaced the logical AI approach that has relied on symbolic programs.

All transformers have the same primary components: Tokenizers, which convert text into machine-readable symbols known as tokens; Embedding layers, which convert the machine-readable symbols into semantically meaningful representations; and Transformer layers, which carry out the reasoning capabilities of the models. Transformer layers come in two types known as encoders and decoders. While the transformer from the original paper was composed of both encoder layers and decoder layers, subsequent work has also explored encoder-only architectures (BERT) and decoder-only architectures (GPT) as well. While all three have their benefits and uses, decoder-only models are the dominant form at very large scales due to being substantially more efficient to train at scale.

LLMs are mathematical functions whose input and output are lists of numbers. Consequently, words must be converted to numbers. In general, a LLM uses a separate tokenizer. A tokenizer maps between texts and coded tokens (e.g., lists of integers). The tokenizer is generally adapted to the entire training dataset first, then frozen, before the LLM is trained. A common choice is byte pair encoding. Another function of tokenizers is text compression, which saves compute. Common words or phrases like “where is” can be encoded into one token, instead of 7 characters. The OpenAI GPT series uses a tokenizer where 1 token maps to around 4 characters, or around 0.75 words, in common English text. Uncommon English text is less predictable, thus less compressible, thus requiring more tokens to encode.

The output of a LLM is a probability distribution over its vocabulary. This is usually implemented as follows: Upon receiving a text, the bulk of the LLM outputs a vector, which is passed through a softmax function.

An LLM is a language model, which is not an agent as it has no goal, but it can be used as a component of an intelligent agent. The ReAct (“Reason+Act”) method constructs an agent out of an LLM, using the LLM as a planner. The LLM is prompted to “think out loud”. Specifically, the language model is prompted with a textual description of the environment, a goal, a list of possible actions, and a record of the actions and observations so far. It generates one or more thoughts before generating an action, which is then executed in the environment. The Reflexion method constructs an agent that learns over multiple episodes. At the end of each episode, the LLM is given the record of the episode, and prompted to think up “lessons learned”, which would help it perform better at a subsequent episode. These “lessons learned” are given to the agent in the subsequent episodes. Monte Carlo tree search can use an LLM as rollout heuristic. When a programmatic world model is not available, an LLM can also be prompted with a description of the environment to act as world model.

For open-ended exploration, an LLM can be used to score observations for their “interestingness”, which can be used as a reward signal to guide a normal (non-LLM) reinforcement learning agent. Alternatively, it can propose increasingly difficult tasks for curriculum learning. Instead of outputting individual actions, an LLM planner can also construct “skills”, or functions for complex action sequences. The skills can be stored and later invoked, allowing increasing levels of abstraction in planning. LLM-powered agents can keep a long-term memory of its previous contexts, and the memory can be retrieved in the same way as Retrieval Augmented Generation. Multiple such agents can interact socially.

Multimodality means “having several modalities”, and a “modality” means a type of input, such as video, image, audio, text, proprioception, etc. There have been many AI models trained specifically to ingest one modality and output another modality, such as AlexNet for image to label, visual question answering for image-text to text, and speech recognition for speech to text. A common method to create multimodal models out of an LLM is to “tokenize” the output of a trained encoder.

See Artificial Intelligence references.

### BRIEF DESCRIPTION OF THE DRAWINGS

FIG. 1 shows the home screen according to a preferred embodiment.

FIG. 2 shows a user profile screen according to the preferred embodiment.

FIG. 3 shows an analytics home page according to a preferred embodiment.

FIG. 4 shows a schematic view of an exemplary system according to the prior art.

### DETAILED DESCRIPTION OF THE PREFERRED EMBODIMENT

### Example 1

A social network system is provided. A feature of a preferred embodiment of the social network is that users of the network are compensated based on their role and value added to the network. Each user has an account, associated with a cryptocurrency token wallet. That wallet is authenticated per user, preferably with a user biometric identification option to authenticate transactions, i.e., incoming payment and outbound payments.

Another feature of a preferred embodiment is that it is built on a hybrid centralized control/decentralized ledger transactional basis. This means that should the centralized control fail, such as might occur during an outage, upgrade, or high usage, the social network would still operate, though without certain functions. Likewise, in some cases, an open API permits modes of operation in a totally decentralized fashion, or in a totally centralized fashion.

In the centralized use case, the social network may operate similarly to Meta (FaceBook), YouTube, Twitter, Instagram, etc., with one difference being an economic distribution formula that provides compensation to users for “excess” advertising revenues, and to referrers/influencers for their role in the network. When the social network operates in a decentralized mode, payments are made using a decentralized cryptocurrency, with smart contracts or similar technology used to ensure collection and distribution of revenues according to an algorithm. In the decentralized case, the system operate off a decentralized content database, which may have different records than a centralized database. Typically, because of delays in distribution and potential orphan records due to attrition, the decentralized database may be effectively incomplete for a user at a given time. On the other hand, new content may be released into the P2P network, and not immediately acquired and indexed by the central social network database, so the P2P may have newer content. Ads more typically are syndicated through a central provider, and newer campaigns may be dominated by the central database. Older campaigns may still be maintained on the decentralized system, but may become stale and unfunded.

One advantage of a decentralized system is that it can operate without providing a central repository of personal information. Therefore, users may be more willing to permit use of personal information if that information is not amassed in a central database. As a result, the user profiles used by the decentralized system implementation may be richer and more accurate than the corresponding central database records. In a decentralized system, some aspects of the system may be implemented at the destination node, or in a nearby node using homomorphic encryption. Thus, detailed and accurate profiles may be exploited without high risk of privacy breach. On the other hand, a centralized user profile may have limited and inaccurate information, and therefore ad targeting and content links and recommendations may differ. Both central and distributed implementations may coexist, and their results merged, with deduplication and consistency enhanced.

On the other hand, a centralized system facilitates use of large language models (LLM), that would be infeasible for a distributed network and processing system. The LLM, such as a GPT, can target ads and content to a user, synthesize entertainment content, perform complex sentiment analysis, assist a user in composing media, assist a user in comprehending media (e.g., translation, summarization, simplification, complexification, etc.), and form (discover) links between new users and media. The LLM can be provided by third parties, and therefore are centralized in the sense that the function is performed by a service provider on behalf of multiple users, and need not be controlled by the social network provider.

Ad views are preferably verified both for view/consumption of the ad, and identification of the user experiencing the ad. For example, a camera facing the user may capture face (for biometric authentication) and attention (e.g., eye gaze direction).

The users initially authenticate themselves with a certification authority, which may be a financial institution, professional authentication organization (PAO), professional employment organization (PEO), or other organization. Typically, the certification authority will also be responsible for tax compliance reporting, though this may be a separate function.

A user may be biometrically authenticated with an image, video, iris pattern, blood vessel pattern, photoplethysmographic pattern, fingerprint, voice pattern, keystroke temporal pattern, etc.

The user authentication serves an additional purpose from transactions. That is, assuring advertisers or sponsors that the target of the message corresponds to the profile targeted.

Further, user authentication also ensures accountability for user activity within the social network.

The social network provides content for the user, in the form of premium media (i.e., media for which the creator seeks compensation), advertising/sponsored segments, non-premium media (media for which the creator does not particularly demand compensation), messages between users, and other types of content. The user interface has an open API, and therefore is not limited to predetermined media types and usage models.

The social media platform operates using tokens, which represent values of a cryptocurrency, which are authenticated. The tokens may be locked into use only in the social media platform, or a freely transferrable cryptocurrency. While a central implementation of the system does not require use of cryptocurrencies, since a central ledger may suffice, a hybrid or system benefits from use of a decentralized ledger.

As an alternate to a typical cryptocurrency, points issued as part of an incentive program may be used as a medium of exchange. However, since these must be transacted electronically in a system that supports decentralized operation, this embodiment corresponds to an asset-backed stablecoin.

The tie-in to commercial transaction systems provides another dimension to the system, distinct from advertising, i.e., commercial transactions engaged in by users regardless of promotions. The platform may provide users with opportunities to engage in transactions, and receive a commission for sales or other transactions. The commission may be allocated between the network operator, and a portion of the user's network, in the manner of a multilevel marketing (MLM) system allocation, or on another basis. Payment back to the user is not required, since it simply amounts to a discount. In some cases, there may be an interaction between an advertiser and a transaction, especially where the advertiser is unrelated to the transaction counterparty. That is, an advertiser may obtain credit for “inspiring” a user to engage in a transaction, even if the transaction is not with the advertiser.

While all aspects of the system may operate on a distributed ledger, and financial transactions adopt the typical attributes of a cryptocurrency blockchain-immutability, protection against double spending, pseudonomy, etc. On the other hand, the social network data may violate one or more of these precepts, and in particular the immutability factor may be reconsidered. One way to achieve this is to host encrypted information or external references on the blockchain, so that the recordation on the blockchain does not irrevocably reveal the referenced information.

The social network has a proprietor, which seeks compensation for usage of the social media platform, and exercises some control over its nature and operation. Therefore, the proprietor has access to the wallet (or transactions involving the wallet), and can deduct a portion based on its terms of service. In other cases, the sponsor compensates the user, and adds to the wallet balance.

The social network has an interface for content providers to present premium media content for use within the network. This may be stored in a central server, in a decentralized database, a hybrid store, or in any other fashion. The user interface includes a media player that implements a DRM system, and limits consumption or export of premium media content based on compliance with a smart contract. The smart contract is typically a token payment for use of the media, though there may be other types of smart contracts. The smart contract is executed based on a gas fee or other pre-paid or post-paid basis. Typically, the key for unlocking usage of the premium content is provided or enabled in a blockchain transaction, though a central server may also release the content. The unlocking blockchain event typically provides payment to the respective content, though in some cases the compensation to the content provider is made after completion of the playback, or dependent on an amount of content consumed.

Typically, the content provider establishes a fixed fee for content consumption, but in other cases, the cost is dependent on the user characteristics (e.g., per a user profile), amount of subsidy or commission on the payment (which may be established in a competitive process between advertisers), time, location, etc. An oracle may provided needed information for the smart contract to execute for the correct transaction amount. The ad price may be predetermined for all users, dependent ion user characteristics, dependent on context (i.e., media content consumed in proximity to the ad), dependent on consummation of a transaction with the advertiser, or other basis.

The social network has a sponsor interface that permits interested parties, such as advertisers, to promote content or messages, and pay a subsidy for operation of the system. Advertising is not the only model, and for example, an employer may seek to avoid all advertising and simply pay for desirable content usage by employees. The typical sponsor does have a message for presentation to a user, in consideration of a token transaction which will be discussed in more detail below. The sponsor typically presents its messages as part of a campaign, with defined budget, target demographics or profiles, restrictions on linked content, and the like. The campaign is typically implemented as a prefunded smart contract, with a declining token balance until exhaustion. Alternately, a sponsor may individually process and serve ads to users.

The social network has a user interface, typically associated with a content browser/media player, and the user wallet, which stores user preferences and manages a user profile. The user profile is typically adaptively defined based on usage, along with demographic characteristics. In order to preserve privacy, the user profile may be used by third parties, or the advertiser campaign definition may be used by the user interface, in a homomorphic or fully homomorphic encryption (FHE) system, which permits testing of the profile for certain characteristics, without release of the profile itself in unencrypted form. This FHE system can be implemented in the media player if the encrypted campaign profile is distributed to the users, in a distributed virtual machine, or at a sponsor platform if the encrypted user profile is conveyed to the sponsor. A typical advertisement will target users based on a set of criteria, and a valuation of the sponsorship may depend on the user, the targeted advertisement, the sponsored content, and competitive pressures.

The targeting of a user by data is similar to a content addressable memory (CAM). en.wikipedia.org/wiki/Content-addressable_memory.

The user interface may perform a combinatorial optimization to optimize various metrics, for example, system revenues, network operator revenues, user revenues, user satisfaction/satiation, etc.

To the extent that user revenues are optimized (maximized), and to the extent that the subsidies exceed the payments to others, the user's wallet token balance will increase. The user may also permit a deficit, if the acceptable advertisements do not fully pay for the content consumed. A user interface screen permits the user to adjust parameters of the compensation scheme.

In the social network, users form social relationships, which are stored in a metadata profile by the sponsor, content player, central server (e.g., the proprietor platform), and/or within a blockchain or distributed database. The social relationships are used in a recommender or collaborative filter, to present proposals to the user for various types of content, information, or messages, and accepting explicit or implicit feedback from the user to update the user preference profile and social relationship profile.

As mentioned, the distributed database may be distinct from a cryptocurrency blockchain. On the other hand, some information may reside on the blockchain. For example, public portions or encrypted private portions of a user profile may reside on blockchain. Ad targeting information, or a hash of such information, for a user (distinct from a user profile) may also be on-blockchain.

According to a typical blockchain, data is immutable. However, user profiles and targeting information may change over time. Therefore, rather than including the user profile or targeting information within the blockchain, an reference to a file repository may be provided, wherein the file repository may be updated in an authenticated manner or marked as invalid/superseded.

The advantage of an integration of blockchain and various profiles is that they may be used in conjunction, and therefore the distributed ledger transaction authorization process may be consolidated, with a single set of transactions employed instead of a plurality of distinct transactions.

When one user promotes content to another user, and the user the promoting user is preferably compensated for its referral. While for regular users, the referral fees are likely small, but for so-called influencers, the fees may be significant. The incentive for influencers is to reliably promote content which is preferred by users, since users who dislike content from an influencer will demote them on their ranking, and users who like content promoted by an influencer will consume more of the promoted content.

Where multiple referrers promote content to a user, an algorithm may be used to distribute the share, i.e., first to promote only, pro rata share, weighting based on relationship to user, etc.

When the user interacts with the media player/browser social network interface, he or she logs in, and a biometric monitoring process is initiated, to ensure that content, especially advertisements, are actually viewed by the user. If the advertisement is not perceived by the user, the subsidy fails. If a user is not present for premium content, the smart contract may include a rule that reduces or eliminates payment.

The user interface includes, among other social network functions, a ranked or prioritized list of content to be selected by the user. The interface may include other elements, such as static ads, and unranked content, along with icons, chat features, wallet management, etc. The ranked list is derived from available content and metadata associated with the content, which is then processed along with a user preference profile and user demographic profile to determine a ranking, which may result from a biased weighting according to a subjective distance function or clustering process. The ranking is adaptive to user action, predicted mood, diurnal variations, group settings (multiple concurrent viewers); available content and sponsorship opportunities, and social trends.

The user interaction typically includes a selection of particular content to view. The metadata for the content specifies the transaction value for viewing of the content, which may be fixed or variable. The client software receives a user control parameter that determines acceptability of advertising, amount of advertising, etc. A mini-automated auction occurs between competing advertisers with acceptable advertisements, for sponsored content acceptable to the advertisers, and the advertisement is delivered to the user. Upon delivery, or upon play/verified viewing, a blockchain transaction is consummated and payment made to the user's wallet or to an intermediate wallet or maintained in escrow within a smart contract. The premium content playback triggers another transaction, which draws from the user's wallet or the escrow. In each transaction, a portion, e.g., 25%, is provided to the proprietor. A further portion is allocated to the referrer. In the typical case, the advertising subsidy balances the premium content cost plus shares for proprietor and referrer.

Another option is a subscription, in which the content provider, or an aggregator that licenses from content providers, charge a fee for a term of service. In that case, the aggregator or content provider charges a fee before or after the term, to either the user wallet or advertising syndicator. The subscription model works with referrals also, with the referral fee paid from gross transaction value proceeds.

In order to preserve privacy, communications throughout the system may be encrypted end-to-end, preferably with two-layer security with a TLS style transport layer encryption and an application layer encryption. The security may also be performed using transcription (untrusted intermediary). Kerberos-style authentication and key exchange may be employed. en.wikipedia.org/wiki/Kerberos_(protocol)

The system allows various degrees of external control, e.g., censorship, from none at all (e.g., prohibition of limitations) to strict control. This may be implemented by way of a mask or rule set which is implemented in parallel or within the DRM platform. Content filtering may also implemented using AI, such as an LLM, to classify the themes of the message or content, and limit all or a portion of the message or content from reaching the user. The AI may be use to amplify or suppress selected topics, and reformulate communications (exploiting the transformer component of the GPT). As a censor, GPT may provide a flexible and nuanced guardian for a user, and is especially useful in the context of fiction and entertainment. Hallucination propensity of transformer architecture makes application to non-fiction and news problematic.

Note that typically, the DRM platform operates after accessing the protected content, while censorship is best applied before links to the content are provided, i.e., within the recommender or display formatter.

For example, while freedom from censorship and anonymizing virtual private network communications are features desired by some users, others prefer or require a walled garden with curated content and centrally controlled interactions. For example, where the system and method is deployed in a business environment, and especially a regulated business, all communications may be authenticated and logged, content filtered for malicious content, secret exfiltration attempts, user time-wasting, phishing attempts, etc. The business may prefer to avoid all third party advertising, and simply pay (self-subsidize) network usage. Another example are religious or social groups that wish to implement a biased system toward their own beliefs or norms, and to exclude, tag, or diminish opposing beliefs. While as a general feature for all users, such control is undesired, a user or group of users may voluntarily accept external limitations. A still further example are persons or groups for which the embedded payment scheme is unacceptable. For example, business employees should normally not be paid by third parties for work supposedly on behalf of the employer. Likewise, some persons may wish to remain anonymous on the network, and regulations in the US for users which accept payment transactions require compliance with know-your-customer regulations. Therefore, a user may simply wish to opt-out of accepting payments, and therefore heightened authentication requirements.

The user interface software is preferably modular, with a rich API, that allows extensions of the functionality and customization of both functionality and aesthetics. The modules are preferably cryptographically signed and authenticated with a closed and secure supervisor, which acts as a hypervisor that executes a virtual machine and associated operating system isolated from other processes executing on the same platform. This helps avoid malicious additions and helps protect the system from other malicious processes, especially those modules that directly or indirectly influence the distributed ledger transactions. The supervisor, in turn, may be authenticated by a trusted platform module. The system architecture may provide a hypervisor executing on a host platform, which in turn executes an operating system such as Linux or Android, which in turn provide security features and execute modules or apps. The memory access, interrupts, and I/O requests all pass through the hypervisor.

In an exemplary embodiment, the user interface has a number of elements:

Views: display will show the number of views for the content.

Likes: This will display the number of likes. This will also be a button that will be clickable. Use of the like button may be associated with a cost or fee, to incentivize a genuine like, and disincentivize fraudulent manipulation of ratings. This also allows the content creator that has uploaded the original content to gain rewards from likes, in addition to referrals to new viewers. The cost of “likes” and corresponding “dislikes” if supported may be at the marginal cost according to an economic analysis, above or below. At the marginal cost, the user has no economic incentive to shade or bias the review. With a cost above or below the marginal cost, there may economic incentives distinct from the truthfulness of the label. Likes and dislikes may carry different costs.

A user may also be economically incentivized to review content. In order to avoid spurious reviews, the user may have an associated reputation that has an economic value dependent on the reliability of reviews and applied labels. If the user maintains a good reputation, the reviews are more valuable, and the reputation score increases. A user with a poor reputation may receive no incentive, or may be charged to present its opinion. The reliability of the review, and therefore the reputation may be assessed after the review is published, by other users, or by an automated process. A penalty may be imposed on misreporting users by reducing the reputation, and/or forfeiting the economic incentive previously provided. A user with a poor prior reputation, but who is later determined to be reliable may receive a retroactive incentive.

The reliability of a review may be subjective, and therefore the issue of a subjective classification by a user is not whether the review or classification is validated by all other users, but rather whether there are a substantial class of users for whom the label is predictive of later outcome.

Unlike: This will show how many users have not liked or have actively disliked the content. Note that this may be a consolidated score, the disliked and not liked may be separately provided.

Share: This will allow the users of the platform to share any content and earn a split or commission. The users that shares the content is able to earn rewards from likes/shares/comments/views. There may be a cost or fee associated with using the share button. Note that the shared content may lead to later revenues for the sharing user based on referral commissions.

Profile: This button takes the user to their personal account profile for editing and viewing including biography, description, profile picture, and other editable features.

Duration: This shows the duration of the content if applicable.

Comment: This button allows the users to comment on content and reply. Use of this button incurs a cost or fee. Comment will have a like/unlike/share buttons to allow the uploader to earn rewards.

Ads may be placed on the comment pages. This allows rewards to be earned from viral comments.

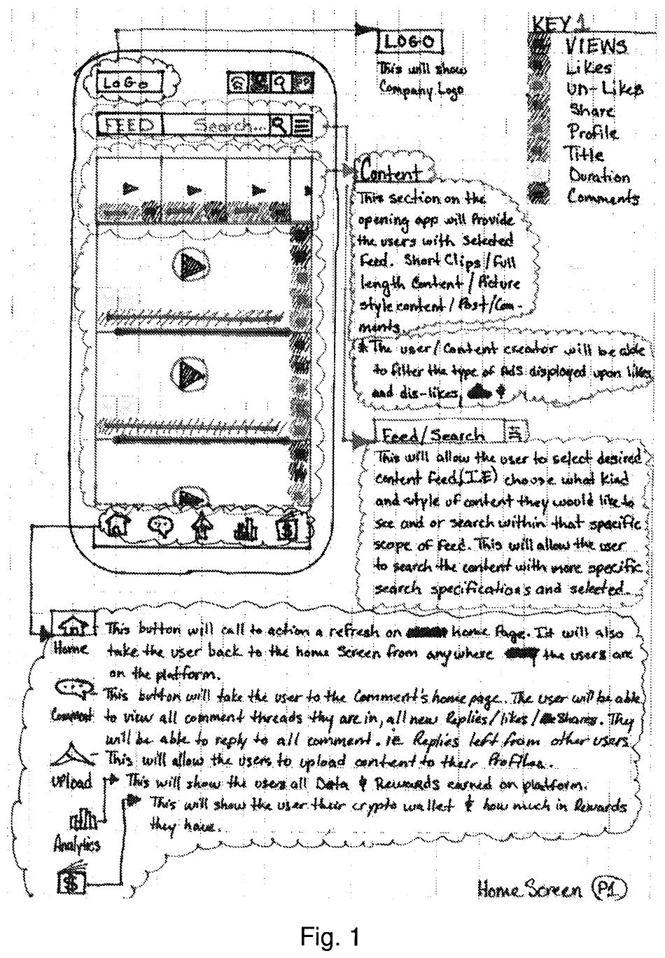

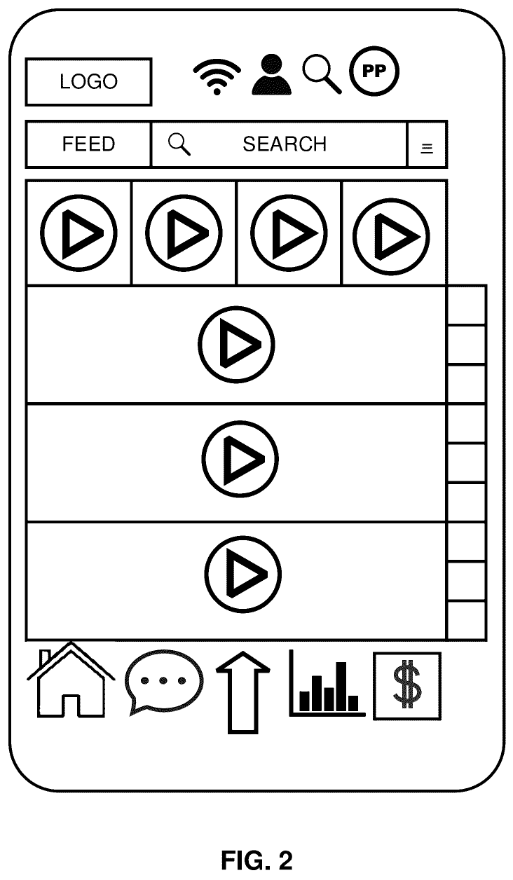

FIG. 1 shows the home screen. A content frame provides users with the selected feed, such as short clips, full length content, ads, images, text, comments and replies (blog), etc. Filters are available, both explicit and intelligent. The feed/search pane allows user to select desired content feeds, but name or label, style, social relationships, recommender, social recommendations, etc.

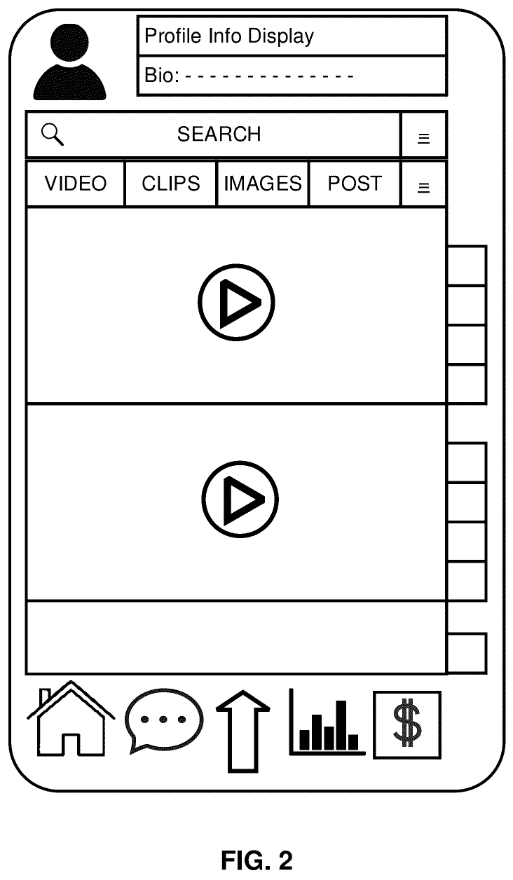

FIG. 2 shows the profile screen. On this screen user may edit and manage access to their user profile, including image, text, affinity groups, biography, demographics, and curriculum vitae, etc. The user profile generally represents an explicit basis for targeting of content and ads, and may include the ability to test sensitivity of system at large to changes in the profile. The user may therefore tweak explicit profile settings to favor desirable content and disfavor undesirable content. In some cases, the profile is authenticated. For example, the profile may indicate that the user is a qualified investor under SEC rules, and the data that backs this determination may be authenticated to ensure regulatory compliance. In the more general sense, an originator of communications may designate communications (and the economic streams associated with the communications) to be limited to authenticated recipients. Authentication may derive from objective data sources, such as government demographic databases, third party authentication, and internal system authentication.

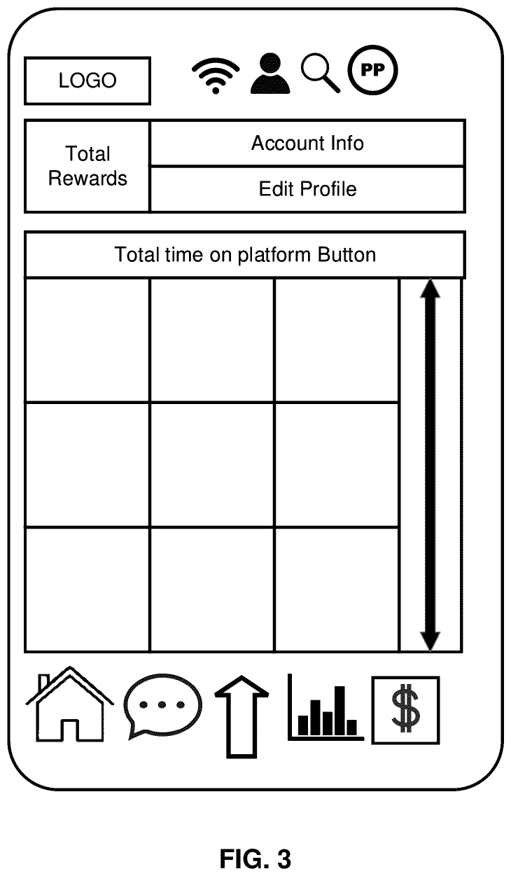

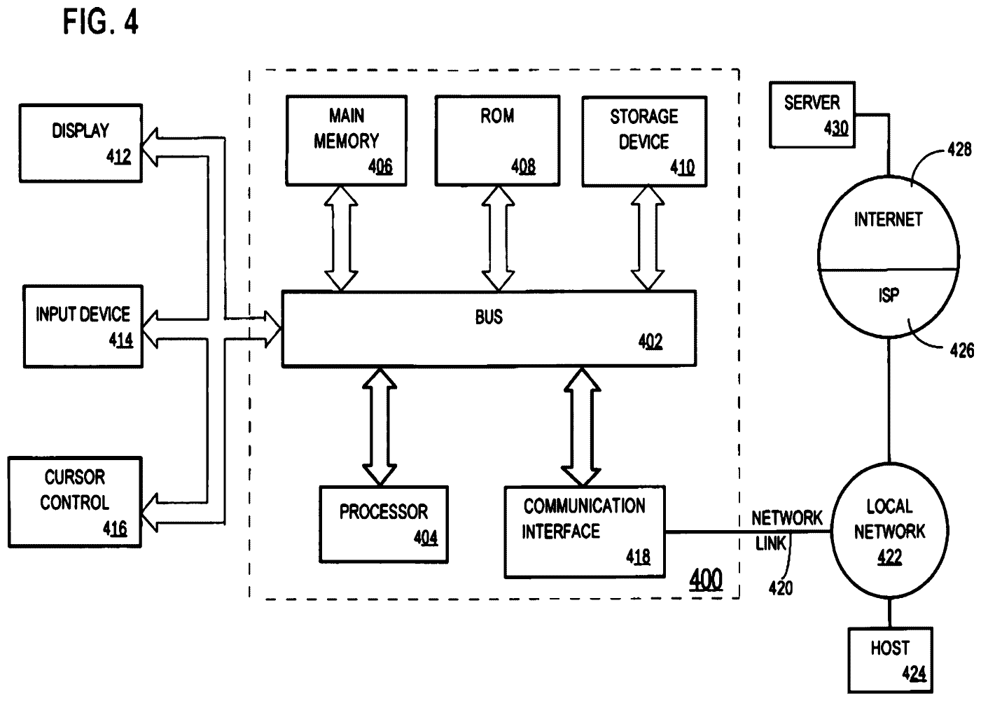

FIG. 3 shows the analytics home page that permits a user to understand usage of the services. In this case, the user may conduct various investigations, some of which are free, and others which incur usage fees. For example, active searches of other users' profiles may be discouraged by a fee, and also provide a revenue stream for users whose profiles or other activity are accessed or used. The analytics home page also provides access to implicit user profiles, which are typically statistical in nature, such as metrics, statistical distributions, clustering with other users, e.g., for implementing a collaborative filter, etc. The analytics page may also inform the user regarding personal or population trends, revenue opportunities within the network, and overcompetitive opportunities which may have reduced revenues due to competitive forces. This may help maintain diversity within the network, and reduce duplication and emulation of prior trends, making use of the network services more interesting.

Hardware Overview

FIG. 1 (see U.S. Pat. No. 7,702,660, issued to Chan, expressly incorporated herein by reference), shows a block diagram that illustrates a computer system 400 upon which an embodiment may be implemented. Computer system 400 includes a bus 402 or other communication mechanism for communicating information, and a processor 404 coupled with bus 402 for processing information. Computer system 400 also include a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further may also include a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions. Thus, embodiments are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine. Non-transitory information is stored as instructions or control information.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an Integrated Services Digital Network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In this description, several preferred embodiments were discussed. Persons skilled in the art will, undoubtedly, have other ideas as to how the systems and methods described herein may be used. It is understood that this broad invention is not limited to the embodiments discussed herein. Rather, the invention is limited only by the following claims.

The system may be implemented by a hardware component, a software component and/or a combination of a hardware component and a software component. For example, the device and components described in the embodiments may be implemented using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processor may perform an operating system (OS) and one or more software applications executed on the OS.

See, 11636475; 20230066272; 20230069223; 20210176202; 20210042854; 20200342546; 20200294135; 20200151270; 20200074566; 20190019208; 20180225693; 20160321676.

Furthermore, the processor may access, store, manipulate, process and generate data in response to the execution of software. For convenience of understanding, one processing device has been illustrated as being used, but a person having ordinary skill in the art may understand that the processor may include a plurality of processing elements and/or a plurality of types of processing elements. For example, the processor may include a plurality of processors or a single processor and a single controller. Furthermore, a different processing configuration, such as a parallel processor, is also possible.

Software may include a computer program, code, an instruction or a combination of one or more of them and may configure a processor so that it operates as desired or may instruct the processor independently or collectively. The software and/or data may be embodied in a machine, component, physical device, virtual equipment or computer storage medium or device of any type in order to be interpreted by the processor or to provide an instruction or data to the processor. The software may be distributed to computer systems connected over a network and may be stored or executed in a distributed manner. The software and data may be stored in one or more computer-readable recording media.

The method according to the embodiments may be implemented in the form of a program instruction executable by various computer means and stored in a computer-readable recording medium. In this case, the medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. An example of the medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the medium may include an app store in which apps are distributed, a site in which other various pieces of software are supplied or distributed, and recording media and/or store media managed in a server.

The invention may be used as a method, system or apparatus, as programming codes for performing the stated functions and their equivalents on programmable machines, and the like. The aspects of the invention are intended to be separable, and may be implemented in combination, subcombination, and with various permutations of embodiments. Therefore, the various disclosure herein, including that which is represented by acknowledged prior art, may be combined, subcombined and permuted in accordance with the teachings hereof, without departing from the spirit and scope of the invention.

As described above, although the embodiments have been described in connection with the limited embodiments and drawings, those skilled in the art may modify and change the embodiments in various ways from the description. For example, proper results may be achieved although the above descriptions are performed in order different from that of the described method and/or the aforementioned elements, such as the system, configuration, device, and circuit, are coupled or combined in a form different from that of the described method or replaced or substituted with other elements or equivalents.

Other embodiments will be apparent to those skilled in the art from consideration of the specification and practice of the invention disclosed herein. It is intended that the specification and examples be considered as exemplary only, with a true scope of the invention being indicated by the following claims.

### REFERENCES APPENDIX

(Each of the following reference is incorporated by reference in its entirety.)

1. Social Networks

AU-2006240230; AU-2006240230; AU-2008259934; AU-2010200995; AU-2010200995; AU-2011250794; AU-2011250794; AU-2012272664; AU-2014200286; AU-2014354663; AU-2017210638; BR-112015013565; BR-112019012818; BR-P11005204; CA-2605995; CA-2605995; CA-2672735; CA-2750189; CA-2844801; CA-2849158; CA-2931623; CA-3111211; CN-102831536; EP-1894152; EP-2177010; EP-2177010; EP-2486742; EP-2523466; EP-2583231; EP-2724309; EP-2742470; EP-2759156; EP-2788907; EP-3074944; EP-3844703; IN-2009MN02228; IN-2013DN00508; IN-201727014824; JP-2010086382; JP-2013171418; JP-2013528886; JP-2014029705; JP-2017027613; JP-5143691; JP-5775833; JP-6022448; KR-101161617; KR-101270649; KR-101350735; KR-101585863; KR-101609521; KR-101656030; KR-101751679; KR-101777332; KR-101789922; KR-101841657; KR-101907321; KR-101956844; KR-102115104; KR-102242942; KR-102356332; KR-20100031588; KR-20100037525; KR-20120026859; KR-20130139836; KR-20140091516; KR-20140100661; KR-20150023308; KR-20150032415; KR-20150041674; KR-20150062180; KR-20150064119; KR-20150088732; KR-20150126734; KR-20150132461; KR-20160113685; KR-20170018930; KR-20190022128; KR-20190054681; KR-20200084506; KR-20210025958; KR-20210072000; U.S. Ser. No. 10/019,728; U.S. Ser. No. 10/031,969; U.S. Ser. No. 10/037,545; U.S. Ser. No. 10/078,694; U.S. Ser. No. 10/083,234; U.S. Ser. No. 10/176,491; U.S. Ser. No. 10/180,982; U.S. Ser. No. 10/186,003; U.S. Ser. No. 10/210,533; U.S. Ser. No. 10/325,325; U.S. Ser. No. 10/354,337; U.S. Ser. No. 10/360,581; U.S. Ser. No. 10/409,862; U.S. Ser. No. 10/459,977; U.S. Ser. No. 10/460,339; U.S. Ser. No. 10/482,496; U.S. Ser. No. 10/726,472; U.S. Ser. No. 10/740,722; U.S. Ser. No. 10/776,815; U.S. Ser. No. 10/943,212; U.S. Ser. No. 10/943,254; U.S. Ser. No. 10/945,016; U.S. Ser. No. 10/963,903; U.S. Ser. No. 10/997,633; U.S. Ser. No. 11/004,112; U.S. Ser. No. 11/004,139; U.S. Ser. No. 11/010,786; U.S. Ser. No. 11/068,929; U.S. Ser. No. 11/113,333; U.S. Ser. No. 11/182,427; U.S. Ser. No. 11/238,480; U.S. Ser. No. 11/308,544; US-20060242554; US-20060287916; US-20070130015; US-20080033776; US-20080109306; US-20080195664; US-20080200154; US-20080201225; US-20080201386; US-20080207137; US-20080207182; US-20080228575; US-20080300974; US-20080313042; US-20090094108; US-20090132373; US-20090144139; US-20090183179; US-20100042487; US-20100223119; US-20100241576; US-20100287282; US-20100311496; US-20110066506; US-20110137975; US-20110225417; US-20110258024; US-20110258026; US-20110276376; US-20110276505; US-20110276506; US-20110276582; US-20110282728; US-20110313944; US-20120029990; US-20120047008; US-20120066056; US-20120208512; US-20120214416; US-20120246085; US-20120278209; US-20120278821; US-20120290374; US-20120290399; US-20120290431; US-20120290432; US-20120290433; US-20120290446; US-20120290448; US-20120290553; US-20120310755; US-20130041952; US-20130046605; US-20130064527; US-20130097093; US-20130124283; US-20130144605; US-20130166580; US-20130290204; US-20130297403; US-20130304527; US-20130325734; US-20130332389; US-20140033288; US-20140040067; US-20140052671; US-20140095406; US-20140101016; US-20140114737; US-20140195316; US-20140222702; US-20140258469; US-20140278942; US-20140279064; US-20140310079; US-20140316903; US-20140317112; US-20140325030; US-20140337120; US-20140342659; US-20140356845; US-20150019550; US-20150025980; US-20150025981; US-20150058104; US-20150078247; US-20150087224; US-20150120872; US-20150127565; US-20150148115; US-20150149544; US-20150150046; US-20150245084; US-20150312607; US-20150312643; US-20150317666; US-20150324748; US-20160007052; US-20160066187; US-20160092967; US-20160150078; US-20160196620; US-20160239881; US-20170032406; US-20170032407; US-20170039590; US-20170083960; US-20170132720; US-20170154359; US-20170161685; US-20170262451; US-20170277701; US-20170323308; US-20180011942; US-20180053221; US-20180053222; US-20180053224; US-20180060981; US-20180158089; US-20180300744; US-20180300767; US-20180322597; US-20180357248; US-20180365250; US-20190087785; US-20190138553; US-20190141021; US-20190279240; US-20190279241; US-20190281030; US-20190354552; US-20190362438; US-20190378152; US-20200027108; US-20200051117; US-20200193475; US-20200302465; US-20200302510; US-20200357080; US-20200387923; US-20210065131; US-20210133790; US-20210158297; US-20210174426; US-20210326964; US-20210366056; US-20210409800; US-20220012285; US-20220084137; U.S. Pat. Nos. 8,219,134; 8,321,321; 8,494,903; 8,548,821; 8,554,635; US-Muriai-201.1-115-8671021; U.S. Pat. Nos. 8,805,270; 8,849,945; 8,855,469; 8,856,019; 8,943,514; 8,995,815; 9,064,010; 9,064,011; 9,117,196; 9,124,650; 9,135,665; 9,170,718; 9,256,855; 9,595,068; 9,697,280; 9,715,693; 9,760,916; 9,795,888; 9,801,071; WO-2006115908; WO-2006138484; WO-2007139857; WO-2008072093; WO-2008151076; WO-2009023867; WO-2010018580; WO-2010078188; WO-2010129966; WO-2011041916; WO-2011130442; WO-2011140253; WO-2011140256; WO-2011140259; WO-2011140261; WO-2011159875; WO-2012116213; WO-2012162568; WO-2012178130; WO-2013020219; WO-2013023185; WO-2013040708; WO-2013055770; WO-2013070343; WO-2013086513; WO-2013108073; WO-2014018808; WO-2014068404; WO-2014085650; WO-2014108762; WO-2014148821; WO-2015077105; WO-2015080762; WO-2015081302; WO-2015131126; WO-2016049632; WO-2016086229; WO-2018045212; WO-2018106619; WO-2018227020; WO-2019039682; WO-2020046906; WO-2020227562;
Himelboim, Itai, and Guy J. Golan. “A social networks approach to viral advertising: The role of primary, contextual, and low influencers.” Social Media+Society 5, no. 3 (2019): 2056305119847516.
Campbell, Colin, Carla Ferraro, and Sean Sands. “Segmenting consumer reactions to social network marketing.” European Journal of Marketing (2014).
Cox, Shirley. “Online social network member attitude toward online advertising formats.” (2010).
Fainmesser, Itay P., and Andrea Galeotti. “The market for online influence.” American Economic Journal: Microeconomics 13, no. 4 (2021): 332-72.
Kelly, Louise, Gayle Kerr, and Judy Drennan. “Avoidance of advertising in social networking sites: The teenage perspective.” Journal of interactive advertising 10, no. 2 (2010): 16-27.
Roelens, Iris, Philippe Baecke, and Dries F. Benoit. “Identifying influencers in a social network: The value of real referral data.” Decision Support Systems 91 (2016): 25-36.
Zeljko, Dominik, Bozidar Jakovic, and Ivan Strugar. “New Methods Of Online Advertising: Social Media Influencers.” Annals of DAAAM & Proceedings 29 (2018).

2. Targeted Advertising

10002396; 10003926; 10007915; 10019757; 10022613; 10022614; 10023117; 10025779; 10026098; 10028211; 10031969; 10032190; 10033738; 10033832; 10037406; 10038756; 10038933; 10043022; 10043035; 10045055; 10046228; 10049392; 10050959; 10051304; 10055745; 10055751; 10057609; 10059342; 10063267; 10068261; 10073530; 10074100; 10074235; 10075754; 10078694; 10078837; 10078838; 10083234; 10085074; 10089592; 10089630; 10096043; 10097698; 10104411; 10110633; 10117290; 10121186; 10123078; 10127247; 10127564; 10129211; 10129506; 10129604; 10133878; 10134095; 10140305; 10140627; 10147284; 10152756; 10153908; 10156965; 10157390; 10157503; 10162816; 10163084; 10165128; 10165316; 10169751; 10169774; 10171476; 10180982; 10191972; 10192241; 10192244; 10195513; 10198747; 10198942; 10200834; 10203673; 10203712; 10204316; 10210502; 10212251; 10217139; 10222771; 10223679; 10223707; 10223713; 10231077; 10232869; 10235681; 10237368; 10248956; 10250757; 10250928; 10250932; 10250951; 10257569; 10257581; 10264029; 10269034; 10269048; 10270490; 10275746; 10275785; 10275959; 10282741; 10282914; 10285008; 10290018; 10291710; 10298877; 10298980; 10304147; 10306314; 10311451; 10318983; 10321259; 10322313; 10324435; 10324591; 10324598; 10325287; 10325323; 10325325; 10325596; 10332108; 10332506; 10333720; 10338913; 10339553; 10339554; 10340976; 10341485; 10346552; 10346839; 10354265; 10354267; 10354337; 10356199; 10359783; 10360578; 10360591; 10361802; 10361859; 10366378; 10366438; 10368117; 10368255; 10375514; 10375759; 10380237; 10380585; 10380617; 10382631; 10387891; 10387976; 10395256; 10395289; 10402853; 10405057; 10409862; 10410237; 10410241; 10411939; 10412430; 10412523; 10417401; 10417440; 10417658; 10419405; 10425674; 10430806; 10430823; 10437898; 10438199; 10438226; 10438240; 10438299; 10440097; 10445286; 10445754; 10445784; 10448103; 10452863; 10453070; 10453100; 10459977; 10460349; 10471231; 10474963; 10475060; 10476848; 10477033; 10482091; 10482477; 10482495; 10482506; 10482559; 10484755; 10488878; 10489433; 10489754; 10489797; 10489821; 10492204; 10497022; 10497037; 10497055; 10499477; 10504118; 10504150; 10504193; 10506098; 10506299; 10510082; 10511580; 10516441; 10517141; 10521604; 10521813; 10523772; 10524307; 10528963; 10528981; 10530877; 10531163; 10532268; 10534819; 10534821; 10536859; 10540690; 10540776; 10546326; 10546332; 10547886; 10552869; 10555050; 10560583; 10561349; 10565553; 10565607; 10565616; 10565623; 10565625; 10567380; 10567820; 10568552; 10572679; 10572684; 10574614; 10579825; 10580032; 10580036; 10580043; 10581842; 10582593; 10585942; 10586253; 10589699; 10592549; 10592930; 10595100; 10599981; 10600009; 10600041; 10602225; 10606353; 10606916; 10607219; 10607244; 10607247; 10607252; 10607608; 10609434; 10614471; 10621550; 10621653; 10623802; 10628825; 10628842; 10631035; 10635263; 10638178; 10638361; 10641861; 10643164; 10643235; 10643266; 10644891; 10645547; 10650313; 10650398; 10650412; 10652354; 10657543; 10657544; 10661111; 10664484; 10665237; 10665339; 10665340; 10666904; 10667154; 10671806; 10672018; 10672031; 10673847; 10678233; 10684350; 10684599; 10685367; 10685481; 10699108; 10699271; 10699310; 10701054; 10706176; 10706233; 10706395; 10708732; 10709388; 10712738; 10713387; 10713669; 10721336; 10726158; 10726401; 10726472; 10732621; 10733273; 10733623; 10740722; 10740796; 10742821; 10743054; 10743125; 10747837; 10747858; 10748648; 10754334; 10762061; 10762236; 10762538; 10763922; 10769495; 10769646; 10769701; 10771247; 10771936; 10773124; 10775755; 10776831; 10778852; 10782659; 10783559; 10783573; 10789590; 10790056; 10790995; 10791225; 10795350; 10795393; 10795394; 10796343; 10799157; 10802452; 10803461; 10803482; 10803512; 10805803; 10810357; 10810388; 10810628; 10812150; 10812274; 10812617; 10817855; 10818033; 10819613; 10820163; 10824140; 10825059; 10826748; 10827371; 10831452; 10831924; 10831925; 10832008; 10832310; 10832738; 10839320; 10839424; 10839426; 10839514; 10839955; 10841535; 10846433; 10846728; 10846762; 10848974; 10853591; 10853630; 10853842; 10853845; 10853855; 10855337; 10856115; 10858024; 10860731; 10860815; 10860995; 10861039; 10861045; 10861063; 10861112; 10863238; 10866584; 10866798; 10867221; 10873577; 10878418; 10878448; 10878480; 10880252; 10881335; 10885102; 10885466; 10887426; 10887647; 10891785; 10892932; 10893138; 10893152; 10896436; 10897877; 10902023; 10902226; 10902469; 10902473; 10902485; 10902852; 10904261; 10905337; 10908602; 10909508; 10909529; 10910882; 10911103; 10911794; 10911808; 10911894; 10915578; 10915921; 10915924; 10917382; 10921801; 10922501; 10922716; 10926135; 10929772; 10932084; 10932134; 10936957; 10937060; 10937407; 10938548; 10939229; 10942913; 10943231; 10944546; 10945022; 10949880; 10949893; 10951956; 10952029; 10956922; 10956924; 10957416; 10958607; 10958948; 10959033; 10963333; 10965668; 10965997; 10966073; 10966076; 10967255; 10971121; 10973081; 10977565; 10977666; 10979528; 10979745; 10979849; 10980450; 10980451; 10980453; 10983514; 10984016; 10984064; 10984405; 10986403; 10990879; 10991002; 10991009; 10991463; 10997251; 10997620; 10997632; 10997662; 10997675; 10998003; 11003179; 11003525; 11004072; 11004092; 11004139; 11005857; 11006159; 11009865; 11010553; 11010787; 11010794; 11010946; 11012228; 11017211; 11017212; 11017213; 11017214; 11017329; 11017411; 11017482; 11017488; 11017490; 11017602; 11023441; 11025626; 11026317; 11029656; 11029657; 11029680; 11030274; 11030341; 11030425; 11030860; 11032164; 11032518; 11036215; 11036370; 11037141; 11037197; 11039021; 11039185; 11042717; 11042878; 11044254; 11048248; 11049094; 11049132; 11055501; 11055675; 11055707; 11055734; 11055739; 11062054; 11062347; 11062357; 11067976; 11070890; 11074061; 11074360; 11074495; 11074598; 11074617; 11074640; 11080425; 11080742; 11080777; 11089348; 11092955; 11093293; 11093922; 11093972; 11099024; 11099465; 11100087; 11100479; 11100534; 11102255; 11106199; 11106711; 11107115; 11108627; 11109084; 11109090; 11109114; 11109756; 11112784; 11112785; 11113333; 11113727; 11113745; 11113754; 11113897; 11114742; 11115821; 11120370; 11120401; 11120475; 11121858; 11122316; 11122852; 11126171; 11126173; 11126748; 11127048; 11128636; 11130042; 11131989; 11132403; 11132625; 11132701; 11134086; 11134311; 11137752; 11138280; 11138418; 11138631; 11138640; 11139081; 11139954; 11139976; 11140103; 11140450; 11144047; 11146380; 11146546; 11151220; 11151549; 11151585; 11151607; 11156998; 11157943; 11159839; 11159851; 11159909; 11163931; 11163983; 11163984; 11164666; 11165911; 11169511; 11169538; 11170399; 11170402; 11170430; 11171521; 11171781; 11171792; 11175653; 11176566; 11176571; 11177937; 11177941; 11178204; 11178289; 11178503; 11178507; 11182427; 11182819; 11184446; 11188615; 11188909; 11189368; 11190232; 11194318; 11194319; 11195057; 11195073; 11195195; 11196747; 11197047; 11197050; 11199835; 11199837; 11200284; 11200499; 11205197; 11205926; 11206245; 11207584; 11209813; 11210659; 11210669; 11210693; 11210699; 11212126; 11213711; 11213758; 11215980; 11216750; 11216853; 11218324; 11219026; 11221613; 11222062; 11222142; 11222185; 11222346; 11222370; 11223470; 11223860; 11227304; 11227310; 11231705; 11232466; 11232478; 11232580; 11237546; 11238478; 11238491; 11238522; 11240025; 11243521; 11243522; 11244313; 11244377; 11245946; 11249714; 11250493; 11250621; 11256242; 11256243; 11256777; 11256778; 11257073; 11257151; 11258983; 11262737; 11265326; 11265685; 11269318; 11269319; 11269891; 11270346; 11275929; 11276014; 11276022; 11276115; 11277390; 11277412; 11277490; 11277656; 11277703; 11280042; 11281202; 11282101; 11282107; 11285372; 11290292; 11295318; 11296895; 11296935; 11297459; 11297469; 11298017; 11301670; 11301948; 11303738; 11304025; 11307565; 11308276; 11308524; 11308754; 11310865; 11311342; 11314935; 11315150; 11315546; 11317253; 11320588; 11327475; 11327551; 11327735; 11328213; 11328315; 11329825; 11334063; 11334802; 11334875; 11334876; 11334897; 11336654; 11336743; 11340589; 11341650; 11341818; 11343098; 11347205; 11347206; 11347215; 11348178; 11350310; 11353851; 11353852; 11354434; 11354706; 11354712; 11356819; 11361242; 11363062; 11366531; 11368498; 11372936; 11373207; 20010020236; 20010034762; 20010034763; 20010043364; 20010044736; 20010044741; 20010044751; 20010047408; 20020019769; 20020019774; 20020022551; 20020026359; 20020026510; 20020029166; 20020032608; 20020035573; 20020038289; 20020038337; 20020038456; 20020049792; 20020059584; 20020066033; 20020069148; 20020072967; 20020087525; 20020091575; 20020108121; 20020111912; 20020116510; 20020120554; 20020124182; 20020124249; 20020128908; 20020133402; 20020133490; 20020138848; 20020144262; 20020147645; 20020151992; 20020178053; 20020178447; 20020193095; 20020194601; 20030003988; 20030014412; 20030023598; 20030028432; 20030033194; 20030033587; 20030037041; 20030040959; 20030040962; 20030046130; 20030046162; 20030050832; 20030061610; 20030063072; 20030067554; 20030070167; 20030079222; 20030093314; 20030093792; 20030101449; 20030101451; 20030110503; 20030121040; 20030130899; 20030133702; 20030134648; 20030140023; 20030149603; 20030149738; 20030206710; 20030208483; 20030225614; 20030227479; 20040003398; 20040003400; 20040005046; 20040029567; 20040030932; 20040031856; 20040032393; 20040039642; 20040039784; 20040044565; 20040053602; 20040054569; 20040054588; 20040073482; 20040073488; 20040078809; 20040093328; 20040098449; 20040103032; 20040107125; 20040133480; 20040145777; 20040163101; 20040198386; 20040199575; 20040215564; 20040226051; 20040249708; 20040255150; 20040260470; 20040261095; 20040266457; 20040267611; 20040267805; 20040268383; 20040268389; 20040268390; 20050021404; 20050021713; 20050033657; 20050043060; 20050060232; 20050060641; 20050065855; 20050086112; 20050091165; 20050091685; 20050091686; 20050097599; 20050108776; 20050114210; 20050120033; 20050120034; 20050129201; 20050131727; 20050131757; 20050131762; 20050132060; 20050141864; 20050144067; 20050144641; 20050149398; 20050154627; 20050165766; 20050188328; 20050198677; 20050222906; 20050251820; 20050267809; 20050267810; 20050267820; 20050283796; 20050288953; 20060008069; 20060026060; 20060026061; 20060026062; 20060026063; 20060026064; 20060026067; 20060029093; 20060031114; 20060031376; 20060036491; 20060059259; 20060069749; 20060085408; 20060100892; 20060117046; 20060122879; 20060122886; 20060129458; 20060136393; 20060143084; 20060150216; 20060155398; 20060158756; 20060161952; 20060173985; 20060178966; 20060178967; 20060178968; 20060178970; 20060178972; 20060178975; 20060184886; 20060190616; 20060195376; 20060200253; 20060200258; 20060200259; 20060200260; 20060205566; 20060206912; 20060211369; 20060211493; 20060212900; 20060212901; 20060212904; 20060224505; 20060229904; 20060229976; 20060235790; 20060235791; 20060242000; 20060242017; 20060242046; 20060242047; 20060242048; 20060242049; 20060242050; 20060242051; 20060242554; 20060252547; 20060253330; 20060259359; 20060259360; 20060265489; 20060276201; 20060277116; 20060277117; 20060282319; 20060287915; 20060288023; 20060293954; 20060293955; 20070004511; 20070005428; 20070005429; 20070005795; 20070013691; 20070013692; 20070015564; 20070016476; 20070016500; 20070016501; 20070022032; 20070022459; 20070024613; 20070033531; 20070035548; 20070035549; 20070038559; 20070038567; 20070038643; 20070038728; 20070038931; 20070043730; 20070050264; 20070053513; 20070060099; 20070060109; 20070060114; 20070060129; 20070060136; 20070060173; 20070061195; 20070061197; 20070061198; 20070061211; 20070061229; 20070061242; 20070061243; 20070061244; 20070061245; 20070061246; 20070061247; 20070061266; 20070061300; 20070061301; 20070061302; 20070061303; 20070061317; 20070061328; 20070061331; 20070061332; 20070061333; 20070061334; 20070061335; 20070061336; 20070061363; 20070061393; 20070061487; 20070067206; 20070067207; 20070067208; 20070067209; 20070067297; 20070073582; 20070073614; 20070073717; 20070073718; 20070073719; 20070073722; 20070073723; 20070076728; 20070078741; 20070078835; 20070082707; 20070088656; 20070088801; 20070094042; 20070099658; 20070099659; 20070100648; 20070100650; 20070100651; 20070100652; 20070100653; 20070100805; 20070100806; 20070106526; 20070106536; 20070106537; 20070106551; 20070106557; 20070106576; 20070106750; 20070106751; 20070106752; 20070106753; 20070106754; 20070112624; 20070112627; 20070112660; 20070112762; 20070116036; 20070116037; 20070118420; 20070118533; 20070121843; 20070121882; 20070124239; 20070125860; 20070130001; 20070130117; 20070136185; 20070136283; 20070136533; 20070143260; 20070143715; 20070146322; 20070150986; 20070156505; 20070156509; 20070156519; 20070156677; 20070162348; 20070162456; 20070162501; 20070167150; 20070168214; 20070168246; 20070168354; 20070168461; 20070174183; 20070179841; 20070185721; 20070192165; 20070192294; 20070192318; 20070198305; 20070198485; 20070203725; 20070203817; 20070203828; 20070203971; 20070204308; 20070206507; 20070206748; 20070206773; 20070208619; 20070208630; 20070208789; 20070209054; 20070209065; 20070219940; 20070220553; 20070226114; 20070226130; 20070233513; 20070233565; 20070239724; 20070242661; 20070244732; 20070250370; 20070250901; 20070260635; 20070261072; 20070268299; 20070276740; 20070280441; 20070282683; 20070282959; 20070287473; 20070288427; 20070288953; 20070291739; 20070294126; 20070298885; 20070299795; 20080000964; 20080004884; 20080004948; 20080004950; 20080004951; 20080004990; 20080005069; 20080005076; 20080005086; 20080005264; 20080005313; 20080009268; 20080010045; 20080015877; 20080015933; 20080016526; 20080021783; 20080028066; 20080028067; 20080033799; 20080033800; 20080033801; 20080033802; 20080033803; 20080033804; 20080033959; 20080034088; 20080040151; 20080040740; 20080045234; 20080046312; 20080046369; 20080046437; 20080046471; 20080052162; 20080052343; 20080059220; 20080059305; 20080059308; 20080059390; 20080059997; 20080075099; 20080082381; 20080087732; 20080088581; 20080088886; 20080091341; 20080091505; 20080091506; 20080091526; 20080091527; 20080091611; 20080092055; 20080092065; 20080092084; 20080097823; 20080097842; 20080097843; 20080098420; 20080103795; 20080103877; 20080103896; 20080103897; 20080103898; 20080103901; 20080103903; 20080103952; 20080120168; 20080126178; 20080126476; 20080133126; 20080133392; 20080134043; 20080134101; 20080140491; 20080140522; 20080141110; 20080160956; 20080162157; 20080172344; 20080177558; 20080195425; 20080195444; 20080195445; 20080195645; 20080195664; 20080200153; 20080200154; 20080200160; 20080201225; 20080201283; 20080201305; 20080201310; 20080201311; 20080201321; 20080201386; 20080201413; 20080201733; 20080207137; 20080207182; 20080209229; 20080212539; 20080214148; 20080214149; 20080214150; 20080214151; 20080214152; 20080214153; 20080214154; 20080214155; 20080214156; 20080214157; 20080214162; 20080214166; 20080214204; 20080215428; 20080215429; 20080215434; 20080215437; 20080215475; 20080215557; 20080215623; 20080221934; 20080221947; 20080221970; 20080221971; 20080221972; 20080221973; 20080221982; 20080222015; 20080222016; 20080222027; 20080222283; 20080228538; 20080228539; 20080228540; 20080228541; 20080228556; 20080228580; 20080228606; 20080228607; 20080228635; 20080242279; 20080243680; 20080244091; 20080249833; 20080249876; 20080255897; 20080255954; 20080262901; 20080262917; 20080263633; 20080270165; 20080270220; 20080270579; 20080276270; 20080276271; 20080281687; 20080281794; 20080288310; 20080288328; 20080288405; 20080294584; 20080300986; 20080301727; 20080301746; 20080301750; 20080304518; 20080305775; 20080305778; 20080306815; 20080306816; 20080306830; 20080318678; 20080318679; 20080319781; 20080319786; 20080319787; 20080319796; 20080319844; 20080319855; 20080319857; 20080320029; 20080320030; 20090006083; 20090006180; 20090006363; 20090006442; 20090006457; 20090006458; 20090012864; 20090018910; 20090024546; 20090029687; 20090037364; 20090037949; 20090043604; 20090043682; 20090043683; 20090044246; 20090045260; 20090048907; 20090048910; 20090048911; 20090048912; 20090048913; 20090048914; 20090048917; 20090049090; 20090055246; 20090055249; 20090063250; 20090063268; 20090063273; 20090063491; 20090066722; 20090070180; 20090070238; 20090070273; 20090070379; 20090070806; 20090076914; 20090076915; 20090082037; 20090083150; 20090099927; 20090099930; 20090100354; 20090100459; 20090100496; 20090106105; 20090106673; 20090112648; 20090112653; 20090119172; 20090124241; 20090125321; 20090125383; 20090125462; 20090125517; 20090125585; 20090132353; 20090132440; 20090138328; 20090138333; 20090138335; 20090138347; 20090138348; 20090138355; 20090138445; 20090144131; 20090144132; 20090144148; 20090150210; 20090157450; 20090157512; 20090157834; 20090163321; 20090164301; 20090170608; 20090170610; 20090170611; 20090170612; 20090170613; 20090170614; 20090171715; 20090172773; 20090176520; 20090176560; 20090176564; 20090176578; 20090176579; 20090176580; 20090177514; 20090177530; 20090177550; 20090178108; 20090178109; 20090178131; 20090178132; 20090182646; 20090187939; 20090190730; 20090192881; 20090193016; 20090193485; 20090197577; 20090197582; 20090198580; 20090198608; 20090199259; 20090201850; 20090201896; 20090204348; 20090204354; 20090204706; 20090210291; 20090210899; 20090216682; 20090216847; 20090217326; 20090222329; 20090222373; 20090222374; 20090222375; 20090222376; 20090222377; 20090222378; 20090222379; 20090222380; 20090226871; 20090228600; 20090228920; 20090234711; 20090234717; 20090234745; 20090234861; 20090234878; 20090240568; 20090240569; 20090240586; 20090248494; 20090254971; 20090265220; 20090265257; 20090271244; 20090271289; 20090276771; 20090281889; 20090282030; 20090288012; 20090288109; 20090291755; 20090292599; 20090298480; 20090298505; 20090299853; 20090299857; 20090306893; 20090307003; 20090307091; 20090307144; 20090319166; 20090319348; 20090326947; 20090327243; 20090327401; 20100004975; 20100005156; 20100022227; 20100023375; 20100023383; 20100029268; 20100031162; 20100042747; 20100049525; 20100049695; 20100057534; 20100057801; 20100063877; 20100066804; 20100070052; 20100070322; 20100076642; 20100076845; 20100076847; 20100076994; 20100077095; 20100082392; 20100082401; 20100082425; 20100082430; 20100082431; 20100082972; 20100088177; 20100094878; 20100114662; 20100114689; 20100114739; 20100121694; 20100121705; 20100131507; 20100138293; 20100138296; 20100145794; 20100145804; 20100153208; 20100153211; 20100161382; 20100169163; 20100169179; 20100179028; 20100180009; 20100180232; 20100185517; 20100190469; 20100191580; 20100198681; 20100198686; 20100205057; 20100205060; 20100211458; 20100217662; 20100217663; 20100223168; 20100223191; 20100227664; 20100227683; 20100227684; 20100228595; 20100228606; 20100228625; 20100228630; 20100228773; 20100235292; 20100235386; 20100235867; 20100235869; 20100250268; 20100250269; 20100250370; 20100250714; 20100251290; 20100256976; 20100257054; 20100259386; 20100262607; 20100271263; 20100274648; 20100274739; 20100287048; 20100287050; 20100287213; 20100293049; 20100293050; 20100293051; 20100293054; 20100293056; 20100293058; 20100299274; 20100301112; 20100306249; 20100306773; 20100312572; 20100312661; 20100312680; 20100312706; 20100312717; 20100313009; 20100318419; 20100318427; 20100318429; 20100318893; 20100325666; 20100332315; 20100332583; 20110010367; 20110015989; 20110015993; 20110015994; 20110016003; 20110016109; 20110016479; 20110022461; 20110022641; 20110022653; 20110029378; 20110029387; 20110029427; 20110029644; 20110029658; 20110035278; 20110035280; 20110035288; 20110035333; 20110035379; 20110040609; 20110041146; 20110043847; 20110047071; 20110047072; 20110055235; 20110066487; 20110066615; 20110067046; 20110071003; 20110071997; 20110072052; 20110078004; 20110078305; 20110082924; 20110082946; 20110087519; 20110087530; 20110087531; 20110087546; 20110087547; 20110087550; 20110087651; 20110087652; 20110087664; 20110093324; 20110093327; 20110093335; 20110093339; 20110099202; 20110103356; 20110103357; 20110103358; 20110103374; 20110105077; 20110105084; 20110105130; 20110105145; 20110105146; 20110106614; 20110106829; 20110107364; 20110107379; 20110112950; 20110119108; 20110119137; 20110119704; 20110125565; 20110125578; 20110125605; 20110131160; 20110143731; 20110143733; 20110145049; 20110145057; 20110145076; 20110145122; 20110153426; 20110153428; 20110153465; 20110156896; 20110159902; 20110161450; 20110166918; 20110167110; 20110173071; 20110177799; 20110184806; 20110184851; 20110185020; 20110190580; 20110190595; 20110191163; 20110191417; 20110202874; 20110208736; 20110213659; 20110213660; 20110213767; 20110218854; 20110218866; 20110223571; 20110225015; 20110225021; 20110225043; 20110225049; 20110225417; 20110225508; 20110226851; 20110231223; 20110231224; 20110231225; 20110231257; 20110231258; 20110231305; 20110238485; 20110238496; 20110238755; 20110238829; 20110243553; 20110251788; 20110251918; 20110251948; 20110251990; 20110257985; 20110258044; 20110258046; 20110258049; 20110258064; 20110258142; 20110258156; 20110258659; 20110261945; 20110264497; 20110264501; 20110264521; 20110264530; 20110264553; 20110264567; 20110264581; 20110264613; 20110265116; 20110275393; 20110276372; 20110282779; 20110282964; 20110288918; 20110288932; 20110288937; 20110289422; 20110292785; 20110295733; 20110295768; 20110301894; 20110302011; 20110302022; 20110302036; 20110302039; 20110302197; 20110307241; 20110307801; 20110309139; 20110312310; 20110313829; 20110313835; 20110313841; 20110313853; 20110313862; 20110313900; 20110314092; 20110320264; 20110320265; 20110320266; 20110320267; 20110320268; 20110320269; 20110320270; 20110320271; 20110320275; 20110320279; 20110320280; 20110320281; 20110320282; 20110321084; 20120004984; 20120004985; 20120004986; 20120004987; 20120004988; 20120004989; 20120004990; 20120004991; 20120004992; 20120004993; 20120004994; 20120004995; 20120004996; 20120004997; 20120004998; 20120004999; 20120005000; 20120005001; 20120005002; 20120005003; 20120005004; 20120005005; 20120005006; 20120005007; 20120005008; 20120005009; 20120005010; 20120005011; 20120005012; 20120005013; 20120005014; 20120005016; 20120005019; 20120005020; 20120005023; 20120005025; 20120010945; 20120010946; 20120010947; 20120010948; 20120010949; 20120010950; 20120010951; 20120010952; 20120010953; 20120010954; 20120010955; 20120010956; 20120010957; 20120010958; 20120010959; 20120010960; 20120010961; 20120010962; 20120010963; 20120010964; 20120010965; 20120010966; 20120010967; 20120010968; 20120010969; 20120010970; 20120010971; 20120010972; 20120010973; 20120010974; 20120010975; 20120010976; 20120010977; 20120010978; 20120010979; 20120010980; 20120010981; 20120010982; 20120010983; 20120010984; 20120010985; 20120010986; 20120010987; 20120010988; 20120010989; 20120010990; 20120010991; 20120011530; 20120016729; 20120016739; 20120016740; 20120016750; 20120016751; 20120017012; 20120020060; 20120022945; 20120023131; 20120023522; 20120029989; 20120030006; 20120035980; 20120035995; 20120036010; 20120036016; 20120040615; 20120041819; 20120046979; 20120046996; 20120054040; 20120054090; 20120058775; 20120059702; 20120059711; 20120059718; 20120059852; 20120066057; 20120066062; 20120066064; 20120066065; 20120066108; 20120066198; 20120066199; 20120066220; 20120072272; 20120072286; 20120072997; 20120078697; 20120078699; 20120078717; 20120078729; 20120079149; 20120084230; 20120084285; 20120089455; 20120089996; 20120100829; 20120101871; 20120102523; 20120109709; 20120109730; 20120109734; 20120109749; 20120110615; 20120110616; 20120110618; 20120110619; 20120110620; 20120123810; 20120123931; 20120123968; 20120130807; 20120130811; 20120130812; 20120130815; 20120131147; 20120131443; 20120131609; 20120131610; 20120136704; 20120136763; 20120136856; 20120143383; 20120143862; 20120144282; 20120144314; 20120150593; 20120150629; 20120150646; 20120150647; 20120150660; 20120150663; 20120150665; 20120150721; 20120150722; 20120150723; 20120150724; 20120150944; 20120151324; 20120151325; 20120151509; 20120151515; 20120158489; 20120158516; 20120158517; 20120158518; 20120158527; 20120166583; 20120173339; 20120173346; 20120173358; 20120173359; 20120173360; 20120173361; 20120173362; 20120173363; 20120173364; 20120173365; 20120173366; 20120173367; 20120173368; 20120173369; 20120173370; 20120173371; 20120173372; 20120173373; 20120173374; 20120173375; 20120173376; 20120173377; 20120173378; 20120173379; 20120179562; 20120179563; 20120179564; 20120179565; 20120179566; 20120179567; 20120179568; 20120179975; 20120185296; 20120185297; 20120185349; 20120185899; 20120190327; 20120190386; 20120191525; 20120191537; 20120191541; 20120191716; 20120196619; 20120197705; 20120197739; 20120203625; 20120203877; 20120205436; 20120208512; 20120209705; 20120209706; 20120209707; 20120209708; 20120209709; 20120209710; 20120215602; 20120215610; 20120215612; 20120215622; 20120215623; 20120215624; 20120215625; 20120215626; 20120215635; 20120215639; 20120215640; 20120221400; 20120221404; 20120221409; 20120221452; 20120226563; 20120233061; 20120233631; 20120238255; 20120238353; 20120239479; 20120239487; 20120239488; 20120239498; 20120239523; 20120239524; 20120244835; 20120246142; 20120246684; 20120253937; 20120253951; 20120253977; 20120254912; 20120256915; 20120258697; 20120264570; 20120265613; 20120265661; 20120266191; 20120271691; 20120271715; 20120271718; 20120271770; 20120272289; 20120278132; 20120284081; 20120289147; 20120290374; 20120290395; 20120290399; 20120290431; 20120290432; 20120290433; 20120290446; 20120290448; 20120290553; 20120296747; 20120297408; 20120303439; 20120303505; 20120304207; 20120310717; 20120310738; 20120310797; 20120310798; 20120310831; 20120310838; 20120310971; 20120315009; 20120317652; 20120323346; 20120323688; 20120323694; 20120327815; 20120330750; 20120330754; 20120331098; 20120331515; 20130006775; 20130012178; 20130013991; 20130014159; 20130024307; 20130024906; 20130032634; 20130036033; 20130041733; 20130041781; 20130042285; 20130046582; 20130046607; 20130053005; 20130053657; 20130054375; 20130055097; 20130059607; 20130060639; 20130060716; 20130061127; 20130064527; 20130066683; 20130066706; 20130066711; 20130066723; 20130066771; 20130073336; 20130073343; 20130073388; 20130073464; 20130073859; 20130080239; 20130080358; 20130080377; 20130080434; 20130080439; 20130080447; 20130085856; 20130085869; 20130090750; 20130091000; 20130091013; 20130091212; 20130096943; 20130097015; 20130097180; 20130097664; 20130101272; 20130103468; 20130103749; 20130103764; 20130103841; 20130103973; 20130104251; 20130110636; 20130110637; 20130110750; 20130110986; 20130111520; 20130117086; 20130117108; 20130122874; 20130124263; 20130124287; 20130124315; 20130124317; 20130124324; 20130124325; 20130124327; 20130124329; 20130124331; 20130124332; 20130124333; 20130124340; 20130124417; 20130129149; 20130130672; 20130138474; 20130138507; 20130144722; 20130144724; 20130151388; 20130159081; 20130166365; 20130166580; 20130167162; 20130172073; 20130173380; 20130173394; 20130176221; 20130176441; 20130179201; 20130184002; 20130188095; 20130191195; 20130191198; 20130191213; 20130191223; 20130191250; 20130191391; 20130191394; 20130197969; 20130197991; 20130198004; 20130204703; 20130211879; 20130211925; 20130218664; 20130218670; 20130218678; 20130219307; 20130222406; 20130224695; 20130224696; 20130226699; 20130226706; 20130226753; 20130226778; 20130226779; 20130226780; 20130226781; 20130226782; 20130226783; 20130226787; 20130226857; 20130227617; 20130231974; 20130232263; 20130235042; 20130238409; 20130238413; 20130238424; 20130238439; 20130238440; 20130238443; 20130238751; 20130238761; 20130238762; 20130238777; 20130246150; 20130246182; 20130246183; 20130246273; 20130254008; 20130254035; 20130254038; 20130254135; 20130254787; 20130254897; 20130262225; 20130262233; 20130262342; 20130262431; 20130262558; 20130262619; 20130262620; 20130262633; 20130262997; 20130263185; 20130263189; 20130268324; 20130268333; 20130268357; 20130268620; 20130275129; 20130275209; 20130275215; 20130275219; 20130275222; 20130275226; 20130275227; 20130275331; 20130275505; 20130282461; 20130282482; 20130282491; 20130282504; 20130282510; 20130282586; 20130282810; 20130282811; 20130282812; 20130282813; 20130285855; 20130288710; 20130290106; 20130291060; 20130293530; 20130297404; 20130297419; 20130304581; 20130304585; 20130304878; 20130310158; 20130311261; 20130311270; 20130311291; 20130311292; 20130311293; 20130311294; 20130311297; 20130311320; 20130318027; 20130325579; 20130325602; 20130325606; 20130325610; 20130325623; 20130325870; 20130325936; 20130325937; 20130325938; 20130331175; 20130332255; 20130332281; 20130332355; 20130332361; 20130332362; 20130332987; 20130334300; 20130339146; 20130339180; 20130346177; 20130346199; 20130346206; 20130346264; 20130346488; 20140006118; 20140006129; 20140006255; 20140006951; 20140012633; 20140012664; 20140012665; 20140012734; 20140013244; 20140019209; 20140019245; 20140019257; 20140019288; 20140019331; 20140019563; 20140025494; 20140025502; 20140025786; 20140025794; 20140032306; 20140032326; 20140032384; 20140033074; 20140038725; 20140040051; 20140040067; 20140040134; 20140040135; 20140040255; 20140040343; 20140046744; 20140046758; 20140046761; 20140046777; 20140052533; 20140052538; 20140052577; 20140052707; 20140053187; 20140058812; 20140058926; 20140067501; 20140067958; 20140073420; 20140074575; 20140074599; 20140074627; 20140081753; 20140081835; 20140082645; 20140087854; 20140089084; 20140089089; 20140089093; 20140089100; 20140089241; 20140089325; 20140089413; 20140089798; 20140089799; 20140095285; 20140101696; 20140108158; 20140109167; 20140115008; 20140115671; 20140122220; 20140122243; 20140122496; 20140122536; 20140122537; 20140122595; 20140123176; 20140123188; 20140123246; 20140123247; 20140123298; 20140123300; 20140128691; 20140129306; 20140129308; 20140129313; 20140129314; 20140129330; 20140129332; 20140130140; 20140133530; 20140136104; 20140136325; 20140136328; 20140136414; 20140136624; 20140137188; 20140143004; 20140143020; 20140143048; 20140143051; 20140143057; 20140143058; 20140143061; 20140149179; 20140149203; 20140149244; 20140149317; 20140154969; 20140156698; 20140161326; 20140162241; 20140164113; 20140164454; 20140172525; 20140172534; 20140172567; 20140172576; 20140172686; 20140173452; 20140180018; 20140180024; 20140180025; 20140180598; 20140180720; 20140180825; 20140180914; 20140180993; 20140181100; 20140181102; 20140181108; 20140187872; 20140187873; 20140188874; 20140189013; 20140195380; 20140195447; 20140200963; 20140200999; 20140201126; 20140207551; 20140207563; 20140213300; 20140213854; 20140213938; 20140214526; 20140214527; 20140214552; 20140214836; 20140214873; 20140214874; 20140214903; 20140215513; 20140215578; 20140220525; 20140221730; 20140221773; 20140221775; 20140221776; 20140222533; 20140222534; 20140222566; 20140222577; 20140222667; 20140222704; 20140222732; 20140222733; 20140222734; 20140222735; 20140222804; 20140222847; 20140222848; 20140222849; 20140222850; 20140222851; 20140223475; 20140223573; 20140228060; 20140229274; 20140229277; 20140229281; 20140230025; 20140230030; 20140236542; 20140236644; 20140236672; 20140236678; 20140236700; 20140236718; 20140236721; 20140236723; 20140236732; 20140236848; 20140236946; 20140237051; 20140237053; 20140237062; 20140244352; 20140244353; 20140244360; 20140244372; 20140244400; 20140244401; 20140244419; 20140244420; 20140244514; 20140257836; 20140257837; 20140257850; 20140257851; 20140257852; 20140257960; 20140257967; 20140258002; 20140258198; 20140258469; 20140259045; 20140272914; 20140273998; 20140278747; 20140278748; 20140278762; 20140278763; 20140278764; 20140278776; 20140278777; 20140278916; 20140278942; 20140278958; 20140278959; 20140278960; 20140278985; 20140278990; 20140279047; 20140279052; 20140279064; 20140279065; 20140279078; 20140279420; 20140279724; 20140279727; 20140281963; 20140282036; 20140282710; 20140287782; 20140289012; 20140289017; 20140297394; 20140304083; 20140304087; 20140304130; 20140304212; 20140306799; 20140306814; 20140306817; 20140306826; 20140306833; 20140306834; 20140306835; 20140307655; 20140307724; 20140308636; 20140308639; 20140308902; 20140308978; 20140309789; 20140309790; 20140309804; 20140309805; 20140309813; 20140309838; 20140309847; 20140309849; 20140309852; 20140309853; 20140309862; 20140309863; 20140309864; 20140309865; 20140309866; 20140309867; 20140309868; 20140309869; 20140309871; 20140309872; 20140309873; 20140309874; 20140309875; 20140309876; 20140309877; 20140309878; 20140309879; 20140309885; 20140309892; 20140309893; 20140309919; 20140309920; 20140309921; 20140309922; 20140309923; 20140309927; 20140309929; 20140309930; 20140309934; 20140309935; 20140309939; 20140309940; 20140309982; 20140310031; 20140310075; 20140310080; 20140310086; 20140310103; 20140310105; 20140310108; 20140310137; 20140310157; 20140310186; 20140310223; 20140310274; 20140310275; 20140310276; 20140310277; 20140310284; 20140310294; 20140310295; 20140310296; 20140310297; 20140310298; 20140310379; 20140310702; 20140310788; 20140315527; 20140316852; 20140316855; 20140316885; 20140316903; 20140317022; 20140317039; 20140317042; 20140317112; 20140317119; 20140317135; 20140317657; 20140317696; 20140324538; 20140324572; 20140325030; 20140330645; 20140335948; 20140337089; 20140337090; 20140337120; 20140337205; 20140337938; 20140342659; 20140344065; 20140344068; 20140344069; 20140344282; 20140351048; 20140351154; 20140351248; 20140351835; 20140351870; 20140359298; 20140359667; 20140365301; 20140365349; 20140365572; 20140365581; 20140372224; 20140372225; 20140372572; 20140380495; 20150003333; 20150003810; 20150006286; 20150006294; 20150006295; 20150006895; 20150012360; 20150012441; 20150019328; 20150019329; 20150019435; 20150019550; 20150021990; 20150026815; 20150030311; 20150032366; 20150032510; 20150039413; 20150042570; 20150042571; 20150042572; 20150046147; 20150058108; 20150058883; 20150058957; 20150061895; 20150066632; 20150067754; 20150073989; 20150078247; 20150081349; 20150081355; 20150081430; 20150081446; 20150082362; 20150087224; 20150088564; 20150088626; 20150088633; 20150088662; 20150095144; 20150095158; 20150100526; 20150100544; 20150100581; 20150100646; 20150100787; 20150106078; 20150106156; 20150106157; 20150106178; 20150112767; 20150113570; 20150118994; 20150120418; 20150120429; 20150120482; 20150120533; 20150127321; 20150127405; 20150127422; 20150127445; 20150127464; 20150127663; 20150131845; 20150134459; 20150134528; 20150135160; 20150142585; 20150143414; 20150145671; 20150149272; 20150149274; 20150149275; 20150150046; 20150150107; 20150154642; 20150154828; 20150161624; 20150161625; 20150161648; 20150163311; 20150176997; 20150178392; 20150178744; 20150178786; 20150186929; 20150186945; 20150186953; 20150188873; 20150189351; 20150189396; 20150199716; 20150199742; 20150201229; 20150202770; 20150206118; 20150206165; 20150206203; 20150208190; 20150213014; 20150213015; 20150213315; 20150213465; 20150213504; 20150220778; 20150223002; 20150227890; 20150227922; 20150227925; 20150227973; 20150228004; 20150235258; 20150235275; 20150235277; 20150235594; 20150237383; 20150237386; 20150238817; 20150242447; 20150242751; 20150242884; 20150244690; 20150246281; 20150254745; 20150264438; 20150269220; 20150271541; 20150271620; 20150277980; 20150278387; 20150278444; 20150278847; 20150278855; 20150278883; 20150278906; 20150278909; 20150279154; 20150287094; 20150294358; 20150294375; 20150310476; 20150310499; 20150310687; 20150312348; 20150312882; 20150324820; 20150324845; 20150331872; 20150332338; 20150339376; 20150339402; 20150339687; 20150339734; 20150339736; 20150339787; 20150348094; 20150348096; 20150348119; 20150348136; 20150350706; 20150350804; 20150358355; 20150358790; 20150358818; 20150363810; 20150371241; 20150371280; 20150379568; 20150379583; 20150379981; 20150379989; 20150381402; 20150382030; 20160004820; 20160004971; 20160011673; 20160012121; 20160012465; 20160012492; 20160012538; 20160014819; 20160019574; 20160019581; 20160019582; 20160019595; 20160027034; 20160027048; 20160027051; 20160029368; 20160034705; 20160034938; 20160037057; 20160037197; 20160037201; 20160039426; 20160039430; 20160040998; 20160041820; 20160044344; 20160047662; 20160048370; 20160048556; 20160048698; 20160048934; 20160050447; 20160059865; 20160063573; 20160065583; 20160070527; 20160071133; 20160072800; 20160078460; 20160082839; 20160086391; 20160088459; 20160088461; 20160092914; 20160092959; 20160098524; 20160098713; 20160104207; 20160110537; 20160110728; 20160112770; 20160117675; 20160117718; 20160117719; 20160119742; 20160125314; 20160125465; 20160125466; 20160127539; 20160127540; 20160127541; 20160127548; 20160127549; 20160127562; 20160127566; 20160127567; 20160127569; 20160127802; 20160127808; 20160127875; 20160127981; 20160140122; 20160140614; 20160142754; 20160148507; 20160156941; 20160157062; 20160162947; 20160163133; 20160166180; 20160170996; 20160170998; 20160171508; 20160171509; 20160171537; 20160171542; 20160180384; 20160180401; 20160189217; 20160191668; 20160191716; 20160192321; 20160196386; 20160196572; 20160196603; 20160203204; 20160217446; 20160217493; 20160219332; 20160223347; 20160224803; 20160225016; 20160225027; 20160225029; 20160225272; 20160225278; 20160227284; 20160232149; 20160232161; 20160232569; 20160232570; 20160235309; 20160239575; 20160239878; 20160241645; 20160241912; 20160241927; 20160241933; 20160241934; 20160244011; 20160246526; 20160247377; 20160249111; 20160249853; 20160250985; 20160253342; 20160253699; 20160253710; 20160254698; 20160255205; 20160259778; 20160260126; 20160261921; 20160267546; 20160267556; 20160267694; 20160269857; 20160277528; 20160283676; 20160283923; 20160283951; 20160283971; 20160285662; 20160285999; 20160286627; 20160286629; 20160292722; 20160294621; 20160300223; 20160300252; 20160307398; 20160315981; 20160316240; 20160318467; 20160318468; 20160318524; 20160321370; 20160321848; 20160323259; 20160323711; 20160323767; 20160324478; 20160325755; 20160328478; 20160328484; 20160328667; 20160328759; 20160330034; 20160330530; 20160335648; 20160335674; 20160337713; 20160343017; 20160343037; 20160344848; 20160352846; 20160353240; 20160358195; 20160358197; 20160359957; 20160359987; 20160361599; 20160364746; 20160364767; 20160371692; 20160371733; 20160373891; 20160379086; 20160379213; 20160379224; 20160379256; 20160379267; 20160379284; 20160379298; 20160379299; 20170001074; 20170003845; 20170004459; 20170004588; 20170005994; 20170006315; 20170011424; 20170011458; 20170011472; 20170013417; 20170024091; 20170024723; 20170024762; 20170031449; 20170031935; 20170032402; 20170033834; 20170034592; 20170034593; 20170039452; 20170039560; 20170039600; 20170039602; 20170046029; 20170046333; 20170048672; 20170053114; 20170055043; 20170061508; 20170062010; 20170066406; 20170067747; 20170068970; 20170075877; 20170076306; 20170078223; 20170082447; 20170085724; 20170091820; 20170091825; 20170097243; 20170098234; 20170099295; 20170099512; 20170103410; 20170108935; 20170112671; 20170116277; 20170116642; 20170118533; 20170118622; 20170132660; 20170133054; 20170140330; 20170140331; 20170140332; 20170140333; 20170140424; 20170140442; 20170142158; 20170148021; 20170148048; 20170148051; 20170161439; 20170161772; 20170161773; 20170161779; 20170163937; 20170169384; 20170169528; 20170173262; 20170178143; 20170178193; 20170180567; 20170180961; 20170181628; 20170189817; 20170193100; 20170193571; 20170195854; 20170200197; 20170201779; 20170206611; 20170207916; 20170208536; 20170221095; 20170222962; 20170223131; 20170223425; 20170228786; 20170230791; 20170232300; 20170232888; 20170236146; 20170236167; 20170236196; 20170238025; 20170243028; 20170247000; 20170249095; 20170249663; 20170249710; 20170251172; 20170255820; 20170255845; 20170255964; 20170256000; 20170256001; 20170256003; 20170270122; 20170270292; 20170270709; 20170272362; 20170272930; 20170277701; 20170281000; 20170281060; 20170287212; 20170289597; 20170300917; 20170300957; 20170303088; 20170310364; 20170317985; 20170322525; 20170322529; 20170322530; 20170322576; 20170322577; 20170323207; 20170323208; 20170323277; 20170323338; 20170323339; 20170329840; 20170329881; 20170330107; 20170332205; 20170337173; 20170344552; 20170345105; 20170352061; 20170358041; 20170364955; 20170364982; 20170372434; 20170374038; 20180006829; 20180007214; 20180011842; 20180011942; 20180019984; 20180020310; 20180025010; 20180025442; 20180027129; 20180027386; 20180040009; 20180043130; 20180046944; 20180047425; 20180053215; 20180054411; 20180060384; 20180060696; 20180061459; 20180067939; 20180068350; 20180069929; 20180075513; 20180075739; 20180077511; 20180078843; 20180081509; 20180084224; 20180084306; 20180089717; 20180090992; 20180096328; 20180096329; 20180096330; 20180096365; 20180096417; 20180096752; 20180108032; 20180117446; 20180117447; 20180121817; 20180121827; 20180131663; 20180131905; 20180131975; 20180133583; 20180137364; 20180137506; 20180137512; 20180137593; 20180144368; 20180146361; 20180149486; 20180150816; 20180152766; 20180158091; 20180158109; 20180174167; 20180174188; 20180176390; 20180176506; 20180178066; 20180181939; 20180181971; 20180182052; 20180183610; 20180186288; 20180186311; 20180189076; 20180189285; 20180189518; 20180189695; 20180189766; 20180189805; 20180189806; 20180189807; 20180189912; 20180190040; 20180191503; 20180192117; 20180192130; 20180192162; 20180196694; 20180199101; 20180204111; 20180204249; 20180204268; 20180205631; 20180206135; 20180206136; 20180211331; 20180211718; 20180213060; 20180218393; 20180219581; 20180225361; 20180225678; 20180225682; 20180225686; 20180225705; 20180225708; 20180225709; 20180232549; 20180232712; 20180232713; 20180232817; 20180233000; 20180235480; 20180240143; 20180246951; 20180247191; 20180247319; 20180247380; 20180247707; 20180253805; 20180253906; 20180254070; 20180256985; 20180257688; 20180259976; 20180260836; 20180260843; 20180260874; 20180261318; 20180264347; 20180268401; 20180276708; 20180276710; 20180284735; 20180284736; 20180284737; 20180284741; 20180284742; 20180284743; 20180284744; 20180284745; 20180284746; 20180284747; 20180284749; 20180284752; 20180284753; 20180284754; 20180284755; 20180284756; 20180284757; 20180284758; 20180285879; 20180285884; 20180285957; 20180285996; 20180288041; 20180288369; 20180299878; 20180300741; 20180302252; 20180307859; 20180308128; 20180309585; 20180310123; 20180314982; 20180315083; 20180315093; 20180315094; 20180315414; 20180316665; 20180321072; 20180321666; 20180321667; 20180321672; 20180322303; 20180322520; 20180322541; 20180326291; 20180329935; 20180336583; 20180336964; 20180338189; 20180342106; 20180349478; 20180349479; 20180349480; 20180349481; 20180349483; 20180349484; 20180349485; 20180349922; 20180352386; 20180352473; 20180357248; 20180357670; 20180357675; 20180365212; 20180365250; 20180365332; 20180365690; 20180365730; 20180368130; 20180374126; 20180376186; 20190007381; 20190007724; 20190012249; 20190013932; 20190013933; 20190013934; 20190013948; 20190014111; 20190014356; 20190014390; 20190019171; 20190019203; 20190019218; 20190019498; 20190019499; 20190020651; 20190025805; 20190025806; 20190025812; 20190025813; 20190026669; 20190026781; 20190026786; 20190028595; 20190033845; 20190033846; 20190033848; 20190033849; 20190034602; 20190035499; 20190036887; 20190037418; 20190041835; 20190041836; 20190041840; 20190041841; 20190041842; 20190041843; 20190041844; 20190042228; 20190043082; 20190043083; 20190043090; 20190044740; 20190045235; 20190056902; 20190057372; 20190058248; 20190058581; 20190058999; 20190064791; 20190064792; 20190065011; 20190065610; 20190065615; 20190065970; 20190066063; 20190066064; 20190066079; 20190069004; 20190073666; 20190073688; 20190079659; 20190079953; 20190082207; 20190082234; 20190087800; 20190087844; 20190087865; 20190089717; 20190089844; 20190102791; 20190102802; 20190107990; 20190107991; 20190108362; 20190108499; 20190108548; 20190108556; 20190108578; 20190108596; 20190109713; 20190109911; 20190113973; 20190114334; 20190114593; 20190114652; 20190115950; 20190121333; 20190121338; 20190121339; 20190121340; 20190121341; 20190121342; 20190121343; 20190121344; 20190121345; 20190121346; 20190121347; 20190121348; 20190121850; 20190122149; 20190122183; 20190122258; 20190122266; 20190125457; 20190129406; 20190129407; 20190129408; 20190130462; 20190130655; 20190132815; 20190137985; 20190137986; 20190138294; 20190138553; 20190141021; 20190141291; 20190141536; 20190146432; 20190146433; 20190146472; 20190146473; 20190146474; 20190146475; 20190146476; 20190146479; 20190146480; 20190146538; 20190146539; 20190147471; 20190147472; 20190147504; 20190150134; 20190155263; 20190156368; 20190156370; 20190156374; 20190158544; 20190158614; 20190158906; 20190158975; 20190163790; 20190166403; 20190171174; 20190171175; 20190171187; 20190171341; 20190171405; 20190171438; 20190171620; 20190172025; 20190172030; 20190172124; 20190172166; 20190174172; 20190178657; 20190179861; 20190180276; 20190180325; 20190182257; 20190187680; 20190187681; 20190187682; 20190187683; 20190187684; 20190187686; 20190187687; 20190187688; 20190188628; 20190191223; 20190197477; 20190197583; 20190205773; 20190205932; 20190206565; 20190207651; 20190208354; 20190213046; 20190213618; 20190215934; 20190219995; 20190220894; 20190221001; 20190222567; 20190222962; 20190227419; 20190227536; 20190227537; 20190228570; 20190230070; 20190230394; 20190236559; 20190236562; 20190236594; 20190236598; 20190236606; 20190238316; 20190238525; 20190244222; 20190246175; 20190251593; 20190251600; 20190253431; 20190253515; 20190253745; 20190253835; 20190259042; 20190266645; 20190268392; 20190279143; 20190279181; 20190279257; 20190279440; 20190279447; 20190281030; 20190289350; 20190294133; 20190295119; 20190295122; 20190295128; 20190296919; 20190297367; 20190303925; 20190303962; 20190306137; 20190308639; 20190311709; 20190312734; 20190312915; 20190312941; 20190312979; 20190318433; 20190324416; 20190324431; 20190324432; 20190324433; 20190324434; 20190324435; 20190324436; 20190324437; 20190324438; 20190324439; 20190324440; 20190324441; 20190324442; 20190324443; 20190324444; 20190325020; 20190325432; 20190325433; 20190325469; 20190332807; 20190332921; 20190333073; 20190334957; 20190335096; 20190335551; 20190335715; 20190339684; 20190339685; 20190339686; 20190339687; 20190339688; 20190339712; 20190340013; 20190340306; 20190340467; 20190340605; 20190340627; 20190340645; 20190340671; 20190340686; 20190340707; 20190340715; 20190340716; 20190342629; 20190347105; 20190347442; 20190347624; 20190349254; 20190349261; 20190349426; 20190349701; 20190349708; 20190354374; 20190354552; 20190355031; 20190355472; 20190356641; 20190356775; 20190356960; 20190358515; 20190361917; 20190362388; 20190362389; 20190362716; 20190362826; 20190364320; 20190370686; 20190370824; 20190370831; 20190370847; 20190373301; 20190378126; 20190378150; 20190378164; 20190378166; 20190378225; 20190384935; 20190384968; 20190385186; 20190385187; 20190386969; 20190387356; 20190392007; 20190392019; 20190392107; 20190392489; 20190393926; 20200004791; 20200004986; 20200004987; 20200004988; 20200004995; 20200004996; 20200004997; 20200004998; 20200004999; 20200005107; 20200005295; 20200005349; 20200007516; 20200007540; 20200008721; 20200008722; 20200011683; 20200012767; 20200012768; 20200013087; 20200013095; 20200013380; 20200014671; 20200014691; 20200015053; 20200016496; 20200017135; 20200019154; 20200019155; 20200020006; 20200020440; 20200021598; 20200026270; 20200027085; 20200027096; 20200027120; 20200027125; 20200027132; 20200027133; 20200028974; 20200037034; 20200038702; 20200043056; 20200045035; 20200045127; 20200050228; 20200050229; 20200050791; 20200051059; 20200051117; 20200051118; 20200051149; 20200051368; 20200053403; 20200053857; 20200057783; 20200058051; 20200059269; 20200059270; 20200059467; 20200059754; 20200065517; 20200065778; 20200065852; 20200065862; 20200066414; 20200067747; 20200068075; 20200074112; 20200074113; 20200074429; 20200074461; 20200074484; 20200074574; 20200074751; 20200076798; 20200076957; 20200081896; 20200082126; 20200082393; 20200082433; 20200082437; 20200084051; 20200084483; 20200089210; 20200089211; 20200089212; 20200089213; 20200089214; 20200089215; 20200089216; 20200089217; 20200090156; 20200090193; 20200090228; 20200092593; 20200096986; 20200096987; 20200096988; 20200096990; 20200096991; 20200096992; 20200096994; 20200096995; 20200096996; 20200096997; 20200096998; 20200097639; 20200097974; 20200097988; 20200098057; 20200098058; 20200098059; 20200098060; 20200098061; 20200098062; 20200098063; 20200098064; 20200098066; 20200098067; 20200098068; 20200098069; 20200098070; 20200101367; 20200103889; 20200103890; 20200103891; 20200103892; 20200103893; 20200103894; 20200104156; 20200104157; 20200104158; 20200104178; 20200104326; 20200104337; 20200104867; 20200104871; 20200104872; 20200104873; 20200104932; 20200104949; 20200104955; 20200104956; 20200106735; 20200110397; 20200110398; 20200110399; 20200110400; 20200110401; 20200110796; 20200111065; 20200111125; 20200111178; 20200111179; 20200111180; 20200111181; 20200111182; 20200112758; 20200112833; 20200117180; 20200117181; 20200117182; 20200117690; 20200118120; 20200118161; 20200118170; 20200118224; 20200118234; 20200120205; 20200126119; 20200128134; 20200133254; 20200133255; 20200133256; 20200133257; 20200134612; 20200134671; 20200137078; 20200143314; 20200143404; 20200143411; 20200143426; 20200143459; 20200143558; 20200145216; 20200145708; 20200146132; 20200150643; 20200150644; 20200150645; 20200151774; 20200159206; 20200159207; 20200160374; 20200160379; 20200160388; 20200166922; 20200166923; 20200167145; 20200167501; 20200167820; 20200169546; 20200174463; 20200174464; 20200175206; 20200178237; 20200184278; 20200184431; 20200184437; 20200184547; 20200184556; 20200186355; 20200186607; 20200192957; 20200193145; 20200193418; 20200193472; 20200193475; 20200195436; 20200195437; 20200195748; 20200202284; 20200202427; 20200202429; 20200204855; 20200213260; 20200213308; 20200213685; 20200218350; 20200218409; 20200219093; 20200219188; 20200225655; 20200226196; 20200226628; 20200226643; 20200227160; 20200228993; 20200234152; 20200234153; 20200234154; 20200234155; 20200234380; 20200238122; 20200242145; 20200242557; 20200242576; 20200242595; 20200242646; 20200242661; 20200242880; 20200244814; 20200249950; 20200249951; 20200249952; 20200249953; 20200250176; 20200250177; 20200250295; 20200250590; 20200250661; 20200250667; 20200250683; 20200250747; 20200251936; 20200252205; 20200252681; 20200252743; 20200257893; 20200258018; 20200258099; 20200258605; 20200259237; 20200259526; 20200261027; 20200264688; 20200264689; 20200265164; 20200265915; 20200268260; 20200272469; 20200272470; 20200272471; 20200272472; 20200272473; 20200272763; 20200272764; 20200273048; 20200273099; 20200273100; 20200273101; 20200273578; 20200274694; 20200279637; 20200283136; 20200284883; 20200293321; 20200293322; 20200293323; 20200293324; 20200293325; 20200293326; 20200293327; 20200294076; 20200294128; 20200294129; 20200294131; 20200294132; 20200294133; 20200294134; 20200294135; 20200294136; 20200294137; 20200294138; 20200294139; 20200296091; 20200297063; 20200297262; 20200297269; 20200301775; 20200302482; 20200302523; 20200302525; 20200304318; 20200310905; 20200311566; 20200311721; 20200311816; 20200311848; 20200311992; 20200314042; 20200314248; 20200320207; 20200320571; 20200320576; 20200320582; 20200320644; 20200320781; 20200322309; 20200322800; 20200327378; 20200327577; 20200329398; 20200333426; 20200334708; 20200334712; 20200334715; 20200334751; 20200334810; 20200335198; 20200335199; 20200336475; 20200336777; 20200336868; 20200341965; 20200342394; 20200342449; 20200342466; 20200342980; 20200344233; 20200344243; 20200344317; 20200344515; 20200348662; 20200349249; 20200349536; 20200349610; 20200349611; 20200356695; 20200356697; 20200357024; 20200364671; 20200364817; 20200366634; 20200372546; 20200372547; 20200379079; 20200379769; 20200379770; 20200379771; 20200380326; 20200382480; 20200382892; 20200387379; 20200387896; 20200387914; 20200387923; 20200387924; 20200387935; 20200387965; 20200387966; 20200387967; 20200387968; 20200388359; 20200389301; 20200389495; 20200389542; 20200394708; 20200394709; 20200396065; 20200397354; 20200401637; 20200402138; 20200402144; 20200405148; 20210004437; 20210005325; 20210006870; 20210006993; 20210007644; 20210012282; 20210012332; 20210012372; 20210014060; 20210014113; 20210019444; 20210019816; 20210019944; 20210020302; 20210020303; 20210021788; 20210022003; 20210026687; 20210026985; 20210027015; 20210027281; 20210028940; 20210029482; 20210035144; 20210037142; 20210042796; 20210042830; 20210042960; 20210044703; 20210049628; 20210049655; 20210049703; 20210051218; 20210056294; 20210056536; 20210058758; 20210060404; 20210064766; 20210065070; 20210067911; 20210072066; 20210073282; 20210073287; 20210073291; 20210073486; 20210073647; 20210073654; 20210075619; 20210076237; 20210081271; 20210081568; 20210081994; 20210082006; 20210082044; 20210083876; 20210085226; 20210090036; 20210090185; 20210090449; 20210091941; 20210092201; 20210092604; 20210097198; 20210103921; 20210106236; 20210108939; 20210110374; 20210110448; 20210110827; 20210117935; 20210117962; 20210118012; 20210118085; 20210119785; 20210119801; 20210124838; 20210124843; 20210125195; 20210125203; 20210125204; 20210125205; 20210125206; 20210125209; 20210125232; 20210125233; 20210125234; 20210125241; 20210125275; 20210125297; 20210125405; 20210126784; 20210133160; 20210133400; 20210133647; 20210133650; 20210133669; 20210133670; 20210133776; 20210133777; 20210133778; 20210133779; 20210133780; 20210133781; 20210133784; 20210133785; 20210133786; 20210133790; 20210133801; 20210133802; 20210133804; 20210133805; 20210133809; 20210133812; 20210133813; 20210133818; 20210133819; 20210133820; 20210133821; 20210133822; 20210136122; 20210136458; 20210137429; 20210141044; 20210141853; 20210142357; 20210142874; 20210144517; 20210144972; 20210149958; 20210149982; 20210150541; 20210150586; 20210152035; 20210152535; 20210152536; 20210152864; 20210153019; 20210157312; 20210158440; 20210158441; 20210160555; 20210160562; 20210166309; 20210166310; 20210166311; 20210166666; 20210168109; 20210168116; 20210168132; 20210168466; 20210168557; 20210168612; 20210174222; 20210174257; 20210174316; 20210174388; 20210174426; 20210174427; 20210174448; 20210174625; 20210174778; 20210174925; 20210176202; 20210176536; 20210182423; 20210182827; 20210182886; 20210182912; 20210182915; 20210182961; 20210182995; 20210182996; 20210185383; 20210185408; 20210186385; 20210192081; 20210192082; 20210192595; 20210192651; 20210192652; 20210200943; 20210201328; 20210203749; 20210216749; 20210216750; 20210216751; 20210216752; 20210216920; 20210217099; 20210219094; 20210227275; 20210232624; 20210232642; 20210232643; 20210232937; 20210233048; 20210233093; 20210233108; 20210233110; 20210233631; 20210236044; 20210240783; 20210241321; 20210241396; 20210241918; 20210243023; 20210248330; 20210248338; 20210248514; 20210248594; 20210250353; 20210250648; 20210256070; 20210256084; 20210256191; 20210256550; 20210256577; 20210264311; 20210264520; 20210264653; 20210266346; 20210273804; 20210274333; 20210275083; 20210275863; 20210279049; 20210279202; 20210279309; 20210279668; 20210281569; 20210281893; 20210284217; 20210286546; 20210286899; 20210287247; 20210287257; 20210287459; 20210295378; 20210295389; 20210295522; 20210295637; 20210297252; 20210297399; 20210303137; 20210303164; 20210303644; 20210311931; 20210312081; 20210312447; 20210314143; 20210315503; 20210319428; 20210319429; 20210319430; 20210319431; 20210319432; 20210319433; 20210319436; 20210319473; 20210319520; 20210320914; 20210326478; 20210326845; 20210326846; 20210326847; 20210326848; 20210326849; 20210326850; 20210326851; 20210326852; 20210326853; 20210326854; 20210326855; 20210326856; 20210326857; 20210326964; 20210329321; 20210329756; 20210331072; 20210331078; 20210334827; 20210341331; 20210342020; 20210342415; 20210342822; 20210342836; 20210342890; 20210342894; 20210349381; 20210350289; 20210350399; 20210350443; 20210350453; 20210350923; 20210352134; 20210352478; 20210354295; 20210356941; 20210357029; 20210357422; 20210357447; 20210357823; 20210357827; 20210357838; 20210357850; 20210357959; 20210358015; 20210358032; 20210360044; 20210361162; 20210365445; 20210365574; 20210365815; 20210365940; 20210366586; 20210367764; 20210368220; 20210368905; 20210368906; 20210373963; 20210374143; 20210374391; 20210374704; 20210374784; 20210374787; 20210374801; 20210374802; 20210374805; 20210374807; 20210374813; 20210375066; 20210376445; 20210377263; 20210377490; 20210382806; 20210383115; 20210383277; 20210383370; 20210383429; 20210383461; 20210383489; 20210384764; 20210387350; 20210390196; 20210392290; 20210392400; 20210398029; 20210398193; 20210398363; 20210399894; 20210400349; 20210400428; 20210406853; 20210407317; 20220004663; 20220004925; 20220004926; 20220004927; 20220005003; 20220005023; 20220005078; 20220006813; 20220007068; 20220012285; 20220012364; 20220012757; 20220012762; 20220012770; 20220012774; 20220012799; 20220014525; 20220019639; 20220021099; 20220021632; 20220023742; 20220026924; 20220027472; 20220027908; 20220027936; 20220027937; 20220027938; 20220027939; 20220027940; 20220027945; 20220027971; 20220029464; 20220030000; 20220030373; 20220035341; 20220035342; 20220036274; 20220036275; 20220036276; 20220036301; 20220036302; 20220036343; 20220036405; 20220036406; 20220036480; 20220038410; 20220038446; 20220039703; 20220040557; 20220044204; 20220044281; 20220044334; 20220050921; 20220050982; 20220050983; 20220051171; 20220051184; 20220051276; 20220051358; 20220051361; 20220053333; 20220057519; 20220058212; 20220058247; 20220058329; 20220058569; 20220058624; 20220058625; 20220058626; 20220058627; 20220058628; 20220058629; 20220058630; 20220058631; 20220058632; 20220058633; 20220058634; 20220058635; 20220058636; 20220060772; 20220061767; 20220067651; 20220067705; 20220067706; 20220067707; 20220067708; 20220067709; 20220067710; 20220070010; 20220070011; 20220070610; 20220070627; 20220070628; 20220070629; 20220075812; 20220076257; 20220076287; 20220076293; 20220076812; 20220076851; 20220078210; 20220080246; 20220083046; 20220083047; 20220083048; 20220083622; 20220084015; 20220084055; 20220084633; 20220086201; 20220086242; 20220088493; 20220092056; 20220092215; 20220092218; 20220092278; 20220092619; 20220092635; 20220092643; 20220092649; 20220092686; 20220094531; 20220094544; 20220094554; 20220100825; 20220101326; 20220101599; 20220107988; 20220107999; 20220108262; 20220114584; 20220116335; 20220116364; 20220116401; 20220118618; 20220121731; 20220121779; 20220121884; 20220122426; 20220123948; 20220124396; 20220126864; 20220129064; 20220129171; 20220129587; 20220129938; 20220131699; 20220131844; 20220138223; 20220138594; 20220138640; 20220138760; 20220141615; 20220147535; 20220147578; 20220147579; 20220147580; 20220147694; 20220147988; 20220148035; 20220148041; 20220150570; 20220156475; 20220156652; 20220156754; 20220156759; 20220156799; 20220156812; 20220158855; 20220159419; 20220160309; 20220163959; 20220163960; 20220164879; 20220166459; 20220171825; 20220171826; 20220172206; 20220172207; 20220172208; 20220172250; 20220173893; 20220174039; 20220174491; 20220180053; 20220180382; 20220180612; 20220180990; 20220182221; 20220182363; 20220188883; 20220188925; 20220191581; 20220194400; 20220194401; 20220207579; 20220208155; 5220501; 5446919; 5734720; 5754938; 5754939; 5758257; 5781202; 5835087; 5870724; 6020883; 6029195; 6088722; 6134532; 6202054; 6286005; 6363411; 6400996; 6405203; 6453420; 6458060; 6460036; 6473794; 6519571; 6536037; 6571279; 6594355; 6607136; 6615166; 6631397; 6640145; 6647417; 6665489; 6708172; 6718551; 6721713; 6747755; 6779030; 6799201; 6834195; 6850252; 6868525; 6954525; 6957186; 6968333; 6981024; 6996579; 6997852; 7006881; 7013288; 7027178; 7055168; 7060006; 7076458; 7092821; 7103643; 7120592; 7136177; 7139731; 7146329; 7146627; 7149698; 7165041; 7166062; 7178107; 7181438; 7181691; 7194687; 7194688; 7197709; 7209900; 7209964; 7227942; 7231418; 7254824; 7257367; 7280975; 7289799; 7293279; 7305697; 7315826; 7330816; 7330828; 7370016; 7370342; 7370364; 7383309; 7386426; 7386517; 7415424; 7418451; 7424439; 7424677; 7424678; 7430633; 7433868; 7440674; 7451005; 7454193; 7455622; 7464086; 7464394; 7483871; 7484008; 7484236; 7509580; 7519529; 7530020; 7533082; 7546619; 7548915; 7552862; 7562028; 7562051; 7565328; 7567958; 7571177; 7574659; 7577620; 7577665; 7603106; 7603360; 7606562; 7610243; 7617122; 7628730; 7630986; 7645213; 7660581; 7669212; 7676394; 7693790; 7698236; 7699223; 7702318; 7706838; 7711475; 7711607; 7714778; 7715448; 7720687; 7720733; 7725730; 7730509; 7752209; 7753789; 7760969; 7761393; 7762453; 7769634; 7769764; 7774388; 7775440; 7778882; 7789800; 7792732; 7793824; 7801054; 7801879; 7801896; 7812717; 7813822; 7814004; 7814008; 7814522; 7821507; 7822564; 7822665; 7822762; 7840437; 7840484; 7844534; 7849004; 7853520; 7853600; 7855811; 7860871; 7865187; 7865567; 7885986; 7890420; 7890505; 7890552; 7891004; 7899015; 7899455; 7903029; 7904187; 7904337; 7904569; 7907940; 7912458; 7912770; 7917371; 7917491; 7921036; 7921069; 7925973; 7930215; 7933632; 7937314; 7958081; 7958457; 7961743; 7966078; 7970389; 7971784; 7974714; 7974869; 7976386; 7981000; 7983662; 7984169; 7987003; 7991677; 7991690; 8000893; 8010992; 8010993; 8020183; 8024245; 8027879; 8028314; 8028894; 8031060; 8036632; 8041717; 8042132; 8045455; 8045482; 8046797; 8050675; 8056100; 8060018; 8060507; 8060829; 8065185; 8065703; 8069168; 8069169; 8069202; 8073752; 8073768; 8078136; 8078485; 8078884; 8079118; 8081954; 8081956; 8082096; 8086509; 8090619; 8099434; 8099757; 8103545; 8103665; 8107940; 8108432; 8108895; 8116616; 8121874; 8121918; 8131271; 8131614; 8131737; 8132202; 8135413; 8136028; 8140402; 8140515; 8144182; 8146126; 8149827; 8156032; 8156128; 8156158; 8165916; 8170938; 8171032; 8175585; 8175945; 8175950; 8177634; 8180332; 8182346; 8187087; 8187101; 8192289; 8195133; 8195513; 8195550; 8200205; 8200700; 8200775; 8209344; 8214346; 8219134; 8221245; 8223938; 8224794; 8229914; 8229933; 8230089; 8234263; 8238888; 8239889; 8244593; 8244597; 8246466; 8249932; 8250600; 8260665; 8264352; 8270955; 8271365; 8274897; 8275635; 8277324; 8280766; 8285195; 8285598; 8285638; 8290351; 8290810; 8296178; 8296184; 8296213; 8301125; 8301454; 8301784; 8302030; 8302127; 8306890; 8311884; 8311885; 8311886; 8311888; 8311936; 8315933; 8315942; 8315950; 8316031; 8321267; 8322607; 8326671; 8326672; 8328088; 8332258; 8332397; 8332454; 8332517; 8340666; 8341020; 8341255; 8342928; 8344949; 8347088; 8351933; 8352343; 8358609; 8359019; 8359274; 8360870; 8364136; 8364521; 8364540; 8364582; 8364627; 8365212; 8365213; 8366550; 8369967; 8370362; 8374956; 8382590; 8396743; 8401918; 8407148; 8407220; 8413205; 8417612; 8423408; 8425332; 8429630; 8433297; 8438105; 8442849; 8442886; 8452832; 8457607; 8458083; 8458349; 8463249; 8463867; 8467774; 8468050; 8468271; 8473382; 8473410; 8478514; 8478673; 8483671; 8483674; 8484234; 8485906; 8489077; 8489482; 8489546; 8493213; 8494500; 8494914; 8494915; 8495679; 8495680; 8500562; 8503995; 8509680; 8509750; 8510773; 8511565; 8512143; 8512150; 8515400; 8515401; 8515925; 8516266; 8516529; 8521593; 8527353; 8527647; 8532633; 8532634; 8533013; 8533047; 8533048; 8533221; 8538812; 8538817; 8538869; 8542599; 8543456; 8543499; 8544048; 8549076; 8554192; 8554635; 8554653; 8554666; 8554667; 8554718; 8556723; 8560385; 8560537; 8560610; 8566111; 8566115; 8566207; 8566228; 8566229; 8572117; 8572677; 8577745; 8577894; 8578408; 8582584; 8583089; 8583263; 8585503; 8588830; 8589233; 8589247; 8590785; 8595058; 8595790; 8601595; 8606630; 8612293; 8612646; 8615434; 8615505; 8615719; 8620285; 8620765; 8620801; 8621343; 8626579; 8626736; 8626758; 8626818; 8627388; 8630929; 8631018; 8639567; 8639785; 8640160; 8641519; 8645572; 8645991; 8650083; 8655718; 8655738; 8655891; 8660539; 8660891; 8660894; 8666376; 8666851; 8667539; 8671021; 8671433; 8676961; 8679014; 8682770; 8688088; 8688671; 8690735; 8694362; 8694403; 8700738; 8701138; 8706557; 8707179; 8707343; 8712395; 8712846; 8712848; 8713603; 8718617; 8719090; 8725126; 8725567; 8725570; 8725700; 8725768; 8732091; 8732572; 8737972; 8738024; 8738418; 8738426; 8738545; 8738653; 8744906; 8744944; 8745658; 8751922; 8755776; 8756030; 8756102; 8756103; 8758201; 8762221; 8762302; 8768319; 8768731; 8768769; 8768876; 8769013; 8774777; 8775254; 8775255; 8775290; 8775301; 8775328; 8776111; 8781896; 8781897; 8781914; 8781933; 8781954; 8782069; 8784270; 8786438; 8787895; 8788337; 8788388; 8792909; 8793066; 8793252; 8798592; 8798594; 8798595; 8799076; 8799461; 8804695; 8805270; 8805339; 8806329; 8812526; 8813124; 8813143; 8819659; 8825683; 8825757; 8826139; 8831624; 8832100; 8837920; 8838629; 8838784; 8838982; 8843057; 8843391; 8843392; 8843395; 8843396; 8843481; 8843997; 8848891; 8849063; 8850465; 8850471; 8850473; 8855271; 8855469; 8856028; 8856229; 8856638; 8862978; 8863178; 8863245; 8868639; 8875027; 8880097; 8880431; 8881223; 8888497; 8892037; 8897344; 8898074; 8898250; 8903857; 8904271; 8909569; 8909590; 8909771; 8910268; 8914314; 8917716; 8924318; 8930806; 8935721; 8935742; 8938060; 8938755; 8938758; 8955029; 8958779; 8959563; 8965409; 8965803; 8972268; 8972396; 8976027; 8977232; 8977284; 8977566; 8977611; 8977721; 8989696; 8989718; 8990229; 8992329; 8995815; 8995963; 8995968; 8995973; 8996033; 8996659; 8997150; 9002754; 9009190; 9009783; 9020565; 9031860; 9031986; 9037516; 9046984; 9053494; 9058406; 9058619; 9058703; 9060208; 9063564; 9064010; 9064011; 9064288; 9069934; 9070101; 9071859; 9075909; 9076153; 9076175; 9077736; 9081802; 9082238; 9084931; 9087080; 9087332; 9098841; 9099090; 9110996; 9113343; 9117318; 9123022; 9124650; 9135665; 9135666; 9135764; 9137578; 9142071; 9142072; 9143535; 9145067; 9147296; 9147297; 9147298; 9148458; 9153084; 9153166; 9154824; 9154826; 9158372; 9159084; 9165301; 9165604; 9171396; 9172915; 9180362; 9182903; 9183569; 9183572; 9183685; 9195993; 9201885; 9201979; 9202084; 9202224; 9202232; 9203911; 9203912; 9210217; 9213985; 9218698; 9223878; 9230019; 9230379; 9235605; 9235849; 9235851; 9240011; 9253229; 9256761; 9256832; 9258133; 9262367; 9262772; 9268843; 9271023; 9277264; 9277292; 9282354; 9286388; 9286616; 9288547; 9292866; 9299077; 9300445; 9304827; 9305086; 9305411; 9305426; 9311639; 9311640; 9317983; 9324088; 9338054; 9338233; 9342835; 9349046; 9349234; 9361606; 9361631; 9361635; 9367820; 9367860; 9369330; 9369778; 9373149; 9378510; 9378601; 9384291; 9384493; 9384500; 9384609; 9384626; 9386150; 9386356; 9390423; 9390436; 9390441; 9391789; 9396475; 9396486; 9398022; 9398422; 9412273; 9424590; 9426537; 9430471; 9430781; 9436687; 9439036; 9443253; 9449279; 9449334; 9451019; 9451196; 9454772; 9460436; 9460557; 9465890; 9466075; 9466161; 9467723; 9467808; 9471851; 9471925; 9471926; 9474934; 9477967; 9477988; 9479803; 9483732; 9485537; 9490985; 9495226; 9495690; 9501476; 9501494; 9501783; 9503510; 9503691; 9508102; 9510320; 9519772; 9524597; 9529635; 9530150; 9531760; 9531886; 9532158; 9535563; 9536148; 9536361; 9542493; 9544379; 9544764; 9545930; 9553997; 9558502; 9558511; 9571666; 9571667; 9578088; 9584839; 9594597; 9594825; 9595068; 9596514; 9600569; 9613135; 9615054; 9619467; 9622010; 9626503; 9626678; 9626695; 9626699; 9633372; 9633456; 9635191; 9639854; 9639855; 9641882; 9646439; 9647778; 9654506; 9654648; 9654649; 9655034; 9659285; 9669299; 9672445; 9674372; 9674567; 9679299; 9684852; 9687180; 9692892; 9693086; 9697280; 9703892; 9703947; 9704102; 9705998; 9710821; 9712498; 9712788; 9716799; 9721308; 9721384; 9723450; 9727653; 9735833; 9736646; 9741030; 9747269; 9747603; 9753918; 9754287; 9760735; 9760802; 9760905; 9760907; 9767520; 9781478; 9785975; 9786143; 9794718; 9799042; 9799078; 9799373; 9800742; 9800933; 9800941; 9807049; 9811589; 9817547; 9820656; 9824408; 9826328; 9832610; 9836500; 9836883; 9838480; 9838758; 9846856; 9848169; 9848250; 9849364; 9852193; 9854330; 9854450; 9858546; 9858600; 9864970; 9866513; 9866925; 9872153; 9876775; 9877345; 9881127; 9881289; 9882955; 9888129; 9892293; 9894398; 9895578; 9907147; 9912483; 9916538; 9916611; 9918142; 9918319; 9921072; 9922338; 9922347; 9922380; 9922381; 9925466; 9930189; 9930290; 9930424; 9930425; 9936030; 9940612; 9942077; 9946985; 9947020; 9947037; 9947059; 9952680; 9953373; 9959359; 9959505; 9959554; 9960809; 9961383; 9967513; 9972021; 9972030; 9972034; 9972360; 9978106; 9980011; 9981192; 9984203; 9990422; 9990643; 9990646; 9992352; 9994229; 9996602; 9996626; 9996846; 9996853; 9996981; AU-2006240230; AU-2006261596; AU-2007204647; AU-2007327569; AU-2010200995; AU-2011250794; AU-2012239975; AU-2014374825; AU-2015243183; AU-2015263076; AU-2017292768; AU-2019213395; AU-2019375854; AU-6437001; BR-P10721764; CA-2319981; CA-2418074; CA-2418075; CA-2442842; CA-2484993; CA-2492118; CA-2605995; CA-2636062; CA-2641162; CA-2710431; CA-2713791; CA-2724364; CA-2776973; CA-2840083; CA-2845507; CA-2863124; CA-2887596; CA-2919925; CA-2929029; CA-2949348; CA-3028448; CA-3049394; CA-3073274; CA-3073275; CA-3119025; CN-101120377; CN-101268482; CN-101351783; CN-102754096; CN-104317822; CN-104919481; CN-104994581; CN-105122288; CN-106462881; CN-106656742; CN-107836002; CN-108292040; CN-108923939; CN-109165977; CN-111194278; CN-111225832; CN-111681033; CN-113079057; DK-2119079; EP-0765568; EP-1045322; EP-1314116; EP-1314118; EP-1721412; EP-1782374; EP-1839184; EP-1894152; EP-1920401; EP-1920410; EP-1929437; EP-1977378; EP-2003856; EP-2003857; EP-2085923; EP-2097860; EP-2119079; EP-2135204; EP-2164015; EP-2168086; EP-2225661; EP-2243327; EP-2270741; EP-2286603; EP-2316065; EP-2324450; EP-2384476; EP-2486532; EP-2545509; EP-2622431; EP-2622501; EP-2622557; EP-2622558; EP-2695085; EP-2779072; EP-2817774; EP-2823626; EP-2973325; EP-3090506; EP-3091494; EP-3129937; EP-3142394; EP-3143509; EP-3146487; EP-3189619; EP-3320501; EP-3326136; EP-3362970; EP-3405862; EP-3414713; EP-3428863; EP-3482302; EP-3482525; EP-3493132; EP-3511894; EP-3525496; EP-3541040; EP-3549083; EP-3563521; EP-3563596; EP-3565745; EP-3580716; EP-3583526; EP-3614328; EP-3616383; EP-3619627; EP-3639536; EP-3649570; EP-3649605; EP-3662331; EP-3668752; EP-3668755; EP-3671611; EP-3672828; EP-3673433; EP-3673615; EP-3682405; EP-3685343; EP-3687388; EP-3695339; EP-3743866; EP-3747153; EP-3759681; EP-3783865; EP-3785211; EP-3791236; EP-3791347; EP-3808113; EP-3811265; EP-3815020; EP-3821572; EP-3837634; EP-3844703; EP-3847606; EP-3852047; EP-3853803; EP-3861517; EP-3874440; EP-3874442; EP-3874443; EP-3877892; EP-3890237; EP-3891680; EP-3891691; EP-3891966; EP-3899846; EP-3924828; EP-3935563; EP-3942507; EP-3942508; EP-3947094; EP-3953883; EP-3956847; EP-3959679; EP-3963355; EP-3963866; EP-3966695; EP-3966735; EP-3970155; EP-3974994; EP-3975024; EP-3975025; EP-3983907; EP-3983981; EP-3985511; EP-4000999; EP-4004760; FR-2892547; FR-3076644; GB-2344017; GB-2442818; GB-2445877; GB-2449277; HU-E031574; IN-1177CH2014; IN-2009CN03093; IN-2010CN04208; IN-2010KN02407; IN-2010MN01690; IN-2010MN01703; IN-2012CN03434; IN-2013CN08847; IN-2014CH01177; IN-201617026466; JP-2001357312; JP-2002312664; JP-2008102855; JP-2008508619; JP-2008544380; JP-2009523376; JP-2009540474; JP-2009540770; JP-2010157269; JP-2012120197; JP-2013225904; JP-2013257784; JP-2014501049; JP-2014527668; JP-2015043637; JP-2016009229; JP-2016531359; JP-2017054224; JP-2019204514; JP-2020507500; JP-2021061010; JP-2021523439; JP-2022078134; JP-2022509040; JP-4734342; JP-5153814; JP-5172339; JP-5270781; JP-5660201; JP-5824007; JP-5925317; JP-5934460; JP-6042337; JP-6517325; JP-6576925; JP-6650233; JP-7030944; KR-100379611; KR-100384692; KR-100467011; KR-100616805; KR-100678569; KR-100807871; KR-100807872; KR-100807873; KR-100807876; KR-100807879; KR-101025312; KR-101085880; KR-101103048; KR-101120127; KR-101165905; KR-101196187; KR-101200048; KR-101228965; KR-101315861; KR-101432457; KR-101453343; KR-101503624; KR-101520298; KR-101539774; KR-101599249; KR-101646068; KR-101716873; KR-101733458; KR-101771537; KR-101804595; KR-101813082; KR-101818012; KR-101818013; KR-101861503; KR-101891671; KR-101911215; KR-101911653; KR-102041754; KR-102094724; KR-102122115; KR-102159331; KR-102171388; KR-102196001; KR-102198638; KR-102228105; KR-102234129; KR-102245602; KR-102253753; KR-102276006; KR-102318642; KR-102323551; KR-102344688; KR-20010007709; KR-20010082486; KR-20010090197; KR-20010094196; KR-20010097868; KR-20020010892; KR-20020024423; KR-20020029270; KR-20020059212; KR-20020094890; KR-20030024744; KR-20040082931; KR-20040091397; KR-20040093248; KR-20050022606; KR-20050083195; KR-20050111407; KR-20050111830; KR-20060006694; KR-20060080151; KR-20060080152; KR-20060080153; KR-20060080154; KR-20060080386; KR-20070050450; KR-20070106941; KR-20080109103; KR-20080111176; KR-20080114804; KR-20090016755; KR-20090070948; KR-20090070950; KR-20090070951; KR-20090076936; KR-20090087137; KR-20090095097; KR-20100077419; KR-20100114117; KR-20100114532; KR-20110026285; KR-20110112448; KR-20110116656; KR-20110120370; KR-20110121405; KR-20120115434; KR-20130012238; KR-20130012242; KR-20130055191; KR-20130060299; KR-20130062402; KR-20130084702; KR-20130100546; KR-20140000769; KR-20140013380; KR-20140053452; KR-20140072786; KR-20140078037; KR-20140112372; KR-20140135442; KR-20150005679; KR-20150005766; KR-20150087444; KR-20150093045; KR-20150093880; KR-20150102168; KR-20150129965; KR-20160035521; KR-20160080235; KR-20170008368; KR-20170030661; KR-20170038883; KR-20170052557; KR-20170133524; KR-20180016772; KR-20180054931; KR-20180116469; KR-20190000221; KR-20190027354; KR-20190081160; KR-20190081163; KR-20190082055; KR-20190082056; KR-20190120940; KR-20190129226; KR-20200114683; KR-20200124325; KR-20200125894; KR-20200129767; KR-20200137818; KR-20200139467; KR-20200145211; KR-20210009051; KR-20210020805; KR-20210022580; KR-20210073249; KR-20210101753; KR-20210129377; KR-20220018461; KR-20220018462; KR-20220018463; KR-20220018464; KR-20220032539; KR-20220052635; RE41137; RU-2468419; RU-2471235; RU-2562405; SK-50022009; SK-50052009; TW-200907844; TW-200907845; TW-200912789; TW-200919210; TW-200926033; TW-201224811; TW-201227355; TW-201227531; TW-201415393; TW-201523488; TW-201636933; TW-202207121; TW-202209222; TW-1333766; TW-1467504; TW-1478081; TW-1485638; TW-1502526; TW-1553574; TW-1582714; TW-1594201; TW-1701632; WO-1996032808; WO-1999046719; WO-2001022265; WO-2001075676; WO-2001076120; WO-2002011020; WO-2002011021; WO-2002015056; WO-2002082374; WO-2004008280; WO-2005036859; WO-2006026030; WO-2006062760; WO-2006115908; WO-2006116253; WO-2006124803; WO-2006135981; WO-2007011738; WO-2007011752; WO-2007014358; WO-2007016384; WO-2007016438; WO-2007061892; WO-2007082274; WO-2007098292; WO-2008040024; WO-2008048311; WO-2008063607; WO-2008064422; WO-2008108698; WO-2008108946; WO-2008138991; WO-2008152057; WO-2009002676; WO-2009005905; WO-2009070475; WO-2009076060; WO-2009082588; WO-2009085508; WO-2009086235; WO-2009094633; WO-2009097186; WO-2009099880; WO-2009099916; WO-2009146327; WO-2009158586; WO-2010000826; WO-2010087882; WO-2010118775; WO-2010151379; WO-2011013117; WO-2011019444; WO-2011044174; WO-2011061586; WO-2011112492; WO-2012001680; WO-2012001681; WO-2012047659; WO-2012047662; WO-2012047666; WO-2012047668; WO-2012047671; WO-2012047672; WO-2012047673; WO-2012048244; WO-2012060552; WO2012137882; WO-2012137882; WO-2012139072; WO-2013003797; WO-2013124840; WO-2013134753; WO-2013138203; WO-2014003226; WO-2014144269; WO-2014160135; WO-2015100496; WO-2015157716; WO-2015175033; WO-2015177525; WO-2015179020; WO-2015179424; WO-2015183789; WO-2015183793; WO-2015183807; WO-2015199025; WO-2016036969; WO-2016063092; WO-2016151469; WO-2017011169; WO-2017019646; WO-2017066002; WO-2017127564; WO-2017136956; WO-2017149537; WO-2017156047; WO-2018007828; WO-2018009521; WO-2018102044; WO-2018106974; WO-2018125989; WO-2018126075; WO-2018126077; WO-2018129343; WO-2018136944; WO-2018145195; WO-2018152410; WO-2018160724; WO-2018163032; WO-2018165763; WO-2018170504; WO-2018176006; WO-2018176008; WO-2018176010; WO-2018176011; WO-2018176012; WO-2018176013; WO-2018176014; WO-2018176017; WO-2018176047; WO-2018176048; WO-2018176049; WO-2018176050; WO-2018176051; WO-2018176052; WO-2018176053; WO-2018187873; WO-2018200332; WO-2018201009; WO-2018204822; WO-2018232304; WO-2018236765; WO-2019005098; WO-2019010063; WO-2019010064; WO-2019010065; WO-2019010067; WO-2019010068; WO-2019018437; WO-2019028269; WO-2019036058; WO-2019036059; WO-2019038442; WO-2019040620; WO-2019040651; WO-2019043668; WO-2019050870; WO-2019055703; WO-2019055713; WO-2019058404; WO-2019061249; WO-2019068035; WO-2019070477; WO-2019071113; WO-2019072823; WO-2019079708; WO-2019089078; WO-2019091371; WO-2019094153; WO-2019094729; WO-2019099357; WO-2019103944; WO-2019111007; WO-2019112631; WO-2019113308; WO-2019132516; WO-2019135851; WO-2019137957; WO-2019145826; WO-2019148210; WO-2019152750; WO-2019179625; WO-2019184881; WO-2019191088; WO-2019194388; WO-2019195479; WO-2019200466; WO-2019204213; WO-2019204670; WO-2019207297; WO-2019210138; WO-2019213672; WO-2019213700; WO-2019216975; WO-2019217323; WO-2019217555; WO-2019226489; WO-2019241106; WO-2019241153; WO-2019246568; WO-2020006478; WO-2020009317; WO-2020010159; WO-2020012200; WO-2020013183; WO-2020014399; WO-2020016779; WO-2020036710; WO-2020039573; WO-2020039602; WO-2020039771; WO-2020044341; WO-2020046906; WO-2020051160; WO-2020051226; WO-2020051598; WO-2020061132; WO-2020068155; WO-2020081105; WO-2020092351; WO-2020092426; WO-2020092446; WO-2020092900; WO-2020096752; WO-2020097115; WO-2020101412; WO-2020118047; WO-2020118273; WO-2020118297; WO-2020123464; WO-2020125839; WO-2020125840; WO-2020132084; WO-2020140911; WO-2020141584; WO-2020149790; WO-2020150228; WO-2020163465; WO-2020163508; WO-2020163514; WO-2020168114; WO-2020168115; WO-2020182591; WO-2020185525; WO-2020188349; WO-2020197612; WO-2020198409; WO-2020204004; WO-2020205597; WO-2020205642; WO-2020206204; WO-2020214485; WO-2020220029; WO-2020221413; WO-2020223588; WO-2020226979; WO-2020227300; WO-2020227429; WO-2020231001; WO-2020236481; WO-2020251592; WO-2020252460; WO-2020252479; WO-2021016265; WO-2021016268; WO-2021030288; WO-2021041746; WO-2021046551; WO-2021050346; WO-2021055635; WO-2021061399; WO-2021062160; WO-2021072296; WO-2021075080; WO-2021081137; WO-2021081178; WO-2021087173; WO-2021092260; WO-2021092263; WO-2021097000; WO-2021099802; WO-2021101945; WO-2021108003; WO-2021108680; WO-2021127211; WO-2021133939; WO-2021138342; WO-2021158300; WO-2021158702; WO-2021159096; WO-2021163521; WO-2021178445; WO-2021188040; WO-2021188561; WO-2021195187; WO-2021202094; WO-2021202920; WO-2021205485; WO-2021214760; WO-2021215906; WO-2021216597; WO-2021222384; WO-2021222669; WO-2021225844; WO-2021226374; WO-2021226375; WO-2021231052; WO-2021231911; WO-2021243153; WO-2021243154; WO-2021243159; WO-2021250022; WO-2021250037; WO-2021250045; WO-2021252042; WO-2021253020; WO-2021253021; WO-2021253022; WO-2021257829; WO-2022006320; WO-2022011289; WO-2022011293; WO-2022011296; WO-2022011299; WO-2022011300; WO-2022011301; WO-2022011302; WO-2022011304; WO-2022016020; WO-2022016102; WO-2022021997; WO-2022039796; WO-2022039911; WO-2022040366; WO-2022043750; WO-2022043751; WO-2022043752; WO-2022056176; WO-2022060961; WO-2022072626; WO-2022072921; WO-2022076036; WO-2022087328; WO-2022099180; WO-2022104286; WO-2022109428;
Asdemir, Kursad, Nanda Kumar, and Varghese S. Jacob. “Pricing online advertising: CPM vs. CPC.” Information Systems Research 23, no. 3-part-1 (2012): 804-822.
Barbu, Oana. “Advertising, microtargeting and social media.” Procedia-Social and Behavioral Sciences 163 (2014): 44-49.
Bimpikis, Kostas, Asuman Ozdaglar, and Ercan Yildiz. “Competitive targeted advertising over networks.” Operations Research 64, no. 3 (2016): 705-720.
Brown, Bruce C. The complete guide to affiliate marketing on the Web: How to use and profit from affiliate marketing programs. Atlantic Publishing Company, 2009.
Claxton, Christina M. “Private offerings in the age of surveillance capitalism and targeted advertising.” Vand. L. Rev. 74 (2021): 1187.
Edwards, Steven M. “A social media mindset.” Journal of interactive advertising 12, no. 1 (2011): 1-3.
Evans, David S. “The online advertising industry: Economics, evolution, and privacy.” Journal of economic perspectives 23, no. 3 (2009): 37-60.
Iyer, Ganesh, David Soberman, and J. Miguel Villas-Boas. “The targeting of advertising.” Marketing Science 24, no. 3 (2005): 461-476.
Knoll, Johannes. “Advertising in social media: a review of empirical evidence.” International journal of Advertising 35, no. 2 (2016): 266-300.
Lai, Juntao, Tao Cheng, and Guy Lansley. “Improved targeted outdoor advertising based on geotagged social media data.” Annals of GIS 23, no. 4 (2017): 237-250.
Lee, Dokyun, Kartik Hosanagar, and Harikesh S. Nair. “Advertising content and consumer engagement on social media: Evidence from Facebook.” Management Science 64, no. 11 (2018): 5105-5131.
Li, Yung-Ming, Lienfa Lin, and Shih-Wen Chiu. “Enhancing targeted advertising with social context endorsement.” International Journal of Electronic Commerce 19, no. 1 (2014): 99-128.
Liu, Stephanie Q., and Anna S. Mattila. “Airbnb: Online targeted advertising, sense of power, and consumer decisions.” International Journal of Hospitality Management 60 (2017): 33-41.
Maurer, Christian, and Rona Wiegmann. “Effectiveness of advertising on social network sites: a case study on Facebook.” In ENTER, pp. 485-498. 2011.
Mitra, Pinaki, and Kamal Baid. “Targeted advertising for online social networks.” In 2009 First International Conference on Networked Digital Technologies, pp. 366-372. IEEE, 2009.
Nair, Lekha R., Sujala D. Shetty, and Siddhant Deepak Shetty. “Streaming big data analysis for real-time sentiment based targeted advertising.” International Journal of Electrical and Computer Engineering 7, no. 1 (2017): 402.
Perlich, Claudia, Brian Dalessandro, Rod Hook, Ori Stitelman, Troy Raeder, and Foster Provost. “Bid optimizing and inventory scoring in targeted online advertising.” In Proceedings of the 18th ACM SIGKDD international conference on Knowledge discovery and data mining, pp. 804-812. 2012.
Plummer, Joe, Taddy Hall, Robert Barocci, and Stephen D. Rappaport. The online advertising playbook: Proven strategies and tested tactics from the advertising research foundation. John Wiley & Sons, 2007.
Saravanakumar, Murugesan, and T. SuganthaLakshmi. “Social media marketing.” Life science journal 9, no. 4 (2012): 4444-4451.
Speicher, Till, Muhammad Ali, Giridhari Venkatadri, Filipe Nunes Ribeiro, George Arvanitakis, Fabricio Benevenuto, Krishna P. Gummadi, Patrick Loiseau, and Alan Mislove. “Potential for discrimination in online targeted advertising.” In Conference on Fairness, Accountability and Transparency, pp. 5-19. PMLR, 2018.
Stephen, Andrew T. “The role of digital and social media marketing in consumer behavior.” Current opinion in Psychology 10 (2016): 17-21.
Tan, LeeAnn, See Hoe Ng, Azahadi Omar, and Tilakavati Karupaiah. “What's on YouTube? A case study on food and beverage advertising in videos targeted at children on social media.” Childhood obesity 14, no. 5 (2018): 280-290.
Tuten, Tracy L. Advertising 2.0: social media marketing in a web 2.0 world: social media marketing in a web 2.0 world. ABC-CLIO, 2008.
Wright, Elizabeth, Nile M. Khanfar, Catherine Harrington, and Lee E. Kizer. “The lasting effects of social media trends on advertising.” Journal of Business & Economics Research (JBER) 8, no. 11 (2010).
Zhang, Lu, Jialie Shen, Jian Zhang, Jingsong Xu, Zhibin Li, Yazhou Yao, and Litao Yu. “Multimodal marketing intent analysis for effective targeted advertising.” IEEE Transactions on Multimedia 24 (2021): 1830-1843.

3. Distributed Ledger and Blockchain

10002389; 10022613; 10022614; 10025797; 10042782; 10046228; 10068228; 10075298; 10089489; 10102510; 10114970; 10121019; 10121186; 10152756; 10160251; 10178069; 10187214; 10193696; 10195513; 10200834; 10230526; 10230530; 10231077; 10242219; 10243743; 10245875; 10252145; 10255635; 10269009; 10277400; 10297106; 10304143; 10320569; 10325257; 10325596; 10331123; 10338913; 10341121; 10346814; 10354236; 10354325; 10361859; 10366247; 10373158; 10380812; 10382388; 10396985; 10397328; 10417217; 10423921; 10423938; 10430751; 10432402; 10445643; 10454677; 10454878; 10454927; 10455742; 10460283; 10484178; 10489709; 10496923; 10498541; 10498542; 10504193; 10505740; 10509919; 10511580; 10521775; 10523421; 10528377; 10528551; 10529041; 10529042; 10530577; 10530859; 10532268; 10535063; 10536445; 10540344; 10540653; 10540654; 10552556; 10552829; 10554649; 10558825; 10567234; 10572872; 10574464; 10579974; 10581591; 10581805; 10581882; 10587413; 10592642; 10593157; 10594034; 10594488; 10600009; 10600050; 10611474; 10614456; 10614661; 10621653; 10628874; 10630463; 10635655; 10635801; 10636102; 10643266; 10650313; 10650376; 10650456; 10673626; 10679128; 10682981; 10692085; 10693654; 10698879; 10701054; 10713564; 10715463; 10722802; 10726472; 10733160; 10740139; 10740733; 10740849; 10741025; 10747201; 10749676; 10749865; 10755327; 10757007; 10762052; 10762079; 10762506; 10762516; 10764034; 10764325; 10776696; 10776879; 10783164; 10785032; 10785168; 10789179; 10789222; 10789590; 10789597; 10789628; 10790963; 10790990; 10795857; 10795977; 10796000; 10796022; 10803537; 10810546; 10811771; 10812270; 10817953; 10824740; 10825295; 10832310; 10832522; 10833843; 10835825; 10839107; 10839320; 10839379; 10839386; 10841079; 10841237; 10841307; 10841372; 10846281; 10846733; 10846984; 10853341; 10853812; 10855617; 10855758; 10855778; 10861008; 10861037; 10868674; 10868865; 10873559; 10878500; 10878522; 10880080; 10885740; 10887100; 10892887; 10896418; 10902140; 10902320; 10902852; 10905337; 10909317; 10909529; 10909534; 10911241; 10915891; 10916845; 10922304; 10924363; 10928803; 10929473; 10929929; 10931440; 10936723; 10936957; 10937096; 10938835; 10939405; 10943307; 10946278; 10949793; 10949812; 10949922; 10951543; 10951626; 10956377; 10956444; 10956973; 10962965; 10963854; 10965673; 10970411; 10970413; 10977647; 10980155; 10984134; 10984410; 10984470; 10984472; 10986169; 10986177; 10997125; 10997251; 10997551; 11004072; 11009859; 11010370; 11016456; 11017329; 11017381; 11017469; 11020668; 11021171; 11025409; 11025434; 11025626; 11030175; 11030699; 11030841; 11032215; 11032399; 11036720; 11038690; 11038771; 11038891; 11042147; 11042518; 11042801; 11042804; 11042849; 11042878; 11044308; 11048825; 11055676; 11057189; 11062305; 11063744; 11068990; 11069196; 11070231; 11074061; 11074640; 11079127; 11079128; 11080777; 11082203; 11087214; 11087313; 11088827; 11088844; 11089051; 11100284; 11100483; 11100510; 11100565; 11102202; 11107168; 11108820; 11112132; 11113272; 11113410; 11115218; 11120335; 11121880; 11126617; 11126659; 11126975; 11128472; 11130042; 11133983; 11138330; 11139081; 11139955; 11139956; 11139972; 11144911; 11145017; 11146380; 11146394; 11151549; 11153098; 11153621; 11154783; 11157899; 11158164; 11163280; 11164107; 11164115; 11164251; 11165582; 11169976; 11169985; 11170092; 11177939; 11177941; 11182380; 11182775; 11183016; 11184437; 11186111; 11188384; 11188899; 11188977; 11189368; 11190342; 11192033; 11194961; 11195015; 11195231; 11200499; 11200546; 11200569; 11204597; 11205102; 11205162; 11207584; 11212107; 11212296; 11212665; 11216429; 11216750; 11216895; 11218324; 11223608; 11223647; 11227350; 11228439; 11233655; 11238164; 11238325; 11238546; 11240002; 11240025; 11240040; 11243943; 11244309; 11244313; 11245757; 11250125; 11251963; 11252166; 11256881; 11257073; 11257105; 11258614; 11260304; 11263315; 11265171; 11271991; 11276014; 11277390; 11281660; 11281751; 11281779; 11281800; 11282139; 11283857; 11283865; 11288247; 11288280; 11288641; 11290280; 11290294; 11290441; 11295359; 11296873; 11297459; 11301452; 11301602; 11301936; 11303603; 11308461; 11308487; 11308754; 11310051; 11314699; 11314722; 11315017; 11316385; 11316690; 11316692; 11316933; 11321282; 11321718; 11323272; 11331579; 11334875; 11334876; 11334882; 11334883; 11334925; 11336011; 11336589; 11338204; 11341102; 11341123; 11341267; 11341573; 11343075; 11347535; 11347769; 11347878; 11349824; 11354629; 11354744; 11356279; 11361054; 11361228; 11361286; 11361388; 11367055; 11367071; 11368527; 11369878; 11373187; 11373259; 11375404; 20150170112; 20150310476; 20150356524; 20150356555; 20160012465; 20160098723; 20160098730; 20160140653; 20160191243; 20160218879; 20160261411; 20160267472; 20160267474; 20160284033; 20160350749; 20160379212; 20170011392; 20170046652; 20170046664; 20170111175; 20170134161; 20170155515; 20170161439; 20170206522; 20170206523; 20170206603; 20170206604; 20170221029; 20170222814; 20170232300; 20170236120; 20170236123; 20170236196; 20170242475; 20170250796; 20170256000; 20170256001; 20170256003; 20170300872; 20170300875; 20170300877; 20170301033; 20170301047; 20170323392; 20170337534; 20170345105; 20170352012; 20170359374; 20170364450; 20170364698; 20170364699; 20170364700; 20170364701; 20170364908; 20170366353; 20170372278; 20180001184; 20180005318; 20180012311; 20180018723; 20180019984; 20180025365; 20180039667; 20180040007; 20180053182; 20180075527; 20180078843; 20180082296; 20180089651; 20180094953; 20180096175; 20180117446; 20180117447; 20180121673; 20180129700; 20180130034; 20180130050; 20180133583; 20180136633; 20180137503; 20180137512; 20180143995; 20180144292; 20180152289; 20180152442; 20180174122; 20180174188; 20180181904; 20180181909; 20180181964; 20180189449; 20180189730; 20180197172; 20180198630; 20180204416; 20180205552; 20180205558; 20180211718; 20180214777; 20180216946; 20180218027; 20180218176; 20180227130; 20180227131; 20180232817; 20180234433; 20180240107; 20180247191; 20180248699; 20180253691; 20180253702; 20180262493; 20180264347; 20180268483; 20180270244; 20180276626; 20180285839; 20180285840; 20180285996; 20180287997; 20180294956; 20180294967; 20180307857; 20180314539; 20180323964; 20180326291; 20180331832; 20180336552; 20180337769; 20180337882; 20180341861; 20180341930; 20180342007; 20180343120; 20180349879; 20180349896; 20180349968; 20180357603; 20180357683; 20180373983; 20180373984; 20180374283; 20190007381; 20190012466; 20190018984; 20190019180; 20190025817; 20190025818; 20190026828; 20190028276; 20190034892; 20190043024; 20190043050; 20190044725; 20190044734; 20190058581; 20190058590; 20190065709; 20190073666; 20190075686; 20190080392; 20190081789; 20190086235; 20190087793; 20190089155; 20190095879; 20190096191; 20190101896; 20190102409; 20190102423; 20190102736; 20190102837; 20190102850; 20190104102; 20190104196; 20190108232; 20190108498; 20190108499; 20190108513; 20190109713; 20190116047; 20190122186; 20190122208; 20190123889; 20190123892; 20190130086; 20190130399; 20190130698; 20190130701; 20190139032; 20190139159; 20190140935; 20190149336; 20190156301; 20190156363; 20190158594; 20190163672; 20190164156; 20190171438; 20190171838; 20190172023; 20190173854; 20190180237; 20190180291; 20190180558; 20190182030; 20190182048; 20190188411; 20190188654; 20190188732; 20190199514; 20190199516; 20190205558; 20190205563; 20190205773; 20190205870; 20190205873; 20190205894; 20190205970; 20190207767; 20190207951; 20190207995; 20190208354; 20190208422; 20190220324; 20190220603; 20190220813; 20190220836; 20190221076; 20190222424; 20190222575; 20190228407; 20190228409; 20190228461; 20190230070; 20190236286; 20190236559; 20190236562; 20190236594; 20190236598; 20190236606; 20190236698; 20190236716; 20190238316; 20190238319; 20190238525; 20190243820; 20190244227; 20190244531; 20190251187; 20190251199; 20190251627; 20190259120; 20190268138; 20190268466; 20190279204; 20190279210; 20190279215; 20190279247; 20190281030; 20190282906; 20190287107; 20190288850; 20190289454; 20190295182; 20190295193; 20190295371; 20190296915; 20190302249; 20190303622; 20190303807; 20190303886; 20190303892; 20190305933; 20190305938; 20190306137; 20190306190; 20190311148; 20190311343; 20190312734; 20190318117; 20190319861; 20190319968; 20190323858; 20190325115; 20190325430; 20190325502; 20190327180; 20190327292; 20190332702; 20190332921; 20190332955; 20190333054; 20190339668; 20190339678; 20190339684; 20190339685; 20190339686; 20190339687; 20190339688; 20190340013; 20190340170; 20190340269; 20190340379; 20190340467; 20190340588; 20190340627; 20190340645; 20190340686; 20190340707; 20190340715; 20190340716; 20190342095; 20190347105; 20190347433; 20190349371; 20190349372; 20190349426; 20190354076; 20190354374; 20190354518; 20190354611; 20190354723; 20190354962; 20190355031; 20190358515; 20190358543; 20190361842; 20190361869; 20190361917; 20190362716; 20190363874; 20190370486; 20190370760; 20190370789; 20190370793; 20190370813; 20190370925; 20190372756; 20190373047; 20190375373; 20190378134; 20190378224; 20190379546; 20190379642; 20190384927; 20190385153; 20190385154; 20190385183; 20190385215; 20190386969; 20190386986; 20190392386; 20190392489; 20190392511; 20200005254; 20200005290; 20200005292; 20200005410; 20200007317; 20200007331; 20200008320; 20200013027; 20200014529; 20200014668; 20200019626; 20200020032; 20200021589; 20200027089; 20200027096; 20200034353; 20200034548; 20200034551; 20200034571; 20200034712; 20200042635; 20200042657; 20200043115; 20200050786; 20200050797; 20200051076; 20200051092; 20200051184; 20200052898; 20200058055; 20200059354; 20200059363; 20200059369; 20200063999; 20200064783; 20200064815; 20200065794; 20200067713; 20200068009; 20200073560; 20200074422; 20200074424; 20200074460; 20200074468; 20200074778; 20200076613; 20200076829; 20200082266; 20200082359; 20200082362; 20200082363; 20200082364; 20200082398; 20200084019; 20200084041; 20200084217; 20200088602; 20200090156; 20200090193; 20200090228; 20200092085; 20200097639; 20200097974; 20200097988; 20200098057; 20200098058; 20200098059; 20200098060; 20200098061; 20200098062; 20200098063; 20200098064; 20200098066; 20200098067; 20200098068; 20200098069; 20200098070; 20200099512; 20200101367; 20200103894; 20200104156; 20200104157; 20200104158; 20200104178; 20200104428; 20200104712; 20200104809; 20200104836; 20200104867; 20200104871; 20200104872; 20200104873; 20200104932; 20200104949; 20200104955; 20200104956; 20200106605; 20200108840; 20200110728; 20200110740; 20200110821; 20200111065; 20200111112; 20200111178; 20200111179; 20200111180; 20200111181; 20200111182; 20200112442; 20200112443; 20200117690; 20200118224; 20200119906; 20200127813; 20200128022; 20200133254; 20200133255; 20200133256; 20200133257; 20200133955; 20200134586; 20200134606; 20200134656; 20200136807; 20200137064; 20200137082; 20200137154; 20200137176; 20200142728; 20200142739; 20200142905; 20200143085; 20200145216; 20200145366; 20200150643; 20200150644; 20200150645; 20200150994; 20200151353; 20200151712; 20200151817; 20200151842; 20200152005; 20200153627; 20200153793; 20200155944; 20200159206; 20200159207; 20200160319; 20200160455; 20200160465; 20200161858; 20200162239; 20200162251; 20200162268; 20200162550; 20200166922; 20200166923; 20200167145; 20200167341; 20200167345; 20200167367; 20200167503; 20200167512; 20200167779; 20200167870; 20200169125; 20200169387; 20200169388; 20200169407; 20200169546; 20200174463; 20200174464; 20200175155; 20200175156; 20200177372; 20200177519; 20200177604; 20200183898; 20200183915; 20200186335; 20200186336; 20200186355; 20200186568; 20200192957; 20200193418; 20200193432; 20200195421; 20200195497; 20200195758; 20200200090; 20200201679; 20200201681; 20200201877; 20200201910; 20200202312; 20200202334; 20200202336; 20200204352; 20200204375; 20200204524; 20200210451; 20200210519; 20200210978; 20200212932; 20200213130; 20200213329; 20200219045; 20200219362; 20200220881; 20200225643; 20200225649; 20200225655; 20200226114; 20200226123; 20200226629; 20200226687; 20200227160; 20200228316; 20200228342; 20200234351; 20200234386; 20200236168; 20200238952; 20200242200; 20200242577; 20200242595; 20200244463; 20200249950; 20200249951; 20200249952; 20200249953; 20200250174; 20200250176; 20200250177; 20200250295; 20200250374; 20200250549; 20200250590; 20200250661; 20200250683; 20200250698; 20200250747; 20200250752; 20200250778; 20200250780; 20200251213; 20200252205; 20200252404; 20200252406; 20200258020; 20200259633; 20200259643; 20200265356; 20200265511; 20200267003; 20200267163; 20200268260; 20200272469; 20200272470; 20200272471; 20200272472; 20200272473; 20200272618; 20200273003; 20200274694; 20200274695; 20200274830; 20200278963; 20200279232; 20200279249; 20200279309; 20200279321; 20200280443; 20200280546; 20200286050; 20200293321; 20200293322; 20200293323; 20200293324; 20200293325; 20200293326; 20200293327; 20200294006; 20200294034; 20200294143; 20200294417; 20200296128; 20200302300; 20200302409; 20200302429; 20200302745; 20200311566; 20200311666; 20200311670; 20200311675; 20200311697; 20200311698; 20200313894; 20200313897; 20200320097; 20200320582; 20200320825; 20200327629; 20200328892; 20200333765; 20200334653; 20200334669; 20200334773; 20200334945; 20200336475; 20200338438; 20200342319; 20200342449; 20200344132; 20200344233; 20200344292; 20200348662; 20200349142; 20200349532; 20200351098; 20200351657; 20200356082; 20200358183; 20200358184; 20200358812; 20200364187; 20200364682; 20200364817; 20200366950; 20200371995; 20200372501; 20200372578; 20200374105; 20200374106; 20200374113; 20200379537; 20200379769; 20200379770; 20200379771; 20200382480; 20200385320; 20200387379; 20200387432; 20200387896; 20200389292; 20200389309; 20200389312; 20200389519; 20200394165; 20200394531; 20200394626; 20200394652; 20200394671; 20200394673; 20200394708; 20200394709; 20200396065; 20200396082; 20200396251; 20200401578; 20200401678; 20200401729; 20200402091; 20200402138; 20200403809; 20200403899; 20200410349; 20200410461; 20210004366; 20210004473; 20210004777; 20210004792; 20210006478; 20210006506; 20210011892; 20210012326; 20210012420; 20210012447; 20210012894; 20210014060; 20210014071; 20210015252; 20210016178; 20210018953; 20210019429; 20210019740; 20210021607; 20210026740; 20210026840; 20210027289; 20210035092; 20210035094; 20210035096; 20210037008; 20210042830; 20210049562; 20210049715; 20210052976; 20210056088; 20210056542; 20210058382; 20210064780; 20210064784; 20210065070; 20210065322; 20210065516; 20210067511; 20210073177; 20210073212; 20210073736; 20210073795; 20210073804; 20210073913; 20210075623; 20210081374; 20210082044; 20210083852; 20210083876; 20210084005; 20210084105; 20210090036; 20210090037; 20210090170; 20210090189; 20210097528; 20210097537; 20210097538; 20210097561; 20210097562; 20210097602; 20210099279; 20210099294; 20210099311; 20210099312; 20210104167; 20210105148; 20210106236; 20210109534; 20210109917; 20210110342; 20210110388; 20210110827; 20210117410; 20210117962; 20210118072; 20210118085; 20210126800; 20210132582; 20210133888; 20210135932; 20210144149; 20210149878; 20210150298; 20210150522; 20210151884; 20210152354; 20210152364; 20210152535; 20210152536; 20210157312; 20210157859; 20210157947; 20210157982; 20210158229; 20210158384; 20210158441; 20210158448; 20210160077; 20210160080; 20210160235; 20210160309; 20210165400; 20210166126; 20210166310; 20210166311; 20210166327; 20210174316; 20210174426; 20210174427; 20210174432; 20210174442; 20210174641; 20210176045; 20210182277; 20210182423; 20210182837; 20210182895; 20210182968; 20210184836; 20210192473; 20210192514; 20210192526; 20210201305; 20210201328; 20210201625; 20210203584; 20210209077; 20210209483; 20210209885; 20210217091; 20210218720; 20210224256; 20210224801; 20210226769; 20210226773; 20210226774; 20210232707; 20210232937; 20210233023; 20210235362; 20210240858; 20210241149; 20210241241; 20210243007; 20210243193; 20210248514; 20210248594; 20210248621; 20210250353; 20210250812; 20210252407; 20210255995; 20210256016; 20210256070; 20210258142; 20210263905; 20210264387; 20210264520; 20210264532; 20210264539; 20210266170; 20210266174; 20210271778; 20210271877; 20210272075; 20210272205; 20210273806; 20210273993; 20210278820; 20210281569; 20210287234; 20210287285; 20210288817; 20210291690; 20210295159; 20210295320; 20210295321; 20210296963; 20210297368; 20210298195; 20210304155; 20210311916; 20210312081; 20210312291; 20210312444; 20210312447; 20210314140; 20210314143; 20210314164; 20210314395; 20210314396; 20210318735; 20210319428; 20210319429; 20210319430; 20210319431; 20210319432; 20210319433; 20210326845; 20210326846; 20210326847; 20210326848; 20210326849; 20210326850; 20210326851; 20210326852; 20210326853; 20210326854; 20210326855; 20210326856; 20210326857; 20210328806; 20210334176; 20210334796; 20210334881; 20210336769; 20210336785; 20210337023; 20210337033; 20210342363; 20210342800; 20210342825; 20210342836; 20210342849; 20210342940; 20210342957; 20210343122; 20210344496; 20210350289; 20210350368; 20210350443; 20210352080; 20210352083; 20210352139; 20210354295; 20210356941; 20210357029; 20210357893; 20210358015; 20210358032; 20210365867; 20210365918; 20210365948; 20210366056; 20210374266; 20210374539; 20210374693; 20210377310; 20210382860; 20210382875; 20210383232; 20210383334; 20210385246; 20210390549; 20210391993; 20210391997; 20210397998; 20210407001; 20210409230; 20210409799; 20220004925; 20220004926; 20220004927; 20220005023; 20220006641; 20220006705; 20220012672; 20220012700; 20220021538; 20220023742; 20220026877; 20220027344; 20220027345; 20220027496; 20220027803; 20220027894; 20220029786; 20220029811; 20220029815; 20220035623; 20220036343; 20220036350; 20220036366; 20220036448; 20220038285; 20220040557; 20220043831; 20220044334; 20220045860; 20220046027; 20220050433; 20220050887; 20220051276; 20220051358; 20220052853; 20220052855; 20220057519; 20220058282; 20220058624; 20220058625; 20220058626; 20220058627; 20220058628; 20220058629; 20220058630; 20220058631; 20220058632; 20220058633; 20220058634; 20220058635; 20220058636; 20220058700; 20220060484; 20220067035; 20220067705; 20220067706; 20220067707; 20220067708; 20220067709; 20220067710; 20220067715; 20220067725; 20220067738; 20220067752; 20220067831; 20220076246; 20220076354; 20220078014; 20220083046; 20220083047; 20220083048; 20220083988; 20220084015; 20220084368; 20220084665; 20220092586; 20220092592; 20220092593; 20220092910; 20220100724; 20220100846; 20220101318; 20220103341; 20220103343; 20220103344; 20220103364; 20220107958; 20220108262; 20220108313; 20220122062; 20220122425; 20220123941; 20220123948; 20220129475; 20220129546; 20220129847; 20220131699; 20220138182; 20220138594; 20220138640; 20220138878; 20220141037; 20220141198; 20220141231; 20220148025; 20220150050; 20220150257; 20220156475; 20220156652; 20220156856; 20220158844; 20220158855; 20220159069; 20220163959; 20220163960; 20220165384; 20220166626; 20220171877; 20220172203; 20220172206; 20220172207; 20220172208; 20220173893; 20220174059; 20220174077; 20220180333; 20220180374; 20220182221; 20220187847; 20220188296; 20220188815; 20220189256; 20220191272; 20220193915; 20220196889; 20220197246; 20220197247; 20220197306; 20220197625; 20220198410; 20220198418; 20220198441; 20220198458; 20220198562; 20220207019; 20220207159; 20220209963; 20220210266; 9667427; 9749140; 9818092; 9849364; 9855785; 9862222; 9875510; 9881176; 9892460; 9898782; 9922380; 9922381; 9965804; 9965805; 9973341; 9992028;
Narayanan, Arvind; Bonneau, Joseph; Felten, Edward; Miller, Andrew; Goldfeder, Steven (2016). Bitcoin and cryptocurrency technologies: a comprehensive introduction. Princeton: Princeton University Press. ISBN 978-0-691-17169-2.
lansiti, Marco; Lakhani, Karim R. (January 2017). “The Truth About Blockchain”. Harvard Business Review. Harvard University.
Bakos, Yannis; Halaburda, Hanna; Mueller-Bloch, Christoph (February 2021). “When Permissioned Blockchains Deliver More Decentralization Than Permissionless”. Communications of the ACM. 64 (2): 20-22. doi:10.1145/3442371. S2CID 231704491.
Sherman, Alan T.; Javani, Farid; Zhang, Haibin; Golaszewski, Enis (January 2019). “On the Origins and Variations of Blockchain Technologies”. IEEE Security Privacy. 17 (1): 72-77. arXiv:1810.06130. doi:10.1109/MSEC.2019.2893730. ISSN 1558-4046. S2CID 53114747.
Haber, Stuart; Stornetta, W. Scott (January 1991). “How to time-stamp a digital document”. Journal of Cryptology. 3 (2): 99-111. CiteSeerX 10.1.1.46.8740. doi:10.1007/bf00196791. S2CID 14363020.
Bayer, Dave; Haber, Stuart; Stornetta, W. Scott (March 1992). Improving the Efficiency and Reliability of Digital Time-Stamping. Sequences. 2. pp. 329-334. CiteSeerX 10.1.1.71.4891. doi:10.1007/978-1-4613-9323-8_24. ISBN 978-1-4613-9325-2.
Catalini, Christian; Gans, Joshua S. (23 Nov. 2016). “Some Simple Economics of the Blockchain”; SSRN. doi:10.2139/ssrn.2874598. hdl:1721.1/130500. S2CID 46904163. SSRN 2874598.
Chen, Huashan; Pendleton, Marcus; Njilla, Laurent; Xu, Shouhuai (12 Jun. 2020). “A Survey on Ethereum Systems Security: Vulnerabilities, Attacks, and Defenses”. ACM Computing Surveys. 53 (3): 3-4. arXiv:1908.04507. doi:10.1145/3391195. ISSN 0360-0300. S2CID 199551841.
Bhaskar, Nirupama Devi; Chuen, David LEE Kuo (2015). “Bitcoin Mining Technology”. Handbook of Digital Currency. pp. 45-65. doi:10.1016/B978-0-12-802117-0.00003-5. ISBN 978-0-12-802117-0.
Antonopoulos, Andreas (20 Feb. 2014). “Bitcoin security model: trust by computation”. Radar. O'Reilly.
Antonopoulos, Andreas M. (2014). Mastering Bitcoin. Unlocking Digital Cryptocurrencies. Sebastopol, CA: O'Reilly Media. ISBN 978-1449374037.
Nakamoto, Satoshi (October 2008). “Bitcoin: A Peer-to-Peer Electronic Cash System”; bitcoin.org.
Kumar, Randhir; Tripathi, Rakesh (November 2019). “Implementation of Distributed File Storage and Access Framework using IPFS and Blockchain”. 2019 Fifth International Conference on Image Information Processing (ICIIP). IEEE: 246-251. doi:10.1109/iciip47207.2019.8985677. ISBN 978-1-7281-0899-5. S2CID 211119043.
Brito, Jerry; Castillo, Andrea (2013). Bitcoin: A Primer for Policymakers. Fairfax, VA: Mercatus Center, George Mason University.
Raval, Siraj (2016). Decentralized Applications: Harnessing Bitcoin's Blockchain Technology. O'Reilly Media, Inc. pp. 1-2. ISBN 978-1-4919-2452-5.
Kopfstein, Janus (12 Dec. 2013). “The Mission to Decentralize the Internet”. The New Yorker.
Gervais, Arthur; Karame, Ghassan O.; Capkun, Vedran; Capkun, Srdjan. “Is Bitcoin a Decentralized Currency?”. InfoQ. InfoQ & IEEE computer society.
Tapscott, Don; Tapscott, Alex (May 2016). The Blockchain Revolution: How the Technology Behind Bitcoin is Changing Money, Business, and the World. ISBN 978-0-670-06997-2.
Bob Marvin (30 Aug. 2017). “Blockchain: The Invisible Technology That's Changing the World”. PC MAG Australia. ZiffDavis, LLC.
Christian Brenig, Rafael Accorsi & Günter Müller (Spring 2015). “Economic Analysis of Cryptocurrency Backed Money Laundering”. Association for Information Systems AIS Electronic Library (AISeL).
Orcutt, Mike. “It's getting harder to hide money in Bitcoin”. MIT Technology Review. Retrieved 15 May 2019.
“An Untraceable Currency? Bitcoin Privacy Concerns—FinTech Weekly”. FinTech Magazine Article. 7 Apr. 2018.
“Blockchain”. standards.org.au. Standards Australia. Retrieved 21 Jun. 2021.
“ISO/TC 307 Blockchain and distributed ledger technologies”. iso.org. ISO.
Deshmukh, Sumedha; Boulais, Océane; Koens, Tommy. “Global Standards Mapping Initiative: An overview of blockchain technical standards”; weforum.org. World Economic Forum.
“Blockchain Overview”. NIST. 25 Sep. 2019.
“CEN and CENELEC publish a White Paper on standards in Blockchain & Distributed Ledger Technologies”. cencenelec.eu.
“Standards”. blockchain.ieee.org/standards. IEEE Blockchain.
Hardjono, Thomas. “An Interoperability Architecture for Blockchain/DLT Gateways”. ietf.org. IETF.
Franco, Pedro (2014). Understanding Bitcoin: Cryptography, Engineering and Economics. John Wiley & Sons. p. 9. ISBN 978-1-119-01916-9.
Casey, Michael, 1967-(16 Jul. 2018). The impact of blockchain technology on finance: a catalyst for change. London, UK. ISBN 978-1-912179-15-2. OCLC 1059331326.
Chaum, David “Computer Systems Established, Maintained, and Trusted by Mutually Suspicious Groups” (1982).
Governatori, Guido; Idelberger, Florian; Milosevic, Zoran; Riveret, Regis; Sartor, Giovanni; Xu, Xiwei (2018). “On legal contracts, imperative and declarative smart contracts, and blockchain systems”. Artificial Intelligence and Law. 26 (4): 33. doi:10.1007/s10506-018-9223-3. S2CID 3663005.
Andoni, Merlinda; Robu, Valentin; Flynn, David; Abram, Simone; Geach, Dale; Jenkins, David; McCallum, Peter; Peacock, Andrew (2019). “Blockchain technology in the energy sector: A systematic review of challenges and opportunities”. Renewable and Sustainable Energy Reviews. 100: 143-174. doi:10.1016/j.rser.2018.10.014. S2CID 116422191.
Ma, Jinhua; Lin, Shih-Ya; Chen, Xin; Sun, Hung-Min; Chen, Yeh-Cheng; Wang, Huaxiong (2020). “A Blockchain-Based Application System for Product Anti-Counterfeiting”. IEEE Access. 8: 77642-77652. doi:10.1109/ACCESS.2020.2972026. ISSN 2169-3536. S2CID 214205788.
Alzahrani, Naif; Bulusu, Nirupama (15 Jun. 2018). “Block-Supply Chain: A New Anti-Counterfeiting Supply Chain Using NFC and Blockchain”. Proceedings of the 1st Workshop on Cryptocurrencies and Blockchains for Distributed Systems. CryBlock'18. Munich, Germany: Association for Computing Machinery: 30-35. doi:10.1145/3211933.3211939. ISBN 978-1-4503-5838-5. S2CID 169188795.
Balagurusamy, V. S. K.; Cabral, C.; Coomaraswamy, S.; Delamarche, E.; Dillenberger, D. N.; Dittmann, G.; Friedman, D.; Gökge, O.; Hinds, N.; Jelitto, J.; Kind, A. (1 Mar. 2019). “Crypto anchors”. IBM Journal of Research and Development. 63 (2/3): 4:1-4:12. doi:10.1147/JRD.2019.2900651. ISSN 0018-8646. S2CID 201109790.
K. Kotobi, and S. G. Bilen, “Secure Blockchains for Dynamic Spectrum Access: A Decentralized Database in Moving Cognitive Radio Networks Enhances Security and User Access”, IEEE Vehicular Technology Magazine, 2018.
Gatteschi, Valentina; Lamberti, Fabrizio; Demartini, Claudio; Pranteda, Chiara; Santamaria, Victor (20 Feb. 2018). “Blockchain and Smart Contracts for Insurance: Is the Technology Mature Enough?”. Future Internet. 10 (2): 20. doi:10.3390/fi10020020.
Melanie Swan (2015). “Proof_of_Existence” Blockchain: Blueprint for a New Economy. O'Reilly Media. pp. 38-39. ISBN 9781491920473.
Distributed Ledger Technology: Hybrid Approach, Front-to-Back Designing and Changing Trade Processing Infrastructure, By Martin Walker, First published: 24 Oct. 2018 ISBN 978-1-78272-389-9
Siraj Raval (18 Jul. 2016). Decentralized Applications: Harnessing Bitcoin's Blockchain Technology. “O'Reilly Media, Inc.”. pp. 22-. ISBN 978-1-4919-2452-5.
Niaz Chowdhury (16 Aug. 2019). Inside Blockchain, Bitcoin, and Cryptocurrencies. CRC Press. pp. 22-. ISBN 978-1-00-050770-6.
U.S. Pat. No. 10,438,290
Wegner, Peter (March 1996). “Interoperability”. ACM Computing Surveys. 28: 285-287. doi:10.1145/234313.234424. Retrieved 24 Oct. 2020.
Belchior, Rafael; Vasconcelos, André; Guerreiro, Sérgio; Correia, Miguel (May 2020). “A Survey on Blockchain Interoperability: Past, Present, and Future Trends”. arXiv:2005.14282.
Hardjono, T.; Hargreaves, M.; Smith, N. (2 Oct. 2020). An Interoperability Architecture for Blockchain Gateways (Technical report). IETF. draft-hardjono-blockchain-interop-arch-00.
Köhler, Susanne; Pizzol, Massimo (20 Nov. 2019). “Life Cycle Assessment of Bitcoin Mining”. Environmental Science & Technology. 53 (23): 13598-13606. Bibcode:2019EnST . . . 5313598K. doi:10.1021/acs.est.9b05687. PMID 31746188.
Stoll, Christian; Klaaßen, Lena; Gallersdorfer, Ulrich (2019). “The Carbon Footprint of Bitcoin”. Joule. 3 (7): 1647-1661. doi:10.1016/j.joule.2019.05.012.
Catalini, Christian; Tucker, Catherine E. (11 Aug. 2016). “Seeding the S-Curve? The Role of Early Adopters in Diffusion”. doi:10.2139/ssrn.2822729. S2CID 157317501. SSRN 2822729.
Janssen, Marijn; Weerakkody, Vishanth; Ismagilova, Elvira; Sivarajah, Uthayasankar; Irani, Zahir (2020). “A framework for analysing blockchain technology adoption: Integrating institutional, market and technical factors”. International Journal of Information Management. Elsevier. 50: 302-309. doi:10.1016/j.ijinfomgt.2019.08.012.
Koens, Tommy; Poll, Erik (2019), “The Drivers Behind Blockchain Adoption: The Rationality of Irrational Choices”, Euro-Par 2018: Parallel Processing Workshops, Lecture Notes in Computer Science, 11339, pp. 535-546, doi:10.1007/978-3-030-10549-5_42, ISBN 978-3-030-10548-8, S2CID 57662305
Li, Jerry (2020), “Blockchain technology adoption: Examining the Fundamental Drivers”, Proceedings of the 2nd International Conference on Management Science and Industrial Engineering, ACM Publication, April 2020, pp. 253-260. dl.acm.org/doi/abs/10.1145/3396743.3396750
Hsieh, Ying-Ying; Vergne, Jean-Philippe; Anderson, Philip; Lakhani, Karim; Reitzig, Markus (12 Feb. 2019). “Correction to: Bitcoin and the rise of decentralized autonomous organizations”. Journal of Organization Design. 8 (1): 3. doi:10.1186/s41469-019-0041-1. ISSN 2245-408X.
Felin, Teppo; Lakhani, Karim (2018). “What Problems Will You Solve With Blockchain?”. MIT Sloan Management Review.
Lumineau, Fabrice; Wang, Wenqian; Schilke, Oliver (2020). “Blockchain Governance-A New Way of Organizing Collaborations?”. Organization Science. 32 (2): 500-521. doi:10.1287/orsc.2020.1379.
Beck, Roman; Mueller-Bloch, Christoph; King, John Leslie (2018). “Governance in the Blockchain Economy: A Framework and Research Agenda”. Journal of the Association for Information Systems: 1020-1034. doi:10.17705/1jais.00518.
Extance, Andy (30 Sep. 2015). “The future of cryptocurrencies: Bitcoin and beyond”. Nature. 526 (7571): 21-23. Bibcode:2015Natur.526 . . . 21E. doi:10.1038/526021a. ISSN 0028-0836. OCLC 421716612. PMID 26432223.
Crosby, Michael; Nachiappan; Pattanayak, Pradhan; Verma, Sanjeev; Kalyanaraman, Vignesh (16 Oct. 2015). BlockChain Technology: Beyond Bitcoin (PDF) (Report). Sutardja Center for Entrepreneurship & Technology Technical Report. University of California, Berkeley. Retrieved 19 Mar. 2017.
Kakavand, Hossein; De Sevres, Nicolette Kost; Chilton, Bart (12 Oct. 2016). The Blockchain Revolution: An Analysis of Regulation and Technology Related to Distributed Ledger Technologies (Report). Luther Systems & DLA Piper. SSRN 2849251.
Mazonka, Oleg (29 Dec. 2016). “Blockchain: Simple Explanation”; Journal of Reference.
Tapscott, Don; Tapscott, Alex (2016). Blockchain Revolution: How the Technology Behind Bitcoin Is Changing Money, Business and the World. London: Portfolio Penguin. ISBN 978-0-241-23785-4. OCLC 971395169.
Saito, Kenji; Yamada, Hiroyuki (June 2016). What's So Different about Blockchain? Blockchain is a Probabilistic State Machine. IEEE 36th International Conference on Distributed Computing Systems Workshops. International Conference on Distributed Computing Systems Workshops (Icdcs). Nara, Nara, Japan: IEEE. pp. 168-75. doi:10.1109/ICDCSW.2016.28. ISBN 978-1-5090-3686-8. ISSN 2332-5666.
Raval, Siraj (2016). Decentralized Applications: Harnessing Bitcoin's Blockchain Technology. Oreilly. ISBN 9781491924549.
Bashir, Imran (2017). Mastering Blockchain. Packt Publishing, Ltd. ISBN 978-1-78712-544-5. OCLC 967373845.
Knirsch, Fabian; Unterweger, Andread; Engel, Dominik (2019). “Implementing a blockchain from scratch: why, how, and what we learned”. EURASIP Journal on Information Security. 2019. doi:10.1186/s13635-019-0085-3. S2CID 84837476.
D. Puthal, N. Malik, S. P. Mohanty, E. Kougianos, and G. Das, “Everything you Wanted to Know about the Blockchain”, IEEE Consumer Electronics Magazine, Volume 7, Issue 4, July 2018, pp. 06-14.

4. Smart Contracts

6324286; 6938039; 9014661; 9135787; 9298806; 9300467; 9331856; 9338148; 9351124; 9397985; 9413735; 9436923; 9436935; 9480188; 9507984; 9509690; 9513627; 9558524; 9563873; 9569771; 9608829; 9635000; 9641338; 9641342; 9665734; 9667427; 9667600; 9679276; 9702582; 9703986; 9705682; 9705851; 9710808; 9716595; 9722790; 9743272; 9747586; 9749140; 9749297; 9749766; 9754131; 9760574; 9760827; 9767520; 9773099; 9774578; 9785369; 9792101; 9794074; 9805381; 9807106; 9818092; 9818116; 9820120; 9824031; 9824408; 9825931; 9832026; 9836908; 9847997; 9848271; 9849364; 9852427; 9853819; 9853977; 9855785; 9858781; 9862222; 9866545; 9870508; 9870562; 9870591; 9875510; 9875592; 9876646; 9876775; 9881176; 9882918; 9888007; 9892141; 9892460; 9894485; 9898782; 9904544; 9906513; 9910969; 9912659; 10022613; 10046228; 10195513; 10476847; 10532268; 10789590; 10861015; 10936871; 10997251; 11057353; 11068978; 11130042; 20050203815; 20140344015; 20140368601; 20150067143; 20150081566; 20150127940; 20150170112; 20150206106; 20150244690; 20150262137; 20150262138; 20150262139; 20150262140; 20150262141; 20150262168; 20150262171; 20150262172; 20150262176; 20150269624; 20150278820; 20150278887; 20150294425; 20150310476; 20150324764; 20150332256; 20150332283; 20150348169; 20150356524; 20150356555; 20150379510; 20160005032; 20160012424; 20160012465; 20160027229; 20160028552; 20160055236; 20160071108; 20160072800; 20160092988; 20160098723; 20160098730; 20160117471; 20160123620; 20160134593; 20160140653; 20160170996; 20160170998; 20160171514; 20160180338; 20160191243; 20160192166; 20160203448; 20160203522; 20160203572; 20160203575; 20160210626; 20160210710; 20160212109; 20160212146; 20160217436; 20160217532; 20160218879; 20160224803; 20160224949; 20160234026; 20160253663; 20160254910; 20160259923; 20160260091; 20160260169; 20160261411; 20160267472; 20160267474; 20160267558; 20160267566; 20160267601; 20160267605; 20160269182; 20160269402; 20160275461; 20160283920; 20160283939; 20160283941; 20160284033; 20160292396; 20160292672; 20160292680; 20160294783; 20160300200; 20160300223; 20160300234; 20160300252; 20160306982; 20160307197; 20160321316; 20160321434; 20160321435; 20160321629; 20160321654; 20160321675; 20160321676; 20160321751; 20160321752; 20160321769; 20160323109; 20160327294; 20160328713; 20160330027; 20160330034; 20160335533; 20160335609; 20160342958; 20160342959; 20160342976; 20160342977; 20160342978; 20160342980; 20160342981; 20160342982; 20160342983; 20160342984; 20160342985; 20160342986; 20160342987; 20160342988; 20160342989; 20160342994; 20160350728; 20160350749; 20160357550; 20160358158; 20160358165; 20160358169; 20160358184; 20160358186; 20160358187; 20160358253; 20160358267; 20160359637; 20160364700; 20160364787; 20160365978; 20160371771; 20160379212; 20160379213; 20160379256; 20160379298; 20160379312; 20160379330; 20170004563; 20170004578; 20170004588; 20170005804; 20170011053; 20170011392; 20170011460; 20170012780; 20170012943; 20170013047; 20170017936; 20170017954; 20170017955; 20170017958; 20170019496; 20170024817; 20170024818; 20170028622; 20170031676; 20170031874; 20170033932; 20170034197; 20170039330; 20170041148; 20170042068; 20170046526; 20170046638; 20170046651; 20170046652; 20170046664; 20170046670; 20170046680; 20170046689; 20170046693; 20170046694; 20170046698; 20170046709; 20170046799; 20170046806; 20170048209; 20170048216; 20170048234; 20170048235; 20170052676; 20170053036; 20170053131; 20170054611; 20170061396; 20170070778; 20170075877; 20170075938; 20170075941; 20170076109; 20170076306; 20170078097; 20170078493; 20170083907; 20170083911; 20170083989; 20170084118; 20170085545; 20170085555; 20170088397; 20170091397; 20170091467; 20170091750; 20170091756; 20170098291; 20170103167; 20170103385; 20170103390; 20170103391; 20170103468; 20170103472; 20170104831; 20170109475; 20170109636; 20170109637; 20170109638; 20170109639; 20170109640; 20170109657; 20170109667; 20170109668; 20170109670; 20170109676; 20170109735; 20170109744; 20170109748; 20170109814; 20170109955; 20170111175; 20170111385; 20170115976; 20170116693; 20170118301; 20170124535; 20170124556; 20170124647; 20170126702; 20170131988; 20170132393; 20170132615; 20170132619; 20170132620; 20170132621; 20170132625; 20170132626; 20170132630; 20170132635; 20170132636; 20170134161; 20170134162; 20170134280; 20170134326; 20170134375; 20170134937; 20170140145; 20170140371; 20170140375; 20170140394; 20170140408; 20170147808; 20170147975; 20170148016; 20170148021; 20170149560; 20170149795; 20170149796; 20170149819; 20170150939; 20170154331; 20170155515; 20170161439; 20170161517; 20170161652; 20170161697; 20170161733; 20170161734; 20170161762; 20170161829; 20170161833; 20170163733; 20170169125; 20170169363; 20170169473; 20170169800; 20170173262; 20170177855; 20170177898; 20170178127; 20170178128; 20170178236; 20170178237; 20170178263; 20170178417; 20170180128; 20170180134; 20170180211; 20170185692; 20170185981; 20170185998; 20170186057; 20170187535; 20170188168; 20170191688; 20170192994; 20170193464; 20170193619; 20170195299; 20170195336; 20170195397; 20170195747; 20170198931; 20170199671; 20170200137; 20170200147; 20170201385; 20170205102; 20170206382; 20170206522; 20170206523; 20170206532; 20170206603; 20170206604; 20170207917; 20170212781; 20170213198; 20170213209; 20170213210; 20170213221; 20170213287; 20170213289; 20170214522; 20170214675; 20170214699; 20170214701; 20170220781; 20170220815; 20170220998; 20170221021; 20170221029; 20170221032; 20170221052; 20170222814; 20170228371; 20170228557; 20170228705; 20170228706; 20170228731; 20170228734; 20170228822; 20170228841; 20170230189; 20170230285; 20170230345; 20170230349; 20170230353; 20170230375; 20170230791; 20170232300; 20170232300; 20170234709; 20170235970; 20170236094; 20170236102; 20170236103; 20170236104; 20170236120; 20170236121; 20170236123; 20170236143; 20170236177; 20170236196; 20170237553; 20170237554; 20170237569; 20170237570; 20170237700; 20170238072; 20170242475; 20170243025; 20170243177; 20170243179; 20170243193; 20170243208; 20170243209; 20170243212; 20170243213; 20170243214; 20170243215; 20170243216; 20170243217; 20170243222; 20170243239; 20170243241; 20170243284; 20170243286; 20170243287; 20170244707; 20170244720; 20170244721; 20170244757; 20170244909; 20170249482; 20170249623; 20170250796; 20170250815; 20170250972; 20170251025; 20170255912; 20170256000; 20170256001; 20170256003; 20170256951; 20170257358; 20170262778; 20170262862; 20170262902; 20170264428; 20170265789; 20170270492; 20170270493; 20170270527; 20170277909; 20170278080; 20170278186; 20170279620; 20170279774; 20170279783; 20170279818; 20170285720; 20170286717; 20170286880; 20170286951; 20170287068; 20170287090; 20170289111; 20170289124; 20170289134; 20170291295; 20170293503; 20170293669; 20170293898; 20170293912; 20170295021; 20170295023; 20170295157; 20170295180; 20170295232; 20170300627; 20170300872; 20170300875; 20170300876; 20170300877; 20170300898; 20170300905; 20170300910; 20170300928; 20170300946; 20170300978; 20170301031; 20170301033; 20170301047; 20170302450; 20170302460; 20170307387; 20170308070; 20170308893; 20170308920; 20170308928; 20170309117; 20170310484; 20170310653; 20170310747; 20170316162; 20170316390; 20170316391; 20170316409; 20170316410; 20170316487; 20170316497; 20170317833; 20170317834; 20170317997; 20170318008; 20170323294; 20170323392; 20170324738; 20170329922; 20170329980; 20170329996; 20170330143; 20170330159; 20170330174; 20170330179; 20170330180; 20170330181; 20170330250; 20170331624; 20170331635; 20170331810; 20170331828; 20170331896; 20170337534; 20170338947; 20170338957; 20170338963; 20170338967; 20170339503; 20170344435; 20170344580; 20170344983; 20170344987; 20170344988; 20170345011; 20170345019; 20170345105; 20170346637; 20170346639; 20170346693; 20170346752; 20170346804; 20170346830; 20170346833; 20170346907; 20170347253; 20170351693; 20170352012; 20170352027; 20170352031; 20170352033; 20170352116; 20170352185; 20170352219; 20170353309; 20170353311; 20170353320; 20170357966; 20170357970; 20170358041; 20170359288; 20170359316; 20170359374; 20170359408; 20170364450; 20170364552; 20170364637; 20170364655; 20170364698; 20170364699; 20170364700; 20170364701; 20170364702; 20170364825; 20170364860; 20170364871; 20170364900; 20170364908; 20170364934; 20170364936; 20170366348; 20170366353; 20170366395; 20170366416; 20170366516; 20170366547; 20170372278; 20170372300; 20170372308; 20170372391; 20170372392; 20170372431; 20170373849; 20170374049; 20180000367; 20180001184; 20180005186; 20180005318; 20180005326; 20180005489; 20180005492; 20180006826; 20180006829; 20180006831; 20180006990; 20180007131; 20180012195; 20180012262; 20180012311; 20180013567; 20180013815; 20180015838; 20180017791; 20180018590; 20180018655; 20180018695; 20180018723; 20180018738; 20180019867; 20180019872; 20180019873; 20180019879; 20180019921; 20180019984; 20180019993; 20180020324; 20180025135; 20180025140; 20180025166; 20180025181; 20180025272; 20180025365; 20180025368; 20180025388; 20180025401; 20180025435; 20180025442; 20180026979; 20180032273; 20180032383; 20180032696; 20180032759; 20180034634; 20180034636; 20180034642; 20180034804; 20180039397; 20180039512; 20180039667; 20180039785; 20180039786; 20180039942; 20180039982; 20180039993; 20180040007; 20180040040; 20180040041; 20180040062; 20180041072; 20180041338; 20180041345; 20180041445; 20180041446; 20180041486; 20180041487; 20180041571; 20180043386; 20180046766; 20180046956; 20180046992; 20180047111; 20180048461; 20180048463; 20180048469; 20180048485; 20180048738; 20180052462; 20180052813; 20180052926; 20180052927; 20180052970; 20180053158; 20180053160; 20180053161; 20180053182; 20180054436; 20180054491; 20180060496; 20180060596; 20180060600; 20180060771; 20180060835; 20180060836; 20180060860; 20180060927; 20180061237; 20180062831; 20180062835; 20180062848; 20180063099; 20180063139; 20180063189; 20180063238; 20180068091; 20180068097; 20180068130; 20180068271; 20180068282; 20180068359; 20180069798; 20180069899; 20180078843; 20180117446; 20180117447; 20180264347; 20180285971; 20180308072; 20180326291; 20190012660; 20190043043; 20190080392; 20190147553; 20190279240; 20190279241; 20190303926; 20190347605; 20190358515; 20190361917; 20200042989; 20200051188; 20200101367; 20200112545; 20200117690; 20200162254; 20200184556; 20200202427; 20200202429; 20200219188; 20200273099; 20200273100; 20200273101; 20200286196; 20200294128; 20200294129; 20200294131; 20200294132; 20200294133; 20200294134; 20200294135; 20200294136; 20200294137; 20200294138; 20200294139; 20200302523; 20200302525; 20200327609; 20200357024; 20200359550; 20200359582; 20200364456; 20200387896; 20200387965; 20200387966; 20200387967; 20200387968; 20200394652; 20200394708; 20200394709; 20210042823; 20210065293; 20210073540; 20210097198; 20210110469; 20210158440; 20210158441; 20210166233; 20210166309; 20210166310; 20210166311; 20210182915; 20210182961; 20210201315; 20210248514; 20210256070; 20210264000; 20210264426; 20210271877; 20210279797; 20210304089; 20210304119; 20210312545; 20210342836; 20210354295; 20210356941; 20210357029; 20210358032; 20210365574; AU2018230763A1; AU2018309748A1; AU2019245423A1; AU2019369396A1; AU2019370273A1; AU2020271014A1; CA3055829A1; CA3098150A1; CA3118308A1; CA3118313A1; CA3136435A1; EP3593305A1; EP3649601A1; EP3776438A1; EP3809291A1; EP3861517A1; EP3874442A2; EP3874443A2; EP3903269A1; JP2019159935A; JP2021177422A; JP2021515296A; JP2021520010A; JP6922097B2; KR20210024993A; WO2018165472A1; WO2019028068A1; WO2019191687A1; WO2019217379A1; WO2020092426A2; WO2020092446A2; WO2020097115A1; WO2020106882A1; WO2020106882A9; WO2020139980A1; WO2020205642A1; WO2020210076A1; WO2021158702A1
“Blockchain: Forget Bitcoin, here comes the real thing”. Idealog. idealog.co.nz/tech/2016/03/blockchain-forget-bitcoin-here-comes-real-thing 2016-03-29;
“Contract-Bitcoin Wiki”. en.bitcoin.it;
“Dumb Contracts and Smart Scripts-We Use Cash”. weuse.cash.
“How Do Ethereum Smart Contracts Work?-CoinDesk”. CoinDesk. www.coindesk.com/learn/how-do-ethereum-smart-contracts-work/Retrieved 2017-10-27;
“Namecoin”. Cointelegraph. 23 May 2015. Automated Transactions;
“Qora and Burst Now Able to Make Cross-Chain Transactions”. www.ccn.com/qora-burst-now-able-make-cross-chain-transactions/May 22, 2015.
“Ripple discontinues smart contract platform Codius”. Bitcoin Magazine. bitcoinmagazine.com/business/ripple-discontinues-smart-contract-platform-codius-citing-small-market-1435182153 Jun. 24, 2015;

“RSK—Rootstock Open-Source Smart Contract Bitcoin Technology?” bitcoinexchangeguide.com/rsk/;
“Smart contracts and bitcoin”, medium.com/@maraoz/smart-contracts-and-bitcoin-a5d61011d9b1;
“Smart contracts: Turing completeness & reality”, hackernoon.com/smart-contracts-turing-completeness-reality-3eb897996621 (Jun. 21, 2016);
“What is a Bitcoin Merklized Abstract Syntax Tree (MAST)?”. Bitcoin Tech Talk. 2017-Oct.-12;
Accenture, “Blockchain Technology: Preparing for Change”, financedocbox.com/Tax_Planning/77008616-Blockchain-technology-preparing-for-change.html (2015);
AI Khalil, Firas, Tom Butler, Leona O'Brien, and Marcello Ceci. “Trust in smart contracts is a process, as well.” In International Conference on Financial Cryptography and Data Security, pp. 510-519. Springer, Cham, 2017.
Al-Bassam, Mustafa. “SCPKI: a smart contract-based PKI and identity system.” In Proceedings of the ACM Workshop on Blockchain, Cryptocurrencies and Contracts, pp. 35-40. ACM, 2017.
Ammous, Saifedean Hisham. “Blockchain Technology: What is it good for?.” Browser Download This Paper (2016).
Andrychowicz, Marcin; Dziembowski, Stefan; Malinowski, Daniel;
Atzei, Nicola, Massimo Bartoletti, and Tiziana Cimoli. “A survey of attacks on Ethereum smart contracts (SoK).” In International Conference on Principles of Security and Trust, pp. 164-186. Springer, Berlin, Heidelberg, 2017.
Atzei, Nicola; Bartoletti, Massimo; Cimoli, Tiziana; Lande, Stefano; Zunino, Roberto (2018), “SoK: unraveling Bitcoin smart contracts”, 7th International Conference on Principles of Security and Trust (POST), European Joint Conferences on Theory and Practice of Software.
Bahga, Arshdeep, and Vijay K. Madisetti. “Blockchain platform for industrial Internet of Things.” Journal of Software Engineering and Applications 9, no. 10 (2016): 533.
Bartoletti, Massimo, and Livio Pompianu. “An empirical analysis of smart contracts: platforms, applications, and design patterns.” In International Conference on Financial Cryptography and Data Security, pp. 494-509. Springer, Cham, 2017.
Beck, Roman, Jacob Stenum Czepluch, Nikolaj Lollike, and Simon Malone. “Blockchain—the Gateway to Trust-Free Cryptographic Transactions.” In ECIS, p. ResearchPaper153. 2016.
Bhargavan, Karthikeyan, Antoine Delignat-Lavaud, Cedric Fournet, Anitha Gollamudi, Georges Gonthier, Nadim Kobeissi, Natalia Kulatova et al. “Formal verification of smart contracts: Short paper.” In Proceedings of the 2016 ACM Workshop on Programming Languages and Analysis for Security, pp. 91-96. ACM, 2016.
bitcoinbook: Mastering Bitcoin 2nd Edition—Programming the Open Blockchain—Chapter 7, Mastering Bitcoin, 2017-05-30;
BitFury Group, “Smart Contracts on Bitcoin Blockchain”; Sep. 4, 2015, bitfury.com/content/downloads/contracts-1.1.1.pdf;
Bocek, Thomas, “Digrate Express rating report on Project Rootstock”, Digital Marketplaces Unleashed. Springer-Verlag GmbH. p. 169-184 (15 Sep. 2017);
Bogner, Andreas, Mathieu Chanson, and Arne Meeuw. “A decentralised sharing app running a smart contract on the ethereum blockchain.” In Proceedings of the 6th International Conference on the Internet of Things, pp. 177-178. ACM, 2016.
Brown, Richard Gendal, “Bitcoin as a Smart Contract Platform” gendal.me/2015/03/30/bitcoin-as-a-smart-contract-platform/2015-03-30;
Brown, Richard Gendal, James Carlyle, Ian Grigg, and Mike Hearn. “Corda: An Introduction.” R3 CEV, August (2016).
Buterin, Vitalik. “A next-generation smart contract and decentralized application platform.” white paper (2014).
Buterin, Vitalik. “Ethereum Whitepaper”, Github;
Butler, T., “A Solution for the Problems of Translation and Transparency in Smart Contracts” www.semanticscholar.org/paper/A-Solution-for-the-Problems-of-Translation-and-in-Butler/08c9c7c019aad37ef64eedcbca14168f472182dc (2017);
Cachin, Christian. “Architecture of the Hyperledger Blockchain Fabric”, ibm.com.
Chainfrog, “What are Smart Contracts”; www.chainfrog.com/wp-content/uploads/2017/08/smart-contracts.pdf Aug. 3, 2017.
Chesebro, Russell. A contract that manages itself: the time has arrived. Defense Acquisition Univ Ft Belvoir VA, 2015.
Christidis, Konstantinos, and Michael Devetsikiotis. “Blockchains and smart contracts for the internet of things.” IEEE Access 4 (2016): 2292-2303.
CIYAM, “Automated Transactions Specification”, ciyam.org/at/at.html;
Clack, Christopher D., Vikram A. Bakshi, and Lee Braine. “Smart contract templates: foundations, design landscape and research directions.” arXiv preprint arXiv:1608.00771 (2016).
Clack, Christopher D., Vikram A. Bakshi, and Lee Braine. “Smart Contract Templates: essential requirements and design options.” arXiv preprint arXiv:1612.04496 (2016).
Dai, Patrick, Neil Mahi, Jordan Earls, and Alex Norta. “Smart-contract value-transfer protocols on a distributed mobile application platform” tum.org/uploads/files/cf6d69348ca50dd985b60425ccf282f3. (2017).
Delmolino, Kevin, Mitchell Arnett, Ahmed Kosba, Andrew Miller, and Elaine Shi. “Step by step towards creating a safe smart contract: Lessons and insights from a cryptocurrency lab.” In International Conference on Financial Cryptography and Data Security, pp. 79-94. Springer, Berlin, Heidelberg, 2016.
English, Matthew, Soren Auer, and John Domingue. “Block chain technologies & the semantic web: A framework for symbiotic development.” In Computer Science Conference for University of Bonn Students, J. Lehmann, H. Thakkar, L. Halilaj, and R. Asmat, Eds, pp. 47-61. 2016.
Foroglou, George, and Anna-Lali Tsilidou. “Further applications of the blockchain.” In 12th Student Conference on Managerial Science and Technology. 2015.
Frantz, Christopher K., and Mariusz Nowostawski. “From institutions to code: Towards automated generation of smart contracts.” In Foundations and Applications of Self* Systems, IEEE International Workshops on, pp. 210-215. IEEE, 2016.
Glaser, Florian. “Pervasive decentralisation of digital infrastructures: a framework for blockchain enabled system and use case analysis.” (2017).
Hal Hodson (20 Nov. 2013). “Bitcoin moves beyond mere money”. New Scientist.
Hirai, Yoichi. “Defining the ethereum virtual machine for interactive theorem provers.” In International Conference on Financial Cryptography and Data Security, pp. 520-535. Springer, Cham, 2017.
Huckle, Steve, Rituparna Bhattacharya, Martin White, and Natalia Beloff. “Internet of things, blockchain and shared economy applications.” Procedia Computer Science 98 (2016): 461-466.
Hull, Richard, Vishal S. Batra, Yi-Min Chen, Alin Deutsch, Fenno F. Terry Heath III, and Victor Vianu. “Towards a shared ledger business collaboration language based on data-aware processes.” In International Conference on Service-Oriented Computing, pp. 18-36. Springer, Cham, 2016.
Idelberger, Florian, Guido Governatori, Régis Riveret, and Giovanni Sartor. “Evaluation of logic-based smart contracts for blockchain systems.” In International Symposium on Rules and Rule Markup Languages for the Semantic Web, pp. 167-183. Springer, Cham, 2016.
Kolvart, Merit, Margus Poola, and Addi Rull. “Smart contracts.” In The Future of Law and etechnologies, pp. 133-147. Springer, Cham, 2016.
Korpela, Kari, Jukka Hallikas, and Tomi Dahlberg. “Digital supply chain transformation toward blockchain integration.” In proceedings of the 50th Hawaii international conference on system sciences. 2017.
Kosba, Ahmed, Andrew Miller, Elaine Shi, Zikai Wen, and Charalampos Papamanthou. “Hawk: The blockchain model of cryptography and privacy-preserving smart contracts.” In Security and Privacy (SP), 2016 IEEE Symposium on, pp. 839-858. IEEE, 2016.
Levy, Karen EC. “Book-smart, not street-smart: blockchain-based smart contracts and the social workings of law.” Engaging Science, Technology, and Society 3 (2017): 1-15.
Luu, Loi, Duc-Hiep Chu, Hrishi Olickel, Prateek Saxena, and Aquinas Hobor. “Making smart contracts smarter.” In Proceedings of the 2016 ACM SIGSAC Conference on Computer and Communications Security, pp. 254-269. ACM, 2016.
Marino, Bill, and Ari Juels. “Setting standards for altering and undoing smart contracts.” In International Symposium on Rules and Rule Markup Languages for the Semantic Web, pp. 151-166. Springer, Cham, 2016.
Maskell, Brian. “Just-in-time manufacturing.” Industrial Management & Data Systems 87, no. 9/10 (1987): 17-20.
Mazurek, Lukasz (2013). “Secure Multiparty Computations on Bitcoin”;
Miller, Mark S., Chip Morningstar, and Bill Frantz. “Capability-based financial instruments.” In International Conference on Financial Cryptography, pp. 349-378. Springer, Berlin, Heidelberg, 2000.
Möbius, Martin (2009). “Erstellung eines Archivierungskonzepts für die Speicherung rückverfolgbarer Datenbestände im Askemos-System”;
Morrison, Alan, and Subhankar Sinha. “Blockchain and smart contract automation: Blockchains defined.” (2016).
Norta, Alex. “Creation of smart-contracting collaborations for decentralized autonomous organizations.” In International Conference on Business Informatics Research, pp. 3-17. Springer, Cham, 2015.
Omohundro, Steve. “Cryptocurrencies, smart contracts, and artificial intelligence.” AI matters 1, no. 2 (2014): 19-21.
Peters, Gareth W., and Efstathios Panayi. “Understanding modern banking ledgers through blockchain technologies: Future of transaction processing and smart contracts on the internet of money.” In Banking Beyond Banks and Money, pp. 239-278. Springer, Cham, 2016.
Porru, Simone, Andrea Pinna, Michele Marchesi, and Roberto Tonelli. “Blockchain-oriented software engineering: challenges and new directions.” In Proceedings of the 39th International Conference on Software Engineering Companion, pp. 169-171. IEEE Press, 2017.
RA Markus Heinker (2007). “Beweiswurdigung elektronischer Dokumente im Zivilprozess unter vergleichender Betrachtung von qualifizierten elektronischen Signaturen nach dem Signaturgesetz und dem Askemos-Verfahren”;
RootStock (RSK) is a smart contract platform that is connected to the Bitcoin blockchain through sidechain technology. RSK is compatible with smart contracts created for Ethereum. See:
Rosa, Davide De. “The Bitcoin Script language (pt. 1)”. davidederosa.com;
Ross, Rory (2015-09-12). “Smart Money: Blockchains Are the Future of the Internet”, Newsweek;
Savelyev, Alexander. “Contract law 2.0:‘Smart’contracts as the beginning of the end of classic contract law.” Information & Communications Technology Law 26, no. 2 (2017): 116-134.
Seijas, Pablo Lamela, Simon Thompson, and Darryl McAdams. “Scripting smart contracts for distributed ledger technology.” Cryptology ePrint Archive (2016).
Smart contract infrastructure can be implemented by replicated asset registries and contract execution using cryptographic hash chains and Byzantine fault tolerant replication. See:
Swan, Melanie. “Blockchain temporality: smart contract time specifiability with blocktime.” In International symposium on rules and rule markup languages for the semantic web, pp. 184-196. Springer, Cham, 2016.
Szabo, Nick (1997-09-01). “Formalizing and Securing Relationships on Public Networks”. First Monday. 2 (9);
Szabo, Nick (2005). “Secure Property Titles with Owner Authority”;
Szabo, Nick, “Smart Contracts: Building Blocks for Digital Markets”. www.fon.hum.uva.nl, Extropy #16 (1996);
Szabo, Nick. “Formalizing and securing relationships on public networks.” First Monday 2, no. 9 (1997).
Tapscott, Don; Tapscott, Alex (May 2016). The Blockchain Revolution: How the Technology Behind Bitcoin is Changing Money, Business, and the World. pp. 72, 83, 101, 127. ISBN 978-0670069972.
Thomas Bocek (15 Sep. 2017). Digital Marketplaces Unleashed. Springer-Verlag GmbH. p. 169-184. ISBN 978-3-662-49274-1;
Vukolić, Marko. “Rethinking permissioned blockchains.” In Proceedings of the ACM Workshop on Blockchain, Cryptocurrencies and Contracts, pp. 3-7. ACM, 2017.
Vukolić, Marko. “The quest for scalable blockchain fabric: Proof-of-work vs. BFT replication.” In International Workshop on Open Problems in Network Security, pp. 112-125. Springer, Cham, 2015.
Watzke, Tom-Steve (2010). “Entwicklung einer Datenbankschnittstelle als Grundlage für Shop-Systeme unter dem Betriebssystem Askemos”.
Weber, Ingo, Xiwei Xu, Régis Riveret, Guido Governatori, Alexander Ponomarev, and Jan Mendling. “Untrusted business process monitoring and execution using blockchain.” In International Conference on Business Process Management, pp. 329-347. Springer, Cham, 2016.
Wigan, David (2015-06-11). “Bitcoin technology will disrupt derivatives, says banker”, IFR Asia.
Wittenberger, Jorg F. (2002). “Askemos a distributed settlement”;
Xu, Xiwei, Cesare Pautasso, Liming Zhu, Vincent Gramoli, Alexander Ponomarev, An Binh Tran, and Shiping Chen. “The blockchain as a software connector.” In Software Architecture (WICSA), 2016 13th Working IEEE/IFIP Conference on, pp. 182-191. IEEE, 2016.
Xu, Xiwei, Ingo Weber, Mark Staples, Liming Zhu, Jan Bosch, Len Bass, Cesare Pautasso, and Paul Rimba. “A taxonomy of blockchain-based systems for architecture design.” In Software Architecture (ICSA), 2017 IEEE International Conference on, pp. 243-252. IEEE, 2017.
Yasin, Affan, and Lin Liu. “An online identity and smart contract management system.” In Computer Software and Applications Conference (COMPSAC), 2016 IEEE 40th Annual, vol. 2, pp. 192-198. IEEE, 2016.
Zhang, Fan, Ethan Cecchetti, Kyle Croman, Ari Juels, and Elaine Shi. “Town crier: An authenticated data feed for smart contracts.” In Proceedings of the 2016 aCM sIGSAC conference on computer and communications security, pp. 270-282. ACM, 2016.
Zheng, Zibin, Shaoan Xie, Hong-Ning Dai, and Huaimin Wang. “Blockchain challenges and opportunities: A survey.” Work Pap.−2016 (2016).

5. Fungible Tokens (Ft) and Non-Fungible Tokens (Nft)

10505726; 10540654; 10614661; 10673847; 10715329; 10721069; 10751628; 10832522; 10896412; 10951409; 11032072; 11075891; 11089051; 11099813; 11102255; 11113754; 11128468; 11133936; 11144279; 11146399; 11148058; 11154783; 11158164; 11165911; 11170582; 11173402; 11173404; 11175889; 11182467; 11192033; 11200569; 11206138; 11212126; 11216773; 11226787; 11228436; 11229848; 11238477; 11244032; 11250111; 11250399; 11256788; 11261896; 11263607; 11265685; 11290292; 11295318; 11297469; 11301460; 11308184; 11308487; 11317253; 11321709; 11331579; 11334875; 11334876; 11334883; 11338204; 11341555; 11348099; 11348152; 11366634; 11367060; 11369878; 11372987; 11374756; 20190130701; 20190220836; 20190221076; 20190287175; 20190299105; 20190303892; 20190325452; 20190334957; 20190366475; 20190392511; 20200005284; 20200034869; 20200038761; 20200053081; 20200059361; 20200059362; 20200059364; 20200065847; 20200076798; 20200111068; 20200127833; 20200127834; 20200160289; 20200160320; 20200175485; 20200184041; 20200184547; 20200186338; 20200213121; 20200242105; 20200272713; 20200273048; 20200294011; 20200296091; 20200320825; 20200322154; 20200327112; 20200328890; 20200334752; 20200342539; 20200349562; 20200349625; 20200351092; 20200351093; 20200351094; 20200364703; 20200376387; 20210012447; 20210035246; 20210065293; 20210067342; 20210082044; 20210083874; 20210097508; 20210097528; 20210103923; 20210103938; 20210118085; 20210119807; 20210133700; 20210133708; 20210133713; 20210150626; 20210174377; 20210174378; 20210174432; 20210182020; 20210199146; 20210201280; 20210201336; 20210201625; 20210233067; 20210241243; 20210243027; 20210243272; 20210248214; 20210248523; 20210248594; 20210248653; 20210256070; 20210256110; 20210258155; 20210266169; 20210271508; 20210279305; 20210279695; 20210281410; 20210287195; 20210287257; 20210294884; 20210295324; 20210297258; 20210304196; 20210304200; 20210311931; 20210319428; 20210319429; 20210319430; 20210319431; 20210319432; 20210319433; 20210326845; 20210326846; 20210326847; 20210326848; 20210326849; 20210326850; 20210326851; 20210326852; 20210326853; 20210326854; 20210326855; 20210326856; 20210326857; 20210326862; 20210326872; 20210327008; 20210342909; 20210349685; 20210349686; 20210357447; 20210357489; 20210357893; 20210358038; 20210359996; 20210365909; 20210377028; 20210377045; 20210382966; 20210383461; 20210390161; 20210390531; 20210398095; 20210406920; 20220004562; 20220006642; 20220010996; 20220020075; 20220021728; 20220026736; 20220027447; 20220027867; 20220027902; 20220027992; 20220028200; 20220029464; 20220029843; 20220030022; 20220035936; 20220036404; 20220036905; 20220040557; 20220043518; 20220043913; 20220044334; 20220045841; 20220052921; 20220058610; 20220058624; 20220058625; 20220058626; 20220058627; 20220058628; 20220058629; 20220058630; 20220058631; 20220058632; 20220058633; 20220058634; 20220058635; 20220058636; 20220058706; 20220067681; 20220067705; 20220067706; 20220067707; 20220067708; 20220067709; 20220067710; 20220067829; 20220069996; 20220070010; 20220070011; 20220070627; 20220070628; 20220070629; 20220075845; 20220076221; 20220078008; 20220083585; 20220084368; 20220086011; 20220086201; 20220092161; 20220092162; 20220092163; 20220092164; 20220092165; 20220092562; 20220092599; 20220093256; 20220094550; 20220101312; 20220101316; 20220103365; 20220108027; 20220108028; 20220108232; 20220108315; 20220109667; 20220113937; 20220114210; 20220114542; 20220114567; 20220114584; 20220116227; 20220116231; 20220122050; 20220122062; 20220122072; 20220123939; 20220129982; 20220130501; 20220138300; 20220138760; 20220138791; 20220138849; 20220139546; 20220139566; 20220147512; 20220147876; 20220147988; 20220156339; 20220156753; 20220158996; 20220158997; 20220159419; 20220164424; 20220164787; 20220164899; 20220172050; 20220172278; 20220173893; 20220182700; 20220188672; 20220188780; 20220188810; 20220188811; 20220188812; 20220188839; 20220188898; 20220188917; 20220197985; 20220198034; 20220198254; 20220198418; 20220198447; 20220198562; 20220200869; 20220203168; 20220207119; 20220207535; 20220210061; 20220210266; AU-2018100995; AU-2018901546; AU-2019245424; AU-2019256002; AU-2019372344; AU-2019384566; AU-2019466472; AU-2020237499; AU-2020237499; AU-2020351764; AU-2020370265; AU-2020380960; AU-2020387408; AU-2021221772; AU-2021901605; AU-2021902227; AU-2022900433; AU-2022901024; CA-3049577; CA-3097092; CA-3098182; CA-3118593; CA-3120857; CA-3137098; CA-3137744; CA-3139309; CA-3148668; CA-3155654; CA-3157091; CA-3158514; CN-111275439; CN-112529709; CN-112598426; CN-112749957; CN-112819466; CN-112837084; CN-113095912; CN-113095913; CN-113095915; CN-113095916; CN-113095917; CN-113095918; CN-113112262; CN-113128992; CN-113129176; CN-113129176; CN-113129177; CN-113139775; CN-113159898; CN-113159899; CN-113159900; CN-113159902; CN-113160001; CN-113160001; CN-113261029; CN-113296944; CN-113327165; CN-113362073; CN-113362142; CN-113393180; CN-113487428; CN-113506111; CN-113542405; CN-113570387; CN-113743921; CN-113746638; CN-113792267; CN-113869933; CN-113886775; CN-113901005; CN-113906515; CN-113935840; CN-113987062; CN-114004684; CN-114008653; CN-114020718; CN-114020846; CN-114024687; CN-114036162; CN-114036227; CN-114037437; CN-114037494; CN-114037528; CN-114037529; CN-114065269; CN-114065269; CN-114089829; CN-114092250; CN-114095214; CN-114119046; CN-114143007; CN-114146415; CN-114153412; CN-114154987; CN-114155095; CN-114187111; CN-114238930; CN-114240521; CN-114266864; CN-114283002; CN-114283005; CN-114283006; CN-114298699; CN-114307162; CN-114307163; CN-114307164; CN-114328713; CN-114328731; CN-114331008; CN-114331397; CN-114331407; CN-114331428; CN-114331462; CN-114331730; CN-114332286; CN-114341628; CN-114358946; CN-114358947; CN-114358948; CN-114359590; CN-114363009; CN-114377400; CN-114377401; CN-114377402; CN-114386102; CN-114404988; CN-114405005; CN-114417406; CN-114418570; CN-114418757; CN-114422149; CN-114429267; CN-114429366; CN-114444745; CN-114463019; CN-114493583; CN-114548987; CN-114548988; CN-114548989; CN-114553515; CN-114565378; CN-114565384; CN-114580201; CN-114581089; CN-114581229; CN-114595471; CN-114596145; CN-114612244; CN-114615083; DE-102018133104; DE-102018133104; DE-202021002167; EP-3540662; EP-3671674; EP-3671674; EP-3776441; EP-3782058; EP-3803746; EP-3803746; EP-3814967; EP-3830786; EP-3869444; EP-3874440; EP-3883744; EP-3891680; EP-3912121; EP-3938986; EP-3956841; EP-3963530; EP-3977698; EP-3981016; EP-4000028; ES-2808411; GB-202107343; GB-2570786; GB-2597592; GB-2601894; IL-282825; IL-283305; IL-288548; IN-201811015112; IN-202117027421; IN-202121047427; IN-202127049448; IN-202141030001; IN-202141055732; IN-202211008201; IN-202217000087; IN-202217000088; IN-202221026486; IN-202241008445; IN-202241010924; JP-2020068388; JP-2020080061; JP-2020140400; JP-2020170296; JP-2020201564; JP-2021043970; JP-2021072116; JP-2021089640; JP-2021131779; JP-2021149904; JP-2021152815; JP-2021162974; JP-2021166028; JP-2021189475; JP-2021522631; JP-2022000765; JP-2022002008; JP-2022013271; JP-2022029608; JP-2022035296; JP-2022045382; JP-2022059707; JP-2022079884; JP-2022082269; JP-2022084095; JP-2022514466; JP-6710401; JP-6804073; JP-6850463; JP-6940212; JP-6967116; JP-6982352; JP-6987417; JP-7020739; JP-7033352; JP-7043672; JP-7044927; JP-7044927; JP-7063512; JP-7076671; JP-7081040; JP-7086316; JP-7089815; JP-7090800; JP-7093487; JP-WO2020080537; JP-WO2021100118; JP-WO2021132483; KR-102100457; KR-102130651; KR-102199567; KR-102272511; KR-102272511; KR-102294571; KR-102317234; KR-102322511; KR-102325686; KR-102340588; KR-102343025; KR-102345424; KR-102355550; KR-102356260; KR-102365689; KR-102368776; KR-102368782; KR-102368785; KR-102368793; KR-102369358; KR-102371071; KR-102372709; KR-102372710; KR-102372960; KR-102375394; KR-102375395; KR-102381499; KR-102382272; KR-102382379; KR-102385602; KR-102387682; KR-102388233; KR-102388302; KR-102388581; KR-102389969; KR-102397137; KR-102398366; KR-102400524; KR-102400828; KR-102402558; KR-102404913; KR-102406172; KR-102407591; KR-102410142; KR-102410669; KR-20200018967; KR-20200046260; KR-20200066189; KR-20200103275; KR-20200104792; KR-20210003181; KR-20210046982; KR-20210059589; KR-20210101275; KR-20210105362; KR-20210111066; KR-20210127132; KR-20220010701; KR-20220013548; KR-20220014052; KR-20220016267; KR-20220027826; KR-20220030887; KR-20220037849; KR-20220048207; KR-20220053526; KR-20220064067; KR-20220065255; KR-20220065256; KR-20220065257; KR-20220065258; KR-20220065259; KR-20220065260; KR-20220065261; KR-20220065262; KR-20220065263; KR-20220065264; KR-20220065265; KR-20220065266; KR-20220065267; KR-20220065268; KR-20220065269; KR-20220065270; KR-20220065271; KR-20220065272; KR-20220065273; KR-20220065274; KR-20220066769; KR-20220066801; KR-20220066823; KR-20220066842; KR-20220068687; KR-20220069339; KR-20220089499; LU-102335; LU-102335; NZ-779436; TW-202038162; TW-202118257; TW-202121289; TW-202145112; TW-202145113; TW-202145114; TW-202203144; TW-202205183; TW-1712973; TW-1726468; TW-1762321; TW-M604432; TW-M607726; TW-M621821; TW-M622047; TW-M622824; TW-M624097; TW-M626295; TW-M626967; TW-M626968; TW-M627535; WO-2019089778; WO-2019139678; WO-2019191688; WO-2019202563; WO-2019210138; WO-2019213700; WO-2019232536; WO-2019246072; WO-2020010023; WO-2020030891; WO-2020041069; WO-2020041126; WO-2020044341; WO-2020080537; WO-2020082077; WO-2020082082; WO-2020092900; WO-2020100602; WO-2020106498; WO-2020106991; WO-2020111870; WO-2020118297; WO-2020125863; WO-2020175656; WO-2020186001; WO-2020203349; WO-2020212436; WO-2020212445; WO-2020214880; WO-2020221181; WO-2020222862; WO-2020223332; WO-2020245280; WO-2020247017; WO-2020255372; WO-2021002917; WO-2021022000; WO-2021030246; WO-2021030877; WO-2021034603; WO-2021044211; WO-2021054989; WO-2021061415; WO-2021062160; WO-2021081178; WO-2021092434; WO-2021100118; WO-2021102116; WO-2021111653; WO-2021119104; WO-2021119106; WO-2021119618; WO-2021132483; WO-2021140460; WO-2021159097; WO-2021173837; WO-2021174139; WO-2021177695; WO-2021178900; WO-2021186814; WO-2021188472; WO-2021188561; WO-2021195249; WO-2021202920; WO-2021211814; WO-2021215998; WO-2021219869; WO-2021231911; WO-2021242709; WO-2021243043; WO-2021246498; WO-2021250022; WO-2021250037; WO-2021250045; WO-2021257588; WO-2021260674; WO-2022006661; WO-2022009715; WO-2022016020; WO-2022018433; WO-2022020183; WO-2022020183; WO-2022020772; WO-2022025634; WO-2022026374; WO-2022032385; WO-2022043750; WO-2022043751; WO-2022043752; WO-2022050739; WO-2022054342; WO-2022058977; WO-2022060149; WO-2022064497; WO-2022072609; WO-2022072617; WO-2022072624; WO-2022072625; WO-2022072630; WO-2022074449; WO-2022074450; WO-2022075051; WO-2022075154; WO-2022075675; WO-2022076036; WO-2022076800; WO-2022078303; WO-2022079217; WO-2022079488; WO-2022084414; WO-2022084737; WO-2022087420; WO-2022087542; WO-2022098793; WO-2022101452; WO-2022101515; WO-2022101980; WO-2022102815; WO-2022102816; WO-2022102817; WO-2022102818; WO-2022107746; WO-2022108886; WO-2022115572; WO-2022117609; WO-2022119785; WO-2022120073; WO-2022120474; WO-2022125851; WO-2022129610; WO-2022132234; WO-2022132235; WO-2022132255; WO-2022132256; WO-2022133160; WO-2022133210; WO-2022140454; WO-2022140803.
docs.openzeppelin.com/contracts/3.xlerc1155
en.wikipedia.org/wiki/Non-fungible_token
“EIP-1155: ERC-1155 Multi Token Standard”. Ethereum Improvement Proposals. Retrieved 2021-04-05.
“EIP-721: ERC-721 Non-Fungible Token Standard”. Ethereum Improvement Proposals. Retrieved 2021-04-05.
“Memes for Sale? Making sense of NFTs”. Harvard Law Today. Retrieved 26 Jun. 2021.
“NFTS' Nifty Copyright Issues—Intellectual Property—Canada”.
“The Cult of CryptoPunks”. TechCrunch. Retrieved 2021-05-05.
“Uniswap UNI Token was “Shining Star” of DeFi this Past Week, while Ethereum based NFTs Rising in Popularity, OKEx Reports”. Crowdfund Insider. 2021-03-07. Retrieved 2021-04-09.
“WTF Is an NFT, Anyway? And Should I Care?”. Wired. ISSN 1059-1028. Retrieved 2021-03-13.
Abbruzzese, Jason (16 Jun. 2017). “This ethereum-based project could change how we think about digital art”. Mashable. Retrieved 2021-04-06.
Ahmad Sghaier Omar and Otman Basir. Capability-based non-fungible tokens approach for a decentralized aaa framework in iot., 2020.
Ahmad Sghaier Omar. Decentralized identity and access management framework for internet of things devices. 2020.
Alexei Zamyatin, Mustafa AI-Bassam, Dionysis Zindros, Eleftherios Kokoris-Kogias, Pedro Moreno-Sanchez, Aggelos Kiayias, and William J Knottenbelt. Sok: communication across distributed ledgers. 2019.
Apptunix. The rise of non fungible tokens—benefits, features, risks and scope. www.apptunix.com/blog/the-rise-of-non-fungible-tokens-benefits-features-risks-and-scope/, 2021.
Ariel J Feldman, William P Zeller, Michael J Freedman, and Edward W Felten. Sporc: Group collaboration using untrusted cloud resources. In OSDI, volume 10, pages 337-350, 2010.
Babu Pillai, Kamanashis Biswas, and Vallipuram Muthukkumarasamy. Blockchain interoperable digital objects. In International Conference on Blockchain, pages 80-94. Springer, 2019.
Boscovic, Dragan. “How nonfungible tokens work and where they get their value—a cryptocurrency expert explains NFTs”. The Conversation. Retrieved 2021-04-08.
Chevet, Sylve (2018-05-10). “Blockchain Technology and Non-Fungible Tokens: Reshaping Value Chains in Creative Industries”. Rochester, NY. SSRN 3212662.
Chris Dannen. Introducing Ethereum and solidity, volume 318. Springer, 2017.
Chris Dannen. Smart contracts and tokens. In Introducing Ethereum and Solidity, pages 89-110. Springer, 2017.
Corinne Bernstein. 5 business use cases for nfts. whatis.techtarget.com/feature/5-business-use-cases-for-NFTs, 2021.
Daniel Uribe and Gisele Waters. Privacy laws, genomic data and non-fungible tokens. The Journal of The British Blockchain Association, page 13164, 2020.
Daniele Mazzei, Giacomo Baldi, Gualtiero Fantoni, Gabriele Montelisciani, Antonio Pitasi, Laura Ricci, and Lorenzo Rizzello. A blockchain tokenizer for industrial iot trustless applications. Future Generation Computer Systems, 105:432-445, 2020.
Hyland-Wood, David, and Shahan Khatchadourian. A future history of international blockchain standards. The Journal of the British Blockchain Association, 1(1):3724, 2018.
Lee, David, Kuo Chuen, Li Guo, and Yu Wang. Cryptocurrency: A new investment opportunity? The Journal of Alternative Investments, 20(3):16-40, 2017.
Uzsoki, David, Patrick Guerdat, et al. Impact tokens: a blockchain-based solution for impact investing. Impact tokens: a blockchain-based solution for impact investing., 2019.
Uzsoki, David. Tokenization of infrastructure: a blockchain-based solution to financing sustainable infrastructure. International Institute for Sustainable Development, 2019.
deVries, Alex (2018-05-16). “Bitcoin's Growing Energy Problem”. Joule.
Entriken, William (Jun. 22, 2018). “Move EIP 721 to Final (#1170) ethereum/EIPs@b015a86”. GitHub. Retrieved Nov. 7, 2021.
Entriken, William; Shirley, Dieter; Evans, Jacob; Natassia, Sachs (Jan. 24, 2018). “EIP-721: Non-Fungible Token Standard”. Ethereum Improvement Proposals. Retrieved Oct. 28, 2021.
Ethereum. Eip-1155: Erc-1155 multi token standard. Accessed: July, 2021. eips.ethereum.org/EIPS/eip-1155, 2018.
Ethereum. Erc-20 token standard. Accessed: July, 2021. ethereum.org/tr/developers/docs/standards/tokens/erc-20/, 2018.
Ethereum. Ethereum improvement proposals. Accessed: July, 2021. eips. ethereum.org/erc, 2021.
Feige, Uriel, Amos Fiat, and Adi Shamir. “Zero-knowledge proofs of identity.” Journal of cryptology 1, no. 2 (1988): 77-94.
Ferdinand Regner, Nils Urbach, and Andre Schweizer. Nfts in practice-nonfungible tokens as core component of a blockchain-based event ticketing application. 2019.
Florian Glatz. A blockchain token taxonomy. heckerhut.medium.com/a-blockchain-token-taxonomy-fadf5c56139a, 2016.
Florian Tschorsch and Bjorn Scheuermann. Bitcoin and beyond: A technical survey on decentralized digital currencies. IEEE Communications Surveys & Tutorials, 18(3):2084-2123, 2016.
Gallersdorfer, Ulrich; Klassen, Lena; Stoll, Christian (2020). “Energy Consumption of Cryptocurrencies Beyond Bitcoin”. Joule. 4 (9): 1843-1846. doi:10.1016/j.joule.2020.07.013. PMC 7402366. PMID 32838201.
Gang Wang and Mark Nixon. Intertrust: Towards an efficient blockchain interoperability architecture with trusted services. In 2021 IEEE International Conference on Blockchain (Blockchain). IEEE, 2021.
Gang Wang. Sok: Exploring blockchains interoperability. IACR Cryptol. ePrint Arch., 2021:537, 2021.
Genç, Ekin (2021-10-05). “Investors Spent Millions on ‘Evolved Apes’ NFTs. Then They Got Scammed”. Vice Media. Retrieved 2021-11-09.
Jake Frankenfield. Fungibility. www.investopedia.com/terms/f/fungibility.asp, 2021.
Javier Arcenegui, Rosario Arjona, and Iluminada Baturone. Secure management of iot devices based on blockchain non-fungible tokens and physical unclonable functions. In International Conference on Applied Cryptography and Network Security, pages 24-40. Springer, 2020.
Coleman, Jeff, Liam Horne, and Li Xuanji. Counterfactual: Generalized state channels. Acessed: 14.ventures/papers/statechannels.pdf, 4:2019, 2018.
Li, Jiasun, and William Mann. Initial coin offering and platform building. SSRN Electronic Journal, pages 1-56, 2018.
Benet, Juan. Ipfs-content addressed, versioned, p2p file system. arXiv preprint arXiv:1407.3561, 2014.
Katalyse.io. Security tokens vs. utility tokens how different are they? hackernoon.com/security-tokens-vs-utility-tokens-how-different-are-they-22d6be8901c2, 2018.
Krause, Max; Tolaymat, Thabet (2018). “Quantification of energy and carbon costs for mining cryptocurrencies”. Nature Sustainability. 1:814. doi:10.1038/s41893-018-0188-8.
Oliveira, Luis, Liudmila Zavolokina, Ingrid Bauer, and Gerhard Schwabe. To token or not to token: Tools for understanding blockchain tokens. 2018.
Miraz, Mahdi H, and David C Donald. Atomic cross-chain swaps: development, trajectory and potential of non-monetary digital token swap facilities. Annals of Emerging Technologies in Computing (AETiC) Vol, 3, 2019.
Matney, Lucas (2021-03-30). “ConsenSys launches a more energy-efficient NFT ecosystem with a project from artist Damien Hirst as its first drop”. Techcrunch. Retrieved 2021-04-21.
Herlihy, Maurice. Atomic cross-chain swaps. In Proceedings of ACM symposium on principles of distributed computing, pages 245-254, 2018.
Rosenfeld, Meni. Overview of colored coins. White paper, bitcoil. co. il, 41:94, 2012.
Borkowski, Michael, Christoph Ritzer, Daniel McDonald, and Stefan Schulte. Caught in chains: claim-first transactions for cross-blockchain asset transfers. Technische Universitst Wien, Whitepaper, 2018.
Morrow, Monique J., and Mehran Zarrebini. Blockchain and the tokenization of the individual: Societal implications. Future Internet, 11(10):220, 2019.
Salek Ali, Muhammad, Massimo Vecchio, Miguel Pincheira, Koustabh Dolui, Fabio Antonelli, and Mubashir Husain Rehmani. Applications of blockchains in the internet of things: A comprehensive survey. IEEE Communications Surveys & Tutorials, 21(2):1676-1717, 2018.
Bal, Mustafa, and Caitlin Ner. Nftracer: a non-fungible token tracking proof-of-concept using hyperledger fabric. arXiv preprint arXiv:1905.04795, 2019.
Karandikar, Nikita, Antorweep Chakravorty, and Chunming Rong. Blockchain based transaction system with fungible and non-fungible tokens for a community-based energy infrastructure. Sensors, 21(11):3822, 2021.
Ross, Omri, and Johannes Jensen. Assets under tokenization: Can blockchain technology improve post-trade processing? 2019.
Katsiampa, Paraskevi. Volatility co-movement between bitcoin and ether. Finance Research Letters, 30:221-227, 2019.
Aksoy, Pinar ça\ddot{g}layan, and Zehra Özkan Üner. Nfts and copyright: challenges and opportunities. Journal of Intellectual Property Law & Practice, 2021.
Proceedings of the 7th International Conference on Cloud Computing and Services Science, pages 755-764. Scitepress-Science and Technology Publications, Lda, 2017.
Wang, Qin, Rujia Li, Qi Wang, and Shiping Chen. Non-fungible token (nft): Overview, evaluation, opportunities and challenges. arXiv preprint arXiv:2105.07447, 2021.
Raman, Ravi Kiran, Roman Vaculin, Michael Hind, Sekou L Remy, Eleftheria K Pissadaki, Nelson Kibichii Bore, Roozbeh Daneshvar, Biplav Srivastava, and Kush R Varshney. Trusted multi-party computation and verifiable simulations: A scalable blockchain approach. arXiv preprint arXiv:1809.08438, 2018.
Conti, Robyn, and John Schmidt. What you need to know about non-fungible tokens (nfts). www.forbes.com/advisor/investing/nft-non-fungible-token/, 2021.
Merre, Ruben. Why 2021 will be the year of non-fungible tokens (nfts). www.linkedin.com/pulse/why-2021-year-non-fungible-tokens-nfts-ruben/, 2021.
Nakamoto, Satoshi. Bitcoin: A peer-to-peer electronic cash system. 2008.
Wilkinson, Shawn, Tome Boshevski, Josh Brandoff, and Vitalik Buterin. Storj a peer-to-peer cloud storage network. 2014.
Schulte, Stefan, Marten Sigwart, Philipp Frauenthaler, and Michael Borkowski. Towards blockchain interoperability. In International Conference on Business Process Management, pages 3-10. Springer, 2019.
Tai, Stefan, Jacob Eberhardt, and Markus Klems. Not acid, not base, but salt. In
Tönnissen, Stefan, Jan Heinrich Beinke, and Frank Teuteberg. Understanding token-based ecosystems-a taxonomy of blockchain-based business models of start-ups. Electronic Markets, 30(2):307-323, 2020.
Sun, Zhiyuan (2021-10-07). “Is There Any Hope Left for Cardano?”. The Motley Fool. Retrieved 2021-11-22.
Chevet, Sylve. Blockchain technology and non-fungible tokens: Reshaping value chains in creative industries. Available at SSRN 3212662, 2018.
Evans, Tonya M. Cryptokitties, cryptography, and copyright. AIPLA QJ, 47:219, 2019.
Urbach, Nils (Dec. 13, 2019). “NFTs in Practice—Non-Fungible Tokens as Core Component of a Blockchain-based Event Ticketing Application”; Fraunhofer Research Center, Finance and Information Management. Retrieved Oct. 28, 2021.
Chohan, Usman W. Non-fungible tokens: Blockchains, scarcity, and value. Critical Blockchain Research Initiative (CBRI) Working Papers, 2021.
Azevedo, Victor HM, Margareth S P Meirelles, Rodrigo P D Ferraz, and Antonio Ramalho-Filho. Interoperability among heterogeneous geographic objects. In Advances in Geoinformatics, pages 193-202. Springer, 2007.
Volpicelli, Gian (24 Feb. 2021). “The bitcoin elite are spending millions on collectable memes”. Wired U K.
Wang, Gang, and Mark Nixon. “SoK: Tokenization on Blockchain.” Cryptology ePrint Archive (2021).
Wang, Qin, Rujia Li, Qi Wang, and Shiping Chen. “Non-fungible token (NFT): Overview, evaluation, opportunities and challenges.” arXiv preprint arXiv:2105.07447 (2021).
Entriken, William, Dieter Shirley, Jacob Evans, and Nastassia Sachs. Erc-721 non-fungible token standard. Ethereum Foundation, 2018.
Wilson, Kathleen Bridget; Karg, Adam; Ghaderi, Hadi (October 2021). “Prospecting non-fungible tokens in the digital economy: Stakeholders and ecosystem, risk and opportunity”. Business Horizons: S0007681321002019. doi:10.1016/j.bushor.2021.10.007.
Li, Xuefeng, Xiaochuan Wu, Xin Pei, and Zhuojun Yao. Tokenization: Open asset protocol on blockchain. In 2019 IEEE 2nd International Conference on Information and Computer Technologies (ICICT), pages 204-209. IEEE, 2019.
Shen, Xuemin, Heather Yu, John Buford, and Mursalin Akon. Handbook of peerto-peer networking, volume 34. Springer Science & Business Media, 2010.
Hui, Yuk. What is a digital object? Metaphilosophy, 43(4):380-395, 2012.
Liu, Zhuotao, Yangxi Xiang, Jian Shi, Peng Gao, Haoyu Wang, Xusheng Xiao, Bihan Wen, and Yih-Chun Hu. Hyperservice: Interoperability and programmability across heterogeneous blockchains. In Proceedings of the 2019 ACM SIGSAC Conference on Computer and Communications Security, pages 549-566, 2019.

6. The Ethereum Virtual Machine (Evm)

9849364; 9967334; 10022613; 10022614; 10046228; 10121025; 10195513; 10200834; 10243743; 10250381; 10325596; 10373129; 10373158; 10445643; 10447478; 10454878; 10460283; 10482288; 10489709; 10496923; 10497037; 10532268; 10540640; 10540653; 10540654; 10581882; 10592985; 10594034; 10601585; 10635471; 10666778; 10671599; 10679128; 10693957; 10693958; 10699006; 10699269; 10700852; 10701054; 10701192; 10705866; 10708068; 10713564; 10715339; 10725843; 10733152; 10733583; 10735204; 10735207; 10740325; 10740844; 10742658; 10749848; 10762228; 10762516; 10764032; 10764067; 10769135; 10776696; 10783082; 10785168; 10789590; 10797994; 10805084; 10811771; 10817936; 10824601; 10825310; 10826709; 10839070; 10839107; 10839379; 10846765; 10853750; 10855448; 10860350; 10860710; 10866823; 10873559; 10877829; 10880077; 10880200; 10892898; 10893022; 10896149; 10896195; 10901955; 10902320; 10902852; 10909317; 10911220; 10915891; 10916845; 10917332; 10922195; 10924484; 10929842; 10931440; 10936871; 10937096; 10938567; 10938750; 10938791; 10942756; 10943618; 10944567; 10949231; 10951410; 10956903; 10963854; 10965447; 10965466; 10977135; 10992649; 10997251; 11010184; 11010303; 11016962; 11019059; 11030331; 11032215; 11038700; 11038771; 11039317; 11042400; 11042801; 11048825; 11049099; 11049115; 11055712; 11057189; 11057426; 11057504; 11063759; 11063864; 11063865; 11082850; 11086847; 11087214; 11088849; 11095434; 11100284; 11102190; 11119987; 11120335; 11128463; 11130042; 11132355; 11138597; 11139955; 11140077; 11144893; 11146555; 11151549; 11151838; 11153072; 11153073; 11159945; 11165589; 11170097; 11170371; 11175987; 11188418; 11188977; 11190342; 11195015; 11195231; 11200569; 11201727; 11207584; 11210660; 11216802; 11216811; 11218313; 11218409; 11233655; 11233734; 11238448; 11244313; 11250438; 11250493; 11251963; 11252166; 11257073; 11257077; 11257089; 11258586; 11258778; 11263067; 11263200; 11263632; 11263656; 11269864; 11270308; 11281796; 11283865; 11288736; 11294875; 11301222; 11301602; 11303603; 11307990; 11308487; 11310032; 11310051; 11310244; 11314885; 11315017; 11316690; 11316933; 11321282; 11321710; 11327732; 11327959; 11329982; 11334883; 11336011; 11336589; 11341467; 11347598; 11354447; 11354657; 11354727; 11354744; 11356285; 11361054; 11361289; 11361294; 11361562; 11366677; 11372848; 11374765; 20160260171; 20160261690; 20160335533; 20170232300; 20170236120; 20170289111; 20170338967; 20170352027; 20170353309; 20180025442; 20180040007; 20180078843; 20180089758; 20180089759; 20180089760; 20180089761; 20180091316; 20180117446; 20180117447; 20180133583; 20180183768; 20180218176; 20180225611; 20180247191; 20180264347; 20180326291; 20180331835; 20180341861; 20180349621; 20180373983; 20190019183; 20190028276; 20190043025; 20190050855; 20190058709; 20190080392; 20190080402; 20190080404; 20190080406; 20190080407; 20190081789; 20190081793; 20190087793; 20190087893; 20190102163; 20190104102; 20190130368; 20190156440; 20190164152; 20190164153; 20190180586; 20190188787; 20190188793; 20190197622; 20190197635; 20190213633; 20190220813; 20190228409; 20190228461; 20190236559; 20190236562; 20190236594; 20190236598; 20190236606; 20190238316; 20190238525; 20190244287; 20190258828; 20190273739; 20190279206; 20190281028; 20190303932; 20190306235; 20190319806; 20190319968; 20190325436; 20190325452; 20190334716; 20190334717; 20190334886; 20190334904; 20190334905; 20190342077; 20190354943; 20190354963; 20190354970; 20190356641; 20190358515; 20190361917; 20190362716; 20190370799; 20190378121; 20190384932; 20190394113; 20190394648; 20200004643; 20200012634; 20200013027; 20200019421; 20200027089; 20200028947; 20200034448; 20200034453; 20200034469; 20200034712; 20200042989; 20200044824; 20200044828; 20200044854; 20200051043; 20200051067; 20200051069;20200058023; 20200065763; 20200074460; 20200082266; 20200082388; 20200084194; 20200101367; 20200104712; 20200110648; 20200117493; 20200117657; 20200117690; 20200117730; 20200118656; 20200120023; 20200120084; 20200120157; 20200125456; 20200125556; 20200127843; 20200127945; 20200133926; 20200134614; 20200142722; 20200142765; 20200145197; 20200145230; 20200145233; 20200145366; 20200145406; 20200145520; 20200151718; 20200153608; 20200153899; 20200160320; 20200160354; 20200167503; 20200167512; 20200167791; 20200167840; 20200169387; 20200169388; 20200169402; 20200169407; 20200169546; 20200174937; 20200175487; 20200175526; 20200177372; 20200177519; 20200177604; 20200184093; 20200193397; 20200193428; 20200201838; 20200210402; 20200210978; 20200213121; 20200213305; 20200213427; 20200213826; 20200213852; 20200213857; 20200225974; 20200241961; 20200242577; 20200242595; 20200250174; 20200250176; 20200250177; 20200250295; 20200250374; 20200250661; 20200250683; 20200250747; 20200252205; 20200252404; 20200252406; 20200258061; 20200258148; 20200258159; 20200258166; 20200274695; 20200279309; 20200286090; 20200293346; 20200293516; 20200294009; 20200294039; 20200294143; 20200302300; 20200302434; 20200304319; 20200310901; 20200311050; 20200311257; 20200313857; 20200322129; 20200327609; 20200329018; 20200336475; 20200342092; 20200342319; 20200342449; 20200344060; 20200344069; 20200344132; 20200344233; 20200358183; 20200358184; 20200358784; 20200359550; 20200359582; 20200364075; 20200364149; 20200364187; 20200364207; 20200364214; 20200364456; 20200364703; 20200364813; 20200366680; 20200371995; 20200372502; 20200372505; 20200374105; 20200374106; 20200379852; 20200380476; 20200380624; 20200382478; 20200387896; 20200394652; 20200396065; 20200409942; 20200410349; 20210004791; 20210004796; 20210006506; 20210012336; 20210012676; 20210014066; 20210014150; 20210026668; 20210034460; 20210035090; 20210035092; 20210036839; 20210039669; 20210042137; 20210044545; 20210050989; 20210051026; 20210056638; 20210064784; 20210073212; 20210073284; 20210073285; 20210073540; 20210073796; 20210074120; 20210075591; 20210075623; 20210075825; 20210081549; 20210081934; 20210082033; 20210084005; 20210090166; 20210092059; 20210092060; 20210097508; 20210099283; 20210103582; 20210110827; 20210112117; 20210117933; 20210118005; 20210118532; 20210119774; 20210119918; 20210119994; 20210124722; 20210126794; 20210133155; 20210133700; 20210135880; 20210142431; 20210149696; 20210149884; 20210150205; 20210150524; 20210151884; 20210152369; 20210152535; 20210152536; 20210152557; 20210157799; 20210157823; 20210157982; 20210158273; 20210158344; 20210160057; 20210165686; 20210165890; 20210166126; 20210174432; 20210176045; 20210182423; 20210182773; 20210182968; 20210184836; 20210224796; 20210226774; 20210232572; 20210243193; 20210256070; 20210258143; 20210264416; 20210264520; 20210271602; 20210271877; 20210274350; 20210279358; 20210297368; 20210306164; 20210311925; 20210311934; 20210312089; 20210312291; 20210314164; 20210318896; 20210318897; 20210319438; 20210319439; 20210319441; 20210319456; 20210319510; 20210326158; 20210326864; 20210326865; 20210326868; 20210326869; 20210326880; 20210326889; 20210326906; 20210328791; 20210328806; 20210329009; 20210329453; 20210334363; 20210334804; 20210337033; 20210342131; 20210342133; 20210342329; 20210342787; 20210342849; 20210344496; 20210350010; 20210350019; 20210352139; 20210357891; 20210365902; 20210365903; 20210365937; 20210367790; 20210374539; 20210377003; 20210382865; 20210383232; 20210385206; 20210390161; 20210390531; 20210391995; 20210398116; 20210400042; 20220005316; 20220006705; 20220006817; 20220014922; 20220020018; 20220021538; 20220023742; 20220027867; 20220036343; 20220036350; 20220036366; 20220038261; 20220038264; 20220040557; 20220050887; 20220051238; 20220060484; 20220066751; 20220066756; 20220066803; 20220067715; 20220067721; 20220067725; 20220067831; 20220076518; 20220084021; 20220092562; 20220101307; 20220101313; 20220108311; 20220111960; 20220129475; 20220129884; 20220138705; 20220138739; 20220143511; 20220147512; 20220147694; 20220147988; 20220148002; 20220150169; 20220160309; 20220166626; 20220171607; 20220171876; 20220173912; 20220179651; 20220180432; 20220191272; 20220207022; 20220210061; AU-2017240682; AU-2017240682; AU-2017277857; AU-2017277857; AU-2018230763; AU-2018278351; AU-2018347199; AU-2018347199; AU-2018348324; AU-2018410093; AU-2019101575; AU-2019101593; AU-2019101607; AU-2019101610; AU-2019101612; AU-2019200729; AU-2019203861; AU-2019203862; AU-2019203864; AU-2019203864; AU-2019203865; AU-2019203865; AU-2019204722; AU-2019204722; AU-2019204729; AU-2019204729; AU-2019204730; AU-2019204730; AU-2019207311; AU-2019207311; AU-2019207312; AU-2019273039; AU-2019280577; AU-2019305079; AU-2019325569; AU-2020207841; AU-2020271014; AU-2020291554; AU-2020351308; AU-2020353683; AU-2021104504; AU-2022203954; AU-2022203955; BR-112019008064; BR-112019014847; BR-112020017132; CA-3019642; CA-3023325; CA-3023492; CA-3035817; CA-3037123; CA-3040783; CA-3043416; CA-3049924; CA-3049924; CA-3055108; CA-3055108; CA-3055829; CA-3057212; CA-3057395; CA-3058233; CA-3061265; CA-3061265; CA-3061268; CA-3061268; CA-3061427; CA-3061427; CA-3061808; CA-3065319; CA-3066816; CA-3077702; CA-3077702; CA-3086531; CA-3088610; CA-3094904; CA-3098920; CA-3101606; CA-3102237; CA-3103565; CA-3136435; CA-3141042; CA-3150262; CA-3152588; CA-3153011; CA-3153499; CH-716261; CH-716262; CH-716263; CH-716266; CH-716267; CH-716269; CH-716272; CH-716273; CH-716275; CH-716276; CH-716277; CH-716279; CH-716281; CH-716283; CH-716284; CH-716285; CH-716286; CH-716287; CH-716288; CH-716289; CH-716290; CH-716291; CH-716292; CH-716293; CH-716294; CH-716295; CH-716296; CH-716298; CH-716299; CH-716300; CH-716301; CH-716302; CN-107360238; CN-107844294; CN-107844294; CN-108011741; CN-108011741; CN-108200203; CN-108200203; CN-108282539; CN-108347483; CN-108347483; CN-108647958; CN-108664650; CN-108664650; CN-108694575; CN-108764852; CN-108846659; CN-108846659; CN-108846748; CN-108847943; CN-109034814; CN-109034814; CN-109064171; CN-109274524; CN-109274524; CN-109285014; CN-109345714; CN-109376504; CN-109376504; CN-109409885; CN-109460657; CN-109508968; CN-109508968; CN-109525865; CN-109525865; CN-109559136; CN-109583857; CN-109583905; CN-109615517; CN-109672542; CN-109688211; CN-109711849; CN-109711849; CN-109726206; CN-109726206; CN-109739485; CN-109872113; CN-109903161; CN-109903161; CN-109933404; CN-109933404; CN-109934005; CN-109981673; CN-109981673; CN-110009321; CN-110009321; CN-110046023; CN-110046023; CN-110046991; CN-110046991; CN-110046992; CN-110047077; CN-110047077; CN-110048846; CN-110048846; CN-110097373; CN-110210209; CN-110223172; CN-110223172; CN-110225049; CN-110245490; CN-110245490; CN-110245503; CN-110245503; CN-110245504; CN-110245504; CN-110245506; CN-110245506; CN-110245945; CN-110245945; CN-110245946; CN-110245946; CN-110247895; CN-110247895; CN-110263086; CN-110263086; CN-110263087; CN-110263087; CN-110263088; CN-110263088; CN-110263089; CN-110263089; CN-110263090; CN-110263090; CN-110263091; CN-110263091; CN-110263536; CN-110263543; CN-110263543; CN-110264194; CN-110264194; CN-110264195; CN-110264195; CN-110264196; CN-110264196; CN-110264197; CN-110264197; CN-110264198; CN-110264198; CN-110266644; CN-110266644; CN-110276684; CN-110276684; CN-110278193; CN-110278193; CN-110287002; CN-110297689; CN-110297689; CN-110377323; CN-110392052; CN-110392052; CN-110399184; CN-110414957; CN-110427179; CN-110427179; CN-110428257; CN-110458708; CN-110472974; CN-110474884; CN-110489973; CN-110554866; CN-110557362; CN-110599169; CN-110599169; CN-110716724; CN-110716724; CN-110766550; CN-110766550; CN-110795755; CN-110795755; CN-110866255; CN-110866255; CN-110910135; CN-110992027; CN-110992027; CN-111221780; CN-111221780; CN-111371941; CN-111381938; CN-111381938; CN-111444092; CN-111444092; CN-111478932; CN-111488115; CN-111523784; CN-111524007; CN-111768183; CN-111768184; CN-111768187; CN-111768200; CN-111770113; CN-111770113; CN-111770116; CN-111770116; CN-111770202; CN-111770202; CN-111770204; CN-111770204; CN-111770205; CN-111770205; CN-111770206; CN-111770206; CN-111782338; CN-111784426; CN-111814202; CN-111814202; CN-111815310; CN-111815310; CN-111815330; CN-111970112; CN-111970112; CN-112052235; CN-112070605; CN-112073254; CN-112214802; CN-112269839; CN-112368699; CN-112380541; CN-112381651; CN-112581140; CN-112613946; CN-112689009; CN-112749230; CN-112767155; CN-112819468; CN-112822432; CN-112862650; CN-112866392; CN-112866412; CN-113010878; CN-113034137; CN-113051144; CN-113051144; CN-113068201; CN-113077260; CN-113240519; CN-113283901; CN-113284362; CN-113327167; CN-113467888; CN-113468599; CN-113486114; CN-113504940; CN-113537625; CN-113645036; CN-113792318; CN-113807802; CN-113872772; CN-113872948; CN-113888163; CN-113986300; CN-114024748; CN-114116134; CN-114331785; CN-114418570; CN-114429402; CN-209911801; DE-102019216743; DE-102020215135; EP-3329440; EP-3355225; EP-3423999; EP-3432240; EP-3437048; EP-3437048; EP-3465516; EP-3465516; EP-3477569; EP-3497581; EP-3503012; EP-3540662; EP-3542494; EP-3542494; EP-3545481; EP-3563329; EP-3563329; EP-3564884; EP-3570550; EP-3579494; EP-3579494; EP-3580913; EP-3580913; EP-3582161; EP-3583507; EP-3583508; EP-3583531; EP-3586263; EP-3590226; EP-3590226; EP-3593249; EP-3593249; EP-3593305; EP-3593491; EP-3596888; EP-3596906; EP-3596906; EP-3602457; EP-3602457; EP-3607733; EP-3607733; EP-3610357; EP-3610450; EP-3612930; EP-3613170; EP-3613170; EP-3614328; EP-3616358; EP-3619665; EP-3619665; EP-3642753; EP-3642753; EP-3643041; EP-3643041; EP-3656084; EP-3665595; EP-3665595; EP-3665634; EP-3665635; EP-3669280; EP-3669280; EP-3669281; EP-3669514; EP-3673404; EP-3673620; EP-3673620; EP-3688618; EP-3688618; EP-3692462; EP-3701383; EP-3701383; EP-3701446; EP-3701666; EP-3701701; EP-3714381; EP-3718069; EP-3747153; EP-3752975; EP-3759630; EP-3777089; EP-3782350; EP-3785199; EP-3788569; EP-3789901; EP-3791538; EP-3792855; EP-3794532; EP-3794532; EP-3794770; EP-3794770; EP-3796188; EP-3798861; EP-3804215; EP-3812897; EP-3813000; EP-3813002; EP-3813003; EP-3813297; EP-3815294; EP-3817281; EP-3824423; EP-3834155; EP-3834363; EP-3834364; EP-3862947; EP-3863220; EP-3867770; EP-3889780; EP-3893137; EP-3893137; EP-3896633; EP-3906488; EP-3906652; EP-3906657; EP-3910516; EP-3910516; EP-3910877; EP-3910877; EP-3913890; EP-3921794; EP-3923538; EP-3923546; EP-3923546; EP-3933581; EP-3933581; EP-3933641; EP-3933642; EP-3937050; EP-3937424; EP-3945432; EP-3955191; EP-3961375; EP-3961376; EP-3961390; EP-3961391; EP-3961437; EP-3961438; EP-3961453; EP-3961455; EP-3961456; EP-3961460; EP-3961546; EP-3961973; EP-3961974; EP-3961975; EP-3961976; EP-3962020; EP-3962135; EP-3971741; EP-3971742; EP-3971809; EP-3973431; EP-3973490; EP-3977383; EP-3983907; EP-3997572; EP-4005151; EP-4007985; EP-4010817; EP-4016916; EP-4018596; ES-2808411; ES-2862428; ES-2864179; ES-2871062; ES-2872101; ES-2880108; ES-2882677; FR-3100631; HR-P20191236; HR-PK20191236; IL-277004; IL-278873; IL-288930; IN-201817045851; IN-201841004279; IN-201914036514; IN-201941039217; IN-201947004919; IN-201947015709; IN-201947024465; IN-201947024677; IN-201947024872; IN-201947024874; IN-201947029881; IN-201947037557; IN-201947037931; IN-201947038455; IN-201947038548; IN-201947039002; IN-201947043731; IN-201947043918; IN-201947044084; IN-201947044089; IN-202011043075; IN-202017044630; IN-202041003745; IN-202047014826; IN-202111004571; IN-202111024778; IN-202117016530; IN-202141058687; IN-202241010924; IN-202241022673; IN-202241027370; IN-369670; JP-2018185808; JP-2019153260; JP-2019524018; JP-2020030454; JP-2020064460; JP-2020068388; JP-2020108044; JP-2020502617; JP-2020509443; JP-2020511017; JP-2020511018; JP-2020511702; JP-2020511803; JP-2020516104; JP-2020518887; JP-2020519959; JP-2020519983; JP-2020522725; JP-2020522778; JP-2020522796; JP-2020524421; JP-2020525875; JP-2020525877; JP-2020528224; JP-2021177422; JP-2021503676; JP-2021504813; JP-2021512416; JP-2021515296; JP-2021520169; JP-2021524645; JP-2021527279; JP-2021534486; JP-2022009204; JP-2022065010; JP-2022091158; JP-2022515421; JP-6405478; JP-6640320; JP-6698135; JP-6731123; JP-6779389; JP-6853364; JP-6856749; JP-6856772; JP-6864088; JP-6864330; JP-6869374; JP-6871386; JP-6880227; JP-6882527; JP-6892513; JP-6922097; JP-6923674; JP-6936259; JP-6955026; JP-6964211; JP-6965352; JP-6978168; JP-7007077; JP-7053031; KR-101852077; KR-101852078; KR-101852079; KR-101852080; KR-101870112; KR-101870113; KR-101878869; KR-101878870; KR-101932277; KR-101936756; KR-101936757; KR-101936758; KR-101936759; KR-101947760; KR-101962285; KR-101962286; KR-101962287; KR-101962288; KR-101962289; KR-101962290; KR-101976401; KR-102008001; KR-102014647; KR-102051257; KR-102068250; KR-102092953; KR-102094721; KR-102095046; KR-102096637; KR-102096638; KR-102096639; KR-102096640; KR-102096641; KR-102096642; KR-102096643; KR-102096644; KR-102096645; KR-102096646; KR-102096660; KR-102096890; KR-102123320; KR-102128476; KR-102137784; KR-102142259; KR-102143511; KR-102149998; KR-102149999; KR-102151907; KR-102160379; KR-102166029; KR-102169311; KR-102170345; KR-102170347; KR-102170820; KR-102172514; KR-102186089; KR-102187293; KR-102190870; KR-102192267; KR-102194077; KR-102206026; KR-102207234; KR-102212817; KR-102227442; KR-102230764; KR-102230829; KR-102236341; KR-102237014; KR-102237015; KR-102247233; KR-102247658; KR-102254500; KR-102263325; KR-102263692; KR-102281901; KR-102293877; KR-102296907; KR-102298677; KR-102314384; KR-102315473; KR-102316858; KR-102329221; KR-102332031; KR-102332503; KR-102340903; KR-102348774; KR-102359678; KR-102361207; KR-102361212; KR-102361215; KR-102361217; KR-102361221; KR-102361222; KR-102361224; KR-102365793; KR-102372111; KR-102391469; KR-102392394; KR-102392739; KR-102398543; KR-102404284; KR-20180068888; KR-20190015287; KR-20190019422; KR-20190076812; KR-20190076813; KR-20190076837; KR-20190105734; KR-20190109167; KR-20190109914; KR-20190110398; KR-20190110399; KR-20190110421; KR-20190118432; KR-20190118458; KR-20190124371; KR-20190127512; KR-20190134432; KR-20190136844; KR-20190139742; KR-20190139743; KR-20190139744; KR-20200001301; KR-20200012685; KR-20200012686; KR-20200012687; KR-20200012688; KR-20200012689; KR-20200012690; KR-20200012691; KR-20200020291; KR-20200021194; KR-20200024723; KR-20200027398; KR-20200031264; KR-20200032086; KR-20200037159; KR-20200048546; KR-20200048547; KR-20200048548; KR-20200048549; KR-20200048550; KR-20200048551; KR-20200048552; KR-20200048553; KR-20200048554; KR-20200048555; KR-20200051218; KR-20200056958; KR-20200056959; KR-20200058146; KR-20200059136; KR-20200061853; KR-20200062640; KR-20200066261; KR-20200072318; KR-20200074910; KR-20200077227; KR-20200077681; KR-20200077830; KR-20200078002; KR-20200078922; KR-20200083932; KR-20200089384; KR-20200091237; KR-20200093089; KR-20200093483; KR-20200093484; KR-20200093918; KR-20200093953; KR-20200093972; KR-20200094618; KR-20200105997; KR-20200105998; KR-20200105999; KR-20200106000; KR-20200107712; KR-20200112633; KR-20200112634; KR-20200112635; KR-20200112636; KR-20200114434; KR-20200115902; KR-20200116011; KR-20200118353; KR-20200126320; KR-20200126321; KR-20200141417; KR-20210002978; KR-20210005035; KR-20210019771; KR-20210026000; KR-20210050525; KR-20210050526; KR-20210050527; KR-20210053132; KR-20210061676; KR-20210086035; KR-20210092950; KR-20210093896; KR-20210103615; KR-20210105316; KR-20210105317; KR-20210122211; KR-20210122212; KR-20210125215; KR-20210126152; KR-20210128958; KR-20210131856; KR-20210132462; KR-20210139059; KR-20210158271; KR-20220024240; KR-20220030798; KR-20220041334; KR-20220056036; KR-20220060336; KR-20220061840; KR-20220062781; KR-20220063147; KR-20220076687; KR-20220085568; KR-20220088207; NZ-747888; OA-19964; RU-2729700; RU-2738590; RU-2742003; RU-2744496; RU-2748177; RU-2757256; RU-2758997; RU-2759090; RU-2765980; RU-2766062; TW-201926155; TW-201937419; TW-201945989; TW-202004546; TW-202011312; TW-202022638; TW-202022676; TW-202022734; TW-202022735; TW-202022748; TW-202023235; TW-202025061; TW-202025066; TW-202027530; TW-202036229; TW-202036448; TW-202037116; TW-202037122; TW-202037138; TW-202046299; TW-202101198; TW-202101199; TW-202105276; TW-202105299; TW-202105372; TW-202107315; TW-202107355; TW-202107372; TW-202107373; TW-202107374; TW-202107375; TW-202107376; TW-202107377; TW-202107456; TW-202107457; TW-202107458; TW-202109288; TW-202109330; TW-202109428; TW-202112115; TW-202113645; TW-202118274; TW-202119229; TW-202125296; TW-202201306; TW-202211138; TW-1648680; TW-1675336; TW-1687889; TW-1688907; TW-1699718; TW-1707290; TW-1709063; TW-1716116; TW-1717135; TW-1718662; TW-1719651; TW-1720724; TW-1723622; TW-1723783; TW-1724678; TW-1724813; TW-1728654; TW-1729609; TW-1729719; TW-1730654; TW-1733349; TW-1737183; TW-1737200; TW-1737233; TW-1741373; TW-1742659; TW-1743698; TW-1743881; TW-1748244; TW-1759841; TW-1761879; TW-M543413; TW-M591647; TW-M601391; TW-M607453; TW-M607492; WO-2017021155; WO-2017148527; WO-2017173271; WO-2017190175; WO-2017213943; WO-2018026807; WO-2018031551; WO-2018058105; WO-2018058108; WO-2018140913; WO-2018165472; WO-2018195644; WO-2018209190; WO-2018223042; WO-2018224431; WO-2019023286; WO-2019027457; WO-2019030653; WO-2019030682; WO-2019033116; WO-2019034989; WO-2019035527; WO-2019045589; WO-2019051401; WO-2019051449; WO-2019051451; WO-2019055585; WO-2019070357; WO-2019070853; WO-2019072283; WO-2019072297; WO-2019072310; WO-2019081015; WO-2019084345; WO-2019092508; WO-2019096326; WO-2019101224; WO-2019101225; WO-2019101226; WO-2019101227; WO-2019101241; WO-2019101242; WO-2019101244; WO-2019101245; WO-2019102385; WO-2019109003; WO-2019120316; WO-2019120319; WO-2019120320; WO-2019120327; WO-2019120328; WO-2019126471; WO-2019137564; WO-2019137565; WO-2019141289; WO-2019142049; WO-2019147736; WO-2019148210; WO-2019152750; WO-2019156914; WO-2019156915; WO-2019156916; WO-2019159187; WO-2019162753; WO-2019164926; WO-2019169401; WO-2019170169; WO-2019170175; WO-2019179538; WO-2019179539; WO-2019179540; WO-2019182310; WO-2019186282; WO-2019195639; WO-2019196249; WO-2019198839; WO-2019198840; WO-2019209565; WO-2019209610; WO-2019209611; WO-2019209612; WO-2019210409; WO-2019211691; WO-2019218718; WO-2019227104; WO-2019228550; WO-2019235956; WO-2019236426; WO-2020002974; WO-2020003131; WO-2020011283; WO-2020011284; WO-2020018921; WO-2020029844; WO-2020030891; WO-2020033830; WO-2020033832; WO-2020033835; WO-2020036657; WO-2020040801; WO-2020041547; WO-2020045964; WO-2020050474; WO-2020051486; WO-2020061593; WO-2020080145; WO-2020081163; WO-2020081727; WO-2020091103; WO-2020108138; WO-2020119379; WO-2020119380; WO-2020119382; WO-2020119387; WO-2020119391; WO-2020119393; WO-2020119512; WO-2020130717; WO-2020135393; WO-2020138595; WO-2020142325; WO-2020142326; WO-2020142504; WO-2020145887; WO-2020150185; WO-2020160109; WO-2020163790; WO-2020177547; WO-2020179996; WO-2020204743; WO-2020210076; WO-2020220760; WO-2020220761; WO-2020224353; WO-2020231525; WO-2020233350; WO-2020233421; WO-2020233422; WO-2020233423; WO-2020233424; WO-2020233425; WO-2020233609; WO-2020233610; WO-2020233612; WO-2020233613; WO-2020233614; WO-2020233615; WO-2020233616; WO-2020233619; WO-2020233622; WO-2020233623; WO-2020233624; WO-2020233625; WO-2020233626; WO-2020233627; WO-2020233628; WO-2020233629; WO-2020233630; WO-2020233631; WO-2020233632; WO-2020233633; WO-2020233634; WO-2020233635; WO-2020233637; WO-2020233638; WO-2020233639; WO-2020233640; WO-2020233642; WO-2020233643; WO-2020233644; WO-2020234814; WO-2020236316; WO-2020238254; WO-2020238255; WO-2020238878; WO-2020238955; WO-2020238958; WO-2020238959; WO-2020242587; WO-2020243725; WO-2020244514; WO-2020249572; WO-2020252479; WO-2020253476; WO-2020259629; WO-2021008122; WO-2021008123; WO-2021016998; WO-2021017008; WO-2021017009; WO-2021017429; WO-2021017432; WO-2021017433; WO-2021017437; WO-2021017438; WO-2021017439; WO-2021017440; WO-2021017441; WO-2021017442; WO-2021017443; WO-2021017444; WO-2021017470; WO-2021036173; WO-2021036174; WO-2021036191; WO-2021042809; WO-2021042810; WO-2021042811; WO-2021042817; WO-2021042818; WO-2021042880; WO-2021042885; WO-2021046470; WO-2021046541; WO-2021048056; WO-2021052338; WO-2021053404; WO-2021057124; WO-2021057141; WO-2021057166; WO-2021057167; WO-2021057168; WO-2021057184; WO-2021057272; WO-2021057273; WO-2021062299; WO-2021068726; WO-2021082664; WO-2021088533; WO-2021088535; WO-2021088536; WO-2021088543; WO-2021088546; WO-2021088547; WO-2021088548; WO-2021088549; WO-2021101888; WO-2021103794; WO-2021107826; WO-2021113369; WO-2021114819; WO-2021116950; WO-2021120537; WO-2021121090; WO-2021125997; WO-2021135467; WO-2021173028; WO-2021178719; WO-2021179743; WO-2021184325; WO-2021184882; WO-2021184961; WO-2021184962; WO-2021184963; WO-2021184968; WO-2021184970; WO-2021184973; WO-2021184975; WO-2021197097; WO-2021208754; WO-2021209043; WO-2021209052; WO-2021218778; WO-2021243740; WO-2021244054; WO-2021256699; WO-2021257588; WO-2021259140; WO-2022020072; WO-2022026374; WO-2022033118; WO-2022050608; WO-2022052632; WO-2022061878; WO-2022077181; WO-2022077186; WO-2022078632; WO-2022089518; WO-2022097799; WO-2022097836; WO-2022098015; WO-2022105600; WO-2022109428; WO-2022131954;
Announcement of imminent hard fork for EIP150 gas cost changes. blog.ethereum.org/2016/10/13/announcement-imminent-hard-fork-eip150-gas-cost-changes/
Atzei, Nicola, Massimo Bartoletti, and Tiziana Cimoli. “A survey of attacks on ethereum smart contracts (sok).” In International conference on principles of security and trust, pp. 164-186. Springer, Berlin, Heidelberg, 2017
Bitcointalk: Hi!My name is Rubixi. bitcointalk.org/index.php?topic=1400536.60
Ethereum Classic. ethereumclassic.github.io/
The ethereum network is currently undergoing a dos attack. blog.ethereum.org/2016/09/22/ethereum-network-currently-undergoing-dos-attack/
Ethereum reddit page. www.reddit.com/r/ethereum
Ethereum Wiki: Contract security techniques and tips. github.com/ethereum/wiki/wiki/Safety
Explaining eip 150. www.reddit.com/r/ethereum/comments/56f6we/explaining_eip_150/
GovernMental main page. governmental.github.io/GovernMental/
Hacking, Distribute: Scanning live Ethereum contracts for the “unchecked-send” bug. hackingdistributed.com/2016/06/16/scanning-live-ethereum-contracts-for-bugs/
King of the Ether Throne: Post mortem investigation. www.kingoftheether.com/postmortem.html
MAker DART: a random number generating game for Ethereum. github.com/makerdao/maker-darts
RANDAO: a DAO working as RNG of Ethereum. github.com/randao/randao
Solidity: security considerations. solidity.readthedocs.io/en/develop/index.html
Understanding the DAO attack. www.coindesk.com/understanding-dao-hack-journalists/
Anderson, L., Holz, R., Ponomarev, A., Rimba, P., Weber, I.: New kids on the block: an analysis of modern blockchains. CoRR, abs/1606.06530 (2016)
Andrychowicz, M., Dziembowski, S., Malinowski, D., Mazurek, L.: Secure multiparty computations on Bitcoin. In: IEEE S&P, pp. 443-458 (2014)
Bhargavan, K., Delignat-Lavaud, A., Fournet, C., Gollamudi, A., Gonthier, G., Kobeissi, N., Rastogi, A., Sibut-Pinote, T., Swamy, N., Zanella-Beguelin, S.: Formal verification of smart contracts. In: PLAS (2016)
Bishop, M.: A taxonomy of Unix system and network vulnerabilities. Technical Report, CSE-95-10, Department of Computer Science, University of California at Davis (1995)
Bishop, M.: Vulnerabilities analysis. In: Proceedings of the Recent Advances in Intrusion Detection, pp. 125-136 (1999)
Boneh, D., Naor, M.: Timed commitments. In: Bellare, M. (ed.) CRYPTO 2000. LNCS, vol. 1880, pp. 236-254. Springer, Heidelberg (2000). doi: 10.1007/3-540-44598-6_15CrossRef
Bonneau, J., Clark, J., Goldfeder, S.: On Bitcoin as a public randomness source. IACR Cryptology ePrint Archive 2015, 1015 (2015)
Brown, R. G., Carlyle, J., Grigg, I., Hearn, M.: Corda: an introduction (2016). r3cev.com/s/corda-introductory-whitepaper-final.pdf
Buterin, V.: Ethereum: a next generation smart contract and decentralized application platform (2013). github.com/ethereum/wiki/wiki/White-Paper
Churyumov, A.: Byteball: a decentralized system for transfer of value (2016). byteball.org/Byteball.pdf
Clack, C. D., Bakshi, V. A., Braine, L.: Smart contract templates: foundations, design landscape and research directions. CoRR abs/1608.00771 (2016)
Delmolino, K., Arnett, M., Kosba, A. M. A., Shi, E.: Step by step towards creating a safe smart contract: lessons and insights from a crypto currency lab (2016)
Etherscripter. etherscripter.com
Eyal, I., Sirer, E.: Majority is not enough: bitcoin mining is vulnerable. In: Financial Cryptography and Data Security, pp. 436-454 (2014)
Frantz, C. K., Nowostawski, M.: From institutions to code: towards automated generation of smart contracts. In: Workshop on Engineering Collective Adaptive Systems (eCAS) (2016)
Garay, J., Kiayias, A., Leonardos, N.: The bitcoin backbone protocol: analysis and applications. In: Oswald, E., Fischlin, M. (eds.) EUROCRYPT 2015. LNCS, vol. 9057, pp. 281-310. Springer, Heidelberg (2015). doi: 10.1007/978-3-662-46803-6_10
Gervais, A., Karame, G. O., Wust, K., Glykantzis, V., Ritzdorf, H., Capkun, S.: On the security and performance of proof of work blockchains. In: ACM CCS, pp. 3-16 (2016)
Hirai, Y.: Formal verification of Deed contract in Ethereum name service. yoichihirai.com/deed.pdf
Landwehr, C. E., Bull, A. R., McDermott, J. P., Choi, W. S.: A taxonomy of computer program security flaws. ACM Comput. Surv. 26(3), 211-254 (1994)CrossRef
Luu, L., Chu, D. H., Olickel, H., Saxena, P., Hobor, A.: Making smart contracts smarter. In: ACM CCS (2016). eprint.iacr.org/2016/633
Luu, L., Teutsch, J., Kulkarni, R., Saxena, P.: Demystifying incentives in the consensus computer. In: ACM CCS, pp. 706-719 (2015)
Marino, B., Juels, A.: Setting standards for altering and undoing smart contracts. In: RuleML, pp. 151-166 (2016)
Nakamoto, S.: Bitcoin: a peer-to-peer electronic cash system (2008). bitcoin.org/bitcoin.pdf
Nipkow, T., Wenzel, M., Paulson, L. C. (eds.): Isabelle/HOL: A Proof Assistant for Higherorder. LNCS, vol. 2283. Springer, Heidelberg (2002)zbMATH
Nomura Research Institute: Survey on blockchain technologies and related services. www.meti.go.jp/english/press/2016/pdf/0531_01f.pdf
Pierrot, C., Wesolowski, B.: Malleability of the blockchain's entropy. IACR Cryptology ePrint Archive 2016, 370 (2016)
Piessens, F.: A taxonomy of causes of software vulnerabilities in internet software. In: International Symposium on Software Reliability Engineering, pp. 47-52 (2002)
Popejoy, S.: The Pact smart contract language (2016). kadena.io/pact
Sompolinsky, Y., Zohar, A.: Secure high-rate transaction processing in bitcoin. In: Böhme, R., Okamoto, T. (eds.) FC 2015. LNCS, vol. 8975, pp. 507-527. Springer, Heidelberg (2015). doi: 10.1007/978-3-662-47854-7_32CrossRef
Swamy, N., Hritcu, C., Keller, C., Rastogi, A., Delignat-Lavaud, A., Forest, S., Bhargavan, K., Fournet, C., Strub, P., Kohlweiss, M., Zinzindohoue, J. K., Béguelin, S. Z.: Dependent types and multi-monadic effects in F*. In: POPL (2016)
Szabo, N.: Formalizing and securing relationships on public networks. First Monday 2(9) (1997). firstmonday.org/htbin/cgiwrap/bin/ojs/index.php/fm/article/view/548
UK Government Chief Scientific Adviser: Distributed ledger technology: beyond block chain. www.gov.uk/government/uploads/system/uploads/attachment_data/file/492972/gs-16-1-distributed-ledger-technology.pdf
Wood, G.: Ethereum: a secure decentralised generalised transaction ledger (2014). gavwood.com/paper.pdf
Wüst, K., Gervais, A.: Ethereum Eclipse Attacks. Technical report, ETH-Zurich (2016).

7. Compensation of Users

10034155; 10038933; 10043185; 10115087; 10127555; 10204316; 10212251; 10231099; 10275948; 10282727; 10325264; 10356199; 10395128; 10395535; 10410076; 10438205; 10482461; 10506299; 10521579; 10540654; 10589699; 10595172; 10628760; 10631035; 10652354; 10657732; 10740722; 10740754; 10743046; 10748153; 10750340; 10769495; 10783227; 10783573; 10796309; 10817855; 10825344; 10872256; 10891598; 10896347; 10902424; 10977651; 10979327; 10979745; 10984405; 11011070; 11017490; 11074360; 11120401; 11127003; 11159333; 11159909; 11176566; 11200569; 11205197; 11245653; 11277490; 11282101; 11295348; 11308487; 11334883; 11373216; 11375404; 20020019774; 20020026510; 20020032608; 20020038337; 20020046160; 20020048369; 20020087525; 20020106065; 20020112171; 20020133402; 20020178053; 20030063072; 20030088784; 20030105721; 20030163431; 20030191719; 20030208483; 20030225614; 20040032393; 20040054630; 20040103305; 20040133793; 20040145777; 20050043060; 20050114210; 20050177716; 20060026030; 20060031376; 20060031515; 20060069926; 20060136393; 20060174326; 20060178966; 20060178967; 20060178968; 20060178970; 20060178972; 20060178975; 20060195376; 20060212722; 20060224505; 20060224903; 20060229976; 20060235790; 20060235791; 20060242554; 20060259359; 20070013691; 20070013692; 20070024613; 20070035548; 20070035549; 20070038559; 20070061594; 20070064943; 20070073582; 20070073614; 20070088656; 20070106526; 20070106557; 20070106576; 20070112624; 20070112660; 20070118420; 20070124239; 20070130001; 20070136185; 20070150986; 20070156509; 20070168214; 20070174183; 20070198305; 20070203725; 20070203817; 20070203828; 20070219967; 20070226807; 20070234069; 20070245403; 20070250937; 20070261125; 20070266429; 20070268299; 20070277031; 20080010124; 20080021783; 20080022137; 20080034227; 20080034230; 20080034231; 20080034406; 20080046312; 20080052541; 20080063161; 20080082381; 20080092065; 20080120168; 20080126798; 20080126803; 20080127304; 20080133392; 20080140491; 20080148056; 20080177558; 20080201227; 20080215434; 20080228580; 20080228607; 20080228628; 20080228632; 20080238936; 20080270165; 20080279481; 20080300986; 20090012864; 20090018910; 20090037364; 20090043604; 20090043652; 20090043682; 20090043683; 20090048978; 20090055246; 20090070180; 20090076914; 20090099927; 20090099930; 20090100354; 20090106673; 20090125383; 20090132440; 20090132805; 20090132815; 20090138333; 20090138355; 20090144132; 20090144148; 20090192881; 20090193016; 20090197577; 20090198608; 20090228920; 20090265650; 20090282030; 20090292599; 20090299853; 20100077095; 20100100440; 20100114662; 20100223191; 20100228996; 20100235292; 20100250935; 20100257614; 20100275040; 20100287050; 20100312661; 20100312680; 20100313013; 20110010367; 20110022520; 20110022846; 20110145057; 20110145602; 20110173695; 20110197285; 20110281246; 20110282929; 20110307801; 20120059708; 20120059713; 20120072272; 20120072286; 20120078729; 20120095937; 20120110615; 20120110616; 20120110618; 20120110619; 20120110620; 20120150598; 20120158516; 20120190386; 20120233066; 20120271718; 20120289147; 20120297408; 20130006775; 20130103468; 20130110986; 20130144970; 20130159033; 20130185139; 20130190094; 20130190096; 20130238409; 20130238439; 20130238440; 20130238751; 20130238761; 20130238762; 20130238777; 20130246275; 20130311261; 20130339146; 20130339155; 20130339180; 20130346177; 20140040255; 20140053187; 20140067501; 20140143889; 20140187147; 20140278942; 20140279688; 20140282900; 20140308632; 20140310108; 20140324895; 20140325333; 20140325542; 20140325543; 20140325552; 20140325557; 20140335948; 20140359667; 20150026815; 20150100581; 20150100646; 20150113609; 20150120533; 20150126226; 20150156188; 20150178392; 20150193744; 20150213446; 20150235277; 20150235316; 20150278855; 20150294358; 20150324770; 20150324804; 20150324899; 20150324900; 20150324901; 20150324902; 20150324903; 20150324904; 20150324906; 20150324907; 20150324908; 20150348001; 20150348002; 20150348014; 20150348029; 20160034938; 20160057594; 20160057609; 20160107084; 20160133134; 20160155101; 20160192119; 20160196723; 20160232468; 20160232569; 20160241927; 20160253665; 20160260089; 20160277528; 20160328759; 20160335633; 20160359957; 20160359987; 20170032375; 20170053476; 20170132688; 20170178034; 20170193468; 20170214763; 20170223131; 20170255964; 20170364955; 20180025334; 20180077550; 20180114250; 20180158066; 20180186288; 20180186311; 20180189518; 20180189766; 20180189912; 20180190040; 20180232958; 20180276673; 20180341500; 20180352399; 20180357900; 20180373956; 20190012612; 20190050867; 20190056902; 20190057372; 20190058248; 20190073673; 20190080066; 20190080070; 20190080071; 20190080072; 20190080189; 20190109911; 20190130779; 20190147471; 20190171341; 20190172030; 20190172124; 20190172272; 20190174172; 20190197477; 20190208377; 20190236549; 20190236959; 20190253515; 20190303934; 20190303962; 20190362392; 20190370583; 20190394052; 20200045127; 20200057997; 20200065821; 20200090279; 20200127908; 20200134616; 20200151774; 20200168311; 20200210904; 20200219191; 20200234380; 20200252681; 20200252743; 20200372514; 20200389542; 20200410487; 20210019816; 20210042549; 20210062474; 20210073823; 20210110383; 20210110393; 20210118012; 20210133160; 20210192530; 20210206285; 20210233047; 20210233108; 20210241274; 20210250812; 20210256550; 20210256864; 20210342894; 20210350399; 20210350453; 20210374784; 20210374787; 20210374813; 20210387350; 20220005031; 20220005069; 20220012762; 20220012799; 20220014390; 20220027936; 20220027937; 20220027938; 20220027939; 20220027940; 20220027971; 20220076287; 20220116343; 20220118618; 20220150570; 20220188879; 5602462; 5781202; 5781205; 5784077; 5796416; 5796418; 5801739; 5805178; 5808631; 5808639; 5812162; 5815178; 5815179; 5825385; 5838339; 5841449; 5850241; 5856836; 5859652; 5864351; 5870124; 5871656; 5880759; 5892524; 5892900; 5905517; 5909227; 5910987; 5914737; 5915019; 5916358; 5917912; 5920331; 5949876; 5982891; 5984446; 6012799; 6030072; 6035281; 6045710; 6126846; 6217155; 6237786; 6253193; 6363488; 6389402; 6427140; 6537772; 6631397; 6640304; 6714632; 6747755; 6834195; 6948070; 6968333; 6981024; 7027178; 7051212; 7069451; 7076652; 7095854; 7100199; 7120800; 7124302; 7133845; 7231418; 7289799; 7330816; 7383309; 7433868; 7533082; 7535402; 7720687; 7720733; 7752466; 7831823; 7844835; 7917371; 7917749; 7937314; 7958457; 7984509; 8006087; 8055913; 8060829; 8103665; 8112625; 8141165; 8181021; 8191157; 8191158; 8239889; 8271365; 8285638; 8291238; 8316449; 8402557; 8458038; 8464077; 8468050; 8473382; 8512143; 8533851; 8533854; 8543842; 8556723; 8566111; 8572411; 8577894; 8578408; 8639625; 8648850; 8677507; 8706639; 8707343; 8713603; 8727782; 8782069; 8843392; 8850471; 8868639; 8959595; 8965803; 8976947; 8977566; 8995963; 8997150; 9154826; 9202224; 9210217; 9268866; 9286616; 9324067; 9338233; 9426537; 9432377; 9483763; 9503510; 9530150; 9582829; 9596514; 9632984; 9635133; 9654506; 9734463; 9760871; 9832625; 9892400; 9911123; 9936030; AU-2006240230; AU-2006240230; AU-2010200995; AU-2010200995; AU-2011250794; AU-2011250794; AU-2012239975; AU-2012239975; AU-2014227941; AU-2014374825; AU-2015100708; AU-2015100708; AU-2015100709; AU-2015100709; AU-2015243183; AU-2015266650; AU-2015266650; AU-2015266693; AU-2015266693; AU-2016100367; AU-2016100367; AU-2016100383; AU-2016100383; AU-2017100070; AU-2017100070; AU-2017201064; AU-2017201064; AU-2017201068; AU-2018202559; AU-2018202559; AU-2018279788; AU-2018312629; AU-2018312629; AU-2019200360; AU-2019200360; AU-2019201101; AU-2019201101; AU-2019201101; AU-2019282536; AU-2019375854; AU-2020200685; AU-2020200685; AU-2020200795; AU-2020200795; AU-2020200849; AU-2020201306; AU-2020201306; AU-2020203899; AU-2020204256; AU-2020204256; AU-2020239783; AU-2020289822; AU-2020289822; AU-2022200068; AU-2022200900; AU-2022203027; AU-6437001; AU-711733; BR-112012008157; BR-P10721764; CA-2286845; CA-2418074; CA-2418075; CA-2605995; CA-2605995; CA-2641162; CA-2710431; CA-2713791; CA-2840083; CA-2863124; CA-2887596; CA-2887596; CA-2907182; CA-2939650; CA-3049394; CA-3073274; CA-3073275; CA-3101638; CA-3119025; CN-100391103; CN-101002224; CN-101253738; CN-101290540; CN-101290540; CN-101351783; CN-101351797; CN-101399732; CN-101473653; CN-101473653; CN-101542923; CN-101542923; CN-101542941; CN-101542941; CN-101553838; CN-101889442; CN-101896236; CN-101918935; CN-101918937; CN-101918943; CN-101996445; CN-102216941; CN-102227923; CN-102365878; CN-102428484; CN-102428656; CN-102428697; CN-102428703; CN-102779043; CN-102779043; CN-102812483; CN-102884779; CN-102893327; CN-102915004; CN-102917372; CN-102968441; CN-103020841; CN-103038652; CN-103155612; CN-103198407; CN-103220697; CN-103246948; CN-103297077; CN-103390973; CN-103401944; CN-103401945; CN-103491533; CN-103534682; CN-103546199; CN-103577982; CN-103668859; CN-103685395; CN-103714456; CN-103765861; CN-103858439; CN-103875017; CN-103903141; CN-103917985; CN-103917985; CN-103955847; CN-103996115; CN-103996252; CN-104025071; CN-104025557; CN-104040568; CN-104078072; CN-104090844; CN-104125358; CN-104125358; CN-104134244; CN-104134289; CN-104203357; CN-104205882; CN-104246806; CN-104272335; CN-104319777; CN-104321681; CN-104364811; CN-104378134; CN-104380373; CN-104380373; CN-104392361; CN-104484955; CN-104637159; CN-104639604; CN-104661151; CN-104700508; CN-104703581; CN-104794809; CN-104809611; CN-104823125; CN-104850984; CN-104967607; CN-104967607; CN-104994581; CN-104995541; CN-105050487; CN-105122288; CN-105122642; CN-105190667; CN-105224075; CN-105227952; CN-105227952; CN-105230116; CN-105321064; CN-105324784; CN-105359177; CN-105389866; CN-105427134; CN-105450634; CN-105488702; CN-105515949; CN-105518749; CN-105531948; CN-105590131; CN-105654282; CN-105654284; CN-105761062; CN-105793876; CN-105809430; CN-105809431; CN-105844462; CN-105872923; CN-105894405; CN-105993155; CN-106022899; CN-106104917; CN-106127564; CN-106128152; CN-106204185; CN-106228416; CN-106250381; CN-106251133; CN-106355391; CN-106416128; CN-106436157; CN-106464226; CN-106465112; CN-106469517; CN-106503996; CN-106504061; CN-106537378; CN-106559095; CN-106575230; CN-106600273; CN-106651338; CN-106656742; CN-106663257; CN-106663271; CN-106714124; CN-106779641; CN-106875105; CN-106886877; CN-106910117; CN-106911991; CN-106951507; CN-106970966; CN-106991311; CN-107004194; CN-107004196; CN-107005624; CN-107046668; CN-107067221; CN-107071674; CN-107103461; CN-107105477; CN-107133791; CN-107146077; CN-107147981; CN-107153799; CN-107169759; CN-107180212; CN-107180341; CN-107193365; CN-107209205; CN-107220794; CN-107230070; CN-107230072; CN-107251071; CN-107317834; CN-107342976; CN-107403310; CN-107408247; CN-107409131; CN-107423995; CN-107426663; CN-107430728; CN-107430732; CN-107430735; CN-107454538; CN-107464102; CN-107506877; CN-107527198; CN-107534934; CN-107578033; CN-107622411; CN-107633397; CN-107657476; CN-107798527; CN-107833069; CN-107836002; CN-107836002; CN-107847148; CN-107847786; CN-107847786; CN-107851262; CN-107862521; CN-107875629; CN-107924520; CN-107925698; CN-107944995; CN-107949883; CN-107958300; CN-108028076; CN-108039703; CN-108040495; CN-108053221; CN-108090760; CN-108133367; CN-108200523; CN-108292040; CN-108305055; CN-108390859; CN-108573374; CN-108596658; CN-108604340; CN-108665616; CN-108695856; CN-108711004; CN-108764734; CN-108769020; CN-108845805; CN-108882135; CN-108885744; CN-108961593; CN-109064256; CN-109102393; CN-109146572; CN-109165977; CN-109347299; CN-109508336; CN-109523398; CN-109559236; CN-109559237; CN-109562928; CN-109656935; CN-109660928; CN-109712005; CN-109727158; CN-109785086; CN-109905733; CN-109920150; CN-109993515; CN-109993620; CN-109996755; CN-110009508; CN-110073717; CN-110111483; CN-110223447; CN-110245005; CN-110304127; CN-110377433; CN-110383014; CN-110415097; CN-110472785; CN-110533473; CN-110896659; CN-111194278; CN-111225832; CN-111460107; CN-111476431; CN-111476431; CN-111832898; CN-111869187; CN-112182915; CN-112184477; CN-112445130; CN-113228600; CN-113919973; CN-113962720; CN-1152277; CN-1186740; CN-1187756; CN-1307305; CN-1313973; CN-1318196; CN-1320492; CN-1388940; CN-1395708; CN-1408144; CN-1418355; CN-1476575; CN-1612151; CN-1637758; CN-1650303; CN-1768351; CN-1811807; CN-1828651; CN-1904924; CN-204243758; CN-204515918; CN-205103924; CN-205608792; CN-216593363; DE-102019101790; DE-19529321; DE-202015004267; DE-202015004268; DE-202015009088; DE-202015009089; DE-20220617; DE-60131018; DK-179695; DK-179696; DK-180320; DK-180328; DK-201770712; DK-201770713; DK-201770714; DK-201770715; DK-201870855; DK-201870855; DK-201970127; EP-0765235; EP-0765237; EP-0765241; EP-0765568; EP-0771272; EP-0772525; EP-0861461; EP-0861461; EP-0861461; EP-0922248; EP-0976821; EP-0976821; EP-1045322; EP-1314116; EP-1314118; EP-1431864; EP-1431864; EP-1431864; EP-1515216; EP-1526472; EP-1531379; EP-1555591; EP-1563641; EP-1621960; EP-1643340; EP-1662418; EP-1710717; EP-1894152; EP-1914655; EP-1914655; EP-1920401; EP-1920410; EP-1923814; EP-2015214; EP-2085923; EP-2164015; EP-2225661; EP-2243327; EP-2442268; EP-2622431; EP-2622501; EP-2622501; EP-2622557; EP-2622557; EP-2622558; EP-2674902; EP-2695085; EP-2695085; EP-2823626; EP-2823626; EP-2939348; EP-3025297; EP-3090506; EP-3108426; EP-3108427; EP-3129937; EP-3154014; EP-3156958; EP-3176742; EP-3320501; EP-3385852; EP-3385852; EP-3392775; EP-3461291; EP-3482345; EP-3514729; EP-3525496; EP-3525496; EP-3528173; EP-3565745; EP-3598341; EP-3668752; EP-3668755; EP-3679729; EP-3745303; EP-3779780; EP-3783865; EP-3811562; EP-3877892; ES-2245371; ES-2350980; FR-2892547; FR-3029337; GB-2320720; GB-2372615; GB-2484892; IN-2005CN00815; IN-2010CN04208; IN-2010KN02407; IN-2010MN01703; IN-2013CN07681; IN-2013CN08847; IN-201617026466; IN-201717028496; IN-201747006007; IN-201817036875; IN-201847034713; IN-201917024374; IN-201947035584; IN-202018009906; IN-202047056017; JP-2001222497; JP-2001357312; JP-2002083205; JP-2002312664; JP-2003524240; JP-2003529821; JP-2004005558; JP-2004005601; JP-2004005614; JP-2004005625; JP-2004005629; JP-2004030600; JP-2004139550; JP-2004265358; JP-2006146504; JP-2007201547; JP-2008102855; JP-2008257186; JP-2009523376; JP-2010521018; JP-2012120197; JP-2012503261; JP-2013257784; JP-2014501049; JP-2015011190; JP-2015043637; JP-2015115768; JP-2017134403; JP-2017164188; JP-2017505961; JP-2017505961; JP-2020038455; JP-2020507500; JP-2021022160; JP-2021077962; JP-2021517673; JP-2022056136; JP-2022056137; JP-2022056138; JP-2022509040; JP-4692297; JP-4734342; JP-4764870; JP-5270781; JP-5337704; JP-5430797; JP-5660201; JP-6042337; JP-6086436; JP-6326656; JP-6565049; JP-6574950; JP-6977127; JP-7027450; JP-7034226; JP-7092699; JP-H09275530; JP-H10512074; JP-WO2012137882; JP-WO2012140871; JP-WO2012140872; KR-100379611; KR-100384692; KR-100467011; KR-100616805; KR-100624162; KR-100678569; KR-100807871; KR-100807872; KR-100807873; KR-100807876; KR-100807879; KR-100842859; KR-100852845; KR-101025312; KR-101050169; KR-101085880; KR-101103048; KR-101120127; KR-101165905; KR-101196187; KR-101200048; KR-101228965; KR-101264718; KR-101315861; KR-101432457; KR-101453343; KR-101503624; KR-101520298; KR-101539774; KR-101599249; KR-101602990; KR-101632093; KR-101646068; KR-101646300; KR-101646301; KR-101646810; KR-101653852; KR-101716873; KR-101733458; KR-101740068; KR-101771537; KR-101804595; KR-101813082; KR-101818012; KR-101818013; KR-101861503; KR-101891671; KR-101911215; KR-101911653; KR-102015634; KR-102048961; KR-102063107; KR-102094724; KR-102122115; KR-102137903; KR-102171388; KR-102184147; KR-102196001; KR-102198638; KR-102228105; KR-102234129; KR-102245602; KR-102253753; KR-102258278; KR-102276006; KR-102318642; KR-102323551; KR-102344688; KR-102411578; KR-20010007709; KR-20010082486; KR-20010090197; KR-20010094196; KR-20010097868; KR-20020010892; KR-20020024423; KR-20020029270; KR-20020059212; KR-20020094890; KR-20030024744; KR-20040001183; KR-20040082931; KR-20040091397; KR-20040093248; KR-20050022606; KR-20050098380; KR-20050098381; KR-20050111407; KR-20050111830; KR-20060006694; KR-20060080151; KR-20060080152; KR-20060080153; KR-20060080154; KR-20060080386; KR-20060086685; KR-20070038665; KR-20070106941; KR-20080109103; KR-20080111176; KR-20080114804; KR-20090016755; KR-20090070948; KR-20090070950; KR-20090070951; KR-20090076936; KR-20100033919; KR-20100077419; KR-20100114117; KR-20100114532; KR-20110026285; KR-20110108416; KR-20110110360; KR-20110110829; KR-20110110830; KR-20110110831; KR-20110110832; KR-20110110833; KR-20110110834; KR-20110110835; KR-20110112448; KR-20110113192; KR-20110113640; KR-20110116189; KR-20110116190; KR-20110117200; KR-20110121405; KR-20110124258; KR-20110124259; KR-20110124260; KR-20110124261; KR-20110126638; KR-20120029980; KR-20120108942; KR-20120115434; KR-20130006792; KR-20130012238; KR-20130012242; KR-20130055191; KR-20130060299; KR-20130062402; KR-20130084702; KR-20140000769; KR-20140013380; KR-20140053452; KR-20140072786; KR-20140078037; KR-20140112372; KR-20140135442; KR-20150005679; KR-20150005766; KR-20150087444; KR-20150093880; KR-20150099886; KR-20150102168; KR-20150129965; KR-20160035521; KR-20160080235; KR-20170008368; KR-20170030661; KR-20170038883; KR-20170052557; KR-20170133524; KR-20180016772; KR-20180054931; KR-20180116469; KR-20190000221; KR-20190017783; KR-20190027354; KR-20190054681; KR-20190081160; KR-20190081163; KR-20190082055; KR-20190082056; KR-20190120940; KR-20190129226; KR-20190130584; KR-20190134546; KR-20200002769; KR-20200042250; KR-20200049172; KR-20200061783; KR-20200091237; KR-20200114683; KR-20200124325; KR-20200125894; KR-20200129767; KR-20200137818; KR-20200139467; KR-20200145211; KR-20210009051; KR-20210012973; KR-20210020805; KR-20210022580; KR-20210073249; KR-20210088881; KR-20210101753; KR-20210129377; KR-20210131026; KR-20220018461; KR-20220018462; KR-20220018463; KR-20220018464; KR-20220032539; KR-20220052635; KR-20220073557; KR-20220073558; KR-20220073899; KR-20220073900; KR-20220089026; MX-PA06003104; RU-2468419; RU-2471235; RU-2562405; RU-2669522; TW-200841320; TW-200907844; TW-200907845; TW-200919210; TW-200926033; TW-201224811; TW-201227355; TW-201227531; TW-201415393; TW-201435780; TW-201610878; TW-201833827; TW-202207121; TW-202209222; TW-392403; TW-513651; TW-1385637; TW-1478081; TW-1582714; TW-1681345; TW-1736705; TW-M599430; WO-1996027155; WO-1996027155; WO-1996032267; WO-1996032278; WO-1996032279; WO-1996032282; WO-1996032284; WO-1996032284; WO-1996032285; WO-1996032808; WO-1997009387; WO-1997016497; WO-1997016498; WO-1998009209; WO-2001075676; WO-2001076120; WO-2002011020; WO-2002011021; WO-2004043008; WO-2006115908; WO-2006124803; WO-2007011738; WO-2007011752; WO-2007014358; WO-2007016384; WO-2007016438; WO-2007033326; WO-2007061892; WO-2007098292; WO-2008040024; WO-2008048311; WO-2008063607; WO-2008080276; WO-2008127337; WO-2009002676; WO-2009086235; WO-2009094633; WO-2009097186; WO-2009099916; WO-2009129514; WO-2009146327; WO-2010151379; WO-2011019444; WO-2011068912; WO-2011143251; WO-2012031262; WO-2012040950; WO-2012047659; WO-2012047662; WO-2012047666; WO-2012047668; WO-2012047671; WO-2012047672; WO-2012047673; WO-2012060552; WO-2012137882; WO-2012139072; WO-2012140871; WO-2012140872; WO-2012176999; WO-2013003797; WO-2013134753; WO-2013138203; WO-2013183053; WO-2014003226; WO-2014105162; WO-2014121396; WO-2014121397; WO-2014134603; WO-2014144006; WO-2014144269; WO-2014150277; WO-2015011705; WO-2015077872; WO-2015084031; WO-2015090393; WO-2015100496; WO-2015123543; WO-2015157716; WO-2015184353; WO-2015184389; WO-2016028938; WO-2016138606; WO-2017004866; WO-2017011169; WO-2017143965; WO-2017156047; WO-2018075293; WO-2018129343; WO-2018226265; WO-2019033129; WO-2019036058; WO-2019036059; WO-2019043246; WO-2019094153; WO-2019112631; WO-2019132516; WO-2019194388; WO-2019236482; WO-2020006001; WO-2020018589; WO-2020096752; WO-2020148849; WO-2020163514; WO-2020231001; WO-2021015665; WO-2021155614; WO-2021214760; WO-2021222669; WO-2021226374; WO-2021226375; WO-2021243153; WO-2021243154; WO-2021243159; WO-2021258071; WO-2022011289; WO-2022011293; WO-2022011296; WO-2022011299; WO-2022011300; WO-2022011301; WO-2022011302; WO-2022011304; WO-2022039796; WO-2022070453; WO-2022119767.
“INSNA Connections Journal”. Connections Bulletin of the International Network for Social Network Analysis. Toronto: International Network for Social Network Analysis. ISSN 0226-1766.
Abidin, C. (2016). “Aren't these just young, rich women doing vain things online?”: Influencer selfies as subversive frivolity. Social Media+Society, 2(2), 2056305116641342.
AdAge.com. (2017). Heineken's “socialexperiment” racks up views. adage.com/article/the-viral-video-chart/viral-video-chart-5-1-17/308885/
Afshar, S., M. Behnam, R. J. Bril, and T. Nolte, “Resource sharing in a hybrid partitioned/global scheduling framework for multiprocessors,” in Proc. IEEE 20th Conf. Emerg. Technol. Factory Automat., September 2015, pp. 1-10.
Ahrens, J., Coyle, J. R., & Strahilevitz, M. A. (2013). Electronic word of mouth: The effects of incentives on e-referrals by senders and receivers. European Journal of Marketing, 47(7), 1034-1051.
Akimova, T., M. H. Levine, U. H. Beier, and W. W. Hancock, “Standardization, evaluation, and area-under-curve analysis of human and murine treg suppressive function,” in Suppression and Regulation of Immune Responses. New York, NY, USA: Springer, 2016, pp. 43-78.
Alhabash, S., & McAlister, A. R. (2015). Redefining virality in less broad strokes: Predicting viral behavioral intentions from motivations and uses of Facebook and Twitter. New Media & Society, 17, 1317-1339.
Alhabash, S., McAlister, A. R., Hagerstrom, A., Quilliam, E. T., Rifon, N. J., & Richards, J. 1. (2013). Between likes and shares: Effects of emotional appeal and virality on the persuasiveness of anticyberbullying messages on Facebook. Cyberpsychology, Behavior, and Social Networking, 16, 175-182.
Alhabash, Saleem, Jong-hwan Baek, Carie Cunningham, and Amy Hagerstrom. “To comment or not to comment?: How virality, arousal level, and commenting behavior on YouTube videos affect civic behavioral intentions.” Computers in human behavior 51 (2015): 520-531.
Ali, M.; J. Nelson, R. Shea, and M. J. Freedman. Blockstack: A global naming and storage system secured by blockchains. In 2016 USENIX Annual Technical Conference (USENIX ATC 16), 2016.
Ali, R., J. Barrdear, R. Clews, and J. Southgate, The Economics of Digital Currencies. New York, NY, USA: Social Science Electronic Publishing, 2014, pp. 276-286.
Amichai-Hamburger, Yair; Hayat, Tsahi (2017). The International Encyclopedia of Media Effects. John Wiley & Sons, Inc. doi:10.1002/9781118783764.wbieme0170. ISBN 9781118783764.
Anand, Bharat N., and Ron Shachar. “Targeted advertising as a signal.” QME 7, no. 3 (2009): 237-266.
Anderson, Brian A. “Reward processing in the value-driven attention network: reward signals tracking cue identity and location.” Social Cognitive and Affective Neuroscience 12, no. 3 (2017): 461-467.
Androulaki E, Barger A, Bortnikov V, Cachin C, Christidis K, De Caro A, Enyeart D, Ferris C, Laventman G, Manevich Y, Muralidharan S, Murthy C, Nguyen B, Sethi M, Singh G, Smith K, Sorniotti A, Stathakopoulou C, Vukolic'M, Cocco S W, Yellick J (2018) Hyperledger fabric: a distributed operating system for permissioned blockchains. In: Proceedings of the thirteenth EuroSys conference, EuroSys '18. ACM, New York, pp 30:1-30:15. doi.org/10.1145/3190508.3190538/. doi.acm. org/10.1145/3190508.3190538
Andrychowicz M, Dziembowski S, Malinowski D, Mazurek L (2014) Modeling bitcoin contracts by timed automata. In: Legay A, Bozga M (eds) Formal modeling and analysis of timed systems. Springer International Publishing, Cham, pp 7-22
Andrychowicz, M.; S. Dziembowski, D. Malinowski, and L. Mazurek. Secure multiparty computations on bitcoin. In 2014 IEEE Symposium on Security and Privacy, pages 443-458. IEEE, 2014.
Aneja, Nagender; Gambhir, Sapna (August 2013). “Ad-hoc Social Network: A Comprehensive Survey”; International Journal of Scientific & Engineering Research. 4 (8): 156-160. ISSN 2229-5518.
Anheier, H. K.; Romo, F. P. (1995). “Forms of capital and social structure of fields: examining Bourdieu's social topography”. American Journal of Sociology. 100 (4): 859-903. doi:10.1086/230603. S2CID 143587142.
Anthony, S., P. S. Constance, and M. Joshua, “Crypto currencies: Core information technology and information system fundamentals enabling currency without borders,” Inf. Syst. Edu. J., vol. 13, no. 3, pp. 43-52, May 2015.
Antoniadis, I., S. Kontsas, and K. Spinthiropoulos. “Blockchain applications in marketing.” The Proceedings of 7th ICCMI (2019).
Antonopoulos, Andreas M., and Gavin Wood. Mastering ethereum: building smart contracts and dapps. O'reilly Media, 2018.
Araujo, T., Neijens, P., & Vliegenthart, R. (2017). Getting the word out on Twitter: The role of influentials, information brokers and strong ties in building word-of-mouth for brands. International Journal of Advertising, 36, 496-513.
Arbatskaya, Maria, and Hideo Konishi. “A theory of consumer referral: Revisited.” SSRN 2345288 (2013).
Ariely, D., Bracha, A., & Meier, S. (2009). Doing good or doing well? Image motivation and monetary incentives in behaving prosocially. American Economic Review, 99(1), 544-555.
Aste, T., Tasca, P., Matteo, T. D.: Blockchain technologies: the foreseeable impact on society and industry. Computer 50(9), 18-28 (2017). doi.org/10.1109/MC.2017.3571064
Audrezet, A., De Kerviler, G., & Moulard, J. G. (2018). Authenticity under threat: When social media influencers need to go beyond self-presentation. Journal of Business Research. Advance online publication. doi:10.1016/j.jbusres.2018.07.008
Bach L, Mihaljevic B, Zagar M (2018) Comparative analysis of blockchain consensus algorithms. In: 2018 41st International convention on information and communication technology, electronics and microelectronics (MIPRO). IEEE, pp 1545-1550
Back, Adam. “Hashcash-a denial of service counter-measure.” (2002).
Bakshy, E., Hofman, J. M., Mason, W. A., & Watts, D. J. (2011, February 9-12). Everyone's an influencer: Quantifying influence on Twitter. In Proceedings of the fourth ACM international conference on web search and data mining (pp. 65-74). New York, NY: ACM.
Bakshy, E., Karrer, B., & Adamic, L. (2006). Patterns of influence in a recommendation network. In Proceedings of the 10th Pacific-Asia conference on Advances in Knowledge Discovery and Data Mining (pp. 380-389).
Baños, R. A., Borge-Holthoefer, J., & Moreno, Y. (2013). The role of hidden influentials in the diffusion of online information cascades. EPJ Data Science, 2, 6.
Bansal, Harvir S., & Voyer, Peter A. (2000). Word-of-mouth processes within a services purchase decision context. Journal of Service Research, 3(2), 166-177.
Bao, T., & Chang, T. (2014). Finding disseminators via electronic word of mouth message for effective marketing communications. Decision Support Systems, 67, 21-29.
Barabási, Albert-László (2003). Linked: how everything is connected to everything else and what it means for business, science, and everyday life. New York: Plum. ISBN 978-0-452-28439-5.
Barnes, John (1954). “Class and Committees in a Norwegian Island Parish”. Human Relations, (7): 39-58.
Barnett, George A. (2011). Encyclopedia of Social Networks. Sage. ISBN 978-1-4129-7911-5.
Bartoletti, Massimo, and Livio Pompianu. “An empirical analysis of smart contracts: platforms, applications, and design patterns.” In International conference on financial cryptography and data security, pp. 494-509. Springer, Cham, 2017.
Batson, C. Daniel, Sager, Karen, Garst, Eric, Kang, Misook, Rubchinsky, Kostia, & Dawson, Karen. (1997). Is empathy-induced helping due to self-other merging? Journal of Personality and Social Psychology, 73(3), 495-509.
Beck R (2018) Beyond bitcoin: the rise of blockchain world. Computer 51(2):54-58. doi.org/10.1109/MC.2018.1451660
Beck, T. H., J. C. Davenport. The Attention Economy: Understanding the New Currency of Business. Harvard Business School Press, 2001. isbn: 978-1578514410.
Bénabou, R., & Tirole, J. (2003). Intrinsic and extrinsic motivation. Review of Economic Studies, 70(244), 489-520.
Ben-Sasson, Eli, Iddo Bentov, Alessandro Chiesa, Ariel Gabizon, Daniel Genkin, Matan Hamilis, Evgenya Pergament et al. “Computational integrity with a public random string from quasi-linear PCPs.” In Annual International Conference on the Theory and Applications of Cryptographic Techniques, pp. 551-579. Springer, Cham, 2017.
Bentov I., and R. Kumaresan. How to use bitcoin to design fair protocols. In International Cryptology Conference, pages 421-439. Springer, 2014.
Bentov, I., Lee, C., Mizrahi, A., Rosenfeld, M.: Proof of activity: extending Bitcoin's proof of work via proof of stake. SIGMETRICS Perform. Eval. Rev. 42(3), 34-37 (2014). doi.org/10.1145/2695533.2695545 Berman, B. (2016). Referral marketing: Harnessing the power of your customers. Business Horizons, 59, 19-28.
Berndt, D. J. and J. Clifford, “Using dynamic time warping to find patterns in time series,” in Proc. KDD Workshop, Seattle, WA, USA, vol. 10, 1994, pp. 359-370.
Bernie Hogan. “The Networked Individual: A Profile of Barry Wellman”.
Bettencourt, L. A., Brown, S. W., & Mackenzie, S. B. (2005). Customer-oriented boundary-spanning behaviors: Test of a social exchange model of antecedents. Journal of Retailing, 81(2), 141-157.
Bing, L., W. Lam, T.-L. Wong, and S. Jameel, “Web query reformulation via joint modeling of latent topic dependency and term context,” ACM Trans. Inf. Syst., vol. 33, no. 2, pp. 1-38, February 2015.
Biswas, K., and V. Muthukkumarasamy, “Securing smart cities using blockchain technology,” in Proc. IEEE 18th Int. Conf. High Perform. Comput. Commun., IEEE 14th Int. Conf. Smart City, IEEE 2nd Int. Conf. Data Sci. Syst. (HPCC/SmartCity/DSS), December 2016, pp. 1392-1393.
Biyalogorsky, Eyal, Eitan Gerstner, and Barak Libai. “Customer referral management: Optimal reward programs.” Marketing Science 20, no. 1 (2001): 82-95.
Blackston, M. (1992). Observations: Building brand equity by managing the brand's relationships. Journal of Advertising Research, 32(3), 79-83.
Blau, Peter (1956). Bureaucracy in Modern Society. New York: Random House, Inc.
Blau, Peter (1960). “A Theory of Social Integration”. The American Journal of Sociology, (65)6: 545-556, (May).
Blau, Peter (1964). Exchange and Power in Social Life.
Boland, Margaret. Cyber criminals are stealing billions from the ad industry each year. 2016. www.businessinsider. com/the-ad-fraud-report-bot-traffic-2016-3.
Bolt, Wilko, and Maarten van Oordt. On the Value of Virtual Currencies. Tech. rep. Working Paper No. 2016-42. Bank of Canada, April 2016.
Borgatti, Stephen P.; Mehra, Ajay; Brass, Daniel J.; Labianca, Giuseppe (2009). “Network Analysis in the Social Sciences”. Science. 323 (5916): 892-895. Bibcode:2009Sci . . . 323..892B. CiteSeerX 10.1.1.536.5568. doi:10.1126/science.1165821. PMID 19213908. S2CID 522293.
Boukis, Achilleas. “Exploring the implications of blockchain technology for brand-consumer relationships: a future research agenda.” Journal of Product & Brand Management (2019).
Bowler, W. M.; Brass, D. J. (2011). “Relational correlates of interpersonal citizenship behaviour: A social network perspective”. Journal of Applied Psychology. 91 (1): 70-82. CiteSeerX 10.1.1.516.8746. doi:10.1037/0021-9010.91.1.70. PMID 16435939.
Bowles, S., & Gintis, H. (1998). The moral economy of communities: Structured populations and the evolution of pro-social norms. Evolution & Human Behavior, 19(1), 3-25.
Braden, L. E. A. (2021-01-01). “Networks Created Within Exhibition: The Curators' Effect on Historical Recognition”. American Behavioral Scientist. 65 (1): 25-43. doi:10.1177/0002764218800145. ISSN 0002-7642.
Braden, L. E. A.; Teekens, Thomas (September 2019). “Reputation, Status Networks, and the Art Market”. Arts. 8 (3): 81. doi:10.3390/arts8030081.
Braden, L. E. A.; Teekens, Thomas (2020-08-01). “Historic networks and commemoration: Connections created through museum exhibitions”. Poetics. 81: 101446. doi:10.1016/j.poetic.2020.101446. ISSN 0304-422X.
Brahim, Nada Ben Elhadj-Ben, Rim Lahmandi-Ayed, and Didier Laussel. “Is targeted advertising always beneficial?.” International Journal of Industrial Organization 29, no. 6 (2011): 678-689.
Brauer, Jimmy, and Bjorn Linnala Eriksson. “Blockchain's influence on digital marketing: An exploratory study examining blockchain in relation to big data and digital marketing.” (2020).
Brown R G, Carlyle J, Grigg I, Hearn M (2016) Corda: an introduction. R3 CEV. August 1, 15
Brown, D. & Hayes, N. (2008). Influencer Marketing: Who Really Influences Your Customers? Taylor & Francis.
Brown, M. R., Bhadury, R. K., & Pope, N. K. L. (2010). The impact of comedic violence on viral advertising effectiveness. Journal of Advertising, 39, 49-66.
Budak, C., Goel, S., Rao, J., Zervas, G.: Understanding emerging threats to online advertising. In: Proceedings of the 2016 ACM Conference on Economics and Computation, E C 2016, pp. 561-578. ACM, New York (2016). doi.org/10.1145/2940716.2940787
Burt, R. S. (1992). Shucturalholes: The social structure of competition. Cambridge, MA: Harvard University Press.
Burt, R. S. (2001). Social capital: Theory and research (N. L. Karen, S. Cook, & R. S. Burt, Eds.). New York, NY: Aldine de Gruyter.
Burt, R. S. (2005). Brokerage and closure: An introduction to social capital. Oxford, UK: Oxford University Press.
Burt, Ronald (2004). “Structural Holes and Good Ideas”. American Journal of Sociology. 110 (2): 349-399. CiteSeerX 10.1.1.388.2251. doi:10.1086/421787. S2CID 2152743.
Buterin, V., A next-generation smart contract and decentralized application platform. white paper, 2014.
Buyya, R., C. S. Yeo, S. Venugopal, J. Broberg, and I. Brandic. Cloud computing and emerging it platforms: Vision, hype, and reality for delivering computing as the 5th utility. Future Generation computer systems, 25(6):599-616, 2009.
Cachin, C., Architecture of the hyperledger blockchain fabric. 2016.
Callen, J., V. Aivazian. “The Coase Theorem and the Empty Core”. In: Journal of Law and Economics 24 (1 1981), pp. 175-181.
Carlin, Domhnall, Jonah Burgess, Philip O'Kane, and Sakir Sezer. “You could be mine (d): the rise of cryptojacking.” IEEE Security & Privacy 18, no. 2 (2019): 16-22.
Caro M P, Ali M S, Vecchio M, Giaffreda R (2018) Blockchain-based traceability in agri-food supply chain management: a practical implementation. In: 2018 IoT vertical and topical summit on agriculture-Tuscany (IOT Tuscany), pp 1-4. doi.org/10.1109/IOT-Tuscany.2018.8373021
Carrington, Peter J.; Scott, John (2011). “Introduction”. The Sage Handbook of Social Network Analysis. Sage. p. 1. ISBN 978-1-84787-395-8.
Castro, M., Liskov, B.: Practical byzantine fault tolerance. In: Proceedings of the Third Symposium on Operating Systems Design and Implementation, OSDI 1999, pp. 173-186. USENIX Association, Berkeley (1999). dl.acm.org/citation. cfm?id=296806.296824
Cha, M., Haddadi, H., Benevenuto, F., & Gummadi, K. P. (2010). Measuring user influence in Twitter: The million follower fallacy. Paper presented at Proceedings of the fourth international AAAI Conference on Weblogs and Social Media. Retrieved from twitter.mpi-sws.org/icwsm2010_fallacy.pdf
Cha, M., Mislove, A., & Gummadi, K. (2009). A measurement-driven analysis of information propagation in the flickr social network. In Proceedings of the 18th International Conference on World Wide Web (pp. 721-730).
Chang, F.; J. Dean, S. Ghemawat, W. C. Hsieh, D. A. Wallach, M. Burrows, T. Chandra, A. Fikes, and R. E. Gruber. Bigtable: A distributed storage system for structured data. ACM Transactions on Computer Systems (TOCS), 26(2):4, 2008.
Chapelle, O., “Offline evaluation of response prediction in online advertising auctions,” in Proc. 24th Int. Conf. World Wide Web, May 2015, pp. 919-922.
Chaum, D., A. Fiat, and M. Naor. Untraceable electronic cash. In Proceedings on Advances in cryptology, pages 319-327. Springer-Verlag New York, Inc., 1990.
Chen, C.-M., B. Xiang, Y. Liu, and K.-H. Wang, “A secure authentication protocol for Internet of vehicles,” IEEE Access, vol. 7, pp. 12047-12057, 2019.
Chen, Q., Y. Feng, L. Liu, and X. Tian, “Understanding consumers' reactance of online personalized advertising: A new scheme of rational choice from a perspective of negative effects,” Int. J. Inf. Manage., vol. 44, pp. 53-64, February 2019.
Chen, W., Wang, C., & Y. Wang (2010). Scalable influence maximization for prevalent viral marketing in large-scale social networks. In Proceedings of the 16th ACM SIGKDD international conference on Knowledge discovery and data mining (pp. 1029-1038).
Chen, W., Wang, Y., & Yang, S. (2009). Efficient influence maximization in social networks. In Proceedings of the 15th ACM SIGKDD international conference on Knowledge discovery and data mining (pp. 199-208).
Chen, W., Yuan, Y., & Zhang, L. (2010). Scalable influence maximization in social networks under the linear threshold model. In IEEE International Conference on Data Mining (pp. 88-97).
Cheng, H.-T., L. Koc, J. Harmsen, T. Shaked, T. Chandra, H. Aradhye, G. Anderson, G. Corrado, W. Chai, M. Ispir, R. Anil, Z. Haque, L. Hong, V. Jain, X. Liu, and H. Shah, “Wide & deep learning for recommender systems,” in Proc. 1st Workshop Deep Learn. Recommender Syst., 2016, pp. 7-10.
Chiu, H. Y., Chen, C. C., Joung, Y. J., & Chen, S. (2014). A study of blog networks to determine online social network properties from the tie strength perspective. Online Information Review, 38(3), 381-398.
Cho, K., B. van Merrienboer, C. Gulcehre, D. Bahdanau, F. Bougares, H. Schwenk, and Y. Bengio, “Learning phrase representations using RNN encoder-decoder for statistical machine translation,” 2014, arXiv:1406.1078. [Online]. Available: arxiv.org/abs/1406.1078
Cho, S., Huh, J., & Faber, R. J. (2014). The influence of sender trust and advertiser trust on multistage effects of viral advertising. Journal of Advertising, 43, 100-114.
Chohan, Usman W. “A history of bitcoin.” Available at SSRN 3047875 (2017).
Choi, H., C. F. Mela, S. R. Balseiro, and A. Leary, “Online display advertising markets: A literature review and future directions,” Inf. Syst. Res., vol. 31, no. 2, pp. 556-575, June 2020.
Christakis, N., & Fowler, J. (2013). Social contagion theory: examining dynamic social networks and human behaviour. Statistics in Medicine, 32, 556-577.
Christidis, K., and M. Devetsikiotis, “Blockchains and smart contracts for the Internet of Things,” IEEE Access, vol. 4, pp. 2292-2303, 2016.
Chu, S. C. (2011). Viral advertising in social media: Participation in Facebook groups and responses among college-aged users. Journal of Interactive Advertising, 12, 30-43.
Chuen, D. L. K.: Handbook of Digital Currency: Bitcoin, Innovation, Financial Instruments, and Big Data. Academic Press, Cambridge (2015)
Cieplak, Jenny, and Simon Leefatt. “Smart contracts: A smart way to automate performance.” Geo. L. Tech. Rev. 1 (2016): 417.
Clark, M. S., & Mills, J. (1979). Interpersonal attraction in exchange and communal relationships. Journal of Personality and Social Psychology, 37(1), 12-24.
Clark, M. S., & Mils, J. (1993). The difference between communal and exchange relationships: What it is and is not. Personality and Social Psychology Bulletin, 19(6), 684-691.
Clark, M. S., Mills, J., & Powell, M. C. (1986). Keeping track of needs in communal and exchange relationships. Journal of Personality and Social Psychology, 51(2), 333.
Collibus, Francesco Maria De, Alberto Partida, and Matija Piškorec. “The Role of Smart Contracts in the Transaction Networks of Four Key DeFi-Collateral Ethereum-Based Tokens.” In International Conference on Complex Networks and Their Applications, pp. 792-804. Springer, Cham, 2021.
Conte, R., Gilbert, N., Bonelli, G., Cioffi-Revilla, C., Deffuant, G., Kertesz, K., Loreto, V., Moat, S., Nadal, J.-P., Sanchez, A., Nowak, A., Flache, A., San Miguel, M., & Helbing, D. (2012). Manifesto of computational social science. The European Physical Journal, 214, 325-346.
Coussement, K., Benoit, D. F., & Antioco, M. (2015). A bayesian approach for incorporating expert opinions into decision support systems: a case study of online consumer-satisfaction detection. Decision Support Systems, 79, 24-32.
Covington, P., J. Adams, and E. Sargin, “Deep neural networks for YouTube recommendations,” in Proc. 10th ACM Conf. Recommender Syst., September 2016, pp. 191-198.
Cranmer, Skyler J.; Desmarais, Bruce A. (2011). “Inferential Network Analysis with Exponential Random Graph Models”. Political Analysis. 19 (1): 66-86. CiteSeerX 10.1.1.623.751. doi:10.1093/pan/mpq037.
Crona, Beatrice and Klaus Hubacek (eds.) (2010). “Special Issue: Social network analysis in natural resource governance”. Ecology and Society, 48.
Cui, Weirong, Chenglie Du, and Jinchao Chen. “CP-ABE based privacy-preserving user profile matching in mobile social networks.” PloS one 11, no. 6 (2016): e0157933.
Dahl, D. W., Honea, H., & Manchanda, R. V. (2005). Three Rs of interpersonal consumer guilt: Relationship, reciprocity, reparation. Journal of Consumer Psychology, 15(4), 307-315.
Dai, Wei, and Apostolos Serletis. “On the Markov switching welfare cost of inflation.” Journal of Economic Dynamics and Control 108 (2019): 103748.
Dai, Wei. “B-money.” Consulted 1, no. 2012 (1998): 412.
Daniel, E. S., Crawford, J. E. C., & Westerman, D. K. (2018). The influence of social media influencers: Understanding online vaping communities and parasocial interaction through the lens of Taylor's six-segment strategy wheel. Journal of Interactive Advertising, 18, 96-109.
Dasgupta, K., Singh, R., Viswanathan, B., Chakraborty, D., Mukherjea, S., Nanavati, A. A., & Joshi, A. (2008). Social ties and their relevance to churn in mobile telecom networks. In Proceedings of the 11th international conference on Extending database technology: Advances in database technology (pp. 668-677).
De Filippi, Primavera, Chris Wray, and Giovanni Sileno. “Smart contracts.” Internet Policy Review 10, no. 2 (2021).
De Nooy, W (2003). “Fields and networks: Correspondence analysis and social network analysis in the framework of Field Theory”. Poetics. 31 (5-6): 305-327. doi:10.1016/S0304-422X(03)00035-4.
de Nooy, Wouter (2012). “Social Network Analysis, Graph Theoretical Approaches to”. “Graph Theoretical Approaches to Social Network Analysis”. in Computational Complexity: Theory, Techniques, and Applications (RobertA. Meyers, ed.). Springer. pp. 2864-2877. doi:10.1007/978-1-4614-1800-9_176. ISBN 978-1-4614-1800-9.
De Veirman, M., Cauberghe, V., & Hudders, L. (2017). Marketing through Instagram influencers: The impact of number of followers and product divergence on brand attitude. International Journal of Advertising, 36, 798-828.
DeFigueiredo, Dimitri. Github discussion of concave score. May 2016.
github.com/brave/ledger/issues/2 #issuecomment-221752002.
Dennis R., and G. Owen, “Rep on the block: A next generation reputation system based on the blockchain,” in Proc. 10th Int. Conf. Internet Technol. Secured Trans., December 2015, pp. 131-138.
Dennis, R., Disso, J. P.: An analysis into the scalability of Bitcoin and ethereum. In: Yang, X.-S., Sherratt, S., Dey, N., Joshi, A. (eds.) Third International Congress on Information and Communication Technology. AISC, vol. 797, pp. 619-627. Springer, Singapore (2019). doi.org/10.1007/978-981-13-1165-9 57
Deshpande, Nishad, Shabib Ahmed, and Alok Khode. “Web based targeted advertising: A study based on patent information.” Procedia Economics and Finance 11 (2014): 522-535.
Devanbu, P.; M. Gertz, C. Martel, and S. G. Stubblebine. Authentic third-party data publication. In Data and Application Security, pages 101-112. Springer, 2002.
Dhillon, V., Metcalf, D., Hooper, M.: Recent developments in blockchain. Blockchain Enabled Applications, pp. 151-181. Apress, Berkeley (2017). doi.org/10.1007/978-1-4842-3081-7 11
Dhumwad, S., Sukhadeve, M., Naik, C., Manjunath, K. N., Prabhu, S.: A peer to peer money transfer using SHA256 and Merkle tree. In: Annual International Conference on Advanced Computing and Communications (2017). eprints. manipal.edu/id/eprint/150090
Digital Content Next Research Team. DCNs Distributed Content Revenue Bench-mark Report. Tech. rep. Digital Content Next, January 2017. digitalcontentnext.
org/blog/2017/01/25/dcnsdistributedcontentrevenuebenchmark-report/.
Ding, Yong, Decun Luo, Hengkui Xiang, Chenjun Tang, Lingang Liu, Xiuqing Zou, Shijie Li, and Yujue Wang. “A blockchain-based digital advertising media promotion system.” In International Conference on Security and Privacy in New Computing Environments, pp. 472-484. Springer, Cham, 2019.
Ding, Yong, Decun Luo, Hengkui Xiang, Wenyao Liu, and Yujue Wang. “Design and implementation of blockchain-based digital advertising media promotion system.” Peer-to-Peer Networking and Applications 14, no. 2 (2021): 482-496.
Domingos, P., & Richardson, M. (2001). Mining the network value of customers. In Proceedings of the 7th ACM SIGKDD Conference on Knowledge Discovery and Data Mining (pp. 57-66).
Donet, J. A. D., C. Perez-Sola, and J. Herrera-Joancomarti, “The bitcoin P2P network,” in Proc. Int. Conf. Financial Cryptogr. Data Secur. Berlin, Germany: Springer, 2014, pp. 87-102.
Du, Hongyang, Dusit Niyato, Jiawen Kang, Dong In Kim, and Chunyan Miao. “Optimal Targeted Advertising Strategy For Secure Wireless Edge Metaverse.” arXiv preprint arXiv:2111.00511 (2021).
Duda, Miroslav. “The Profitability of Standard Trading Strategies in Cryptocurrency Markets.” (2019).
Durkheim, Emile (1893). De la division du travail social: étude sur I'organisation des societes superieures, Paris: F. Alcan. (Translated, 1964, by Lewis A. Coser as The Division of Labor in Society, New York: Free Press.)
Easley, David; Kleinberg, Jon (2010). “Overview”. Networks, Crowds, and Markets: Reasoning about a Highly Connected World. Cambridge University Press. pp. 1-20. ISBN 978-0-521-19533-1.
Eckler, P., & Bolls, P. (2011). Spreading the virus: Emotional tone of viral advertising and its effect on forwarding intentions and attitudes. Journal of Interactive Advertising, 11(2), 1-11.
Elster, J. (2003). Coleman on social norms. Revue Frangaise De Sociologie, 44(2), 297-304.
eMarketer. US Ad Blocking to Jump by Double Digits This Year. [Online; accessed 22 Jan. 2017]. Jun. 2016. www.emarketer.com/Article/USAd-Blocking-Jump-by-Double-Digits-This-Year/1014111. en.wikipedia.org/wiki/Social_network
EOS.IO: Technical white paper. Technical report (2017). github.com/
EOSIO/Documentation/blob/master/TechnicalWhitePaper.md
Ernstson, Henrich (2010). “Reading list: Using social network analysis (SNA) in social-ecological studies”. Resilience Science
Escalas, J. E., & Bettman, J. R. (2003). You are what they eat: The influence of reference groups on consumers' connections to brands. Journal of Consumer Psychology, 13(3), 339-348.
Estrada, E (2011). The Structure of Complex Networks: Theory and Applications. Oxford University Press. ISBN 978-0-199-59175-6.
www.sciencedirect.com/science/article/pii/S0140366416307083
Estrada-Jimenez J, Parra-Arnau J, Rodnguez-Hoyos A, Forne J (2017) Online advertising: analysis of privacy threats and protection approaches. Comput Commun 100(1):32-51.
www.sciencedirect.com/science/article/pii/S0140366416307083 doi.org/10.1016/j.comcom.2016.12.016
“Ethereum Whitepaper.” Ethereum. ethereum. org
Evans, N. J., Phua, J., Lim, J., & Jun, H. (2017). Disclosing Instagram influencer advertising: The effects of disclosure language on advertising recognition, attitudes, and behavioral intent. Journal of Interactive Advertising, 17, 138-149.
Fan, Xiaomeng, Fengyan Cindy Cai, and Galen V. Bodenhausen. “The boomerang effect of zero pricing: when and why a zero price is less effective than a low price for enhancing consumer demand.” Journal of the Academy of Marketing Science 50, no. 3 (2022): 521-537.
Farahat, Ayman, and Michael C. Bailey. “How effective is targeted advertising?.” In Proceedings of the 21st international conference on World Wide Web, pp. 111-120. 2012.
Faust, Stanley Wasserman; Katherine (1998). Social network analysis: methods and applications (Reprint. ed.). Cambridge [u.a.]: Cambridge Univ. Press. ISBN 978-0521382694.
Feng X, Ma J, Miao Y, Meng Q, Liu X, Jiang Q, Li H (2019) Pruneable sharding-based blockchain protocol. Peer-to-Peer Netw Appl 12(4):934-950. doi.org/10.1007/s12083-018-0685-6
Feng, Y., F. Lv, B. Hu, F. Sun, K. Kuang, Y. Liu, Q. Liu, and W. Ou, “MTBRN: Multiplex target-behavior relation enhanced network for clickthrough rate prediction,” in Proc. 29th ACM Int. Conf. Inf. Knowl. Manage., October 2020, pp. 2421-2428.
Ferguson, Niall (2018). The Square and the Tower: Networks and Power, from the Freemasons to Facebook. Penguin Press. ISBN 978-0735222915.
Finney, Hal, “Detecting Double Spending” (Oct. 15,1993).
Fiske, A. P., & Tetlock, P. E. (1997). Taboo trade-offs: Reactions to transactions that transgress the spheres of justice. Political Psychology, 18(2), 255-297.
Forehand, M. R., Deshpande, R., & Reed Ii, A. (2002). Identity salience and the influence of differential activation of the social self-schema on advertising response. Journal of Applied Psychology, 87(6), 1086-1099.
Freberg, K., Graham, K., McGaughey, K., & Freberg, L. A. (2011). Who are the social media influencers? A study of public perceptions of personality. Public Relations Review, 37, 90-92.
Freeman, Linton C. (2004). The Development of Social Network Analysis: A Study in the Sociology of Science. Empirical Press. ISBN 978-1-59457-714-7.
Freeman, Linton C.; Wellman, Barry (1995). “A note on the ancestral Toronto home of social network analysis”. Connections. 18 (2): 15-19.
Freni, Pierluigi, Enrico Ferro, and G. Ceci. “Fixing social media with the blockchain.” In Proceedings of the 6th EAI international conference on smart objects and technologies for social good, pp. 175-180. 2020.
Frenzen, J. K., & Davis, H. L. (1990). Purchasing behavior in embedded markets. Journal of Consumer Research, 17(1), 1-12.
Freund, D. A.: Economic incentives and blockchain security. J. Secur. Oper. Custody 10(1), 67-76 (2018)
Fu, Dongqi, and Liri Fang. “Blockchain-based trusted computing in social network.” In 2016 2nd IEEE international conference on computer and communications (ICCC), pp. 19-22. IEEE, 2016.
Gai, K., “Deep interest network for click-through rate prediction,” in Proc. 24th ACM SIGKDD Int. Conf. Knowl. Discovery Data Mining, July 2018, pp. 1059-1068.
Gai, K., X. Zhu, H. Li, K. Liu, and Z. Wang, “Learning piece-wise linear models from large scale data for ad click prediction,” 2017, arXiv:1704.05194. arxiv.org/abs/1704.05194
Gan, M. and K. Xiao, “R-RNN: Extracting user recent behavior sequence for click-through rate prediction,” IEEE Access, vol. 7, pp. 111767-111777,2019.
Gans, J., “A zero price can be special”, (2010) voxeu.org/article/zero-price-can-be-special
Gans, Joshua S. “Mobile application pricing.” Information Economics and Policy 24, no. 1 (2012): 52-59.
Gans, Joshua S. “The specialness of zero.” The Journal of Law and Economics 65, no. 1 (2022): 157-176.
Gardner, Heidi; Eccles, Robert (2011). “Eden McCallum: A Network Based Consulting Firm”. Harvard Business School Review.
Garewal, Karan Singh. “The Cryptocurrency Ecosystem.” In Practical Blockchains and Cryptocurrencies, pp. 19-27. Apress, Berkeley, C A, 2020.
Garnefeld, I., Eggert, A., Helm, S., & Tax, S. (2013). Growing existing customers' revenue streams through customer referral programs. Management Science, 77, 17-32.
Garton, Laura; Haythornthwaite, Caroline; Wellman, Barry (23 Jun. 2006). “Studying Online Social Networks”. Journal of Computer-Mediated Communication. 3 (1): 0. doi:10.1111/j.1083-6101.1997.tb00062.x.
Gaudeul, Alexia; Giannetti, Caterina (2013). “The role of reciprocation in social network formation, with an application to LiveJournal”. Social Networks. 35 (3): 317-330. doi:10.1016/j.socnet.2013.03.003. ISSN 0378-8733.
Gelb, B. D., & Sundaram, S. (2002). Adapting to “word of mouse”. Business Horizons, 45(4), 21-25.
Gile, Krista J.; Beaudry, Isabelle S.; Handcock, Mark S.; Ott, Miles Q. (7 Mar. 2018). “Methods for Inference from Respondent-Driven Sampling Data”. Annual Review of Statistics and Its Application. 5 (1): 65-93. Bibcode:2018AnRSA . . . 5 . . . 65G. doi:10.1146/annurev-statistics-031017-100704. Retrieved 21 Sep. 2021.
Gleim, Mark R., and Jennifer L. Stevens. “Blockchain: a game changer for marketers?.” Marketing Letters 32, no. 1 (2021): 123-128.
Godes, G., & Mayzlin, D. (2004). Using online conversations to study word-of-mouth communication. Marketing Science, 23, 545-560.
Goel, S., Anderson, A., Hofman, J., & Watts, D. J. (2015). The structural virality of online diffusion. Management Science, 62, 180-196.
Goel, V., Facebook tinkers with users emotions in news feed experiment, stirring outcry. The New York Times, 2014.
Golan, G. J., & Zaidner, L. (2008). Creative strategies in viral advertising: An application of Taylor's six-segment message strategy wheel. Journal of Computer-Mediated Communication, 13, 959-972.
Goldenberg, J., Libai, B., & Muller, E. (2001). Talk of the network: A complex systems look at the underlying process of word-of mouth. Marketing Letters, 12, 211-223.
Goodfellow, I., Bengio, Y., Courville, A., Bengio, Y.: Deep Learning, vol. 1. MIT Press, Cambridge (2016)
Goyal, A., Bonchi, F., & Lakshmanan, L. V. (2011). A data-based approach to social influence maximization. In Proceedings of the VLDB Endowment (pp. 73-84).
Graepel, T., J. Q. N. Candela, T. Borchert, and R. Herbrich, “Web-scale Bayesian click-through rate prediction for sponsored search advertising in Microsoft's bing search engine,” in Proc. 27th Int. Conf. Mach. Learn. (ICML), 2010, pp. 13-20.
Granovetter, M. (1973). “The strength of weak ties”. American Journal of Sociology. 78 (6): 1360-1380. doi:10.1086/225469. S2CID 59578641.
Granovetter, M. (1976). “Network sampling: Some first steps”. American Journal of Sociology. 81 (6): 1287-1303. doi:10.1086/226224. S2CID 40359730.
Granovetter, Mark (2005). “The Impact of Social Structure on Economic Outcomes”. The Journal of Economic Perspectives. 19 (1): 33-50. doi:10.1257/0895330053147958. JSTOR 4134991.
Granovetter, Mark (2007). “Introduction for the French Reader”. Sociologica. 2: 1-8.
Grayson, L. (2007). Using evidence: How research can inform public services: A review. Evidence & Policy A Journal of Research Debate & Practice, 3(3), 439-457.
Green, Matthew D., Jingcheng Liu Ian Miers Peihan Miao Pratyush Mishra Alessandro Chiesa. “Decentralized Anonymous Micropayments”. In: EUROCRYPT 2017 (36th International Conference on the Theory and Applications of Cryptographic Techniques) (2017).
Growth, Jens. “Short pairing-based non-interactive zero-knowledge arguments”. In: Proceedings of the 16th International Conference on the Theory and Application of Cryptology and Information Security,ASIACRYPT '10 (2010), pp. 321-340.
Gu, Ke, Linyu Wang, and Weijia Jia. “Autonomous resource request transaction framework based on blockchain in social network.” IEEE Access 7 (2019): 43666-43678.
Guidi, Barbara, Vanessa Clemente, Tomás Garcia, and Laura Ricci. “A rewarding model for the next generation social media.” In Proceedings of the 6th EAI International Conference on Smart Objects and Technologies for Social Good, pp. 169-174. 2020.
Guidi, Barbara. “When blockchain meets online social networks.” Pervasive and Mobile Computing 62 (2020): 101131.
Guo, H., R. Tang, Y. Ye, Z. Li, and X. He, “DeepFM: A factorization machine based neural network for CTR prediction,” 2017, arXiv:1703.04247. arxiv.org/abs/1703.04247
Guo, Q., Q. Liu, H. Zhang, J. Wan, and X. Chen, “An access control model for resource sharing based on the Role-Based access control intended for Multi-domain manufacturing Internet of Things,” IEEE Access, vol. 5, pp. 7001-7011, 2019.
Guo, Y., & Barnes, S. (2009). Virtual item purchase behavior in virtual worlds: An exploratory investigation. Electronic Commerce Research, 9(1-2), 77-96.
Haleem, Amir, Andrew Allen, Andrew Thompson, Marc Nijdam, and Rahul Garg. “A Decentralized Wireless Network.”
Halevi, S.; D. Harnik, B. Pinkas, and A. Shulman-Peleg. Proofs of ownership in remote storage systems. In Proceedings of the 18th ACM conference on Computer and communications security, pages 491-500. ACM, 2011.
Handley, Tyler. “P2P Search as an Alternative to Google.” (Jul. 31, 2013)
Hanneman, R. & M. Riddle, Introduction to Social Networks Methods (2005)
Hansen, D. L., Shneiderman, B., & Smith, M. A. (2011). Analyzing social media networks with NodeXL: Insights from a connected world. Burlington, MA: Morgan Kaufmann.
Hanson, S. (2000). Networking. Professional Geographer, 52(4), 751-758.
Harvey, Campbell R., Christine Moorman, and Marc Toledo. “How blockchain will change marketing as we know it.” SSRN 3257511 (2018).
Hayes, A. Evidence for bitcoin. Altcoin Price Efficiency: Miners' Arbitrage in Cryptocurrency Markets, 2014.
Hayes, J. L., & King, K. W. (2014). The social exchange of viral ads: Referral and coreferral of ads among college students. Journal of Interactive Advertising, 14, 98-109.
Hayes, J. L, King, K. W., & Ramirez, A. (2016). Brands, friends, & viral advertising: A social exchange perspective on the ad referral processes. Journal of Interactive Marketing, 36, 31-45. Hayes, N. (2008). Influencer Marketing: Who Really Influences Your Customers? Taylor & Francis.
He, W., Qiao, Q., & Wei, K. K. (2009). Social relationship and its role in knowledge management systems usage. Information & Management, 46(3), 175-180.
He, X., S. Bowers, J. Q. Candela, J. Pan, O. Jin, T. Xu, B. Liu, T. Xu, Y. Shi, A. Atallah, and R. Herbrich, “Practical lessons from predicting clicks on ads at Facebook,” in Proc. 20th ACM SIGKDD Conf. Knowl. Discovery Data Mining (ADKDD), 2014, pp. 1-9.
Heckathorn, Douglas D.; Cameron, Christopher J. (31 Jul. 2017). “Network Sampling: From Snowball and Multiplicity to Respondent-Driven Sampling”. Annual Review of Sociology. 43 (1): 101-119. doi:10.1146/annurev-soc-060116-053556. Retrieved 21 Sep. 2021.
Hedström, Peter; Sandell, Rickard; Stern, Charlotta (2000). “Mesolevel Networks and the Diffusion of Social Movements: The Case of the Swedish Social Democratic Party”; American Journal of Sociology. 106 (1): 145-172. doi:10.1086/303109. S2CID 3609428.
Hemsley, J. (2016). Studying the viral growth of a connective action network using information event signatures. First Monday, 21(8). firstmonday.orglojslindex,php/fm/article/view/6650/5598,
Heyman, J. E., & Dan, A. (2004). Effort for payment. Psychological Science, 15(11), 787-793.
Hidasi, B., A. Karatzoglou, L. Baltrunas, and D. Tikk, “Session-based recommendations with recurrent neural networks,” 2015, arXiv:1511.06939. arxiv.org/abs/1511.06939
Hill, S., Provost, F., & Volinsky, C. (2006). Network-based marketing: Identifying likely adopters via consumer networks. Statistical Science, 21, 256-276.
Hillbom, Erik, and Tobias Tillström. “Applications of smart-contracts and smart-property utilizing blockchains.” Master's thesis, 2016.
Himelboim, I., Golan, G. J., Moon, B. B., & Suto, R. J. (2014). A social networks approach to public relations on Twitter: Social mediators and mediated public relations. Journal of Public Relations Research, 26, 359-379.
Himelboim, Itai, and Guy J. Golan. “A social networks approach to viral advertising: The role of primary, contextual, and low influencers.” Social Media+Society 5, no. 3 (2019): 2056305119847516. journals.sagepub.com/doi/full/10.1177/2056305119847516
Hinz, O., Skiera, B., Barrot, C., & Becker, J. U. (2011). Seeding strategies for viral marketing: An empirical comparison. Journal of Marketing, 75, 55-71.
Hjalmarsson, F. P., Hreioarsson, G. K., Hamdaqa, M., Hjalmtysson, G.: Blockchainbased e-voting system. In: 2018 IEEE 11th International Conference on Cloud Computing (CLOUD), pp. 983-986, July 2018.doi.org/10.1109/CLOUD. 2018.00151
Hong, Z., Z. Wang, W. Cai, and V. C. M. Leung, “Blockchain-empowered fair computational resource sharing system in the D2D network,” Future Internet, vol. 9, no. 4, p. 85, 2017.
Horton, D., & Wohl, R. (1956), Mass communication and parasocial interaction: Observations on intimacy at a distance. Psychiatry, 19, 215-229.
Hsieh, J. K., Hsieh, Y. C., & Tang, Y. C. (2012). Exploring the disseminating behaviors of eWOM marketing: Persuasion in online video. Electronic Commerce Research, 12, 201-224.
Hu, Yao-Chieh, Ting-Ting Lee, Dimitris Chatzopoulos, and Pan Hui. “Hierarchical interactions between ethereum smart contracts across testnets.” In Proceedings of the 1st Workshop on Cryptocurrencies and Blockchains for Distributed Systems, pp. 7-12. 2018.
Huang D, Ma X, Zhang S (2020) Performance analysis of the raft consensus algorithm for private blockchains. IEEE Trans Syst Man Cybern: Syst 50(1):172-181. doi.org/10.1109/TSMC.2019.2895471
Huang, J., Su, S., Zhou, L., & Liu, X. (2013). Attitude toward the viral ad: Expanding traditional advertising models to interactive advertising. Journal of Interactive Marketing, 27, 36-46.
Hundt, Reed. Statement of Reed Hundt, Chairman of the Federal Communications Commission on Spectrum Policy Management before the Subcommittee on Telecommunications, Trade and user Protection, Committee on Commerce, U.S. House of Representatives. February 1997. transition.fcc.gov/Speeches/Hundt/spreh743.html.
Hyperledger (2018) A blockchain benchmark framework to measure performance of multiple blockchain solutions. github.com/hyperledger/caliper
Ingram, Hillary. “How Google and Facebook Have Taken Over the Digital Ad Industry”. In: Fortune (January 2017). fortune.com/2017/01/04/google-facebook-ad-industry/.
Interactive Advertising Bureau. Ad Blocking: Who Blocks Ads, Why and How to Win Them Back. Tech. rep. Interactive Advertising Bureau, 2016. www.iab.com/wp-content/uploads/2016/07/IAB-Ad-Blocking-2016-WhoBlocks-Ads-Why-and-How-to-Win-Them-Back.pdf.
Isa, D., & Himelboim, I. (2018). A social networks approach to online social movements: Social mediators and mediated content in #FreeAJStaff Twitter network. Social Media+Society, 4(1), 2056305118760807.
Iyengar, R., Van den Bulte, C., & Valente, T. (2013). Opinion leadership and social contagion in new product diffusion. Marketing Science, 30, 195-212.
Iyer, Ganesh, David Soberman, and J. Miguel Villas-Boas. “The targeting of advertising.” Marketing Science 24, no. 3 (2005): 461-476.
Jarman, Stephen, and Deniz D. Karaman Orsal. “The regulation of zero-price markets by the competition authorities in the USA and the EU.” Competition and Regulation in Network Industries 21, no. 4 (2020): 315-343.
Jiang, Le, and Xinglin Zhang. “BCOSN: A blockchain-based decentralized online social network.” IEEE Transactions on Computational Social Systems 6, no. 6 (2019): 1454-1466.
Jin, L., & Huang, Y. (2014). When giving money does not work: The differential effects of monetary versus in-kind rewards in referral reward programs. International Journal of Research in Marketing, 31(1), 107-116.
Jin, S. A. A., & Phua, J. (2014). Following celebrities' tweets about brands: The impact of twitter-based electronic word-of-mouth on consumers' source credibility perception, buying intention, and social identification with celebrities. Journal of Advertising, 43(2), 181-195,
Johnson, Justin P. “Targeted advertising and advertising avoidance.” The RAND Journal of Economics 44, no. 1 (2013): 128-144.
Jones, C.; Volpe, E. H. (2011). “Organizational identification: Extending our understanding of social identities through social networks”. Journal of Organizational Behavior. 32 (3): 413-434. doi:10.1002/job.694.

Jothikumar, B., & Baby, N. (2021). Blockchain Digital Marketing. International Journal of Advanced
Jothikumar, R. “Applying Blockchain in Agriculture: A Study on Blockchain Technology, Benefits, and Challenges.” In Deep Learning and Edge Computing Solutions for High Performance Computing, pp. 167-181. Springer, Cham, 2021.

Juan, Y., D. Lefortier, and O. Chapelle, “Field-aware factorization machines in a real-world online advertising system,” in Proc. 26th Int. Conf. World Wide Web Companion (WWW Companion), 2017, pp. 680-688.
Jun, Tackseung, and Jeong-Yoo Kim. “A theory of consumer referral.” International Journal of Industrial Organization 26, no. 3 (2008): 662-678.
Jurkowitz, Mark Amy Mitchell and Kenneth Olmstead. Social, Search and Direct: Pathways to Digital News. Tech. rep. Pew Research Center, March 2014. www.journalism.org/2014/03/13/social-search-direct.
Kadushin, Charles (2012). Understanding Social Networks: Theories, Concepts, and Findings. Oxford University Press. ISBN 978-0-19-537946-4.
Kaplan, A. M., & Haenlein, M. (2011). Two hearts in three-quarter time: How to waltz the social media/viral marketing dance. Business Horizons, 54, 253-263.
Karame, G.: On the security and scalability of Bitcoin's blockchain. In: Proceedings of the 2016 ACM SIGSAC Conference on Computer and Communications Security, C C S 2016, pp. 1861-1862. ACM, New York (2016). doi.org/10. 1145/2976749.2976756
Kasprzyk, Karolina. “The concept of smart contracts from the legal perspective.” Rev. Eur. & Comp. L. 34 (2018): 101.
Katsumata S, Motohashi E, Nishimoto A, Toyosawa E (2017) The contents-based website classification for the internet advertising planning: an empirical application of the natural language analysis. Rev Socionetwork Strateg 11(2):129-142. doi.org/10.1007/s12626-017-0007-0
Kautz, Henry, Bart Selman, and Mehul Shah. “Referral Web: combining social networks and collaborative filtering.” Communications of the ACM 40, no. 3 (1997): 63-65.
Keller, E. (2007). Unleashing the power of word of mouth: creating brand advocacy to drive growth. Journal of Advertising Research, 47, 448.
Keller, K. L. (2009). Building strong brands in a modern marketing communications environment. Journal of Marketing Communications, 15, 139-155.
Kempe, D., Kleinbert, J., & Tardos, E. (2003). Maximizing the spread of influence through a social network. In Proceedings of the 9th ACM SIGKDD Conference on Knowledge Discovery and Data Mining (pp. 134-146).
Ketelaar, P. E., Janssen, L, Vergeer, M., van Reijmersdal, E. A., Crutzen, R., & van't Riet, J. (2016). The success of viral ads: Social and attitudinal predictors of consumer pass-on behavior on social network sites. Journal of Business Research, 69, 2603-2613.
Kiayias, A., Russell, A., David, B., Oliynykov, R.: Ouroboros: a provably secure proof-of-stake blockchain protocol. In: Katz, J., Shacham, H. (eds.) CRYPTO 2017. LNCS, vol. 10401, pp. 357-388. Springer, Cham (2017). doi.org/10.1007/978-3-319-63688-7 12
Kilduff, M.; Tsai, W. (2003). Social networks and organisations. Sage Publications.
Kim, Beom Jun, Tackseung Jun, Jeong-Yoo Kim, and M. Y. Choi. “Network marketing on a small-world network.” Physica A: Statistical Mechanics and its Applications 360, no. 2 (2006): 493-504.
Kim, J., Kim, S.-K., & Yu, H. (2013). Scalable and parallelizable processing of influence maximization for large-scale social networks. In IEEE 29th International Conference on Data Engineering (pp. 266-277).
Kim, J., Lee, C., & Elias, T. (2015). Factors affecting information sharing in social networking sites amongst university students. Online Information Review, 39(3), 290-309.
Kim, Kyungwon, Eun Kwon, and Jaram Park. “Deep user segment interest network modeling for click-through rate prediction of online advertising.” IEEE Access 9 (2021): 9812-9821.
Kim, S., Lee, J. S., & Pan, S. (2014). The role of relationship marketing investments in customer reciprocity. International Journal of Contemporary Hospitality Management, 26(8), 1200-1224.
Kim, Yoon, Carl Denton, Luong Hoang, and Alexander M. Rush. “Structured attention networks.” arXiv preprint arXiv:1702.00887 (2017). Chen, Yize, Quanlai Li, and Hao Wang. “Towards trusted social networks with blockchain technology.” arXiv preprint arXiv:1801.02796 (2018).
King, S.; and S. Nadal. Ppcoin: Peer-to-peer crypto-currency with proof-of-stake. self-published paper, Aug. 19, 2012.
Kishigami, J. J., “Blockchain contract: A complete consensus using blockchain,” in Proc. IEEE 4th Global Conf. Consumer Electron., October 2016, pp. 577-578.
Klimmt, C., Hartmann, T., & Schramm, H. (2006). Parasocial interactions and relationships. In J. Bryant &
P. Vorderer (Eds.), Psychology of entertainment (pp. 291-313). Mahwah, NJ: Lawrence Erlbaum.
Koch, Julia, and Christian Reitwiessner. “A predictable incentive mechanism for truebit.” arXiv preprint arXiv:1806.11476 (2018).
Koley, Gaurav; Deshmukh, Jayati; Srinivasa, Srinath (2020). Aref, Samin; Bontcheva, Kalina; Braghieri, Marco; Dignum, Frank; Giannotti, Fosca; Grisolia, Francesco; Pedreschi, Dino (eds.). “Social Capital as Engagement and Belief Revision”. Social Informatics. Lecture Notes in Computer Science. Cham: Springer International Publishing. 12467: 137-151. doi:10.1007/978-3-030-60975-7_11. ISBN 978-3-030-60975-7. S2CID 222233101.
Kolvart, Merit, Margus Poola, and Addi Rull. “Smart contracts.” In The Future of Law and etechnologies, pp. 133-147. Springer, Cham, 2016.
Konforty, D.; Y. Adam, D. Estrada, and L. G. Meredith. Synereo: The decentralized and distributed social network. 2015.
Korpela K, Hallikas J, Dahlberg T (2017) Digital supply chain transformation toward blockchain integration. In: Proceedings of the 50th Hawaii international conference on system sciences, pp 4182-4191
Kosba A, Miller A, Shi E, Wen Z, Papamanthou C (2016) Hawk: the blockchain model of cryptography and privacy-preserving smart contracts. In: 2016 IEEE symposium on security and privacy (SP). IEEE, pp 839-858
Kotila M, Cuevas Rumin R, Dhar S (2016) Compendium of ad fraud knowledge for media investors. Report ETLA Reports No 68, WFA Global Transparency Group, Brussels, Belgium. pub.etla.fi/ETLA-Raportit-Reports-68.pdf
Koulu, Riikka. “Blockchains and online dispute resolution: smart contracts as an alternative to enforcement.” SCRIPTed 13 (2016): 40.
Kumar, V., Petersen, J. A., & Leone, R. P. (2010). Driving profitability by encouraging customer referrals: who, when, and how. Journal of Marketing, 74, 1-17.
Kwak, H., Lee, C., Park, H., & Moon, S. (2010). What is Twitter. a socialnetwork or a news media? Paper presented at Proceedings of the 19th International Conference on World Wide Web. Retrieved from dl.acm.org/citation.cfm?id=1772751
Lamb, Kirsten. “Blockchain and Smart Contracts: What the AEC sector needs to know.” (2018).
Larimer D (2017) Dpos consensus algorithm—the missing whitepaper. Tech. rep. Steemit Larson, Jennifer M. (11 May 2021). “Networks of Conflict and Cooperation”. Annual Review of Political
Science. 24 (1): 89-107. doi:10.1146/annurev-polisci-041719-102523.
Laubscher, Michael Casparus, and Muhammed Siraaj Khan. “Smart Contracts: An Overview.” Legal Regulations, Implications, and Issues Surrounding Digital Data (2020): 127-135.
Lauslahti K, Mattila J, Seppala T (2017) Smart contracts-how will blockchain technology affect contractual practices? Report ETLA Reports No 68, ETLA. The Research Institute of the Finnish Economy. pub.etla.fi/ETLA-Raportit-Reports-68.pdf
Leathern, Rob. “Carriers are Making More From Mobile Ads than Publishers Are”. In: Medium (October 2015). medium.com/@robleathern/carriersare-making-more-from-mobile-ads-than-publishers-are-d5d3c0827b39 #.aiw3hs4ls.
Lee B., and H.-J. Lee, “Blockchain-based secure firmware update for embedded devices in an Internet of Things environment,” J. Supercomput., vol. 73, no. 3, pp. 1152-1167, September 2016.
Lee, J.; Kim, S. (2011). “Exploring the role of social networks in affective organizational commitment: Network centrality, strength of ties, and structural holes”. The American Review of Public Administration. 41 (2): 205-223. doi:10.1177/0275074010373803. S2CID 145641976.
Lee, M. K., Yoon, H. Y., Smith, M., Park, H. J., & Park, H. W. (2017). Mapping a Twitter scholarly communication network: A case of the association of internet researchers' conference. Scientometrics, 112, 767-797.
Lemos, Catarina, Ricardo F. Ramos, Sergio Moro, and Pedro Miguel Oliveira. “Stick or Twist—The Rise of Blockchain Applications in Marketing Management.” Sustainability 14, no. 7 (2022): 4172.
Leskovec, J., Krause, A., Guestrin, C., & Faloutsos, C. (2007). Cost-effective outbreak detection in networks. In Proceedings of the 13th ACM SIGKDD international conference on Knowledge discovery and data mining (pp. 420-429).
Lévi-Strauss, Claude ([1947]1967). Les structures elementaires de la parente. Paris: La Haye, Mouton et Co. (Translated, 1969 by J. H. Bell, J. R. von Sturmer, and R. Needham, 1969, as The Elementary Structures of Kinship, Boston: Beacon Press.)
Levy, Judith and Bernice Pescosolido (2002). Social Networks and Health. Boston, MA: JAI Press.
Li H, Pei L, Liao D, Sun G, Xu D (2019) Blockchain meets vanet: an architecture for identity and location privacy protection in vanet. Peer-to-Peer Netw Appl 12(5):1178-1193. doi.org/10.1007/s12083-019-00786-4
Li Z, Kang J, Yu R, Ye D, Deng Q, Zhang Y (2018) Consortium blockchain for secure energy trading in industrial internet of things. IEEE Trans Ind Inf 14(8):3690-3700. doi.org/10.1109/TII.2017.2786307
Li, Chao, and Balaji Palanisamy. “Incentivized blockchain-based social media platforms: A case study of steemit.” In Proceedings of the 10th ACM conference on web science, pp. 145-154. 2019.
Li, D., B. Hu, Q. Chen, X. Wang, Q. Qi, L. Wang, and H. Liu, “Attentive capsule network for click-through rate and conversion rate prediction in online advertising,” Knowl.-Based Syst., vol. 211, January 2021, Art. no. 106522.
Li, H., C. Wu, Z. Li, and F. C. M. Lau, “Virtual machine trading in a federation of clouds: Individual profit and social welfare maximization,” IEEE/ACM Trans. Netw., vol. 24, no. 3, pp. 1827-1840, September 2013.
Li, Ruinian, Hongjuan Li, Xiuzhen Cheng, Xiaobo Zhou, Keqiu Li, Shengling Wang, and Rongfang Bie. “Perturbation-based private profile matching in social networks.” IEEE Access 5 (2017): 19720-19732.
Li, X., C. Wang, B. Tong, J. Tan, X. Zeng, and T. Zhuang, “Deep time-aware item evolution network for click-through rate prediction,” in Proc. 29th ACM Int. Conf. Inf. Knowl. Manage., October 2020, pp. 785-794.
Li, Y.-M., & Shiu., Y.-L. (2012). A diffusion mechanism for social advertising over microblogs. Decision Support Systems, 54, 9-22.
Li, Z., Kang, J., Yu, R., Ye, D., Deng, Q., Zhang, Y.: Consortium blockchain for secure energy trading in industrial internet of things. IEEE Trans. Ind. Inform. 14(8), 3690-3700 (2018). doi.org/10.1109/TII.2017.2786307
Liang, X., J. Zhao, S. Shetty, J. Liu, and D. Li, “Integrating blockchain for data sharing and collaboration in mobile healthcare applications,” in Proc. IEEE 28th Annu. Int. Symp. Personal, Indoor, Mobile Radio Commun., October 2017, pp. 1-5.
Liu D., and V. Mookerjee, “Advertising competition on the Internet: Operational and strategic considerations,” Prod. Oper. Manage., vol. 27, no. 5, pp. 884-901, May 2018.
Liu, Chang, and Sheng Bin. “Research on Maximizing Influence of Blockchain Social Network Based on BCLT Model.” Discrete Dynamics in Nature and Society 2022 (2022).
Liu, Dongxiao, Jianbing Ni, Xiaodong Lin, and Xuemin Shen. “Transparent and accountable vehicular local advertising with practical blockchain designs.” IEEE Transactions on Vehicular Technology 69, no. 12 (2020): 15694-15705.
Liu, Liqun, Weihan Zhang, and Cunqi Han. “A survey for the application of blockchain technology in the media.” Peer-to-Peer Networking and Applications 14, no. 5 (2021): 3143-3165.
Liu, X., Y. Song, C. Aggarwal, Y. Zhang, and X. Kong, “BiCycle: Item recommendation with life cycles,” in Proc. IEEE Int. Conf. Data Mining (ICDM), November 2017, pp. 297-306.
Lotker, Zvi (2021), “Machine Narrative”, Analyzing Narratives in Social Networks, Cham: Springer International Publishing, pp. 283-298, doi:10.1007/978-3-030-68299-6_18, ISBN 978-3-030-68298-9, S2CID 241976819, retrieved 2022-03-16
Lou, C., & Yuan, S. (2018). Influencer marketing: How message value and credibility affect consumer trust of branded content on social media. Journal of Interactive Advertising, 19, 58-73.
Lu, C., Z. Li-Qiang, Z. Qing, and C. Yun, “A trust-based usage control scheme for resource sharing,” in Proc. IEEE 18th Int. Conf. High Perform. Comput. Commun., IEEE 14th Int. Conf. Smart City, IEEE 2nd Int. Conf. Data Sci. Syst. (HPCC/SmartCity/DSS), August 2015, pp. 550-556.
Lund, Brady. “The Brave browser: a monetary opportunity for libraries in the cryptoverse.” Library Hi Tech News (2021).
Ma, L., Krishnan, R., & Montgomery, A. (2014). Latent homophily or social influence? an empirical analysis of purchase within a social network. Management Science, 61, 454-473.
Malinowski, Bronislaw (1913). The Family Among the Australian Aborigines: A Sociological Study. London: University of London Press.
Mancini, James, and Cristina Volpin. “Quality Considerations in Digital Zero-Price Markets: OECD Background Paper.” DAF/COMP (2018) 14 (2018).
Mao, Y., Y. Guo, H. Hu, Z. Wang, and T. Ma, “Sharing based virtual network embedding algorithm with dynamic resource block generation,” IEEE Commun. Lett., vol. 19, no. 12, pp. 2126-2129, December 2015.
Markovic, M.: Data protection techniques, cryptographic protocols and PKI systems in modern computer networks. In: 2007 14th International Workshop on Systems, Signals and Image Processing and 6th EURASIP Conference focused on Speech and Image Processing, Multimedia Communications and Services, pp. 13-24, June 2007. doi.org/10.1109/IWSSIP.2007.4381086
Martino, Francesco, and Andrea Spoto. “Social Network Analysis: A brief theoretical review and further perspectives in the study of Information Technology.” PsychNology J. 4, no. 1 (2006): 53-86.
Mauro, Rios; Petrella, Carlos (2014). La Quimera de las Redes Sociales [The Chimera of Social Networks](in Spanish). Bubok Espaha. ISBN 978-9974-99-637-3.
Mcmahan, H. B., G. Holt, D. Sculley, M. Young, D. Ebner, J. Grady, L. Nie, T. Phillips, E. Davydov, D.

Golovin, S. Chikkerur, D. Liu, M. Wattenberg, A. M. Hrafnkelsson, T. Boulos, and J. Kubica, “Ad click prediction: A view from the trenches,” in Proc. 19th ACM SIGKDD Int. Conf. Knowl. Discovery Data Mining, August 2013, pp. 1222-1230.
Merkle, R.: Secrecy, authentication, and public key systems. Ph. D. thesis, Stanford University (1979)
Miers, Ian, Matthew Green. “Bolt: Anonymous Payment Channels for Decentralized Currencies”. In: IACR Cryptology ePrint Archive 2016 (2016).
Miles, C. (2014). The rhetoric of managed contagion: Metaphor and agency in the discourse of viral marketing. Marketing Theory, 14, 3-18.
Mill, John (1909). Principles of Political Economy. Library of Economics and Liberty: William J Ashley.
Miralles-Pechuan, L., D. Rosso, F. Jimenez, and J. M. Garcia, “A methodology based on deep learning for advert value calculation in CPM, CPC and CPA networks,” Soft Comput., vol. 21, no. 3, pp. 651-665, February 2017.
MIT Technology Review and Vigilant. “Navigating Planet Ad Tech: A Guide for Marketers”. In: MIT Technology Review (October 2013). www.technologyreview.com/s/519991/navigating-planet-ad-tech.
Mohanta, Bhabendu Kumar, Soumyashree S. Panda, and Debasish Jena. “An overview of smart contract and use cases in blockchain technology.” In 2018 9th international conference on computing, communication and networking technologies (ICCCNT), pp. 1-4. IEEE, 2018.
Moreira, Andrë A.; Demétrius R. Paula; Raimundo N. Costa Filho; Jose S. Andrade Jr. (2006). “Competitive cluster growth in complex networks”. Physical Review E. 73 (6): 065101. arXiv:cond-mat/0603272. Bibcode:2006PhRvE..73f5101M. doi:10.1103/PhysRevE.73.065101. PMID 16906890. S2CID 45651735.
Morhart, F. M., Herzog, W., & Tomczak, T. (2009). Brand-specific leadership: Turning employees into brand champions. Journal of Marketing, 73(5), 122-142.
Muller, L.: Transforming online advertising: a user centric approach to bridge the gap. In: Proceedings of the 2018 ACM SIGMIS Conference on Computers and People Research, SIGMIS-CPR 2018, pp. 181-182. ACM, New York (2018). doi.org/10.1145/3209626.3209632
Mullins, Nicholas. Theories and Theory Groups in Contemporary American Sociology. New York: Harper and Row, 1973.
Murillo, D. E. C., Kang, J., & Yoon, S. (2016). Factors influencing pro-social consumer behavior through non-profit organizations. Internet Research, 26(3), 626-643.
Myers, S., R. Pass S. Hohenberger and A. Shelat. “An Overview of ANONIZE: A Large-Scale Anonymous Survey System”. In: IEEE Security and Privacy 13.2 (2015), pp. 22-29.
Nadel, S. F. 1957. The Theory of Social Structure. London: Cohen and West.
Nagler, Jan; Anna Levina; Marc Timme (2011). “Impact of single links in competitive percolation”. Nature Physics. 7 (3): 265-270. arXiv:1103.0922. Bibcode:2011NatPh . . . 7..265N. doi:10.1038/nphysl860. S2CID 2809783.
Nakamoto, S.: Bitcoin: a peer-to-peer electronic cash system. Technical report (2008). bitcoin.org/bitcoin.pdf
Narayanam, R., & Narahari, Y. (2010). A shapley value based approach to discover influential nodes in social networks. Automation Science and Engineering, 8, 1-18.
Nasir Q, Qasse I A, Abu Talib M, Nassif A B (2018) Performance analysis of hyperledger fabric platforms. Secur Commun Netw 2018:3976093
Neff, Jack, “P&G Tells Digital to Clean Up, Lays Down New Rules for Agencies and Ad Tech to Get Paid”. In: Advertising Age (January 2017). adage.com/article/media/p-g-s-pritchard-calls-digital-grow-up-new-rules/307742/.
Newman, John M. “Antitrust in zero-price markets: applications.” Wash. UL Rev. 94 (2016): 49.
Newman, M. (2000). The power of design. Nature, 405, 412-413.
Newman, Mark, Albert-Leszlo Barabesi and Duncan J. Watts (2006). The Structure and Dynamics of Networks (Princeton Studies in Complexity). Oxford: Princeton University Press.
Newshub.co.nz. www.newshub.co.nz/home/entertainment/2017/04/heineken-create-the-anti-pepsi-advert-aziz-al-sa-afin.hhtml
Nielsen, J. (2006). Participation inequality: Encouraging more users to contribute. Retrieved from www.useit.com/alertbox/participation_inequality.html
Norberhuis, S. D.; MultiChain: A cybercurrency for cooperation. PhD thesis, TU Delft, Delft University of Technology, 2015.
Nurhandayani, Arum, Rizal Syarief, and Mukhamad Najib. “The impact of social media influencer and brand images to purchase intention.” Jurnal Aplikasi Manajemen 17, no. 4 (2019): 650-661.
Okazaki, S., Katsukura, A., & Nishiyama, M. (2007). How mobile advertising works: The role of trust in improving attitudes and recall. Journal of Advertising Research, 47, 165-178.
Olaru, D., Purchase, S., & Peterson, N. (2008). From customer value to repurchase intentions and recommendations. Journal of Business & Industrial Marketing, 23(8), 554-565.
Ouaddah, A.; A. A. Elkalam, and A. A. Ouahman, “Towards a novel privacy-preserving access control model based on blockchain technology in IoT,” in Proc. Eur. MENA Cooperation Adv. Inf. Commun. Technol. Cham, Switzerland: Springer, 2017, pp. 523-533.
Pacheco, João. “Smart Contracts using Blockchain.” PhD diss., 2020.
Papachristos, Andrew (2009). “Murder by Structure: Dominance Relations and the Social Structure of Gang Homicide”; American Journal of Sociology. 115 (1): 74-128. doi:10.2139/ssrn.855304. PMID 19852186. S2CID 24605697.
Paradowski, Michal B.; Jarynowski, Andrzej; Jelinska, Magdalena; Czopek, Karolina (2021). “Out-of-class peer interactions matter for second language acquisition during short-term overseas sojourns: The contributions of Social Network Analysis [Selected poster presentations from the American Association of Applied Linguistics conference, Denver, USA, March 2020]”. Language Teaching. 54 (1): 139-143. doi:10.1017/S0261444820000580.
Paradowski, Michal B.; Jonak, Lukasz (2012). “Diffusion of linguistic innovation as social coordination”.
Psychology of Language and Communication. 16 (2): 53-64. doi:10.2478/v10057-012-0010-z.
Park, Semin; Grosser, Travis J.; Roebuck, Adam A.; Mathieu, John E. (3 Feb. 2020). “Understanding Work Teams From a Network Perspective: A Review and Future Research Directions”. Journal of Management. 46 (6): 1002-1028. doi:10.1177/0149206320901573.
Parsons, Talcott ([1937] 1949). The Structure of Social Action: A Study in Social Theory with Special Reference to a Group of European Writers. New York: The Free Press.
Parsons, Talcott (1951). The Social System. New York: The Free Press.
Parssinen M, Kotila M, Cuevas R, Phansalkar A, Manner J (2018) Is blockchain ready to revolutionize online advertising? IEEE Access 6:54884-54899. doi.org/10.1109/ACCESS. 2018.2872694
Pass, Rafael, and Abhi Shelat. “Micropayments for decentralized currencies.” In Proceedings of the 22nd ACM SIGSAC Conference on Computer and Communications Security, pp. 207-218. 2015.
Pastor Valles A (2016) An entropy-based methodology for detecting online advertising fraud at scale. Ph.D. thesis. Universidad Carlos III de Madrid, Spain
Pathak, S. (2017, August 10). Report: Brands are falling for fake Instagram influencers. Digiday.com. digiday.com/marketing/report-brands-falling-fake-instagram-influencers/
Pearson, B. (2016). Storytizing: What's next after advertising. Austin, TX: 1845 Publishing.
Peck, M., The bitcoin arms race is on! IEEE Spectrum, 6(50), 2013.
Pei, Sen, Lev Muchnik, Jose S. Andrade Jr, Zhiming Zheng, and Hernen A. Makse. “Searching for superspreaders of information in real-world social media.” Scientific reports 4, no. 1 (2014): 1-12.
Pemberton, Chris. Gartner CMO Spend Survey 2016-2017 Shows Marketing Budgets Continue to Climb. Tech. rep. Gartner Research, December 2016. www.gartner.com/smarterwithgartner/gartner-cmo spend survey 2016-2017-shows-marketing-budgets-continue-to-climb/.
Penny, Troy Lyall. “Basic Attention Token & Brave: Digital Marketing on the Blockchain.” (2018).
Perugini, Maria Letizia, and Paolo Dal Checco. “Smart Contracts: a preliminary evaluation.” Available at SSRN 2729548 (2015).
Peters, G. W. and E. Panayi. Understanding modern banking ledgers through blockchain technologies: Future of transaction processing and smart contracts on the internet of money. SSRN 2692487, 2015.
Petkanics, Doug. “Protocol and Economic Incentives for a Decentralized Live Video Streaming Network.” (2018).
Petrescu, M. (2014). Viralmarketing and socialnetworks. New York, NY: Business Expert Press.
Petrescu, M., & Korgaonkar, P. (2011). Viral advertising: Definitional review and synthesis. Journal of Internet Commerce, 10, 208-226.
Phelps, J. E., Lewis, R., Mobilio, L., Perry, D., & Raman, N. (2004). Viral marketing or electronic word-of-mouth advertising: Examining consumer responses and motivations to pass along email. JournalofAdvertising Research, 44, 333-348.
Phua, J., & Kim, J. J. (2018). Starring in your own Snapchat advertisement: Influence of self-brand congruity, self-referencing and perceived humor on brand attitude and purchase intention of advertised brands. Telematics and informatics, 35, 15241533.
Phua, J., Jin, S. V., & Kim, J. J. (2017). Gratifications of using Facebook, Twitter, Instagram, or Snapchat to follow brands: The moderating effect of social comparison, trust, tie strength, and network homophily on brand identification, brand engagement, brand commitment, and membership intention. Telematics and Informatics, 34(1), 412-424.
Pi, Q., W. Bian, G. Zhou, X. Zhu, and K. Gai, “Practice on long sequential user behavior modeling for click-through rate prediction,” in Proc. 25th ACM SIGKDD Int. Conf. Knowl. Discovery Data Mining, July 2019, pp. 2671-2679.
Podolny, J. M.; Baron, J. N. (1997). “Resources and relationships: Social networks and mobility in the workplace”. American Sociological Review. 62 (5): 673-693. CiteSeerX 10.1.1.114.6822. doi:10.2307/2657354. JSTOR 2657354.
Pongjit, C., & Beisezee, R. (2015). The effects of word-of-mouth incentivization on consumer brand attitude. Journal of Product & Brand Management, 24(7), 720-735.
Porter, L., & Golan, G. J. (2006). From subservient chickens to brawny men: A comparison of viral advertising to television advertising. Journal of Interactive Advertising, 6, 30-38.
Preacher, K. J., Rucker, D. D., & Hayes, A. F. (2007). Addressing moderated mediation hypotheses: Theory, methods, and prescriptions. Multivariate Behavioral Research, 42(1), 185-227.
Probst, F., Grosswiele, D. K. L., & Pfleger, D. K. R. (2013). Who will lead and who will follow: Identifying influential users in online social networks. Business and Information Systems Engineering, 5, 179-193.
Publicis. (2017, April 21). Heineken® unveils social experiment for new Open Your World campaign. publicis.london/news/heineken-unveils-social-experiment-for-new-open-your-world-campaign/
Purnama, Suryari, Untung Rahardja, Qurotul Aini, Alfiah Khoirunisa, and Restu Ajeng Toyibah. “Approaching The Anonymous Deployment Of Blockchain-Based Fair Advertising On Vehicle Networks.” In 2021 3rd International Conference on Cybernetics and Intelligent System (ICORIS), pp. 1-6. IEEE, 2021.
Puthussery, A., Digital Marketing: An Overview. Chennai, India: Notion Press, 2020.
PwC: lab internet advertising revenue report 2016 full-year results. Technical report, Interactive Advertising Bureau (IAB) and PricewaterhouseCoopers (PwC) (2017). www.iab.com/wp-content/uploads/2016/04/IAB Internet Advertising Revenue Report FY 2016.pdf
Qiu, L., Rui, H., & Whinston, A. (2013). Social network-embedded prediction markets: The effects of information acquisition and communication on predictions. Decision Support Systems, 55(4), 978-987.
Qu, Y., H. Cai, K. Ren, W. Zhang, Y. Yu, Y. Wen, and J. Wang, “Product-based neural networks for user response prediction,” in Proc. IEEE 16th Int. Conf. Data Mining (ICDM), December 2016, pp. 1149-1154.
Radcliffe-Brown, A. R. (1940). “On social structure”. Journal of the Royal Anthropological Institute. 70 (1): 1-12. doi:10.2307/2844197. JSTOR 2844197.
Radcliffe-Brown, Alfred Reginald (1930) The social organization of Australian tribes. Sydney, Australia: University of Sydney Oceania monographs, No. 1.
Rafieiankoopaei, O., “Essays on personalization and market design in mobile advertising,” Ph.D. dissertation, Foster School Bus., Univ. Washington, Seattle, WA, USA, 2020. Accessed: Jan. 8, 2021. [Online]. Available: hdl.handle.net/1773/45873
Rahman, Mohsin Ur, Barbara Guidi, and Fabrizio Baiardi. “Blockchain-based access control management for decentralized online social networks.” Journal of Parallel and Distributed Computing 144 (2020): 41-54.
Rainie, Lee. “The state of privacy in post-Snowden America”. In: Pew Research Center FactTank (September 2016). www.pewresearch.org/fact-tank/2016/09/21/the-state-of-privacy-in-America.
Rainie, Lee; Wellman, Barry (2012). Networked: The New Social Operating System. Cambridge, Mass.: MIT Press. ISBN 978-0262017190.
Raskin, Max. “The law and legality of smart contracts.” Geo. L. Tech. Rev. 1 (2016): 305.
Rasmussen, L. (2018). Parasocial interaction in the Digital Age: An examination of relationship building and the effectiveness of YouTube celebrities. The Journal of Social Media in Society, 7, 280-294.
Reddy, N. Anudeep, N. Chaitra Sangeeth, B. Keerthi Samhitha, Suja Cherukullapurath Mana, and Jithina Jose. “Blockchain Based Incentive Announcement Network for Communications Using VANET.” Annals of the Romanian Society for Cell Biology (2021): 47-54.
Reed Ii, A. (2004). Activating the self-importance of consumer selves: Exploring identity salience effects on judgments. Journal of Consumer Research, 31(2), 286-295.
Reichheld, F. (2006). The ultimate question: Driving good profits and true growth. Harvard Business School Press.
Rejeb, Abderahman, John G. Keogh, and Horst Treiblmaier. “How blockchain technology can benefit marketing: Six pending research areas.” Frontiers in Blockchain 3 (2020): 3.
Rendle, S., “Factorization machines,” in Proc. IEEE Int. Conf. Data Mining, December 2010, pp. 995-1000.
Richins, M. L. (1983). Negative word-of-mouth by dissatisfied consumers: A pilot study. Journal of Marketing, 47(1), 68-78.
Riketta, M.; Nienber, S. (2007). “Multiple identities and work motivation: The role of perceived compatibility between nested organizational units”. British Journal of Management. 18: S61-77. doi:10.1111/j.1467-8551.2007.00526.x. S2CID 144857162.
Roelens, Iris, Philippe Baecke, and Dries F. Benoit. “Identifying influencers in a social network: The value of real referral data.” Decision Support Systems 91 (2016): 25-36.
Rong, C., and G. Zhao. System for protecting an encrypted information unit, Oct. 7 2014. U.S. Pat. No. 8,855,317.
Rouhani, S., Deters, R.: Performance analysis of ethereum transactions in private blockchain. In: 2017 8th IEEE International Conference on Software Engineering and Service Science (ICSESS), pp. 70-74, November 2017). doi.org/10. 1109/ICSESS.2017.8342866
Routray, Janendra Kumar. “Blockchain: How it is changing digital marketing?.” Splint International Journal of Professionals 7, no. 3 (2020): 55-64.
Rui, H., Liu, Y., & Whinston, A. (2013). Whose and what chatter matters? The effect of tweets on movie sales. Decision Support Systems, 55, 863-870.
Rutt, James. “Targeted advertising and media market competition.” SSRN 2103061 (2012).
Ryu, G., & Feick, L. (2007). A penny for your thoughts: Referral reward programs and referral likelihood. Journal of Marketing, 71(1), 84-94.
Saberi S, Kouhizadeh M, Sarkis J, Shen L (2019) Blockchain technology and its relationships to sustainable supply chain management. Int J Prod Res 57(7):2117-2135. doi.org/10.1080/00207543.2018.1533261
Sadovykh, V., Sundaram, D., & Piramuthu, S. (2015). Do online social networks support decision-making?Decision Support Systems, 70, 15-30.
Savage, Mike (2008). “Elizabeth Bott and the formation of modern British sociology”. The Sociological Review. 56 (4): 579-605. doi:10.1111/j.1467-954x.2008.00806.x. S2CID 145286556.
Schafer, J. B., J. Konstan, and J. Riedi, “Recommender systems in ecommerce,” in Proc. 1st ACM Conf. Electron. Commerce (EC), 1999, pp. 158-166.
Schmitt, P., Skiera, B., & Christophe, V. D. B. (2011). Referral programs and customer value. Journal of Marketing, 75(1), 46-59.
Schroder, N., A. Falke, H. Hruschka, and T. Reutterer, “Analyzing the browsing basket: A latent interests-based segmentation tool,” J. Interact. Marketing, vol. 47, pp. 181-197, August 2019.
Scott, D. M. (2015). The new rules of marketing and PR: How to use social media, online video, mobile applications, blogs, news releases, and viral marketing to reach buyers directly. Hoboken, NJ: John Wiley & Sons.
Scott, John (1991). Social Network Analysis: A Handbook. Sage. ISBN 978-0-7619-6338-7.
Scott, John P. (2000). Social Network Analysis: A Handbook (2nd edition). Thousand Oaks, CA: Sage Publications. ISBN 978-0-7619-6339-4.
Scott, W. Richard; Davis, Gerald F. (2003). “Networks In and Around Organizations”. Organizations and Organizing. Pearson Prentice Hall. ISBN 978-0-13-195893-7.
Sebastián, Valenzuela; Namsu Park; Kerk F. Kee (2009). “Is There Social Capital in a Social Network Site?Facebook Use and College Students' Life Satisfaction, Trust, and Participation”. Journal of Computer-Mediated Communication. 14 (4): 875-901. doi:10.1111/j.1083-6101.2009.01474.x.
Senekal, B. A. (2012). “Die Afrikaanse literêre sisteem: 'n Eksperimentele benadering met behulp van Sosiale-netwerk-analise (SNA)”. LitNet Akademies. 9: 3.
Senft, T. M. (2008). Camgirls: Celebrity and Community in the Age of Social Networks (Vol. 4). New York: Peter Lang.
Serada, Alesha, Jori Grym, and Tanja Sihvonen. “The Economy of Attention on Blockchain in the Brave Browser.” In Futures of Journalism, pp. 49-62. Palgrave Macmillan, Cham, 2022.
Shampanier, Kristina, Nina Mazar, and Dan Ariely. “Zero as a special price: The true value of free products.” Marketing science 26, no. 6 (2007): 742-757.
Shan, Y., & King, K. W. (2015). The effects of interpersonal tie strength and subjective norms on consumers' brand-related eWOM referral intentions. Journal of Interactive Advertising, 15, 16-27.
Shapley, L. (1953). A value for n-person games. contributions to the theory of games volume ii. (pp. 307-317).
Sharma, Minky. “Emergence of Virtual Currencies-Study of Cryptocurrency in Digital Marketing.” International Journal of Islamic and Social Sciences (ISOS) 1, no. 3 (2021): 1-5.
Sheth, Alpen, and Hemang Subramanian. “Blockchain and contract theory: modeling smart contracts using insurance markets.” Managerial Finance (2019).
Shin, Jiwoong, and Jungju Yu. “Targeted advertising and consumer inference.” Marketing Science 40, no. 5 (2021): 900-922.
Shirado, Hirokazu; Christakis, Nicholas A (2017). “Locally noisy autonomous agents improve global human coordination in network experiments”. Nature. 545 (7654): 370-374. Bibcode:2017Natur.545..370S. doi:10.1038/nature22332. PMC 5912653. PMID 28516927.
Sholtz, Paul. “Transaction Costs and the Social Costs of Online Privacy”. In: First Monday 6.5 (May 2001). firstmonday.org/issues/issue6_5/sholtz/index.html.
Shrestha, Bikram, Malka N. Halgamuge, and Horst Treiblmaier. “Using Blockchain for Online Multimedia Management: Characteristics of Existing Platforms.” In Blockchain and Distributed Ledger Technology Use Cases, pp. 289-303. Springer, Cham, 2020.
Simmel, Georg (1908). Soziologie, Leipzig: Duncker & Humblot.
Simpson, Jack. 40% of publishers describe their digital ad revenue as shrinking or static. Tech. rep. Econsultancy, October 2015. econsultancy.com/blog/67028-40-of-publishers-describe-their-digital-ad-revenue-asshrinking-or-static/.
Song, W., C. Shi, Z. Xiao, Z. Duan, Y. Xu, M. Zhang, and J. Tang, “AutoInt: Automatic feature interaction learning via self-attentive neural networks,” in Proc. 28th ACM Int. Conf. Inf. Knowl. Manage., November 2019, pp. 1161-1170.
Stallone, Valerio, Martin Wetzels, and Michael Klaas. “Applications of Blockchain Technology in marketing systematic review of marketing technology companies.” Blockchain: Research and Applications (2021): 100023.
Steffes, E. M., & Burgee, L. E. (2009). Social ties and online word of mouth. Internet Research, 19(1), 42-59.
Sterne, J. (2010). Social media metrics: How to measure and optimize your marketing investment. Hoboken, NJ: John Wiley & Sons.
Stets, J. E., & Burke, P. J. (2000). Identity theory and social identity theory. Social Psychology Quarterly, 63(3), 224-237.
Strogatz, Steven H. (2001). “Exploring complex networks”. Nature. 410 (6825): 268-276. Bibcode:2001Natur.410..268S. doi:10.1038/35065725. PMID 11258382.
Summers, Matt. “Facebook isn't free: zero-price companies overcharge consumers with data.” Behavioural Public Policy (2020): 1-25.
Sundaram, D., Kaushik, M., & Webster, C. (1998). Word of mouth communications: A motivational analysis. Advances in Consumer Research, 25(1), 527-531.
Swan, M., Blockchain: Blueprint for a New Economy. Newton, MA, USA: O'Reilly Media, 2015, pp. 107-123.
Szabo, Nick. “Bit Gold proposal.” Decentralized Business Review (2008): 21449.
Szabo, Nick. “Formalizing and securing relationships on public networks.” First monday (1997).
Szabo, Nick. “Smart contracts glossary.” Phonetic Sciences, Amsterdam (1995).
Szabo, Nick. “The idea of smart contracts.” Nick Szabo's papers and concise tutorials 6, no. 1 (1997): 199.
Tangney, J. P., Miller, R. S., Flicker, L., & Barlow, D. H. (1996). Are shame, guilt, and embarrassment distinct emotions? Journal of Personality and Social Psychology, 70(6), 1256-1269.
Thakkar P, Nathan S, Viswanathan B (2018) Performance benchmarking and optimizing hyperledger fabric blockchain platform. In: 2018 IEEE 26th international symposium on modeling, analysis, and simulation of computer and telecommunication systems (MASCOTS). IEEE, pp 264-276
Thakur, Subhasis, and John G. Breslin. “Decentralized Content Vetting in Social Network with Blockchain.” Wireless Blockchain: Principles, Technologies and Applications (2021): 269-296.
Tilly, Charles, ed. An Urban World. Boston: Little Brown, 1974.
Tiwari, Trishita, David Starobinski, and Ari Trachtenberg. “Distributed web mining of ethereum.” In International Symposium on Cyber Security Cryptography and Machine Learning, pp. 38-54. Springer, Cham, 2018.
Token, Basic Attention. “Blockchain Based Digital Advertising.” Whitepaper (13 March, 2018) basicattentiontoken.org/BasicAttentionTokenWhitePaper-4. Pdf
Tonin, M., & Vlassopoulos, M. (2013). Experimental evidence of self-image concerns as motivation for giving. Journal of Economic Behavior & Organization, 90(6), 19-27.
Tönnies, Ferdinand (1887). Gemeinschaft und Gesellschaft, Leipzig: Fues's Verlag. (Translated, 1957 by Charles Price Loomis as Community and Society, East Lansing: Michigan State University Press.)
Trusov, M., Bodapati, A. V., & Bucklin, R. E. (2010). Determining influential users in internet social networks. Journal of Marketing Research, 47(4), 643-658.
Tsai, W. H. S., & Men, L. R. (2017). Social CEOs: The effects of CEOs' communication styles and parasocial interaction on social networking sites. New Media & Society, 19, 18481867.
Tsiotsou, R. H. (2015). The role of social and parasocial relationships on social networking sites loyalty. Computers in Human Behavior, 48, 401-414.
Tucker, Catherine E. “The economics of advertising and privacy.” International journal of Industrial organization 30, no. 3 (2012): 326-329.
Tuk, M. A., Verlegh, P. W. J., Smidts, A., & Wigboldus, D. H. J. (2009). Interpersonal relationships moderate the effect of faces on person judgments. European Journal of Social Psychology, 39(5), 757-767.
Tukachinsky, R. (2010). Para-romantic love and para-friendships: Development and assessment of a Multiple Parasocial Relationships Scale. American Journal ofMedia Psychology, 3, 73-94.
Tuttle, Hillary. “The Rise of Malvertising”. In: Risk Management Monitor (August 2015). www.riskmanagementmonitor.com/the-rise-of-malvertising/.
Ullah, Imdad, Salil S. Kanhere, and Roksana Boreli. “Privacy-preserving targeted mobile advertising: A blockchain-based framework for mobile ads.” arXiv preprint arXiv:2008.10479 (2020).
Van den Bulte, Christophe, Emanuel Bayer, Bernd Skiera, and Philipp Schmitt. “How customer referral programs turn social capital into economic capital.” Journal of Marketing Research 55, no. 1 (2018): 132-146.
Vasin, P., Blackcoins proof-of-stake protocol v2, 2014.
Vaswani, A., N. Shazeer, N. Parmar, J. Uszkoreit, L. Jones, A. N. Gomez, Kaiser, and I. Polosukhin, “Attention is all you need,” in Proc. Adv. Neural Inf. Process. Syst., 2017, pp. 5998-6008.
Verbeke, W., Martens, D., & Baesens, B. (2014). Social network analysis for customer churn prediction. Applied Soft Computing, 14, 431-446.
Verbraken, T., Goethals, F., Verbeke, W., & Baesens, B. (2014). Predicting online channel acceptance with social network data. Decision Support Systems, 63, 104-114.
Verlegh, P. W. J., Ryu, G., Tuk, M. A., & Feick, L. (2013). Receiver responses to rewarded referrals: The motive inferences framework. Journal of the Academy of Marketing Science, 41(6), 669-682.
Vigliotti, Maria G. “What Do We Mean by Smart Contracts? Open Challenges in Smart Contracts.” Frontiers in Blockchain 3 (2021): 45.
Vikander, Nick E. “Targeted advertising and social status.” (2010).
Villanueva, J., Yoo, S., & Hassens, D. (2008). The impact of marketing-induced versus word-of-mouth customer acquisition on customer equity growth. Journal of Marketing Research, 45, 48-59.
Vohs, K. D., Mead, N. L., & Goode, M. R. (2006). The psychological consequences of money. Science, 314(5802), 1154-1156.
Wallsten, K. (2010). “Yes we can”: How online viewership, blog discussion, campaign statements, and mainstream media coverage produced a viral video phenomenon. Journal of Information Technology & Politics, 7, 163-181.
Walster, E., Berscheid, E., & Walster, G. W. (1976). New directions in equity research. Journal of Personality and Social Psychology, 25(2), 151-176.
Wang, Hua & Barry Wellman (2010). “Social Connectivity in America: Changes in Adult Friendship Network Size from 2002 to 2007”. American Behavioral Scientist. 53 (8): 1148-1169. doi:10.1177/0002764209356247. S2CID 144525876.
Wang, J. C., & Chang, C. H. (2013). How online social ties and product-related risks influence purchase intentions: A facebook experiment. Electronic Commerce Research and Applications, 12(5), 337-346.
Wang, K.-H., C.-M. Chen, W. Fang, and T.-Y. Wu, “On the security of a new ultra-lightweight authentication protocol in IoT environment for RFID tags,” J. Supercomput., vol. 74, no. 1, pp. 65-70, 2018.
Wang, Q., Mao, Y., Zhu, J. et al. Receiver responses to referral reward programs in social networks. Electron Commer Res 18, 563-585 (2018). doi.org/10.1007/s10660-017-9271-x
Wang, Qi, Yunxia Mao, Ji Zhu, and Xiaohang Zhang. “Receiver responses to referral reward programs in social networks.” Electronic Commerce Research 18, no. 3 (2018): 563-585.
Wang, Y. L., B. Yin, and K. Gu, “Resource transaction framework based on block chain in social community,” in Proc. 15th IEEE Int. Conf. Ubiquitous Intell. Comput. (UIC), October 2018, pp. 1265-1270.
Wang, Y., Cong, G., Song, G., & Xie, K. (2010). Community-based greedy algorithm for mining top-k influential nodes in mobile social networks. In Proceedings of the 16th ACM SIGKDD international conference on Knowledge discovery and data mining (pp. 1039-1048).
Wasserman, Stanley; Faust, Katherine (1994). “Social Network Analysis in the Social and Behavioral Sciences”. Social Network Analysis: Methods and Applications. Cambridge University Press. pp. 1-27. ISBN 9780521387071.
Watanabe, H., S. Fujimura, A. Nakadaira, Y. Miyazaki, A. Akutsu, and
Watts, D. J., & Dodds, P. S. (2007). Influentials, networks, and public opinion formation. Journal of Consumer Research, 34, 441-458.
Wei, Wei; Joseph, Kenneth; Liu, Huan; Carley, Kathleen M. (2016). “Exploring Characteristics of Suspended Users and Network Stability on Twitter”. Social Network Analysis and Mining. 6: 51. doi:10.1007/si3278-016-0358-5. S2CID 18520393.
Wellman, Barry (1988). “Structural analysis: From method and metaphor to theory and substance”. pp. 19-61 in B. Wellman and S. D. Berkowitz (eds.) Social Structures: A Network Approach, Cambridge, UK: Cambridge University Press.
Wellman, Barry (2008). “Review: The development of social network analysis: A study in the sociology of science”. Contemporary Sociology. 37 (3): 221-222. doi:10.1177/009430610803700308. S2CID 140433919.
Wellman, Barry; Berkowitz, S. D. (1988). Social Structures: A Network Approach. Structural Analysis in the Social Sciences. Cambridge University Press. ISBN 978-0-521-24441-1.
Wells, W., Moriarty, S., & Burnett, J. (2000). Advertising Principles and Practice. Upper Saddle River, NJ: Prentice Hall.
Wentzel, D., Tomczak, T., & Henkel, S. (2014). Can friends also become customers? The impact of employee referral programs on referral likelihood. Journal of Service Research, 17(2), 119-133.
Widyantoro, D. H., T. R. Ioerger, and J. Yen, “Learning user interest dynamics with a three-descriptor representation,” J. Amer. Soc. Inf. Sci. Technol., vol. 52, no. 3, pp. 212-225, 2001.
Wikipedia. AIDA (marketing). en.wikipedia.org/wiki/AIDA_(marketing).
Williamson, G. M., & Clark, M. S. (1992). Impact of desired relationship type on affective reactions to choosing and being required to help. Personality and Social Psychology Bulletin, 18(1), 10-18.
Wiratama, Jeremy Iron, and Lamhot Henry Pasaribu. “The Effect Of Application Of Blockchain Technology On Digital Marketing.” Enrichment: Journal of Management 12, no. 1 (2021): 801-807.
Wirtz, J., Orsingher, C., Chew, P., & Tambyah, S. K. (2013). The role of metaperception on the effectiveness of referral reward programs. Journal of Service Research, 16(1), 82-98.
Wolfson, O., and D. Ayala, “A framework on spatio-temporal resource search,” in Proc. Int. Wireless Commun. Mobile Comput. Conf., August 2015, pp. 1043-1048.
Wood G (2014) Ethereum: a secure decentralised generalised transaction ledger. Ethereum Project Yellow Paper 151:1-32
Wood, G.: Polkadot: vision for a heterogeneous multi-chain framework (draft 1). Technical report, Founder, Ethereum & Parity (2016)
Wu, D., J. Wang, R. Q. Hu, Y. Cai, and L. Zhou, “Energy-Efficient Resource Sharing for Mobile Device-to-Device Multimedia Communications,” IEEE Trans. Veh. Technol., vol. 63, no. 5, pp. 2093-2103, July 2014.
Wu, Tim. “Blind spot: The attention economy and the law.” Antitrust LJ 82 (2018): 771.
Xia, Q. I., E. B. Sifah, K. O. Asamoah, J. Gao, X. Du, and M. Guizani, “MeDShare: Trust-less medical data sharing among cloud service providers via blockchain,” IEEE Access, vol. 5, pp. 14757-14767, 2017.
Xia, Q., E. B. Sifah, A. Smahi, S. Amofa, and X. Zhang, “BBDS: Blockchain-based data sharing for electronic medical records in cloud environments,” Information, vol. 8, no. 2, p. 44, 2017.
Xiao, Z., L. Yang, W. Jiang, Y. Wei, Y. Hu, and H. Wang, “Deep multi-interest network for click-through rate prediction,” in Proc. 29th ACM Int. Conf. Inf. Knowl. Manage., October 2020, pp. 2265-2268.
Xiao, Zhixing; Tsui, Anne (2007). “When Brokers May Not Work: The Cultural Contingency of Social Capital in Chinese High-tech Firms”. Administrative Science Quarterly.
Xing, C. F., Y. Liu, and M. Yang, “A efficient resource search mechanic for unstructured peer-to-peer networks,” (In Chinese), Comput. Knowl. Technol., vol. 11, no. 17, pp. 229-230, June 2015.
Xu, F., Michael, K., & Chen, X. (2013). Factors affecting privacy disclosure on social network sites: An integrated model. Electronic Commerce Research, 13(2), 151-168.
Xu, Quanqing, Zhiwen Song, Rick Siow Mong Goh, and Yongjun Li. “Building an ethereum and ipfs-based decentralized social network system.” In 2018 IEEE 24th international conference on parallel and distributed systems (ICPADS), pp. 1-6. IEEE, 2018.
Yahiatene, Youcef, and Abderrezak Rachedi. “Towards a blockchain and software-defined vehicular networks approaches to secure vehicular social network.” In 2018 IEEE Conference on Standards for Communications and Networking (CSCN), pp. 1-7. IEEE, 2018.
Yang W, Garg S, Raza A, Herbert D, Kang B (2018) Blockchain: trends and future. In: Yoshida K, Lee M (eds) Knowledge management and acquisition for intelligent systems. Springer International Publishing, Cham, pp 201-210
Yang X, Yi X, Nepal S, Han F (2018) Decentralized voting: a self-tallying voting system using a smart contract on the ethereum blockchain. In: Hacid H, Cellary W, Wang H, Paik H Y, Zhou R (eds) Web information systems engineering-WISE 2018. Springer International Publishing, Cham, pp 18-35
Yang, Fan, Yanan Qiao, Shan Wang, Cheng Huang, and Xiao Wang. “Blockchain and multi-agent system for meme discovery and prediction in social network.” Knowledge-Based Systems 229 (2021): 107368.
Yang, Feihong, Ying Wang, Chunlei Fu, Chunqiang Hu, and Arwa Alrawais. “An efficient blockchain-based bidirectional friends matching scheme in social networks.” IEEE Access 8 (2020): 150902-150913.
Yang, W., Garg, S., Raza, A., Herbert, D., Kang, B.: Blockchain: trends and future. In: Yoshida, K., Lee, M. (eds.) PKAW 2018. LNCS (LNAI), vol. 11016, pp. 201-210. Springer, Cham (2018). doi.org/10.1007/978-3-319-97289-315
Yang, X., Yi, X., Nepal, S., Han, F.: Decentralized voting: a self-tallying voting system using a smart contract on the ethereum blockchain. In: Hacid, H., Cellary, W., Wang, H., Paik, H.-Y., Zhou, R. (eds.) WISE 2018. LNCS, vol. 11233, pp. 18-35. Springer, Cham (2018). doi.org/10.1007/978-3-030-02922-7 2
Yep, J., Brown, M., Fagliarone, G., & Shulman, J. (2017). Influential players in Twitter networks of libraries at primarily undergraduate institutions. The Journal of Academic Librarianship, 43, 193-200.
YouExec. Google & Facebook ad traffic is 90% useless. January 2017. youexec.com/dev/2017/1/14/google-facebook-ads-traffic-is-useless.
Youssef J R, Zacharewicz G, Chen D (2016) Developing an enterprise operating system (eos)—requirements and architecture. In: 2016 IEEE 25th international conference on enabling technologies: infrastructure for collaborative enterprises (WETICE). IEEE, pp 130-135
Yu, S., Wang, G., Liu, X., Niu, J.: Security and privacy in the age of the smart internet of things: an overview from a networking perspective. IEEE Commun. Mag. 56(9), 14-18 (2018)
Yuan Y., and F.-Y. Wang, “Towards blockchain-based intelligent transportation systems,” in Proc. IEEE 19th Int. Conf. Intell. Transp. Syst. (ITSC), November 2016, pp. 2663-2668.
Zahnentferner J (2018) Chimeric ledgers: translating and unifying utxo-based and account-based cryptocurrencies. IACR Cryptology ePrint Archive 2018:262 Zhang Y, Xu C, Cheng N, Li H, Yang H, Shen X (2020) Chronos++: an accurate blockchain-based time-stamping scheme for cloud storage. IEEE Trans Serv Comput 13(2):216-229
Zhang Y, Xu C, Ni J, Li H, Shen X Blockchain-assisted public-key encryption with keyword search against keyword guessing attacks for cloud storage. IEEE Trans Cloud Comput 1-1 (accepted 2019, to appear). doi.org/10.1109/TCC.2019.2923222
Zhang, H., J. Yan, and Y. Zhang, “CTR prediction models considering the dynamics of user interest,” IEEE Access, vol. 8, pp. 72847-72858, 2020.
Zhang, R., X. Cheng, L. Yang, and B. Jiao, “Interference-aware graph based resource sharing for device-to-device communications underlaying cellular networks,” in Proc. IEEE Wireless Commun. Netw. Conf., April 2013, pp. 140-145.
Zhang, S., J. Han, and F. Jiang, “An object encapsulation approach for P2P resource sharing platform,” in Proc. Int. Conf. Inf. Technol. Softw. Eng. Berlin, Germany: Springer, 2013, pp. 265-273.
Zhang, Shiwen, Tingting Yao, Voundi Koe Arthur Sandor, Tien-Hsiung Weng, Wei Liang, and Jinshu Su. “A novel blockchain-based privacy-preserving framework for online social networks.” Connection Science 33, no. 3 (2021): 555-575.
Zhang, W., T. Du, and J. Wang, “Deep learning over multi-field categorical data,” in Proc. Eur. Conf. Inf. Retr. Cham, Switzerland: Springer, 2016, pp. 45-57.
Zhao W, Wang D (2010) Study on internet advertising placement problem. In: 2010 International conference on logistics systems and intelligent management (ICLSIM), vol 3, pp 1798-1801. doi.org/10.1109/ICLSIM.2010.5461317
Zhao, Q., M. A. Erdogdu, H. Y. He, A. Rajaraman, and J. Leskovec, “Seismic: A self-exciting point process model for predicting tweet popularity,” in Proc. 21th ACM SIGKDD Int. Conf. Knowl. Discovery Data Mining, 2015, pp. 1513-1522.
Zhao, X., Lynch, J. G., & Chen, Q. (2010). Reconsidering baron and kenny: Myths and truths about mediation analysis. Journal of Consumer Research, 37(2), 197-206.
Zhao, Yan, Sheng Bin, and Gengxin Sun. “Research on Information Propagation Model in Social Network Based on BlockChain.” Discrete Dynamics in Nature and Society 2022 (2022).
Zheng Q, Li Y, Chen P, Dong X (2018) An innovative ipfs-based storage model for blockchain. In: 2018 IEEE/WIC/ACM international conference on web intelligence (WI). IEEE, pp 704-708
Zheng Z, Xie S, Dai H, Chen X, Wang H (2017) An overview of blockchain technology: architecture, consensus, and future trends. In: 2017 IEEE International congress on big data (BigData Congress), pp 557-564. doi.org/10.1109/BigData Congress.2017.85
Zheng, Zibin, Shaoan Xie, Hong-Ning Dai, Weili Chen, Xiangping Chen, Jian Weng, and Muhammad Imran. “An overview on smart contracts: Challenges, advances and platforms.” Future Generation Computer Systems 105 (2020): 475-491.
Zhou, G., N. Mou, Y. Fan, Q. Pi, W. Bian, C. Zhou, X. Zhu, and K. Gai, “Deep interest evolution network for click-through rate prediction,” in Proc. AAAI Conf. Artif. Intell., vol. 33, 2019, pp. 5941-5948.
Zhou, Guorui, Xiaoqiang Zhu, Chenru Song, Ying Fan, Han Zhu, Xiao Ma, Yanghui Yan, Junqi Jin, Han Li, and Kun Gai. “Deep interest network for click-through rate prediction.” In Proceedings of the 24th ACM SIGKDD international conference on knowledge discovery & data mining, pp. 1059-1068. 2018.
Zhou, H., M. Huang, Y. Mao, C. Zhu, P. Shu, and X. Zhu, “Domain-constrained advertising keyword generation,” in Proc. World Wide Web Conf., 2019, pp. 2448-2459.
Zhu, Y., R. Guo, G. Gan, and W.-W. Tsai, “Interactive incontestable signature for transactions confirmation in bitcoin blockchain,” in Proc. IEEE 40th Annu. Comput. Softw. Appl. Conf., June 2016, pp. 443-448.
Zhu, M., and X. Liu, “Study on internet finance credit information sharing based on block chain technology,” Asian Social Sci., vol. 14, no. 2, p. 81, September 2018.
Zyskind, G., O. Nathan, and A. Pentland, “Decentralizing privacy: Using blockchain to protect personal data,” in Proc. IEEE Secur. Privacy Workshops, May 2015, pp. 180-184.

8. Digital Rights Management and Compensation of Content Providers

5,999,919; 5,930,777; 5,857,023; 5,815,657; 5,793,868; 5,717,757; 5,666,416; 5,677,955; 5,839,119; 5,915,093; 5,937,394; 5,933,498; 5,903,880; 5,903,651; 5,884,277; 5,960,083; 5,963,924; 5,996,076; 6,016,484; 6,018,724; 6,021,202; 6,035,402; 6,049,786; 6,049,787; 6,058,381; 6,061,448; 5,987,132; 6,057,872; 6,061,665; 4,977,595; 5,224,162; 5,237,159; 5,392,353; 5,511,121; 5,621,201; 5,623,547; 5,679,940; 5,696,908; 5,754,939; 5,768,385; 5,799,087; 5,812,668; 5,828,840; 5,832,089; 5,850,446; 5,889,862; 5,889,863; 5,898,154; 5,901,229; 5,920,629; 5,926,548; 5,943,424; 5,949,045; 5,952,638; 5,963,648; 5,978,840; 5,983,208; 5,987,140; 6,002,767; 6,003,765; 6,021,399; 6,026,379; 6,029,150; 6,029,151; 6,047,067; 6,047,887; 6,055,508; 6,065,675; 6,072,870; 5812668; 5815657; 5850446; 5889863; 5931917; 5943424; 5963924; 5978840; 5983208; 5987132; 5996076; 6002767; 6016484; 6021202; 6026379; 6029150; 6055508; 6072870; 6112181; 6119105; 6138107; 6157920; 6163772; 6178409; 6209095; 6226743; 6236981; 6253027; 6260024; 6263436; 6278783; 6298442; 6304915; 6324525; 6327661; 6341273; 6349288; 6363363; 6373950; 6385596; 6473794; 6487658; 6510518; 6519571; 6536037; 6539092; 6606744; 6609200; 6615166; 6619544; 6654884; 6658568; 6671818; 6681017; 6721713; 6836765; 6839691; 6842741; 6850252; 6868403; 6868525; 6938021; 6957186; 6973445; 7010512; 7013296; 7020638; 7050993; 7079649; 7080041; 7092914; 7093130; 7110983; 7124101; 7127236; 7130807; 7133846; 7140039; 7143066; 7149698; 7152047; 7159116; 7165041; 7165174; 7171559; 7177429; 7177838; 7181017; 7181438; 7206769; 7206941; 7210620; 7228424; 7233926; 7237125; 7240024; 7249099; 7263497; 7266692; 7269735; 7272855; 7287275; 7315826; 7315941; 7328189; 7337315; 7356696; 7366701; 7376621; 7389273; 7412605; 7415617; 7441015; 7478120; 7494055; 7496540; 7509685; 7530020; 7530102; 7532725; 7562304; 7568234; 7574659; 7580898; 7584153; 7587044; 7587368; 7590589; 7596530; 7599488; 7599844; 7603319; 7606741; 7620606; 7634083; 7639156; 7660863; 7668310; 7685420; 7689518; 7702624; 7716077; 7739168; 7743252; 7743259; 7747523; 7747857; 7765481; 7783579; 7787620; 7801896; 7805377; 7812738; 7813506; 7813822; 7814314; 7822620; 7827401; 7848521; 7869591; 7904517; 7913095; 7917454; 7941666; 7957991; 7974714; 8006086; 8024562; 8032409; 8060426; 8073910; 8104079; 8121874; 8144619; 8156327; 8185473; 8190528; 8200775; 8209531; 8224705; 8225414; 8229859; 8240557; 8261094; 8265278; 8271336; 8296664; 8316237; 8321791; 8327141; 8335745; 8370362; 8380630; 8386800; 8392306; 8429545; 8438499; 8473746; 8489483; 8489900; 8498941; 8516377; 8527406; 8538011; 8539235; 8555079; 8555408; 8560366; 8566247; 8566726; 8590056; 8596528; 8600830; 8600895; 8619287; 8620760; 8639629; 8656180; 8660355; 8667518; 8683564; 8683602; 8706570; 8707052; 8713418; 8713661; 8724808; 8732023; 8751793; 8751829; 8752153; 8767962; 8768838; 8769304; 8781131; 8798268; 8826019; 8826154; 8826155; 8832852; 8839391; 8874477; 8874504; 8879724; 8886932; 8893238; 8903737; 8904181; 8914906; 8915780; 8924741; 8929877; 8972719; 8977864; 8983874; 9002018; 9070151; 9137048; 9137258; 9177169; 9197736; 9256806; 9258116; 9298904; 9311670; 9336366; 9361606; 9367693; 9379559; 9384345; 9396468; 9405984; 9419790; 9419951; 9471906; 9495668; 9495673; 9539501; 9547957; 9558622; 9569616; 9569623; 9571289; 9576133; 9600674; 9615264; 9639717; 9666023; 9680846; 9720555; 9721425; 9755822; 9756549; 9760938; 9794797; 9799060; 9811728; 9818109; 9818136; 9830600; 9843445; 9849364; 9852572; 9853964; 9922345; 9940463; 9940772; 9948654; 9955286; 9959383; 9959429; 9972013; 10013705; 10015720; 10022613; 10046228; 10068220; 10110379; 10148428; 10163137; 10195513; 10198141; 10223685; 10225721; 10245968; 10262141; 10311255; 10336205; 10339523; 10361802; 10368222; 10375037; 10395515; 10418856; 10423807; 10438251; 10445730; 10445800; 10462153; 10498827; 10504179; 10511580; 10516662; 10521623; 10521973; 10531436; 10532268; 10554407; 10567975; 10581613; 10586219; 10594034; 10594484; 10594645; 10601836; 10602424; 10615979; 10642752; 10643266; 10644884; 10657725; 10673617; 10682967; 10686591; 10692085; 10708070; 10708071; 10726401; 10735437; 10771524; 10785365; 10789590; 10791354; 10805175; 10811771; 10839411; 10853592; 10861112; 10866709; 10868865; 10902156; 10911239; 10916845; 10932156; 10938896; 10938950; 10943273; 10951675; 10956878; 10959099; 10970780; 10972448; 10979467; 10984403; 10997251; 11005290; 11025784; 11030326; 11040672; 11042719; 11057819; 11074349; 11075891; 11080777; 11082344; 11088827; 11089051; 11094122; 11102303; 11108627; 11122546; 11128528; 11128636; 11130042; 11134366; 11144911; 11145134; 11151229;11153358; 11159909; 11176226; 11182787; 11188886; 11188977; 11189368; 11196573; 11200545; 11200564; 11201756; 11207584; 11232414; 11245528; 11245653; 11256823; 11269426; 11272400; 11290324; 11296935; 11296937; 11321282; 11323544; 11334388; 11336011; 11343215; 11355931; 11356243; 11366531; 11367072; RE44222; RE44307; 20010018739; 20010021927; 20010032878; 20010034719; 20010034831; 20010037311; 20010042043; 20010053220; 20010054001; 20020002538; 20020010679; 20020010684; 20020046182; 20020046193; 20020069130; 20020071556; 20020073049; 20020107808; 20020108050; 20020111907; 20020124178; 20020156696; 20020161476; 20020175207; 20020184159; 20030040917; 20030046244; 20030055735; 20030061605; 20030069748; 20030069749; 20030097331; 20030135473; 20030140007; 20030140240; 20030167204; 20030177400; 20030182579; 20030188158; 20030195856; 20030196091; 20030196092; 20030196093; 20030196109; 20030196119; 20030196120; 20030196121; 20030200439; 20030200468; 20030204753; 20030221101; 20040029569; 20040030904; 20040030925; 20040034597; 20040054624; 20040064351; 20040068659; 20040093273; 20040107125; 20040111380; 20040117320; 20040123129; 20040148523; 20040199475; 20040243477; 20050038756; 20050042983; 20050044016; 20050060584; 20050070257; 20050071280; 20050131811; 20050165766; 20050171847; 20050171903; 20050171904; 20050192912; 20050261995; 20050278787; 20050278793; 20060000900; 20060026140; 20060031338; 20060041484; 20060045264; 20060056402; 20060059333; 20060061806; 20060098900; 20060116960; 20060137006; 20060144925; 20060167784; 20060168237; 20060173985; 20060178918; 20060200392; 20060200523; 20060200530; 20060200531; 20060206397; 20060212370; 20060218651; 20060224470; 20060242075; 20060242699; 20060248016; 20060248334; 20060253458; 20060253578; 20060253579; 20060253580; 20060253581; 20060253582; 20060253583; 20060253584; 20060277122; 20060287964; 20060288023; 20070005499; 20070005702; 20070011140; 20070016533; 20070028113; 20070053513; 20070074036; 20070087756; 20070100754; 20070110240; 20070136211; 20070156677; 20070168266; 20070168297; 20070179883; 20070185813; 20070192252; 20070208671; 20070214030; 20070241183; 20070276759; 20070283396; 20070290877; 20080005086; 20080005571; 20080005572; 20080016000; 20080021832; 20080021835; 20080022146; 20080034228; 20080049940; 20080059826; 20080091619; 20080103805; 20080107264; 20080109240; 20080109242; 20080109473; 20080114709; 20080120240; 20080133415; 20080141117; 20080147506; 20080163338; 20080165701; 20080201264; 20080262893; 20080262969; 20080306872; 20080313075; 20090006262; 20090106119; 20090108064; 20090117883; 20090119698; 20090132813; 20090157735; 20090158413; 20090164380; 20090164381; 20090187507; 20090187764; 20090190754; 20090193260; 20090198619; 20090210711; 20090259843; 20090265547; 20090265548; 20090287837; 20090287924; 20090288012; 20090292619; 20100042931; 20100091982; 20100114739; 20100153230; 20100153714; 20100174652; 20100174904; 20100182631; 20100185538; 20100199089; 20100217691; 20100217994; 20100223184; 20100228683; 20100235285; 20100241569; 20100241595; 20100257102; 20100280946; 20100280948; 20100287370; 20100312692; 20100312768; 20100317420; 20100318797; 20100332583; 20110001631; 20110004513; 20110022940; 20110026709; 20110040967; 20110041158; 20110047054; 20110047077; 20110047078; 20110047389; 20110113248; 20110138192; 20110145049; 20110145102; 20110154215; 20110161076; 20110173701; 20110178884; 20110197064; 20110213980; 20110238542; 20110244919; 20110246333; 20110251868; 20110255696; 20110280406; 20110295722; 20120017089; 20120059761; 20120066402; 20120066517; 20120066752; 20120066756; 20120066757; 20120089410; 20120095911; 20120185942; 20120190386; 20120191513; 20120204032; 20120239566; 20120253974; 20120259722; 20120260353; 20120278241; 20120300928; 20120311705; 20120323717; 20120323786; 20120324242; 20130013509; 20130014020; 20130015241; 20130030938; 20130042110; 20130054417; 20130054471; 20130061055; 20130080307; 20130091452; 20130145148; 20130145172; 20130145173; 20130159021; 20130173928; 20130179337; 20130185198; 20130191899; 20130195270; 20130198037; 20130198083; 20130202185; 20130204471; 20130204777; 20130208893; 20130212704; 20130246787; 20130260856; 20130275311; 20130276140; 20130311348; 20130340100; 20140040343; 20140081793; 20140081872; 20140106840; 20140141861; 20140141862; 20140141866; 20140143216; 20140164251; 20140173749; 20140189368; 20140201014; 20140222610; 20140222684; 20140236758; 20140237342; 20140241524; 20140247944; 20140279324; 20140279551; 20140281573; 20140323142; 20140331119; 20140337733; 20140380408; 20150006403; 20150026062; 20150026162; 20150040199; 20150052005; 20150052046; 20150052053; 20150052368; 20150058214; 20150074830; 20150088721; 20150088754; 20150111591; 20150111630; 20150112858; 20150154579; 20150169904; 20150188949; 20150193744; 20150193770; 20150195082; 20150222656; 20150264626; 20150264627; 20150269617; 20150278604; 20150278820; 20150280907; 20150288524; 20150310426; 20150324181; 20150365369; 20150371548; 20150379510; 20160012465; 20160019749; 20160026826; 20160034282; 20160048684; 20160149701; 20160164879; 20160164890; 20160189118; 20160203448; 20160224951; 20160250941; 20160250943; 20160267478; 20160283923; 20160285861; 20160292672; 20160294960; 20160342983; 20160342984; 20160342985; 20160342986; 20160342987; 20160342988; 20160373250; 20170011365; 20170017936; 20170017954; 20170017955; 20170039556; 20170046290; 20170046669; 20170046689; 20170048209; 20170048234; 20170048235; 20170076275; 20170083907; 20170085545; 20170085555; 20170091756; 20170099134; 20170109735; 20170132588; 20170132619; 20170132620; 20170132621; 20170140219; 20170154193; 20170177874; 20170178417; 20170180136; 20170187729; 20170193575; 20170206512; 20170213198; 20170213289; 20170221052; 20170228731; 20170232300; 20170243205; 20170249607; 20170249623; 20170286955; 20170289341; 20170293848; 20170294206; 20170324711; 20170344983; 20170358041; 20170364908; 20170366347; 20180004957; 20180014241; 20180049043; 20180068358; 20180078843; 20180096203; 20180096412; 20180096551; 20180097883; 20180117446; 20180117447; 20180122006; 20180124043; 20180138748; 20180158052; 20180165781; 20180173906; 20180176017; 20180181964; 20180186309; 20180189781; 20180191503; 20180211065; 20180211718; 20180216946; 20180264347; 20180270638; 20180276626; 20180285863; 20180326291; 20180337769; 20180337847; 20180343126; 20180359096; 20190011283; 20190020629; 20190028272; 20190034350; 20190034939; 20190037012; 20190043341; 20190044738; 20190057372; 20190089716; 20190095879; 20190098432; 20190098555; 20190108505; 20190122443; 20190139037; 20190139314; 20190141045; 20190147432; 20190149429; 20190149633; 20190158594; 20190171849; 20190182032; 20190188657; 20190190742; 20190190987; 20190208442; 20190215404; 20190230070; 20190244298; 20190295045; 20190303807; 20190306137; 20190317651; 20190318427; 20190327102; 20190333054; 20190335294; 20190347426; 20190349190; 20190349254; 20190349261; 20190349426; 20190349733; 20190355053; 20190358515; 20190361917; 20190362104; 20190377879; 20190385256; 20190386832; 20190393722; 20200007918; 20200014529; 20200021446; 20200028360; 20200034902; 20200042989; 20200045019; 20200058023; 20200059826; 20200068022; 20200073560; 20200077942; 20200082139; 20200100218; 20200101367; 20200110907; 20200117690; 20200119921; 20200119926; 20200126070; 20200145387; 20200162264; 20200169859; 20200187018; 20200202376; 20200202414; 20200202467; 20200219094; 20200227160; 20200245147; 20200252408; 20200269776; 20200279249; 20200279256; 20200287834; 20200313892; 20200334229; 20200349536; 20200356962; 20200358183; 20200358184; 20200364187; 20200364647; 20200366489; 20200382276; 20200382480; 20200387611; 20200387896; 20200396196; 20210035098; 20210037076; 20210042747; 20210042830; 20210044642; 20210073212; 20210078571; 20210084105; 20210090185; 20210110374; 20210110612; 20210112154; 20210126826; 20210151884; 20210160343; 20210182111; 20210192582; 20210209885; 20210227011; 20210233044; 20210243022; 20210256070; 20210266167; 20210266359; 20210303700; 20210319082; 20210319083; 20210319192; 20210342020; 20210350357; 20210357924; 20210358015; 20210365930; 20210367889; 20210373676; 20210374391; 20210390585; 20210399911; 20210400142; 20210400642; 20220004541; 20220006813; 20220011878; 20220023742; 20220027894; 20220040557; 20220046072; 20220058614; 20220083665; 20220084015; 20220084020; 20220105308; 20220108355; 20220114584; 20220114793; 20220116343; 20220147400; 20220156776; 20220168539; 20220176065; 20220182805; 20220201071; WO-1996031965; WO-1996031965; WO-1997041537; WO-1997041540; WO-1997041541; WO-1997043761; WO-1997048034; WO-1997049050; WO-1997049050; WO-1997049052; WO-1997049053; WO-1997049053; WO-1997049054; WO-1997049055; WO-1997049055; WO-1997049069; WO-1997049070; WO-1997049070; WO-1997049072; WO-1997049072; WO-1997049074; WO-1998005011; WO-1998010381; WO-1998013796; WO-1998013797; WO-1998014921; WO-1998022915; WO-1998027688; WO-1998037655; WO-1998037675; WO-1998043211; WO-1998044402; WO-1999010843; WO-1999024928; WO-1999046720; WO-1999048243; WO-1999063696; WO-1999067766; WO-1999067909; WO-1999067919; WO-2000002342; WO-2000014925; WO-2000022561; WO-2000026867; WO-2000028461; WO-2000033271; WO-2000042593; WO-2000055793; WO-2000062265; WO-2000073928; WO-2000073929; WO-2000073929; WO-2000073930; WO-2000073955; WO-2000073955; WO-2000073956; WO-2000073956; WO-2000073957; WO-2000073958; WO-2000073958; WO-2000074300; WO-2001001300; WO-2001001625; WO-2001001625; WO-2001011515; WO-2001015045; WO-2001039028; WO-2001039029; WO-2001039030; WO-2001039082; WO-2001039086; WO-2001043026; WO-2001043094; WO-2001050391; WO-2001055815; WO-2001059727; WO-2001069914; WO-2001082148; WO-2001082242; WO-2001084906; WO-2001086411; WO-2001086881; WO-2001091007; WO-2002005061; WO-2002005152; WO-2002005226; WO-2002007109; WO-2002014973; WO-2002017635; WO-2002050743; WO-2002054196; WO-2002057865; WO-2002057971; WO-2002086830; WO-2002088874; WO-2002097685; WO-2002097685; WO-2003003173; WO-2003034310; WO-2003058391; WO-2004017664; WO-2004066581; WO-2004068296; WO-2005004069; WO-2005027008; WO-2005027035; WO-2005034042; WO-2005072425; WO-2005088568; WO-2005096750; WO-2005096755; WO-2005098601; WO-2005101192; WO-2005106643; WO-2005114526; WO-2006004794; WO-2006026737; WO-2006029297; WO-2006037011; WO-2006066142; WO-2006066143; WO-2006073907; WO-2006094184; WO-2006119479; WO-2006119480; WO-2006119480; WO-2006119481; WO-2006119481; WO-2007016747; WO-2007016869; WO-2007044383; WO-2007082452; WO-2007084409; WO-2007118052; WO-2007137145; WO-2007143687; WO-2008016462; WO-2008046012; WO-2008060299; WO-2008060300; WO-2008157053; WO-2009018683; WO-2009044371; WO-2009059282; WO-2009070430; WO-2009091421; WO-2009100112; WO-2009111799; WO-2009143084; WO-2010028071; WO-2010041164; WO-2010043974; WO-2010052378; WO-2010065056; WO-2010090664; WO-2010102269; WO-2010147559; WO-2011032257; WO-2011053717; WO-2011053718; WO-2011068996; WO-2011089533; WO-2011116309; WO-2011120158; WO-2011137600; WO-2011160584; WO-2012005744; WO-2012078012; WO-2012115341; WO-2012131157; WO-2012144930; WO-2012174427; WO-2013012531; WO-2013019206; WO-2013059794; WO-2013071858; WO-2013085666; WO-2013108119; WO-2013116767; WO-2013117775; WO-2013118081; WO-2013118082; WO-2013118083; WO-2013122869; WO-2013122875; WO-2014057473; WO-2014057474; WO-2014057476; WO-2014057477; WO-2014075000; WO-2014081390; WO-2014083382; WO-2014149251; WO-2015010083; WO-2015036642; WO-2015058282; WO-2015089300; WO-2015103338; WO-2015122850; WO-2015136434; WO-2015139026; WO-2015148725; WO-2015180581; WO-2016001821; WO-2016001867; WO-2016009353; WO-2016025990; WO-2016082678; WO-2016128567; WO-2016128568; WO-2016128569; WO-2016161073; WO-2017011601; WO-2017060816; WO-2017060817; WO-2017132450; WO-2017167399; WO-2017167399; WO-2017190794; WO-2017190795; WO-2017198291; WO-2017220115; WO-2017220165; WO-2017222703; WO-2018000396; WO-2018006945; WO-2018020389; WO-2018026727; WO-2018028766; WO-2018028777; WO-2018046105; WO-2018063666; WO-2018091066; WO-2018091091; WO-2018093492; WO-2018097830; WO-2018099549; WO-2018099920; WO-2018125989; WO-2018126029; WO-2018126065; WO-2018126075; WO-2018126077; WO-2018129358; WO-2018146373; WO-2018157940; WO-2018162789; WO-2018175666; WO-2018177520; WO-2018193341; WO-2018209543; WO-2018211274; WO-2018217804; WO-2018224635; WO-2019010459; WO-2019014337; WO-2019023372; WO-2019036059; WO-2019040539; WO-2019045738; WO-2019049022; WO-2019078601; WO-2019081015; WO-2019092046; WO-2019092508; WO-2019099335; WO-2019100063; WO-2019101420; WO-2019119408; WO-2019125664; WO-2019133819; WO-2019142049; WO-2019142968; WO-2019155331; WO-2019183869; WO-2019186346; WO-2019201319; WO-2019202437; WO-2019204794; WO-2019226099; WO-2019234003; WO-2019243359; WO-2019246249; WO-2020016739; WO-2020028197; WO-2020030390; WO-2020041372; WO-2020051261; WO-2020125839; WO-2020131822; WO-2020132694; WO-2020142000; WO-2020142603; WO-2020150228; WO-2020185707; WO-2020199703; WO-2020231600; WO-2020240290; WO-2020240292; WO-2020240297; WO-2020249554; WO-2021005474; WO-2021022305; WO-2021030288; WO-2021030906; WO-2021050929; WO-2021055515; WO-2021059090; WO-2021059091; WO-2021062293; WO-2021072417; WO-2021144479; WO-2021222908; WO-2021226527; WO-2021229334; WO-2021254703; WO-2021257463; WO-2022030144; WO-2022030204; WO-2022058103; WO-2022060961; WO-2022076036; WO-2022076800; WO-2022098481; WO-2022101023; WO-2022101334; WO-2022103900; WO-2022111807; WO-2022119785; WO-2022122038;
Abdulla, N T Bushra, and K. A. Navas. “High security watermarking techniques for digital rights management: A review.” In 2020 International Conference on Communication and Signal Processing (ICCSP), pp. 162-166. IEEE, 2020.
Ahene, Emmanuel, Zhangchi Qin, Akua Konadu Adusei, and Fagen Li. “Efficient signcryption with proxy re-encryption and its application in smart grid.” IEEE Internet of Things Journal 6, no. 6 (2019): 9722-9737.
Bashir, Faiza, and Nosheen Fatima Warraich. “Prospects of Semantic Web and Blockchain Technologies in Libraries.” In Blockchain and Deep Learning, pp. 31-45. Springer, Cham, 2022.
Bechtold, Stefan. “Digital Rights Management.” E-Merging Media: Communication and the Media Economy of the Future (2004): 331.
Bodó, Balázs, Daniel Gervais, and João Pedro Quintais. “Blockchain and smart contracts: the missing link in copyright licensing?.” International Journal of Law and Information Technology 26, no. 4 (2018): 311-336.
Boneh, D., J. Horwitz, “Generating a product of three primes with an unknown factorization”, Proc. of the third Algorithmic Number Theory Symposium (ANTS), 1998, pp. 237-251;
Cao, Zihang, and Li Zhao. “A Design of Key Distribution Mechanism in Decentralized Digital Rights Management Based on Blockchain and Zero-Knowledge Proof.” In 2021 The 3rd International Conference on Blockchain Technology, pp. 53-59. 2021.
Common Markup for web Micropayment Systems, www.w3.org/TR/WD-Micropayment-Markup (09-June-99).
Computer Forensics: Investigating Network Intrusions and Cybercrime. Cengage Learning. 16 Sep. 2009. pp. 9-26. ISBN 978-1435483521.
Coyle, Karen. “The technology of rights: Digital rights management.” (2003).
Dias Oliva, Thiago. “Content moderation technologies: Applying human rights standards to protect freedom of expression.” Human Rights Law Review 20, no. 4 (2020): 607-640.
Dutta, Priyanka, Willy Susilo, Dung Hoang Duong, Joonsang Baek, and Partha Sarathi Roy. “Identity-based unidirectional proxy re-encryption in standard model: a lattice-based construction.” In International Conference on Information Security Applications, pp. 245-257. Springer, Cham, 2020.
Dutta, Priyanka, Willy Susilo, Dung Hoang Duong, Joonsang Baek, and Partha Sarathi Roy. “Identity-based Unidirectional Proxy Re-Encryption and Re-Signature in Standard Model: Lattice-based Constructions.” J. Internet Serv. Inf. Secur. 10, no. 4 (2020): 1-22.
Dwivedi, Ashutosh Dhar. “A scalable blockchain based digital rights management system.” Cryptology ePrint Archive (2019).
Eberhard Becker, Willms Buhse, Dirk GUnnewig, Niels Rump: Digital Rights Management—Technological, Economic, Legal and Political Aspects. An 800-page compendium from 60 different authors on DRM.
Fan, Qing, Jianhua Chen, Yihong Wen, and Min Luo. “Eland: An Efficient Lightweight Anonymous Authentication Protocol Applied to Digital Rights Management System.” Journal of Internet Technology 23, no. 2 (2022): 267-278.
Fei, Xie. “BDRM: A Blockchain-based Digital Rights Management Platform with Fine-grained Usage Control.” Int. J. Sci 6 (2019): 54-63.
Feigenbaum, Joan, Michael J. Freedman, Tomas Sander, and Adam Shostack. “Privacy engineering for digital rights management systems.” In ACM Workshop on Digital Rights Management, pp. 76-105. Springer, Berlin, Heidelberg, 2001.
Finck, Michele, and Valentina Moscon. “Copyright law on blockchains: between new forms of rights administration and digital rights management 2.0.” IIC-International Review of Intellectual Property and Competition Law 50, no. 1 (2019): 77-108.
Gao, Juntao, Haiyong Yu, Xiuqin Zhu, and Xuelian Li. “Blockchain-Based Digital Rights Management Scheme via Multiauthority Ciphertext-Policy Attribute-Based Encryption and Proxy Re-Encryption.” IEEE Systems Journal 15, no. 4 (2021): 5233-5244.
Garba, Abba, Ashutosh Dhar Dwivedi, Mohsin Kamal, Gautam Srivastava, Muhammad Tariq, M. Anwar Hasan, and Zhong Chen. “A digital rights management system based on a scalable blockchain.” Peer-to-Peer Networking and Applications 14, no. 5 (2021): 2665-2680.
Garba, Abba, Ashutosh Dhar Dwivedi, Mohsin Kamal, Gautam Srivastava, Muhammad Tariq, M. Anwar Hasan, and Zhong Chen. “Correction to: A digital rights management system based on a scalable blockchain.” Peer-to-Peer Netw. Appl. 14, no. 4 (2021): 1869.
Garcia, Roberto, and Rosa Gil. “Social media copyright management using semantic web and blockchain.” In Proceedings of the 21st International Conference on Information Integration and Web-based Applications & Services, pp. 339-343. 2019.
Ge, W. G., and Li Sun. “A security scheme of digital rights management based on agent encryption and key distribution in cloud computing.” International Journal of Security and Networks 13, no. 4 (2018): 228-235.
Geethanjali, D., R. Priya, and R. Bhavani. “IPFS-Based Image Sharing Using Perceptual Hash Code with Digital Right Management.” In Emerging Technologies for Computing, Communication and Smart Cities, pp. 683-700. Springer, Singapore, 2022.
Gilboa, N., “Two Party RSA Key Generation”, Proc of Crypto '99, Lecture Notes in Computer Science, Vol. 1666, Springer-Verlag, pp. 116-129, 1999
Guo, Hui, Zhenfeng Zhang, Jing Xu, Ningyu An, and Xiao Lan. “Accountable proxy re-encryption for secure data sharing.” IEEE Transactions on Dependable and Secure Computing 18, no. 1 (2018): 145-159.
Guo, Junqi, Chuyang Li, Guangzhi Zhang, Yunchuan Sun, and Rongfang Bie. “Blockchain-enabled digital rights management for multimedia resources of online education.” Multimedia Tools and Applications 79, no. 15 (2020): 9735-9755.
Hussain, Sajid, Yousaf Bin Zikria, Ghulam Ali Mallah, Chien-Ming Chen, Mohammad Dahman Alshehri, Farruh Ishmanov, and Shehzad Ashraf Chaudhry. “An Improved Authentication Scheme for Digital Rights Management System.” Wireless Communications and Mobile Computing 2022 (2022).
Khan, Muhammad Ayaz, Anwar Ghani, Mohammad S. Obaidat, Pandi Vijayakumar, Khwaja Mansoor, and Shehzad Ashraf Chaudhry. “A Robust Anonymous Authentication Scheme using Biometrics for Digital Rights Management System.” In 2021 International Conference on Communications, Computing, Cybersecurity, and Informatics (CCCI), pp. 1-5. IEEE, 2021.
Ku, William, and Chi-Hung Chi. “Survey on the technological aspects of digital rights management.” In International Conference on Information Security, pp. 391-403. Springer, Berlin, Heidelberg, 2004.
Kumar, Vakati Raja, and V. Chiranjeevi. “Proxy Re-encryption Schemes for Secure Cloud Data and Applications: A Survey.” Kwok, Sai Ho. “Digital rights management for the online music business.” ACM Sigecom exchanges 3, no. 3 (2002): 17-24.
Lee, Cheng-Chi, Chun-Ta Li, Zhi-Wei Chen, and Yan-Ming Lai. “A biometric-based authentication and anonymity scheme for digital rights management system.” Information Technology and Control 47, no. 2 (2018): 262-274.
Lee, Cheng-Chi, Chun-Ta Li, Zhi-Wei Chen, Shun-Der Chen, and Yan-Ming Lai. “A novel authentication scheme for anonymity and digital rights management based on elliptic curve cryptography.” International Journal of Electronic Security and Digital Forensics 11, no. 1 (2019): 96-117.
Lin, Cun-Li, Sun, Hung-Min, and Hwang, Tzonelih, “Three Party Key Exchange: Attacks and a Solution”.
Liu, Qiong, Reihaneh Safavi-Naini, and Nicholas Paul Sheppard. “Digital rights management for content distribution.” In Proceedings of the Australasian information security workshop conference on ACSW frontiers 2003-Volume 21, pp. 49-58. 2003.
Ma, Zhaofeng, Ming Jiang, Hongmin Gao, and Zhen Wang. “Blockchain for digital rights management.” Future Generation Computer Systems 89 (2018): 746-764.
Ma, Zhaofeng, Weihua Huang, Wei Bi, Hongmin Gao, and Zhen Wang. “A master-slave blockchain paradigm and application in digital rights management.” China Communications 15, no. 8 (2018): 174-188.
Ma, Zhaofeng. “Digital rights management: model, technology and application.” China communications 14, no. 6 (2017): 156-167.
Meng, Zhaoxiong, Tetsuya Morizumi, Sumiko Miyata, and Hirotsugu Kinoshita. “Design scheme of copyright management system based on digital watermarking and blockchain.” In 2018 IEEE 42nd Annual Computer Software and Applications Conference (COMPSAC), vol. 2, pp. 359-364. IEEE, 2018.
Micali, S., Fair cryptosystems, MIT Technical Report, MIT/LCS/TR-579, November 1993, MIT Laboratory for Computer Science, November 1993.
Micali, S., Fair Public-Key Cryptosystems. Advances in Cryptology—Proceedings of CRYPTO'92 (E. F. Brickell, ed.) Lecture Notes in Computer Science 740, SpringerVerlag (1993) pages 113-138;
Micro Payment Transfer Protocol (MPTP) Version 0.1 (22-Nov.-95) et seq., www.w3.org/pub/WWW/TR/WD-mptp.
Mishra, Dheerendra, and Saurabh Rana. “Authenticated content distribution framework for digital rights management systems with smart card revocation.” International Journal of Communication Systems 33, no. 9 (2020): e4388.
Mishra, Dheerendra, Mohammad S. Obaidat, Saurabh Rana, Dharminder Dharminder, Ankita Mishra, and Balqies Sadoun. “Chaos-based content distribution framework for digital rights management system.” IEEE Systems Journal 15, no. 1 (2020): 570-576.
Olivia, Maurizio, “Distributing Intellectual Property: a Model of Microtransaction Based Upon Metadata and Digital Signatures”, olivia.modlang.denison.edu/-olivia/RFC/09/
Ouyang, Ri. “HBRO: a registration oracle scheme for digital rights management based on heterogeneous blockchains.” Communications and Network 14, no. 1 (2021): 45-67.
Panescu, Adrian-Tudor, and Vasile Manta. “Smart contracts for research data rights management over the ethereum blockchain network.” Science & Technology Libraries 37, no. 3 (2018): 235-245.
Pang, Xiaoqiong, Ting Yang, Wenjun Chen, Yunting Wang, and Tianye Liu. “Digital rights management scheme based on secret sharing in blockchain environment.” Journal of Computer Applications 41, no. 11 (2021): 3257.
Ramani, S., Lakshit Dua, Arya Abrol, and Marimuthu Karuppiah. “Blockchain for digital rights management.” In Blockchain Technology for Emerging Applications, pp. 177-205. Academic Press, 2022.
Rana, Saurabh, and Dheerendra Mishra. “Cryptanalysis and improvement of biometric based content distribution framework for digital rights management systems.” Security and Privacy 4, no. 1 (2021): e133.
Rana, Saurabh, and Dheerendra Mishra. “Provably secure authenticated content key distribution framework for IoT-enabled enterprise digital rights management systems.” International Journal of Ad Hoc and Ubiquitous Computing 36, no. 3 (2021): 131-140.
Rinaldi, James. “Peer to Peer Digital Rights Management Using Blockchain.” PhD diss., University of the Pacific, 2018.
Rivest and Shamir, “PayWord and MicroMint: Two Simple Micropayment Schemes” (May 7, 1996).
Rizkallah, Jean-Paul. “Automatic management of digital rights using semantic Web technologies.” (2018).
Rosenblatt, B. et al, Digital Rights Management: Business and Technology, published by M&T Books (John Wiley & Sons) in 2001. An overview of DRM technology, business implications for content publishers, and relationship to U.S. copyright law.
Subramanya, S. R., and Byung K. Yi. “Digital rights management.” IEEE potentials 25, no. 2 (2006): 31-34.
Tan, Wenan, Xiao Zhang, and Xiaojuan Cai. “Digital Rights Management Platform Based on Blockchain Technology.” In International Conference on Human Centered Computing, pp. 173-183. Springer, Cham, 2020.
Temmermans, Frederik, Deepayan Bhowmik, Fernando Pereira, Touradj Ebrahimi, and Peter Schelkens. “Exploration of media block chain technologies for JPEG privacy and security.” In Optics, Photonics and Digital Technologies for Imaging Applications VI, vol. 11353, pp. 177-185. SPIE, 2020.
Tietze, Frank, and Ove Granstrand. “Enabling the digital economy-distributed ledger technologies for automating ip licensing payments.” In Managing Innovation in a Global and Digital World, pp. 347-365. Springer Gabler, Wiesbaden, 2020.
Tresise, Annabel, Jake Goldenfein, and Dan Hunter. “What blockchain can and can't do for copyright.” (2018).
Van Tassel, Joan. Digital rights management: Protecting and monetizing content. Taylor & Francis, 2006.
Wang, Danni, Juntao Gao, Haiyong Yu, and Xuelian Li. “A novel digital rights management in P2P networks based on Bitcoin system.” In International Conference on Frontiers in Cyber Security, pp. 227-240. Springer, Singapore, 2018.
Wang, Yun-Ciao, Chin-Ling Chen, and Yong-Yuan Deng. “Authorization mechanism based on blockchain technology for protecting museum-digital property rights.” Applied Sciences 11, no. 3 (2021): 1085.
Yu, Liqiang, Xiaoyuan Yang, Minqing Zhang, and Longfei Liu. “New identity based proxy re-encryption scheme from lattices.” China Communications 16, no. 10 (2019): 174-190.
Yang, Xiaodong, Sen Yuan, Hang Zhou, and Binbin Ding. “A proxy-protected proxy signature based on SM9.” In 2021 IEEE Sixth International Conference on Data Science in Cyberspace (DSC), pp. 166-170. IEEE, 2021.
Yu, SungJin, KiSung Park, YoHan Park, HyungPyo Kim, and YoungHo Park. “A lightweight three-factor authentication protocol for digital rights management system.” Peer-to-peer Networking and Applications 13, no. 5 (2020): 1340-1356.
Zeng, Wenjun, Heather Yu, and Ching-Yung Lin, eds. Multimedia security technologies for digital rights management. Elsevier, 2011.
Zhang, Yun, Zhi Tang, Jing Huang, Yue Ding, Hao He, Xiaosheng Xia, and Chunhua Li. “A decentralized model for spatial data digital rights management.” ISPRS International Journal of Geo-Information 9, no. 2 (2020): 84.
Zhang, Zehao, and Li Zhao. “A design of digital rights management mechanism based on blockchain technology.” In International conference on blockchain, pp. 32-46. Springer, Cham, 2018.
Zhaofeng, Ma, Wang Xiaochang, Deepak Kumar Jain, Haneef Khan, Gao Hongmin, and Wang Zhen. “A blockchain-based trusted data management scheme in edge computing.” IEEE Transactions on Industrial Informatics 16, no. 3 (2019): 2013-2021.

9. Transcryption and Intermediated Transactions

7,181,017; 6,937,726; 6,859,533; 6,779,111; 6,687,822; 6,587,946; 20020073202; 10168814; 10180982; 10182073; 10185584; 10191996; 10204357; 10225593; 10248653; 10248972; 10249263; 10250639; 10250640; 10275455; 10276172; 10284928; 10289809; 10291417; 10291561; 10297086; 10302456; 10313134; 10317243; 10318995; 10367882; 10375620; 10388291; 10397618; 10409862; 10409963; 10412071; 10417432; 10417554; 10418065; 10423207; 10423862; 10429608; 10438251; 10440368; 10452897; 10459977; 10460081; 10460501; 10475290; 10489223; 10491536; 10499068; 10504162; 10509672; 10509910; 10509911; 10509915; 10515644; 10521565; 10523582; 10535111; 10536435; 10540205; 10540484; 10549202; 10553225; 10578949; 10582239; 10582240; 10585942; 10592195; 10592930; 10600009; 10607614; 10616452; 10616573; 10621309; 10621635; 10635723; 10672404; 10678233; 10679632; 10685061; 10699283; 10712738; 10728129; 10732621; 10743036; 10748547; 10754334; 10758133; 10761481; 10762532; 10769431; 10771263; 10771524; 10791354; 10791363; 10795350; 10797994; 10803482; 10805084; 10812801; 10817096; 10824140; 10830990; 10832690; 10834014; 10838758; 10839320; 10848807; 10853136; 10854208; 10866584; 10867613; 10873772; 10880200; 10880591; 10884803; 10887400; 10891607; 10893256; 10908602; 10911894; 10917332; 10921801; 10936857; 10938791; 10951675; 10957416; 10977799; 10979467; 10983514; 10986403; 11003179; 11009865; 11017329; 11026283; 11029680; 11030860; 11036215; 11042854; 11042871; 11048248; 11054817; 11062357; 11063864; 11063865; 11067976; 11073826; 11080336; 11080407; 11081118; 11086311; 11086971; 11095907; 11106199; 11112272; 11112784; 11112785; 11113333; 11119473; 11126171; 11126173; 11130042; 11131989; 11137752; 11140077; 11140417; 11144047; 11153358; 11153626; 11156998; 11166013; 11175653; 11181893; 11182427; 11190802; 11190861; 11194319; 11199835; 11199837; 11205172; 11209813; 11215980; 11216305; 11218409; 11231705; 11233734; 11238499; 11243522; 11243528; 11244533; 11256242; 11256243; 11256778; 11256782; 11269295; 11269318; 11269319; 11270713; 11276014; 11276038; 11276056; 11284055; 11295296; 11307565; 11310274; 11314567; 11316794; 11317087; 11323723; 11327273; 11327551; 11330279; 11334063; 11334874; 11336551; 11340589; 11347206; 11347215; 11348097; 11348098; 11353850; 11353851; 11360459; 11366455; 11366456; 11368733; 20160004820; 20160006716; 20160006733; 20160027467; 20160029138; 20160029140; 20160034240; 20160034305; 20160035082; 20160038045; 20160041648; 20160041993; 20160042342; 20160048370; 20160049051; 20160051201; 20160064003; 20160070926; 20160095017; 20160098131; 20160098544; 20160099963; 20160103542; 20160104346; 20160104487; 20160104488; 20160104489; 20160104497; 20160111095; 20160117502; 20160117503; 20160162478; 20160174841; 20160174894; 20160180384; 20160183870; 20160188639; 20160189198; 20160191931; 20160192876; 20160198129; 20160203132; 20160203298; 20160213308; 20160213323; 20160224956; 20160224957; 20160225027; 20160225116; 20160234144; 20160239675; 20160249854; 20160253342; 20160262082; 20160262191; 20160262205; 20160266939; 20160277768; 20160277769; 20160291544; 20160295062; 20160295379; 20160300043; 20160314283; 20160317781; 20160354689; 20160358224; 20160358346; 20160358408; 20160358584; 20160373891; 20170011134; 20170017837; 20170019392; 20170032613; 20170048528; 20170048594; 20170048754; 20170069024; 20170076330; 20170078754; 20170103215; 20170108350; 20170132186; 20170140155; 20170140219; 20170140493; 20170161472; 20170192960; 20170193575; 20170223397; 20170228973; 20170228974; 20170228975; 20170230211; 20170232300; 20170235848; 20170236365; 20170236368; 20170249507; 20170250004; 20170250005; 20170250006; 20170269151; 20170277701; 20170278590; 20170278591; 20170287592; 20170287593; 20170287594; 20170289266; 20170310482; 20170323703; 20170323704; 20170331885; 20170344923; 20170347026; 20170357814; 20170364746; 20190012752; 20190014304; 20190018638; 20190025805; 20190033845; 20190033846; 20190033847; 20190033848; 20190035008; 20190041841; 20190041842; 20190041845; 20190041846; 20190042336; 20190052465; 20190064791; 20190064792; 20190065702; 20190069329; 20190087656; 20190118094; 20190121338; 20190121339; 20190121340; 20190121341; 20190121343; 20190121344; 20190121345; 20190121346; 20190121349; 20190121350; 20190122266; 20190122300; 20190129404; 20190129405; 20190129406; 20190129407; 20190129408; 20190129409; 20190129410; 20190137985; 20190137987; 20190137988; 20190137989; 20190138553; 20190146472; 20190146473; 20190146474; 20190146475; 20190146476; 20190146477; 20190146478; 20190146479; 20190146480; 20190146481; 20190146482; 20190149864; 20190155263; 20190155272; 20190155997; 20190156162; 20190171187; 20190171405; 20190171476; 20190173854;20190179300; 20190179301; 20190180291; 20190187680; 20190187681; 20190187682; 20190187683; 20190187685; 20190187686; 20190187687; 20190187688; 20190187689; 20190187690; 20190197888; 20190200060; 20190219995; 20190219996; 20190227536; 20190227537; 20190251977; 20190253262; 20190272358; 20190282098; 20190303586; 20190311134; 20190313021; 20190318389; 20190324431; 20190324432; 20190324433; 20190324434; 20190324435; 20190324436; 20190324437; 20190324438; 20190324439; 20190324440; 20190324441; 20190324442; 20190324443; 20190324444; 20190334973; 20190339684; 20190339685; 20190339686; 20190339687; 20190339688; 20190341061; 20190349848; 20190354552; 20190362051; 20190362219; 20190362388; 20200005831; 20200007918; 20200019154; 20200019155; 20200026030; 20200026270; 20200027096; 20200034332; 20200034792; 20200042773; 20200042982; 20200042983; 20200042984; 20200042985; 20200042986; 20200042987; 20200042990; 20200044827; 20200044857; 20200045323; 20200050483; 20200053020; 20200053392; 20200077105; 20200082057; 20200088545; 20200089210; 20200089211; 20200089212; 20200089213; 20200089214; 20200089215; 20200089216; 20200089217; 20200096986; 20200096989; 20200096991; 20200096993; 20200096994; 20200096995; 20200096996; 20200096997; 20200096998; 20200097637; 20200097665; 20200103889; 20200103890; 20200103891; 20200103892; 20200103893; 20200103894; 20200103949; 20200110397; 20200110398; 20200114266; 20200120023; 20200126353; 20200126568; 20200126570; 20200133254; 20200133255; 20200133256; 20200133257; 20200145388; 20200150643; 20200150644; 20200150645; 20200151842; 20200154159; 20200159206; 20200159207; 20200159579; 20200166824; 20200166922; 20200166923; 20200174463; 20200174464; 20200177809; 20200192957; 20200193418; 20200204375; 20200225655; 20200228856; 20200236251; 20200250590; 20200258529; 20200258530; 20200260063; 20200260071; 20200264688; 20200264689; 20200265915; 20200304290; 20200312338; 20200320514; 20200344060; 20200348662; 20200359919; 20200374505; 20200380476; 20200393794; 20200403808; 20200413107; 20210012282; 20210012367; 20210014143; 20210014150; 20210021539; 20210021849; 20210026715; 20210029392; 20210035161; 20210037076; 20210037246; 20210042823; 20210044545; 20210044642; 20210044851; 20210055506; 20210056978; 20210065070; 20210089353; 20210092059; 20210092060; 20210098003; 20210112117; 20210117955; 20210118453; 20210119918; 20210133721; 20210142809; 20210142916; 20210149696; 20210157312; 20210157643; 20210174069; 20210192651; 20210194946; 20210211752; 20210216599; 20210227011; 20210227231; 20210250617; 20210272103; 20210295372; 20210295637; 20210306665; 20210312552; 20210314626; 20210318132; 20210334340; 20210334770; 20210342452; 20210342801; 20210342836; 20210342890; 20210350289; 20210396546; 20220004308; 20220012285; 20220014733; 20220020001; 20220027893; 20220034004; 20220040557; 20220046072; 20220050715; 20220058622; 20220059103; 20220078486; 20220083046; 20220083047; 20220083048; 20220083978; 20220092135; 20220093070; 20220094909; 20220100825; 20220108262; 20220121731; 20220121779; 20220138640; 20220156652; 20220157117; 20220159267; 20220163959; 20220163960; 20220171826; 20220172206; 20220172207; 20220172208; 20220180878; 20220182742; 20220187822; 20220187847; 20220188451; 20220193915; 20220196889; 20220197246; 20220197247; 20220197255; 20220197306; 20220198562; 9235704; 9235862; 9241180; 9251322; 9262632; 9268852; 9271023; 9275051; 9275157; 9292866; 9311499; 9319555; 9323784; 9323902; 9324064; 9326094; 9368052; 9374685; 9378065; 9384500; 9386150; 9390436; 9390441; 9392313; 9396361; 9397991; 9401810; 9405740; 9430644; 9438595; 9454764; 9454772; 9460346; 9460433; 9461876; 9471755; 9471925; 9479591; 9489697; 9497495; 9514134; 9516392; 9526032; 9536097; 9536233; 9538183; 9538292; 9544657; 9547753; 9558349; 9558350; 9558526; 9560247; 9563749; 9568984; 9571604; 9578345; 9595046; 9596293; 9596386; 9602661; 9610030; 9633013; 9640028; 9654280; 9654456; 9659460; 9661043; 9684902; 9697280; 9703892; 9704211; 9712623; 9715899; 9721193; 9723463; 9730033; 9734169; 9734659; 9743078; 9754287; 9760916; 9760938; 9773167; 9779253; 9781148; 9785975; 9792160; 9799060; 9805727; 9807069; 9811589;9811728; 9817627; 9818136; 9849364; RE47877; WO-2016000015; WO-2016003500; WO-2016005225; WO-2016022791; WO-2016025852; WO-2016026846; WO-2016048446; WO-2016108188; WO-2016109513; WO-2016109807; WO-2016113458; WO-2016126680; WO-2016128612; WO-2016144405; WO-2016144414; WO-2016144422; WO-2016148848; WO-2016148849; WO-2016149479; WO-2016185090; WO-2016196496; WO-2016197033; WO-2017066690; WO-2017093611; WO-2017140945; WO-2017140946; WO-2017140948; WO-2017203098; WO-2019002662; WO-2019028269; WO-2019038473; WO-2019068353; WO-2019073112; WO-2019073113; WO-2019083674; WO-2019094729; WO-2019141901; WO-2019141907; WO-2019195036; WO-2019216975; WO-2020008106; WO-2020008115; WO-2020046913; WO-2020053477; WO-2020081727; WO-2020125839; WO-2020125840; WO-2020132084; WO-2020141248; WO-2020141258; WO-2020141260; WO-2020168114; WO-2020183055; WO-2020201632; WO-2020206379; WO-2020218854; WO-2020227429; WO-2020229734; WO-2020243725; WO-2020254720; WO-2020264251; WO-2021033026; WO-2021072417; WO-2021083728; WO-2021090120; WO-2021096964; WO-2021108680; WO-2021112830; WO-2021136877; WO-2021198553; WO-2021205061; WO-2022016102; WO-2022066773; WO-2022072626; WO-2022072921; WO-2022133210; and WO-2022133330.
Ateniese, Giuseppe, Kevin Fu, Matthew Green, Susan Hohenberger, “Improved Proxy Re-Encryption Schemes with Applications to Secure Distributed Storage”, Cryptology ePrint Archive, Report 2005/028, Proceedings of NDSS 2005 (journal version to appear in ACM TISSEC)(received 3 Feb. 2005, last revised 11 Jan. 2006). eprint.iacr.org/2005/028.pdf;
Bao, Feng; Robert Deng; Jianying Zhou; Public Key Cryptography-Pkc 2004: 7th International Workshop On Theory And Practice In Public . . . ;
Basney, J., P. Flanigan, J. Heo, H. Khurana, J. Muggli, M. Pant, A. Slagell and V. Welch. Mithril: Adaptable Security for Survivability in Collaborative Computing Sites. Workshop on Enterprise Network Security, held in conjunction with SecureComm 2006, Baltimore, MD, September, 2006;
Blaze M.; Bleumer G.; Strauss M.; Nyberg Kaisa, “Divertible protocols and atomic proxy cryptography”, EUROCRYPT '98: Advances in Cryptology (Espoo, 31 May-4 Jun. 1998) International Conference On The Theory And Application Of Cryptographic Techniques, Espoo, Finlande (31 May 1998);
Blaze, Matt, Martin Strauss, “Atomic Proxy Cryptography”, www.research.att.com, AT&T Labs—Research (Feb. 23, 1998);
Bodó, Balazs, Daniel Gervais, and João Pedro Quintais. “Blockchain and smart contracts: the missing link in copyright licensing?.” International Journal of Law and Information Technology 26, no. 4 (2018): 311-336.
Cramer, R., and V. Shoup, “A Practical Public Key Cryptosystem Provably Secure against Adaptive Chosen Ciphertext Attack,” Proceedings of CRYPTO '98, Springer Verlag LNCS, vol. 1462, pp. 13-25 (1998).
Finck, Michéle, and Valentina Moscon. “Copyright law on blockchains: between new forms of rights administration and digital rights management 2.0.” IIC-International Review of Intellectual Property and Competition Law 50, no. 1 (2019): 77-108.
Garba, Abba, Ashutosh Dhar Dwivedi, Mohsin Kamal, Gautam Srivastava, Muhammad Tariq, M. Anwar Hasan, and Zhong Chen. “A digital rights management system based on a scalable blockchain.” Peer-to-Peer Networking and Applications 14, no. 5 (2021): 2665-2680.
Guo, Junqi, Chuyang Li, Guangzhi Zhang, Yunchuan Sun, and Rongfang Bie. “Blockchain-enabled digital rights management for multimedia resources of online education.” Multimedia Tools and Applications 79, no. 15 (2020): 9735-9755.
Hohenberger, Susan, “Advances in Signatures, Encryption, and E-Cash from Bilinear Groups”, (Ph.D. Thesis, MIT, May 2006);
Ivan, Anca; Yevgeniy Dodis; Proxy Cryptography Revisited, Network and Distributed System Security Symposium Conference Proceedings: 2003;
Jakobsson, Markus, “On Quorum Controlled Asymmetric Proxy Re-Encryption”, and Tatsuaki Okamoto, “Threshold Key-Recovery Systems for RSA”;
Khurana, Himanshu; Adam Slagell; and Rafael Bonilla, SELS: A Secure E-mail List Service, Proc. Security Track ACM Symp. Applied Computing (SAC), March 2005;
Khurana, Himanshu; Jin Heo; and Meenal Pant, “From Proxy Encryption Primitives to a Deployable Secure-Mailing-List Solution”, To appear in the Eighth International Conference on Information and Communications Security (ICICS '06), Raleigh, NC, December 2006;
Khurana, Himanshu; Jin Heo; Meenal Pant; “PSELS: Practical Secure Email Lists Services”, Securecomm 2006, September 2006, Baltimore, MD;
Khurana, Himanshu; SELS: Secure Email List Services, NCSA Private Sector Program Annual Meeting, Urbana, IL, May 2005;
Ma, Zhaofeng, Ming Jiang, Hongmin Gao, and Zhen Wang. “Blockchain for digital rights management.” Future Generation Computer Systems 89 (2018): 746-764.
Ma, Zhaofeng, Weihua Huang, Wei Bi, Hongmin Gao, and Zhen Wang. “A master-slave blockchain paradigm and application in digital rights management.” China Communications 15, no. 8 (2018): 174-188.
Mambo, M., and E. Okamoto, “Proxy cryptosystems: Delegation of the power to decrypt ciphertexts,” IEICE Trans. on Fundamentals, Vol. E80-A, No. 1, pp. 54-63 (1997);
Wang Shuhong; Guilin Wang; Feng Bao; Jie Wang, “Cryptanalysis of a Proxy-protected Proxy Signature Scheme Based on Elliptic Curve Cryptosystem”, iteseer.ist.psu.edu/wang02cryptanalysis.html,
Xu, Cong. “Panorama of Digital Rights Management Systems.” In Regulatory Model for Digital Rights Management, pp. 9-51. Springer, Singapore, 2020.
Zhang, Zehao, and Li Zhao. “A design of digital rights management mechanism based on blockchain technology.” In International conference on blockchain, pp. 32-46. Springer, Cham, 2018.

10. Homomorphic Encryption

4076960; 4240037; 4452590; 5273632; 5495532; 5561718; 6035041; 6771320; 6862326; 7231063; 7640432; 7743253; 7856100; 7877410; 8105237; 8229939; 8249250; 8281121; 8423586; 8433893; 8433925; 8510550; 8515058; 8520844; 8526603; 8539220; 8565435; 8627107; 8635465; 8652045; 8667062; 8667288; 8681973; 8806194; 8837715; 8843762; 8862895; 8868153; 8925075; 8972742; 9002007; 9031229; 9094378; 9100185; 9166785; 9191196; 9213764; 9215219; 9270446; 9270947; 9275250; 9276734; 9281941; 9288039; 9306738; 9313022; 9313028; 9350543; 9369273; 9397825; 9432188; 9436835; 9509492; 9509493; 9509494; 9521124; 9524370; 9524392; 9536047; 9542155; 9584311; 9596083; 9608817; 9614665; 9619658; 9621346; 9641318; 9646306; 9679149; 9722776; 9722777; 9729312; 9742556; 9742566; 9749128; 9760737; 9787647; 9819650; 9846785; 9847871; 9876636; 9892211; 9900147; 9912472; 9948453; 9973334; 9979551; 9985935; 10009343; 10015007; 10019709; 10027486; 10027633; 10027654; 10033708; 10037544; 10038562; 10057057; 10075288; 10075289; 10079674; 10095880; 10102399; 10116437; 10153894; 10153895; 10163370; 10171230; 10171459; 10200347; 10211974; 10211975; 10248800; 10250576; 10250591; 10255454; 10257173; 10270588; 10296709; 10298385; 10326598; 10333695; 10333696; 10333715; 10341086; 10382194; 10397002; 10397003; 10419221; 10423449; 10423806; 10439798; 10454668; 10476853; 10484168; 10491373; 10536263; 10541805; 10546141; 10554384; 10559049; 10560257; 10572677; 10594472; 10601579; 10606931; 10630472; 10644877; 10652010; 10673613; 10673614; 10673615; 10680799; 10693626; 10693628; 10715309; 10715508; 10719828; 10721070; 10721217; 10728017; 10735181; 10749665; 10754907; 10757081; 10761887; 10771237; 10778408; 10778409; 10778410; 10778431; 10778657; 10790960; 10790961; 10797856; 10812252; 10826680; 10841100; 10861016; 10868666; 10873447; 10873568; 10880275; 10885203; 10887088; 10903976; 10904225; 10911216; 10924262; 10929402; 10938547; 10951394; 10970402; 10972251; 10972261; 10985905; 11005665; 11017151; 11032061; 11032255; 11036874; 11048805; 11050720; 11050725; 11063759; 11080280; 11082234; 11087223; 11095428; 11101976; 11101977; 11115182; 11115183; 11121854; 11133922; 11138333; 11139952; 11139961; 11159305; 11165558; 11171773; 11177935; 11177944; 11184163; 11190336; 11196539; 11196540; 11196541; 11200328; 11201725; 11206130; 11210375; 11228423; 11232478; 11233659; 11239995; 11239996; 11244306; 11250116; 11256900; 11257076; 11257093; 11265153; 11265168; 11275585; 11275848; 11276060; 11277256; 11277257; 11277258; 11283591; 11283620; 11290252; 11297043; 11303427; 11308233; 11308234; 11310049; 11316657; 11321382; 11323240; 11323241; 11323255; 11328082; 11341492; 11343070; 11343100; 11354482; 11356241; 11362831; 11367065; 11368279; 11368280; 11368296; 11368308; 11374736; 20020039152; 20020073318; 20020076116; 20040028258; 20050008152; 20050107248; 20060233454; 20060233455; 20070053506; 20070116283; 20070118746; 20070140479; 20070171050; 20080301448; 20090083546; 20090119518; 20090299186; 20100146299; 20100177888; 20100246812; 20100329448; 20110060901; 20110060917; 20110060918; 20110211692; 20110258167; 20110264920; 20110283099; 20120039473; 20120054485; 20120066510; 20120130247; 20120201378; 20120213359; 20120215845; 20120254605; 20130010950; 20130097417; 20130148868; 20130216044; 20130254532; 20130262863; 20130281822; 20130326224; 20130329883; 20130339413; 20130339722; 20130346741; 20130346755; 20140172830; 20140177828; 20140185794; 20140185797; 20140208101; 20140233726; 20140233727; 20140237253; 20140237254; 20140247939; 20140334622; 20140348326; 20140359287; 20140372769; 20150039912; 20150046450; 20150046708; 20150089243; 20150100785; 20150149427; 20150154406; 20150169889; 20150170197; 20150172049; 20150193628; 20150193633; 20150195083; 20150215123; 20150227930; 20150229480; 20150236849; 20150244516; 20150244517; 20150295716; 20150312028; 20150312031; 20150318991; 20150356281; 20150365239; 20150381348; 20150381349; 20160020898; 20160036584; 20160044003; 20160072623; 20160105402; 20160105414; 20160119119; 20160119346; 20160125141; 20160127125; 20160133164; 20160156595; 20160164670; 20160164671; 20160164676; 20160189461; 20160191233; 20160224735; 20160254912; 20160261404; 20160323098; 20160330017; 20160344557; 20160352710; 20160359617; 20160364582; 20160371684; 20170032016; 20170039377; 20170039487; 20170041132; 20170048058; 20170048208; 20170053282; 20170063525; 20170070340; 20170099263; 20170104752; 20170134156; 20170134157; 20170134158; 20170147835; 20170149557; 20170149558; 20170177899; 20170180115; 20170201371; 20170235736; 20170235969; 20170237725; 20170244553; 20170264426; 20170272235; 20170288856; 20170293913; 20170301052; 20170357749; 20170366338; 20180019982; 20180048459; 20180048628; 20180060604; 20180109376; 20180131506; 20180131507; 20180131512; 20180139054; 20180145825; 20180183570; 20180198601; 20180212750; 20180212751; 20180212752; 20180212753; 20180212755; 20180212756; 20180212757; 20180212758; 20180212775; 20180212933; 20180227278; 20180234253; 20180234254; 20180260576; 20180262474; 20180267981; 20180276417; 20180278410; 20180288023; 20180294950; 20180337788; 20180343109; 20180349632; 20180349740; 20180359078; 20180359079; 20180359229; 20180367294; 20180373882; 20180375639; 20180375640; 20190007196; 20190007197; 20190013950; 20190036678; 20190058580; 20190097787; 20190108350; 20190124051; 20190140818; 20190149317; 20190155643; 20190182027; 20190182216; 20190190694; 20190190713; 20190199509; 20190199510; 20190199511; 20190205875; 20190222412; 20190260585; 20190268135; 20190278895; 20190278937; 20190279047; 20190280868; 20190280869; 20190294956; 20190296897; 20190296910; 20190312719; 20190327077; 20190332431; 20190334694; 20190334708; 20190334716; 20190342069; 20190342270; 20190354574; 20190362054; 20190363870; 20190363871; 20190363872; 20190363878; 20190386814; 20190394019; 20200013118; 20200014541; 20200019723; 20200019867; 20200021568; 20200026867; 20200036510; 20200036511; 20200036512; 20200042994; 20200044837; 20200044852; 20200052903; 20200074459; 20200076570; 20200076614; 20200082126; 20200084017; 20200084191; 20200089906; 20200099666; 20200125739; 20200127810; 20200136797; 20200136798; 20200136818; 20200142993; 20200151356; 20200153803; 20200162235; 20200175178; 20200175426; 20200175509; 20200177366; 20200186325; 20200204340; 20200204341; 20200213079; 20200226318; 20200228307; 20200228308; 20200228309; 20200228336; 20200228340; 20200228341; 20200235908; 20200244435; 20200244436; 20200244437; 20200252199; 20200279253; 20200279260; 20200295917; 20200304284:20200304290; 20200311720; 20200328874; 20200351097; 20200351253; 20200358594; 20200358599; 20200358611; 20200358746; 20200364704; 20200366460; 20200374100; 20200374101; 20200374135; 20200382273; 20200382274; 20200382325; 20200394518; 20200396053; 20200402073; 20210019428; 20210028921; 20210028945; 20210036849; 20210044419; 20210044609; 20210058229; 20210075588; 20210075600; 20210080124; 20210081203; 20210083841; 20210090077; 20210091955; 20210099308; 20210105256; 20210109940; 20210111863; 20210117533; 20210117553; 20210119779; 20210124815; 20210126768; 20210135837; 20210150037; 20210160049; 20210160050; 20210194666; 20210194668; 20210194669; 20210194670; 20210194856; 20210203474; 20210211269; 20210211290; 20210216300; 20210234689; 20210241166; 20210243004; 20210243005; 20210248176; 20210248263; 20210256162; 20210271764; 20210273787; 20210281391; 20210287218; 20210297232; 20210297233; 20210297235; 20210303728; 20210311148; 20210319131; 20210326439; 20210328762; 20210328763; 20210328765; 20210328766; 20210328778; 20210336765; 20210336770; 20210344477; 20210344478; 20210344479; 20210344489; 20210351912; 20210351913; 20210351914; 20210359835; 20210367758; 20210373537; 20210376995; 20210376996; 20210376997; 20210376998; 20210376999; 20210377031; 20210377038; 20210377231; 20210385084; 20210390599; 20210391976; 20210391987; 20210397988; 20210399872; 20210399873; 20210399874; 20210399983; 20210409189; 20210409191; 20210409197; 20220006629; 20220012359; 20220012366; 20220014351; 20220021515; 20220029783; 20220035951; 20220038478; 20220045840; 20220045841; 20220045851; 20220050999; 20220052834; 20220052848; 20220070665; 20220075878; 20220075880; 20220078023; 20220083815; 20220085970; 20220085971; 20220085972; 20220085973; 20220094517; 20220094518; 20220094670; 20220100889; 20220100896; 20220103375; 20220109574; 20220116198; 20220126210; 20220129531; 20220129847; 20220129892; 20220131690; 20220140996; 20220140997; 20220141038; 20220147595; 20220150047; 20220150048; 20220166599; 20220173914; 20220182234; 20220182239; and 201601549719.
en.wikipedia.org/wiki/Homomorphism;
en.wikipedia.org/wiki/Homomorphic_encryption
Abbas, Fizza, Ubaidullah Rajput, Adnan Manzoor, lmtiaz Ali Halepoto, and Ayaz Hussain, “Towards Privacy Preserving Commutative Encryption-Based Matchmaking in Mobile Social Network.” International Journal of Advanced Computer Science and Applications 9, no. 5 (2018).
Alloghani, Mohamed, Mohammed M. Alani, Dhiya A1-Jumeily, Thar Baker, Jamila Mustafina, Abir Hussain, and Ahmed J. Aljaaf. “A systematic review on the status and progress of homomorphic encryption technologies.” Journal of Information Security and Applications 48 (2019): 102362.
Almutairi, Nawal, Frans Coenen, and Keith Dures. “K-means clustering using homomorphic encryption and an updatable distance matrix: secure third party data clustering with limited data owner interaction.” In International Conference on Big Data Analytics and Knowledge Discovery, pp. 274-285. Springer, Cham, 2017.
Armknecht, Frederik, Colin Boyd, Christopher Carr, Kristian Gjosteen, Angela Jsschke, Christian A. Reuter, and Martin Strand. “A guide to fully homomorphic encryption.” Cryptology ePrint Archive (2015).
Baharon, Mohd Rizuan, Qi Shi, and David Llewellyn-Jones. “A new lightweight homomorphic encryption scheme for mobile cloud computing.” In 2015 IEEE International Conference on Computer and Information Technology; Ubiquitous Computing and Communications; Dependable, Autonomic and Secure Computing; Pervasive Intelligence and Computing, pp. 618-625. IEEE, 2015.
Bao, Rongxin, Zhikui Chen, and Mohammad S. Obaidat. “Challenges and techniques in Big data security and privacy: A re^{v}iew.” Security and Privacy 1, no. 4 (2018): e13.
Carpio, Miguel, Sergi Robles, Adrien Senchez, and Carlos Borrego. “Market Equity for Car-sharing Applications using Homomorphic Encryption and Opportunistic Networking,” In 2021 Wireless Days (WD), pp. 1-5. IEEE, 2021.
Chergui, Rachid. “Homomorphism Encryption For Privacy-Preserving Distributed Profile Matching In Mobile Social Networks.”
Chergui, Rachid. “Privacy preserving distributed profile matching in mobile social network.” arXiv preprint arXiv:1502.06993 (2015).
Chillotti et al., “Faster fully homomorphic encryption: Bootstrapping in less than 0.1 seconds”, Advances in Cryptology—ASIACRYPT 2016: 22nd International Conference on the Theory and Application of Cryptology and Information Security, Hanoi, Vietnam, Dec. 4-8, 2016, Proceedings, Part I 22, Springer, 2016, pp. 3-33; “Improving TFHE: faster packed homomorphic operations and efficient circuit bootstrapping”, eprint.iacr.org/2017/430.
Ducas and Micciancio, “FHEW: bootstrapping homomorphic encryption in less than a second”, Advances in cryptology—EUROCRYPT 2015. Part I, Lecture Notes in Comput. Sci., vol. 9056, Springer, Heidelberg, 2015, pp. 617-640.
Gao, Chong-zhi, Qiong Cheng, Xuan Li, and Shi-bing Xia. “Cloud-assisted privacy-preserving profile-matching scheme under multiple keys in mobile social netvork,” Cluster Computing 22, no. 1 (2019): 1655-1663.
Gao, Weichao, Wei Yu, Fan Liang, William Grant Hatcher, and Chao Lu. “Privacy-preserving auction for big data trading using homomorphic encryption.” IEEE Transactions on Network Science and Engineering 7, no. 2 (2018): 776-791.
Gentry et al. “Fully homomorphic encryption using ideal lattices”, Proceedings of the 41st Annual ACM Symposium on Theory of Computing, STOC 2009, Bethesda, Md., USA, May 31-Jun. 2, 2009, pp. 169-178.
Guide, Reshma Zunke, and Amit Pimpalkar. “A Survey Of Secure And Privacy Preserving In Social Network With Group Matching Techniques.” IJCSMC, Vol. 3, Issue. 5, May 2014, pg.506-514.
Guo, Mengjiao, Chi-Hung Chi, Hui Zheng, Kai Zhang, and Jing He. “Homomorphic Encryption based Subgraph lsomorphism Protocol in Blockchain.” In IEEE/WIC/ACM International Conference on Web Intelligence and Intelligent Agent Technology, pp. 449-456. 2021.
Jin, Biao, Dongshuo Jiang, Jinbo Xiong, Lei Chen, and Qi Li. “D2D data privacy protection mechanism based on reliability and homomorphic encryption.” IEEE Access 6 (2018): 51140-51150.
Kaibing Zhang. “Secure multimedia big data sharing in social networks using fingerprinting and encryption in thejpeg2000 compressed domain.” In 2014 IEEE 13th International Conference on Trust, Security and Privacy in Computing and Communications, pp. 616-621. IEEE, 2014.
Kaosar, Mohammed, and Quazi Mamun. “Privacy-preserving interest group formation in online social networks (OSNs) using fully homomorphic encryption.” Journal of Information Privacy and Security 10, no. 1 (2014): 44-52.
Kerschbaum, Florian, and Andreas Schaad. “Privacy-preserving social network analysis for criminal investigations.” In Proceedings of the 7th ACM workshop on Privacy in the electronic society, pp. 9-14. 2008.
Kumar, Yogesh, and Arun Mishra. “Secure Online Polling: Based on Homomorphic Encryption Using (n, n) Secret Sharing Scheme.” In International Conference on Advanced Informatics for Computing Research, pp. 590-600. Springer, Singapore, 2018.
Li, Peng, Fucai Zhou, Zifeng Xu, Yuxi Li, and Jian Xu. “Privacy-preserving graph operations for social network analysis.” In International Symposium on Security and Privacy in Social Networks and Big Data, pp. 303-317. Springer, Singapore, 2020.
Liu, Jibang, Yung-Hsiang Lu, and Cheng-Kok Koh. “Performance analysis of arithmetic operations in homomorphic encryption.” (2010).
Mallaiah, Kurra, and S. Ramachandram. “Applicability of homomorphic encryption and CryptDB in social and business applications: Securing data stored on the third party servers while processing through applications.” International Journal of Computer Applications 100, no. 1 (2014).
Patil, Mrs Sonali. “Generating Private Recommendation System Using Multiple Homomorphic Encryption Scheme.” International Journal on Recent and Innovation Trends in Computing and Communication 3, no. 7: 4690-4694.
Reddy, Jonnala Santhi Sree Priya, and Mande Praveen Kumar. “Online Social Friend Recommendation Based on Multiple Social Network Correlation.” (2018).
Shankar, K., Mohamed Elhoseny, R. Satheesh Kumar, S. K. Lakshmanaprabu, and Xiaohui Yuan. “Secret image sharing scheme with encrypted shadow images using optimal homomorphic encryption technique.” Journal of Ambient Intelligence and Humanized Computing 11, no. 5 (2020): 1821-1833.
Sun, Dechao, Hong Huang, Dongsong Zheng, Haoliang Hu, Chunyue Bi, and Renfang Wang. “Face Security Authentication System Based on Deep Learning and Homomorphic Encryption.” Security and Communication Networks 2022 (2022).
Tang, Chunming, and Cailing Cai. “Verifiable mobile online social network privacy-preserving location sharing scheme.” Concurrency and Computation: Practice and Experience 29, no. 24 (2017): e4238.
Teng, Lin, Hang Li, Jie Liu, and Shoulin Yin. “An Efficient and Secure Cipher-Text Retrieval Scheme Based on Mixed Homomorphic Encryption and Multi-Attribute Sorting Method.” Int. J. Netw. Secur. 20, no. 5 (2018): 872-878.
Tu, Chunxia. “Survey on homomorphic encryption technology.” In 8th International Conference on Social Network, Communication and Education (SNCE 2018), pp. 764-768. Atlantis Press, 2018.
Umar, V. S. A. K., and V. T. R. K. Umar. “Securing Data using Fully Homomorphic Encryption Schemes Over Cloud Computing.” Compusoft 3, no. 10 (2014): 1157.
Wang, Xiaowei, Shoulin Yin, Hang Li, Lin Teng, and Shahid Karim. “A modified homomorphic encryption method for multiple keywords retrieval.” International Journal of Network Security 22, no. 6 (2020): 905-910.
Xu, Jian, Andi Wang, Jun Wu, Chen Wang, Ruijin Wang, and Fucai Zhou. “SPCSS: social network based privacy-preserving criminal suspects sensing.” IEEE Transactions on Computational Social Systems 7, no. 1 (2020): 261-274.
Yan, Xiaoyan, Qilin Wu, and Youming Sun. “A homomorphic encryption and privacy protection method based on blockchain and edge computing,” Wireless Communications and Mobile Computing 2020 (2020).
Yang, Bin, Issei Sato, and Hiroshi Nakagawa. “Privacy-preserving EM algorithm for clustering on social network.” In Pacific-Asia Conference on Knowledge Discovery and Data Mining, pp. 542-553. Springer, Berlin, Heidelberg, 2012.
Ye, Conghuan, Zenggang Xiong, Yaoming Ding, Jiping Li, Guangwei Wang, Xuemin Zhang, and
Yin, Shoulin, Jie Liu, and Lin Teng. “Improved Elliptic Curve Cryptography with Homomorphic Encryption for Medical Image Encryption.” Int. J. Netw. Secur. 22, no. 3 (2020): 419-424.
Yonetani, Ryo, Vishnu Naresh Boddeti, Kris M. Kitani, and Yoichi Sato. “Privacy-preserving visual learning using doubly permuted homomorphic encryption.” In Proceedings of the IEEE International Conference on Computer Vision, pp. 2040-2050. 2017.
Zhan, Justin, Gary Blosser, Chris Yang, and Lisa Singh. “Privacy-preserving collaborative social networks.” In International Conference on Intelligence and Security Informatics, pp. 114-125. Springer, Berlin, Heidelberg, 2008.
Zhan, Justin. “Secure collaborative social networks.” IEEE Transactions on Systems, Man, and Cybernetics, Part C (Applications and Reviews) 40, no. 6 (2010): 682-689.
Zhang, Kuan, Xiaohui Liang, Jianbing Ni, Kan Yang, and Xuemin Shen. “Exploiting social network to enhance human-to-human infection analysis without privacy leakage.” IEEE Transactions on Dependable and Secure Computing 15, no. 4 (2016): 607-620.
Zhang, Lili, Fei Wang, Yanan Chang, and Jian Wang. “Private Set Intersection Protocol Based on Threshold Scheme in Mobile Social Network.” Recent Advances in Electrical & Electronic Engineering (Formerly Recent Patents on Electrical & Electronic Engineering) 8, no. 2 (2015): 74-78.
Zhou, Tianci, Yong Zeng, Yixin Li, Zhongyuan Jiang, Zhihong Liu, and Teng Li. “Cold-start Recommendation Method Based on Homomorphic Encryption.” In 2021 International Conference on Networking and Network Applications (NaNA), pp. 461-465. IEEE, 2021.

11. Data Clustering

20120137182; 20120136860; 20120131701; 20120125178; 20120123279; 20120109778; 20120089341; 20120088981; 20120084251; 20120078927; 20120078906; 20120078858; 20120076372; 20120072124; 20120070452; 20120054133; 20120047098; 20120045119; 20120041955; 20120039541; 20120036096; 20120030185; 20120030165; 20120021710; 20120015841; 20120014560; 20120011135; 20120005238; 20110320396; 20110306354; 20110304619; 20110301860; 20110299765; 20110295773; 20110288890; 20110282877; 20110282828; 20110269479; 20110264432; 20110261049; 20110255748; 20110255747; 20110251081; 20110246483; 20110246409; 20110246200; 20110231414; 20110225158; 20110221767; 20110218990; 20110206246; 20110205399; 20110202540; 20110191353; 20110191283; 20110191076; 20110185234; 20110179019; 20110178965; 20110175905; 20110173189; 20110173173; 20110172501; 20110166949; 20110161205; 20110144914; 20110144480; 20110143650; 20110142318; 20110142287; 20110124525; 20110119108; 20110116690; 20110115787; 20110106801; 20110105350; 20110105340; 20110103613; 20110097001; 20110093492; 20110093482; 20110091083; 20110091074; 20110091073; 20110086349; 20110081066; 20110081056; 20110080490; 20110078144; 20110078143; 20110060717; 20110060716; 20110055192; 20110052076; 20110048731; 20110047172; 20110040192; 20110029657; 20110022599; 20110022354; 20110020779; 20110015869; 20110013840; 20110008805; 20110004578; 20110004415; 20110004115; 20110002194; 20110002028; 20100332475; 20100332474; 20100332425; 20100332242; 20100332210; 20100322525; 20100318492; 20100313157; 20100305930; 20100305868; 20100299128; 20100296748; 20100284915; 20100280987; 20100278425; 20100268512; 20100268476; 20100257092; 20100254614; 20100250527; 20100250477; 20100239147; 20100232718; 20100228731; 20100228625; 20100221722; 20100217763; 20100216660; 20100215903; 20100205213; 20100204061; 20100199186; 20100198864; 20100191722; 20100191532; 20100189333; 20100183555; 20100174985; 20100174983; 20100174982; 20100174980; 20100174979; 20100174978; 20100174977; 20100174976; 20100174732; 20100174492; 20100169025; 20100166339; 20100161590; 20100161232; 20100157340; 20100157089; 20100150453; 20100149917; 20100138894; 20100136553; 20100135597; 20100135582; 20100125594; 20100121638; 20100117978; 20100114929; 20100114928; 20100112234; 20100111396; 20100111370; 20100106713; 20100100515; 20100085358; 20100082614; 20100082367; 20100081661; 20100080439; 20100076981; 20100067745; 20100057534; 20100057399; 20100057391; 20100055678; 20100054278; 20100050260; 20100049431; 20100042563; 20100036647; 20100034422; 20100033182; 20100017487; 20100005105; 20100004923; 20100004898; 20090327185; 20090326383; 20090319526; 20090319454; 20090318815; 20090313294; 20090311786; 20090299990; 20090299822; 20090299705; 20090297048; 20090292802; 20090292695; 20090292694; 20090292482; 20090290778; 20090287689; 20090277322; 20090276705; 20090271694; 20090271424; 20090271405; 20090271404; 20090271397; 20090271363; 20090271359; 20090271246; 20090265024; 20090252046; 20090248399; 20090234876; 20090226081; 20090222430; 20090220488; 20090204609; 20090204574; 20090204333; 20090199099; 20090190798; 20090175545; 20090175544; 20090169065; 20090164192; 20090154795; 20090150340; 20090132347; 20090125916; 20090125482; 20090124512; 20090104605; 20090097728; 20090094265; 20090094233; 20090094232; 20090094231; 20090094209; 20090094208; 20090094207; 20090094021; 20090094020; 20090093717; 20090083211; 20090081645; 20090080777; 20090077093; 20090070346; 20090063537; 20090060042; 20090055257; 20090055147; 20090048841; 20090043714; 20090028441; 20090024555; 20090022472; 20090022374; 20090012766; 20090010495; 20090006378; 20080319973; 20080310005; 20080302657; 20080300875; 20080300797; 20080275671; 20080267471; 20080263088; 20080261820; 20080261516; 20080260247; 20080256093; 20080249414; 20080243839; 20080243817; 20080243816; 20080243815; 20080243638; 20080243637; 20080234977; 20080232687; 20080226151; 20080222225; 20080222075; 20080221876; 20080215510; 20080212899; 20080208855; 20080208828; 20080201397; 20080198231; 20080198160; 20080191035; 20080189306; 20080188964; 20080183546; 20080182282; 20080181479; 20080177640; 20080177538; 20080162541; 20080155335; 20080152231; 20080147655; 20080147591; 20080147441; 20080147440; 20080147438; 20080146334; 20080144943; 20080126464; 20080123940; 20080114800; 20080114756; 20080114710; 20080114564; 20080112684; 20080109288; 20080101705; 20080097820; 20080091423; 20080082426; 20080077570; 20080069437; 20080057590; 20080037872; 20080037536; 20080033658; 20080030836; 20080010605; 20080010273; 20080010272; 20080010262; 20080010045; 20080005137; 20070291958; 20070288465; 20070286489; 20070285575; 20070276723; 20070275108; 20070269804; 20070263900; 20070255707; 20070250522; 20070244768; 20070239982; 20070239741; 20070239694; 20070233711; 20070231921; 20070217676; 20070198553; 20070192063; 20070192034; 20070185946; 20070180980; 20070179784; 20070174335; 20070172803; 20070156516; 20070154931; 20070154066; 20070150443; 20070141527; 20070129991; 20070129011; 20070128573; 20070111316; 20070106405; 20070093966; 20070092905; 20070092888; 20070078846; 20070067212; 20070064627; 20070054266; 20070050708; 20070044010; 20070038612; 20070033533; 20070033521; 20070033515; 20070033292; 20070033221; 20070033214; 20070033170; 20070025637; 20070022279; 20070008905; 20070006177; 20070005556; 20070003138; 20060282425; 20060282298; 20060281473; 20060253258; 20060248141; 20060246495; 20060239338; 20060224356; 20060212337; 20060208185; 20060195415; 20060195269; 20060195204; 20060190465; 20060190191; 20060177837; 20060136589; 20060112146; 20060106816; 20060101377; 20060101060; 20060095521; 20060093208; 20060093188; 20060074924; 20060074771; 20060074621; 20060064177; 20060058592; 20060053142; 20060053129; 20060052943; 20060041414; 20060034545; 20060031219; 20060020662; 20060015630; 20060015341; 20060013482; 20050286774; 20050285937; 20050283328; 20050281291; 20050278324; 20050273319; 20050267993; 20050267992; 20050267991; 20050265331; 20050262044; 20050256413; 20050255458; 20050251882; 20050225678; 20050198575; 20050193216; 20050192768; 20050185848; 20050182570; 20050180638; 20050176057; 20050175244; 20050164273; 20050163384; 20050163373; 20050149269; 20050147303; 20050138056; 20050137806; 20050132069; 20050130230; 20050130215; 20050120105; 20050114331; 20050102305; 20050102272; 20050085436; 20050075995; 20050058336; 20050027829; 20050015376; 20050010571; 20040267774; 20040260694; 20040254901; 20040249939; 20040249789; 20040243362; 20040233987; 20040230586; 20040213461; 20040181527; 20040177069; 20040175700; 20040172225; 20040171063; 20040170318; 20040162834; 20040162647; 20040139067; 20040130546; 20040129199; 20040127777; 20040122797; 20040107205; 20040103377; 20040101198; 20040091933; 20040075656; 20040071368; 20040068332; 20040056778; 20040049517; 20040048264; 20040036716; 20040024773; 20040024758; 20040024739; 20040019574; 20040013292; 20040003005; 20040002973; 20040002954; 20030229635; 20030208488; 20030205124; 20030175720; 20030174179; 20030161500; 20030161396; 20030158842; 20030145014; 20030139851; 20030138978; 20030129660; 20030120630; 20030107768; 20030101003; 20030100996; 20030097357; 20030097356; 20030093227; 20030088563; 20030078509; 20030078494; 20030074251; 20030065661; 20030065635; 20030061249; 20030059081; 20030058339; 20030054573; 20030050923; 20030050908; 20030046253; 20030046018; 20030044062; 20030044053; 20030036093; 20030033138; 20030028564; 20030016250; 20030014191; 20030009469; 20030009333; 20020191034; 20020190198; 20020184080; 20020183966; 20020181786; 20020181711; 20020147703; 20020146175; 20020143989; 20020132479; 20020131641; 20020129038; 20020128781; 20020122587; 20020115070; 20020111966; 20020099721; 20020099675; 20020091655; 20020069218; 20020050990; 20020049740; 20020033835; 20020023061; 20020002555; 20020002550; 20020000986; 20010055019; 20010048753; 20010014868; 20010000356; 8,200,648; 8,200,506; 8,195,734; 8,195,670; 8,195,345; 8,191,783; 8,190,663; 8,190,082; 8,184,913; 8,183,050; 8,180,766; 8,180,627; 8,180,147; 8,175,896; 8,175,730; 8,175,412; 8,170,961; 8,170,306; 8,169,681; 8,169,481; 8,165,407; 8,165,406; 8,164,507; 8,150,169; 8,145,669; 8,139,838; 8,135,719; 8,135,681; 8,135,680; 8,135,679; 8,122,502; 8,122,045; 8,117,213; 8,117,204; 8,117,203; 8,117,139; 8,116,566; 8,108,931; 8,108,405; 8,108,392; 8,099,381; 8,097,469; 8,095,830; 8,095,521; 8,095,389; 8,090,729; 8,082,246; 8,077,984; 8,073,652; 8,065,316; 8,065,248; 8,055,677; 8,051,139; 8,051,082; 8,046,362; 8,041,715; 8,032,476; 8,027,977; 8,019,766; 8,015,183; 8,015,125; 8,015,124; 8,014,957; 8,014,591; 8,010,589; 8,010,466; 8,005,294; 8,000,533; 8,000,527; 7,996,369; 7,991,557; 7,979,435; 7,979,362; 7,975,039; 7,975,035; 7,970,627; 7,966,327; 7,966,225; 7,966,130; 7,962,651; 7,958,096; 7,954,090; 7,953,705; 7,953,679; 7,949,186; 7,937,349; 7,937,234; 7,933,915; 7,933,740; 7,930,189; 7,926,026; 7,917,517; 7,917,306; 7,912,734; 7,912,726; 7,912,290; 7,912,284; 7,904,303; 7,899,564; 7,894,995; 7,894,669; 7,890,512; 7,890,510; 7,890,294; 7,889,914; 7,889,679; 7,885,966; 7,882,126; 7,882,119; 7,879,620; 7,876,947; 7,873,616; 7,868,786; 7,865,456; 7,856,434; 7,849,027; 7,848,567; 7,842,874; 7,835,542; 7,831,549; 7,831,531; 7,831,325; 7,827,183; 7,827,181; 7,826,635; 7,823,055; 7,822,426; 7,813,580; 7,805,496; 7,805,443; 7,805,266; 7,801,893; 7,801,685; 7,783,249; 7,773,784; 7,767,395; 7,761,448; 7,752,208; 7,747,547; 7,747,390; 7,747,054; 7,746,534; 7,743,059; 7,739,284; 7,736,905; 7,716,148; 7,711,846; 7,707,210; 7,702,155; 7,697,785; 7,693,683; 7,689,457; 7,688,495; 7,685,090; 7,684,963; 7,679,617; 7,660,468; 7,657,379; 7,657,126; 7,657,100; 7,650,320; 7,644,090; 7,643,597; 7,639,868; 7,639,714; 7,624,337; 7,613,572; 7,610,306; 7,603,326; 7,599,917; 7,599,799; 7,590,264; 7,584,168; 7,580,682; 7,580,556; 7,574,409; 7,574,069; 7,570,213; 7,567,961; 7,565,432; 7,565,346; 7,565,251; 7,565,213; 7,562,325; 7,562,015; 7,558,425; 7,555,441; 7,552,474; 7,552,131; 7,545,978; 7,539,656; 7,529,732; 7,526,101; 7,519,227; 7,519,209; 7,516,149; 7,512,524; 7,499,916; 7,492,943; 7,487,056; 7,475,085; 7,468,730; 7,464,074; 7,458,050; 7,450,746; 7,450,122; 7,437,308; 7,428,541; 7,428,528; 7,426,301; 7,424,462; 7,418,136; 7,406,200; 7,401,087; 7,397,946; 7,395,250; 7,389,281; 7,386,426; 7,376,752; 7,369,961; 7,369,889; 7,369,680; 7,346,601; 7,337,158; 7,328,363; 7,325,201; 7,296,088; 7,296,011; 7,293,036; 7,287,019; 7,275,018; 7,272,262; 7,263,220; 7,251,648; 7,246,128; 7,246,012; 7,231,074; 7,225,397; 7,222,126; 7,221,794; 7,216,129; 7,215,786; 7,206,778; 7,202,791; 7,196,705; 7,188,055; 7,177,470; 7,174,048; 7,167,578; 7,158,970; 7,142,602; 7,139,739; 7,111,188; 7,068,723; 7,065,587; 7,065,521; 7,062,083; 7,058,650; 7,058,638; 7,054,724; 7,047,252; 7,043,463; 7,039,621; 7,039,446; 7,035,823; 7,035,431; 7,031,980; 7,031,844; 7,016,531; 7,010,520; 6,999,886; 6,993,186; 6,980,984; 6,976,016; 6,970,796; 6,968,342; 6,961,721; 6,954,756; 6,950,752; 6,915,241; 6,912,547; 6,907,380; 6,906,719; 6,904,420; 6,895,267; 6,854,096; 6,845,377; 6,841,403; 6,834,278; 6,834,266; 6,832,162; 6,826,316; 6,819,793; 6,816,848; 6,807,306; 6,804,670; 6,801,859; 6,801,645; 6,799,175; 6,797,526; 6,785,419; 6,785,409; 6,778,981; 6,778,699; 6,763,128; 6,760,701; 6,757,415; 6,751,614; 6,751,363; 6,750,859; 6,735,465; 6,735,336; 6,732,119; 6,711,585; 6,701,026; 6,700,115; 6,684,177; 6,674,905; 6,643,629; 6,636,849; 6,627,464; 6,615,205; 6,594,658; 6,592,627; 6,584,433; 6,564,197; 6,556,983; 6,539,352; 6,535,881; 6,526,389; 6,519,591; 6,505,191; 6,496,834; 6,487,554; 6,473,522; 6,470,094; 6,468,476; 6,466,695; 6,463,433; 6,453,246; 6,445,391; 6,437,796; 6,424,973; 6,424,971; 6,421,612; 6,415,046; 6,411,953; 6,400,831; 6,389,169; 6,373,485; 6,351,712; 6,331,859; 6,300,965; 6,295,514; 6,295,504; 6,295,367; 6,282,538; 6,263,334; 6,263,088; 6,249,241; 6,203,987; 6,192,364; 6,185,314; 6,140,643; 6,122,628; 6,121,969; 6,112,186; 6,100,825; 6,092,049; 6,085,151; 6,049,777; 6,041,311; 5,949,367; 5,940,833; 5,940,529; 5,926,820; 5,920,852; 5,889,523; 5,872,850; 5,813,002; 5,809,490; 5,795,727; 5,764,283; 5,748,780; 5,731,989; 5,724,571; 5,717,915; 5,710,916; 5,699,507; 5,668,897; 5,627,040; 5,625,704; 5,574,837; 5,566,078; 5,506,801; 5,497,486; 5,463,702; 5,448,684; 5,442,792; 5,327,521; 5,285,291; 5,253,307; 5,020,411; 4,965,580; 4,855,923; 4,773,093; 4,257,703; and 4,081,607.
Abraham, Ittai, et al. “Low-distortion inference of latent similarities from a multiplex social network.” SIAM Journal on Computing 44.3 (2015): 617-668.
Aldenderfer, M. S., and R. K. Blashfield. Cluster Analysis. Sage Publications, Los Angeles, 1985.
Anderberg, M. R. (1973). Cluster Analysis for Applications. Academic Press, New York.
Anderson, E. (1957). A semi-graphical method for the analysis of complex problems. Proc. Nat. Acad. Sci. USA 43923-927.
Anderson, T. W. (1958). An Introduction to Multivariate Statistical Analysis. Wiley, New York.
Anderson, T. W., and Bahadur, R. R. (1962). classification into two multivariate normal distributions with different covariance matrices. Ann. Math. Statist. 33420-431.
Andrews, D. F. (1972). Plots of high-dimensional data. Biometrics 28 125-136.
Ankerst, M., M. M. Breunig, H.-P. Kriegel, and J. Sander. OPTICS: Ordering Points To Identify the Clustering Structure. In Proc. of 1999 ACM-SIGMOD Intl. Conf. on Management of Data, pages 49-60, Philadelphia, Pennsylvania, June 1999. ACM Press.
Arabie, P. (1977). clustering representations of group overlap. J. Math. Soc. 5 112-128.
Arabie, P. and Carroll, J. D. (1980). MAPCLUS: A mathematical programming approach to fitting to ADCLUS model. Psychometrika 45211-235.
Arabie, P., L. Hubert, and G. D. Soete. An overview of combinatorial data analysis. In P. Arabie, L. Hubert, and G. D. Soete, editors, Clustering and Classification, pages 188-217. World Scientific, Singapore, January 1996.
Art, D., Gnanadesikan, R., and Kettenring, J. R. (1982). Data-based metrics for cluster analysis. Utilitas Mathematica 31A 75-99.
Asimov, D. (1985). The grand tour. SLAM J. Sci. Statist. Corn-put. 6128-143.
Auffarth, Benjamin, Yasumasa Muto, and Yasuharu Kunii. “An artificial system for visual perception in autonomous Robots.” Proceedings of the IEEE International Conference on Intelligent Engineering Systems. 2005.
Babu, B. Hari, N. Subash Chandra, and T. Venu Gopal. “Clustering Algorithms For High Dimensional Data-A Survey Of Issues And Existing Approaches.”
Baker, F. B. (1974). Stability of two hierarchical grouping techniques, Case I: Sensitivity to data errors. J. Amer. Statist. Assoc. 69440-445.
Ball, G., and D. Hall. A Clustering Technique for Summarizing Multivariate Data. Behavior Science, 12:153-155, March 1967.
Banerjee, A., S. Merugu, I. S. Dhillon, and J. Ghosh. Clustering with Bregman Divergences. In Proc. of the 2004 SIAM Intl. Conf. on Data Mining, pages 234-245, Lake Buena Vista, FL, April 2004.
Baraglia, R., Dazzi, P., Mordacchini, M., & Ricci, L. (2013). A peer-to-peer recommender system for self-emerging user communities based on gossip overlays. Journal of Computer and System Sciences, 79(2), 291-308.
Baragliaa, R., Dazzia, P., Mordacchinib, M., & Riccic, L. A Peer-to-Peer Recommender System for self-emerging user communities based on Gossip Overlays. (2012)
Beck, Carolyn, et al. “Dynamic Coverage and Clustering: A Maximum Entropy Approach.” Distributed Decision Making and Control. Springer London, 2012. 215-243.
Becker, P. (1968). Recognitions of Patterns. Polyteknisk, Copenhagen.
Bell, P. A. and Korey, J. L. (1975). QUICLSTR: A FOR'TRAN program for hierarchical cluster analysis with a large number of subjects. Behavioral Research Methods and Instrumentation 7575.
Berg, Mikko. “Human abilities to perceive, understand, and manage multi-dimensional information with visualizations.” (2012).
Berkhin, P. Survey Of Clustering Data Mining Techniques. Technical report, Accrue Software, San Jose, C A, 2002.
Bhat, Sajid Yousuf, and Muhammad Abulaish. “A density-based approach for mining overlapping communities from social network interactions.” Proceedings of the 2nd International Conference on Web Intelligence, Mining and Semantics. ACM, 2012.
Binder, D. A. (1978). Comment on ‘Estimating mixtures of normal distributions and switching regressions’. j Amer. Statist. Assoc. 73746-747.
Blashfield, R. K., Aldenderfer, M. S. and Morey, L. C. (1982). cluster analysis literature on validation. In Classifying Social Data. (H. Hudson, ed.) 167-176. Jossey-Bass, San Francisco.
Bock, H. H. (1985). On significance tests in cluster analysis. J. Classification 277-108.
Boley, D. Principal Direction Divisive Partitioning. Data Mining and Knowledge Discovery, 2(4):325-344, 1998.
Boley, Daniel, and Vivian Borst. “A General Unsupervised Clustering Tool for Unstructured Data.” matrix 100: 2.
Boratto, Ludovico. “Group recommendation with automatic detection and classification of groups.” (2012).
Bradley, P. S. and U. M. Fayyad. Refining Initial Points for K-Means Clustering. In Proc. of the 15th Intl. Conf. on Machine Learning, pages 91-99, Madison, WI, July 1998. Morgan Kaufmann Publishers Inc.
Breiman, L. Meisel, W. S., and Purcell, E. (1977). Variable kernel estimates of multivariate densities and their calibration. Technometrics 19 135-144.
Brieman, L., Friedman, J. H., Olshen, R. A., and Stone, C. J. (1984). Classification and Regression Trees. Wadsworth, Belmont, CA.
Broadbent, S. R. and Hammersley, J. M. (1957). Percolation Processes, I: Crystals and Mazes. Proc. Cambridge Philos. Soc. 53629-641
Bu, Yingyi, et al. “The HaLoop approach to large-scale iterative data analysis.” The VLDB Journal-The International Journal on Very Large Data Bases 21.2 (2012): 169-190.

Buja, A., Hurify, C. and Mcdonald, J. A. (1986). A data viewer for multivariate data. Computer Science and Statistics: Proceedings of the 18th Symposium on the Interface 171-174.
Cacoullos, T. (1966). Estimation of a multivariate density. Ann. Math. Statist. 18 179-189.
Cai, Rui, et al. “Scalable music recommendation by search.” Proceedings of the 15th international conference on Multimedia. ACM, 2007.
Carrizosa, Emilio, and Dolores Romero Morales. “Supervised classification and mathematical optimization.” Computers & Operations Research 40.1 (2013): 150-165.
Chang, Chin-Chun, and Hsin-Yi Chen. “Semi-supervised clustering with discriminative random fields.” Pattern Recognition 45.12 (2012): 4402-4413.
Chen, H., Gnanadesikan, R., and Kettenring, J. R. (1974). Statistical methods for grouping corporations. Sankhya B 361-28.
Chen, Yen Hung. “The k Partition-Distance Problem.” Journal of Computational Biology 19.4 (2012): 404-417.
Cheng, Hong, et al. “Clustering large attributed information networks: an efficient incremental computing approach.” Data Mining and Knowledge Discovery 25.3 (2012): 450-477.
Chernoff, H. (1972). The selection of effective attributes for deciding between hypotheses using linear discriminant functions. In Frontiers of Pattern Recognition. (S. Watanabe, ed.) 55-60. Academic Press, New York.
Chernoff, H. (1973a). Some measures for discriminating between normal multivariate distributions with unequal covariance matrices. In Multivariate Analysis III. (P. R. Krishnaiah, ed.) 337-344. Academic Press, New York.
Chernoff, H. (1973b). The use of faces to represent points in k-dimensional space graphically. J Amer. Statist. Assoc. 68 361-368.
Cherubini, Umberto, and Agnese Sironi. Bond Trading, Market Anomalies and Neural Networks: An Application with Kohonen Nets. No._012. Society for Computational Economics.
Christou, loannis T., George Gekas, and Anna Kyrikou. “A classifier ensemble approach to the TV-viewer profile adaptation problem.” International Journal of Machine Learning and Cybernetics 3.4 (2012): 313-326.
Clunies-Ross, C. W. and Riffenburgh, R. H. (1960). Geometry and linear discrimination. Biometrika 47185-189.
Cormack, R. M. (1971). A review of classification (with discussion). J Roy. Statist. Soc. A 134321-367.
Cornfield, J. (1962). Joint dependence of rish of coronary heart disease on serum cholesterol and systolic blood pressure: a discriminant function analysis. Federal Proceedings 21 58-61.
Cover, T. M. (1968). Estimation by the nearest neighbor rule. IEEE Transactions Information Theory IT-14 50-55.
Cover, T. M. and Hart, P. E. (1967). Nearest neighbor pattern classification. IEEE Transactions, Information Theory IT-13 21-27.
Dallal, G. E. (1975) A user's guide to J. A. Hartigan's clustering algorithms. (unpublished manuscript) Yale University.
Day, N. E. (1969). Estimating the components of a mixture of normal distributions. Biometrika 56463-474.
Day, N. E., and Kerridge, D. F., (1967). A general maximum likelihood discriminant. Biometrics 23313-323. 94
de Máster, Trabajo Fin. “Novelty and Diversity Enhancement and Evaluation in Recommender Systems.” (2012).
Defays, D. (1977). An efficient algorithm for a complete link method. Computer Journal 20364-366.
Derrac, Joaquin, Isaac Triguero, Salvador Garcia, and Francisco Herrera. “Integrating instance selection, instance weighting, and feature weighting for nearest neighbor classifiers by coevolutionary algorithms.” Systems, Man, and Cybernetics, Part B: Cybernetics, IEEE Transactions on 42, no. 5 (2012): 1383-1397.
Devi, B. Naveena, et al. “Design and implementation of web usage mining intelligent system in the field of e-commerce.” Procedia Engineering 30 (2012): 20-27.
Dhillon, I. S., and D. S. Modha. Concept Decompositions for Large Sparse Text Data Using Clustering. Machine Learning, 42(1/2):143-175, 2001.
Dhillon, I. S., Y. Guan, and J. Kogan. Iterative Clustering of High Dimensional Text Data Augmented by Local Search. In Proc. of the 2002 IEEE Intl. Conf. on Data Mining, pages 131-138. IEEE Computer Society, 2002.
Dick, N. P. and Bowden, D. C. (1973). Maximum likelihood estimation for mixtures of two normal distributions. Biometrics 29781-790
Dixon, W. J. (ed.) (1981). BMDP Statistical Software. University of California Press, Berkeley.
Donoho, A. W., Donoho, D. L. and Gasko, M. (1985). MacS-pin graphical data analysis software. D2 Software, Austin.
Dragut, Andreea B. “Stock Data Clustering and Multiscale Trend Detection.” Methodology and Computing in Applied Probability 14.1 (2012): 87-105.
Dragut, Eduard C., Weiyi Meng, and Clement T. Yu. “Deep Web Query Interface Understanding and Integration.” Synthesis Lectures on Data Management 7.1 (2012): 1-168.
Drosou, Marina, and Evaggelia Pitoura. “Dynamic diversification of continuous data.” Proceedings of the 15th International Conference on Extending Database Technology. ACM, 2012.
Duda, R. O. and Hart, P. E. (1973). Pattern Classification and Scene Analysis. Wiley, New York.
Duda, R. O., P. E. Hart, and D. G. Stork. Pattern Classification. John Wiley & Sons, Inc., New York, second edition, 2001.
Edmonston, B. (1985). MICRO-CLUSTER: Cluster analysis software for microcomputers. Journal of Classification 2 127-130.
Efron, B. (1975). The efficiency of logistic regression compared to normal discriminant analysis. j Amer. Statist. Assoc. 70 892-898.
Efron, B. (1979). Bootstrap methods: Another look at the jack-knife. Ann. Statist. 7 1-26.
Efron, B. (1982). The Jackknife, The Bootstrap, and Other Resampling Plans, SIAM NSF-CBMS, Monograph #38.
Efron, B. (1983). Estimating the error rate of a prediction rule: Improvements on cross-validation. J. Amer. Statist. Assoc. 78 316-331.
Ehmke, Jan Fabian. “Knowledge Discovery and Data Mining.” Integration of Information and Optimization Models for Routing in City Logistics. Springer US, 2012. 37-57.
Ester, M., H.-P. Kriegel, J. Sander, and X. Xu. A Density-Based Algorithm for Discovering Clusters in Large Spatial Databases with Noise. In Proc. of the 2nd Intl. Conf. on Knowledge Discovery and Data Mining, pages 226-231, Portland, Oregon, August 1996. AAAI Press.
Ester, M., H.-P. Kriegel, J. Sander, M. Wimmer, and X. Xu. Incremental Clustering for Mining in a Data Warehousing Environment. In Proc. of the 24th VLDB Conf., pages 323-333, New York City, August 1998. Morgan Kaufmann.
Everitt, B. (1980). Cluster Analysis. 2nd ed. Halsted, New York.
Everitt, B. S. and Hand, D. J. (1981). Finite Mixture Distributions. Chapman and Hall, London.
Everitt, B. S., S. Landau, and M. Leese. Cluster Analysis. Arnold Publishers, London, fourth edition, May 2001.
Farver, T. B. and Dunn, 0. J. (1979). Stepwise variable selection in classification problems. Biom. J. 21 145-153.
Fisher, D. Iterative Optimization and Simplification of Hierarchical Clusterings. Journal of Artificial Intelligence Research, 4:147-179, 1996.
Fisher, R. A. (1936). The use of multiple measurements in taxonomic problems. Ann. Eugenics 7 (part 2) 179-188.
Fisherkeller, M. A., Friedman, J. H., and Tukey, J. W. (1974). Prim-9: An interactive multidimensional data display and analysis system. SLAC-Pub. 1408, Stanford Linear Accelerator Center, Stanford, California.
Fitch, W. M. and Marcouash, E. (1967). Construction of phylogenetic trees. Science 155279-284.
Fix, E. and Hodges, J. (1951). Discriminatory analysis, non-parametric discrimination: consistency properties. Technical Report. Randolph Field, Texas: USAF School of Aviation Medicine.
Fouad, Khaled M., et al. “Web-based Semantic and Personalized Information Retrieval Semantic and Personalized Information Retrieval Semantic and Personalized Information Retrieval.” (2012).
Fournier, Chris, and Diana Inkpen. “Segmentation similarity and agreement.” Proceedings of the 2012 Conference of the North American Chapter of the Association for Computational Linguistics: Human Language Technologies. Association for Computational Linguistics, 2012.
Fowixes, E. B. (1987). Some diagnostics for binary logistic regression via smoothing. Biometrika to appear.
Fowlkes, E. B. and Mallows, C. L. (1983). A method for comparing two hierarchical clusterings (with discussion). J Amer. Statist. Assoc. 78553-583.
Fowlkes, E. B., Gnanadesikan, R. and Kettenring, J. R. (1987). Variable selection in clustering and other contexts. In Design, Data, and Analysis, by Some Friends of Cuthbert Daniel (C. L. Mallows, ed.). Wiley, New York, to appear.
Friedman, H. P. and Rubin, J. (1967). On some invariant criteria for grouping data. Journal of American Statistical Association 62 1159-1178.
Friedman, J. H. and Tukey, J. W. (1974). A projection pursuit algorithm for exploratory data analysis. IEEE Trans. Comput. C-23 881-889.
Ganu, Gayatree, Yogesh Kakodkar, and AméLie Marian. “Improving the quality of predictions using textual information in online user reviews.” Information Systems 38.1 (2013): 1-15.
Gao, J., Hu, W., Zhang, Z. M., & Wu, 0. (2012). Unsupervised ensemble learning for mining top-n outliers. In Advances in Knowledge Discovery and Data Mining (pp. 418-430). Springer Berlin Heidelberg.
Ghaemi, Reza, et al. “A novel fuzzy C-means algorithm to generate diverse and desirable cluster solutions used by genetic-based clustering ensemble algorithms.” Memetic Computing 4.1 (2012): 49-71.
Gnanadesikan, R. (1977). Methods for Statistical Data Analysis of Multivariate Observations. Wiley, New York.
Gnanadesikan, R. and Kettenring, J. R. (1984). A pragmatic review of multivariate methods in applications. In Statistics: An Appraisal. (H. A. David and H. T. David, eds.).
Gnanadesikan, R., Kettenring, J. R. and Landwehr, J. M. (1982). Projection plots for displaying clusters. In Statistics and Probability: Essays in Honor of C. R. Rao. (G. Kallianpur, P. R. Krishnaiah and J. K. Ghosh, eds.) 281-294. North-Holland, Amsterdam.
Gnanadesikan, R., Kettenring, J. R., and Landwehr, J. M. (1977). Interpreting and assessing the results of cluster analyses. Bull Int. Statis. Inst. 47451-463.
Goldman, L., Weinberg, M., Weisberg, M., Olshen, R., Cook, F., Sargent, R. K., Lamas, G. A., Dennis, C., Deckelbam, L., Fineberg, H., Stiratelu, R. and the Medical Housestaffs At Yale-New Haven Hospital and Brigham and Women's Hospital (1982). A computer-derived protocol to aid in the diagnosis of emergency room patients with acute chest pain. The New England Journal of Medicine 307588-596.
Gong, G. (1982). Cross-validation, the jackknife, and the bootstrap: excess error estimation in forward logistic regression. Ph.D. dissertation. Stanford University Technical Report No. 80. Department of Statistics.
Gordon, L. and Olshen, R. A. (1978). Asymptotically efficient solutions to the classification problem. Ann. Statist. 6 515-533.
Gordon, L. and Olshen, R. A. (1980). Consistent non-parametric regression from recursive partitioning schemes. J. Mult. Anal. 10 611-627.
Gordon, L. and Olshen, R. A. (1984). Almost surely consistent nonparametric regression from recursive partitioning schemes. J. Mult. Anal. 15 147-163.
Gower, J. C. and Ross, G. J. S. (1969). Minimum spanning trees and single linkage cluster analysis. Appl. Statist. 18 54-65.
Gray, J. B. and Ling, R. F. (1984). K-clustering as a detection tool for influential subsets regression (with discussion). Technometrics 26 305-330.
Gulhane, Ashwini, Prashant L. Paikrao, and D. S. Chaudhari. “A review of image data clustering techniques.” International Journal of Soft Computing and Engineering 2.1 (2012): 212-215.
Gülten, Sitki, and Andrzej Ruszczyński. “Two-stage portfolio optimization with higher-order conditional measures of risk.” Annals of Operations Research 229.1 (2015): 409-427.
Haff, L. R. (1986). On linear log-odds and estimation of discriminant coefficients. Commun. Statist.-Theor. Meth. 15 2131-2144.
Halkidi, M., Y. Batistakis, and M. Vazirgiannis. Cluster validity methods: part I. SIGMOD Record (ACM Special Interest Group on Management of Data), 31(2):40-45, June 2002.
Halkidi, M., Y. Batistakis, and M. Vazirgiannis. Clustering validity checking methods: part II. SIGMOD Record (ACM Special Interest Group on Management of Data), 31 (3):19-27, September 2002.
Hall, D. J. and Khanna, D. (1977). The ISODATA method of computation for relative perception of similarities and differences in complex and real data. In Statistical Methods for Digital Computers (Vol. 3). (K Enslein, A. Ralston, and H. W. Wilf, eds.) New York: John Wiley.
Hamerly, G. and C. Elkan. Alternatives to the k-means algorithm that find better clusterings. In Proc. of the 11th Intl. Conf. on Information and Knowledge Management, pages 600-607, McLean, Virginia, 2002. ACM Press.
Han, J., M. Kamber, and A. Tung. Spatial Clustering Methods in Data Mining: A review. In H. J. Miller and J. Han, editors, Geographic Data Mining and Knowledge Discovery, pages 188-217. Taylor and Francis, London, December 2001.
Hand, D. J. (1981). Discrimination and Classification. Wiley, New York.
Hartigan, J. A. (1967). Representation of similarity matrices by trees. J Amer. Statist. Assoc. 621140-1158.
Hartigan, J. A. (1975). Clustering Algorithms. Wiley, New York.
Hartigan, J. A. (1977). Distribution problems in clustering. In Classification and Clustering (J. Van Ryzin, ed.) 45-71. Academic Press, New York.
Hartigan, J. A. (1978). Asymptotic distributions for clustering criteria. Ann. Statist. 6 117-131.
Hartigan, J. A. (1981). Consistency of single linkage for high density clusters. J. Amer. Statist Assoc. 76388-394.
Hartigan, J. A. and Hartigan, P. M. (1985). The dip test of multimodality. Ann. of Statist. 1370-84.
Hastie, T., R. Tibshirani, and J. H. Friedman. The Elements of Statistical Learning: Data Mining, Inference, Prediction. Springer, New York, 2001.
Hermans, J., Habbema, J., and Schaefer, R. (1982). The ALLOC80 package for discriminant analysis, Stat. Software Newsletter, 8 15-20.
Hodge, V., Tom Jackson, and Jim Austin. “Intelligent decision support using pattern matching.” Proceedings of the 1st International Workshop on Future Internet Applications for Traffic Surveillance and Management (FIATS-M 2011), Sofia, Bulgaria. 2011.
Hodson, F. R., Sneath, P. H. A. and Doran, J. E. (1966). Some experiments in the numerical analysis of archaeological data. Biometrika 53311-324.
Hosmer, D. W. (1973). A comparison of iterative maximum likelihood estimates of the parameters of a mixture of two normal distributions under three different typos of sample. Biometrics 29761-770.
Huber, P. J. (1985). Projection pursuit (with discussion). Ann. Statist. 6701-726. International Mathematical and Statistical Library (1977). Reference manual library 1, ed. 6. Vol. 1. Houston.
IIango, V., R. Subramanian, and V. Vasudevan. “A Five Step Procedure for Outlier Analysis in Data Mining.” European Journal of Scientific Research 75.3 (2012): 327-339.
Jain, A. K. and R. C. Dubes. Algorithms for Clustering Data. Prentice Hall Advanced Reference Series. Prentice Hall, March 1988. www.cse.msu.edu/˜jain/Clustering Jain Dubes.pdf.
Jain, A. K., M. N. Murty, and P. J. Flynn. Data clustering: A review. ACM Computing Surveys, 31(3):264-323, September 1999.
Jambu, M. and Lebeaux, M. O. (1983). Cluster Analysis and Data Analysis. North-Holland Publishing Company, Amsterdam.
James, W. and Stein, C. (1961). Estimation with quadratic loss. Proc. Fourth Berkeley Symp. Math. Statist. Prob. 1311-319.
Jardine, C. J., Jardine, N. and Sibson, R. (1967). The structure and construction of taxonomic hierarchies. Math. Biosci. 1173-179.
Jardine, N. and R. Sibson. Mathematical Taxonomy. Wiley, New York, 1971.
Jayasimhan, Anusha, and Jayant Gadge. “Anomaly Detection using a Clustering Technique.” International Journal of Applied Information Systems (IJAIS)-ISSN (2012): 2249-0868.
Jennrich, R. and Moore, R. H. (1975). Maximum likelihood estimation by means of nonlinear least squares. Proceedings of the Statistical Computing Section, American Statistical Association, 57-65.
Jennrich, R. I. (1962). Linear Discrimination in the Case of Unequal Covariance Matrices. Unpublished manuscript.
Joenväärä, Juha, Robert Kosowski, and Pekka Tolonen. “Revisiting “stylized facts” about hedge funds.” Imperial College Business School (2012).
Johnson, S. C. (1967). Hierarchical clustering schemes. Psychometrika 32241-254.
Jouis, Christophe; Biskri, Ismail; Ganascia, Jean-Gabriel; Roux, Magali, “Next Generation Search Engines”, IGI GlobalPub, Mar. 31, 2012 (ISBN-10: 1-4666-0330-5).
Karypis, G., CLUTO 2.1.1: Software for Clustering High-Dimensional Datasets. www.cs.umn.edu/-karypis, November 2003.
Karypis, G., E.-H. Han, and V. Kumar. Multilevel Refinement for Hierarchical Clustering. Technical Report TR 99-020, University of Minnesota, Minneapolis, M N, 1999.
Kaufman, L. and P. J. Rousseeuw. Finding Groups in Data: An Introduction to Cluster Analysis. Wiley Series in Probability and Statistics. John Wiley and Sons, New York, November 1990.
Keshavarzi, M., M. A. Dehghan, and M. Mashinchi. “Applications of classification based on similarities and dissimilarities.” Fuzzy Information and Engineering 4.1 (2012): 75-91.
Kettenring, J. R., Rogers, W. H., Smith, M. E., and Warner, J. L. (1976). Cluster analysis applied to the validation of course objectives. J. Educ. Statist. 1 39-57.
Kitto, Kirsty, and Fabio Boschetti. “Attitudes, ideologies and self-organisation: Information load minimisation in multi-agent decision making.” Advances in Complex Systems 16.2 (2013).
Kleinberg, J. M. An Impossibility Theorem for Clustering. In Proc. of the 16th Annual Conf. on Neural Information Processing Systems, Dec., 9-14 2002.
Kleiner, B. and Hartigan, J. A. (1981). Representing points in many dimensions by trees and castles (with discussion). j Amer. Statist. Assoc. 76260-276.
Kruliš, Martin, Tomáš Skopal, Jakub Lokoč, and Christian Beecks. “Combining CPU and GPU architectures for fast similarity search.” Distributed and Parallel Databases 30, no. 3-4 (2012): 179-207.
Kumar, B. Santhosh, V. Vijayaganth, Data Clustering Using K-Means Algorithm For High Dimensional Data, International Journal of Advanced Research In Technology (ijart.org); 2(1)22-32, February 2012
Lachenbruch P. A. (1975) Discriminant Analysis. Hafner Press, New York.
Lachenbruch, P. A. (1982). Robustness of discriminant flirictions. SUGI-SAS Group Proceedings 7626-632.
Landwehr J. M., Pregibon, D., and Shoemaker, K C. (1984). Graphical methods for assessing logistic regression models (with discussion). J Amer. Statist. Assoc. 7961-83.
Larsen, B. and C. Aone. Fast and Effective Text Mining Using Linear-Time Document Clustering. In Proc. of the 5th Intl. Conf. on Knowledge Discovery and Data Mining, pages 16-22, San Diego, California, 1999. ACM Press.
Le Capitaine, Hoel. “A relevance-based learning model of fuzzy similarity measures.” IEEE Transactions on Fuzzy Systems 20, no. 1 (2012): 57-68.
Le, Hai-Son Phuoc. “Probabilistic Models for Collecting, Analyzing, and Modeling Expression Data.” (2013).
Lee, Kwangchun, and Dan Hyung Lee. “A Market-Driven Product Line Scoping.” Software Engineering Research, Management and Applications 2011. Springer Berlin Heidelberg, 2012. 27-46.
Lennington, R. K. and Rossbach, M. E. (1978). CLASSY: An adaptive maximum likelihood clustering algorithm. Paper presented at 1978 meeting of the Classification Society.
Levisohn, J. R. and Funk, S. G. (1974). CLUSTER: A hierarchical clustering program for large data sets (n>100). Research Memo #40, Thurstone Psychometric Laboratory, University of North Carolina.
Li, Youguo, and Haiyan Wu. “A clustering method based on K-means algorithm.” Physics Procedia 25 (2012): 1104-1109.
Ling, R. F. (1973). A probability theory of cluster analysis. J. Amer. Statist. Assoc. 68159-169.
Liu, Keke Chen Ling. “Vista: Looking Into the Clusters in Very Large Multidimensional Datasets.” Technical; Report GIT-CC-02-30 (2002).
Lloret, Elena, et al. “Towards a unified framework for opinion retrieval, mining and summarization.” Journal of Intelligent Information Systems 39.3 (2012): 711-747.
Loohach, Richa, and Kanwal Garg. “An Insight Overview Of Issues And Challenges Associated With Clustering Algorithms.” mairec.org
Lou, Xiaojun, Junying Li, and Haitao Liu. “Improved Fuzzy C-means Clustering Algorithm Based on Cluster Density Related Work.” Journal of Computational Information Systems 2 (2012): 72.
Macqueen, J. (1967). Some methods for classification and analysis of multivariate observations. Proc. Fifth Berkeley Symp. Math. Statist. Prob. 1281-297.
MacQueen, J. Some methods for classification and analysis of multivariate observations. In Proc. of the 5th Berkeley Symp. on Mathematical Statistics and Probability, pages 281-297. University of California Press, 1967.
Madhulatha, T. Soni. “An overview on clustering methods.” arXiv preprint arXiv:1205.1117 (2012).
Marks, S. and Dunn, 0. J. (1974). Discriminant functions when covariance matrices are unequal. J. Amer. Statist. Assoc. 69, 555-559.
Martinez, Sergio, Aida Valls, and David SANchez. “Semantically-grounded construction of centroids for datasets with textual attributes.” Knowledge-Based Systems 35 (2012): 160-172.
Mccullagh, P. and Nelder, J. A. (1983). Generalized Linear Models. Chapman and Hall, London.
Mckay, R. J. (1978). A graphical aid to selection of variables in two-group discriminant analysis. Appl. Statist. 27259-263.
Mckay, R. J. and Campbell, N. A. (1982a). Variable selection techniques in discriminant analysis. 1. Description Br. J. Math. Stat. Psychol. 351-29.
Mckay, R. J. and Campbell, N. A. (1982b). Variable selection techniques in discriminant analysis. II. Allocation. Br. J. Math. Stat. Psychol. 353041.
Mianowska, Bernadetta, and Ngoc Thanh Nguyen. “Tuning user profiles based on analyzing dynamic preference in document retrieval systems.” Multimedia tools and applications 65.1 (2013): 93-118.
Michener, C. D. and Sokal R. R. (1957). A quantitative approach to a problem in classification. Evolution ii 130-162.
Milligan, G. W. Clustering Validation: Results and Implications for Applied Analyses. In P. Arabie, L. Hubert, and G. D. Soete, editors, Clustering and Classification, pages 345-375. World Scientific, Singapore, January 1996.
Mirkin, B. Mathematical Classification and Clustering, volume 11 of Nonconvex Optimization and Its Applications. Kluwer Academic Publishers, August 1996.
Mitchell, T. Machine Learning. McGraw-Hill, Boston, M A, 1997.
Mojena, R. (1977). Hierarchical grouping methods and stopping rules—An evaluation. Computer Journal 20359-363.
Mojena, R. and Wishart, D. (1980). Stopping rules for Ward's clustering method. Proceedings of COMPSTAT. Physica Verlag 426-432.
Morgan, J. N. and Messenger, R. C. (1973). THMD: a sequential search program for the analysis of nominal scale dependent variables. Institute for Social Research, U of Michigan, Ann Arbor.
Morgan, J. N. and Sonquist, J. A. (1963). Problems in the analysis of survey data, and a proposal. J. Amer. Statist. Assoc. 58415-435.
Murtagh, F. Multidimensional Clustering Algorithms. Physica-Verlag, Heidelberg and Vienna, 1985.
Naresh, Tangudu, G. Ramesh Naidu, and S. Vishnu Murty. “Learning Subject Areas by Using Unsupervised Observation of Most Informative Terms in Text Databases.” International Journal of Computer Science 1.1-2 (2012).
Navarro-Arribas, Guillermo, and Viceng Torra. “Information fusion in data privacy: A survey.” Information Fusion 13.4 (2012): 235-244.
Nelder, J. A. and Wedderburn, R. W. M. (1972). Generalized linear models. J Roy. Statist. Soc. A 135 370-384.
Olshen, R. A., Gilpin, E., Henning, H. Lewinter, M., Collins, D., and Ross., J., Jr. (1985). Twelve month prognosis following myocardial infarction: classification trees, logistic regression, and stepwise linear discrimination. Proceedings of the Berkeley Conference in Honor of Jerzy Neyman and Jack Kiefer. (L. LeCam and R. Olshen, eds.) 1 245-267. Wadsworth Advanced Books and Software, Monterey, California and the Institute of Mathematical Statistics, Hayward, California.
Pedronette, Daniel Carlos Guimaraes, and Ricardo da S. Torres. “Exploiting pairwise recommendation and clustering strategies for image re-ranking.” Information Sciences 207 (2012): 19-34.
Pelleg, D. and A. W. Moore. X-means: Extending K-means with Efficient Estimation of the Number of Clusters. In Proc. of the 17th Intl. Conf. on Machine Learning, pages 727-734. Morgan Kaufmann, San Francisco, C A, 2000.
Peters, Georg, and Richard Weber. “Dynamic clustering with soft computing.” Wiley Interdisciplinary Reviews: Data Mining and Knowledge Discovery 2.3 (2012): 226-236.
Pivovarov, Rimma, and Noemie Elhadad. “A hybrid knowledge-based and data-driven approach to identifying semantically similar concepts.” Journal of biomedical informatics 45.3 (2012): 471-481.
Pollard, D. (1982). A central limit theorem for k-means clustering. Ann. Prob. 10919-926.
Pregibon, D. (1981). Logistic regression diagnostics. Ann. Statist. 9 705-724.
Rabiner, L. R., Levinson, S. E., Rosenberg, A. E. and Wilpon, J. G. (1979). Speaker independent recognition of isolated words using clustering techniques. IEEE Trans. Accoust. Speech Signal Process. 27336-349.
Rao, C. R. (1948). The utilization of multiple measurements in problems of biological classification. J. Roy. Statist. Soc. Ser. B 10159-203.
Rao, C. R. (1952). Advanced Statistical Methods in Biometric Research. Wiley, New York.
Rao, C. R. (1960). Multivariate analysis: an indispensable statistical aid in applied research. Sankhya 22317-338.
Rao, C. R. (1962). Use of discriminant and allied functions in multivariate analysis. Sankhya A24 149-154.
Rao, C. R. (1965). Linear Statistical Inference and Its Applications. Wiley, New York.
Richhariya, Pankaj, et al. “A Survey on Financial Fraud Detection Methodologies.” International Journal of Computer Applications 45.22 (2012).
Riffenburgh, R. H. and Clunies-Ross, C. W. (1960). Linear discriminant analysis. Pacific Science 14 251-256.
Rios, Sebastien A., Roberto A. Silva, and Felipe Aguilera. “A dissimilarity measure for automate moderation in online social networks.” Proceedings of the 4th International Workshop on Web Intelligence & Communities. ACM, 2012.
Robinson, Lucy F., and Carey E. Priebe. “Detecting time-dependent structure in network data via a new class of latent process models.” arXiv preprint arXiv:1212.3587 (2012).
Rohlf, F. J. (1977). Computational efficacy of agglomerative clustering algorithms. Technical Report RC-6831. IBM Watson Research Center
Rohlf, F. J. (1982). Single-link clustering algorithms. In Handbook of Statistics: Vol. 2, (P. R. Krishnaiah and L. N. Kanal, eds.) 267-284. North-Holland Publishing Company, Amsterdam.
Romesburg, C. Cluster Analysis for Researchers. Life Time Learning, Belmont, C A, 1984.
Roshchina, Alexandra, John Cardiff, and Paolo Rosso. “Evaluating the Similarity Estimator Component of the TWIN Personality-based Recommender System.” (2012).
Rotman, S. R., Fisher, A. D., and Staelin, D. H. (1981). Analysis of multiple-angle microwave observations of snow and ice using cluster analysis techniques. J. Glaciology 27 89-97.
Rousu, Juho. “Efficient range partitioning in classification learning.” Department of Computer Science, University of Helsinki. 2001.
Ryan, T., Joiner, B., and Ryan, B. (1982). Minitab Reference Manual. Duxbury Press, Boston.
Rybina, Kateryna. Sentiment analysis of contexts around query terms in documents. Diss. Master's thesis, 2012.
Salman, Raied. “Contributions to K-means clustering and regression Via classification algorithms.” (2012).
Sander, J., M. Ester, H.-P. Kriegel, and X. Xu. Density-Based Clustering in Spatial Databases: The Algorithm GDBSCAN and its Applications. Data Mining and Knowledge Discovery, 2(2):169-194, 1998.
SAS Institute, Inc. (1985). SAS User's Guide: Statistics, Version S Edition. Sas Institute, Inc., Cary, NC.
Savaresi, S. M. and D. Boley. A comparative analysis on the bisecting K-means and the PDDP clustering algorithms. Intelligent Data Analysis, 8(4):345-362, 2004.
Schifanella, Claudio, Maria Luisa Sapino, and K. Selguk Candan. “On context-aware co-clustering with metadata support.” Journal of Intelligent Information Systems 38.1 (2012): 209-239.
Schlüter, Tim, and Stefan Conrad. “Hidden markov model-based time series prediction using motifs for detecting inter-time-serial correlations.” Proceedings of the 27th Annual ACM Symposium on Applied Computing. ACM, 2012.
Seber, G. A. F. (1984). Multivariate Observations. Wiley, New York.
Sharma, Puneet, Srinivasa M. Salapaka, and Carolyn L. Beck. “Entropy-based framework for dynamic coverage and clustering problems.” Automatic Control, IEEE Transactions on 57.1 (2012): 135-150.
Shepard, R. N. and Arabie, P. (1979). Additive clustering: representation of similarities as combinations of discrete overlapping properties. Psychological Review 8687-123.
Shibata, R. (1981). An optimal selection of regression variables. Biometrika 6845-54.
Sibson, R. (1973). SLINK: An optimally efficient algorithm for single-link cluster methods. Computer Journal 1630-34.
Siegel, J. H., Goldwyn, R. M., and Friedman, H. P. (1971). Pattern and process in the evolution of human septic shock. Surgery 70232-245.
Silverman, B. W. (1986). Density Estimation for Statistics and Data Analysis. Chapman and Hall, London.
Smythe, R. T. and Wierman, J. C. (1978). First passage percolation on the square lattice. Lecture Notes in Mathematics 671. Springer-Verlag, Berlin.
Sneath, P. H. A. and R. R. Sokal. Numerical Taxonomy. Freeman, San Francisco, 1971.
Sneath, P. H. A. and Sokal, R. R. (1973). Numerical Taxonomy. Freeman, San Francisco.
Sokal, R. R. (1974). Classification: purposes, principles, progress, prospects. Science 185 1115-1123.
Späth, H. Cluster Analysis Algorithms for Data Reduction and Classification of Objects, volume 4 of Computers and Their Application. Ellis Horwood Publishers, Chichester, 1980. ISBN 0-85312-141-9.
SPSS, INC. (1986). SPSSX (a computer program). McGraw-Hill, New York.
Stahl, Frederic, and Ivan Jordanov. “An overview of the use of neural networks for data mining tasks.” Wiley Interdisciplinary Reviews: Data Mining and Knowledge Discovery 2.3 (2012): 193-208.
Stein, C. (1956). Inadmissibility of the usual estimator for the mean of a multivariate normal distribution. Third Berkeley Symp. Math. Statist. Prob. 1197-206.
Steinbach, M., G. Karypis, and V. Kumar. A Comparison of Document Clustering Techniques. In Proc. of KDD Workshop on Text Mining, Proc. of the 6th Intl. Conf. on Knowledge Discovery and Data Mining, Boston, MA, August 2000.
Stone, C. J. (1977). Consistent nonparametric regression (with discussion). Ann. Statist. 5595-645.
Stone, M. (1977). Cross-validation: a review. Math. Operationforsch. Statist. Ser. Statist. 9 127-139.
Streib, Amanda Pascoe. “Markov chains at the interface of combinatorics, computing, and statistical physics.” (2012).
Su, Yu, and Frederic Jurie. “Improving image classification using semantic attributes.” International journal of computer vision 100.1 (2012): 59-77.
Sundaram, Hari, et al. “Understanding community dynamics in online social networks: a multidisciplinary review.” Signal Processing Magazine, IEEE 29.2 (2012): 33-40.
Swamy, G. M., P. McGeer, R. Brayton, In the Proceedings of the International Workshop on Logic Synthesis, Tahoe CA, May 1993 “A Fully Implicit Quine-McClusky Procedure using BDDs”.
Swamy, G. M., S. Edwards, R. Brayton, In the Proceedings of the IEEE International Conference on VLSI Design, Hyderabad, January 1998. “Efficient Verification and Synthesis using Design Commonalities”.
Swamy, Gitanjali, R, Brayton, ISBN:0-591-32212-9, University of California, Berkeley, 1996 Incremental methods for formal verification and logic synthesis”.
Tarter, M. and Kronmal, R. (1970). On multivariate density estimates based on orthogonal expansions. Ann. Math. Statist. 4 718-722.
Thuett, J., Cornfield, J. and Kannel, W. (1967). A multivariate analysis of the risk of coronary heart disease in Framingham. J of Chronic Diseases 20511-524.
Thyon, R. C. (1939). Cluster Analysis. Edwards Brothers, Ann Arbor, MI.
Tidke, B. A., R. G. Mehta, and D. P. Rana. “A novel approach for high dimensional data clustering.” Int J Eng Sci Adv Technology 2.3 (2012): 645-51.
Tilak, Gayatri, et al. “Study of statistical correlations in intraday and daily financial return time series.” Econophysics of Systemic Risk and Network Dynamics. Springer Milan, 2013. 77-104.
Toussaint, G. T. (1974). Bibliography on estimation of misclassification. IEEE Transactions on Information Theory IT-20 472A79.
Treerattanapitak, Kiatichai, and Chuleerat Jaruskulchai. “Exponential fuzzy C-means for collaborative filtering.” Journal of Computer Science and Technology 27.3 (2012): 567-576.
Tu, Chunhao, Shuo Jiao, and Woon Yuen Koh. “Comparison of clustering algorithms on generalized propensity score in observational studies: a simulation study.” Journal of Statistical Computation and Simulation 83.12 (2013): 2206-2218.
Van Giessen, A. N. O. U. K. H. Dimension reduction methods for classification; MRI-based automatic classification of Alzheimer's disease. Diss. TU Delft, Delft University of Technology, 2012.
Vandic, Damir, Jan-Willem Van Dam, and Flavius Frasincar. “Faceted product search powered by the Semantic Web.” Decision Support Systems 53.3 (2012): 425-437.
Vapnik, V. N. and Chervonenkis, A. YA. (1971). On the uniform convergence of relative frequencies of events to their probabilities. Theor. Prob. Appl. 16264-280.
Vapnik, V. N. and Chervonenkis, A. YA. (1974). Theory of Pattern Recognition (in Russian). Nauka, Moscow.
Vasconcelos, Cristina Nader, et al. “Photo Tagging by Collection-Aware People Recognition.” (2012).
Vasileios, Efthymiou, and Grigoris Antoniou. “A real-time semantics-aware activity recognition system.” (2012).
Veldman, D. J. (1967). FORTRAN Programming for the Behavioral Sciences. Holt, Rinehart and Winston, New York.
Vlachos, Michail, and Daniel Svonava. “Recommendation and visualization of similar movies using minimum spanning dendrograms.” Information Visualization (2012): 1473871612439644.
Volkovich, Zeev, Dvora Toledano-Kitai, and G-W. Weber. “Self-learning K-means clustering: a global optimization approach.” Journal of Global Optimization (2013): 1-14.
Volkovich, Zeev, et al. “On an adjacency cluster merit approach.” International Journal of Operational Research 13.3 (2012): 239-255.
Vrijenhoek, R. C., Douglas, M. E., and Meffe, G. K(1985). Conservation genetics of endangered fish populations in Arizona. Science 229 100-402.
Wald, A. (1944). On a statistical problem arising in the classification of an individual into one of two groups. Ann. Math. Statist. 15145-162.
Walker, S. B. and Duncan, D. B. (1967). Estimation of the probability of an event as a function of several independent variables. Biometrika 54 167-179.
Wan, Chin Heng, et al. “A hybrid text classification approach with low dependency on parameter by integrating K-nearest neighbor and support vector machine.” Expert Systems with Applications 39.15 (2012): 11880-11888.
Wang, Baohua, and Xiaolong Wang. “Deceptive Financial Reporting Detection: A Hierarchical Clustering Approach Based on Linguistic Features.” Procedia Engineering 29 (2012): 3392-3396.
Wang, Jinlong, Shunyao Wu, and Gang Li. “Clustering with instance and attribute level side information.” International journal of computational intelligence systems 3.6 (2010): 770-785.
Wang, Ziqiang, Xia Sun, and Xu Qian. “Efficient Kernel Discriminative Geometry Preserving Projection for Document Classification.” Przeglqd Elektrotechniczny 88.5b (2012): 56-59.
Watve, Alok. Data Transformation for Improved Query Performance. Diss. Michigan State University, 2012.
Wishart, D. (1969). Mode Analysis: A generalization of nearest neighbor which reduces chaining effects in Numerical Taxonomy, (A. J. Cole, ed.), Academic Press, London.
Wolfe, J. H. (1970). Pattern clustering by multivariate mixture analysis. Multivariate Behavioral Research S 329-350.
Wolfe, J. H. (1971). A Monte-Carlo study of the sampling distribution of the likelihood ratio for mixtures of multinormal distributions. Research Memorandum 72-2, Naval Personnel and Research Training Laboratory, San Diego.
Wu, H. C., et al. “A split-list approach for relevance feedback in information retrieval.” Information Processing & Management 48.5 (2012): 969-977.
Xu, Rui, Jie Xu, and Donald C. Wunsch. “A comparison study of validity indices on swarm-intelligence-based clustering.” Systems, Man, and Cybernetics, Part B: Cybernetics, IEEE Transactions on 42.4 (2012): 1243-1256.
Yang, Di. Mining and Managing Neighbor-Based Patterns in Data Streams. Diss. Worcester Polytechnic Institute, 2012.
Zahn, C. T. Graph-Theoretical Methods for Detecting and Describing Gestalt Clusters. IEEE Transactions on Computers, C-20(1):68-86, January 1971.
Zhang, B., M. Hsu, and U. Dayal. K-Harmonic Means-A Data Clustering Algorithm. Technical Report HPL-1999-124, Hewlett Packard Laboratories, Oct. 29 1999.
Zhang, Yi. Learning with Limited Supervision by Input and Output Coding. Diss. University of Wisconsin-Madison, 2012.
Zhao, Y. and G. Karypis. Empirical and theoretical comparisons of selected criterion functions for document clustering. Machine Learning, 55(3):311-331, 2004.
Zheng, H. T. and Jiang, Y., 2012. Towards group behavioral reason mining. Expert Systems with Applications, 39(16), pp. 12671-12682.
Zhou, Xueyuan. Learning functions on unknown manifolds. The University of Chicago, 2011.
Zuccolotto, Paola. “Principal component analysis with interval imputed missing values.” AStA Advances in Statistical Analysis 96.1 (2012): 1-23.

12. Eye Tracking

10025389; 10025952; 10089966; 10120454; 10137363; 10142276; 10176466; 10180572; 10203758; 10203762; 10228242; 10262148; 10268888; 10288419; 10289376; 10295338; 10324525; 10352693; 10379709; 10408613; 10413246; 10467992; 10473459; 10495453; 10528131; 10533850; 10534605; 10539787; 10540941; 10545574; 10571263; 10591286; 10592238; 10599405; 10606343; 10614504; 10620921; 10620948; 10637853; 10641603; 10732784; 10767986; 10768693; 10769635; 10784696; 10795183; 10835146; 10852540; 10852838; 10860098; 10860100; 10861242; 10866093; 10872322; 10872472; 10884493; 10885802; 10885874; 10910854; 10921896; 10922862; 10936340; 10943407; 10969863; 10976815; 10999226; 11006184; 11029147; 11060858; 111064257; 11074495; 11112932; 11128586; 11128636; 11141113; 11144759; 11157159; 11163416; 11164045; 11176751; 11195057; 11217033; 11221213; 11237623; 11255663; 11269426; 11275482; 11282284; 11302207; 11304657; 11308227; 11357401; 11366531; 11367410; 20030098954; 20030123027; 20040174496; 20040239509; 20050047629; 20050073136; 20050175218; 20050243054; 20050282603; 20050288564; 20060028400; 20060093998; 20060109242; 20060110008; 20060227103; 20070164990; 20080002262; 20080242950; 20080243005; 20080266257; 20080287821; 20080319276; 20090005654; 20090018407; 20090024050; 20090110245; 20090112616; 20090112617; 20090112620; 20090112621; 20090118593; 20090119154; 20090132275; 20090156907; 20090156955; 20090157323; 20090157481; 20090157482; 20090157625; 20090157660; 20090157751; 20090157813; 20090163777; 20090164131; 20090164132; 20090164302; 20090164401; 20090164403; 20090164458; 20090164503; 20090164549; 20090171164; 20090172540; 20090189974; 20090219484; 20090267758; 20090271011; 20090271120; 20090271347; 20090295738; 20090312595; 20090312668; 20090318773; 20100004762; 20100015583; 20100017001; 20100022820; 20100033333; 20100039617; 20100041958; 20100042578; 20100063368; 20100069724; 20100076249; 20100081860; 20100081861; 20100086200; 20100086221; 20100086278; 20100100036; 20100125561; 20100130811; 20100149073; 20100163027; 20100163035; 20100168525; 20100168602; 20100189354; 20100208205; 20100280332; 20100280372; 20100295774; 20110007275; 20110018903; 20110170065; 20110178784; 20110182472; 20110213664; 20110214082; 20110221656; 20110221657; 20110221658; 20110221659; 20110221668; 20110221669; 20110221670; 20110221671; 20110221672; 20110221793; 20110221896; 20110221897; 20110222745; 20110225536; 20110227812; 20110227813; 20110227820; 20110228975; 20110231757; 20110270123; 20110310006; 20120026276; 20120035934; 20120062445; 20120075168; 20120092618; 20120105324; 20120105486; 20120109923; 20120116559; 20120120498; 20120120499; 20120133889; 20120134548; 20120146895; 20120154633; 20120154920; 20120164613; 20120176543; 20120194418; 20120194419; 20120194420; 20120194549; 20120194550; 20120194551; 20120194552; 20120194553; 20120200488; 20120200499; 20120200601; 20120206322; 20120206323; 20120206334; 20120206335; 20120206485; 20120212398; 20120212399; 20120212400; 20120212406; 20120212414; 20120212484; 20120212499; 20120218172; 20120218301; 20120235883; 20120235884; 20120235885; 20120235886; 20120235887; 20120235900; 20120236030; 20120236031; 20120242678; 20120242697; 20120242698; 20120249797; 20120256833; 20120272179; 20120274593; 20120290950; 20130127980; 20130128118; 20130145304; 20130188032; 20130190556; 20130208234; 20130212487; 20130219012; 20130242262; 20130250087; 20130263280; 20130265227; 20130278631; 20130314303; 20130317966; 20130317978; 20130318004; 20130318005; 20130318457; 20130321270; 20130326431; 20140009390; 20140057232; 20140063054; 20140063055; 20140079297; 20140081858; 20140092018; 20140108309; 20140152558; 20140201126; 20140204003; 20140226131; 20140241216; 20140247210; 20140247215; 20140247232; 20140289833; 20140306882; 20140333535; 20140334666; 20140344718; 20140351002; 20150009364; 20150016777; 20150039405; 20150040149; 20150049004; 20150126281; 20150131159; 20150131850; 20150172453; 20150185482; 20150189355; 20150199559; 20150205494; 20150213421; 20150234477; 20150235088; 20150235370; 20150235441; 20150235447; 20150241705; 20150241959; 20150242575; 20150242943; 20150243100; 20150243105; 20150243106; 20150247723; 20150247975; 20150247976; 20150248169; 20150248170; 20150248787; 20150248788; 20150248789; 20150248791; 20150248792; 20150248793; 20150288944; 20150301600; 20150309263; 20150309264; 20150309316; 20150309570; 20150312397; 20150379132; 20160005320; 20160011658; 20160026253; 20160048204; 20160050391; 20160085317; 20160085420; 20160116980; 20160132752; 20160187654; 20160209648; 20160210503; 20160210602; 20160217327; 20160240050; 20160248971; 20160261793; 20160267708; 20160267809; 20160274762; 20160275760; 20160299566; 20160300312; 20160381415; 20170004748; 20170004749; 20170010468; 20170011577; 20170019660; 20170019661; 20170039869; 20170047051; 20170054987; 20170068322; 20170098205; 20170115742; 20170131964; 20170156674; 20170168566; 20170177078; 20170177079; 20170212586; 20170231560; 20170235360; 20170237897; 20170243447; 20170293407; 20170300946; 20170301001; 20170344107; 20170344114; 20180025336; 20180039990; 20180041503; 20180059875; 20180144554; 20180174055; 20180188803; 20180190244; 20180204111; 20180254103; 20180270350; 20180284982; 20180292907; 20180293087; 20180307303; 20180307324; 20180314406; 20180314416; 20180329510; 20180349108; 20180357050; 20190004791; 20190004792; 20190004793; 20190012989; 20190025587; 20190025917; 20190037072; 20190043441; 20190094981; 20190102946; 20190109810; 20190154439; 20190159716; 20190164156; 20190178638; 20190188395; 20190188450; 20190188471; 20190216392; 20190235624; 20190235729; 20190237044; 20190239789; 20190239791; 20190253404; 20190261908; 20190265802; 20190302885; 20190311512; 20190312973; 20190324534; 20190325657; 20190354172; 20190362557; 20190368868; 20190377487; 20190379944; 20200000409; 20200004331; 20200007679; 20200020308; 20200060603; 20200135141; 20200142495; 20200153768; 20200153957; 20200153958; 20200174557; 20200184278; 20200184730; 20200192089; 20200218519; 20200244800; 20200249752; 20200252507; 20200259347; 20200264698; 20200285379; 20200288206; 20200329969; 20200356165; 20200363865; 20200380882; 20210034146; 20210044550; 20210056764; 20210058510; 20210067836; 20210073765; 20210074014; 20210074068; 20210085180; 20210103340; 20210103449; 20210105340; 20210110616; 20210125414; 20210125513; 20210127969; 20210141451; 20210157402; 20210166653; 20210168116; 20210173480; 20210176197; 20210200309; 20210200991; 20210216822; 20210224765; 20210255707; 20210264212; 20210274039; 20210282696; 20210294413; 20210297811; 20210312523; 20210312533; 20210312672; 20210312678; 20210319408; 20210326594; 20210327146; 20210342020; 20210351603; 20210353439; 20210373676; 20210374391; 20210385180; 20210399911; 20210400142; 20210409517; 20220004617; 20220006813; 20220011098; 20220011878; 20220014622; 20220014623; 20220019333; 20220028394; 20220030080; 20220044018; 20220057519; 20220067741; 20220068033; 20220075517; 20220094652; 20220100336; 20220101744; 20220103683; 20220104959; 20220118218; 20220121344; 20220121884; 20220128352; 20220129068; 20220150353; 20220171453; 20220174039; 20220179497; 20220179665; 20220197027; 20220197393; 20220197446; 20220197485; 20220203996; 3689135; 4075657; 4102564; 4145122; 4303394; 4641349; 4651145:4702575; 4755045; 4836670; 4973149; 4975969:5008946; 5016282; 5231674; 5287437; 5325133; 5331149; 5345281; 5360971; 5428413; 5471542; 5481622; 5583795; 5638176; 5649061; 5668622; 5726916; 5731805; 5797046; 5805167; 5818954; 5831594; 5886683; 5898423; 5912721; 5926251; 5984475; 5991085; 6120461; 6152563; 6154559; 6163336; 6204828; 6215898; 6220706; 6243076; 6246779; 6299307; 6323884; 6369952; 6381339; 6393136; 6397137; 6437758; 6456737; 6477267; 6478425; 6546121; 6568809; 6577329; 6578962; 6603504; 6608615; 6634749; 6659611; 6727866; 6753847; 6843564; 6853854; 6943754; 6999071:7040759; 7043056; 7076118; 7084838; 7090348; 7091931; 7138997; 7161596; 7190825; 7197165; 7239293; 7306337:7307609; 7315324; 7324085; 7331929; 7345664:7388580; 7391887; 7396129; 7401920; 7423540; 7428001; 7448751; 7460940; 7490941; 7501995; 7503653; 7520614; 7528823; 7538746; 7542210; 7554541; 7556377; 7567702; 7572008; 7583252; 7600873; 7620216; 7626569; 7633493; 7650034; 7665845; 7693256; 7701441; 7702660; 7703921; 7705876; 7706575; 7724251; 7731360; 7742623; 7753523; 7762665; 7766479; 7768528; 7787009; 7801686; 7809160; 7810926; 7815507; 7819525; 7834912; 7839400; 7857452; 7860382; 7862172; 7866818; 7869848; 7872635; 7880739; 7881493; 7916977; 7925077; 7938540; 7948451; 7963652; 7970179:7974787; 7983733; 7986318; 7999844; 8014571; 8020993; 8065240; 8069125; 8077217; 8077914; 8099748; 8100532; 8121356; 8130260; 8150796; 8154781; 8155479; 8170293; 8175374; 8185845; 8195593; 8199186; 8203530; 8219438; 8292433; 8467133; 8472120; 8477425; 8482859; 8488246; 8525788; 8573980; 8606592; 8614676; 8640946; 8651373; 8676937; 8696113; 8706518; 8774498; 8786675; 8793620; 8814691:8842071; 8849845; 8873813; 8878796; 8885882; 8937591; 8947351; 8955743; 8964298; 8982046; 9004353; 9064036; 9097890; 9097891; 9098961; 9128281; 9129295; 9134534; 9182596; 9201578; 9223134; 9224175; 9229227:9256785; 9274598; 9285589; 9292887; 9311527:9325939; 9329689; 9341843; 9355530; 9366862; 9380287; 9384420; 9423994; 9442567; 9477993; 9519896; 9541383; 9560967; 9607483; 9612403; 9619020; 9640041; 9651368; 9658473; 9661215; 9671566; 9693684; 9710071; 9759917; 9760123; 9785233; 9788056; 9791927; 9798382; 9812096; 9824668; 9830581; 9836639; 9837052; 9841811; 9857170; 9858900; 9858901:9866748; 9875406; 9899005; 9899006; 9900602; 9916538; 9916736; 9952042; 9952672; 9953214; 9961258;9971401; 9983666; 9996159; JP1990224637; JP1995055941; JP2003015816; JP2004504684; JP2005230049; JP2006328548; JP2007055941; JP2007073273; WO2002009025; WO2004045399; WO2008069158;
Ambient Devices, Inc. Ambient Orb. www.ambientdevices.com, 2003.
Atienza et al., “Active Gaze Tracking for Human-Robot Interaction”, Research School of Information Sciences, The Australian National University (2002).
Baluja et al., “Non-intrusive Gaze Tracking Using Artificial Neural Networks”, School of Computer Science, Carnegie Mellon University CMU-CS-94-102 (1994).
Bernardin, K., H. K. Ekenel, and R. Stiefelhagen, “Multimodal identity tracking in a smart room”, Personal and Ubiquitous Computing, vol. 13, pp. 25-31, 2009.
Beymer et al., “Eye Gaze Tracking Using an Active Stereo Head”, Proceedings of the 2003 Computer Society Conference on Computer Vision and Pattern Recognition (CPVR'03) 1063-6919 (2005).
Beymer et al., “WebGazeAnalyzer: A System for Capturing and Analyzing Web Reading Behavior Using Eye Gaze”, IBM Almaden Research Center, submitted to CHI (2005).
Bradley, A., and Thibos, L. (2003). Modeling Off-axis Vision I: the Optical Effects of Decentering Visual Targets or the Eye's Entrance Pupil. Report, School of Optometry, Indiana University, Bloomington, Ind.
Chen et al., “A Robust 3D Eye Gaze Tracking System Using Noise Reduction”, Rensselaer Polytechnic Institute, ACM ETRA (2008).
Chin et al., “Integrated electromyogram and eye-gaze tracking cursor control system for computer users with motor disabilities”, Journal of Rehabilitation Research & Development, Vol. 45, No. 1, pp. 161-174 (2008).
Colburn et al., “The Role of Eye Gaze in Avatar Mediated Conversational Interfaces”, Microsoft Research,
Microsoft Corporation MSR-TR-2000-81 (2000).
Collewijn et al., “Effect of Freeing the Head on Eye Movement Characteristics during Three-Dimensional Shifts of Gaze and Tracking” Ch. 64, in A. Berthoz, Werner Graf, Pierre Paul Vidal, Language Arts & Disciplines (1992).
Colombo, C., D. Comanducci, and A. Del Bimbo, “Robust tracking and remapping of eye appearance with passive computer vision,” ACM TOMCCAP, 3:1-20, December 2007.
Cornelissen et al., “The Eyelink Toolbos: Eye Tracking with MATLAB and the Psychophysics Toolbox”, Laboratory of Experimental Ophthalmology, School for Behavioral and Cognitive Neurosciences, University of Groningen, The Netherlands (2002).
Coutinho et al., “Free head motion eye gaze tracking using a single camera and multiple light sources”, Department of Computer Sciences, Institute of Mathematics and Statistics-IME-USP (2006).
Coutinho F. L., and C. H. Morimoto, “Free head motion eye gaze tracking using a single camera and multiple light sources,” SIBGRAPHI'06, pp. 171-178, October 2006.
Duchowski et al., “A Breadth-First Survey of Eye Tracking Applications”, Behavior Research Methods, Instruments and Computers (2000).
Duchowski, A. T., Eye Tracking Methodology: Theory and Practice. Springer-Verlag, 2003.
Duchowski, A. T., V. Shivashankaraiah, T. Rawls, A. K. Gramopadhye, B. J. Melloy, and B. Kanki, “Binocular eye tracking in virtual reality for inspection training,” in Proceedings of the 2000 symposium on Eye tracking research & applications. New York, N.Y., USA: ACM Press, 2000, pp. 89-96.
Essig, K., M. Pomplun, and H. Ritter, “A neural network for 3d gaze recording with binocular eyetrackers,” International Journal of Parallel, Emergent and Distributed Systems (accepted), 2006.
Essig, K., M. Pomplun, and H. Ritter, “Application of a novel neural approach to 3d gaze tracking: Vergence eye-movements in autostereograms,” in Proceedings of the 26thl Meeting of the Cognitive Science Society, K. Forbus, D. Gentner, and T. Regier, Eds., 2004, pp. 357-362.
Eye Movement Equipment Database (EMED), University of Darby, ibs.derby.ac.uklemed.
Forrester, J., Dick, A., McMenamin, P. and Lee, W. (1996) The Eye. Basic Sciences in Practice, W. B. Saunders, London.
Garau et al., “The Impact of Avatar Realism and Eye Gaze Control on Perceived Quality of Communication in a Shared Immersive Virtual Environment”, Department of Computer Science, University College London ACM CHI (2003).
Garau et al., “The Impact of Eye Gaze on Communication Using Humanoid Avatars”, Department of Computer Science, University College London ACM (2001).
Gee et al., “Determining the Gaze of Faces in Images”, Department of Engineering, University of Cambridge, CUED/FINFENG/TR 174 (1994).
Gee et al., “Non-Intrusive Gaze Tracking for Human-Computer Interaction”, IEEE Proceedings Mechatronics and Machine Vision in Practice, pp. 112-117 (1994).
Guestrin E., and M. Eizenman, “General theory of remote gaze estimation using the pupil center and corneal reflections,” Biomedical Engineering, IEEE Transactions on, vol. 53, no. 6, pp. 1124-1133, June 2006.
Guiard, Y. (1987). Asymmetric division of labor in human skilled bimanual action: The kinematic chain as a model. Journal of Motor Behavior 19:486-517.
Gullstrand. (1955). Schematic Eye. In Visual Optics, H. H. Emsley (Ed), 3rd edition, p. 348, Butterworth, Scarborough, Ontario.
Halle, M., “Autostereoscopic displays and computer graphics,” SIGGRAPH Comput. Graph., vol. 31, no. 2, pp. 58-62, 1997.
Hansen D., and O. Ji, “In the eye of the beholder: a survey of models for eyes and gaze,” IEEE Trans. PAMI, vol. 99, 2009.
Heijde, K. G. L. van der, Dubbelman, M. and Weeber, H. A. The Shape of the Back Surface of the Cornea. S. Afr. Optom. 62 (3), 132. (2003).
Heinzmann et al., “3-D Facial Pose and Gaze Point Estimation using a Robust Real-Time Tracking Paradigm”, Department of Systems Engineering, Australian National University, Proceedings of the IEEE International Conference on Automatic Face and Gesture Recognition (1998).
Hennessey, C., B. Noureddin, and P. Lawrence, “A single camera eye-gaze tracking system with free head motion,” in Proceedings of the 2006 symposium on Eye tracking research & applications. New York, N.Y., USA: ACM Press, 2006, pp. 87-94.
Hutchinson, T., J. White, W. Martin, K. Reichert, and L. Frey, “Human-computer interaction using eye-gaze input,” Systems, Man and Cybernetics, IEEE Transactions on, vol. 19, no. 6, pp. 1527-1534, November-December 1989.
Ishikawa et al., “Passive Driver Gaze Tracking with Active Appearance Models”, The Robotics Institute,
Carnegie Mellon University CMU-RI-TR-04-08, Proceedings of the 11th World Congress on Intelligent Transportation Systems (2004).
Jacob et al., “Eye Tracking in Advance Interface Design”, Human-Computer Interaction Lab, Naval Research Laboratory (1995).
Jacob et al., “Eye Tracking in Human-Computer Interaction and Usability Research: Ready to Deliver the Promises”, The Mind's Eye: Cognitive and Applied Aspects of Eye Movement Research (2003).
Jacob R., and K. Karn, The Mind's Eye: Cognitive and Applied Aspects of Eye Movement Research. Amsterdam: Elsevier Science, 2003, ch. Eye Tracking in Human-Computer Interaction and Usability Research: Ready to Deliver the Promises (Section Commentary), pp. 573-605.
Ji et al., “Non-intrusive Eye and Gaze Tracking for Natural Human Computer Interaction”, Department of Electrical, Computer, and Systems Engineering, Rensselaer Polytechnic Institute, March 2003.
Ji et al., “Real-Time Eye, Gaze, and Face Pose Tracking for Monitoring Driver Vigilance”, Real-Time Imaging, Vol. 8, pp. 357-377 (2002).
Kennedy, P. J., “Point of Regard Tracking Device”, IBM Technical Disclosure Bulletin vol. 34, No. 10A, March 1992.
Kwon, Y.-M., and K.-W. Jeon, “Gaze computer interaction on stereo display,” in Proceedings of the 2006 ACM SIGCHI international conference on Advances in computer entertainment technology. New York, N.Y., USA: ACM Press, 2006, p. 99.
Law et al., “Eye Gaze Patterns Differentiate Novice and Experts in a Virtual Laparoscopic Surgery Training Environment”, School of Computing Science and Kinesiology, Simon Fraser University ACM (2004).
Li et al., “Starburst: A hybrid algorithm for video-based eye tracking combining feature-based and model-based approaches”, Human Computer Interaction Program, Iowa State University IEEE CVPRW (2005).
Li, D., D. Winfield, et al, “Starburst: a hybrid algorithm for video-based eye tracking combining feature-based and model-based approaches,” IEEE CVPR Workshop on V4HCI, 2005.
Liu J., et al., “Three-dimensional PC: toward novel forms of human-computer interaction”, in Three-Dimensional Video and Display: Devices and Systems SPIE CR76, Nov. 5-8, 2000, Boston, MA, USA.
Lyons et al., “Development of a Hybrid Hands-Off Human Computer Interface Based on Electromyogram Signals and Eye-Gaze Tracking”, Electrical and Computer Engineering Department, Florida International University, IEEE Engineering in Medicine and Biology Society (2001).
Mamuji, A. et al. (2003). AuraLamp: Contextual Speech Recognition in an Eye Contact Sensing Light Appliance. In Extended Abstracts of Ubicomp '03, Seattle, 2003.
Matsumoto et al., “An Algorithm for Real-time Stereo Vision Implementation of Head Pose and Gaze Direction Measurement”, Nara Institute of Science and Technology, The Australian National University (2000).
Milekic, M. D., Ph.D., Slavko, “The More You Look the More You Get: Intention-based Interface using Gaze-tracking”, Museums & Web '03: Selected Papers (2003).
Morimoto et al., “Keeping an Eye for HCl”, SIBGRAPHI '99, Brazilian Symposium in Computer Graphics and Image Proc., 171 (1999).
Morimoto et al., “Pupil Detection and Tracking Using Multiple Light Sources”, IBM Almaden Research Center, Technical Report RJ-10117, Image Vision Comput., 2000: 331-335 (2000).
Morimoto, C. H., A. Amir, M. Flickner, “Detecting Eye Position and Gaze from a Single Camera and 2 Light Sources,” 16th International Conference on Pattern Recognition (ICPR'02)-Volume 4, 2002, p. 40314.
Nguyen, K., et al., “Differences in the infrared bright pupil response of human eyes,” ACM ETRA'02, 133-138, 2002.
Noureddin, B., P. Lawrence, and C. Man, “A non-contact device for tracking gaze in a human computer interface,” CVIU, vol. 98, pp. 52-82, 2005.
Ohno et al., “FreeGaze: A Gaze Tracking System for Everyday Gaze Interaction”, Proceedings of ETRA 2002 Symposium: eye tracking research & applications, pp. 125-132 (2002).
Ohno et al., “Just Blink Your Eyes: A Head-Free Gaze Tracking System”, NTT Communication Science Labs and ATR Media Information Science Labs, ACM CHI 2003 (2003).
Ohno T., and N. Mukawa, “A free-head, simple calibration, gaze tracking system that enables gaze-based interaction,” ACM ETRA'04, pp. 115-122, 2004.
Olsen T., Olesen H., Thiml K., Corydon L. (1992). Prediction of Pseudophakic Anterior Chamber Depth with the Newer IOL Calculation Formulas. J. Cataract Refract. Surg., 1992 18: 280-285.
Perez et al., “A Precise Eye-Gaze Detection and Tracking System”, Department of Architecture and Information Systems Technology (DATSI), Polytechnic University of Madrid WSCG (2003).
Pogalin, E., A. Redert, I. Patras, and E. A. Hendriks, “Gaze tracking by using factorized likelihoods particle filtering and stereo vision,” 3DPVT'06, pp. 57-64, June 2006.
Poole et al., “Eye Tracking in Human-Computer Interaction and Usability Research: Current Status and Future Prospects”, Psychology Department, Lancaster University, UK (2007).
Qvarfordt et al., “Conversing with the User Based on Eye-Gaze Patterns”, CHI 2005, Papers: Eye Gaze and Multimodal Integration Patterns (2005).
Rabsilber T. M., Becker K. A., Frisch I. B., Auffarth G. U. (2003). Anterior Chamber Depth in Relation to Refractive Status Measured with the Orbscan II Topography System. J. Cataract Refract. Surg., 2003 Nov. 29(11): 2115-21. Shell, J. S.,
Reale et al., “Pointing with the Eyes: Gaze Estimation Using a Static/Active Camera System and 3D Iris Disk Model”, Department of Computer Science, State University of New York, ICME (2010).
Roy et al., “Brain Stem Pursuit Pathways: Dissociating Visual, Vestibular, and Proprioceptive Inputs During Combines Eye-Head Gaze Tracking”, Journal of Neurophysiology, Vol. 90, pp. 271-290 (2003).
Salvucci et al., “Identifying Fixations and Saccades in Eye-Tracking Protocols”, Proceedings of the Eye Tracking Research and Applications Symposiums, pp. 71-78 ACM (2000).
Shih et al., “A Calibration-Free Gaze Tracking Technique”, Department of Computer Science and Information Engineering, National Chi Nan University, Proceedings of the 15th International Conference on Pattern Recognition, 201-204 (2000).
Shih et al., “A Novel Approach to 3-D Gaze Tracking Using Stereo Cameras”, Department of Computer Science and Information Engineering, National Chi Nan University, IEEE Transactions on Systems, Man, and Cybernetics, Part B: Cybernetics 34(1):234-245 (2004).
Sibert et al., “Evaluation of Eye Gaze Interaction”, Human-Computer Interaction Lab, Naval Research Laboratory and Department of Electrical Engineering & Computer Science, Tufts University ACM (2000).
Sibert et al., “The Reading Assistant: Eye Gaze Triggered Auditory Prompting for Reading Remediation”, Department of Computer Science and Physiology and Experimental Medicine, The George Washington University (2000).
Smith et al., “Hand Eye Coordination Patterns in Target Selection”, IBM Almaden Research Center (2000).
Stiefelhagen et al., “A Model-Based Gaze Tracking System”, Interactive System Laboratories, Carnegie Mellon University, IEEDE Trans. Intelligence and Systems, 304-310 (1996).
Stiefelhagen et al., “Head Orientation and Gaze Direction in Meetings”, Interactive Systems Laboratories, University of Karlsruhe and Carnegie Mellon University ACM (2002).
Stiefelhagen et al., “Tracking Eyes and Monitoring Eye Gaze”, Interactive Systems Laboratory, University of Karlsruhe, Germany (1997).
Stiefelhagen, Rainer, “Gaze Tracking for Multimodal Human-Computer Interaction” Thesis Institut fur Logik, Komplexitat und Deduktionssysteme (1996).
Sugioka et al., “Noncontact Video-Based Eye-Gaze Detection Method Allowing Large Head Displacements”, IEEE Conference in Engineering in Medicine and Biology Society, 2.7.1: Interfaces for Control, 1996.
Talmi, K., and J. Liu, “Eye and Gaze Tracking for Visually Controlled Interactive Stereoscopic Displays”, Image Communication, vol. 14, No. 10, p. 799-810, 1999.
Tan et al., “Appearance-based Eye Gaze Estimation”, Proceedings of IEEE Workshop on Applications of Computer Vision (WACV '02) (2002).
Terry K. F. Hung, “Real-time face detection and applications,” Master's Thesis, Binghamton University, 2008.
Thompson et al., “The Relationship Between Eye Gaze and Verb Agreement in American Sign Language: An Eye-Tracking Study”, Natural Language & Linguistic Theory, Vol. 24, pp. 571-604 (2006).
Traxler et al., “Plausibility and the Processing of Unbounded Dependencies: An Eye-Tracking Study”, Journal of Memory and Language, Vol. 35, Article No. 0025, pp. 454-475 (1996).
Velichkovsky, B. M. and Hansen, J. P. (1996). New technological windows to mind: There is more in eyes and brains for human computer interaction. In Proceedings of ACM CHI '96 Conference on Human Factors in Computing Systems. Vancouver, Canada: ACM, 1996, pp. 496-503.
Vertegaal et al., “Explaining Effects of Eye Gaze on Mediated Group Conversations: Amount or Synchronization?” Human Media Lab, CISC, Queens University, Canada ACM CSCW 2002 (2003).
Vertegaal et al., “Eye Gaze Patterns in Conversations: There is More to Conversational Agents Than Meets the Eyes”, SIGCHI '01 (2001).
Vertegaal, R., Cheng, D., Skaburskis, A. W., Sohn, C., Stewart, A. J., Aoudeh, O., Dickie, C. (2003). ECSGlasses and EyePliances: Using Attention to Open Sociable Windows of Interaction. In Proceedings of ACM Eye Tracking Research and Applications Symposium '04, San Antonio, Tex.
Vezhnevets V., and A. Degtiareva, “Robust and accurate eye contour extraction,” GraphiCon, pp. 81-84, 2003.
Vick et al., “Learning and Limits of Use of Eye Gaze by Capuchin Monkeys (Cebus paella) in an Object-Choice Task”, Journal of Comparative Psychology, Vol. 114, No. 2, pp. 200-207 (2000).
Viola P., and M. Jones, “Rapid object detection using a boosted cascade of simple features,” IEEE CVPR, 2001.
Wallhoff et al., “Multimodal Face Detection, Head Orientation and Eye Gaze Tracking”, Institute for Human-Machine Communication, Proceedings of MFI, Heidelberg, IEEE (2006).
Wang et al., “Chinese Input with Keyboard and Eye-Tracking—An Anatomical Study”, IBM China Research Lab and IBM Almaden Research Center, CHI (2001).
Wang et al., “Eye Gaze Estimation from a Single Image of One Eye”, IEEE International Conference on Computer Vision ICCV (2003),
Wang J. G., and E. Sung, “Gaze determination via images of irises,” Image and Vision Computing, 19:891-911, 2001.
Wang, J., L. Yin, and J. Moore, “Using geometric property of topographic manifold to detect and track eyes for human computer interaction”. ACM TOMCCAP, 3(4):1-19, 2007.
Wolfe, B. et al. “A Neural Network Approach to Tracking Eye Position”, International Journal of Human-Computer Interaction, vol. 9 (1) pp. 59-79 (1997).
Wu H. Y., et al., “Tracking iris contour with a 3D eye-model for gaze estimation,” ACCV'07, p688-697, 2007. www.seeingmachines.com/productifaceapil
Xia D., and Z. Ruan, “IR image based eye gaze estimation,” ACIS-SNPD'07, vol. 1, pp. 220-224, 2007.
Xie J., and X. Lin, “Gaze direction estimation based on natural head movements,” IEEE ICIG'07, pp. 672-677, August 2007,
Yamazoe H., et al., “Remote and head-motion-free gaze tracking for real environments with automated head-eye model calibrations,” CVPR Workshop on CVPR4HB, 2008.
Yang et al., “Real-time Face and Facial Feature Tracking and Applications”, Interactive Systems Laboratory (1998).
Yoo, D. H.; et al. (2002) “Non-contact Eye Gaze Tracking System by Mapping of Corneal Reflections”, Fifth IEEE Int. Conference on Automatic Face and Gesture Recognition.
Young L., and D. Sheena, “Methods & designs: survey of eye movement recording methods,” Behav. Res. Methods Instrum., vol. 5, pp. 397-429, 1975.
Zeng, Z., M. Pantic, G. Roisman, and T. Huang, “A survey of affect recognition methods: audio, visual, and spontaneous expressions,” IEEE Trans. on PAMI, 31(1): 39-58, 2009.
Zhai, S., C. Morimoto, and S. Ihde, “Manual and gaze input cascaded (MAGIC) pointing,” ACM SIGCH'99, p246-253 (1999).
Zhai, Shuman, “What's in the eyes for attentive input”, Communications of the ACM, cacm.acm.org, March 2003.
Zhang, Z., “A Flexible New Technique for Camera Calibration”. IEEE Transactions on Pattern Analysis and Machine Intelligence, vol. 22, No. 11, p1330-1334, 2000, also available as Technical Report MSR-TR-98-71,
Microsoft Research, Microsoft Corporation, Redmond WA, research.microsoft.com/.sup..about. zhang/Papers/TR98-71.pdf.
Zhu et al., “Eye and Gaze Tracking for Interactive Graphic Display”, Machine Vision and Applications, Vol. 15, pp. 139-148 (2004).
Zhu et al., “Eye Gaze Tracking Under Natural Head Movements”, Proceedings of the 2005 IEEE Computer Society Conference on Computer Vision and Pattern Recognition (CPVR'05) 1063-6919, 2005.
Zhu et al., “Novel Eye Gaze Tracking Techniques Under Natural Head Movement”, IEEE Transactions on Biomedical Engineering 54(12):2246-2260 (2007).
Zhu et al., “Subpixel Eye Gaze Tracking”, Interactive Systems Laboratory, Carnegie Mellon University, Proceedings of the Fifth IEEE International Conference on Automatic Face and Gesture Recognition, 131-137 (2002).

13. Biometric Auditing

5790674; 6040783; 6424249; 6615020; 7003670; 7162475; 7545962; 7565545; 8046588; 8126824; 8583570; 8874471; 8984282; 8988187; 9280684; 9805213; 10193884; 10468129; 10805290; 10810290; 11210671; 20010036622; 20020188854; 20030200217; 20040162987; 20070118885; 20070150745; 20070199047; 20080087720; 20080107308; 20110173151; 20120173518; 20120249292; 20140214568; 20180082026; 20180253539; 20190378141; 20220092511; 20220092602; AP-2015008276; AT-276541; AT-456840; AT-511154; AU-2001241870; AU-2001250931; AU-2001270925; AU-2002226250; AU-2002316986; AU-2002951755; AU-2002951755; AU-2003101083; AU-2003266822; AU-2003266822; AU-2004232072: AU-2005277824; AU-2019203135; AU-2405700; AU-3748699; AU-4431799; AU-5677196; AU-702919; AU-PQ178699; AU-PQ178699; BR-102019021367; BR-8200267-U; CA-2349797; CA-2349797; CA-2432141; CA-2432141; CA-2521480; CA-2573652; CA-2573652; CA-2836472; CA-2880246; CA-2880246: CA-3022359; CA-3050850; CH-712399; CH-716898; CH-716900; CH-716901; CH-716902; CN-100520772; CN-101625781; CN-101625781; CN-102714591; CN-102714591; CN-104318149; CN-106487786; CN-109583856; CN-110120953; CN-111899038; CN-113112232; CN-113383353; CN-1774716; DE-50201014; DE-602005019215: DK-2880585; EA-201992482; EP-1031071; EP-1192603; EP-1358533; EP-1358533; EP-1366442; EP-1399874; EP-1399874; EP-1606686; EP-1614053; EP-1714119; EP-1759483; EP-1759483; EP-1779337; EP-1807882; EP-1807882; EP-1809975; EP-1811422; EP-1811422; EP-1866873; EP-1866873; EP-1941422; EP-1941422; EP-1966737; EP-1969528; EP-1969528; EP-2048592; EP-2048592; EP-2048814; EP-2160693; EP-2160693; EP-2269166; EP-2269166; EP-2295298; EP-2295298; EP-2377064; EP-2377064; EP-2391967; EP-2391967; EP-2513834; EP-2513834; EP-2537286: EP-2537286; EP-2705503; EP-2705503: EP-2710514; EP-2710514; EP-2880585; EP-2880585; EP-2923340; EP-2923340; EP-2923340; EP-2939179; EP-2939179; EP-3008704; EP-3008704; EP-3091767; EP-3195206; EP-3250123; EP-3255614; EP-3403371; EP-3403371; EP-3411829; EP-3411829; EP-3449410; EP-3449410; EP-3622375; EP-3622375; EP-3683743; EP-3686788; EP-3832407; EP-3871122; EP-3881222; EP-3887982; EP-3887982; EP-3894943; EP-3912110; FR-2871910; FR-2896604; FR-2896604; FR-2911709; FR-2911710; FR-2922340; FR-2922396; FR-2922396; FR-2929033; FR-2932293; FR-2932293; FR-2950010; FR-2950010; FR-2956941; FR-2956942; FR-2962569; FR-2962569; FR-2966622; FR-2974924; FR-2994301; FR-2994301: FR-2997528; FR-2997528; FR-3000581; FR-3000581; FR-3007171; FR-3007171; FR-3049086; FR-3049086; FR-3052286; FR-3052286; FR-3087550; FR-3087550; FR-3088457; FR-3088457; FR-3091941; FR-3116927; GB-202008056; GB-2595648; IN-2005DN04972; IN-2011DE00333; IN-201621015159; IN-201621040882; IN-201711045129: IN-201721026116; IN-201821025145; IN-201921039569; IN-202041040264; IN-202127035115; JP-2009223464; JP-2015181051; JP-2022517622; JP-6032326; JP-WO2021065002; KR-20060031598; NL-1037554; NO-2880585; PL-2880585; PL-2939179; PT-2880585; PT-3008704; RE48867-E1; RU-2004128951; RU-2005134910; RU-2019135322; RU-2019135322; RU-2427921; RU-2635269; RU-2751315; SG-11201501852R; SG-11201510243Q; TH-10413; TH-10413; WO-1999053389; WO-1999053389; WO-2000031677; WO-2000048135; WO-2001008055; WO-2001008055; WO-2001065375; WO-2001071462; WO-2001071462; WO-2001073724; WO-2001084507; WO-2002007021; WO-2002007021; WO-2002059770; WO-2002065253; WO-2002065253; WO-2002089018; WO-2003003279; WO-2004031920; WO-2004081766; WO-2004081766; WO-2004095318; WO-2005076813; WO-2005076813; WO-2006008395; WO-2006023230; WO-2006036086: WO-2006036086; WO-2006043277; WO-2006043277; WO-2006050357; WO-2006050357; WO-2006103561; WO-2007031811: WO-2007071289; WO-2007073609; WO-2007101125; WO-2007101125; WO-2008135471; WO-2009082199; WO-2009144397; WO-2010080020; WO-2010086420; WO-2010146178; WO-2011074955; WO-2011101407; WO-2011126857; WO-2011126857; WO-2012007668; WO-2012095026; WO-2012153021; WO-2012159070; WO-2012159070; WO-2013061446; WO-2014020087; WO-2014042269; WO-2014080393; WO-2014087425; WO-2014087425; WO-2014087425; WO-2014089884; WO-2014102132; WO-2014147602; WO-2014188287; WO-2014188287; WO-2014198812; WO-2014204515; WO-2015135066; WO-2016044519; WO-2016112821; WO-2016120073; WO-2016133269; WO-2017136857; WO-2017142256; WO-2017187332; WO-2017197974; WO-2018016709; WO-2018016709; WO-2018133059; WO-2018155928; WO-2018217060; WO-2018224287; WO-2019008390; WO-2020083556; WO-2020099400; WO-2020112865; WO-2020120595; WO-2020137637; WO-2020148158; WO-2020159093; WO-2021065002: WO-2021091410; WO-2021110673; WO-2021156746; WO-2021212227; WO-2021233474; WO-2022038709;
Anton, Oana, Ramon Fernandez, Elizabeth Rendon-Morales, Rodrigo Aviles-Espinosa, Harriet Jordan, and Heike Rabe. “Heart rate monitoring in newborn babies: a systematic review.” Neonatology 116, no. 3 (2019): 199-210.
Gauba, Himaanshu, Pradeep Kumar, Partha Pratim Roy, Priyanka Singh, Debi Prosad Dogra, and Balasubramanian Raman. “Prediction of advertisement preference by fusing LEG response and sentiment analysis.” Neural Networks 92 (2017): 77-88.
Gupta, Rishabh, and Tiago H. Falk. “Relevance vector classifier decision fusion and EEG graph-theoretic features for automatic affective state characterization.” Neurocomputing 174 (2016): 875-884.
Huang, Chieh-Yang, Ting-Hao Kenneth Huang, and Lun-Wei Ku. “Challenges in providing automatic affective feedback in instant messaging applications” In 2017 AAAI Spring Symposium Series. 2017.
Huang, Dongyan, Björn Schuller, Jianhua Tao, Lei Xie, and Jie Yang. “ASMMC21: the 6th International Workshop on Affective Social Multimedia Computing.” In Proceedings of the 2021 International Conference on Multimodal Interaction, pp. 864-867. 2021.
Ismail, Sharifah Noor Masidayu Sayed, Nor Azlina Ab Aziz, and Siti Zainab Ibrahim. “A comparison of emotion recognition system using electrocardiogram (ECG) and photoplethysmogram (PPG).” Journal of King Saud University-Computer and Information Sciences (2022).
Jang, Haeng-Jin, Jaemoon Sim, Yonnim Lee, and Ohbyung Kwon. “Deep sentiment analysis: Mining the causality between personality-value-attitude for analyzing business ads in social media.” Expert Systems with applications 40, no. 18 (2013): 7492-7503.
Koelstra, Sander, Christian Muhl, Mohammad Soleymani, Jong-Seok Lee, Ashkan Yazdani, Touradj Ebrahimi, Thierry Pun, Anton Nijholt, and loannis Patras. “Deap: A database for emotion analysis; using physiological signals.” IEEE transactions on affective computing 3, no. 1 (2011): 18-31.
McDuff, Daniel, Kael Rowan, Piali Choudhury, Jessica Wolk, ThuVan Pham, and Mary Czerwinski, “A multimodal emotion sensing platform for building emotion-aware applications.” arXiv preprint arXiv:1903.12133 (2019).
Pham, Phuong, and Jingtao Wang. “Attentivevideo: A multimodal approach to quantify emotional responses to mobile advertisements.” ACM Transactions on Interactive Intelligent Systems (TiiS) 9, no. 2-3 (2019): 1-30.
Pham, Phuong, and Jingtao Wang. “AttentiveVideo: Quantifying emotional responses to mobile video advertisements.” In Proceedings of the 18th ACM International Conference on Multimodal Interaction, pp. 423-424. 2016.
Pham, Phuong, and Jingtao Wang. “Understanding emotional responses to mobile video advertisements via physiological signal sensing and facial expression analysis.” In Proceedings of the 22nd International Conference on intelligent user interfaces, pp. 67-78, 2017.
Picard, Rosalind. “Affective media and wearables: surprising findings.” In Proceedings of the 22nd ACM international conference on Multimedia, pp. 3-4. 2014.
Ruensuk, Mintra, Eunyong Cheon, Hwajung Hong, and Ian Oakley. “How Do You Feel Online: Exploiting Smartphone Sensors to Detect Transitory Emotions during Social Media Use.” Proceedings of the ACM on Interactive, Mobile, Wearable and Ubiquitous Technologies 4, no. 4 (2020): 1-32.
Schulc, Attila, Jeffrey F. Cohn, Jie Shen, and Maja Pantic, “Automatic measurement of visual attention to video content using deep learning.” In 2019 16th International Conference on Machine Vision Applications (MVA), pp. 1-6. IEEE, 2019.
Shukla, Abhinav, Harish Katti, Mohan Kankanhalli, and Ramanathan Subramanian. “Looking beyond a clever narrative: Visual context and attention are primary drivers of affect in video advertisements.” In Proceedings of the 20th ACM International Conference on Multimodal Interaction, pp. 210-219. 2018.
Shukla, Abhinav, Shruti Shriya Gullapuram, Harish Katti, Karthik Yadati, Mohan Kankanhalli, and Ramanathan Subramanian. “Affect recognition in ads with application to computational advertising.” In Proceedings of the 25th ACM international conference on Multimedia, pp. 1148-1156. 2017.
Shukla, Abhinav, Shruti Shriya Gullapuram, Harish Katti, Karthik Yadati, Mohan Kankanhalli, and Ramanathan Subramanian. “Evaluating content-centric vs. user-centric ad affect recognition.” In Proceedings of the 19th ACM International Conference on Multimodal Interaction, pp. 402-410. 2017.
Shukla, Abhinav, Shruti Shriya Gullapuram, Harish Katti, Mohan Kankanhalli, Stefan Winkler, and Ramanathan Subramanian. “Recognition of advertisement emotions with application to computational advertising.” IEEE Transactions on Affective Computing (2020).
Shukla, Abhinav. “Multimodal emotion recognition from advertisements with application to computational advertising.” PhD diss., International Institute of Information Technology Hyderabad, 2018.
Soleymani, Mohammad, Guillaume Chanel, Joep J M Kierkels, and Thierry Pun. “Affective characterization of movie scenes based on content analysis and physiological changes.” International Journal of Semantic Computing 3, no. 02 (2009): 235-254.
Soleymani, Mohammad, Sadjad Asghari-Esfeden, Yun Fu, and Maja Pantic. “Analysis of EEG signals and facial expressions for continuous emotion detection.” IEEE Transactions on Affective Computing 7, no. 1 (2015): 17-28.
Soleymani, Mohammad. “Machine Understanding of Emotion and Sentiment.” In Companion Publication of the 2020 International Conference on Multimodal Interaction, pp. 206-207, 2020.
Vermeulen, Jo, Lindsay MacDonald, Johannes SchOning, Russell Beale, and Sheelagh Carpendale. “Heartefacts: Augmenting mobile video sharing using wrist-worn heart rate sensors.” In Proceedings of the 2016 ACM Conference on Designing Interactive Systems, pp. 712-723, 2016.
Wampfler, Rafael, Severin Klingler, Barbara Solenthaler, Victor R. Schinazi, and Markus Gross. “Affective state prediction based on semi-supervised learning from smartphone touch data.” In Proceedings of the 2020 CHI Conference on Human Factors in Computing Systems, pp. 1-13. 2020.
Xiao, Xiang, Phuong Pham, and Jingtao Wang. “AttentiveLearner: adaptive mobile MOOC learning via implicit cognitive states inference.” In Proceedings of the 2015 ACM on International Conference on Multimodal Interaction, pp. 373-374. 2015.
Yadati, Karthik, Harish Katti, and Mohan Kankanhalli. “Interactive video advertising: A multimodal affective approach.” In International Conference on Multimedia Modeling, pp. 106-117. Springer, Berlin, Heidelberg, 2013.
Zhang, Tianyi. “Multi-modal fusion methods for robust emotion recognition using body-worn physiological sensors in mobile environments.” In 2019 International Conference on Multimodal Interaction, pp. 463-467. 2019.

14. Sentiment Analysis

7730017; 7930302; 7974983; 8090613:8302030; 8311888; 8341169; 8364540; 8375024; 8380803; 8402035; 8478702; 8495143; 8516374; 8543454; 8554635; 8595234; 8600796; 8606869; 8607295; 8620021; 8620718; 8620849; 8630975; 8631473; 8635281; 8635674; 8645383; 8650198; 8650587; 8667520; 8694357; 8744866; 8744908; 8762473; 8788263; 8805699; 8818788; 8838438; 8856235; 8873813; 8880631; 8892355; 8909771:8930304; 8935197; 8955001; 8965897; 8977573; 8978086; 8990097; 8995822; 8996350; 8996530; 8996625; 9009126; 9013591; 9015088; 9020956; 9058406; 9087178; 9092829; 9106979; 9122758; 9135665; 9172690; 9177060; 9201868; 9201979; 9218101; 9230547; 9235646; 9237377; 9251468; 9264764; 9269051; 9298816; 9313149; 9336268; 9336302; 9348934; 9374396; 9377933; 9391855; 9396492; 9407587; 9426538; 9432713; 9449218; 9450771; 9471944; 9495661; 9515968; 9524469; 9536329; 9542489; 9563901; 9571874; 9594730; 9595059; 9600561; 9607023; 9619046; 9633399; 9667733; 9668002; 9672283; 9672865; 9680895; 9710449; 9710539; 9710757; 9720978; 9721024; 9723346; 9740987; 9749334; 9760910; 9785883; 9799049; 9807442; 9820094; 9836455; 9836545; 9848313; 9858564; 9870636; 9892367; 9906613; 9911134; 9916370; 9916538; 9922124; 9922343; 9965462; 9990422; 9996736; 9996800; 10002371; 10009352; 10013601; 10015263; 10019527; 10034034; 10050926; 10078843; 10083490; 10102295; 10104529; 10110545; 10122483; 10122808; 10127522; 10133818; 10140392; 10140630; 10142687; 10162900; 10178067; 10180966; 10185715; 10187337; 10187704; 10194214; 10204143; 10235421; 10235681; 10248960; 10257126; 10268763; 10270732; 10275407; 10275943; 10282372; 10282750; 10284651; 10291947; 10296586; 10318503; 10318596; 10318981; 10320728; 10324598; 10325325; 10331714; 10338913; 10346866; 10347028; 10348897; 10348964; 10354337; 10366400; 10368136; 10380505; 10387511; 10388272; 10394831; 10409546; 10410125; 10410273; 10417241; 10419820; 10430806; 10437936; 10438288; 10445368; 10453097; 10459914; 10460347; 10467344; 10496763; 10503832; 10504039; 10505875; 10509622; 10511933; 10528987; 10530723; 10536542; 10540446; 10540671; 10540692; 10546015; 10546229; 10546235; 10552818; 10555023; 10567838; 10572221; 10572524; 10573312; 10580024; 10581977; 10592831; 10592930; 10595083; 10614467; 10616666; 10621183; 10623346; 10628730; 10643230; 10650456; 10652188; 10652462; 10659403; 10664576; 10664764; 10666710; 10672383; 10679011; 10679147; 10679232; 10681427; 10684738; 10698972; 10699081; 10699320; 10706367; 10706637; 10708216; 10715849; 10733496; 10733622; 10739932; 10747836; 10769317; 10775882; 10776756; 10785371; 10796093; 10803244; 10803524; 10805256; 10810617; 10817670; 10817894; 10825059; 10831283; 10839154; 10839430; 10846488; 10846613; 10846672; 10846753; 10853826; 10867081; 10878500; 10885264; 10885942; 10887666; 10902188; 10902214; 10902468; 10909550; 10911450; 10911815; 10915940; 10917691; 10922449; 10922622; 10929773; 10931736; 10958959; 10963806; 10963926; 10971153; 10977257; 10979769; 10983655; 10986414; 10990350; 10992488; 10992620; 10997186; 11003421; 11003671; 11003674; 11004110; 11010555; 11010797; 11010935; 11017430; 11017778; 11023870; 11024043; 11029926; 11030238; 11030825; 11036896; 11040444; 11042573; 11048752; 11057328; 11057673; 11063987; 11064257; 11068926; 11074061; 11074309; 11074495; 11076202; 11080023; 11080749; 11093971; 11100292; 11100523; 11102155; 11113449; 11113714; 11113722; 11120226; 11127022; 11128636; 11138375; 11138378; 11144903; 11145312; 11146557; 11151600; 11157244; 11157926; 11157946; 11164239; 11169765; 11170761; 11176565; 11177937; 11182858; 11188838; 11188967; 11189368; 11195057; 11195196; 11205023; 11205051; 11205186; 11206441; 11216248; 11216428; 11223676; 11249730; 11249731; 11250089; 11252481; 11257000; 11258735; 11269426; 11270351; 11275565; 11281367; 11281982; 11282098; 11284158; 11288701; 11290766; 11295398; 11301524; 11301632; 11307830; 11308173; 11308542; 11315326; 11321515; 11328029; 11328253; 11328307; 11334718; 11334809; 11348148; 11350164; 11354694; 11361007; 11361160; 11366531; 20070150396; 20070150397; 20070150398; 20080133488; 20080243780; 20090024629; 20090138276; 20090150215; 20090222329; 20090234711; 20090234861; 20090240568; 20090240569; 20090240586; 20090319342; 20100063877; 20100076994; 20100094878; 20100119053; 20100121707; 20100121843; 20100121849; 20100174726; 20100257117; 20100306192; 20110040760; 20110041080; 20110131485; 20110173264; 20110225115; 20110225174; 20110258049; 20110295722; 20110307312; 20110313863; 20120005686; 20120036080; 20120095862; 20120095863; 20120110071; 20120123854; 20120131139; 20120173358; 20120173359; 20120173360; 20120173361; 20120173362; 20120173363; 20120173364; 20120173365; 20120173366; 20120173367; 20120173368; 20120173369; 20120173370; 20120173371; 20120173372; 20120173373; 20120173374; 20120173375; 20120173376; 20120173377; 20120173378; 20120173379; 20120179536; 20120179562; 20120179563; 20120179564; 20120179565; 20120179566; 20120179567; 20120179568; 20120185349; 20120191596; 20120209705; 20120209706; 20120209707; 20120209708; 20120209709; 20120209710; 20120215602; 20120215612; 20120215622; 20120215623; 20120215624; 20120215625; 20120215626; 20120215635; 20120215639; 20120215640; 20120215903; 20120221659; 20120239486; 20120239495; 20120278064; 20120290399; 20120290433; 20120290446; 20120290448; 20120290553; 20120303559; 20120310750; 20120311623; 20130007057; 20130013332; 20130014136; 20130014137; 20130014138; 20130014141; 20130014143; 20130014144; 20130014145; 20130014146; 20130014153; 20130014158; 20130014222; 20130014223; 20130018685; 20130018698; 20130018838; 20130018957; 20130018968; 20130019258; 20130019262; 20130024440; 20130035982; 20130046771; 20130055097; 20130073336; 20130080928; 20130086489; 20130091141; 20130097176; 20130097251; 20130103667; 20130166196; 20130174061; 20130179268; 20130185291; 20130191380; 20130204664; 20130226925; 20130232159; 20130232263; 20130243392; 20130246168; 20130246447; 20130254035; 20130260727; 20130262355; 20130275891; 20130282595; 20130282844; 20130290110; 20130290339; 20130290905; 20130291079; 20130304581; 20130304658; 20130304904; 20130311329; 20130311409; 20130317808; 20130325550; 20130325552; 20130325877; 20130332460; 20130346155; 20130346330; 20130346877; 20140019443; 20140019548; 20140040026; 20140040067; 20140040281; 20140040387; 20140045165; 20140059185; 20140074545; 20140074845; 20140079297; 20140081706; 20140089289; 20140089816; 20140095640; 20140100967; 20140101064; 20140101247; 20140101557; 20140114901; 20140122383; 20140137200; 20140164061; 20140173641; 20140173643; 20140180788; 20140181125; 20140188623; 20140188780; 20140195610; 20140201126; 20140214489; 20140222612; 20140229164; 20140229486; 20140237061; 20140244399; 20140244622; 20140250184; 20140250199; 20140258472; 20140278769; 20140278957; 20140278968; 20140279751; 20140280223; 20140280513; 20140282281; 20140297635; 20140304060; 20140337126; 20140337328; 20140340531; 20140372358; 20140379455; 20150032771; 20150046371; 20150066691; 20150070351; 20150074020; 20150074544; 20150081725; 20150088879; 20150089409; 20150091896; 20150106078; 20150106156; 20150106157; 20150112963; 20150120717; 20150120755; 20150120788; 20150121265; 20150142486; 20150142888; 20150143392; 20150143404; 20150149153; 20150149281; 20150154527; 20150156543; 20150169758; 20150170218; 20150186789; 20150194146; 20150199727; 20150199730; 20150220774; 20150220854; 20150222586; 20150222617; 20150235243; 20150242518; 20150244805; 20150255066; 20150269242; 20150281208; 20150293989; 20150331954; 20150334469; 20150346955; 20150347903; 20150358667; 20150371173; 20150371278; 20160007083; 20160019195; 20160019587; 20160026713; 20160034973; 20160048317; 20160048556; 20160057499; 20160071119; 20160071120; 20160071162; 20160072890; 20160080173; 20160086216; 20160088333; 20160099854; 20160110591; 20160125061; 20160132608; 20160132900; 20160140580; 20160140627; 20160142917; 20160162582; 20160163318; 20160171391; 20160171537; 20160171542; 20160173428; 20160179933; 20160179967; 20160189174; 20160189181; 20160189198; 20160196564; 20160226610; 20160226978; 20160232160; 20160234551; 20160239869; 20160246801; 20160253423; 20160253679; 20160255139; 20160261701; 20160267528; 20160283061; 20160292583; 20160299955; 20160300135; 20160330529; 20160335674; 20160337709; 20160350685:20160371709; 20170004403; 20170017971; 20170017998; 20170024656; 20170039196; 20170046566; 20170046802; 20170048664; 20170053299; 20170053303; 20170061459; 20170061506; 20170063870; 20170075995; 20170083628; 20170091289; 20170091816; 20170115955; 20170115956; 20170140398; 20170147696; 20170150219; 20170154055; 20170169337; 20170169455; 20170178184; 20170180284; 20170180294; 20170180554; 20170193121; 20170193545; 20170193549; 20170206194; 20170206545; 20170206557; 20170206603; 20170206604; 20170212583; 20170223124; 20170249384; 20170286857; 20170293615; 20170295249; 20170300586; 20170300826; 20170300998; 20170301258; 20170308523; 20170318024; 20170323016; 20170323279; 20170332121; 20170345079; 20170351342; 20170351417; 20170351678; 20170351680; 20170352083; 20170353415; 20170353469; 20170359292; 20170364600; 20170366592; 20170366854; 20170372192; 20170372233; 20180012146; 20180025140; 20180025395; 20180032506; 20180035142; 20180035254; 20180040020; 20180040030; 20180041451; 20180047063; 20180053114; 20180081500; 20180089715; 20180091963; 20180108025; 20180113676; 20180114238; 20180129962; 20180131753; 20180139482; 20180165357; 20180165582; 20180165600; 20180165882; 20180167347; 20180182381; 20180189030; 20180189668; 20180189998; 20180204111; 20180211718; 20180212904; 20180218252; 20180225719; 20180232754; 20180232929; 20180232930; 20180246924; 20180246926; 20180247321; 20180253713; 20180260728; 20180268592; 20180276549; 20180287979; 20180300534; 20180300851; 20180307688; 20180307769; 20180307770; 20180307771; 20180315093; 20180315094; 20180343387; 20180357220; 20180373696; 20180373796; 20180375997; 20190012709; 20190012710; 20190013093; 20190019204; 20190026680; 20190028779; 20190034545; 20190034994; 20190042578; 20190052701; 20190065610; 20190073410; 20190073411; 20190073693; 20190075168; 20190079920; 20190079921; 20190079934; 20190087430; 20190087865; 20190108292; 20190124023; 20190129911; 20190130424; 20190138595; 20190138602; 20190141411; 20190146975; 20190147228; 20190158443; 20190163743; 20190164206; 20190171438; 20190182187; 20190190730; 20190190731; 20190197070; 20190197398; 20190205770; 20190205933; 20190213498; 20190213631; 20190228026; 20190230122; 20190236139; 20190236148; 20190236466; 20190259063; 20190266180; 20190266617; 20190272323; 20190273864; 20190279281; 20190297041; 20190303413; 20190303448; 20190311268; 20190313154; 20190325479; 20190327524; 20190332619; 20190332946; 20190333088; 20190340206; 20190340647; 20190347287; 20190347678; 20190347685; 20190378074; 20190378151; 20190392330; 20200005359; 20200005387; 20200007934; 20200008008; 20200012702; 20200028849; 20200028945; 20200036810; 20200037036; 20200050672; 20200051582; 20200057798; 20200073625; 20200073888; 20200074321; 20200074322; 20200082423; 20200090701; 20200092243; 20200097550; 20200097619; 20200104316; 20200104337; 20200110809; 20200120050; 20200125921; 20200133628; 20200134647; 20200150922; 20200151396; 20200159498; 20200159499; 20200159500; 20200159501; 20200159502; 20200159507; 20200159552; 20200159870; 20200159871; 20200159950; 20200160270; 20200160365; 20200160377; 20200160385; 20200160386; 20200160458; 20200160612; 20200167145; 20200175961; 20200175962; 20200175987; 20200184278; 20200215695; 20200219302; 20200236427; 20200242648; 20200243094; 20200265195; 20200272996; 20200275154; 20200275160; 20200279017; 20200279075; 20200279279; 20200285800; 20200286000; 20200286119; 20200286463; 20200288206; 20200298401; 20200301532; 20200304473; 20200304886; 20200310550; 20200311543; 20200312279; 20200320478; 20200320501; 20200320582; 20200320608; 20200334737; 20200334919; 20200341719; 20200342470; 20200351227; 20200356925; 20200356951; 20200364734; 20200372521; 20200372578; 20200379560; 20200380389; 20200380468; 20200387812; 20200394409; 20200396184; 20200401666; 20200410166; 20210012039; 20210019213; 20210019339; 20210019475; 20210019790; 20210027249; 20210034679; 20210035239; 20210037290; 20210042351; 20210042473; 20210042767; 20210049627; 20210049628; 20210056521; 20210065217; 20210065222; 20210065407; 20210071640; 20210082472; 20210084352; 20210090138; 20210090154; 20210090449; 20210094173; 20210097240; 20210097384; 20210110366;20210110610; 20210114205; 20210117471; 20210117942; 20210118014; 20210132688; 20210133268; 20210133848; 20210133849; 20210141991; 20210141997; 20210144426; 20210146543; 20210150593; 20210150604; 20210152866; 20210158814; 20210165918; 20210165969; 20210168447; 20210173552; 20210173553; 20210174234; 20210182496; 20210192143; 20210192460; 20210208842; 20210209651; 20210211758; 20210224671; 20210224843; 20210233530; 20210235132; 20210241040; 20210243145; 20210256629; 20210258349; 20210263975; 20210264095; 20210264929; 20210272040; 20210278953; 20210286945; 20210287147; 20210294811; 20210295837; 20210299575; 20210304261; 20210304294; 20210304421; 20210311577; 20210311974; 20210312002; 20210312096; 20210312124; 20210319457; 20210327582; 20210342020; 20210342527; 20210342528; 20210342544; 20210342548; 20210350281; 20210350285; 20210350394; 20210350426; 20210350460; 20210350465; 20210352371; 20210357262; 20210357773; 20210357888; 20210358489; 20210360027; 20210365998; 20210367981; 20210368222; 20210373676; 20210374391; 20210383416; 20210389926; 20210394636; 20210397651; 20210398164; 20210399911; 20210400142; 20210406836; 20210406938; 20220005102; 20220006813; 20220011878; 20220012427; 20220012428; 20220012755; 20220014868; 20220019989; 20220020058; 20220028397; 20220038776; 20220040860; 20220044260; 20220058703; 20220067084; 20220067755; 20220067766; 20220068273; 20220071535; 20220075956; 20220076285; 20220076326; 20220084033; 20220091817; 20220092664; 20220108042; 20220116341; 20220121884; 20220121992; 20220122134; 20220122397; 20220122587; 20220126438; 20220129236; 20220129615; 20220129616; 20220134547; 20220138606; 20220148093; 20220148699; 20220156303;20220156464; 20220159341; 20220164024; 20220167052; 20220172415; 20220174099; 20220174131; 20220174357; 20220174358; 20220174362; 20220174491; 20220187902; 20220188369; 20220188563; and 20220197625.
Akcora, Cuneyt Gurcan; Bayir, Murat Ali; Demirbas, Murat; Ferhatosmanoglu, Hakan (2010). “Identifying breakpoints in public opinion”. SigKDD, Proceedings of the First Workshop on Social Media Analytics.
Akhtar, Md Shad; Ekbal, Asif; Cambria, Erik (February 2020). “How Intense Are You? Predicting Intensities of Emotions and Sentiments using Stacked Ensemble [Application Notes]”. IEEE Computational Intelligence Magazine. 15 (1): 64-75. doi:10.1109/MCI.2019.2954667. ISSN 1556-6048. S2CID 210883622.
Amigó, Enrique, Adolfo Corujo, Julio Gonzalo, Edgar Meij, and Maarten de Rijke. “Overview of RepLab 2012: Evaluating Online Reputation Management Systems.” In CLEF (Online Working Notes/Labs/Workshop). 2012.
Amigó, Enrique, Jorge Carrillo De Albornoz, Irina Chugur, Adolfo Corujo, Julio Gonzalo, Tamara Martin, Edgar Meij, Maarten de Rijke, and Damiano Spina. “Overview of replab 2013: Evaluating online reputation monitoring systems.” In International Conference of the Cross-Language Evaluation Forum for European Languages, pp. 333-352. Springer Berlin Heidelberg, 2013.
Amigó, Enrique, Jorge Carrillo-de-Albornoz, Irina Chugur, Adolfo Corujo, Julio Gonzalo, Edgar Meij, Maarten de Rijke, and Damiano Spina. “Overview of replab 2014: author profiling and reputation dimensions for online reputation management.” In International Conference of the Cross-Language Evaluation Forum for European Languages, pp. 307-322. Springer International Publishing, 2014.
Augustyniak, Lukasz; Szymanski, Piotr; Kajdanowicz, Tomasz; Tuliglowicz, Wodzimierz (2015-12-25). “Comprehensive Study on Lexicon-based Ensemble Classification Sentiment Analysis”. Entropy. 18 (1): 4. Bibcode:2015Entrp..18 . . . . 4A. doi:10.3390/e18010004.
Bermingham, Adam; Smeaton, Alan F. (2010). Classifying sentiment in microblogs: is brevity an advantage?; Proceedings of the 19th ACM International Conference on Information and Knowledge Management. p. 1833. doi:10.1145/1871437.1871741. ISBN 9781450300995. S2CID 2084603.
Borth, Damian; Ji, Rongrong; Chen, Tao; Breuel, Thomas; Chang, Shih-Fu (2013). “Large-scale Visual Sentiment Ontology and Detectors Using Adjective Noun Pairs”. Proceedings of ACM Int. Conference on Multimedia. pp. 223-232.
Cambria, E; Hussain, A (2015). Sentic Computing: A Common-Sense-Based Framework for Concept-Level Sentiment Analysis. Springer. ISBN 9783319236544.
Cambria, E; Schuller, B; Xia, Y; Havasi, C (2013). “New avenues in opinion mining and sentiment analysis”.
IEEE Intelligent Systems. 28 (2): 15-21. CiteSeerX 10.1.1.688.1384. doi:10.1109/MIS.2013.30. S2CID 12104996.
Cataldi, Mario; Ballatore, Andrea; Tiddi, Ilaria; Aufaure, Marie-Aude (2013-06-22). “Good location, terrible food: detecting feature sentiment in user-generated reviews”. Social Network Analysis and Mining. 3 (4): 1149-1163. CiteSeerX 10.1.1.396.9313. doi:10.10071s13278-013-0119-7. ISSN 1869-5450. S2CID 5025282.
Condliffe, Jamie. “Flaming drives online social networks”, New Scientist, 2010-12-07. Retrieved on 2010 Dec. 13.
Cordis, “Collective emotions in cyberspace (CYBEREMOTIONS)”, European Commission, 2009-02-03. Retrieved on 2010 Dec. 13.
Deng, Shangkun; Mitsubuchi, Takashi; Shioda, Kei; Shimada, Tatsuro; Sakurai, Akito (December 2011). “Combining Technical Analysis with Sentiment Analysis for Stock Price Prediction”. 2011 IEEE Ninth International Conference on Dependable, Autonomic and Secure Computing. IEEE: 800-807. doi:10.1109/dasc.2011.138. ISBN 978-1-4673-0006-3. S2CID 15262023.
Dey, Lipika; Haque, S. K. Mirajul (2008). “Opinion Mining from Noisy Text Data”. Proceedings of the second workshop on Analytics for noisy unstructured text data, p.83-90.
Gottschalk, Louis August, and Goldine C. Gleser. The measurement of psychological states through the content analysis of verbal behavior. Univ of California Press, 1969.
Hamborg, Felix; Donnay, Karsten (2021). “NewsMTSC: A Dataset for (Multi-)Target-dependent Sentiment Classification in Political News Articles”. “Proceedings of the 16th Conference of the European Chapter of the Association for Computational Linguistics: Main Volume”
Hu, Minqing; Liu, Bing (2004). “Mining and Summarizing Customer Reviews”. Proceedings of KDD 2004.
Jakob, Niklas, et al. “Beyond the stars: exploiting free-text user reviews to improve the accuracy of movie recommendations.” Proceedings of the 1st international CIKM workshop on Topic-sentiment analysis for mass opinion. ACM, 2009.
Karlgren, Jussi, Magnus Sahlgren, Fredrik Olsson, Fredrik Espinoza, and Ola Hamfors. “Usefulness of sentiment analysis.” In European Conference on Information Retrieval, pp. 426-435. Springer Berlin Heidelberg, 2012.
Karlgren, Jussi. “Affect, appeal, and sentiment as factors influencing interaction with multimedia information.” In Proceedings of Theseus/ImageCLEF workshop on visual information retrieval evaluation, pp. 8-11.2009.
Karlgren, Jussi. “The relation between author mood and affect to sentiment in text and text genre.” In Proceedings of the fourth workshop on Exploiting semantic annotations in information retrieval, pp. 9-10. ACM, 2011.
Kim, S. M.; Hovy, E. H. (2006). “Identifying and Analyzing Judgment Opinions.”; Proceedings of the Human Language Technology I North American Association of Computational Linguistics conference (HLT-NAACL 2006). New York, NY.
Koppel, Moshe; Schler, Jonathan (2006). “The Importance of Neutral Examples for Learning Sentiment”. Computational Intelligence 22. pp. 100-109. CiteSeerX 10.1.1.84.9735.
Korkontzelos, loannis; Nikfarjam, Azadeh; Shardlow, Matthew; Sarker, Abeed; Ananiadou, Sophia; Gonzalez, Graciela H. (2016). “Analysis of the effect of sentiment analysis on extracting adverse drug reactions from tweets and forum posts”. Journal of Biomedical Informatics. 62: 148-158. doi:10.1016/j.jbi.2016.06.007. PMC 4981644. PMID 27363901.
Lamba, Manika; Madhusudhan, Margam (2018). “Application of sentiment analysis in libraries to provide temporal information service: a case study on various facets of productivity”. Social Network Analysis and Mining. 8 (1): 1-12. doi:10.1007/s13278-018-0541-y. S2CID 53047128.
Liang, Bin; et al. (2022). “Aspect-based sentiment analysis via affective knowledge enhanced graph convolutional networks”. Knowledge-Based Systems. 235: 107643. doi:10.1016/j.knosys.2021.107643.
Liu, Bing (2010). “Sentiment Analysis and Subjectivity”; In Indurkhya, N.; Damerau, F. J. (eds.). Handbook of Natural Language Processing (Second ed.).
Liu, Sing (2012-05-23). “Sentiment Analysis and Opinion Mining”. Synthesis Lectures on Human Language Technologies. 5 (1): 1-167. doi:10.2200S00416ED1V01Y201204HLT016. ISSN 1947-4040.
Liu, Bing; Hu, Minqing; Cheng, Junsheng (2005). “Opinion Observer: Analyzing and Comparing Opinions on the Web”. Proceedings of WWW 2005.
Liu, Yang; Huang, Xiangji; An, Aijun; Yu, Xiaohui (2008). “Modeling and predicting the helpfulness of online reviews”; ICDM'08. Eighth IEEE international conference on Data mining. IEEE. pp. 443-452. doi:10.1109/ICDM.2008.94. ISBN 978-0-7695-3502-9. S2CID 18235238.
M. S. Akhtar, A. Ekbal and E. Cambria, “How Intense Are You? Predicting Intensities of Emotions and Sentiments using Stacked Ensemble [Application Notes],” in IEEE Computational Intelligence Magazine, vol. 15, no. 1, pp. 64-75, February 2020, doi: 10.1109/MCI.2019.2954667.
Ma, Yukun; et al. (2018). “Targeted aspect-based sentiment analysis via embedding commonsense knowledge into an attentive LSTM”. Proceedings of AAAI. pp. 5876-5883.
Mehmood, Yasir; Balakrishnan, Vimala (2020-01-01). “An enhanced lexicon-based approach for sentiment analysis: a case study on illegal immigration”. Online Information Review. 44 (5): 1097-1117. doi:10.1108!OIR-10-2018-0295. ISSN 1468-4527. S2CID 221766042.
Mihalcea, Rada; Banea, Carmen; Wiebe, Janyce (2007). “Learning Multilingual Subjective Language via Cross-Lingual Projections” Proceedings of the Association for Computational Linguistics (ACL). pp. 976-983.
Minqing, Hu; Liu, Bing (2004). “Mining opinion features in customer reviews”; AAAI. 4 (4). S2CID 5724860.
Mozetič, Igor; Grčar, Miha; Smailovič, Jasmina (2016-05-05). “Multilingual Twitter Sentiment Classification: The Role of Human Annotators”. PLOS ONE. 11 (5): e0155036. arXiv:1602.07563. Bibcode:2016PLoSO..1155036M. doi:10.1371/journal.pone.0155036. ISSN 1932-6203. PMC 4858191. PMID 27149621.
Nguyen, KietVan; Nguyen, Vu Duc; Nguyen, Phu XV.; Truong, Tham T. H.; Nguyen, Ngan L-T. (2018-10-01). “UIT-VSFC: Vietnamese Students' Feedback Corpus for Sentiment Analysis”. 201810th International Conference on Knowledge and Systems Engineering (KSE). Vietnam: IEEE: 19-24. doi:10.11091KSE.2018.8573337. ISBN 978-1-5386-6113-0. S2CID 56172224.
Ortony, Andrew; Clore, G; Collins, A (1988). The Cognitive Structure of Emotions. Cambridge Univ. Press.
Pang, Bo; Lee, Lillian (2004). “A Sentimental Education: Sentiment Analysis Using Subjectivity Summarization Based on Minimum Cuts”. Proceedings of the Association for Computational Linguistics (ACL). pp. 271-278.
Pang, So; Lee, Lillian (2005). “Seeing stars: Exploiting class relationships for sentiment categorization with respect to rating scales”. Proceedings of the Association for Computational Linguistics (ACL). pp. 115-124.
Pang, Bo; Lee, Lillian (2008). “4.1.2 Subjectivity Detection and Opinion Identification”. Opinion Mining and Sentiment Analysis. Now Publishers Inc.
Pang, Bo; Lee, Lillian (2008-07-06). “Opinion Mining and Sentiment Analysis”. Foundations and Trends in Information Retrieval. 2 (1-2): 1-135. doi:10.1561/1500000011. ISSN 1554-0669.
Pang, So; Lee, Lillian; Vaithyanathan, Shivakumar (2002). “Thumbs up? Sentiment Classification using Machine Learning Techniques”. Proceedings of the Conference on Empirical Methods in Natural Language Processing (EMNLP). pp. 79-86.
Qu, Yan, James Shanahan, and Janyce Wiebe. “Exploring attitude and affect in text: Theories and applications.” In AAAI Spring Symposium, Technical report SS-04-07. AAAI Press, Menlo Park, C A. 2004.
Quirk, Randolph; Greenbaum, Sidney; Geoffrey, Leech; Jan, Svartvik (1985). A Comprehensive Grammar of the English Language (General Grammar). Longman. pp. 175-239. ISBN 1933108312.
Ribeiro, Filipe Nunes; Araujo, Matheus (2010). “A Benchmark Comparison of State-of-the-Practice Sentiment Analysis Methods”. Transactions on Embedded Computing Systems. 9 (4).
Riloff, Ellen (1996-08-01). “An empirical study of automated dictionary construction for information extraction in three domains”. Artificial Intelligence. 85 (1): 101-134. doi:10.1016/0004-3702(95)00123-9. ISSN 0004-3702.
Riloff, Ellen; Jones, Rosie (July 1999). “Learning dictionaries for information extraction by multi-level bootstrapping”. AAAI '99/IAAI '99: Proceedings of the Sixteenth National Conference on Artificial Intelligence and the Eleventh Innovative Applications of Artificial Intelligence Conference Innovative Applications of Artificial Intelligence: 474-479.
Riloff, Ellen; Wiebe, Janyce (2003-07-11). “Learning extraction patterns for subjective expressions”. Proceedings of the 2003 Conference on Empirical Methods in Natural Language Processing. EMNLP '03. USA: Association for Computational Linguistics. 10: 105-112. doi:10.3115/1119355.1119369. S2CID 6541910.
Roebuck, K. (2012-10-24). Sentiment Analysis: High-impact Strategies—What You Need to Know: Definitions, Adoptions, Impact, Benefits, Maturity, Vendors. ISBN 9781743049457.
Sahlgren, Magnus; Karlgren, Jussi; Eriksson, Gunnar (2007). “Valence annotation based on seeds in word space”. Proceedings of the Fourth International Workshop on Semantic Evaluations (SemEval-2007).
Sasikala, P.; Mary Immaculate Sheela, L. (December 2020). “Sentiment analysis of online product reviews using DLMNN and future prediction of online product using IANFIS”. Journal of Big Data. 7 (1): 33. doi:10.1186/s40537-020-00308-7. ISSN 2196-1115.
Sharma, Raksha; Somani; Kumar; Bhattacharyya (2017). “Sentiment Intensity Ranking among Adjectives Using Sentiment Bearing Word Embeddings”. Association for Computational Linguistics: 547-552.
Snyder, Benjamin; Barzilay, Regina (2007). “Multiple Aspect Ranking using the Good Grief Algorithm”. Proceedings of the Joint Human Language Technology/North American Chapter of the ACL Conference (HLT-NAACL). pp. 300-307.
Socher, Richard; Perelygin, Alex; Wu, Jean Y.; Chuang, Jason; Manning, Christopher D.; Ng, Andrew Y.; Potts, Christopher (2013). “Recursive deep models for semantic compositionality over a sentiment treebank”. In Proceedings of EMNLP: 1631-1642. CiteSeerX 10.1.1.593.7427.
Stevenson, Ryan; Mikels, Joseph; James, Thomas (2007). “Characterization of the Affective Norms for English Words by Discrete Emotional Categories”; Behavior Research Methods. 39 (4): 1020-1024. doi:10.3758/bf03192999. PMID 18183921. S2CID 6673690.
Stone, Philip J., Dexter C. Dunphy, and Marshall S. Smith. “The general inquirer: A computer approach to content analysis.” MIT Press, Cambridge, MA (1966).
Su, Fangzhong; Markert, Katja (2008). “From Words to Senses: a Case Study in Subjectivity Recognition”; Proceedings of Coling 2008, Manchester, UK.
Taboada, Maite; Brooke, Julian (2011). “Lexicon-based methods for sentiment analysis”. Computational Linguistics. 37 (2): 272-274. CiteSeerX 10.1.1.188.5517. doi:10.1162/coli_a_00049. S2CID 3181362.
Tang, Huifeng; Tan, Songbo; Cheng, Xueqi (2009). “A survey on sentiment detection of reviews”; Expert Systems with Applications. 36 (7): 10760-10773. doi:10.1016/j.eswa.2009.02.063. S2CID 2178380.
Thelen, Michael; Riloff, Ellen (2002-07-06). “A bootstrapping method for learning semantic lexicons using extraction pattern contexts”. Proceedings of the ACL-02 Conference on Empirical Methods in Natural Language Processing—Volume 10. EMNLP '02. USA: Association for Computational Linguistics. 10: 214-221. doi:10.3115/1118693.1118721. S2CID 137155.
Thelwall, Mike; Buckley, Kevan; Paltoglou, Georgios; Cai, Di; Kappas, Arvid (2010). “Sentiment strength detection in short informal text”. Journal of the American Society for Information Science and Technology. 61 (12): 2544-2558. CiteSeerX 10.1.1.278.3863. doi:10.1002/asi.21416.
Titov, Ivan; McDonald, Ryan (2008-01-01). Modeling Online Reviews with Multi-grain Topic Models. Proceedings of the 17th International Conference on World Wide Web. WWW '08. New York, NY, USA: ACM. pp. 111-120. arXiv:0801.1063. doi:10.1145/1367497.1367513. ISBN 978-1-60558-085-2. S2CID 13609860.
Tumasjan, Andranik; O. Sprenger, Timm; G. Sandner, Philipp; M. Welpe, Isabell (2010). “Predicting Elections with Twitter: What 140 Characters Reveal about Political Sentiment” “Proceedings of the Fourth International AAAI Conference on Weblogs and Social Media”
Turney, Peter (2002). “Thumbs Up or Thumbs Down? Semantic Orientation Applied to Unsupervised Classification of Reviews”. Proceedings of the Association for Computational Linguistics. pp. 417-424. arXiv:cs.LG/0212032.
USA Issued 7,136,877, Volcani, Yanon; & Fogel, David B., “System and method for determining and controlling the impact of text”
Vong Anh Ho, Duong Huynh-Cong Nguyen, Danh Hoang Nguyen, Linh Thi-Van Pham, Duc-Vu Nguyen, Kiet Van Nguyen, Ngan Luu-Thuy Nguyen. “Emotion Recognition for Vietnamese Social Media Text”. In Proceedings of the 2019 International Conference of the Pacific Association for Computational Linguistics (PACLING 2019), Hanoi, Vietnam (2019).
Vryniotis, Vasilis (2013). The importance of Neutral Class in Sentiment Analysis.
Wiebe, Janyce; Riloff, Ellen (2005). Gelbukh, Alexander (ed.). “Creating Subjective and Objective Sentence Classifiers from Unannotated Texts”. Computational Linguistics and Intelligent Text Processing. Lecture Notes in Computer Science. Berlin, Heidelberg: Springer. 3406: 486-497. doi:10.1007/978-3-540-30586-6_53. ISBN 978-3-540-30586-6.
Wiebe, Janyce; Riloff, Ellen (July 2011). “Finding Mutual Benefit between Subjectivity Analysis and Information Extraction”. IEEE Transactions on Affective Computing. 2 (4): 175-191. doi:10.1109/T-AFFC.201119. ISSN 1949-3045. S2CID 16820846.
Wood, Ian B.; Varela, Pedro L.; Bollen, Johan; Rocha, Luis M.; Gongalves-Sá, Joana (2017). “Human Sexual Cycles are Driven by Culture and Match Collective Moods”. Scientific Reports. 7 (1): 17973. arXiv:1707.03959. Bibcode:2017NatSR . . . 717973W. doi:10.1038/s41598-017-18262-5. PMC 5740080. PMID 29269945.
X. Ouyang, P. Zhou, C. H. Li and L. Liu, “Sentiment Analysis Using Convolutional Neural Network,” 2015 IEEE International Conference on Computer and Information Technology; Ubiquitous Computing and Communications; Dependable, Autonomic and Secure Computing; Pervasive Intelligence and Computing, 2015, pp. 2359-2364, doi: 10.1109iCIT/IUCCIDASC/PICOM.2015.349.
Y. Santur, “Sentiment Analysis Based on Gated Recurrent Unit,” 2019 International Artificial Intelligence and Data Processing Symposium (IDAP), 2019, pp. 1-5, doi: 10.1109/IDAP.2019.8875985.
Yu, Hong; Hatzivassiloglou, Vasileios (2003-07-11). “Towards answering opinion questions: separating facts from opinions and identifying the polarity of opinion sentences”. Proceedings of the 2003 Conference on Empirical Methods in Natural Language Processing. EMNLP '03. USA: Association for Computational Linguistics: 129-136. doi:10.3115/1119355.1119372.
Zhai, Zhongwu; Liu, Bing; Xu, Hua; Jia, Peifa (2011-01-01). Huang, Joshua Zhexue; Cao, Longbing; Srivastava, Jaideep (eds.). Constrained LDA for Grouping Product Features in Opinion Mining. Lecture Notes in Computer Science. Springer Berlin Heidelberg. pp. 448-459. CiteSeerX 10.1.1.221.5178. doi:10.1007/978-3-642-20841-6_37. ISBN 978-3-642-20840-9.
en.wikipedia.org/wiki/Sentiment_analysis
towardsdatascience.comisentiment-analysis-concept-analysis-and-applications-6c94d6f58c17

15. Virtual Private Network

AU 2004321282; AU 2005260197; AU 2005260198; AU 2011247016; AU 2012204726; AU 2013241900; AU 2014256336; AU 2016265989; AU 2016315646; AU 2018300269; AU 2019201542; AU 2020239820; AU 2021200641; AU 2022204565; BR 112016023899; BR 112020000631; BR P10418936; BR P10512909; CA 2345241; CA 2565896; CA 2628560; CA 2795619; CA 2799570; CA 2800395; CA 2823911; CA 2868380; CA 2996421; CA 3038506; CA 3141172; CN 100531136; CN 100531208; CN 100576847; CN 100583798: CN 101001264; CN 101106454; CN 101111680; CN 101222406; CN 101252509; CN 101297523; CN 101315694; CN 101330429; CN 101388823; CN 101599883; CN 101753430; CN 101854313; CN 102025589; CN 102130811: CN 102281161; CN 102468899; CN 102546434; CN 102594678; CN 102739497; CN 102868586; CN 103023667; CN 103023783; CN 103107942; CN 103209108; CN 103957160; CN 103986638; CN 104133889; CN 104301192; CN 104322011; CN 104379071; CN 104426737; CN 104427010; CN 104954260; CN 105072010; CN 105224385; CN 105393501; CN 105591870; CN 105939262; CN 106506533; CN 106789537; CN 106850380: CN 107426100; CN 107925589; CN 108028838: CN 108521362; CN 108667729; CN 108809797; CN 110096084; CN 110380947; CN 110830352; CN 110995600: CN 111050695; CN 111510316; CN 111611280; CN 111884903; CN 112183991; CN 112242943; CN 112260928; CN 112272134; CN 112769670; CN 113300949; CN 113347071; CN 113489811; CN 113595804; CN 113630276; CN 113630809; CN 113746707; CN 113794617; CN 114006887; CN 114039812; CN 114143283; CN 114206560; CN 114422301; CN 114650229; CN 1214583; CN 1306771; CN 1414749; CN 1469599; CN 1758654; CN 1783887; CN 1981487; CN 1981488; CN 1984076; CN 201418081; CN 201418083; CN 201418084; CN 201467149; CN 201467150; CN 201479159; CN 201830291: CN 201846361; CN 216620100; DE 102009023082; DE 112012005631; DE 112012005631; DE 1833378; DE 2603176; DE 60212289; EP 0988711; EP 0988711; EP 1116132; EP 1304830; EP 1304830; EP 1396964; EP 1667382; EP 1762048; EP 1762049; EP 1762050; EP 1770617; EP 1832083; EP 2015538: EP 2154644: EP 2383003; EP 2661871; EP 2676688; EP 2815546; EP 2830510: EP 3039828; EP 3103221; EP 3131528; EP 3207950; EP 3329654; EP 3342100: EP 3599742; EP 3651690; EP 3690649; EP 3761622; EP 3980225; ES 2372389; ES 2442875; ES 2815568; GB 201413351; GB 2419067; GB 2458193; GB 2513270; HU 230551; IL 257708; IN 2006DN07007; IN 2006MN01465; IN 2007DN00096; IN 2014CN07331; IN 2014CN07734; IN 201641005073; IN 256385; IN 329713; JP 2002525753; JP 2004135248; JP 2005229651; JP 2005229652; JP 2005341583; JP 2006109455; JP 2008306725; JP 2008505527; JP 2008505531; JP 2008505532; JP 2008534831; JP 2010252261; JP 2012175198; JP 2013034128; JP 2013038684; JP 2013172428; JP 2015014907; JP 2015512706; JP 2018041224; JP 2018047277; JP 2018532300; JP 2019165291; JP 2021184605; JP 3946731; JP 4011528; JP 4025784; JP 4056849; JP 4555337; JP 4564057; JP 4584998; JP 4601704; JP 4869248; JP 5596637; JP 5690295; JP 6400175; JP 6805654; JP 6910348; JP H10227966; JP WO2005027438; JP WO2007108124; JP WO2015166523; KR 101063049; KR 101145575; KR 101145587; KR 101299622; KR 101352693; KR 102108233; KR 20030034777; KR 20070026591; KR 20070032713; KR 20070035502; KR 20070116785; KR 20080107268; KR 20150023235; KR 20200026985; MX 2014011371; MX PA00012491; RU 2014143006; RU 2206044; RU 2633595; SU 101702; SU 101839; SU 1117089; SU 1735788; TW 200404230; TW 200538153; TW 201140245; TW 1379948; U.S. Ser. No. 10/044,502; U.S. Ser. No. 10/051,002; U.S. Ser. No. 10/257,167; U.S. Ser. No. 10/284,523; U.S. Ser. No. 10/397,275; U.S. Ser. No. 10/516,756; U.S. Ser. No. 10/523,426; U.S. Ser. No. 10/554,685; U.S. Ser. No. 10/567,347; U.S. Ser. No. 10/568,633; U.S. Ser. No. 10/601,779; U.S. Ser. No. 10/728,395; U.S. Ser. No. 11/006,000; U.S. Ser. No. 11/049,349; U.S. Ser. No. 11/303,528: U.S. Ser. No. 11/336,482; U.S. Ser. No. 11/394,692; US 20030069958; US 20030069973; US 20030126233; US 20040006708; US 20040037260; US 20040085973; US 20050055306; US 20050265355; US 20060018300; US 20060090067; US 20060133265; US 20070081530; US 20080114887; US 20080144625; US 20080201486; US 20080307519; US 20090035151; US 20090235359; US 20090287810; US 20090296718; US 20100013607; US 20100058232; US 20100121751; US 20100154050; US 20100287158; US 20100322085; US 20110019550; US 20120170449; US 20130046226; US 20130117459; US 20130155861; US 20130188476; US 20130294443; US 20140369349; US 20150033321; US 20150066066; US 20160036700; US 20160164845; US 20160182444; US 20160241719; US 20170033924; US 20170034129; US 20170063782; US 20170063787; US 20170063794; US 20170063797; US 20170063822; US 20170063928; US 20170064749; US 20170303928; US 20180198920; US 20180350180; US 20180375646; US 20190342346; US 20200120130; US 20200177555; US 20200220785; US 20200252234; US 20200358906; US 20200388074; US 20210113209; US 20210136040; US 20210337070; US 20220103523; U.S. Pat. Nos. 5,818,378; 7,068,640; 7,305,492; 7,363,353; 7,421,736; 7,430,210; 7,765,328; 7,840,701; 7,852,861; 7,869,447; 7,957,304; 8,019,850; 8,203,965; 8,300,554; 8,369,343; 8,370,528; 8,536,989; 8,683,574; 8,721,295; 8,724,452; 8,812,693; 8,997,206; 9,083,628; 9,216,248; 9,264,552; 9,479,356; 9,509,606: U.S. Pat. Nos. 9,537,711; 9,730,698; 9,860,279; 9,860,387; 9,871,762; 9,894,103; 9,906,560; 9,906,561; 9,906,562; WO 1998057438: WO 2000017775; WO 2005027438; WO 2006004461; WO 2006004500: WO 2006004501; WO 2006067623; WO 2006109861; WO 2007108124; WO 2008105795; WO 2008148280; WO 2010069261; WO 2011135427; WO 2012093379; WO 2013120377; WO 2013120406; WO 2013144148; WO 2015007196; WO 2015027904; WO 2015027910; WO 2015159099; WO 2015166523; WO 2016015439; WO 2017023706; WO 2017040334; WO 2019012331; and WO 2020247622.
“1. Ultimate Powerful VPN Connectivity”. www.softether.org. SoftEther VPN Project.
“Configuring PFC3BXL and PFC3B Mode Multiprotocol Label Switching”
“Diff 99761f1eac33d14a4b1613ae4b7076f41cb2df94\hat{ }! kernel/common Git at Google”. android.googlesource.com.
“Overview of Provider Provisioned Virtual Private Networks (PPVPN)”. Secure Thoughts. Retrieved 29 Aug. 2016.
“Virtual Private Networking: An Overview”. TechNet. Microsoft Docs. 4 Sep. 2001. Retrieved 7 Nov. 2021.

Address Allocation for Private Internets, R F C 1918, Y. Rekhter et al., February 1996
Ahmat, Daouda, Mahamat Barka, and Damien Magoni. “Mobile VPN Schemes: Technical Analysis and Experiments.” In International Conference on e-Infrastructure and e-Services for Developing Countries, pp. 88-97. Springer, Cham, 2016.
Aoyagi, S., M. Takizawa, M. Saito, H. Aida, and H. Tokuda. Ela: a fully distributed vpn system over peer-to-peer network. In The 2005 Symposium on Applications and the Internet, February 2005.
Barnes, Richard; Karthikeyan Bhargavan, and Christopher A. Wood. Hybrid Public Key Encryption. Internet-Draft draft-irtf-cfrg-hpke-04, Internet Engineering Task Force, May 2020. Work in Progress.
Benjamin Dowling, and Kenneth G. Paterson (12 Jun. 2018). “A cryptographic analysis of the WireGuard protocol”. International Conference on Applied Cryptography and Network Security. ISBN 978-3-319-93386-3.
Boudot, Fabrice. Efficient proofs that a committed number lies in an interval. In Advances in Cryptology-EUROCRYPT 2000, pages 431-444, Berlin, Heidelberg, 2000. Springer.
Brainard, John, Burt Kaliski, Sean Turner, and James Randall. Use of the RSA-KEM Key Transport Algorithm in the Cryptographic Message Syntax (CMS). RFC 5990, September 2010.
Brinkmann, Martin. Beware: Hola vpn turns your pc into an exit node and sells your traffic. www.ghacks.net/201505128/beware-holavpn-turns-your-pc-into-an-exit-node-and-sells-your-traffic/, 2015.
Buchegger, Sonja, Doris Schibberg, Le-Hung Vu, and Anwitaman Datta. “PeerSoN: P2P social networking: early experiences and insights.” In Proceedings of the Second ACM EuroSys Workshop on Social Network Systems, pp. 46-52. 2009.
Camenisch, Jan, and Markus Michels. Proving in zero-knowledge that a number is the product of two safe primes. In EUROCRYPT '99, pages 107-122, Berlin, Heidelberg, 1999. Springer.
Camenisch, Jan, and Markus Stadler. Efficient group signature schemes for large groups (extended abstract). In Proceedings of the 17th Annual International Cryptology Conference on Advances in Cryptology, CRYPTO '97, pages 410-424, 1997.
Cannell, Jake S., Justin Sheek, Jay Freeman, Greg Hazel, Jennifer Rodriguez-Mueller, Eric Hou, Brian J. Fox, and Steven Waterhouse. “Orchid: A decentralized network routing market.” Tech. Rep. (2019).
Chakeres, I. “Mobile ad hoc network architecture.” draft-ietf-autoconf-manetarch-07 (2007).
Cholez, Thibault, Isabelle Chrisment, and Olivier Festor. Evaluation of sybil attacks protection schemes in kad. In IFIP International Conference on Autonomous Infrastructure, Management and Security, pages 70-82. Springer, 2009.
Cimpanu, Catalin. Hacking vpn servers to plant backdoors in companies. www.zdnet.com/article/iranian-hackers-have-been-hacking-vpnservers-to-plant-backdoors-in-companies-around-the-worldi, 2020.
Cisco Systems, Inc. (2004). Internetworking Technologies Handbook. Networking Technology Series (4 ed.). Cisco Press. p. 233. ISBN 9781587051197. Retrieved 15 Feb. 2013.
Cisco, “What Is a VPN? Virtual Private Network”.
Cvrk, Lubomir, Jiri Misurec, and Vit Vrba. “Application-independent Decentralized and Secure Communication with NAT traversal.” In International Conference on Networking, International Conference on Systems and International Conference on Mobile Communications and Learning Technologies (ICNICONSMCL'06), pp. 58-58. IEEE, 2006.
Davies, Joseph (July 2007). “IPv6 Traffic over VPN Connections”. The Cable Guy. TechNet Magazine.
Deri, Luca, and Richard Andrews. N2n: A layer two peer-to-peer vpn. In IFIP International Conference on Autonomous Infrastructure, Management and Security, pages 53-64. Springer, 2008.
Diaz, Claudia, Harry Halpin, and Aggelos Kiayias. “The Nym Network.” (2021): 1-38.
Ding, Ding, Kyuho Jeong, Shuning Xing, Mauro Conti, Renato Figueiredo, and Fangai Liu. “Send: a social network friendship enhanced decentralized system to circumvent censorships.” IEEE Transactions on Services Computing (2019).
Dittus, Martin, Joss Wright, and Mark Graham. Platform criminalism: The ‘last-mile’ geography of the darknet market supply chain, In Proceedings of the 2018 World Wide Web Conference, WWW '18, pages 277-286, Republic and Canton of Geneva, Switzerland, 2018. International World Wide Web Conferences Steering Committee.
El Gamal, Taher. A public key cryptosystem and a signature scheme based on discrete logarithms. In Proceedings of CRYPTO 84 on Advances in Cryptology, pages 10-18, 1985.
Fujita, Sho, Keiichi Shima, Yojiro Uo, and Hiroshi Esaki. “A decentralized VPN service over generalized mobile ad-hoc networks.” IEICE transactions on information and systems 92, no. 10 (2009): 1897-1904.
Glyn M Burton: RFC 3378 EtherlP with FreeBSD, 3 Feb. 2011
Guillou, Louis C., and Jean-Jacques Quisquater. A practical zeroknowledge protocol fitted to security microprocessor minimizing both transmission and memory. In EUROCRYPT'88, 1988.
Harris, Brendon, and Ray Hunt. Tcp/ip security threats and attack methods. Computer communications, 22(10):885-897, 1999.
Hoffman, P., Dns queries over https (doh). tools.ietf.org/html/rfc8484, 2018.
Hollenbeck, Scott; Housley, Russell. “EtherlP: Tunneling Ethernet Frames in IP Datagrams”.
IETF (1999), RFC 2661, Layer Two Tunneling Protocol “L2TP”
Ikram, Muhammad, Narseo Vallina-Rodriguez, Suranga Seneviratne, Mohamed Ali Kaafar, and Vern Paxson. An analysis of the privacy and security risks of android vpn permission-enabled apps. In Proc. ACM IMC, pages 349-364. ACM, 2016.
IP Based Virtual Private Networks, RFC 2341, A. Valencia et al., May 1998
IPFS Team. Inter-Planetary File System. ipfs.io/.
Juste, Pierre St, David Wolinsky, P. Oscar Boykin, Michael J. Covington, and Renato J. Figueiredo. “SocialVPN: Enabling wide-area collaboration with integrated social and overlay networks.” Computer Networks 54, no. 12 (2010): 1926-1938.
Kaashoek, M Frans, and David R Karger. Koorde: A simple degree-optimal distributed hash table. In International Workshop on Peer-toPeer Systems, pages 98-107. Springer, 2003.
Khan, Mohammad Taha, Joe DeBlasio, Geoffrey M Voelker, Alex C Snoeren, Chris Kanich, and Narseo Vallina-Rodriguez. An empirical analysis of the commercial vpn ecosystem. In Proc. ACM IMC, 2018.
Lewis, Mark (2006). Comparing, designing, and deploying VPNs (1st print. ed.). Indianapolis, Ind.: Cisco Press. pp. 5-6. ISBN 1587051796.
Martin, Alexander J., Do you use hola vpn? you could be part of a ddos, content theft or worse. www.theregister.co.uk/2015/06/10/hola gets holes poked in client lulzsec/, 2015.
Mason, Andrew G. (2002). Cisco Secure Virtual Private Network. Cisco Press. p. 7. ISBN 9781587050336.
net-security.org news: Multi-protocol SoftEther VPN becomes open source, January 2014
Nobori, Daiyuu, and Yasushi Shinjo. VPN gate: A volunteer-organized public VPN relay system with blocking resistance for bypassing government censorship firewalls. In Proceedings of the 11th USENIX Symposium on Networked Systems Design and Implementation (NSDI 14), pages 229-241, Seattle, W A, 2014. USENIX.
OpenVPN. openvpn.netV, 2019.
ownVPN.io. Create your own vpn. proprivacy.com/guides/createyour-own-vpn-server, 2019.
Peng, Kun, and Feng Bao. An efficient range proof scheme. In Proceedings of the 2010 IEEE Second International Conference on Social Computing, SOCIALCOM '10, pages 826-833, Washington, DC, USA, 2010. IEEE Computer Society.
Pestana, Gonçalo, Iñigo Querejeta-Azurmendi, Panagiotis Papadopoulos, and Benjamin Livshits. “Themis: A decentralized privacy-preserving ad platform with reporting integrity.” arXiv preprint arXiv:2106.01940 (2021).
Phifer, Lisa. “Mobile VPN: Closing the Gap”, SearchMobileComputing.com, Jul. 16, 2006.
Point-to-Point Tunneling Protocol (PPTP), RFC 2637, K. Hamzeh et al., July 1999
Protocol Labs. Filecoin, a decentralized storage system. filecoin.io/, 2021.
ProtonVPN. Proton vpn. protonvpn.com/, 2019.
Rescorla, E., TLS 1.3 rfc. tools.ietf.org/html/rfc8446, 2018.
Rescorla, Eric, Kazuho Oku, Nick Sullivan, and Christopher A. Wood. Encrypted Server Name Indication for TLS 1.3. Internet-Draft draft-ietftls-esni-03, Internet Engineering Task Force, 3 2019. Work in Progress.
Rescorla, Eric, Kazuho Oku, Nick Sullivan, and Christopher A. Wood. TLS Encrypted Client Hello. Internet-Draft draft-ietf-tls-esni-07, Internet Engineering Task Force, June 2020. Work in Progress.
RFC 1702: Generic Routing Encapsulation over IPv4 networks. October 1994.
RFC 2917, A Core MPLS IP VPN Architecture
RFC 2918, E. Chen (September 2000)
RFC 3809 Generic Requirements for Provider Provisioned Virtual Private Networks. sec. 1.1. doi:10.17487/RFC3809. RFC 3809.
RFC 6434, “1Pv6 Node Requirements”, E. Jankiewicz, J. Loughney, T. Narten (December 2011)
Rosen E., & Y. Rekhter (March 1999). “BGP/MPLS VPNs”. Internet Engineering Task Force (IETF). RFC 2547.
Salter, Jim (30 Mar. 2020). “WireGuard VPN makes it to 1.0.0—and into the next Linux kernel”. Ars Technica.
Shinjo, Yasushi, Xiao Kunyao, Naoki Kainuma, Daiyuu Nobori, and Akira Sato. “Friend news system: A modern implementation of usenet over social vpns.” In 2014 IEEE Fourth International Conference on Big Data and Cloud Computing, pp. 432-440. IEEE, 2014.
St Juste, Pierre, David Wolinsky, P Oscar Boykin, Michael J Covington, and Renato J Figueiredo. Socialvpn: Enabling wide-area collaboration with integrated social and overlay networks. Computer Networks, 2010.
St Juste, Pierre, Heungsik Eom, Kyungyong Lee, and Renato J. Figueiredo. “Enabling decentralized microblogging through P2PVPNs.” In 2013 IEEE 10th consumer communications and networking conference (CCNC), pp. 323-328. IEEE, 2013.
Steiner, Moritz, Damiano Carra, and Ernst W Biersack. Evaluating and improving the content access in kad. Peer-to-peer networking and applications, 2010.
The Mysterium Network. Mysterium network: Decentralised vpn built on blockchain. mysterium.network/.
Townsley, W., et al., Layer Two Tunneling Protocol “L2TP”, RFC 2661, August 1999 TransmissionBT. Transmission. transmissionbt.com/, 2019.
Tsampas, Georgios. “Survey on decentralized applications.” Master's thesis, novEIIGT-Tpio nElpoal, 2022.
Varvello, Matteo, and Moritz Steiner. Traffic localization for dhtbased bittorrent networks. In International Conference on Research in Networking, pages 40-53. Springer, 2011.
Varvello, Matteo, Inigo Querejeta Azurmendi, Antonio Nappa, Panagiotis Papadopoulos, Goncalo Pestana, and Benjamin Livshits. “VPN-Zero: A Privacy-Preserving Decentralized Virtual Private Network.” In 2021 IFIP Networking Conference (IFIP Networking), pp. 1-6. IEEE, 2021.
Vilenski, Ofer and Derry Shribman. Hola free vpn unblock any website. hola.org/, 2020.
WeißI, Felix. “Bootstrapping P2P VPN.” Network 1 (2014).
Wolinsky, David Isaac. Design, implementation, and applications of peer-to-peer virtual private networks from grids to social networks. University of Florida, 2011.
Yang, Yanyan (2006). “IPsec/VPN security policy correctness and assurance”. Journal of High Speed Networks. 15: 275-289. CiteSeerX 10.1.1.94.8561.
Younglove, R. (December 2000). “Virtual private networks how they work”. Computing & Control Engineering Journal. 11 (6): 260-262. doi:10.1049/cce:20000602. ISSN 0956-3385.
Zhang, Fan, Deepak Maram, Harjasleen Malvai, Steven Goldfeder, and Ari Juels. DECO: liberating web data using decentralized oracles for TLS. In Jay Ligatti, Xinming Ou, Jonathan Katz, and Giovanni Vigna, editors, CCS '20: 2020 ACM SIGSAC Conference on Computer and Communications Security, Virtual Event, USA, Nov. 9-13, 2020, pages 1919-1938. ACM, 2020.
Zhao, Ben Y, Ling Huang, Jeremy Stribling, Sean C Rhea, Anthony D Joseph, and John D Kubiatowicz. Tapestry: A resilient global-scale overlay for service deployment. IEEE Journal on selected areas in communications, 22(1):41-53, 2004.

16. Artificial Intelligence

6182038; 7774197; 8185375; 8239200; 8326598; 8494850; 8527534; 8554769; 8572126; 8577670; 8655647; 8725509; 9037464; 9235567; 9336771; 9378731; 9412365; 9460088; 9786270; 9858922; 9881613; 10134394; 10204619; 10229672; 10403291; 10706840; 10885436; 10924629; 11045271; 11100288; 11200497; 11232266; 11238332; 11295092; 11302310; 11314945; 11361571; 11373107; 11394799; 11397846; 11397892; 11404144; 11430467; 11438457; 11445267; 11461415; 11461774; 11501171; 11531846; 11574168; 11604626; 11615246; 11632456; 11644961; 11646014; 11671385; 11676044; 11681541; 11704503; 20020087313; 20040138883; 20040138884; 20050154580; 20060293899; 20070094024; 20070265826; 20080091427; 20080243481; 20080262828; 20110137653; 20110191100; 20120089387; 20120316877; 20130253908; 20140149102; 20140278407; 20140372119; 20150206528; 20150243285; 20150278191; 20160365090; 20160365093; 20170148434; 20170236518; 20180075084; 20190156816; 20200034436; 20200219492; 20200285704; 20210004432; 20210049458; 20210073891; 20210081728; 20210082561; 20210089724; 20210097144; 20210124876; 20210125051; 20210142164; 20210142789; 20210157990; 20210174023; 20210174162; 20210174794; 20210182489; 20210193121; 20210255842; 20210264109; 20210271823; 20210273954; 20210295822; 20210335503; 20210365500; 20210366103; 20210368134; 20210374133; 20210374198; 20210390263; 20210397793; 20220036153; 20220067077; 20220068443; 20220092440; 20220092608; 20220101052; 20220114479; 20220114851; 20220115008; 20220121822; 20220122391; 20220129450; 20220138559; 20220147570; 20220147702; 20220147843; 20220164549; 20220165257; 20220165356; 20220171930; 20220171938; 20220180071; 20220180180; 20220187847; 20220188366; 20220189223; 20220197306; 20220198130; 20220198144; 20220198254; 20220207321; 20220222047; 20220229832; 20220229999; 20220230089; 20220237368; 20220237382; 20220237390; 20220237422; 20220245339; 20220245343; 20220245354; 20220245362; 20220245574; 20220246150; 20220247584; 20220254150; 20220261535; 20220261551; 20220261732; 20220269534; 20220270421; 20220270597; 20220270744; 20220279014; 20220284884; 20220292139; 20220292173; 20220292266; 20220292268; 20220293107; 20220293267; 20220293271; 20220300711; 20220310080; 20220310084; 20220318254; 20220318669; 20220319260; 20220327288; 20220328038; 20220328039; 20220335303; 20220343250; 20220343938; 20220344008; 20220351089; 20220351195; 20220358125; 20220358291; 20220358295; 20220366127; 20220366135; 20220366145; 20220366153; 20220366282; 20220377107; 20220382565; 20220383084; 20220383159; 20220383879; 20220385603; 20220385703; 20220391591; 20220392434; 20220395975; 20220398438; 20220398439; 20220398794; 20220405193; 20220405461; 20220405484; 20220414123; 20220414128; 20220414137; 20220414329; 20220414334; 20220414467; 20230005312; 20230005475; 20230016729; 20230018116; 20230020886; 20230021996; 20230024468; 20230029196; 20230030086; 20230030405; 20230030870; 20230031449; 20230032678; 20230033114; 20230033622; 20230034495; 20230038895; 20230042956; 20230043702; 20230050655; 20230057387; 20230057691; 20230060252; 20230064886; 20230066320; 20230071274; 20230071799; 20230074406; 20230075884; 20230078448; 20230078698; 20230080674; 20230083512; 20230083562; 20230083724; 20230094511; 20230095180; 20230098602; 20230100208; 20230101174; 20230102048; 20230102198; 20230104491; 20230104655; 20230104662; 20230105053; 20230109379; 20230109734; 20230112740; 20230112921; 20230114150; 20230114374; 20230114673; 20230117135; 20230117297; 20230117430; 20230117725; 20230117801; 20230118213; 20230118717; 20230119584; 20230121711; 20230121779; 20230121913; 20230122304; 20230122874; 20230123026; 20230123322; 20230123346; 20230123865; 20230124040; 20230124288; 20230124608; 20230124806; 20230125194; 20230125711; 20230126030; 20230128136; 20230129494; 20230129511; 20230130594; 20230131603; 20230132061; 20230133851; 20230135179; 20230135659; 20230139347; 20230140125; 20230141398; 20230146197; 20230147668; 20230149746; 20230152971; 20230153460; 20230153545; 20230154186; 20230154266; 20230154453; 20230154574; 20230161779; 20230161808; 20230161964; 20230161972; 20230161978; 20230162719; 20230168411; 20230168899; 20230169023; 20230169305; 20230176242; 20230176557; 20230176829; 20230177097; 20230177261; 20230177279; 20230177357; 20230177558; 20230177878; 20230185768; 20230185769; 20230185957; 20230186071; 20230195478; 20230195768; 20230195814; 20230195828; 20230196018; 20230196022; 20230196105; 20230196179; 20230196341; 20230196583; 20230196936; 20230197070; 20230205803; 20230205804; 20230205805; 20230206708; 20230206910; 20230208869; 20230215282; 20230222388; 20230222454; 20230222531; 20230222653; and 20230223016.
“20B-parameter Alexa model sets new marks in few-shot learning”. Amazon Science. 2 Aug. 2022.
“Abu Dhabi-based TII launches its own version of ChatGPT”. tii.ae.
“Alexa™ 20B is now available in Amazon SageMaker JumpStart I AWS Machine Learning Blog”. aws.amazon.com. 17 Nov. 2022.
“Aligning language models to follow instructions”. openai.com. Archived from the original on 23 Mar. 2023.
“BERT”. Mar. 13, 2023-via GitHub.
“BERT, RoBERTa, DistilBERT, XLNet: Which one to use?”.
“Better Language Models and Their Implications”. OpenAI. 2019-02-14.
“ChatGPT: Optimizing Language Models for Dialogue”. OpenAI. 2022-11-30.
“Could chatbots help devise the next pandemic virus?”. Science. 14 Jun. 2023. doi:10.1126/science.adj2463.
“CSDL|IEEE Computer Society”. www.computer.org.
“Democratizing access to large-scale language models with OPT-175B”. ai.facebook.com.
“Free Dolly: Introducing the World's First Truly Open Instruction-Tuned LLM”. Databricks. Apr. 12, 2023.
“Generative AI: a game-changer society needs to be ready for”. World Economic Forum.
“Google Opens Access to PaLM Language Model”.
“GPT Neo”. Mar. 15, 2023-via GitHub.
“GPT-1 to GPT-4: Each of OpenAI's GPT Models Explained and Compared”. MUO. Apr. 11, 2023.
“gpt-2”. GitHub. Retrieved 13 Mar. 2023.
“GPT-2: 1.5B Release”. OpenAI. 2019-11-05.
“GPT-4 Technical Report” (PDF). OpenAI. 2023.
“GPT-4”. openai.com. Retrieved 2023-05-01.
“GPT-J-6B: An Introduction to the Largest Open Source GPT Model|Forefront”. www.forefront.ai. Retrieved 2023-02-28.
“Improving language understanding with unsupervised learning”. openai.com. Jun. 11, 2018.
“Introducing ChatGPT”. openai.com. Archived from the original on 2023-03-16.
“Introducing Llama 2: The Next Generation of Our Open Source Large Language Model”. Meta A1. 2023.
“Introducing LLaMA: A foundational, 65-billion-parameter large language model”. Meta A1. 24 Feb. 2023.
“Introducing PaLM 2”. Google. May 10, 2023.
“Introducing the Center for Research on Foundation Models (CRFM)”. Stanford HAI.
“Language modelling at scale: Gopher, ethical considerations, and retrieval”. www.deepmind.com.

Retrieved 20 Mar. 2023.
“Large Language Model: world models or surface statistics?”. The Gradient. 2023-01-21.
“Meta Debuts AI Language Model, But It's Only for Researchers”. PCMAG.
“Minerva: Solving Quantitative Reasoning Problems with Language Models”. ai.googleblog.com. 30 Jun. 2022.
“Model index for researchers”. OpenAI API. Archived from the original on 23 Jun. 2023.
“New GPT-3 capabilities: Edit & insert”. openai.com. Retrieved 2023-06-24.
“OpenAI's GPT-3 Language Model: A Technical Overview”. Iambdalabs.com. 3 Jun. 2020.
“PAL: Program-aided Language Models”. reasonwithpal.com.
“Papers with Code—MassiveText Dataset”. paperswithcode.com. Retrieved 2023-04-26.
“Parameter, Compute and Data Trends in Machine Learning”. Google Docs. Retrieved 2023-06-20.
“Prepare for truly useful large language models”. Nature Biomedical Engineering. 7 (2): 85-86. 7 Mar. 2023. doi:10.1038/s41551-023-01012-6. PMID 36882584. S2CID 257403466.
“Product”. Anthropic. Retrieved 14 Mar. 2023.
“Stanford CRFM”. crfm.stanford.edu.
“The A to Z of Artificial Intelligence”. Time. Apr. 13, 2023.
“The Falcon has landed in the Hugging Face ecosystem”. huggingface.co. Retrieved 2023-06-20.
“Voyager|An Open-Ended Embodied Agent with Large Language Models”. voyager.minedojo.org.
“WebGPT: Improving the factual accuracy of language models through web browsing”. openai.com.
Archived from the original on 21 Jun. 2023. Retrieved 2023-07-02.
A Closer Look at Large Language Models Emergent Abilities (Yao Fu, Nov. 20, 2022)
Alayrac, Jean-Baptiste; Donahue, Jeff; Luc, Pauline; Miech, Antoine; Barr, lain; Hasson, Yana; Lenc, Karel; Mensch, Arthur; Millican, Katherine; Reynolds, Malcolm; Ring, Roman; Rutherford, Eliza; Cabi, Serkan; Han, Tengda; Gong, Zhitao (2022-12-06). “Flamingo: a Visual Language Model for Few-Shot Learning”. Advances in Neural Information Processing Systems. 35: 23716-23736. arXiv:2204.14198.
Alford, Anthony (Jul. 13, 2021). “EleutherAl Open-Sources Six Billion Parameter GPT-3 Clone GPT-J”. InfoQ.
Alvi, Ali; Kharya, Paresh (11 Oct. 2021). “Using DeepSpeed and Megatron to Train Megatron-Turing NLG 530B, the World's Largest and Most Powerful Generative Language Model”. Microsoft Research.
Ananthaswamy, Anil (8 Mar. 2023). “In AI, is bigger always better?”. Nature. 615 (7951): 202-205. Bibcode:2023Natur.615..202A. doi:10.1038/d41586-023-00641-w. PMID 36890378. S2CID 257380916.
Anil, Rohan; et al. (2023). “PaLM 2 Technical Report”. arXiv:2305.10403.
Antol, Stanislaw; Agrawal, Aishwarya; Lu, Jiasen; Mitchell, Margaret; Batra, Dhruv; Zitnick, C. Lawrence; Parikh, Devi (2015). “VQA: Visual Question Answering”: 2425-2433.
Askell, Amanda; Bai, Yuntao; Chen, Anna; et al. (9 Dec. 2021). “A General Language Assistant as a Laboratory for Alignment”. arXiv:2112.00861.
Bahdanau, Dzmitry; Cho, Kyunghyun; Bengio, Yoshua (2014-09-01). “Neural Machine Translation by Jointly Learning to Align and Translate”. arXiv:1409.0473.
Bai, Yuntao; Kadavath, Saurav; Kundu, Sandipan; et al. (15 Dec. 2022). “Constitutional AI: Harmlessness from AI Feedback”. arXiv:2212.08073.
Baker, C. L.; McCarthy, John J., eds. (1981). The Logical Problem of Language Acquisition. The MIT Press. ISBN 978-0-262-52389-9.
Banko, Michele; Brill, Eric (2001). “Scaling to very very large corpora for natural language disambiguation”. Proceedings of the 39th Annual Meeting on Association for Computational Linguistics—ACL '01. Morristown, NJ, USA: Association for Computational Linguistics: 26-33. doi:10.3115/1073012.1073017. S2CID 6645623.
Biderman, Stella; Schoelkopf, Hailey; Anthony, Quentin; Bradley, Herbie; Khan, Mohammad Aflah; Purohit, Shivanshu; Prashanth, USVSN Sai (April 2023). “Pythia: A Suite for Analyzing Large Language Models Across Training and Scaling”. arXiv:2304.01373.
Black, Sidney; Biderman, Stella; Hallahan, Eric; et al. (2022-05-01). GPT-NeoX-20B: An Open-Source Autoregressive Language Model. Proceedings of BigScience Episode #5 —Workshop on Challenges & Perspectives in Creating Large Language Models. Vol. Proceedings of BigScience Episode #5—Workshop on Challenges & Perspectives in Creating Large Language Models. pp. 95-136.
Bommasani (et-al), Rishi (Jul. 12, 2022). “On the Opportunities and Risks of Foundation Models”. arXiv:2108.07258.
Bowman, Samuel R. (2023). “Eight Things to Know about Large Language Models”. arXiv:2304.00612.
Brown, Peter F. (1993). “The mathematics of statistical machine translation: Parameter estimation”. Computational Linguistics (19): 263-311.
Brown, Tom B.; et al. (2020). “Language Models are Few-Shot Learners”. arXiv:2005.14165.
Brown, Tom B.; Mann, Benjamin; Ryder, Nick; Subbiah, Melanie; Kaplan, Jared; Dhariwal, Prafulla; Neelakantan, Arvind; Shyam, Pranav; Sastry, Girish; Askell, Amanda; Agarwal, Sandhini; Herbert-Voss, Ariel; Krueger, Gretchen; Henighan, Tom; Child, Rewon; Ramesh, Aditya; Ziegler, Daniel M.; Wu, Jeffrey; Winter, Clemens; Hesse, Christopher; Chen, Mark; Sigler, Eric; Litwin, Mateusz; Gray, Scott; Chess, Benjamin; Clark, Jack; Berner, Christopher; McCandlish, Sam; Radford, Alec; Sutskever, Ilya; Amodei, Dario (December 2020). Larochelle, H.; Ranzato, M.; Hadsell, R.; Balcan, M.F.; Lin, H. (eds.). “Language Models are Few-Shot Learners” (PDF). Advances in Neural Information Processing Systems. Curran Associates, Inc. 33: 1877-1901. arXiv:2005.14165v4.
Bubeck, Sebastien; Chandrasekaran, Varun; Eldan, Ronen; Gehrke, Johannes; Horvitz, Eric; Kamar, Ece; Lee, Peter; Lee, Yin Tat; Li, Yuanzhi; Lundberg, Scott; Nori, Harsha; Palangi, Hamid; Ribeiro, Marco Tulio; Zhang, Yi (2023). “Sparks of Artificial General Intelligence: Early experiments with GPT-4”. arXiv:2303.12712.
Caballero, Ethan; Gupta, Kshitij; Rish, Irina; Krueger, David (2022). “Broken Neural Scaling Laws”. arXiv:2210.14891.
Chen, Mark; Tworek, Jerry; Jun, Heewoo; Yuan, Qiming; Ponde de Oliveira Pinto, Henrique; Kaplan, Jared; Edwards, Harri; Burda, Yuri; Joseph, Nicholas; Brockman, Greg; Ray, Alex; Puri, Raul; Krueger, Gretchen; Petrov, Michael; Khlaaf, Heidy (2021-07-01). “Evaluating Large Language Models Trained on Code”. arXiv:2107.03374.
Cheng, Heng-Tze; Thoppilan, Romal (Jan. 21, 2022). “LaMDA: Towards Safe, Grounded, and High-Quality Dialog Models for Everything”. ai.googleblog.com.
Cho, Kyunghyun; van Merrienboer, Bart; Bahdanau, Dzmitry; Bengio, Yoshua (2014). “On the Properties of Neural Machine Translation: Encoder-Decoder Approaches”. Proceedings of SSST-8, Eighth Workshop on Syntax, Semantics and Structure in Statistical Translation. Stroudsburg, PA, USA: Association for Computational Linguistics: 103-111. doi:10.3115/v1/w14-4012. S2CID 11336213.
Chomsky, N. (September 1956). “Three models for the description of language”. IRE Transactions on Information Theory. 2 (3): 113-124. doi:10.1109/TIT.1956.1056813. ISSN 2168-2712. S2CID 19519474.
Chowdhery, Aakanksha; Narang, Sharan; Devlin, Jacob; et al. (2022). “PaLM: Scaling Language Modeling with Pathways”. arXiv:2204.02311.
Clark, Christopher; Lee, Kenton; Chang, Ming-Wei; Kwiatkowski, Tom; Collins, Michael; Toutanova, Kristina (2019). “BoolQ: Exploring the Surprising Difficulty of Natural Yes/No Questions”. arXiv:1905.10044.
Dai, Andrew M; Du, Nan (Dec. 9, 2021). “More Efficient In-Context Learning with GLaM”. ai.googleblog.com.
Deng, Li (2014-01-22). “A tutorial survey of architectures, algorithms, and applications for deep learning|APSIPA Transactions on Signal and Information Processing|Cambridge Core”. Apsipa Transactions on Signal and Information Processing. Cambridge.org. 3: e2. doi:10.1017/atsip.2013.9. S2CID 9928823.
Dettmers, Tim; Pagnoni, Artidoro; Holtzman, Ari; Zettlemoyer, Luke (2023-05-01). “QLoRA: Efficient Finetuning of Quantized LLMs”. arXiv:2305.14314.
Dettmers, Tim; Svirschevski, Ruslan; Egiazarian, Vage; Kuznedelev, Denis; Frantar, Elias; Ashkboos, Saleh; Borzunov, Alexander; Hoefler, Torsten; Alistarh, Dan (2023-06-01). “SpQR: A Sparse-Quantized Representation for Near-Lossless LLM Weight Compression”. arXiv:2306.03078.
Devlin, Jacob; Chang, Ming-Wei; Lee, Kenton; Toutanova, Kristina (11 Oct. 2018). “BERT: Pre-training of Deep Bidirectional Transformers for Language Understanding”. arXiv:1810.04805v2.
Devlin, Jacob; Chang, Ming-Wei; Lee, Kenton; Toutanova, Kristina (11 Oct. 2018). “BERT: Pre-training of Deep Bidirectional Transformers for Language Understanding”. arXiv:1810.04805v2.
Dey, Nolan (Mar. 28, 2023). “Cerebras-GPT: A Family of Open, Compute-efficient, Large Language Models”. Cerebras.
Dey, Nolan; Gosal, Gurpreet; Zhiming; Chen; Khachane, Hemant; Marshall, William; Pathria, Ribhu; Tom, Marvin; Hestness, Joel (2023-04-01). “Cerebras-GPT: Open Compute-Optimal Language Models Trained on the Cerebras Wafer-Scale Cluster”. arXiv:2304.03208.
Dodge, Jesse; Sap, Maarten; Marasovin, Ana; Agnew, William; Ilharco, Gabriel; Groeneveld, Dirk; Mitchell, Margaret; Gardner, Matt (2021). “Documenting Large Webtext Corpora: A Case Study on the Colossal Clean Crawled Corpus”. arXiv:2104.08758.
Driess, Danny; Xia, Fei; Sajjadi, Mehdi S. M.; Lynch, Corey; Chowdhery, Aakanksha; Ichter, Brian; Wahid, Ayzaan; Tompson, Jonathan; Vuong, Quan; Yu, Tianhe; Huang, Wenlong; Chebotar, Yevgen; Sermanet, Pierre; Duckworth, Daniel; Levine, Sergey (2023-03-01). “PaLM-E: An Embodied Multimodal Language Model”. arXiv:2303.03378.
Elman, Jeffrey L. (March 1990). “Finding Structure in Time”. Cognitive Science. 14 (2): 179-211. doi:10.1207/s15516709cog1402_1. S2CID 2763403.
Emily M., Bender; Gebru, Timnit; McMillan-Major, Angelina; Mitchell, Margaret (2021-03-01). “On the Dangers of Stochastic Parrots: Can Language Models Be Too Big?”. FAccT '21: Proceedings of the 2021 ACM Conference on Fairness, Accountability, and Transparency. FAccT '21. Virtual Event, Canada: ACM. pp. 610-623. doi:10.1145/3442188.3445922.
finetune-transformer-Im, OpenAI, Jun. 11, 2018
Frantar, Elias; Ashkboos, Saleh; Hoefler, Torsten; Alistarh, Dan (2022-10-01). “GPTQ: Accurate Post-Training Quantization for Generative Pre-trained Transformers”. arXiv:2210.17323.
Fu, Yao; Peng, Hao; Khot, Tushar (2022). “How does GPT Obtain its Ability? Tracing Emergent Abilities of Language Models to their Sources”. Yao Fu's Notion.
Gal, Yarin; Blunsom, Phil (12 Jun. 2013). “A Systematic Bayesian Treatment of the IBM Alignment Models” (PDF). University of Cambridge.
Ganguli, Deep; Hernandez, Danny; Lovitt, Liane; et al. (2022-06-20). “Predictability and Surprise in Large Generative Models”. 2022 ACM Conference on Fairness, Accountability, and Transparency. New York, NY, USA: ACM. pp. 1747-1764. doi:10.1145/3531146.3533229. ISBN 9781450393522.
Gao, Leo; Biderman, Stella; Black, Sid; Golding, Laurence; Hoppe, Travis; Foster, Charles; Phang, Jason; He, Horace; Thite, Anish; Nabeshima, Noa; Presser, Shawn; Leahy, Connor (31 Dec. 2020). “The Pile: An 800 GB Dataset of Diverse Text for Language Modeling”. arXiv:2101.00027.
Gao, Luyu; Madaan, Aman; Zhou, Shuyan; Alon, Uri; Liu, Pengfei; Yang, Yiming; Callan, Jamie; Neubig, Graham (2022-11-01). “PAL: Program-aided Language Models”. arXiv:2211.10435.
Goled, Shraddha (May 7, 2021). “Self-Supervised Learning Vs Semi-Supervised Learning: How They Differ”. Analytics India Magazine. gpt-2, OpenAI, 2023-05-01
GPT-4 System Card, OpenAI, Mar. 23 2023
Haddad, Mohammed. “How does GPT-4 work and how can you start using it in ChatGPT?”. www.aljazeera.com.
Hao, Shibo; Gu, Yi; Ma, Haodi; Jiahua Hong, Joshua; Wang, Zhen; Zhe Wang, Daisy; Hu, Zhiting (2023-05-01). “Reasoning with Language Model is Planning with World Model”. arXiv:2305.14992.
Hinton (et-al), Geoffrey (Oct. 15, 2012). “Deep neural networks for acoustic modeling in speech recognition” (PDF). IEEE Signal Processing Magazine. Digital Object Identifier 10.1109/MSP.2012.2205597. doi:10.1109/MSP.2012.2205597. S2CID 206485943.
Hoffmann, Jordan; Borgeaud, Sebastian; Mensch, Arthur; Buchatskaya, Elena; Cai, Trevor; Rutherford, Eliza; Casas, Diego de Las; Hendricks, Lisa Anne; Welbl, Johannes; Clark, Aidan; Hennigan, Tom; Noland, Eric; Millican, Katie; Driessche, George van den; Damoc, Bogdan (2022-03-29). “Training Compute-Optimal Large Language Models”. arXiv:2203.15556.
Hoffmann, Jordan; Borgeaud, Sebastian; Mensch, Arthur; Sifre, Laurent (12 Apr. 2022). “An empirical analysis of compute-optimal large language model training”. Deepmind Blog.
Hu, Luhui (Nov. 15, 2022). “Generative AI and Future”. Medium.
Huang, Wenlong; Abbeel, Pieter; Pathak, Deepak; Mordatch, Igor (2022-06-28). “Language Models as Zero-Shot Planners: Extracting Actionable Knowledge for Embodied Agents”. Proceedings of the 39th International Conference on Machine Learning. PMLR: 9118-9147. arXiv:2201.07207.
Huyen, Chip (18 Oct. 2019). “Evaluation Metrics for Language Modeling”. The Gradient.
Islam, Arham (Mar. 27, 2023). “Multimodal Language Models: The Future of Artificial Intelligence (AI)”.
Islam, Arham (Nov. 14, 2022). “How Do DALL-E 2, Stable Diffusion, and Midjourney Work?”.
Iyer, Abhishek (15 May 2021). “GPT-3's free alternative GPT-Neo is something to be excited about”. VentureBeat.
Ji, Ziwei; Lee, Nayeon; Frieske, Rita; Yu, Tiezheng; Su, Dan; Xu, Yan; Ishii, Etsuko; Bang, Yejin; Dai, Wenliang; Madotto, Andrea; Fung, Pascale (November 2022). “Survey of Hallucination in Natural Language Generation” (pdf). ACM Computing Surveys. Association for Computing Machinery. 55 (12): 1-38. arXiv:2202.03629. doi:10.1145/3571730. S2CID 246652372.
Jin, Charles; Rinard, Martin (2023-05-01). “Evidence of Meaning in Language Models Trained on Programs”. arXiv:2305.11169.
Jurafsky, Dan; Martin, James H. (7 Jan. 2023). Speech and Language Processing (PDF) (3rd edition draft ed.).
Kaplan, Jared; McCandlish, Sam; Henighan, Tom; Brown, Tom B.; Chess, Benjamin; Child, Rewon; Gray, Scott; Radford, Alec; Wu, Jeffrey; Amodei, Dario (2020). “Scaling Laws for Neural Language Models”. arXiv:2001.08361.
Khrushchev, Mikhail; Vasilev, Ruslan; Petrov, Alexey; Zinov, Nikolay (2022-06-22), YaLM 100B.
Kiros, Ryan; Salakhutdinov, Ruslan; Zemel, Rich (2014-06-18). “Multimodal Neural Language Models”. Proceedings of the 31st International Conference on Machine Learning. PMLR: 595-603.
Kjell (2019). “Semantic measures: Using natural language processing to measure, differentiate, and describe psychological constructs”. Psychological Methods. 24 (1): 92-115. doi:10.1037/met0000191. PMID 29963879. S2CID 49642731.
Köpf, Andreas; Kilcher, Yannic; von Rutte, Dimitri; Anagnostidis, Sotiris; Tam, Zhi-Rui; Stevens, Keith; Barhoum, Abdullah; Duc, Nguyen Minh; Stanley, Oliver; Nagyfi, Richard; ES, Shahul; Suri, Sameer; Glushkov, David; Dantuluri, Arnav; Maguire, Andrew (2023-04-14). “OpenAssistant Conversations—Democratizing Large Language Model Alignment”. arXiv:2304.07327.
Krizhevsky, Alex; Sutskever, Ilya; Hinton, Geoffrey E (2012). “ImageNet Classification with Deep Convolutional Neural Networks”. Advances in Neural Information Processing Systems. Curran Associates, Inc. 25.
Lepikhin, Dmitry; Lee, HyoukJoong; Xu, Yuanzhong; Chen, Dehao; Firat, Orhan; Huang, Yanping; Krikun, Maxim; Shazeer, Noam; Chen, Zhifeng (2021-01-12). “GShard: Scaling Giant Models with Conditional Computation and Automatic Sharding”. arXiv:2006.16668.
Lewis, Patrick; Perez, Ethan; Piktus, Aleksandra; Petroni, Fabio; Karpukhin, Vladimir; Goyal, Naman; KUttler, Heinrich; Lewis, Mike; Yih, Wen-tau; Rocktsschel, Tim; Riedel, Sebastian; Kiela, Douwe (2020). “Retrieval-Augmented Generation for Knowledge-Intensive NLP Tasks”. Advances in Neural Information Processing Systems. Curran Associates, Inc. 33: 9459-9474. arXiv:2005.11401.
Lewis-Kraus, Gideon (2016-12-14). “The Great A.I. Awakening”. The New York Times. ISSN 0362-4331. Archived from the original on 24 May 2023. Retrieved 2023-06-22.
Lewkowycz, Aitor; Andreassen, Anders; Dohan, David; Dyer, Ethan; Michalewski, Henryk; Ramasesh, Vinay; Slone, Ambrose; Anil, Cem; Schlag, Imanol; Gutman-Solo, Theo; Wu, Yuhuai; Neyshabur, Behnam; Gur-Ari, Guy; Misra, Vedant (30 Jun. 2022). “Solving Quantitative Reasoning Problems with Language Models”. arXiv:2206.14858.
Li, Junnan; Li, Dongxu; Savarese, Silvio; Hoi, Steven (2023-01-01). “BLIP-2: Bootstrapping Language-Image Pre-training with Frozen Image Encoders and Large Language Models”. arXiv:2301.12597.
Li, Kenneth; Hopkins, Aspen K.; Bau, David; Viegas, Fernanda; Pfister, Hanspeter; Wattenberg, Martin (2022-10-01). “Emergent World Representations: Exploring a Sequence Model Trained on a Synthetic Task”. arXiv:2210.13382.
Liang, Yaobo; Wu, Chenfei; Song, Ting; Wu, Wenshan; Xia, Yan; Liu, Yu; Ou, Yang; Lu, Shuai; Ji, Lei; Mao, Shaoguang; Wang, Yun; Shou, Linjun; Gong, Ming; Duan, Nan (2023-03-01). “TaskMatrix.AI: Completing Tasks by Connecting Foundation Models with Millions of APIs”. arXiv:2303.16434.
Lin, Stephanie; Hilton, Jacob; Evans, Owain (2021). “TruthfulQA: Measuring How Models Mimic Human Falsehoods”. arXiv:2109.07958.
Liu, Haotian; Li, Chunyuan; Wu, Qingyang; Lee, Yong Jae (2023-04-01). “Visual Instruction Tuning”. arXiv:2304.08485.
Luo (et-al), Renqian (Apr. 3, 2023). “BioGPT: Generative pre-trained transformer for biomedical text generation and mining”. Briefings in Bioinformatics. 23 (6). arXiv:2210.10341. doi:10.1093/bib/bbac409. PMID 36156661.
Manning, Christopher D. (2022). “Human Language Understanding & Reasoning”. Daedalus. 151 (2): 127-138. doi:10.1162/daed_a_01905. S2CID 248377870.
Metz, Cade (16 May 2023). “Microsoft Says New A.I. Shows Signs of Human Reasoning”. The New York Times.
Miller, George A.; Chomsky, Noam (1963), Luce, D. (ed.), “Finitary Models of Language Users”, Handbook of Mathematical Psychology, John Wiley & Sons., pp. 2-419
Mitchell, Melanie; Krakauer, David C. (28 Mar. 2023). “The debate over understanding in AI's large language models”. Proceedings of the National Academy of Sciences. 120 (13): e2215907120. arXiv:2210.13966. Bibcode:2023PNAS..12015907M. doi:10.1073/pnas.2215907120. PMC 10068812. PMID 36943882.
Nagel, Markus; Amjad, Rana Ali; Baalen, Mart Van; Louizos, Christos; Blankevoort, Tijmen (2020-11-21). “Up or Down? Adaptive Rounding for Post-Training Quantization”. Proceedings of the 37th International Conference on Machine Learning. PMLR: 7197-7206.
Naik, Amit Raja (Sep. 23, 2021). “Google Introduces New Architecture To Reduce Cost Of Transformers”. Analytics India Magazine.
Nakano, Reiichiro; Hilton, Jacob; Balaji, Suchir; Wu, Jeff; Ouyang, Long; Kim, Christina; Hesse, Christopher; Jain, Shantanu; Kosaraju, Vineet; Saunders, William; Jiang, Xu; Cobbe, Karl; Eloundou, Tyna; Krueger, Gretchen; Button, Kevin (2021-12-01). “WebGPT: Browser-assisted question-answering with human feedback”.
Nanda, Neel; Chan, Lawrence; Lieberum, Tom; Smith, Jess; Steinhardt, Jacob (2023-01-01). “Progress measures for grokking via mechanistic interpretability”. arXiv:2301.05217.
Narang, Sharan; Chowdhery, Aakanksha (Apr. 4, 2022). “Pathways Language Model (PaLM): Scaling to 540 Billion Parameters for Breakthrough Performance”. ai.googleblog.com.
OpenAI (2023-03-27). “GPT-4 Technical Report”. arXiv:2303.08774.
Ornes, Stephen (Mar. 16, 2023). “The Unpredictable Abilities Emerging From Large AI Models”. Quanta Magazine.
Ouyang, Long; Wu, Jeff; Jiang, Xu; Almeida, Diogo; Wainwright, Carroll L.; Mishkin, Pamela; Zhang, Chong; Agarwal, Sandhini; Slama, Katarina; Ray, Alex; Schulman, John; Hilton, Jacob; Kelton, Fraser; Miller, Luke; Simens, Maddie; Askell, Amanda; Welinder, Peter; Christiano, Paul; Leike, Jan; Lowe, Ryan (2022). “Training language models to follow instructions with human feedback”. arXiv:2203.02155.
Paranjape, Bhargavi; Lundberg, Scott; Singh, Sameer; Hajishirzi, Hannaneh; Zettlemoyer, Luke; Tulio Ribeiro, Marco (2023-03-01). “ART: Automatic multi-step reasoning and tool-use for large language models”. arXiv:2303.09014.
Park, Joon Sung; O'Brien, Joseph C.; Cai, Carrie J.; Ringel Morris, Meredith; Liang, Percy; Bernstein, Michael S. (2023-04-01). “Generative Agents: Interactive Simulacra of Human Behavior”. arXiv:2304.03442.
Patel, Ajay; Li, Bryan; Rasooli, Mohammad Sadegh; Constant, Noah; Raffel, Colin; Callison-Burch, Chris (2022). “Bidirectional Language Models Are Also Few-shot Learners”. arXiv:2209.14500.
Patel, Roma; Pavlick, Ellie (2021-10-06). “Mapping Language Models to Grounded Conceptual Spaces”.
Patil, Shishir G.; Zhang, Tianjun; Wang, Xin; Gonzalez, Joseph E. (2023-05-01). “Gorilla: Large Language Model Connected with Massive APIs”. arXiv:2305.15334.
Penedo, Guilherme; Malartic, Quentin; Hesslow, Daniel; Cojocaru, Ruxandra; Cappelli, Alessandro; Alobeidli, Hamza; Pannier, Baptiste; Almazrouei, Ebtesam; Launay, Julien (2023-06-01). “The RefinedWeb Dataset for Falcon LLM: Outperforming Curated Corpora with Web Data, and Web Data Only”. arXiv:2306.01116.
Peters ME, Neumann M, Iyyer M, Gardner M, Clark C, Lee K, Zettlemoyer L (2018). “Deep contextualized word representations”. arXiv:1802.05365.
Pichai, Sundar, Google Keynote (Google I/O '23), timestamp 15:31 Pilehvar, Mohammad Taher; Camacho-Collados, Jose (June 2019). “WiC: the Word-in-Context Dataset for Evaluating Context-Sensitive Meaning Representations”. Proceedings of the 2019 Conference of the North American Chapter of the Association for Computational Linguistics: Human Language Technologies, Volume 1 (Long and Short Papers). Minneapolis, Minnesota: Association for Computational Linguistics: 1267-1273. doi:10.18653/v1/N19-1128. S2CID 102353817.
Polino, Antonio; Pascanu, Razvan; Alistarh, Dan (2018-02-01). “Model compression via distillation and quantization”. arXiv:1802.05668.
Prickett, Nicole Hemsoth (2021-08-24). “Cerebras Shifts Architecture To Meet Massive AI/ML Models”. The Next Platform.
Radford, Alec; Narasimhan, Karthik; Salimans, Tim; Sutskever, Ilya (11 Jun. 2018). “Improving Language Understanding by Generative Pre-Training” (PDF). OpenAI. p. 12. Archived (PDF) from the original on 26 Jan. 2021.
Ramnani, Meeta (Jan. 28, 2022). “OpenAI dumps its own GPT-3 for something called InstructGPT, and for right reason”. Analytics India Magazine.
Ren, Xiaozhe; Zhou, Pingyi; Meng, Xinfan; Huang, Xinjing; Wang, Yadao; Wang, Weichao; Li, Pengfei; Zhang, Xiaoda; Podolskiy, Alexander; Arshinov, Grigory; Bout, Andrey; Piontkovskaya, Irina; Wei, Jiansheng; Jiang, Xin; Su, Teng; Liu, Qun; Yao, Jun (Mar. 19, 2023). “PanGu-Z: Towards Trillion Parameter Language Model with Sparse Heterogeneous Computing”. arXiv:2303.10845.
Sanh, Victor; Debut, Lysandre; Chaumond, Julien; Wolf, Thomas (2019-10-02). “DistiIBERT, a distilled version of BERT: smaller, faster, cheaper and lighter?”. arXiv:1910.01108.
Schaeffer, Rylan; Miranda, Brando; Koyejo, Sanmi (2023-04-01). “Are Emergent Abilities of Large Language Models a Mirage?”. arXiv:2304.15004.
Shannon, C. E. (January 1951). “Prediction and Entropy of Printed English”. Bell System Technical Journal. 30 (1): 50-64. doi:10.1002/j.1538-7305.1951.tb01366.x. ISSN 0005-8580.
Sharir, Or; Peleg, Barak; Shoham, Yoav (2020). “The Cost of Training NLP Models: A Concise Overview”. arXiv:2004.08900.
Shazeer, Noam; Mirhoseini, Azalia; Maziarz, Krzysztof; Davis, Andy; Le, Quoc; Hinton, Geoffrey; Dean, Jeff (2017-01-01). “Outrageously Large Neural Networks: The Sparsely-Gated Mixture-of-Experts Layer”. arXiv:1701.06538.
Shinn, Noah; Cassano, Federico; Labash, Beck; Gopinath, Ashwin; Narasimhan, Karthik; Yao, Shunyu (2023-03-01). “Reflexion: Language Agents with Verbal Reinforcement Learning”. arXiv:2303.11366.
Smith, Shaden; Patwary, Mostofa; Norick, Brandon; LeGresley, Patrick; Rajbhandari, Samyam; Casper, Jared; Liu, Zhun; Prabhumoye, Shrimai; Zerveas, George; Korthikanti, Vijay; Zhang, Elton; Child, Rewon; Aminabadi, Reza Yazdani; Bernauer, Julie; Song, Xia (2022-02-04). “Using DeepSpeed and Megatron to Train Megatron-Turing NLG 530B, A Large-Scale Generative Language Model”. arXiv:2201.11990.
Solaiman, Irene; Brundage, Miles; Clark, Jack; Askell, Amanda; Herbert-Voss, Ariel; Wu, Jeff; Radford, Alec; Krueger, Gretchen; Kim, Jong Wook; Kreps, Sarah; McCain, Miles; Newhouse, Alex; Blazakis, Jason; McGuffie, Kris; Wang, Jasmine (2019-11-12). “Release Strategies and the Social Impacts of Language Models”. arXiv:1908.09203.
Soltan, Saleh; Ananthakrishnan, Shankar; FitzGerald, Jack; et al. (3 Aug. 2022). “Alexa™ 20B: Few-Shot Learning Using a Large-Scale Multilingual Seq2Seq Model”. arXiv:2208.01448.
Srivastava, Aarohi; et al. (2022). “Beyond the Imitation Game: Quantifying and extrapolating the capabilities of language models”. arXiv:2206.04615.
Sutskever, Ilya; Vinyals, Oriol; Le, Quoc V (2014). “Sequence to Sequence Learning with Neural Networks”. Advances in Neural Information Processing Systems. Curran Associates, Inc. 27. arXiv:1409.3215.
PaLM: Scaling Language Modeling with Pathways Taylor, Ross; Kardas, Marcin; Cucurull, Guillem; Scialom, Thomas; Hartshorn, Anthony; Saravia, Elvis; Poulton, Andrew; Kerkez, Viktor; Stojnic, Robert (16 Nov. 2022). “Galactica: A Large Language Model for Science”. arXiv:2211.09085.
Thoppilan, Romal; De Freitas, Daniel; Hall, Jamie; Shazeer, Noam; Kulshreshtha, Apoorv; Cheng, Heng-Tze; Jin, Alicia; Bos, Taylor; Baker, Leslie; Du, Yu; Li, YaGuang; Lee, Hongrae; Zheng, Huaixiu Steven; Ghafouri, Amin; Menegali, Marcelo (2022-01-01). “LaMDA: Language Models for Dialog Applications”. arXiv:2201.08239.
UAE's Falcon 40B, World's Top-Ranked AI Model from Technology Innovation Institute, is Now Royalty-Free, 31 May 2023
Vaswani, Ashish; Shazeer, Noam; Parmar, Niki; Uszkoreit, Jakob; Jones, Llion; Gomez, Aidan N; Kaiser, Lukasz; Polosukhin, IIlia (2017). “Attention is All you Need”. Advances in Neural Information Processing Systems. Curran Associates, Inc. 30. arXiv:1706.03762.
Villalobos, Pablo; Sevilla, Jaime; Heim, Lennart; Besiroglu, Tamay; Hobbhahn, Marius; Ho, Anson (2022-10-25). “Will we run out of data? An analysis of the limits of scaling datasets in Machine Learning”. arXiv:2211.04325.
Vincent, James (3 Apr. 2023). “AI is entering an era of corporate control”. The Verge.
Vincent, James (Mar. 14, 2023). “Google opens up its AI language model PaLM to challenge OpenAI and GPT-3”. The Verge.
Wang, Shuohuan; Sun, Yu; Xiang, Yang; Wu, Zhihua; Ding, Siyu; Gong, Weibao; Feng, Shikun; Shang, Junyuan; Zhao, Yanbin; Pang, Chao; Liu, Jiaxiang; Chen, Xuyi; Lu, Yuxiang; Liu, Weixin; Wang, Xi; Bai, Yangfan; Chen, Qiuliang; Zhao, Li; Li, Shiyong; Sun, Peng; Yu, Dianhai; Ma, Yanjun; Tian, Hao; Wu, Hua; Wu, Tian; Zeng, Wei; Li, Ge; Gao, Wen; Wang, Haifeng (Dec. 23, 2021). “ERNIE 3.0 Titan: Exploring Larger-scale Knowledge Enhanced Pre-training for Language Understanding and Generation”. arXiv:2112.12731.
Wang, Yizhong; Kordi, Yeganeh; Mishra, Swaroop; Liu, Alisa; Smith, Noah A.; Khashabi, Daniel; Hajishirzi, Hannaneh (2022). “Self-Instruct: Aligning Language Model with Self Generated Instructions”. arXiv:2212.10560.
Wayne Xin Zhao; Zhou, Kun; Li, Junyi; Tang, Tianyi; Wang, Xiaolei; Hou, Yupeng; Min, Yingqian; Zhang, Beichen; Zhang, Junjie; Dong, Zican; Du, Yifan; Yang, Chen; Chen, Yushuo; Chen, Zhipeng; Jiang, Jinhao; Ren, Ruiyang; Li, Yifan; Tang, Xinyu; Liu, Zikang; Liu, Peiyu; Nie, Jian-Yun; Wen, Ji-Rong (2023). “A Survey of Large Language Models”. arXiv:2303.18223.
Wei, Jason; Tay, Yi; Bommasani, Rishi; Raffel, Colin; Zoph, Barret; Borgeaud, Sebastian; Yogatama, Dani; Bosma, Maarten; Zhou, Denny; Metzler, Donald; Chi, Ed H.; Hashimoto, Tatsunori; Vinyals, Oriol; Liang, Percy; Dean, Jeff; Fedus, William (31 Aug. 2022). “Emergent Abilities of Large Language Models”. Transactions on Machine Learning Research. ISSN 2835-8856.
Wiggers, Kyle (28 Apr. 2022). “The emerging types of language models and why they matter”. TechCrunch.
Winograd, Terry (1972-01-01). “Understanding natural language”. Cognitive Psychology. 3 (1): 1-191. doi:10.1016/0010-0285(72)90002-3. ISSN 0010-0285.
Wu (et-al), Chenfei (Mar. 8, 2023). “Visual ChatGPT”. arXiv:2303.04671 [cs.CV].
Wu, Shijie; Irsoy, Ozan; Lu, Steven; Dabravolski, Vadim; Dredze, Mark; Gehrmann, Sebastian; Kambadur, Prabhanjan; Rosenberg, David; Mann, Gideon (Mar. 30, 2023). “BloombergGPT: A Large Language Model for Finance”. arXiv:2303.17564.
Wu, Yonghui; et al. (2016-09-01). “Google's Neural Machine Translation System: Bridging the Gap between Human and Machine Translation”. arXiv:1609.08144.
Wu, Yue; Prabhumoye, Shrimai; Min, So Yeon (24 May 2023). “SPRING: GPT-4 Out-performs RL Algorithms by Studying Papers and Reasoning”. arXiv:2305.15486.
Yang (et-al), Zhilin (2019). “XLNet” (PDF). Proceedings from NeurIPS 2019.
Yang, Zhilin; Dai, Zihang; Yang, Yiming; Carbonell, Jaime; Salakhutdinov, Ruslan; Le, Quoc V. (2 Jan. 2020). “XLNet: Generalized Autoregressive Pretraining for Language Understanding”. arXiv:1906.08237.
Yao, Shunyu; Zhao, Jeffrey; Yu, Dian; Du, Nan; Shafran, Izhak; Narasimhan, Karthik; Cao, Yuan (2022-10-01). “ReAct: Synergizing Reasoning and Acting in Language Models”. arXiv:2210.03629.
Yin, Shukang; Fu, Chaoyou; Zhao, Sirui; Li, Ke; Sun, Xing; Xu, Tong; Chen, Enhong (2023-06-01). “A Survey on Multimodal Large Language Models”. arXiv:2306.13549.
Zaib, Munazza; Sheng, Quan Z.; Emma Zhang, Wei (4 Feb. 2020). “A Short Survey of Pre-trained Language Models for Conversational AI-A New Age in NLP”. Proceedings of the Australasian Computer Science Week Multiconference: 1-4. arXiv:2104.10810. doi:10.1145/3373017.3373028. ISBN 9781450376976. S2CID 211040895.
Zellers, Rowan; Holtzman, Ari; Bisk, Yonatan; Farhadi, Ali; Choi, Yejin (2019). “HellaSwag: Can a Machine Really Finish Your Sentence?”. arXiv:1905.07830.
Zhang, Hang; Li, Xin; Bing, Lidong (2023-06-01). “Video-LLaMA: An Instruction-tuned Audio-Visual Language Model for Video Understanding”. arXiv:2306.02858.
Zhang, Jenny; Lehman, Joel; Stanley, Kenneth; Clune, Jeff (2 Jun. 2023). “OMNI: Open-endedness via Models of human Notions of Interestingness”. arXiv:2306.01711.
Zhang, Susan; Roller, Stephen; Goyal, Naman; Artetxe, Mikel; Chen, Moya; Chen, Shuohui; Dewan, Christopher; Diab, Mona; Li, Xian; Lin, Xi Victoria; Mihaylov, Todor; Ott, Myle; Shleifer, Sam; Shuster, Kurt; Simig, Daniel; Koura, Punit Singh; Sridhar, Anjali; Wang, Tianlu; Zettlemoyer, Luke (21 Jun. 2022). “OPT: Open Pre-trained Transformer Language Models”. arXiv:2205.01068.
Zhu, Yukun; Kiros, Ryan; Zemel, Rich; Salakhutdinov, Ruslan; Urtasun, Raquel; Torralba, Antonio; Fidler, Sanja (December 2015). “Aligning Books and Movies: Towards Story-Like Visual Explanations by Watching Movies and Reading Books” (PDF). 2015 IEEE International Conference on Computer Vision (ICCV). 2015 IEEE International Conference on Computer Vision (ICCV). pp. 19-27. arXiv:1506.06724. doi:10.1109/ICCV.2015.11. ISBN 978-1-4673-8391-2. S2CID 6866988.

What is claimed is:

1. A social network method, comprising:
receiving at least one social network record of a social network, comprising a proposal, referral, or recommendation of content, through a network communication interface;
requesting and receiving the content through the network communication interface;
receiving a communication through the network communication interface;
presenting the content and the communication to the user through a content presentation interface; and
accounting for at least one of a presentation of the communication and an action predicated on the communication, to the user, by crediting at least one account associated with the proposal, referral, or recommendation, distinct from an account associated with the user, an account associated a proprietor of the content, and an account of a proprietor of the social network.

2. The user interface method according to claim 1, wherein the social network record comprises a history of user interaction with the content, further comprising debiting the account associated with the user for user interaction with the content.

3. The user interface method according to claim 1, further comprising receiving a subjective assessment or comment, wherein the subjective assessment or comment is linked to the social network record, and crediting or debiting the account associated with the user for the receipt of the subjective assessment or comment.

4. The user interface method according to claim 3, further comprising crediting or debiting the account associated with the user for the subjective assessment or comment, based on interaction of other users with the subjective assessment or comment.

5. The user interface method according to claim 1, further comprising crediting the account associated with the proprietor of the social network for the for at least one of the presentation of the communication and the action predicated on the communication.

6. The user interface method according to claim 1, further comprising crediting at least one of the account associated with the user, the account associated a proprietor of the content, and the account of a proprietor of the social network user for a presentation of the communication to the user.

7. The user interface method according to claim 1, further comprising verifying a presentation of the communication to the user.

8. The user interface method according to claim 7, further comprising capturing images of the user with a camera during the presentation of the communication; and verifying presentation of the communication to the user based on the captured images.

9. The user interface method according to claim 1, further comprising accounting for a transaction in a distributed ledger system.

10. The user interface method according to claim 1, further comprising receiving content through the network communication interface from a peer-to-peer distributed database.

11. The user interface method according to claim 1, further comprising receiving the at least one social network record from a decentralized social network database.

12. The user interface method according to claim 1, wherein the communication comprises a commercial advertisement video, and the at least one social network record of the social network, comprising the proposal, referral, or recommendation of content comprises a reference to a social media influencer who references the content, further comprising:
receiving a payment from an account associated with a commercial sponsor of the commercial advertisement video;
distributing proceeds of the payment to an account of social media influencer being the at least one account associated with the proposal, referral, or recommendation; and
further distributing proceeds to an account associated with the user, an account associated a proprietor of the content, and an account of a proprietor of the social network.

13. The user interface method according to claim 1, further comprising initiating a transaction to authorize presentation of the content to the user through the content presentation interface, wherein the transaction comprises execution of a smart contract on a distributed virtual machine.

14. The user interface method according to claim 1, further comprising providing an automated recommender; generating the proposal, referral, or recommendation of content with the automated recommender; and selecting or ranking the content for presentation to the user.

15. The user interface method according to claim 1, further comprising storing a user profile; and targeting the communication to the user based on the user profile, wherein the user profile is unavailable to the social network.

16. The user interface method according to claim 1, further comprising communicating with a generative pre-trained transformer comprising a large language model, which processes social network records and generates the proposal, referral, or recommendation of the content.

17. The user interface method according to claim 1, wherein: the social network record comprises at least one hyperlink to the content; and the communication comprises an advertisement selected based on at least the user, the social network record, and the content.

18. The user interface method according to claim 17, wherein the account is credited contingent on at least one of a presentation to the user of the advertisement, and consummation of a commercial transaction after display of the advertisement.

19. The user interface method according to claim 1, further comprising communicating with a distributed ledger comprising a blockchain through the network communication interface; and the crediting the at least one account comprises performing a transaction to credit a cryptocurrency token to a cryptocurrency wallet.

20. A decentralized social network method, for operating a device comprising a content presentation interface; a network communication interface; and at least one automated processor, the method comprising:
receiving at least one social network record of a social network, comprising a proposal, referral, or recommendation of content, and a resource locator for the content, through the network communication interface;
issuing a request for the content by communicating the resource locator through the network communication interface;
receiving a sponsor message through the network communication interface associated with a smart contract, the smart contract defining a transaction comprising a cryptocurrency payment for at least one of a presentation to a user of the sponsor message and an action by the user predicated on the sponsor message; and
accounting for the at least one of a presentation to the user of the sponsor message and the action predicated on the sponsor message, by executing the smart contract to conduct the transaction on a distributed ledger, crediting at least one cryptocurrency account associated with the proposal, referral, or recommendation, distinct from an account associated with the user, an account associated a proprietor of the content, and an account of a proprietor of the social network.

21. A social network system, comprising a content presentation interface; a network communication interface; and at least one automated processor, the at least one automated processor being configured to:
receive through the network communication interface at least one social network record of a social network, comprising a proposal, referral, or recommendation of content;
receive the content through the network communication interface;
receive a communication through the network communication interface;
present the content and the communication to the user through the content presentation interface; and
account for at least one of a presentation of the communication and an action predicated on the communication, to the user, by crediting at least one account associated with the proposal, referral, or recommendation, distinct from an account associated with the user, an account associated a proprietor of the content, and an account of a proprietor of the social network.
